(19) United States
(12) Patent Application Publication
(10) Pub. No.: US 2003/0187768 A1
(43) Pub. Date: Oct. 2, 2003

(54) Virtual finance/insurance company

(76) Inventors: Ronald D. Ryan, Missoula, MT (US); Ronald G. Marquart, Missoula, MT (US)

Correspondence Address: PETER K. TRZYNA, ESQ., P O BOX 7131, CHICAGO, IL, 60680, US

(21) Appl. No.: 10/262,185

(22) Filed: Oct. 1, 2002

Related U.S. Application Data
(60) Provisional application No. 60/326,676, filed on Oct. 3, 2001.

(51) Int. Cl. G06F 17/60

(52) U.S. Cl. 705/35

(57) ABSTRACT

A machine, method, and necessary data intermediates produced thereby, for making a sale of a financial product by computers interacting over an Internet-type network. One computer (preferably at a virtual financial/insurance company), communicates with a person's computer to determine a financial need of the person. The interacting can include: associating a financial product with the need; disclosing the cost of the financial product to the person; and automatically triggering delivery of the financial product. A wide range of financial products are supported, particularly investments and insurance.

### I. CROSS REFERENCE TO RELATED APPLICATIONS

This is a continuation-in-part patent application which claims priority from, and incorporates by reference, U.S. Patent Application Serial No. 60/326,676 filed Oct. 3, 2001, both bearing the same title and inventorship.

### II. COPYRIGHT NOTICE

A portion of the disclosure of this patent document contains material that is subject to copyright protection. The copyright owner has no objection to a statutory fair use of this material, as it appears in the files of the files or records of the U.S. Patent and Trademark Office, but otherwise reserves all copyright rights whatsoever.

### II. APPENDIX

This patent application includes Appendix with code on a CD, the CD filed herewith being incorporated by reference herein.

### IV. TECHNICAL FIELD OF THE INVENTION

The present invention pertains to an electrical digital computer machine and a data processing system, methods of making and for using the machine, products produced thereby, as well as data structures and articles of manufacture pertaining thereto, as well as all necessary intermediates, and financial products produced thereby. More particularly, this invention relates to the foregoing in connection with financial activities and commerce, and particularly to insurance, preferably relating to the Internet or the like.

### V. BACKGROUND OF THE INVENTION

The present invention involves understanding financial and insurance trends and discovered problems therein. The inventors herein made these observations and discovered the problems that set the stage for the present invention—an invention applicable generally, especially for the financial and insurance industry, but exemplified with a detailed focus on the life insurance.

For the industry's 1,200 carriers: there is a serious problem. For two decades, total individual life insurance policies sold in the US have been declining each year, together with the number of career life insurance agents. Forrester's Research characterized the problems facing the life insurance industry in their December 1 Report, Reinventing Life Insurance: “The Current Approach To Selling Life Insurance Is Broken . . . ”

“Planned investments in agent automation won't increase sales or profits because they:

Won't fix the underwriting bottleneck. Improving agent productivity won't noticeably reduce the 19 handoffs and 30 steps it currently takes to make a policy decision. Carriers will still need:

1) Underwriters to review applications, and

2) Handwritten physician statements that take 30 days to receive and cost $100 a pop.

Fail to enforce data standards. Large policies require up to seven different types of medical data—including fluid tests, MIB reports, EKGs, x-rays, and attending physician statements—all in proprietary, often non-electronic, data formats. Even when carriers receive data electronically, most adhere to their own proprietary reporting formats, requiring manual re-keying.

Don't allow life insurers to reach new markets. Many carriers plan to jump-start sales by selling through banks and brokers, which won't put their best customers through six weeks of phone tag and medical tests or wait that long to receive commissions.

“. . . . Insurers and their agents have dug themselves into a hole of low profitability because they:

Don't sell effectively. The average agent sells one or two policies per month.

When agents find a prospect, they sell based on price rather than matching a product to customer need. To facilitate price-based selling, carriers like The MONY Group offer money-losing features like unlimited premium guarantees.

Don't capture best practices. A small group of experienced agents sells most of the high-margin products. But the sales practices of these agents are trapped between their two ears—making it difficult to train other agents and impossible to grow premiums without up-selling the same group of affluent customers.

Don't recommend the right products. To spice up their sales pitch and increase commissions, agents sell policy features like accidental death and dismemberment riders that consumers don't need or features like equity-index guarantees that create hard-to-predict losses and drain carrier profits.”

The inventors have observed yet another reason for the decline in the number of policies sold: fewer agents can afford to sell small policies to the demographic group of lower and middle-income customers. With the exception small towns and cities in rural states, the traditional local agent selling all lines of insurance has disappeared, increasingly being replaced by estate planning specialists focused on the high end of the life insurance market. Agents, for their part, rightly complain that complex planning, difficult software, and long underwriting and policy processing times make it uneconomical to spend time selling policies to lower and middle-income policyholders. The percentage of households owning life insurance has dropped from 85 percent in the 1970 and 80's to only 69 percent of households in the 1990's while average policy sizes have grown dramatically, according to data from the American Council of Life Insurers (the ACLI.).

Deregulation has begun to change the competitive environment as well. The Graham Leach Bliley Act, a law passed in 2000, as well as three Supreme Court Decisions handed down during in the 1980's and 1990's, have worked together to make it easier for banks and other financial institutions to sell life insurance. Since banks, brokerage firms and mortgage companies already have relationships with the middle and lower income households, a significant opportunity exists to leverage technology at the service of these new insurance sellers to provide affordable life insurance coverage to uninsured consumers.

Further, each of these new intermediaries are interested in the life insurance market because of declining margins in their core businesses. Banks, for example, have experienced shrinking margins as a result of the steady decline in current account balances and the movement to money market checking accounts. Banks seek to increase so-called “fee income” and have moved increasingly into the insurance market, first with annuities and later with term insurance. The current market environment has forced brokerage firms to move their focus away from customer acquisition toward selling more products to the customers they already have.

Demographers and market researchers at companies like Forrester Research have pointed out that the so-called Generation-X, the group of people who are now between the ages of 20 and 37 are unique historically as a consumer group. Behaviorally, research has shown that this group is more likely to save in a 401(k). They are less likely than their parents to believe social security will be available for them. Members of this group also tend to like to do things for themselves, especially over the Internet, where research shows, two-thirds to three-quarters of this group are active. This group tends to self-serve rather than use agents or other intermediaries for their financial services relationships. Because many members of this group are now marrying and starting families, this group represents the future of the life insurance industry.

But then 1) why haven't banks and brokerage firms sold more life insurance and 2) why haven't consumers self-served to get more insurance more? The answers, the inventors believe, is first: Low commissions and compensation relative to other products. Second is lack of training and product knowledge on the part of the individuals selling the products. Third is a cumbersome sales and underwriting process in which customers can actually be turned down for a purchase of the product.

Life insurance carriers have been slow to move onto the Internet and even slower to web enable their back-end systems. A 1999 study by Accenture showed that less than a quarter of the insurance companies they surveyed could accept applications online, and fewer than ten percent could actually provide an online approval or fulfillment response. As a result of these limitations, the frustration of on-line insurance agents like Quotesmith and Answer Financial has been that they have suffered from “window shopping” and low conversion rates. Many people visit the sites, but few—less than two percent in the case of publicly traded online insurance brokerages—actually buy. Many customers are also lost between the time they decide to buy, and the time the policy is delivered. Moreover there is low brand recognition. Most of the online insurance sellers were new and unrecognized intermediaries. Perhaps this, in combination with the financial woes of many dot.com companies, led many to research the products on-line, but buy from a local agent—once they had a sense of what was “acceptable” pricing. With the notable exceptions of John Hancock, Fidelity Investments, and most recently Vanguard and USAA, very few established financial institutions offered insurance life insurance on-line.

The inventors have also observed that Web sites seem product based, rather than needs based. For example, web sites asked “please type in the face amount” instead of “How much money will you need to leave your love ones when you die?” First generation web sites, were, on the whole, difficult to use and filled industry jargon with no explanations for the terminology. This problem persists. Tools helping customers assess their needs were not integrated with the parts of the web sites relating to the quotes.

The inventors also have observed a problem of hard-to-use technology. Early on-line life insurance applications were simply off the shelf applications forms designed for use by agents, slapped on-line and made “electronic.” These applications were not for the faint-hearted, some taking up to 40 minutes to complete. Since web sites were not data persistent (didn't remember what you put into the fields), if you had to stop and go to dinner in the middle of the application, all the data you entered had to be reentered when you came back!

The inventors also observe a problem of too much jargon. Applications were filled with all sorts of hard-to-understand medical and underwriting jargon (e.g., have you ever suffered a myocardial infarction (heart attack)?”)

The inventors also observed the problem of no real on-line sales and fulfillment capability: web sites did not permit people to actually buy on-line. Instead, after filling out an on-line form, an agent or call center employee would call, to gather more information.

The inventors also observed a problem of long lead times and cumbersome processes. It takes months from the time the forms are completed to the time the coverage is obtained. The online agencies didn't do a particularly good job of keeping consumers apprised of where they were in the process.

The common problem the inventors observed of the sellers of life insurance policies whether traditional agent, bank clerk, brokerage representative or the Internet agency is that fulfillment—that process that occurred from the moment the client said or clicked “yes, I want to buy,” to the point where the policy was delivered. This process is universally too complicated, too expensive, and taking too long. This is especially true for smaller policies sold to the middle market. The sophistication of the underwriting process has grown over the past few decades, with ever-finer distinctions being built into the pricing of life insurance products as to the quality of the mortality risk. However, similar improvements in the automation of the process, the actual processing of the policy applications, have been slow in coming. Computerization has in most cases not resulted in more efficient processing, just “paving over the cow paths.” In short, the life insurance industry has been much more focused on how to underwrite the exact mortality cost of a $5 million policy covering the estate planning needs of a 50 year old executive with a slight liver imbalance, than on how to deliver a $75,000 policy quickly and cheaply to a 25 year old new father who is a free lance journalist earning $25,000 per year.

The life insurance underwriting process usually involves arranging a physical, gathering up and verifying the application information, and obtaining additional information from a variety of electronic sources such as the Medical Information Bureau and the Department of Motor Vehicles. Only a small percentage of the value added actually goes into making the underwriting decision itself.

Simply obtaining accurate and complete applications is a challenge for most insurers. Agents often fill in the application by hand, leaving much of the information blank; leaving it to the insurance company to obtain the remaining information from the insured once the application is in process. Many insurers have rooms of people in underwriting departments; people whose job it is to merely contact potential insured's or agents to gain complete application information, either because the information is missing or it is illegible.

Once available for processing, the evaluation of a completed application in a traditional life insurance company is a very complex process. It can involve as many as five different departments and involve 19 different people. To put the process in layman's terms, imagine widget, which took sixty to one hundred and twenty days to manufacture, involved the evaluation of information from credit and insurance bureaus, a physician, a paramedical specialist, and a laboratory, but which involved only about 17 minutes of actual employee value-added work time to assemble and produce the output. Much of this 17 minutes of work can be automated too, the inventors have observed. The inefficiency is the fundamental problem of life insurance underwriting. Note too that the insurance industry is not alone in its adherence to the momentum of a cumbersome process—to the contrary, it is representative. Other areas of finance are similar, and finance is not alone in this regard either. There is much room for improvement in the field of finance and insurance, and the service industry in general.

So it is this problem that the inventors herein have discovered—not just generic inefficiency, but the specific problems and reasons for the inefficiency in detail. This sets the stage for the present invention.

### VI. BRIEF SUMMARY OF THE INVENTION

A. Objects of the Invention

It is an object of the present invention to address these problems and provide a better approach.

It is another object of the present invention to simplify delivery of complex financial and insurance products.

It is an additional object of the present invention to make these products available to the large segments of the market that are currently not served, or are not efficiently served, by existing distribution.

It is yet another object of the present invention to deliver value, customization, and transparency to the consumer benefits.

It is yet a further object of the present invention to provide a preferably scaleable and unique computer technology of wide ranging utility.

It is still another object of the present invention to provide an electronic platform which companies such as life insurers can use to distribute, and process term and permanent life insurance.

B. Summary of the Invention

Any of these and other aspects of the present invention are accomplished to make it a useful improvement over the prior technology. The invention can be applied to many industries, especially in finance and insurance, as well as E-commerce. Merely as an illustration of one preferred embodiment, the invention is illustrated in connection with a nationally licensed Life Insurance Agency and/or a technology development firm. Generally, the idea is to provide a platform for automating most if not all of a company into a “virtual company.” For example, consider using the platform in connection with a virtual insurance company.

Note again, though, that the present invention evolved from market problems discovered by the inventors, and these discoveries set the stage for the concept of a “virtual financial institution.” The execution of the concept is not so easy as it challenges conventional thinking in many ways. Though applicable to all financial products such as those in the patents incorporated by reference herein (as other financial institutions like stock brokers, mortgage brokers, and the like—in one embodiment, presented in virtual institution form). In order to teach the invention, a representative teaching involves the “virtual insurance company” using a technology or “platform” that provides an integrated electronic system that can take the customer, or an agent assisting the customer, from needs analysis to quote, from quote to application, and from application to underwriting and approval, on a single, electronic platform. The system should be extremely easy to use—so easy that someone who didn't know or understand even the most basic concepts of life insurance could use it without training. The system has to provide automatic solutions, in the form of quotes, to the problems—customer needs—identified by the technology. The site had to be data persistent, meaning that each interaction with the web site (and data therefrom) would actually be retained. Information entered in one part of the site, would appear on other parts of the site where the same data was needed.

The site is easily customizable so that distribution partners can easily apply their brands and their look and feel to the system for their use, so that XYZ banks customer would believe that they were still on XYZ's site. To work, the site has to be compliant with legal requirements, e.g., in the context of insurance, insurance and security regulations across all fifty states. It has hyperlinks and explanations too, e.g., of life insurance. It avoids industry jargon, and if compliance regulations use jargon, the site provide links to easy-to-understand definitions. To reduce carriers costs in processing the policies, the system provides built-in error checking so that the only ‘clean applications’—applications ready to be underwritten—can make it through the system. And the system includes automated underwriting logic, especially so that a certain percentage of the risks—smaller policies for people without health issues in certain age brackets could be approved instantaneously.

The present invention can be carried out using Extensible Mark-up Language or XML. XML is used to permit one vendor to have its computer talk to a partner's computer (e.g., XYZ online mortgage company) over the Internet and with permission from the consumer use information provided (e.g., what kind of mortgage the customer has just purchased) to instantly develop a perfectly customized offering for the customer (an insurance policy that will pay the exact unamortized balance of the mortgage, should the consumer die in any year of the mortgage.)

Implementation Layer: A ‘Virtual Factory’ for Rent Option—This embodiment of the present invention permits competing companies to control their own systems. One alternative is to maintain this infrastructure for the competitors and another is to outsource, in effect renting the virtual financial or insurance company.

Turnkey Factories: The present invention can alternatively be used as a platform rented or equivalently charged to support different company offerings. For example, rather than utilizing computerized accounting systems to monitor per policy charges, this alternative uses other accounting system support to charge a licensing fee for its platform, and can also handle charges for time and materials for adaptations of the system to the carrier's specific needs. The present invention can also handle charging maintenance fees to pay for upgrades and maintenance of the system.

This permits those carriers wishing to own and operate the “virtual life insurance factory” a very cost effective way to do so. This gives a technological “head start.”

Technology Overview: The present invention uses a completely integrated set of technologies, from the product design to customer service technologies to fulfillment to technology for policy administration to ongoing support tools. The present invention preferably uses suppliers and integrates their systems electronically so as to provide seamless usability to the consumer.

The present invention utilizes a quote engine incorporated from U.S. Pat. No. 5,655,085, which permits finding the best policy from among multiple insurers, or only one insurer, depending on the needs of the customer or the distribution system. Finding the best policy (product) can be accomplished with a search engine that holds any two of three different variables (premium, cash value amount and death benefit) and solves for a third.

NAIC compliant illustrations are delivered to the customer online.

Online prospectuses for NASD registered products are provided online too.

Online application with integrated error checking and suitability testing using the present invention, enables compliance with various regulations including, but not limited to, National Association of Security Dealers, Security and Exchange Commission and National Association of Insurance Commissioners guidelines. This engine is used to determine an individual's suitability to purchase a variable universal life insurance policy.

The present invention has automated underwriting logic. For certain ages and death benefit amounts under $200,000, this logic can result in instant underwriting approvals being issued by the system: “Congratulations! Your life insurance application has been approved!” The policy (financial product) can be issued (sold) online.

A substantial database of Dynamic Frequently Asked Questions provides a customer-driven opportunity for high-value information capture. The most often asked question for that particular page view are automatically brought up when the customer clicks the FAQ button. Each customer is asked how well a particular response answered their question, and for those that didn't answer the question well, an automatic e-mail to customer service is generated.

Asset Analyzer TM, an automated suitability review system for customer asset allocations. The Asset Analyzer TM uses a risk-assessment and rules-based proprietary methodology. The technology quizzes the consumer about their risk tolerance, and then generates model asset allocations for a person fitting that risk profile. The consumer can use color-coded choices to pick funds and allocate his investments accordingly.

Automated account management functions to assist in asset allocation, illustration of policy, what-if scenarios, change of address and beneficiary, and other services.

The present invention has been engineered to include service friendly features at the database level include the ability to capture user experience and make it part of the record, including:

Date and times that (1) the initial web user request was received and queued, (2) it was presented to a CRS, and (3) it was completed.

Type of contact.

CRS who handled the transaction.

CRS notes.

For phone calls, the originating number (ANI) if available, the name of the file recording the conversation.

For emails, the sender's email address, the destination to which the response was sent, the text and attachments, if any, for the incoming message, and the The present invention response (if any).

Ability to enter notes about the transaction.

Capability to have telephone calls and emails queued, and the CRS display to indicate how many of each is waiting.

Capability for a caller to leave a voice mail message rather than hold.

All telephone calls will be recorded to compressed-speech files that are transferred to DVD disk.

Management reports that permit evaluation of individual and departmental performance.

All elements from user experience are written to the customer data base including the length of time individual pages were viewed by customers, and which pages they have looked at in the past.

### VII. BRIEF DESCRIPTION OF THE ILLUSTRATIVE EMBODIMENT

FIG. 1 is an overview flow chart.

FIG. 2 is a state diagram.

FIG. 3 is a calculators chart.

FIG. 4 is a flow chart.

FIG. 5 depicts FIGS. 5A and 5B, each collectively representing a flow chart.

FIG. 5A is a portion of FIG. 5.

FIG. 5B is a portion of FIG. 5.

FIG. 6 is a flow chart.

FIG. 7 depicts FIGS. 7A and 7B, each collectively representing a flow chart.

FIG. 5A is a portion of FIG. 7.

FIG. 5B is a portion of FIG. 7.

FIG. 8 is a flow chart.

FIG. 9 is a chart of underwriting rules.

FIG. 10 is a chart of underwriting rules.

FIG. 11 is a chart of underwriting rules.

FIG. 12 is a screen shot.

FIG. 13 is a screen shot.

FIG. 14 is a screen shot.

FIG. 15 is a screen shot.

FIG. 16 is a screen shot.

FIG. 17 is a screen shot.

FIG. 18 is a screen shot.

FIG. 19 is a screen shot.

FIG. 20 is a screen shot.

FIG. 21 is a screen shot.

FIG. 22 is a screen shot.

FIG. 23 is a screen shot.

FIG. 24 is a screen shot.

FIG. 25 is a screen shot.

FIG. 26 is a screen shot.

FIG. 27 is a screen shot.

FIG. 28 is a screen shot.

FIG. 29 is a screen shot.

FIG. 30 is a screen shot.

FIG. 31 is a screen shot.

FIG. 32 is a screen shot.

FIG. 33 is a screen shot.

FIG. 34 is a screen shot.

FIG. 35 is a screen shot.

FIG. 36 is a screen shot.

FIG. 37 is a screen shot.

FIG. 38 is a screen shot.

FIG. 39 is a screen shot.

FIG. 40 is a screen shot.

FIG. 41 is a screen shot.

FIG. 42 is a screen shot.

FIG. 43 is a screen shot.

FIG. 44 is a screen shot.

FIG. 45 is a screen shot.

FIG. 46 is a screen shot.

FIG. 47 is a screen shot.

FIG. 48 is a screen shot.

FIG. 49 is a screen shot.

FIG. 50 is a screen shot.

FIG. 51 is a screen shot.

FIG. 52 is a screen shot.

FIG. 53 is a screen shot.

FIG. 54 is a screen shot.

FIG. 55 is a screen shot.

FIG. 56 is a screen shot.

FIG. 57 is a screen shot.

FIG. 58 is a screen shot.

FIG. 59 is a screen shot.

FIG. 60 is a screen shot.

FIG. 61 is a screen shot.

FIG. 62 is a screen shot.

FIG. 63 is a screen shot.

FIG. 64 is a screen shot.

FIG. 65 is a screen shot.

FIG. 66 is a screen shot.

FIG. 67 is a screen shot.

FIG. 68 is a screen shot.

FIG. 69 is a screen shot.

FIG. 70 is a screen shot.

FIG. 71 is a screen shot.

FIG. 72 is a screen shot.

FIG. 73 is a screen shot.

FIG. 74 is a screen shot.

FIG. 75 is a screen shot.

FIG. 76 is a screen shot.

FIG. 77 is a screen shot.

FIG. 78 is a screen shot.

FIG. 79 is a screen shot.

FIG. 80 is a screen shot.

FIG. 81 is a screen shot.

FIG. 82 is a screen shot.

FIG. 83 is a screen shot.

FIG. 84 is a screen shot.

FIG. 85 is a flow chart.

FIG. 86 FIGS. 86A and 86B, each collectively representing a flow chart.

FIG. 86A is a portion of FIG. 86.

FIG. 86B is a portion of FIG. 86.

FIG. 87 is a flow chart.

FIG. 88 is a flow chart.

FIG. 89 is a flow chart.

FIG. 90 is a flow chart.

FIG. 91 is a print out of the suitability rules.

FIG. 92 is a continuation of the print out of the suitability rules.

FIG. 93 is a print out of the underwriting rules.

FIG. 94 is a continuation of the print out of the suitability rules.

FIG. 95 is a further continuation of the print out of the suitability rules.

FIG. 96 is a screen shot.

FIG. 97 is a screen shot of build your own universal life insurance.

FIG. 98 is a screen shot of insured information.

FIG. 99 is a screen shot of policy information.

FIG. 100 is a screen shot of do you need any riders.

FIG. 101 is a screen shot of policy changes (withdrawals).

FIG. 102 is a screen shot of withdrawal information.

FIG. 103 is a screen shot of review your information.

FIG. 104 is a screen shot of important notice.

FIG. 105 is a continuation of the screen shot of important notice.

FIG. 106 is a screen shot of detailed results.

FIG. 106 is a continuation of the screen shot of detailed results.

FIG. 108 s a further continuation of the screen shot of detailed results.

FIG. 109 is a screen shot of log-in and register information.

FIG. 110 is a continuation of the screen shot of log-in and register information.

FIG. 111 is a screen shot of begin application.

FIG. 112 is a screen shot of the you are about to begin the application process . . . page.

FIG. 113 is a screen shot of the step 1—viewing the prospectus page.

FIG. 114 is a screen shot of privacy statement.

FIG. 115 is a screen shot of complete the application.

FIG. 116 is a continuation of complete the application.

FIG. 117 is a screen shot of insured information.

FIG. 118 is a further screen shot of insured information.

FIG. 119 is a screen shot of tobacco use.

FIG. 120 is a further screen shot of tobacco use.

FIG. 121 is a screen shot of family and dependents.

FIG. 122 is a screen shot of plan information.

FIG. 123 is a screen shot of do you need any riders.

FIG. 124 is a screen shot of children's term rider.

FIG. 125 is a screen shot of summary of demographic information.

FIG. 126 is a continuation of the screen shot of summary of demographic information.

FIG. 127 is a screen shot of information authorization.

FIG. 128 is a continuation of the screen shot of information authorization

FIG. 129 is a further screen shot of information authorization.

FIG. 130 is a screen shot of your income.

FIG. 131 is a screen shot of your investments.

FIG. 132 is a continuation of the screen shot of your investments.

FIG. 133 is a screen shot of investment time horizon.

FIG. 134 is a screen shot of what is your investment risk tolerance.

FIG. 135 is a further screen shot of what is your investment risk tolerance.

FIG. 136 is a screen shot of what is your reason for purchasing realTime>life.

FIG. 137 is a further screen shot of what is your reason for purchasing realTime>life.

FIG. 138 is a screen shot of summary of financial suitability.

FIG. 139 is a screen shot of premium mode.

FIG. 140 is a screen shot of current life insurance policy.

FIG. 141 is a further screen shot of current life insurance policy.

FIG. 142 is a screen shot of medical history.

FIG. 143 is a screen shot of health.

FIG. 144 is a further screen shot of health.

FIG. 145 is a continuation of a further screen shot of health.

FIG. 146 is still a further a screen shot of health.

FIG. 147 is a screen shot of family history.

FIG. 148 is a screen shot of your proportions.

FIG. 149 is a screen shot of your lifestyle.

FIG. 150 is a further screen shot of your lifestyle.

FIG. 151 is still a further screen shot of your lifestyle.

FIG. 152 is a screen shot of international travel.

FIG. 153 is a screen shot of aviation.

FIG. 154 is a further screen shot of aviation.

FIG. 155 is a screen shot of driving record.

FIG. 156 is a screen shot of summary of underwriting information.

FIG. 157 is a continuation of the screen shot of summary of underwriting information.

FIG. 158 is a continuation of the screen shot of summary of underwriting.

FIG. 159 is a screen shot of tell us about the primary beneficiary (or beneficiaries).

FIG. 160 is a screen shot of contingent beneficiary.

FIG. 161 is a further screen shot of tell us about the contingent beneficiary (or beneficiaries).

FIG. 162 is a screen shot of summary of beneficiary information.

FIG. 163 is a screen shot of fund selection.

FIG. 164 is a continuation of the screen shot of fund selection.

FIG. 165 is a screen shot of thank you for choosing realTIME>life.

FIG. 166 is a screen shot of looking to build a brighter future.

FIG. 167 is a continuation of the screen shot of looking to build a brighter future.

FIG. 168 is a screen shot of summary of portfolio information.

FIG. 169 is a screen sot of your application is complete.

FIG. 170 is a screen shot of summary of demographic information.

FIG. 171 is a continuation of the screen shot of summary of demographic information.

FIG. 172 is a screen shot of summary of financial suitability.

FIG. 173 is a screen shot of summary of underwriting information.

FIG. 174 is a continuation of the screen shot of summary of underwriting information.

FIG. 175 is a further continuation of the screen shot of summary of underwriting information.

FIG. 176 is a screen shot of summary of beneficiary information.

FIG. 177 is a screen shot of summary of portfolio information.

FIG. 178 is a screen shot of your policy illustration.

FIG. 179 is a continuation of the screen shot of your policy illustration.

FIG. 180 is a screen shot of detailed results.

FIG. 181 is a further screen shot of detailed results.

FIG. 182 is a screen shot of step 4—review the illustration.

FIG. 183 is a screen shot of the illustration download page.

FIG. 184 is a screen shot of illustration confirmation.

FIG. 185 is a screen shot of application confirmation.

FIG. 186 is a continuation of the screen shot of application confirmation.

FIG. 187 is a screen shot of confirmation problem resolution page.

FIG. 188 is a screen shot of first premium payment method.

FIG. 189 is a screen shot of electronic payment.

FIG. 190 is a screen shot of Troy's e-check pages.

FIG. 191 is a screen shot of thank you for your electronic payment.

FIG. 192 is a screen shot of electronic payment refusal.

FIG. 193 is a screen shot of your acceptance results.

FIG. 194 is a screen shot of step 5—print, sign and mail you application.

FIG. 195 is a screen shot.

FIG. 196 is a screen shot.

FIG. 197 is a screen shot.

FIG. 198 is a screen shot.

FIG. 199 is a screen shot.

FIG. 200 is a screen shot.

FIG. 201 is a screen shot.

FIG. 202 is a screen shot.

FIG. 203 is a screen shot.

FIG. 204 is a screen shot.

FIG. 205 is a screen shot.

FIG. 206 is a screen shot.

FIG. 207 is a screen shot.

FIG. 208 is a screen shot.

FIG. 209 is a screen shot.

FIG. 210 is a screen shot.

FIG. 211 is a screen shot.

FIG. 212 is a screen shot.

FIG. 213 is a screen shot.

FIG. 214 is a screen shot.

FIG. 215 is a screen shot.

FIG. 216 is a screen shot.

FIG. 217 is a screen shot.

FIG. 218 is a screen shot.

FIG. 219 is a screen shot.

FIG. 220 is a screen shot.

FIG. 221 is a screen shot.

FIG. 222 is a screen shot.

FIG. 223 is a screen shot.

FIG. 224 is a screen shot.

FIG. 225 is a screen shot.

FIG. 226 is a screen shot.

FIG. 227 is a screen shot.

FIG. 228 is a screen shot.

FIG. 229 is a screen shot.

FIG. 230 is a screen shot.

FIG. 231 is a screen shot.

FIG. 232 is a screen shot.

FIG. 233 is a screen shot.

FIG. 234 is a screen shot.

FIG. 235 is a screen shot.

FIG. 236 is a screen shot.

FIG. 237 is a screen shot.

FIG. 238 is a screen shot.

FIG. 239 is a screen shot.

FIG. 240 is a screen shot.

FIG. 241 is a screen shot.

FIG. 242 is a screen shot.

FIG. 243 is a screen shot.

FIG. 244 is a screen shot.

FIG. 245 is a screen shot.

FIG. 246 is a screen shot.

FIG. 247 is a screen shot.

FIG. 248 is a screen shot.

FIG. 249 is a screen shot.

FIG. 250 is a screen shot.

FIG. 251 is a screen shot.

FIG. 252 is a screen shot.

FIG. 253 is a screen shot.

FIG. 254 is a screen shot.

FIG. 255 is a screen shot.

FIG. 256 is a screen shot.

FIG. 257 is a screen shot.

FIG. 258 is a screen shot.

FIG. 259 is a screen shot.

FIG. 260 is a screen shot.

FIG. 261 is a screen shot.

FIG. 262 is a screen shot.

FIG. 263 is a screen shot.

FIG. 264 is a screen shot.

FIG. 265 is a screen shot.

FIG. 266 is a screen shot.

FIG. 267 is a screen shot.

FIG. 268 is a screen shot.

FIG. 269 is a screen shot.

FIG. 270 is a screen shot.

FIG. 271 is a screen shot.

FIG. 272 is a screen shot.

FIG. 273 is a screen shot.

FIG. 274 is a screen shot.

FIG. 275 is a screen shot.

FIG. 276 is a screen shot.

FIG. 277 is a screen shot.

FIG. 278 is a screen shot.

FIG. 279 is a screen shot.

FIG. 280 is a screen shot.

FIG. 281 is a screen shot.

FIG. 282 is a screen shot.

FIG. 283 is a screen shot.

FIG. 284 is a screen shot.

FIG. 285 is a screen shot.

FIG. 286 is a screen shot.

FIG. 287 is a screen shot.

FIG. 288 is a screen shot.

FIG. 289 is a screen shot.

FIG. 290 is a screen shot.

FIG. 291 is a screen shot.

FIG. 292 is a screen shot.

FIG. 293 is a screen shot.

FIG. 294 is a screen shot.

FIG. 295 is a screen shot.

FIG. 296 is a screen shot.

FIG. 297 is a screen shot.

FIG. 298 is a screen shot.

FIG. 299 is a screen shot.

FIG. 300 is a screen shot.

FIG. 301 is a screen shot.

FIG. 302 is a screen shot.

FIG. 303 is a screen shot.

FIG. 304 is a screen shot.

FIG. 305 is a screen shot.

FIG. 306 is a screen shot.

FIG. 307 is a screen shot.

FIG. 308 is a screen shot.

FIG. 309 is a screen shot.

FIG. 310 is a screen shot.

FIG. 311 is a screen shot.

FIG. 312 is a screen shot.

FIG. 313 is a screen shot.

FIG. 314 is a screen shot.

FIG. 315 is a screen shot.

FIG. 316 is a screen shot.

FIG. 317 is a screen shot.

FIG. 318 is a screen shot.

FIG. 319 is a screen shot.

FIG. 320 is a screen shot.

FIG. 321 is a screen shot.

FIG. 322 is a screen shot.

FIG. 323 is a screen shot.

FIG. 324 is a screen shot.

FIG. 325 is a screen shot.

FIG. 326 is a screen shot.

FIG. 327 is a screen shot.

FIG. 328 is a screen shot.

FIG. 329 is a screen shot.

FIG. 330 is a screen shot.

FIG. 331 is a screen shot.

FIG. 332 is a screen shot.

FIG. 333 is a screen shot.

FIG. 334 is a screen shot.

FIG. 335 is a screen shot.

FIG. 336 is a screen shot.

FIG. 337 is a screen shot.

FIG. 338 is a screen shot.

FIG. 339 is a screen shot.

FIG. 340 is a screen shot.

FIG. 341 is a screen shot.

FIG. 342 is a screen shot.

FIG. 343 is a screen shot.

FIG. 344 is a screen shot.

FIG. 345 is a flow chart.

FIG. 346 is a flow chart.

FIG. 347 is a flow chart.

FIG. 348 is a screen shot.

FIG. 349 is a screen shot.

FIG. 350 is a screen shot.

FIG. 351 is a screen shot.

FIG. 352 is a screen shot.

FIG. 353 is a screen shot.

FIG. 354 is a screen shot.

FIG. 355 is a screen shot.

FIG. 356 is a screen shot.

FIG. 357 is a screen shot.

FIG. 358 is a screen shot.

FIG. 359 is a screen shot.

FIG. 360 is a screen shot.

FIG. 361 is a screen shot.

FIG. 362 is a screen shot.

FIG. 363 is a screen shot.

FIG. 364 is a screen shot.

FIG. 365 is a screen shot.

FIG. 366 is a screen shot.

FIG. 367 is a screen shot.

FIG. 368 is a screen shot.

FIG. 369 is a screen shot.

FIG. 370 is a screen shot.

FIG. 371 is a screen shot.

FIG. 372 is a screen shot.

FIG. 373 is a screen shot.

FIG. 374 is a screen shot.

FIG. 375 is a screen shot.

FIG. 376 is a screen shot.

FIG. 377 is a screen shot.

FIG. 378 is a screen shot.

FIG. 379 is a screen shot.

FIG. 380 is a screen shot.

FIG. 381 is a screen shot.

FIG. 382 is a screen shot.

FIG. 383 is a screen shot.

FIG. 384 is a screen shot.

FIG. 385 is a screen shot.

FIG. 386 is a screen shot.

FIG. 387 is a screen shot.

FIG. 388 is a screen shot.

FIG. 389 is a screen shot.

FIG. 390 is a screen shot.

FIG. 391 is a screen shot.

FIG. 392 is a screen shot.

FIG. 393 is a screen shot.

FIG. 394 is a screen shot.

FIG. 395 is a screen shot.

FIG. 396 is a screen shot.

FIG. 397 is a screen shot.

FIG. 398 is a screen shot.

FIG. 399 is a screen shot.

FIG. 400 is a screen shot.

### VIII. DETAILED DESCRIPTION OF DRAWINGS FOR THE ILLUSTRATIVE EMBODIMENT

The present invention is a virtual financial and/or insurance company. The invention is disclosed in the context of one application, but the principles are broadly applicable. This requires understanding that features and steps of an embodiment are representative, and thus are replaceable and substitutable or interchangeable as this is the very nature of the present invention.

The teaching embodiment of present invention can facilitate the sale of life insurance online and through non-traditional life insurance distribution channels such as banks, brokerage firms, over the Internet or the like, and the worksite. The technology also increases the productivity and profitability of existing sales organizations.

The present invention's technology can enable, among other things, the straight-through processing and administration of life insurance from point of sale through underwriting, policy issuance, and policy maintenance. Its technology brings together a single, common electronic workflow, which for example permits life insurance carriers using the present invention's platform to significantly lower their customer acquisition and policy processing costs. Note that financial products and other products can find suitable support hereby as well, and in the financial products and system integration extending to U.S. Pat. Nos. 5,655,085 and 5,673,402, which are incorporated by reference.

Using insurance as the example for the embodiment, the present embodiment of the invention offers a “life insurance company in a box,” i.e., is a modular set that can include product designs or alternatives, sales technologies, application processes, underwriting/approval technologies, and administration procedures preferably all interlinked and interoperable, and designed to work in one seamless process flow from customer needs analysis through policy purchase and renewal. The system or “platform” is modular, scaleable, and customizable for each product supplier's own particular brand, look, and feel.

This technology permits financial institutions to sell products, again for example, insurance products such as inexpensive customizable term, universal life and/or variable universal life insurance coverage over the Internet, through the bank branch, at the work place, through an untrained agent and/or even at a kiosk. The present invention can have capability to implement “straight-through processing” of policies, electronically linking every element of the distribution, sales, underwriting and policy administration value chain with scaleable technologies.

Interface: The present invention designed its web interface to do everything an excellent agent does: answer questions about insurance jargon, teach customers about the product and why they should buy it, conduct financial needs analysis, and provide quotes tailored to each customer's specific needs, all through an easy to use HTML interface, online. Like any good agent the web site is accurate and compliant with legal requirements. Because the system is designed to be used by customers who don't know anything about insurance, the system can allow intermediaries—everything from bank platform personnel to insurance agents to sell products more efficiently—simply by adding or taking away elements of the site.

Life Insurance Product Designs: The present invention is illustrated with three product designs: variable universal life insurance, universal life insurance, and a unique, a customizable product—exemplified herein by a term life insurance, but the same approach can work for other financial products, e.g., those in the patents incorporated by reference herein.

Universal Life. The universal life products provide cash value accumulations for the consumer—values can be ever more preferably over 5%, 10%, 15%, and preferably even 20% better than the average performance of the policies sold by conventional agent approaches. The product is simple, flexible, and easy to understand, with plain English policy forms and prospectus. The present invention can change the product design to fit the needs and costs of the distribution channel involved.

Term Life: The term life insurance product also is used to teach a more generic improvement of enabling a consumer to design their own coverage or financial product themselves. Using a user interface, the consumer can dictate what is desired, e.g., the number of years the consumer wants to pay premiums, the amount of the coverage by year, and for how many years they want to buy the coverage. And they can do this all on line. Also, the product (term life) can be convertible, preferably through the proprietary interface, to another product, such as a higher value added universal life insurance product.

Fulfillment: When the customer wants to buy the policy (or other product as per the patents incorporated by reference), the system is able to take the application online, approve it instantaneously (e.g., up to $200,000 in face amount if the customer is in good health, and the Medical Information Bureau confirms that the consumer hasn't previously been turned down for insurance). Even if the consumer is not in good health (or qualification is otherwise of further concern), the invention is able to tell the consumer how long it will take to process, e.g., underwrite, in response to what is typical for people of their age purchasing a policy of this size; the system requests the most convenient time and place for the consumer to have his or her physical for underwriting and passes this information on to the company that arranges the physicals on behalf of the carriers. The system also solicits the information for, and provides for signature and mailing a completed life insurance application that is compliant in the state that the policy is being purchased. Electronic signatures are handled too. The present invention can also collect the funds for the policy binder online through a form that authorizes a debit from the customer's checking account using the bank ACH system or other payment systems.

Suitability Testing: For the sale of an investment security, e.g., For a variable life insurance or cash value sale, the system is capable of providing a prospectus for the life insurance policy. It takes the application information and tests to make sure that the consumer is indeed suitable to purchase this kind of life insurance product, based on NASD and state insurance rules regarding suitability. The system also does a “suitability analysis” by automatically interviewing the consumer about what kind of investor they are, and show them a sample portfolio allocation typical for someone of their particular risk and insurance profile.

Underwriting: Whether the policy is underwritten in real time or through a more lengthy process involving a physical examination, the system notifies the consumer when they have been approved and generates a special letter and even a referral to another carrier if they are not approved. If the consumer is approved but with a higher premium because the information from the physical shows they are not as healthy as they said they were on the application, the system can give two new illustrations: one with a reduced benefit, and the same premium; one with the same benefit but with an increased premium.

Policy Maintenance: Once the customer owns the policy, the system permits the customer to set up a monthly deduction from their checking account. It also permits the customer to move separate account policy values between funds, check on policy values, change name and address information online on a web site. It will e-mail customers annual re-illustrations (revised policy projections and statements of account) electronically, and notify customers if they are not earning enough to achieve the goals they originally set for themselves when they bought the policy.

Customer Service: All of this is linked to a single database that keeps track of all of the customer's page views and data entered before they buy, and which requires them to enter the data only once. The system gives the customer service representatives access to all the customer's information, even the web pages that the customer has looked at so that they can better serve the client. What The present invention has done, simply put, is to bring together all of the technologies to make this new online delivery system.

Here are generally highlighted elements of the technology that make the above user experience possible, other aspects being indicated in below and in the Appendix. The elements of this invention being available in a “menu complete” or “a la carte” embodiments:

The present invention has sales content, needs analysis software, and integrated quote engines for the sale of the product, in the example of the present invention, both term and universal life insurance. Content is compliant from a regulatory standpoint, and robust, educational, and consumer-friendly from a user standpoint. Online tools include dynamic Frequently Asked Questions, and needs analysis tools that automatically provide quotes. The system can move from quote to application to issuance in a single session.

The present invention ‘XML Factory.’ The present invention uses tiered architecture, a four-tier JSP architecture in the present embodiment, to permit easy customization and re-branding of the sales interface for a different look and feel to suit needs of distribution partners. The site is engineered to be data persistent, so customers need only enter information one time. Also, the company's software architecture permits deployment across a variety of channels and platforms including worksite, direct-to-consumer, agent assisted, Internet, and even foreign language offerings. The system even permits integration with other company's needs analysis software so that the present invention's supported products can be provided as the solution to financial needs identified by third party software platforms.

Automated Underwriting. The present invention is integrated with underwriting logic, and for this, incorporated by reference are U.S. Pat. No. 5,523,942 “Design grid for inputting insurance and investment product information in a computer system” and U.S. Pat. No. 4,975,840 “Method and apparatus for evaluating a potentially insurable risk.” For example, an online application process can permit carrier partners to provide approvals of life insurance policies up to $200,000 in face amount on-line, real-time, without the benefit of physicals, blood, or saliva tests. Larger policies may be underwritten using integrated data links to an outside underwriting unit for on-line term offerings such as those from Swiss Reinsurance, Fidelity Life Insurance, Sun Life of Canada, and others.

Suitability Engine. The present invention has developed a rules-based engine to determine whether or not an investor is suitable, a feature for on-line sale of an NASD-registered investment product like Variable Universal Life Insurance. The technology uses an automated suitability review system for customer asset allocations. This Asset Analyzer™ system uses a risk-assessment and rules-based proprietary methodology to advise customers on their asset allocation decisions.

Customer Service Technology. The present invention has an active NASD broker dealer to provide support for sales and service including phone, fax, and e-mail queries. Integrated technology permits the present invention to see the screens the customer has seen, and can even assist them in the completion of their application or illustration.

Policy Administration Integration. Through a partnership with McCamish Systems, a leading policy administration technology provider, the present invention can utilize outsourced policy administration and customer support TPA services. This includes web enabled self-service capabilities for administrative functions, including reallocation of separate account investments, change of address or beneficiary, checking net asset value in investment funds, etc. The present invention has integrated policy administration functions into its call center for live customer support within or on an outsourced basis.

Profitability Controls. Most carriers make money on investments, but lose money on fulfillment and the maintenance of policies. The present invention's product designs can be adjusted to guarantee carrier profitability by including fixed priced charges for each element outsourced—from underwriting to policy administration. Carrier return on investment is ever more preferable in excess of 5, 10, 15, and 20 percent after tax, and after these supplier loads have been taken out of the present invention designed policies.

More particularly, the present invention provides financial services needs analysis and sales support in a worksite setting. The system function on a stand-alone basis, and also can function as middleware between any Human Resources Management System and the relevant product related fulfillment engines. The users of the system can be employees, but it is understood that the system can be sold and implemented by the brokerage community either as an extension of an existing 401(k) offering, or as a stand-alone offering.

The present invention imports employee data (or solicits the data if it is not available) into its databases. Through the use of the system's needs analysis capabilities, the present invention will develop, for the end user, insights about their financial needs that encourage and enable the purchase of financial products.

To understand a representative embodiment of the present invention, by way of a further overview on how the various Figures in this patent application are organized and coordinated, to assist the reader in gaining an overall perspective, the concepts of FIG. 1 are put into operation with a state diagram such as that in FIG. 2. FIG. 2 presents an overview of illustrative technology for implementing, as the example, sales of term life insurance and variable universal life insurance, an application illustrative of other financial product handling.

Once a customer has decided to complete a formal application for term insurance, the flowchart in FIGS. 4-8 describes the logic beginning with Block 70, Apply Button from Quotes Results Page, which is a consumer selection on the Term Results Page Block 71 of FIG. 345 form the RealTIME>term educational path. FIGS. 9-11 are sample underwriting rules that are incorporated into the underwriting logic in the flowchart in FIGS. 4-8. FIGS. 12-84 are website screen shots that illustrate the term life insurance application process as seen by the consumer.

Once a customer has decided to complete a formal application for variable universal life insurance, the flowchart in FIGS. 85-90 describes the logic beginning with Block 288, Apply Button from Quote Results Page, which is a consumer selection on the Apply Now Block 101 of FIG. 346 from the RealTIME>Life educational path. FIGS. 91-92 are suitability rules that are incorporated into the flowchart in FIGS. 85-90. FIGS. 93-95 are sample underwriting rules that are incorporated into the underwriting logic in the flowchart in FIGS. 85-90. FIGS. 100-200 are website screen shots that illustrate the variable universal life insurance application process as seen by the consumer. Figures

FIG. 345 presents a flowchart of the educational paths available to a consumer prior to formal application for purchase of the realTIME>term™ term insurance product. FIGS. 348-361 are website “screen shots” that illustrate this educational path for the term insurance product as seen by the consumer.

FIGS. 346-347 present a flowchart of the educational paths available to a consumer prior to formal application for purchase of the realTIME>life™ variable universal life insurance product. FIGS. 362-400 are website screen shots that illustrate this education path for the variable universal life insurance product as seen by the consumer.

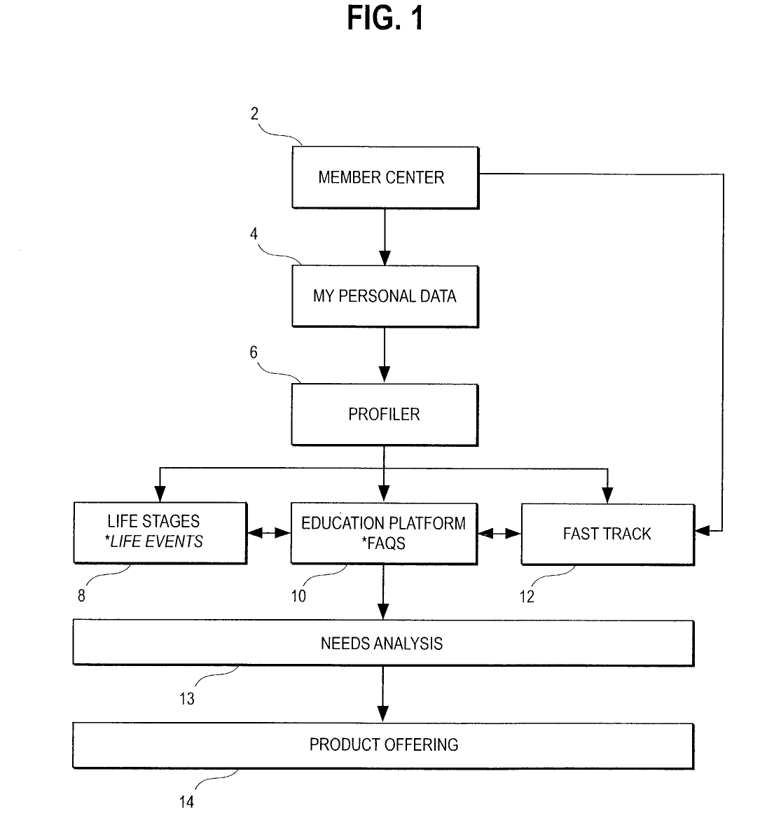

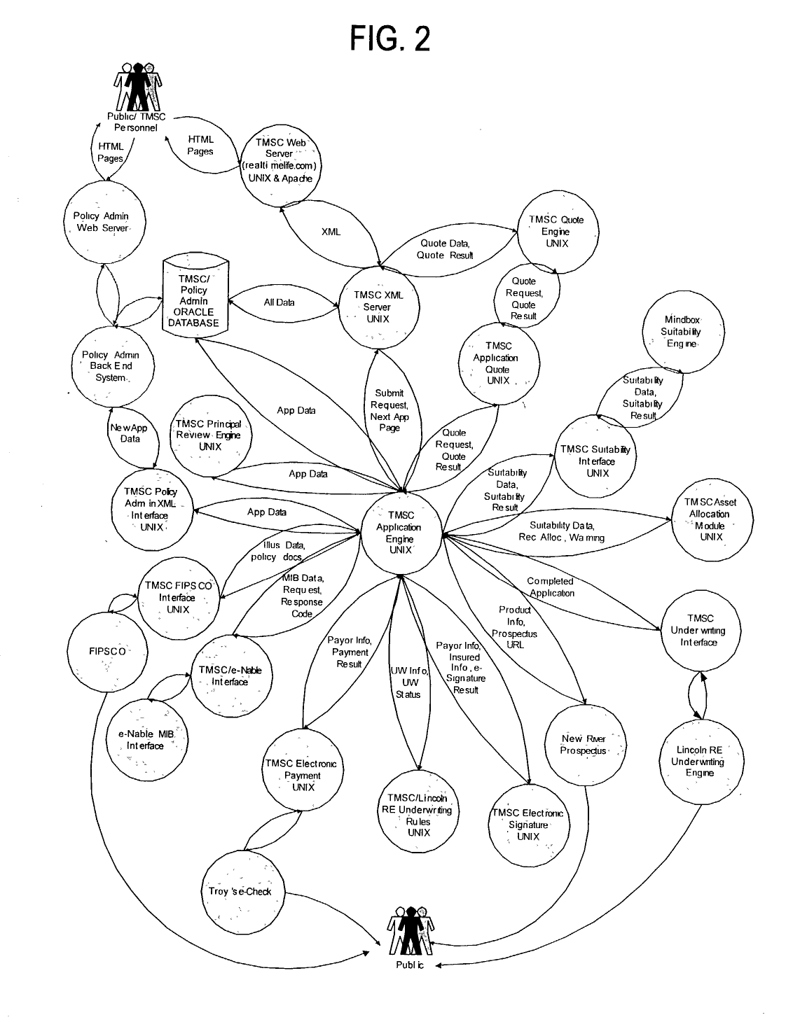

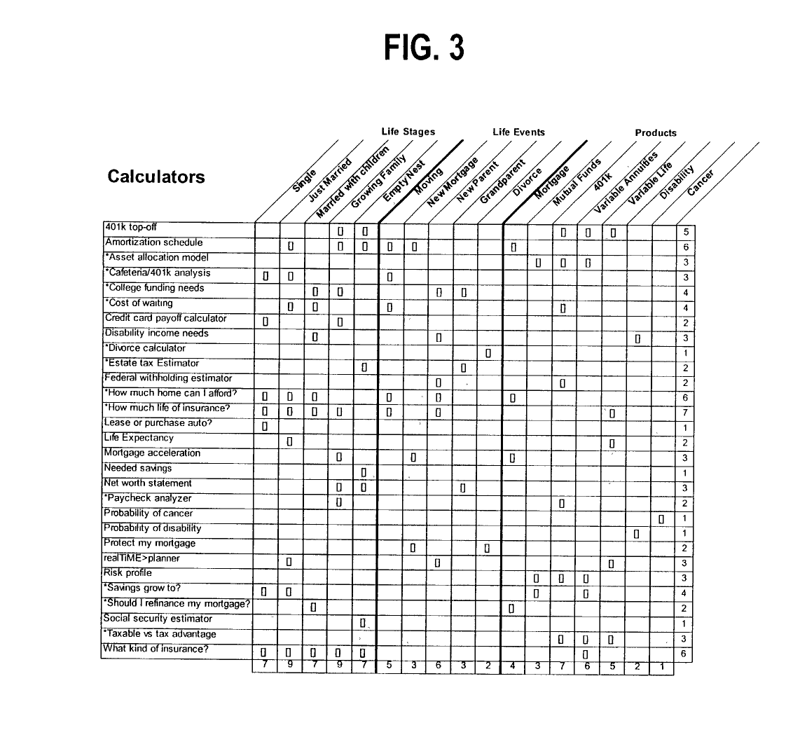

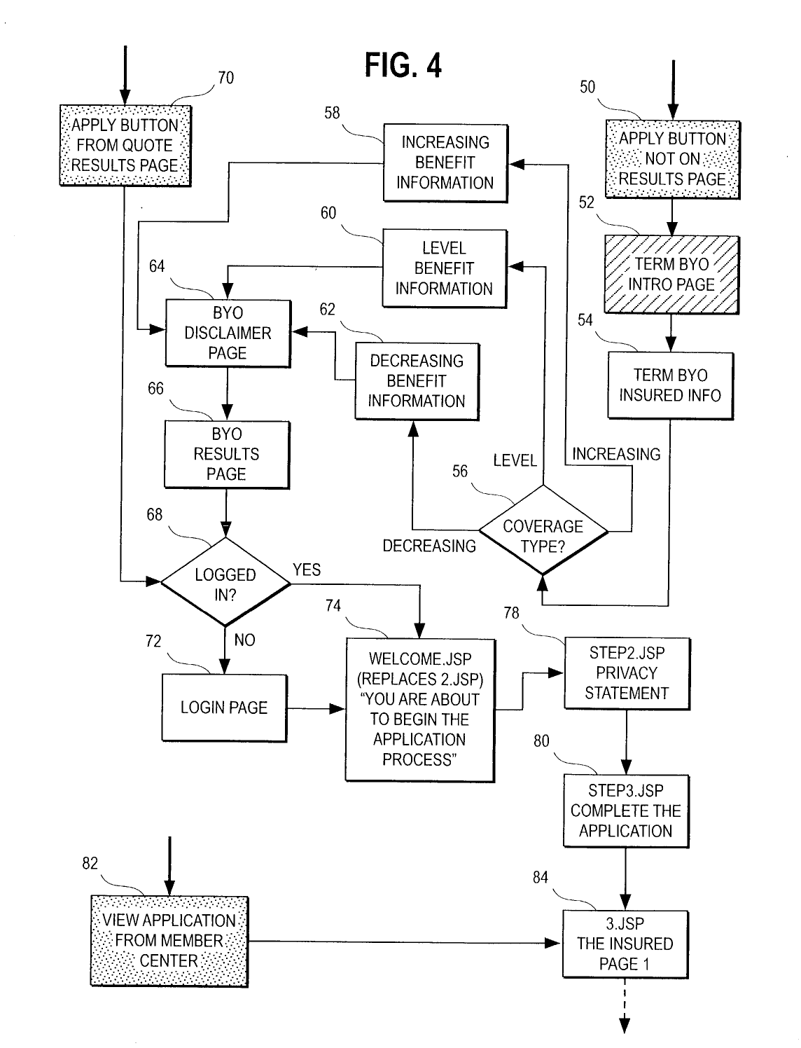

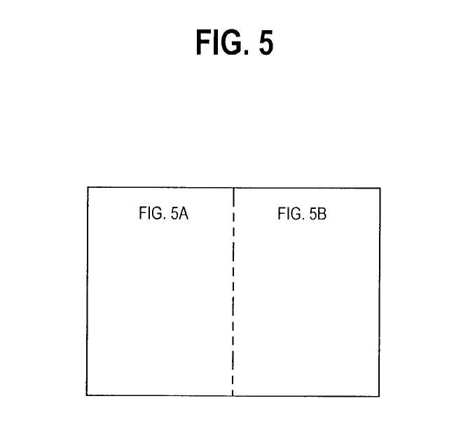

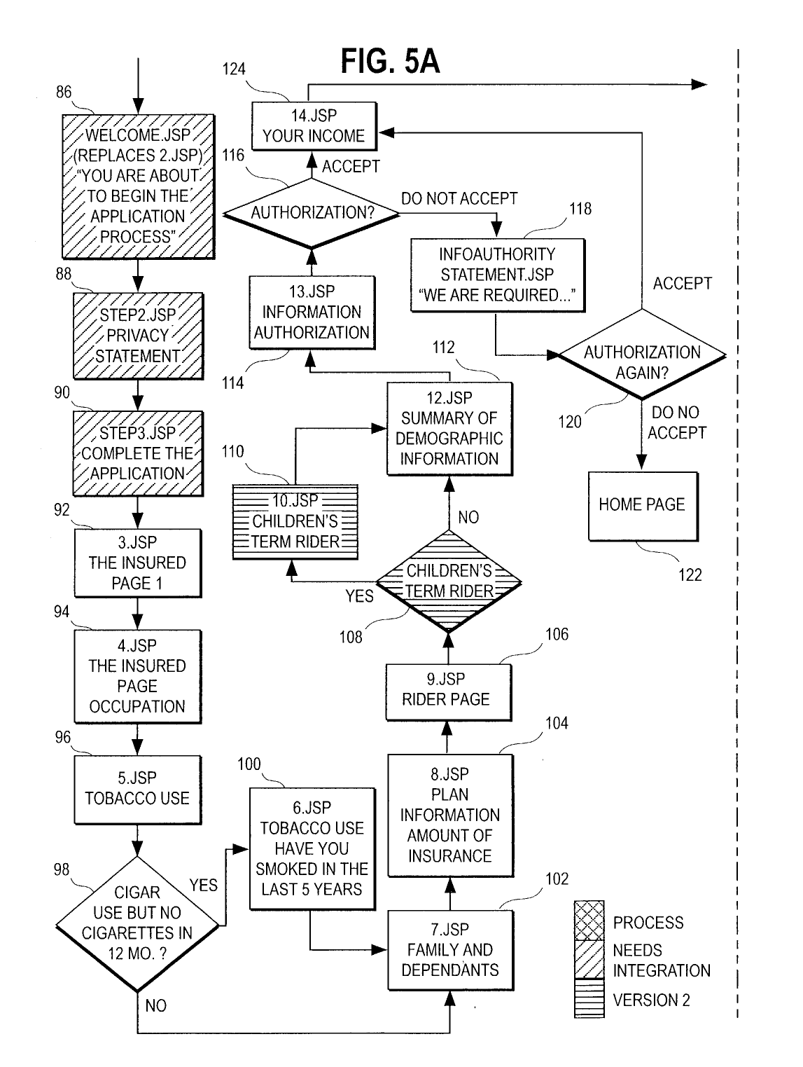

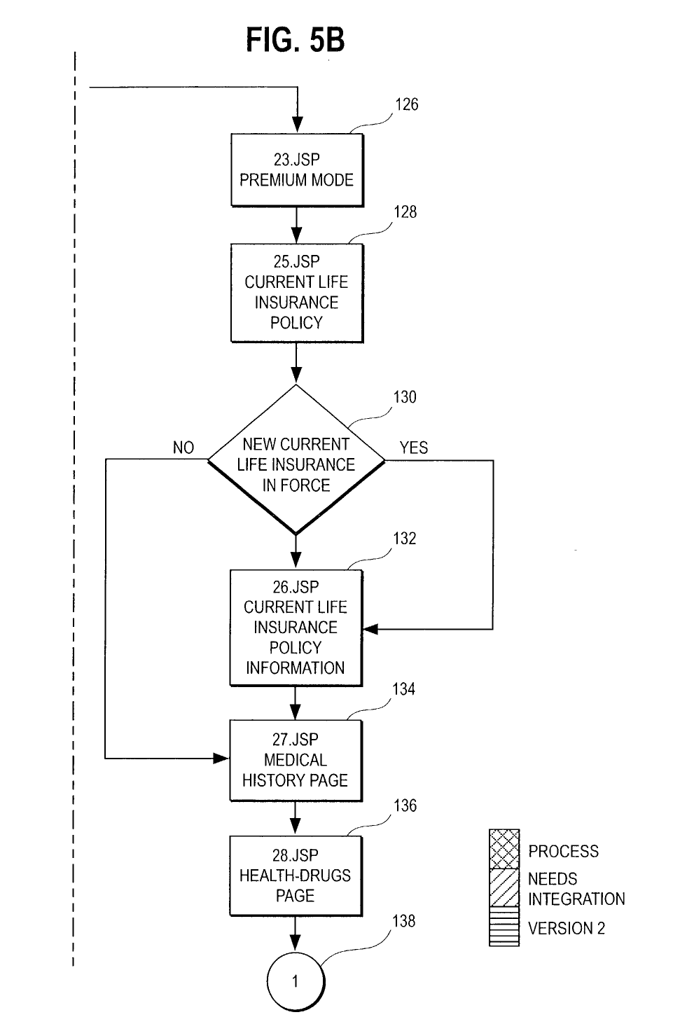

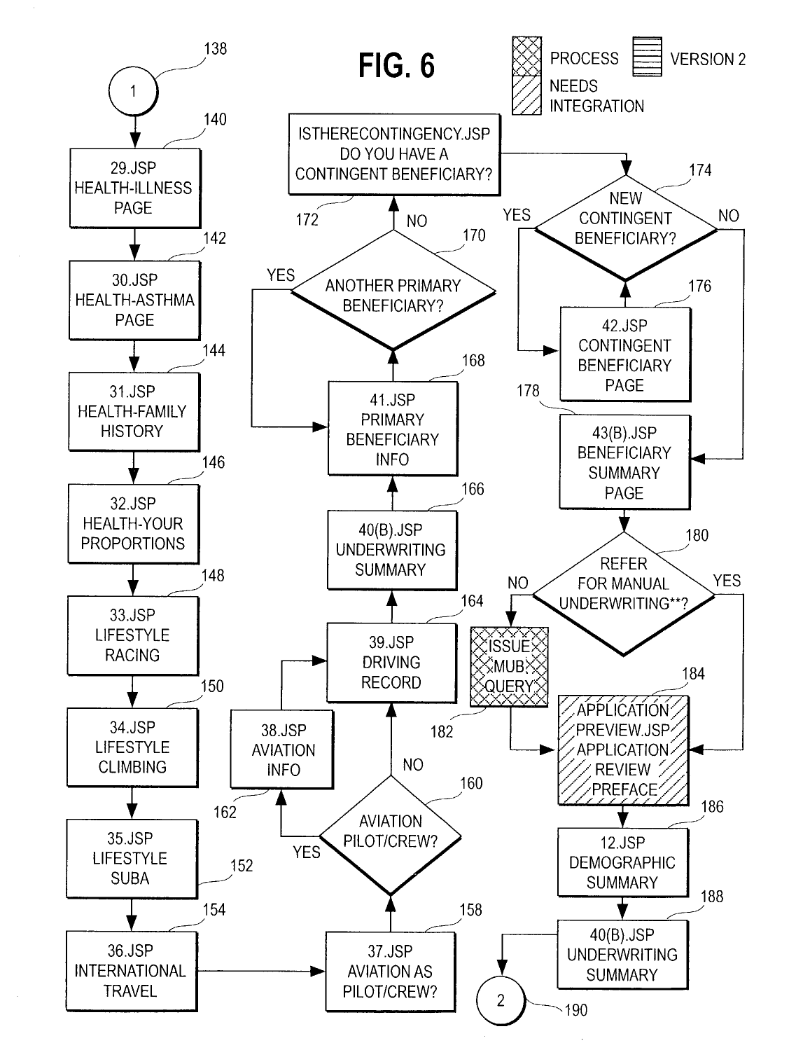

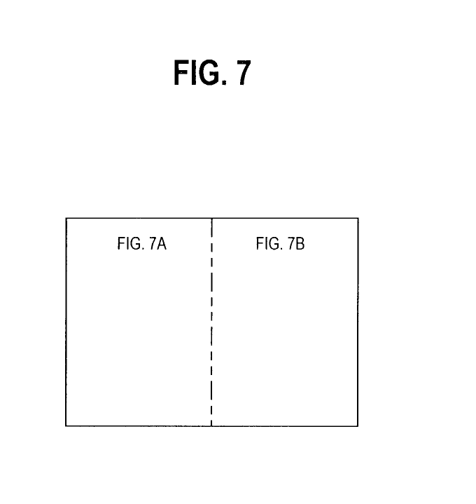

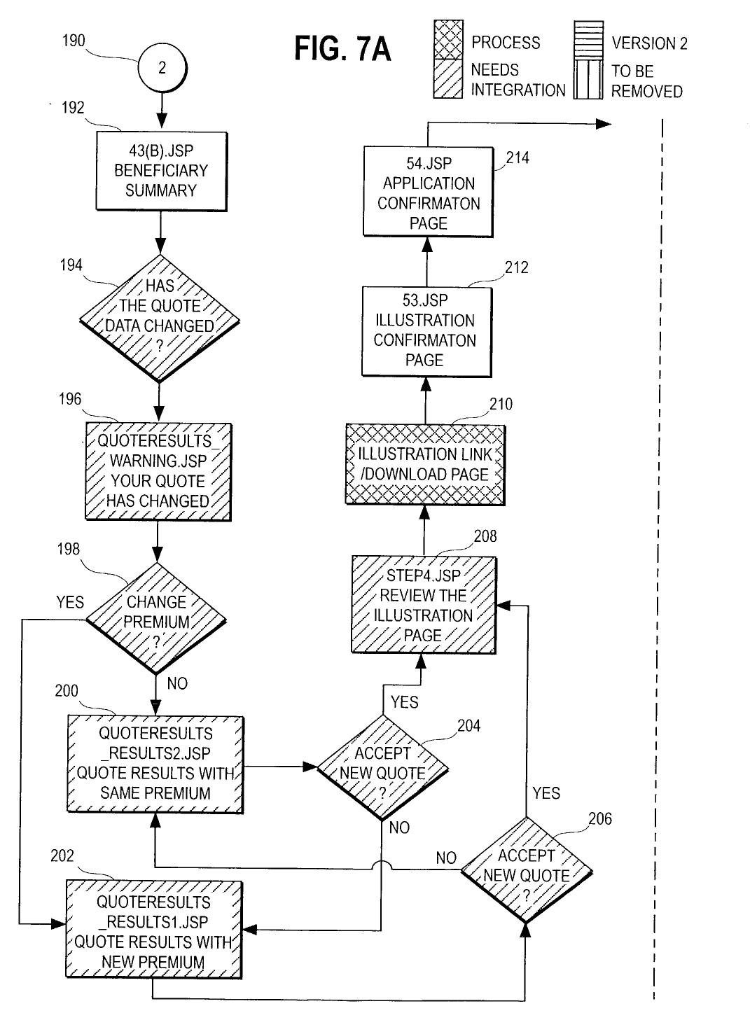

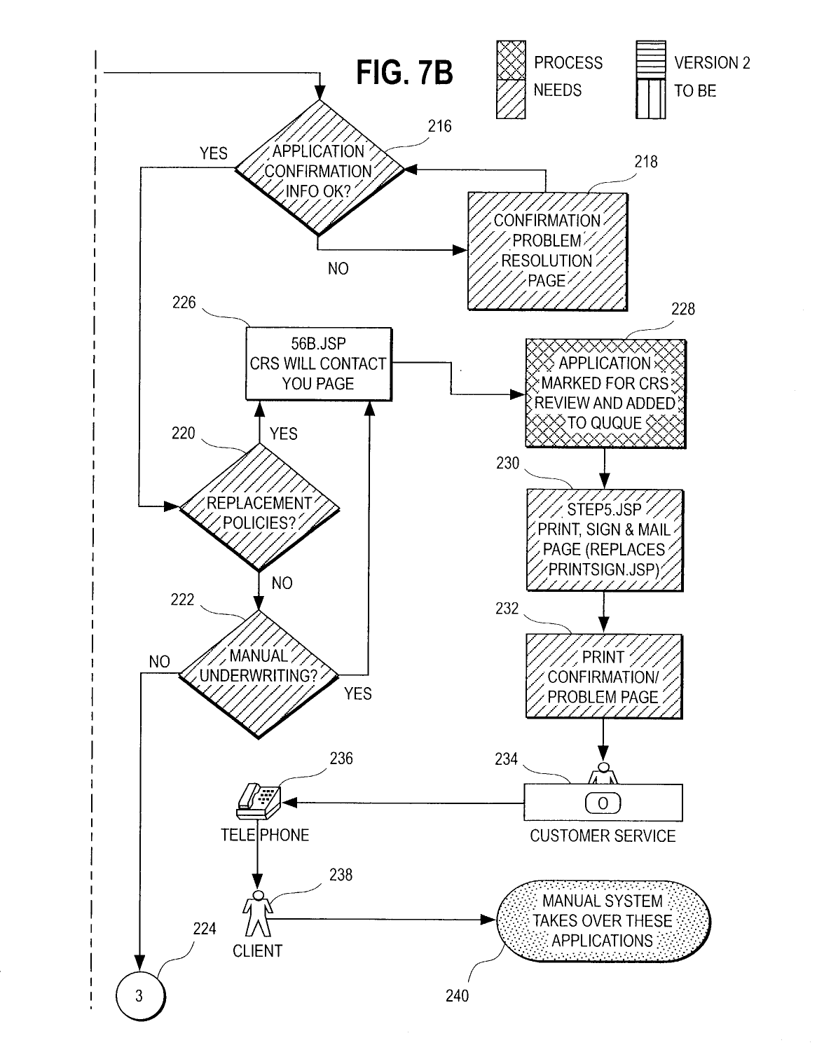

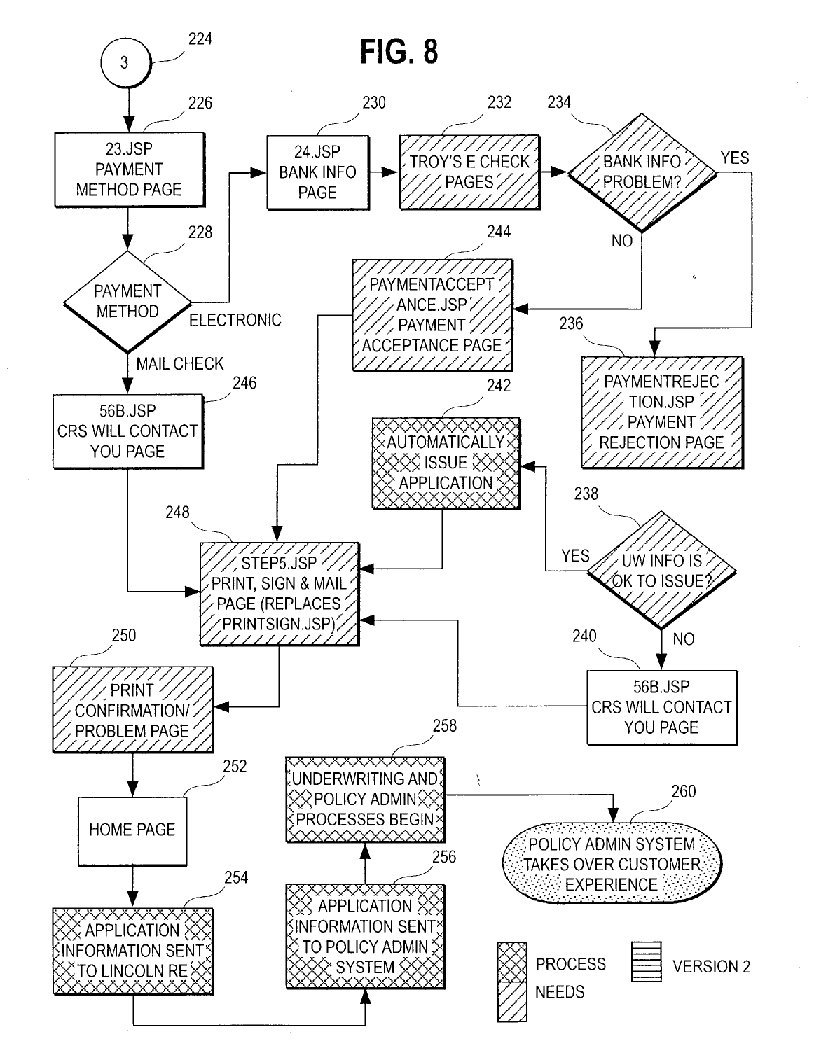

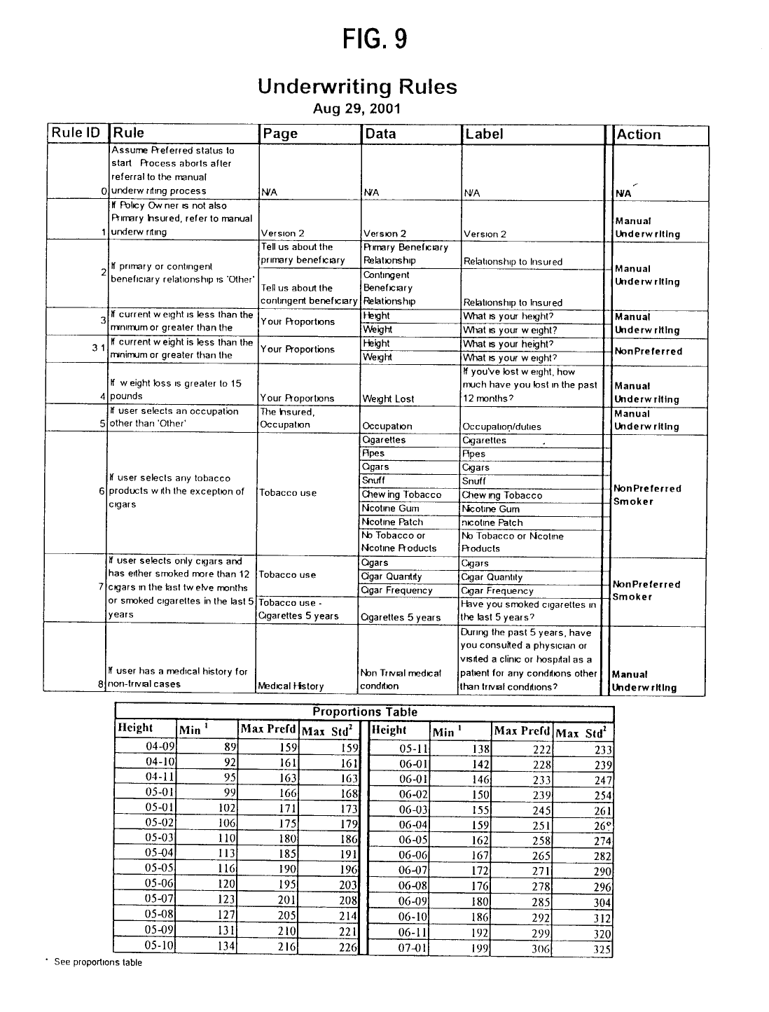

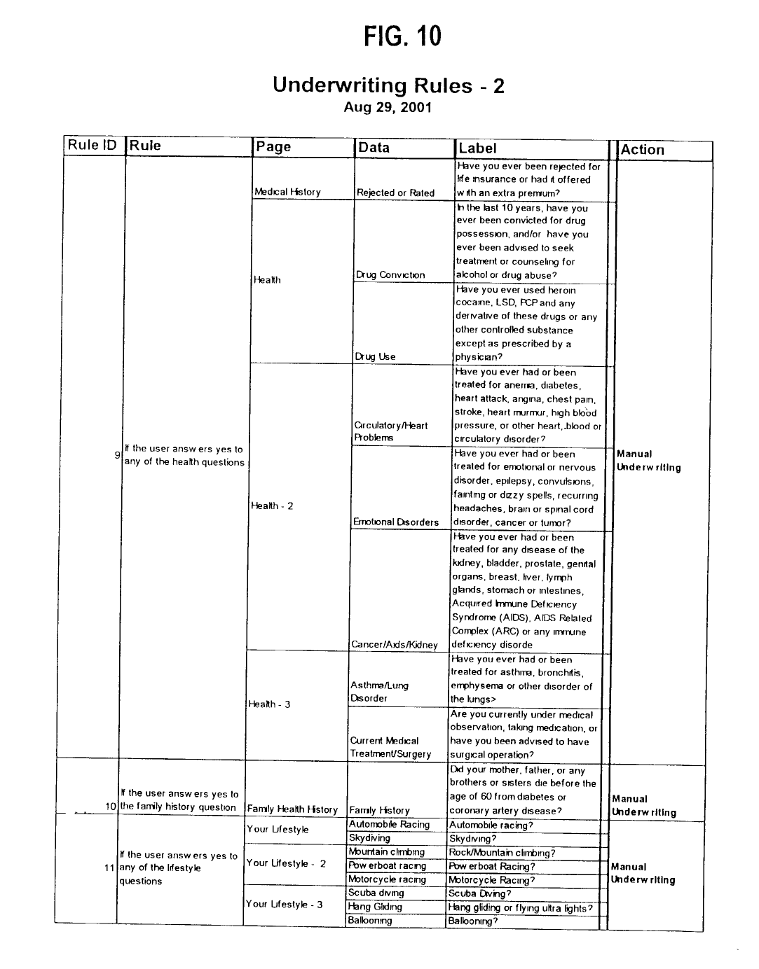

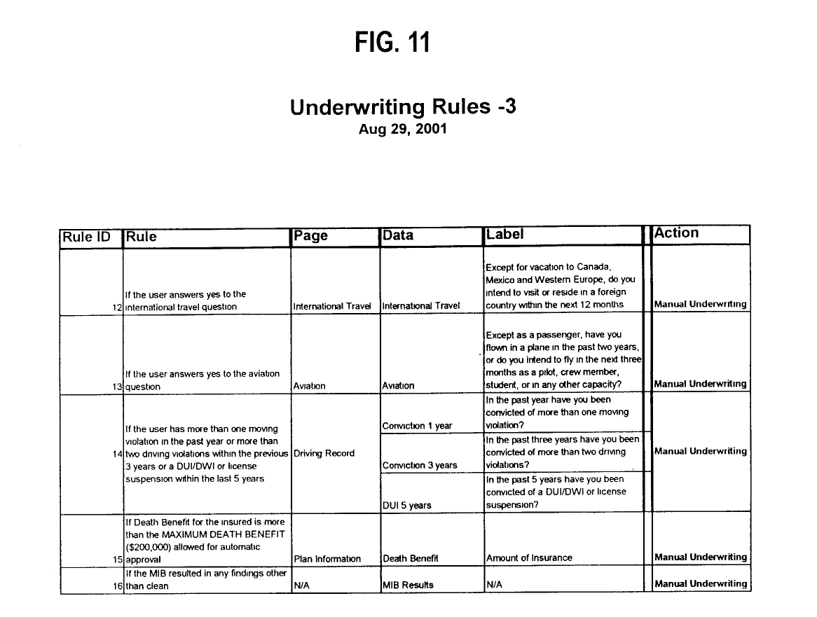

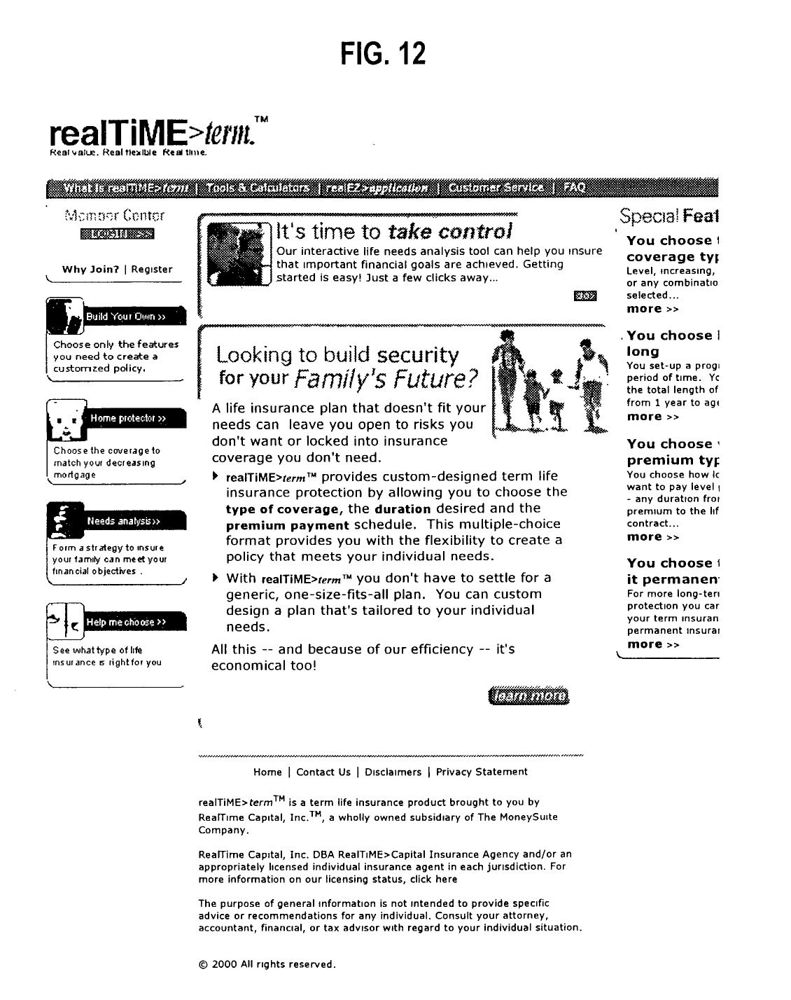

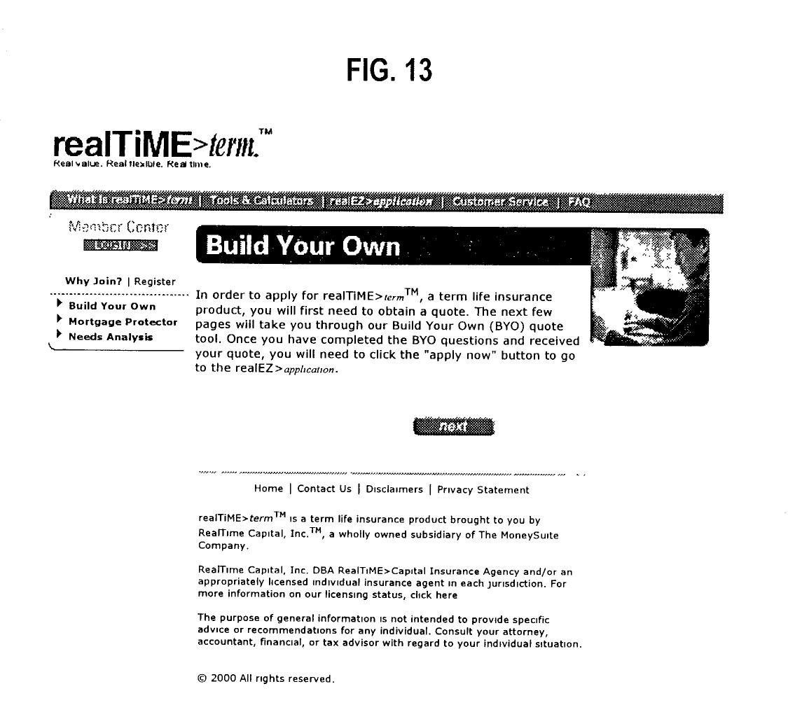

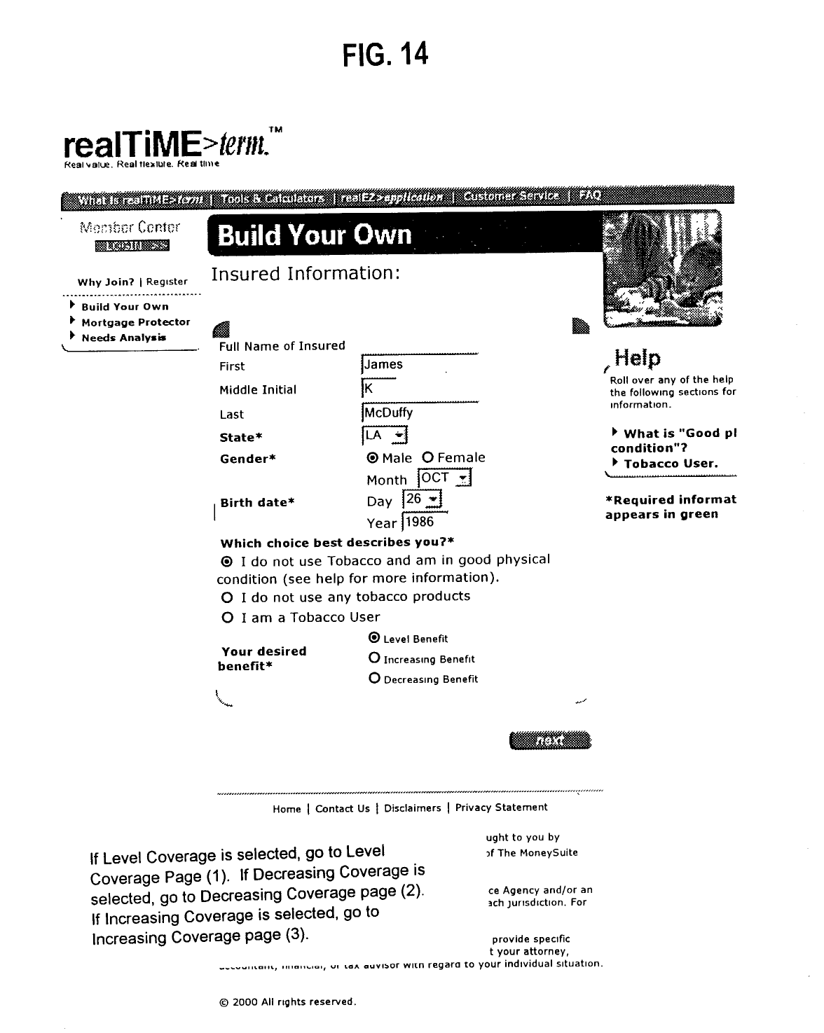

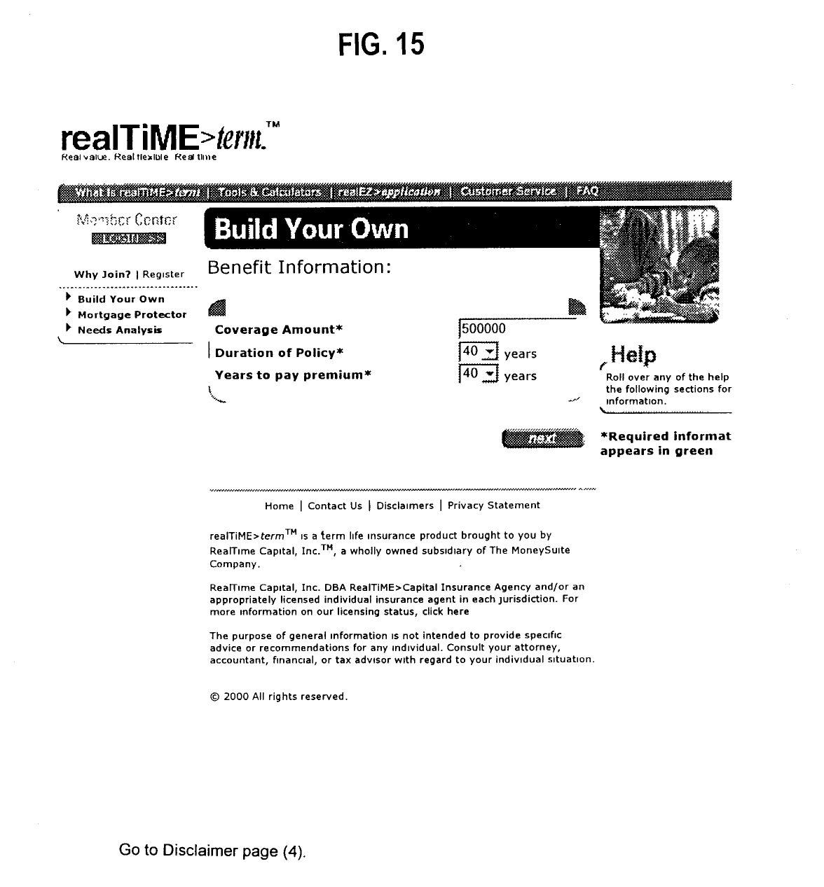

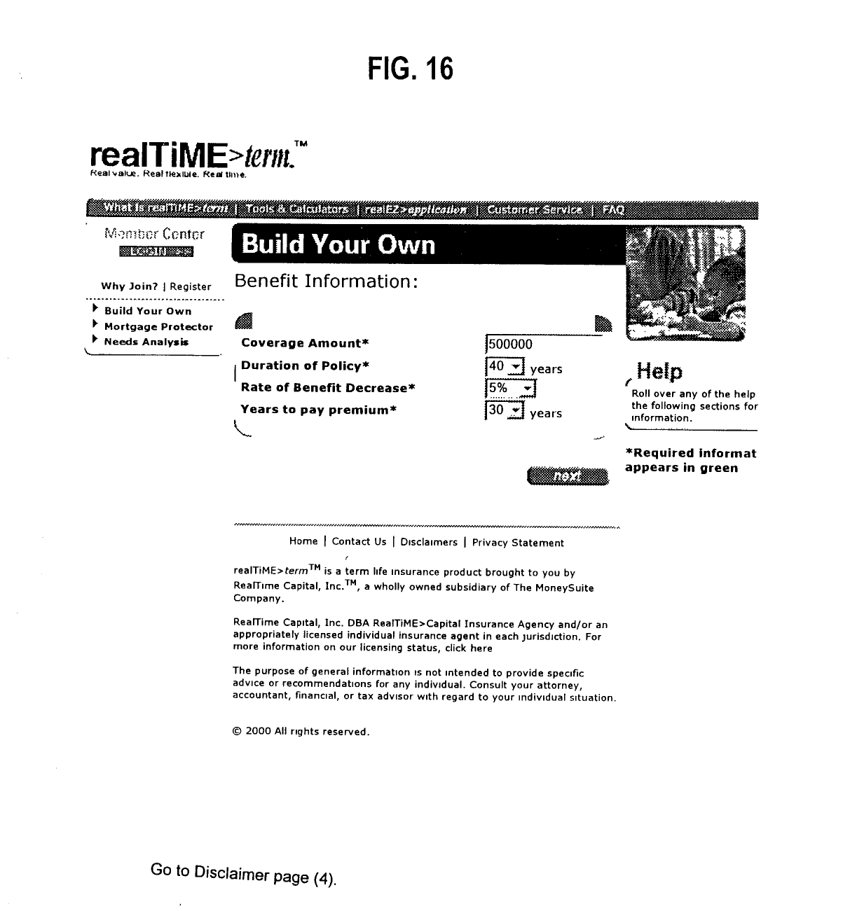

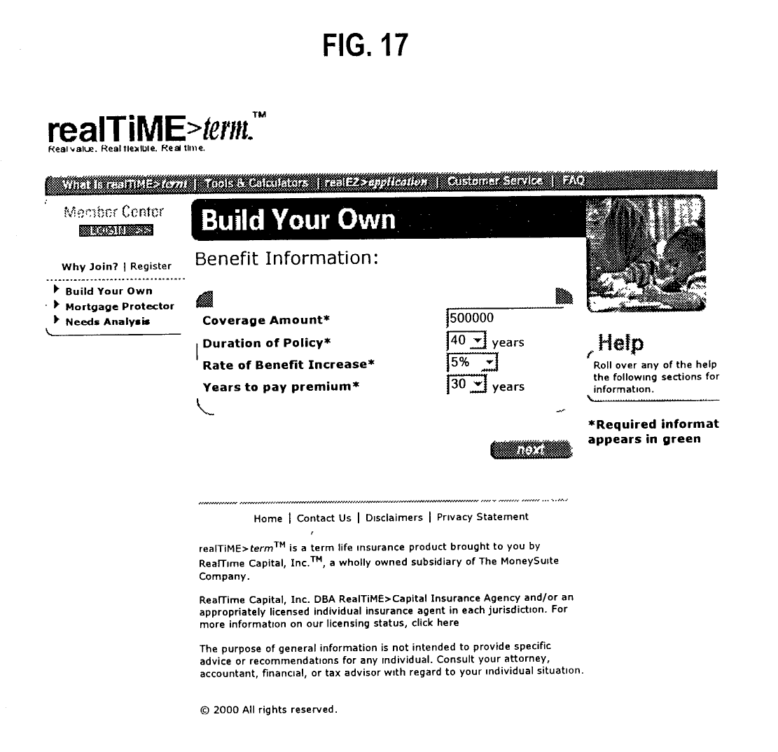

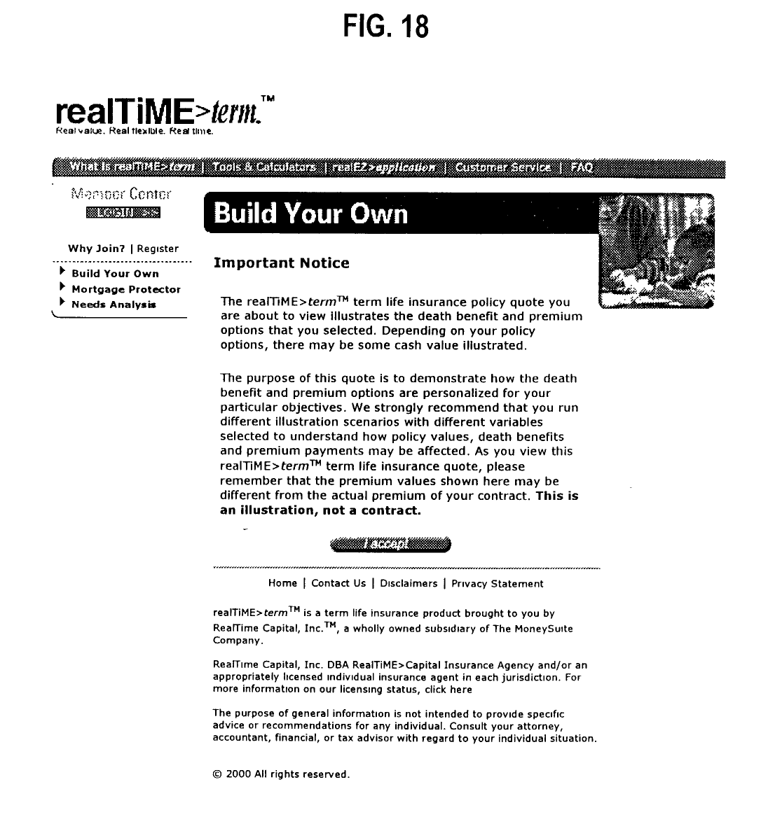

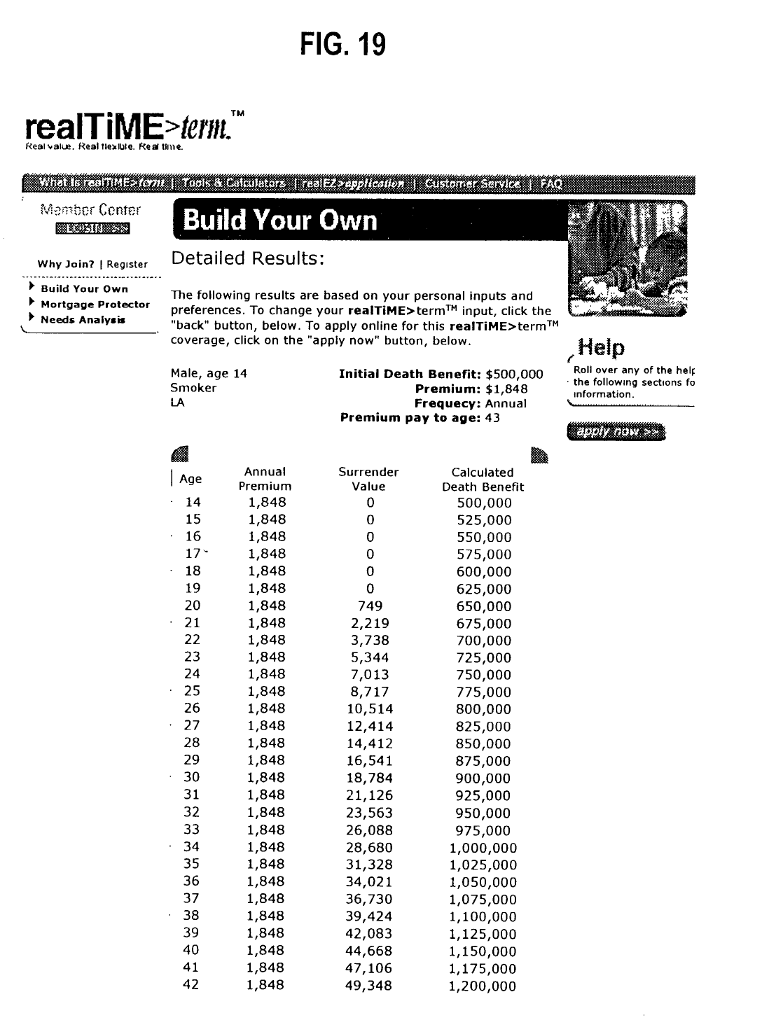

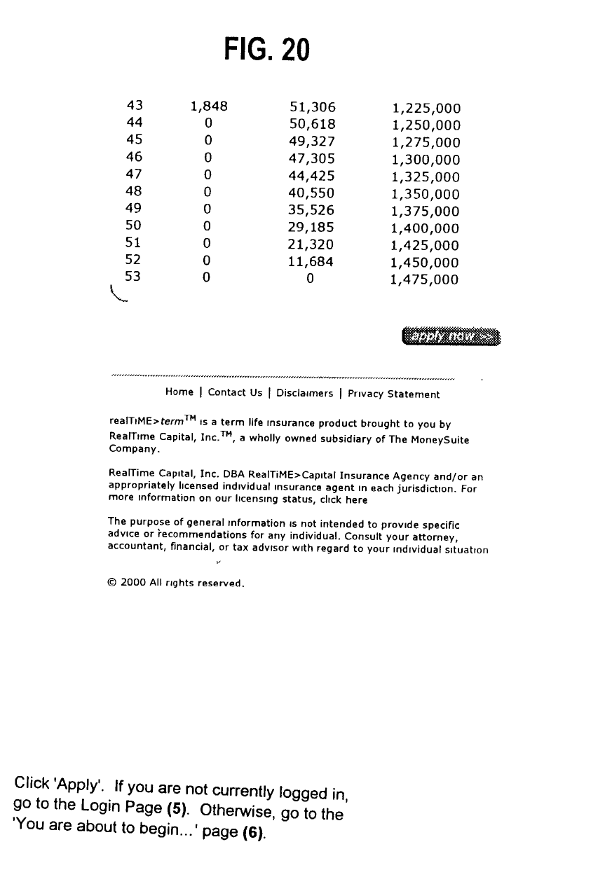

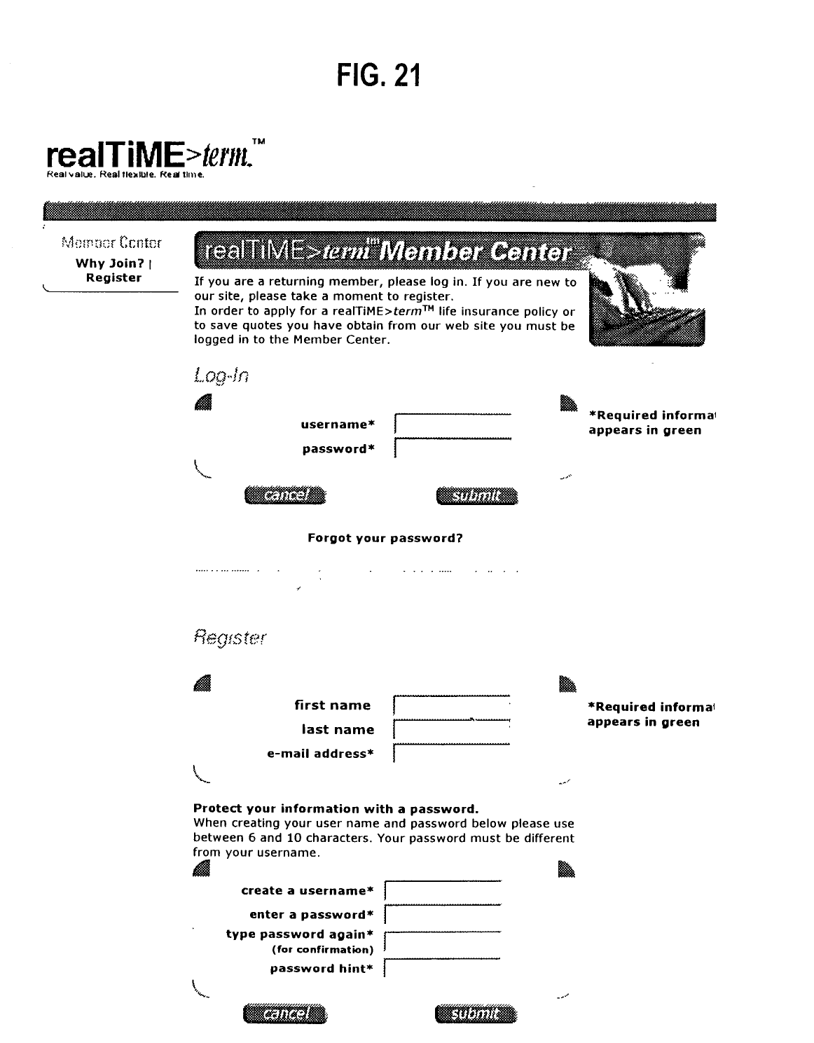

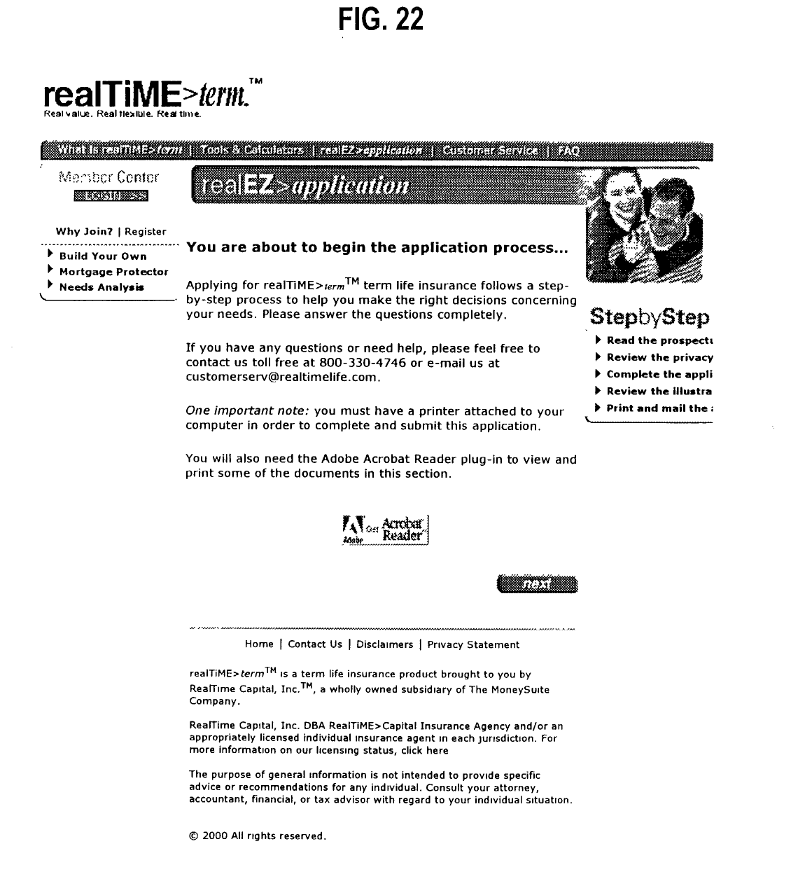

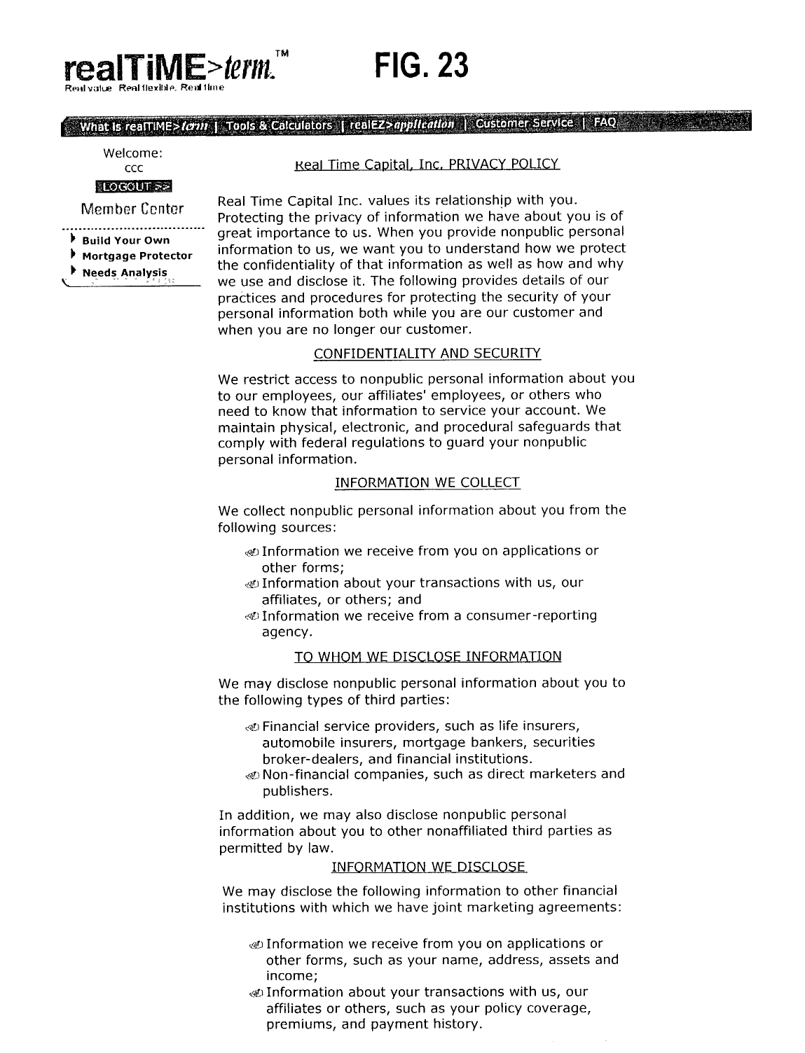

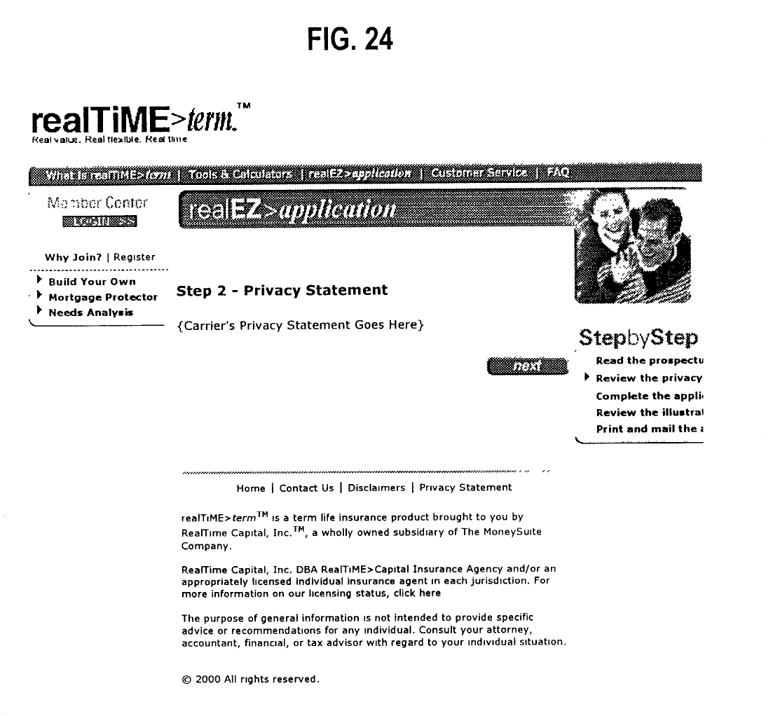

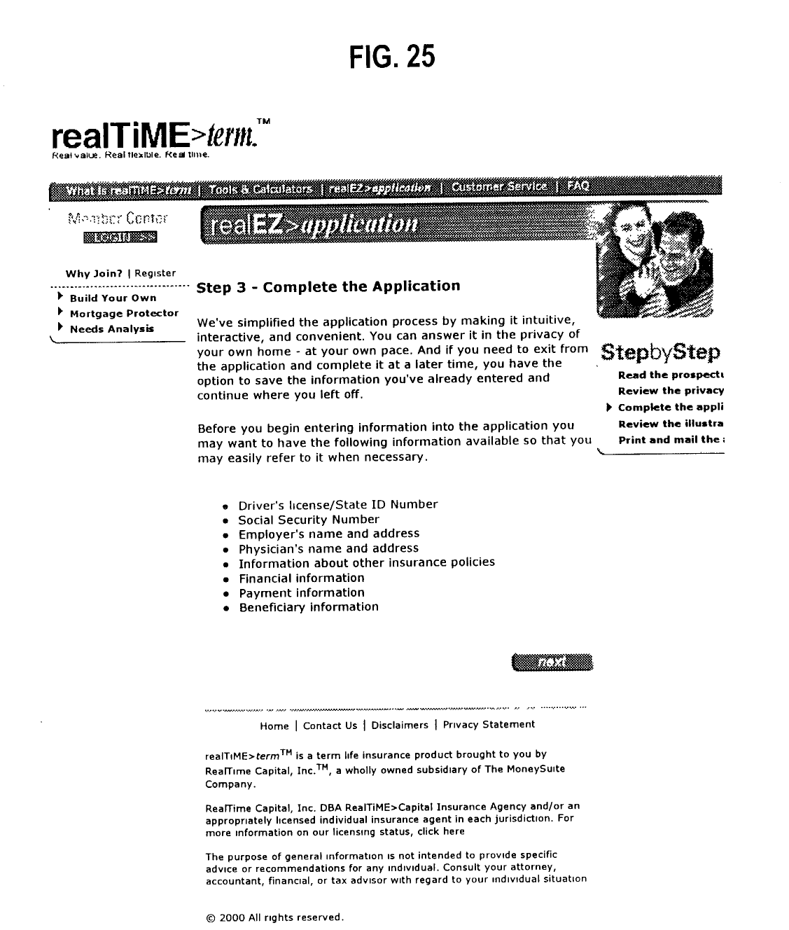

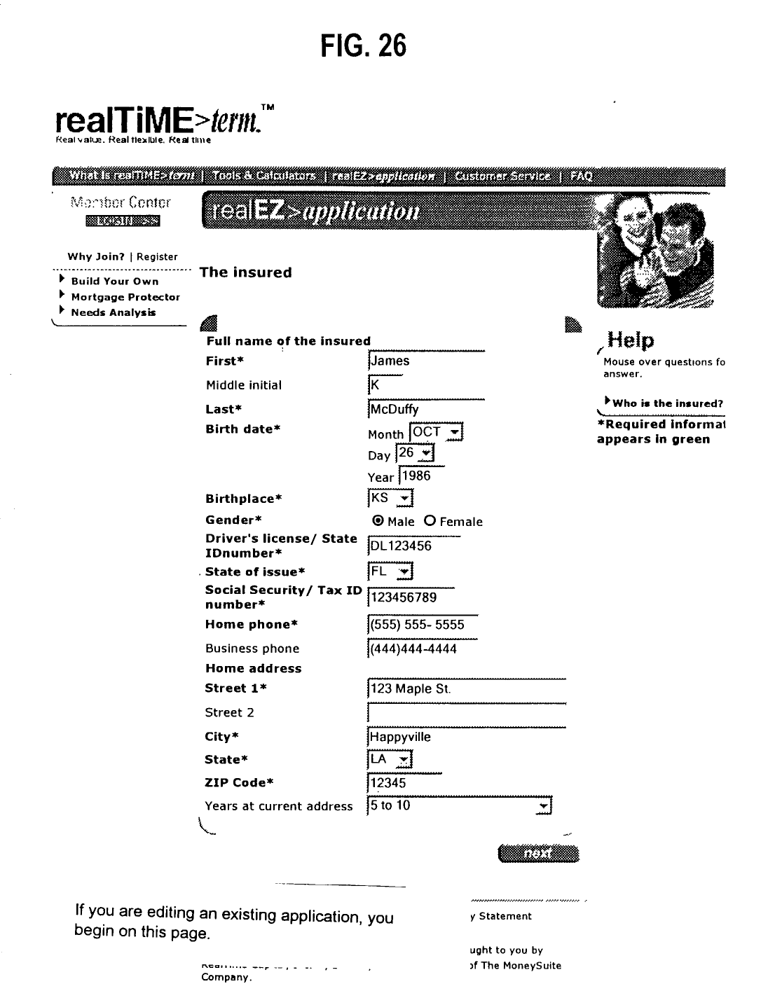

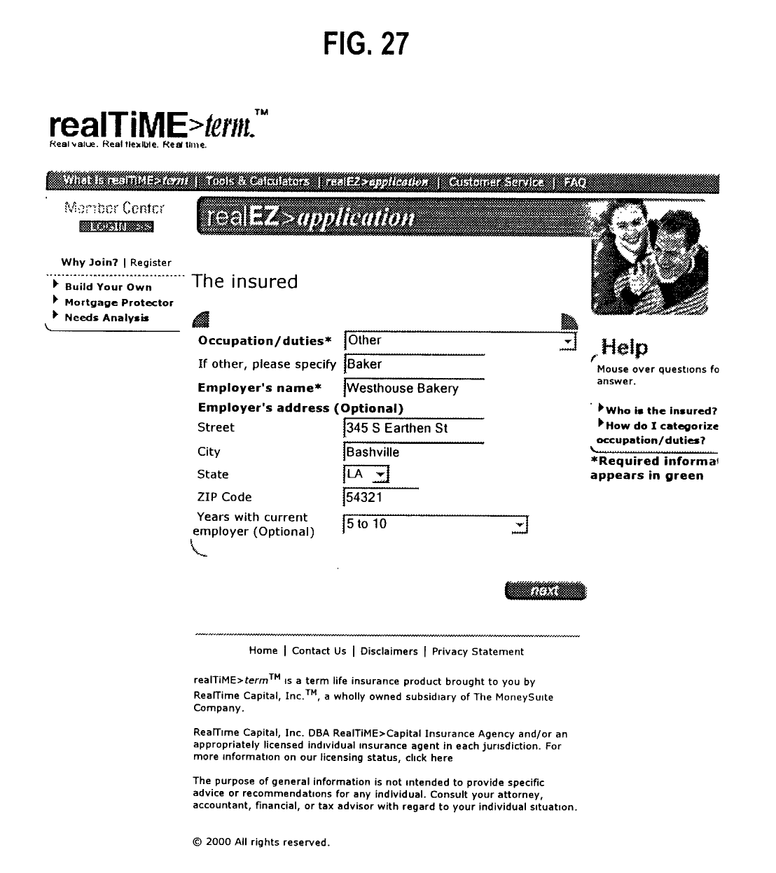

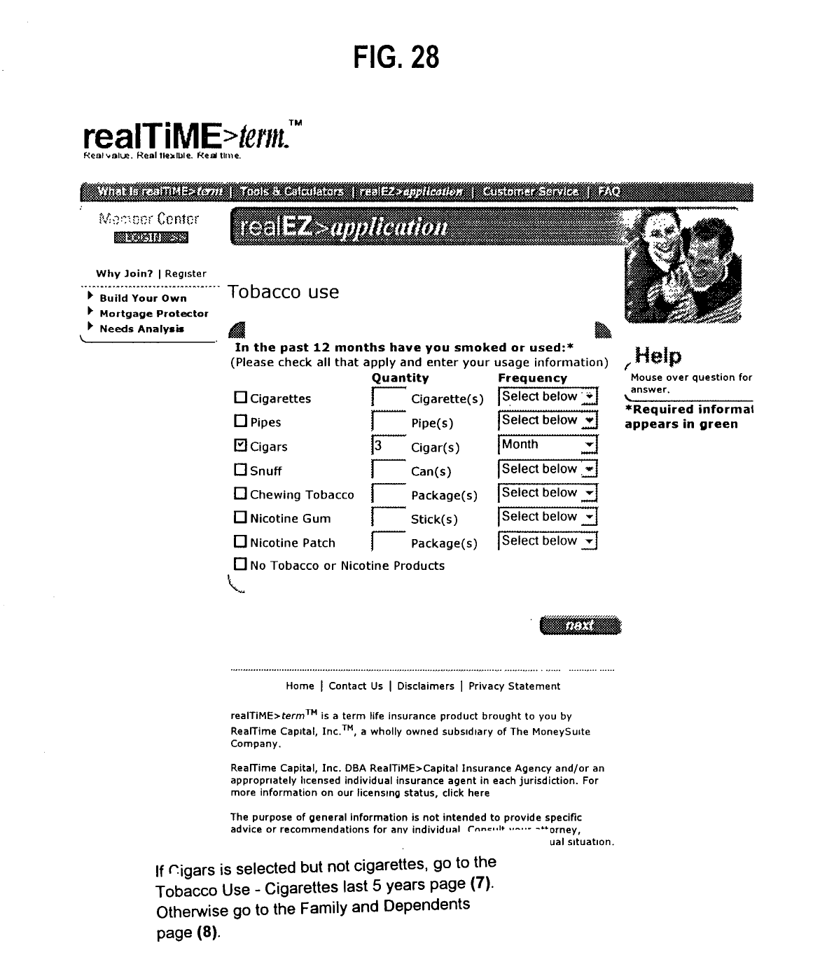

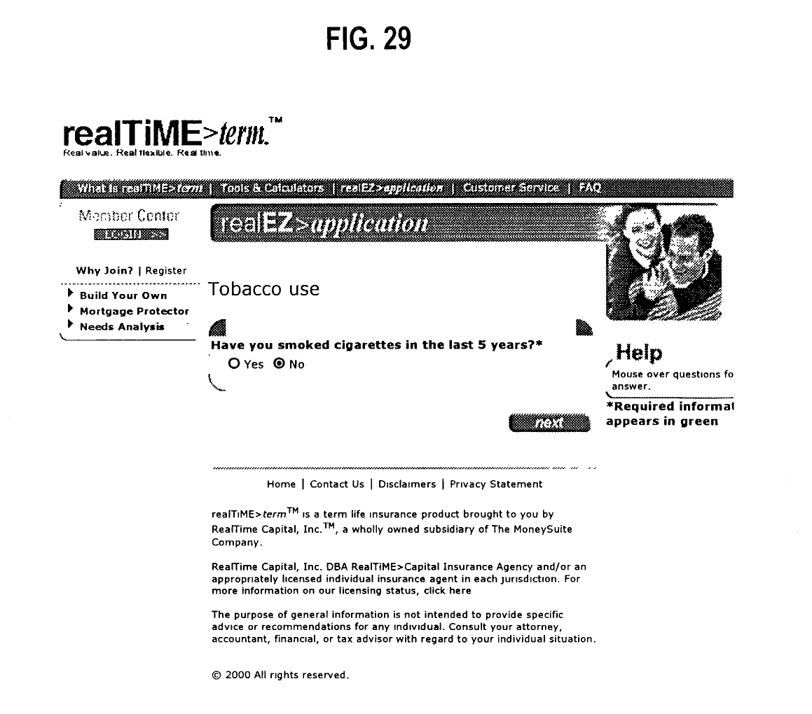

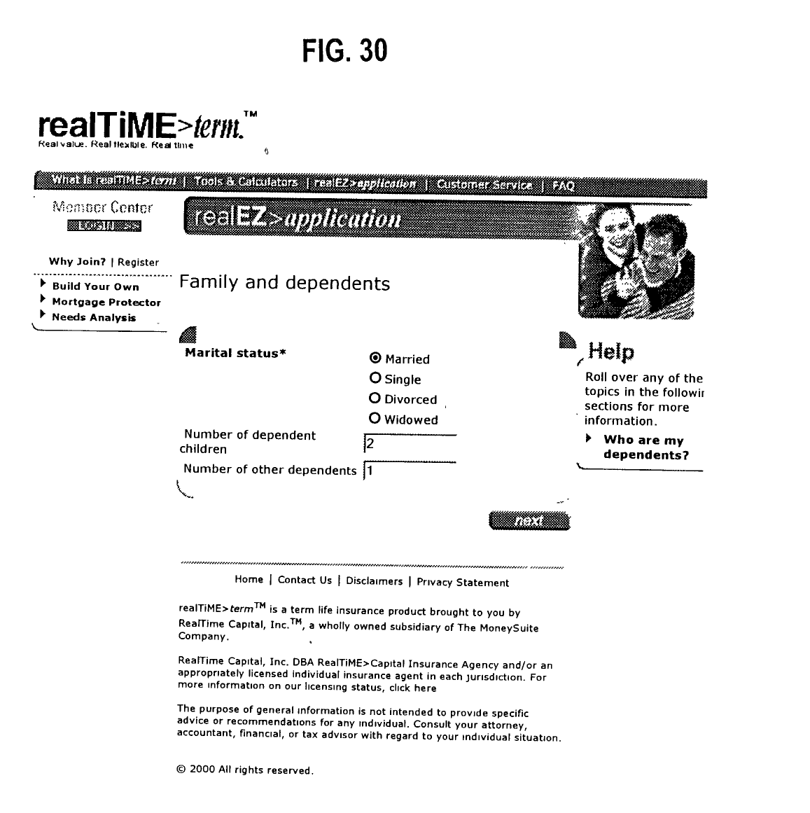

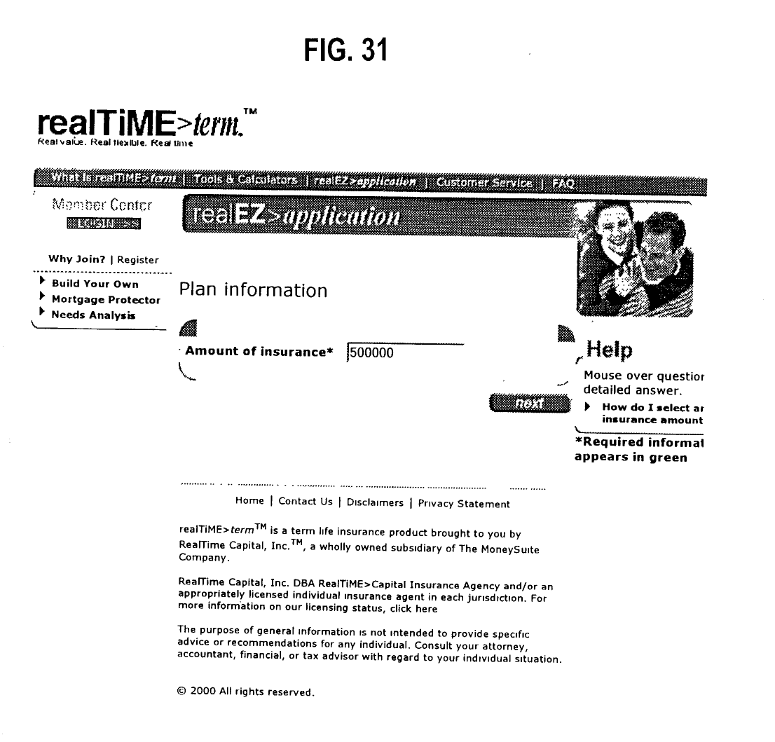

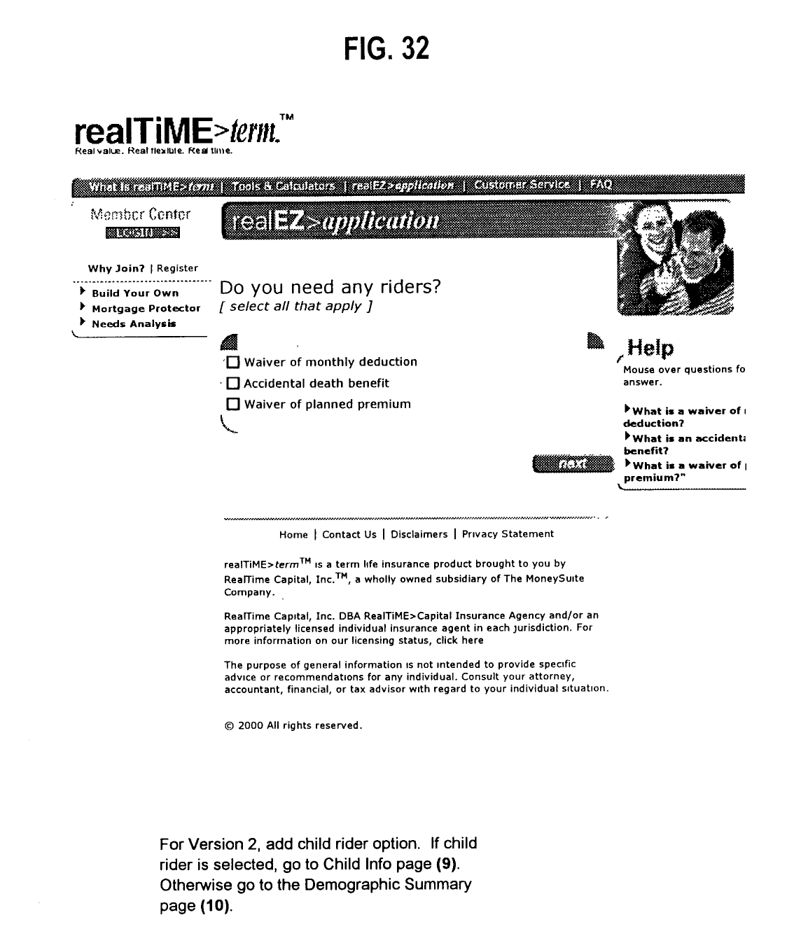

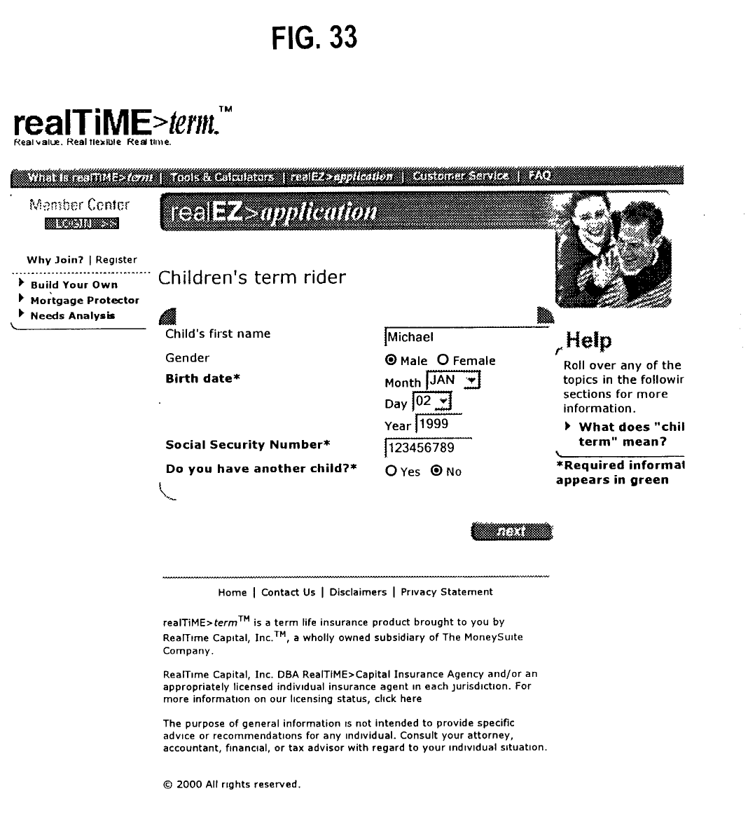

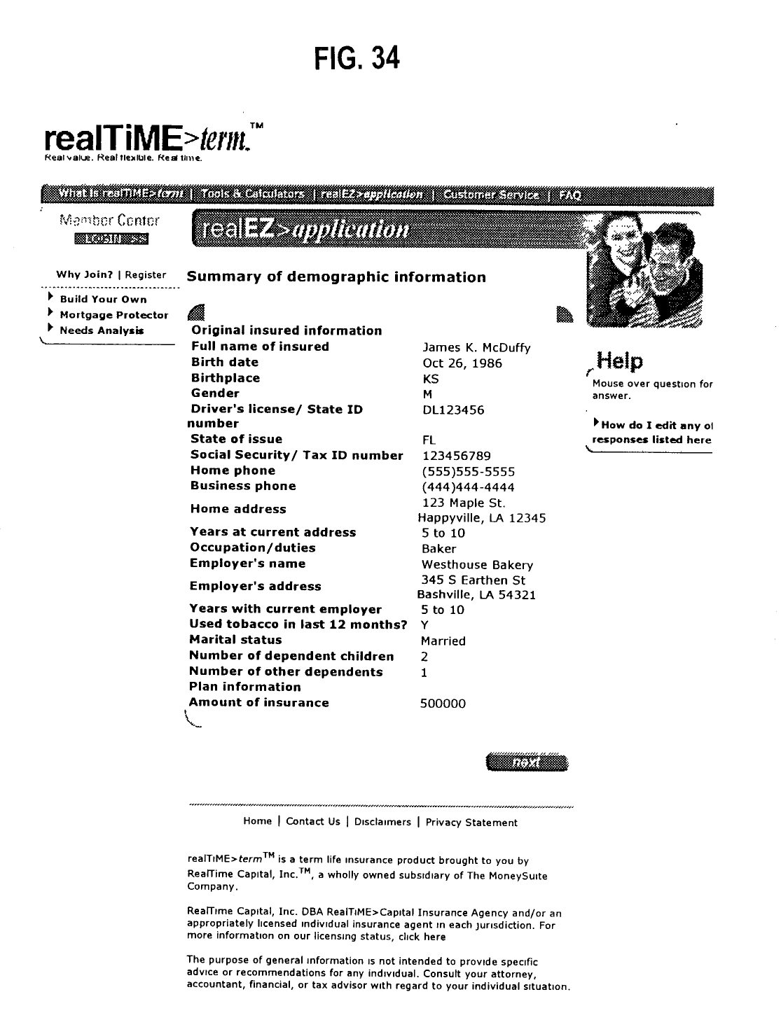

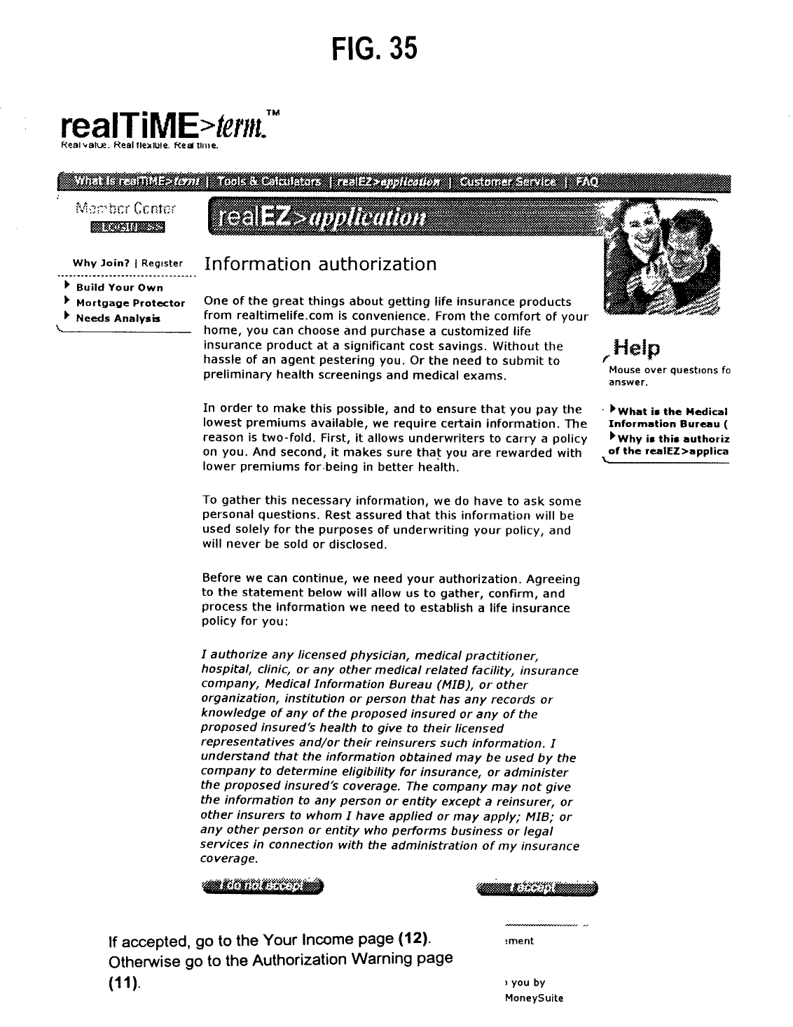

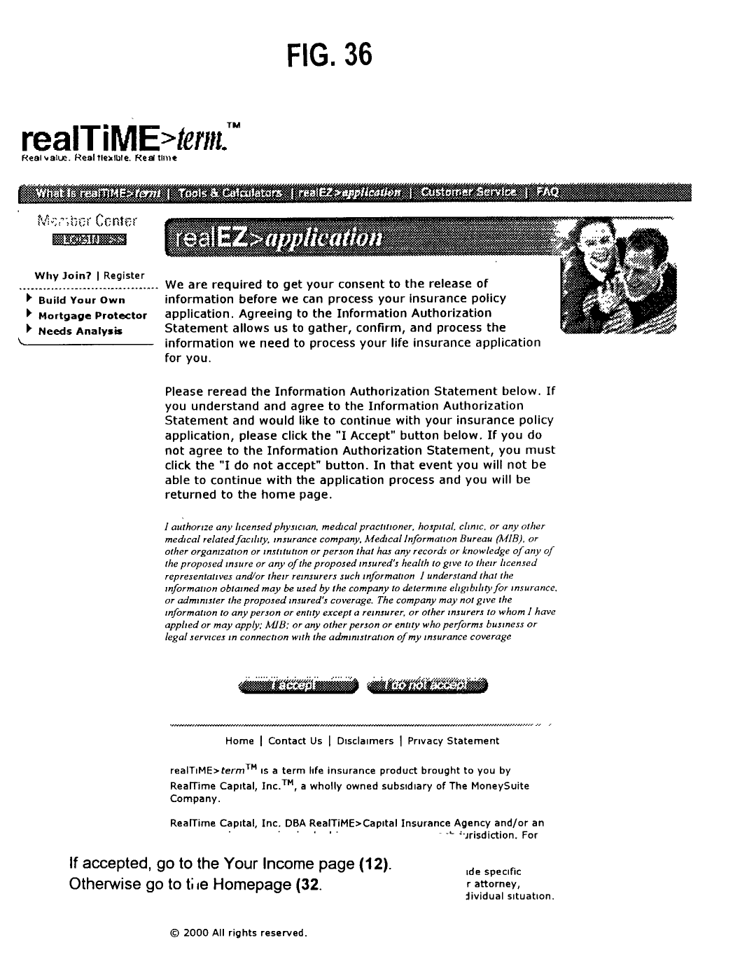

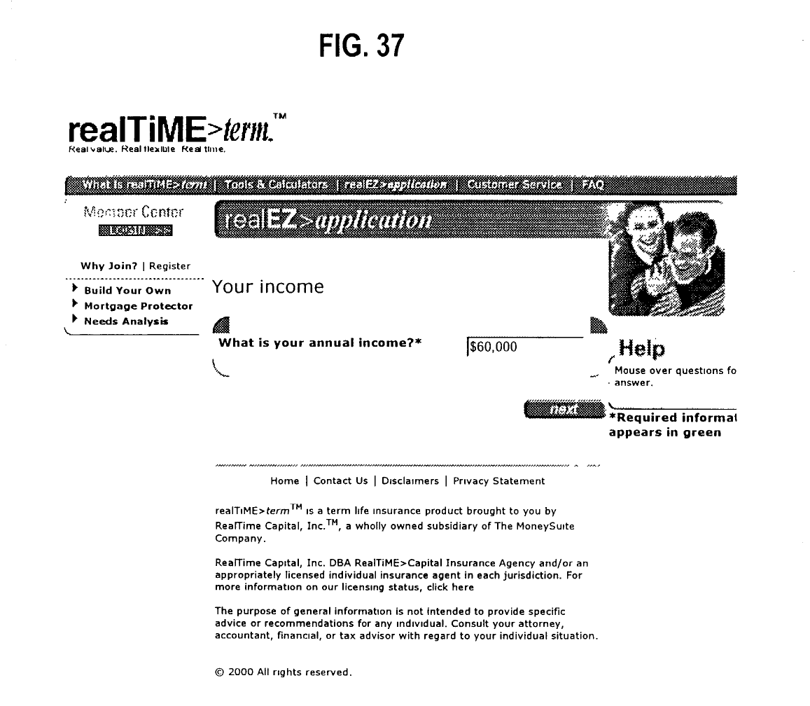

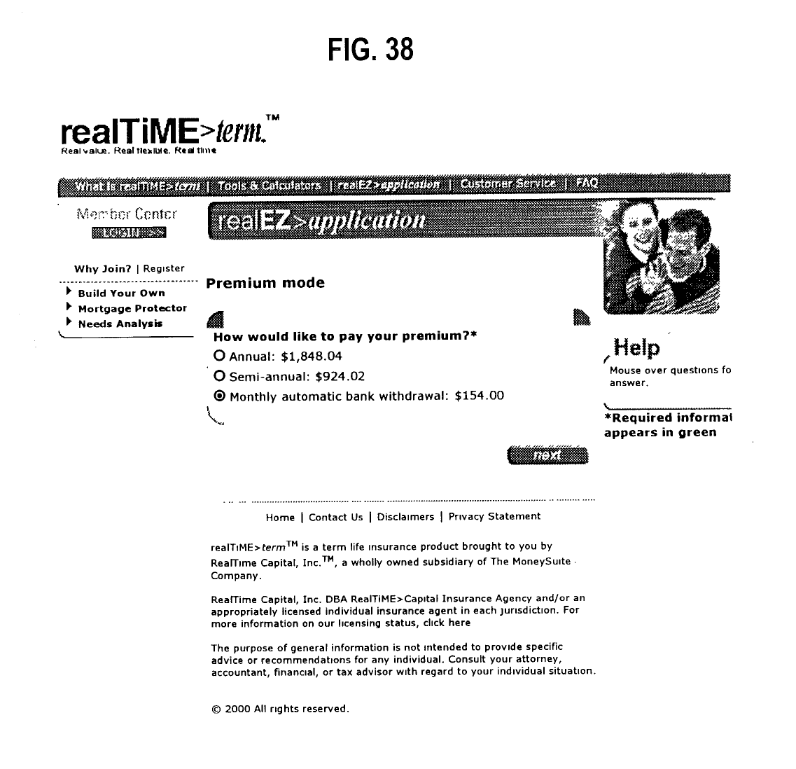

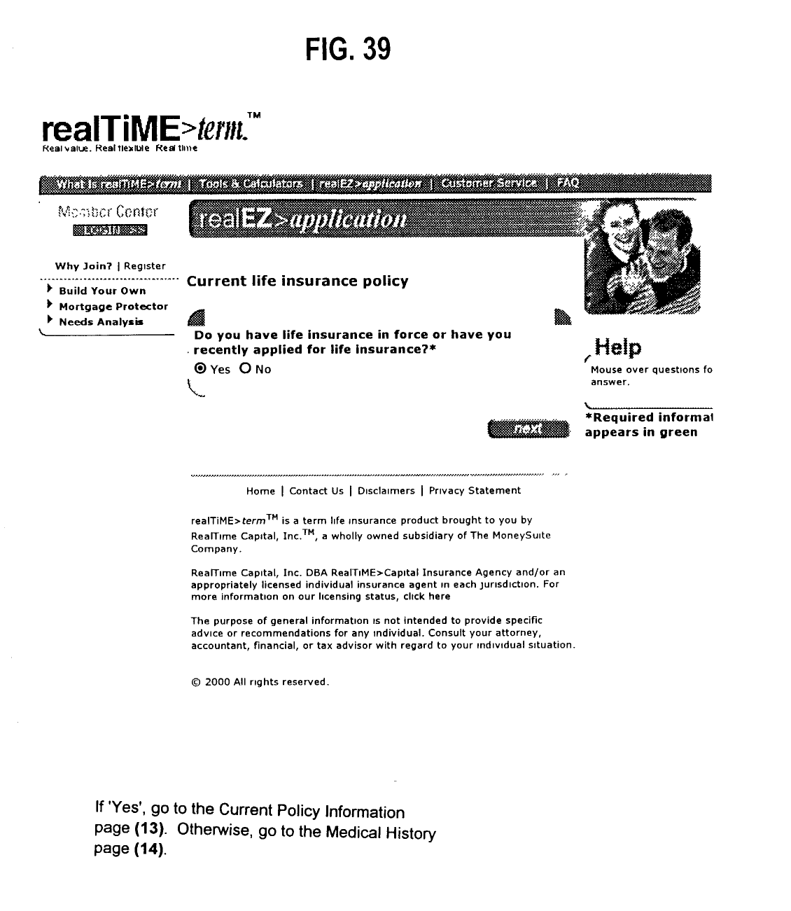

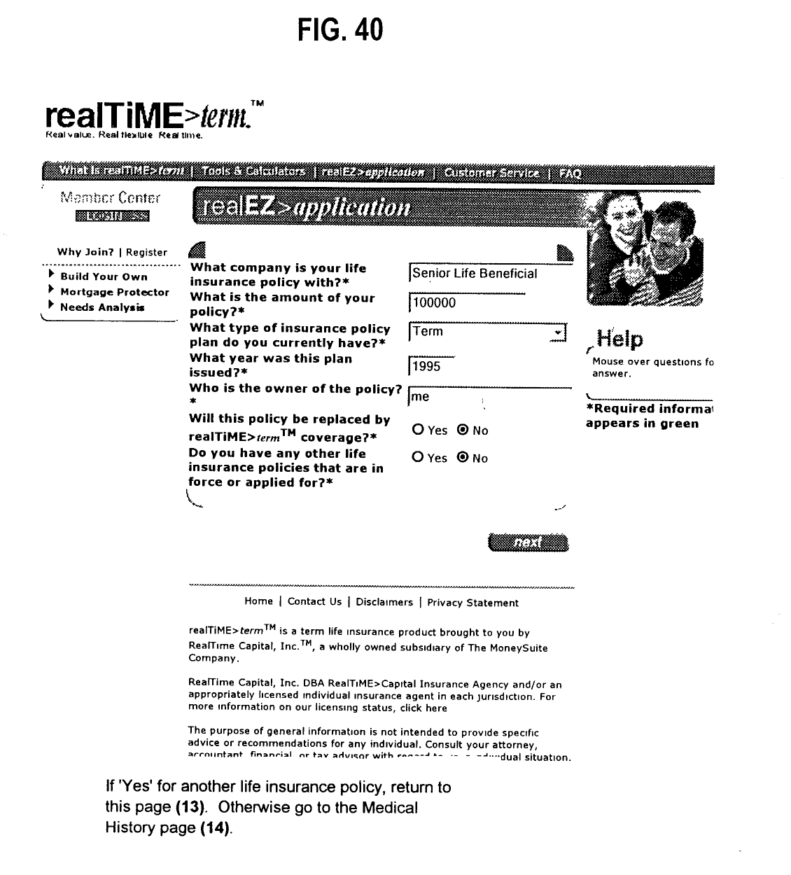

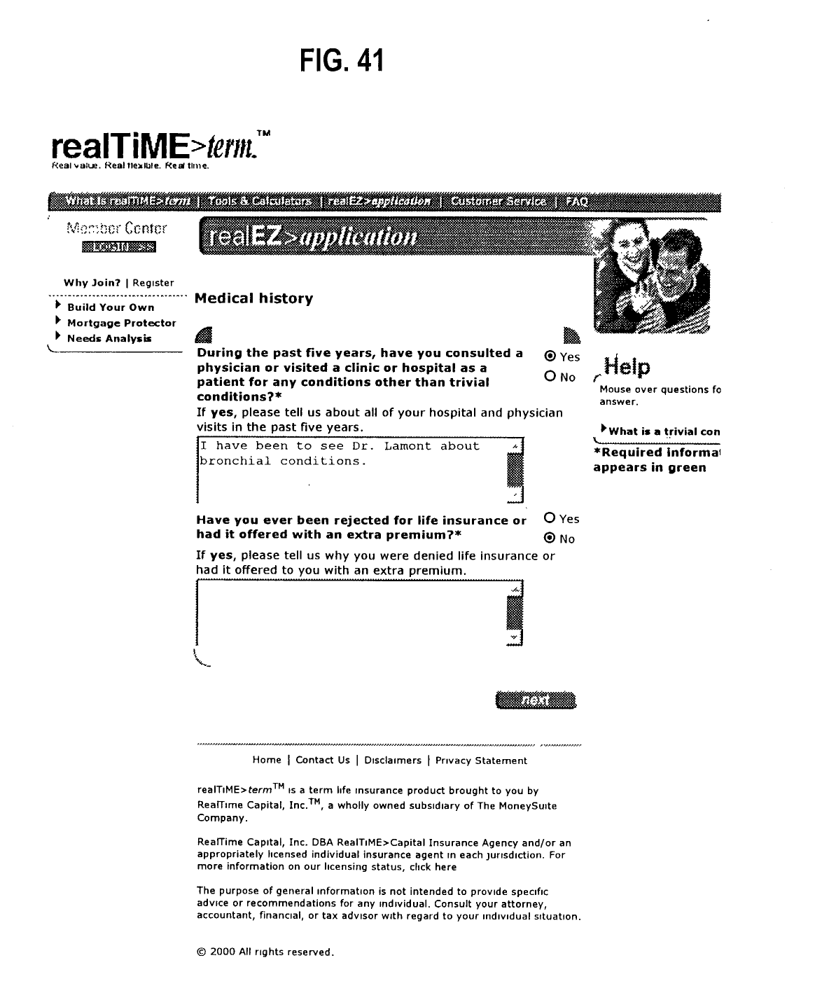

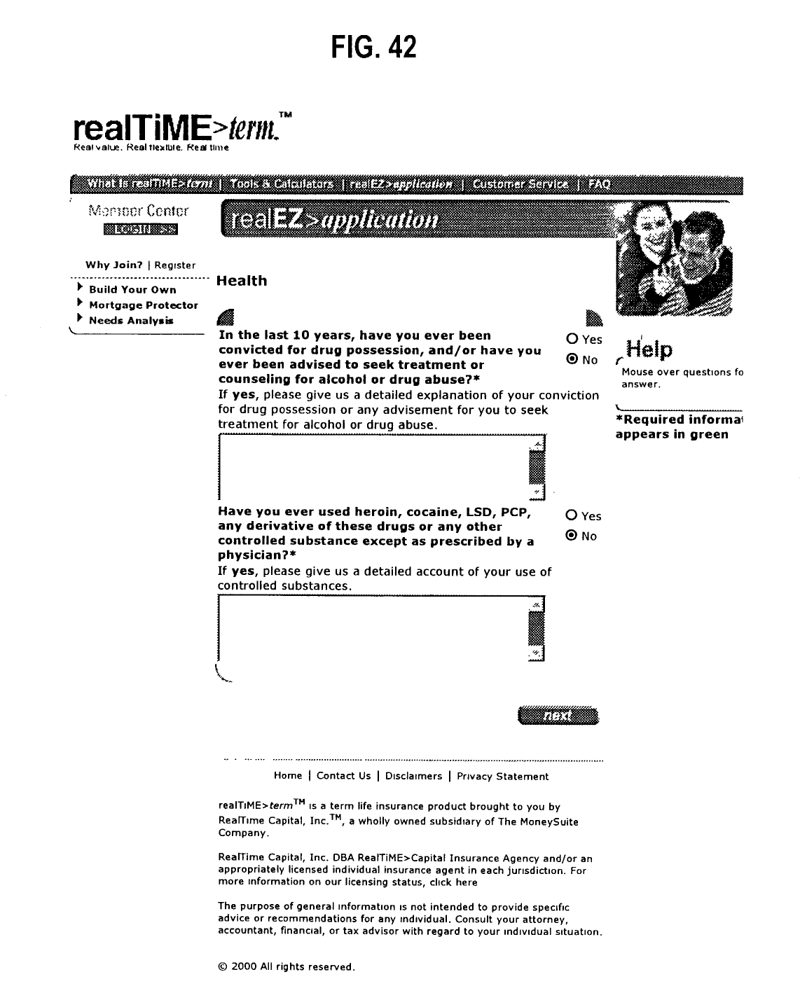

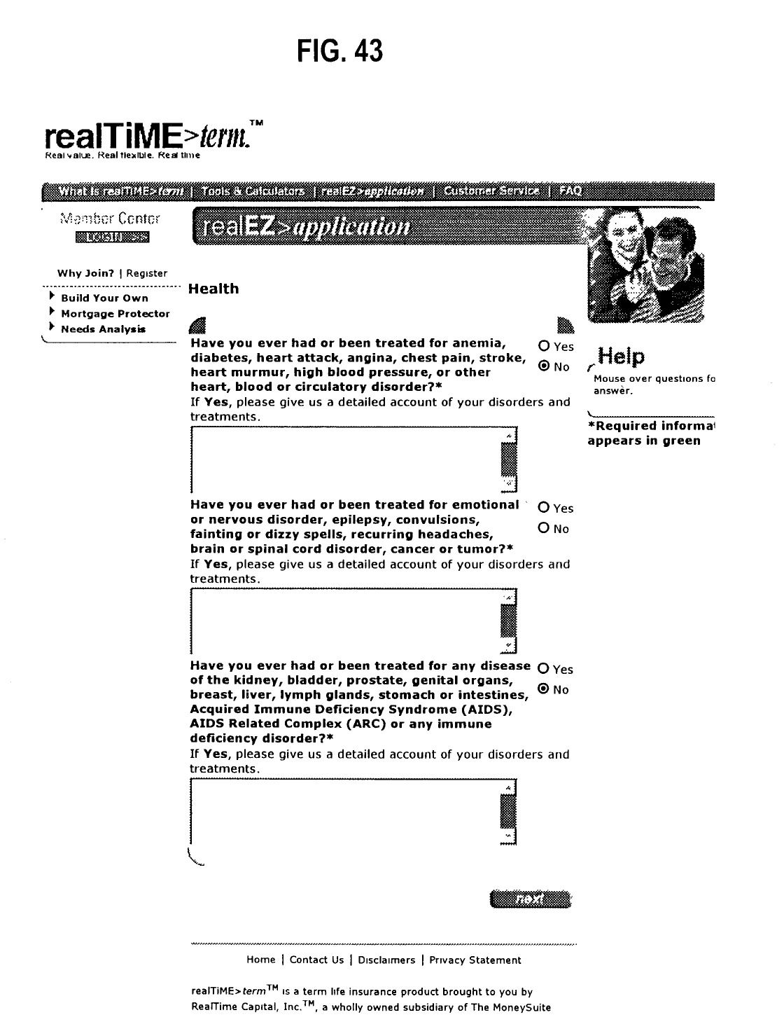

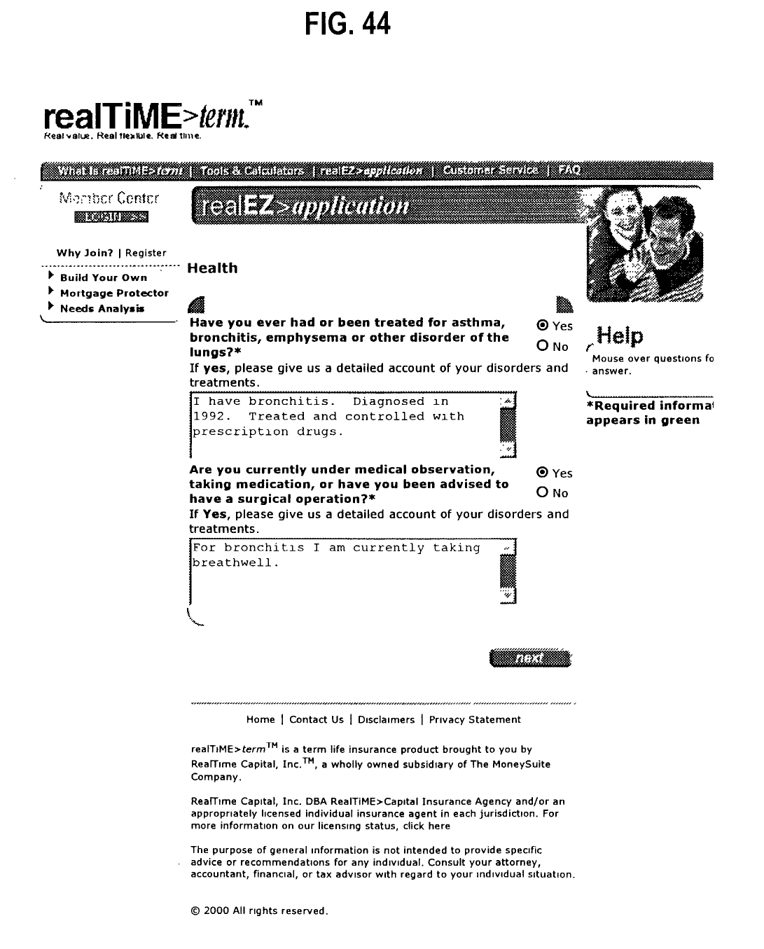

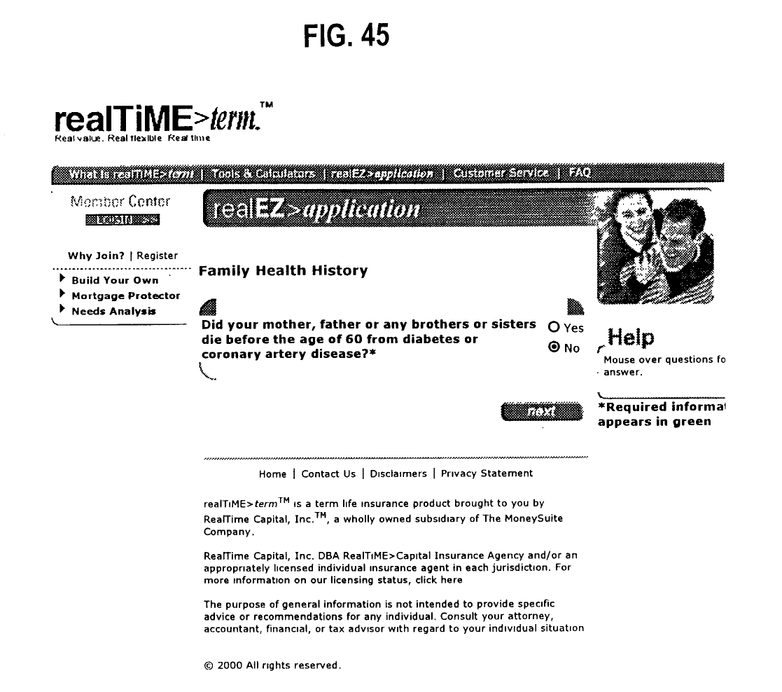

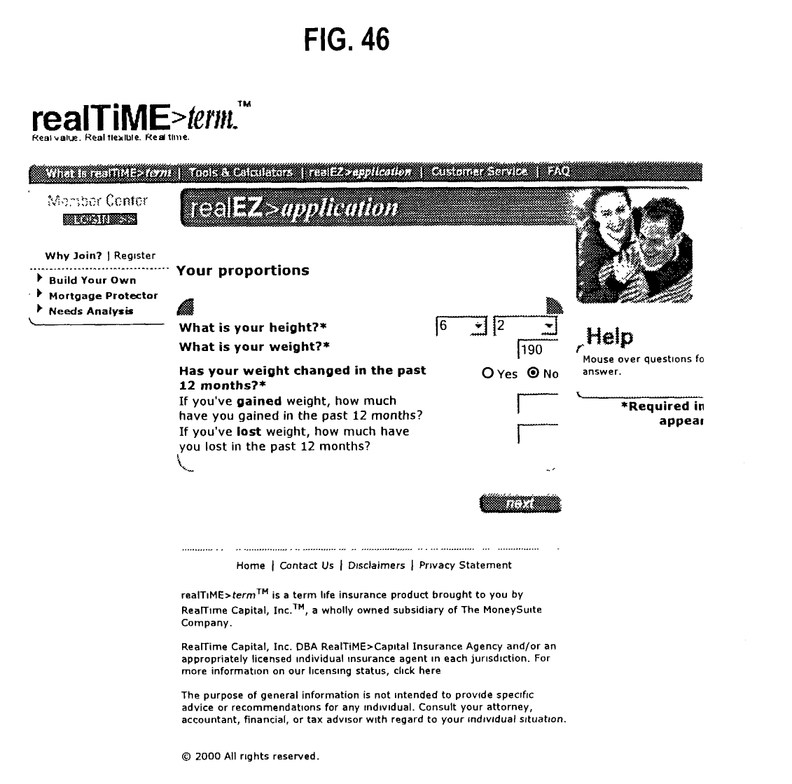

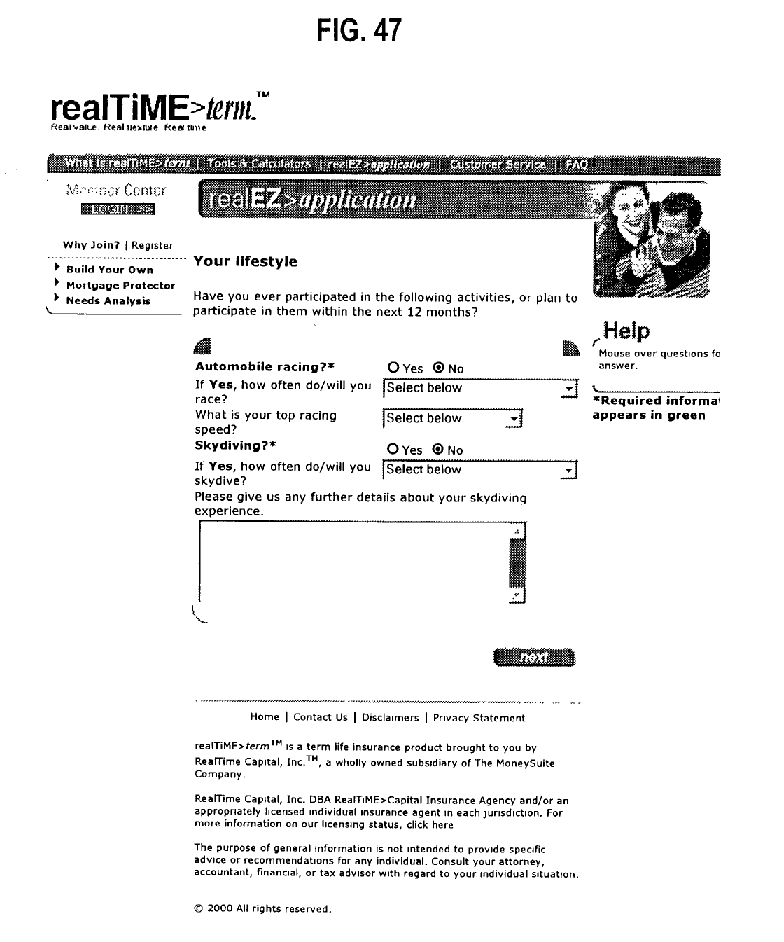

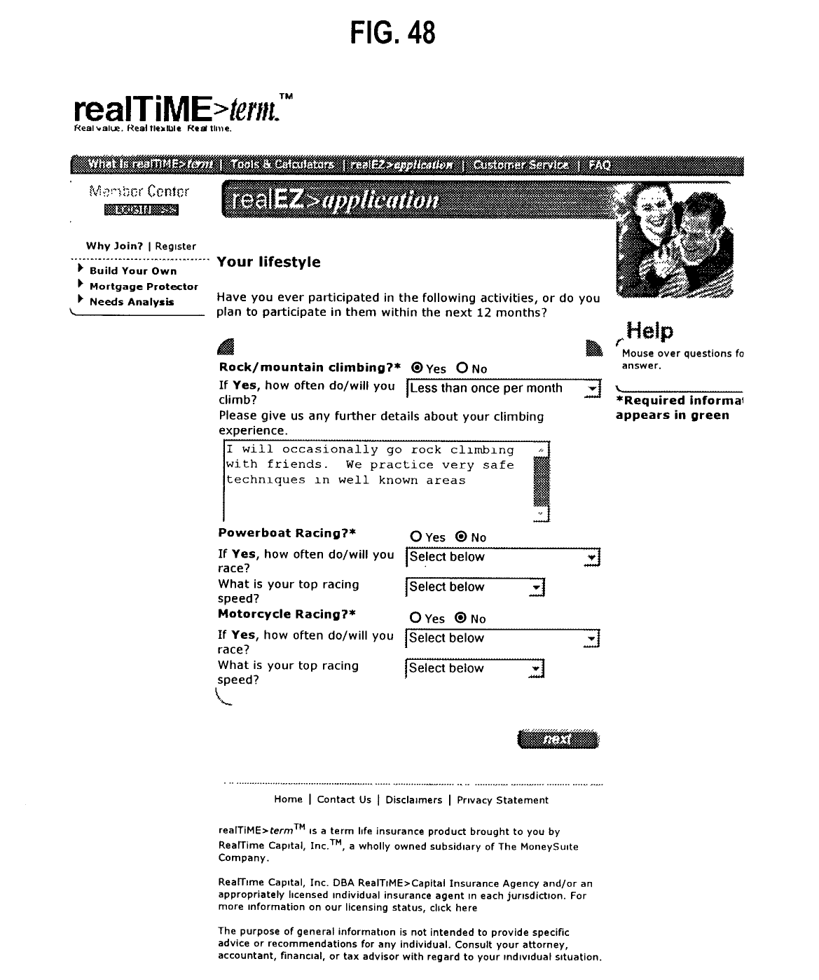

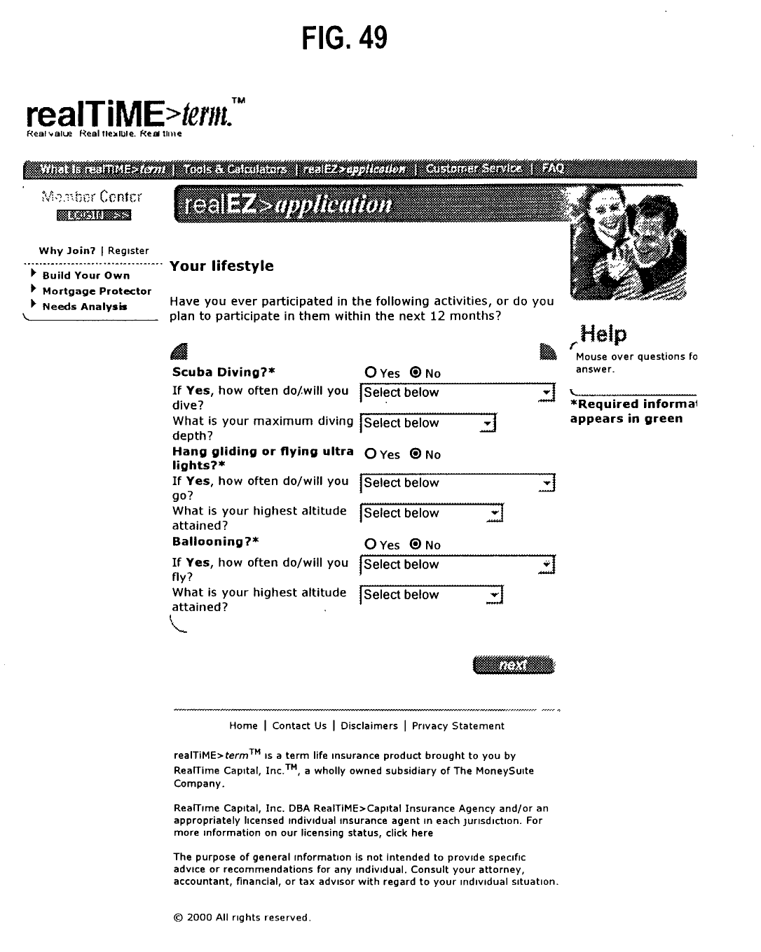

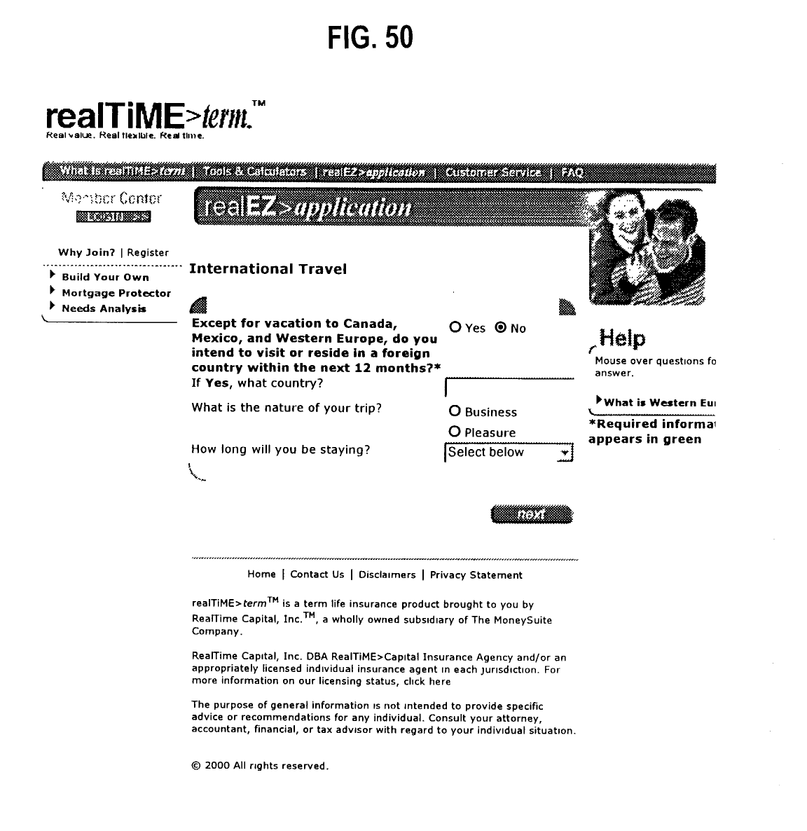

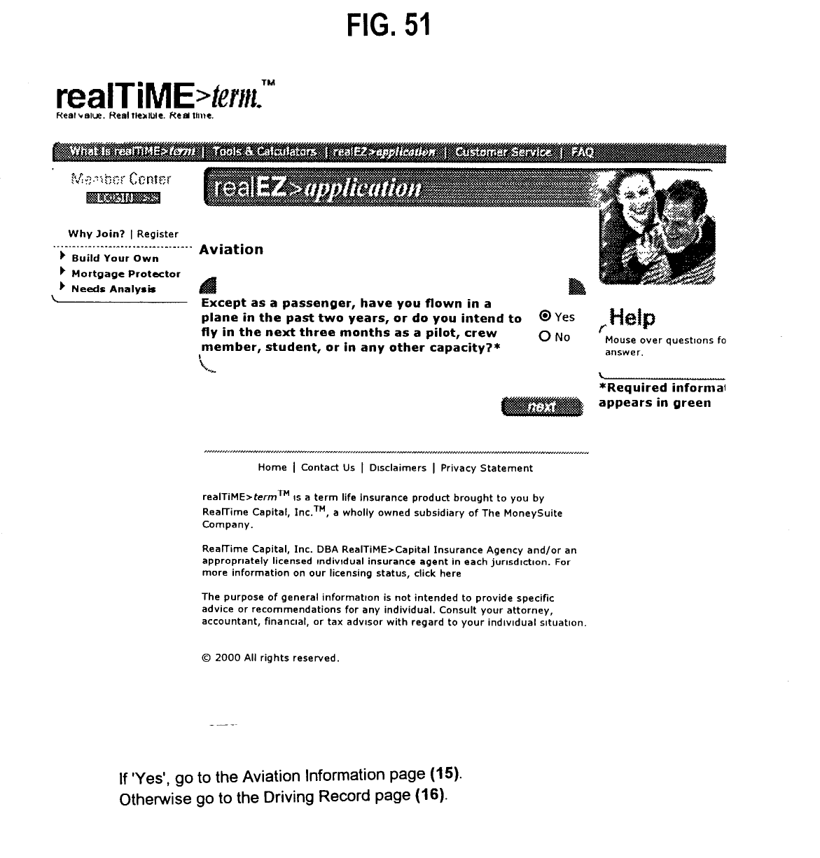

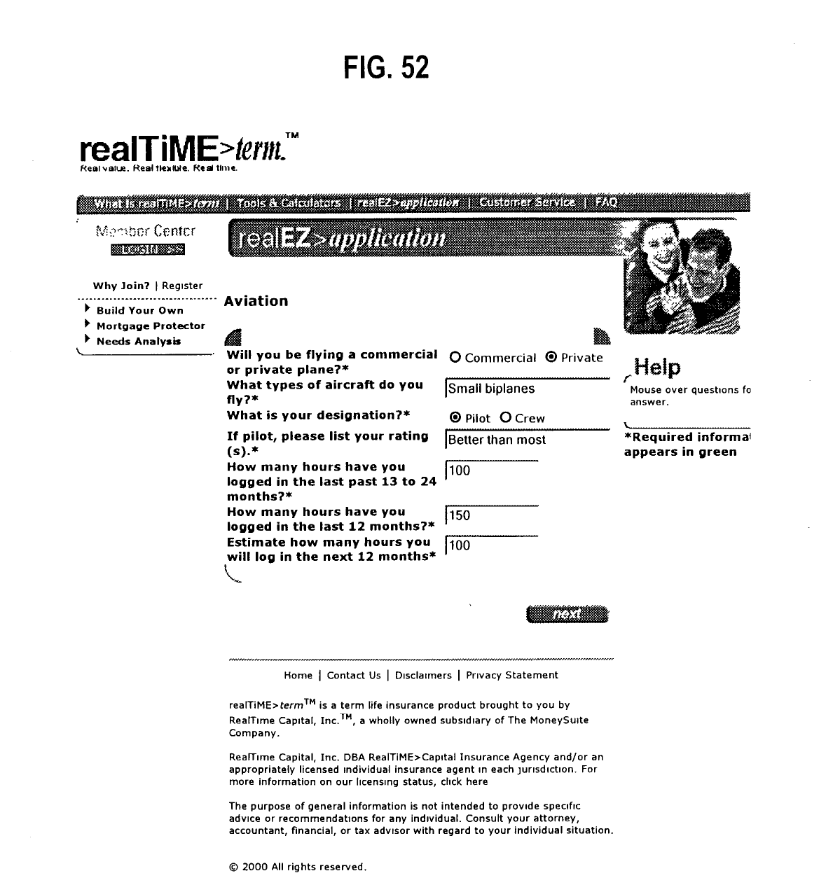

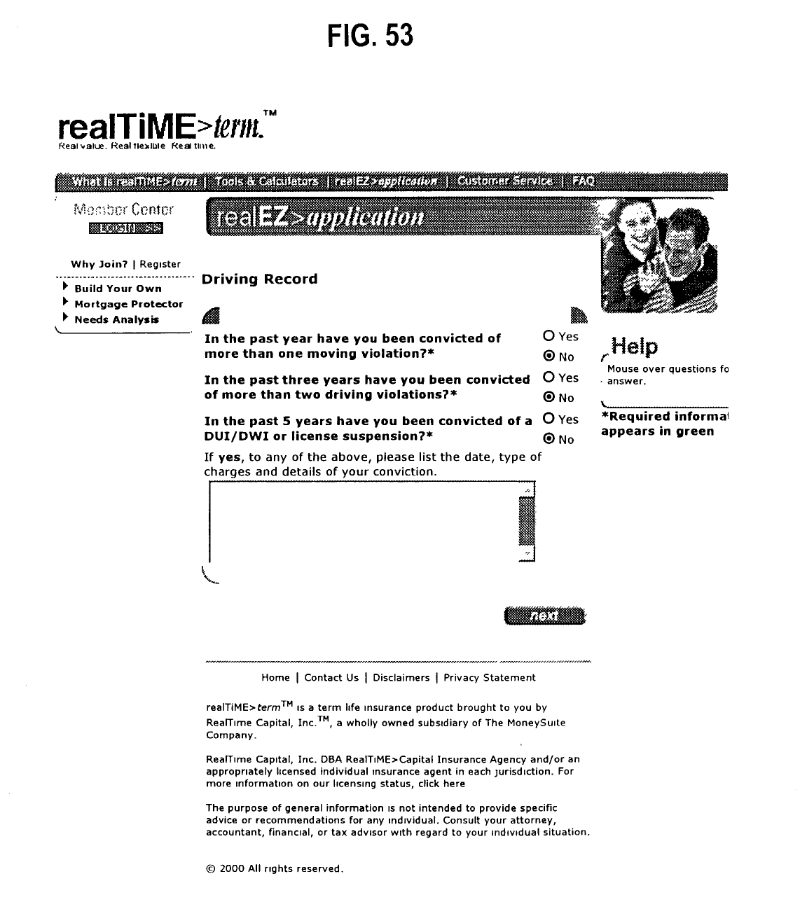

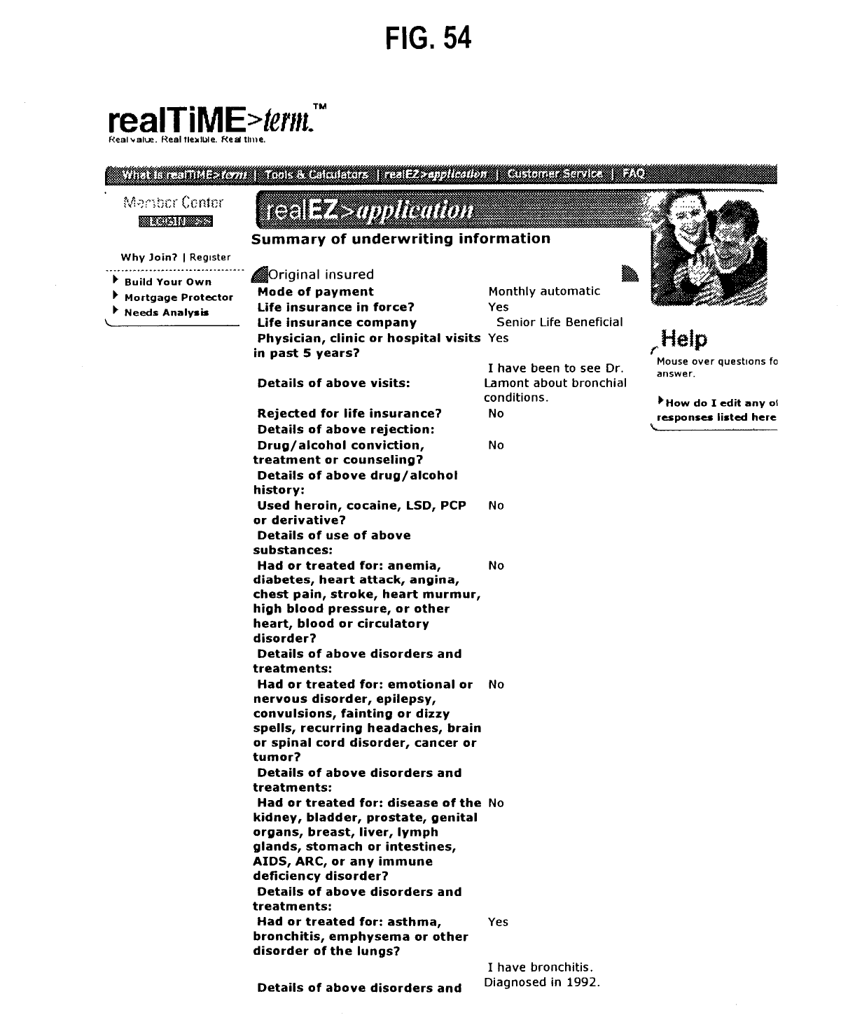

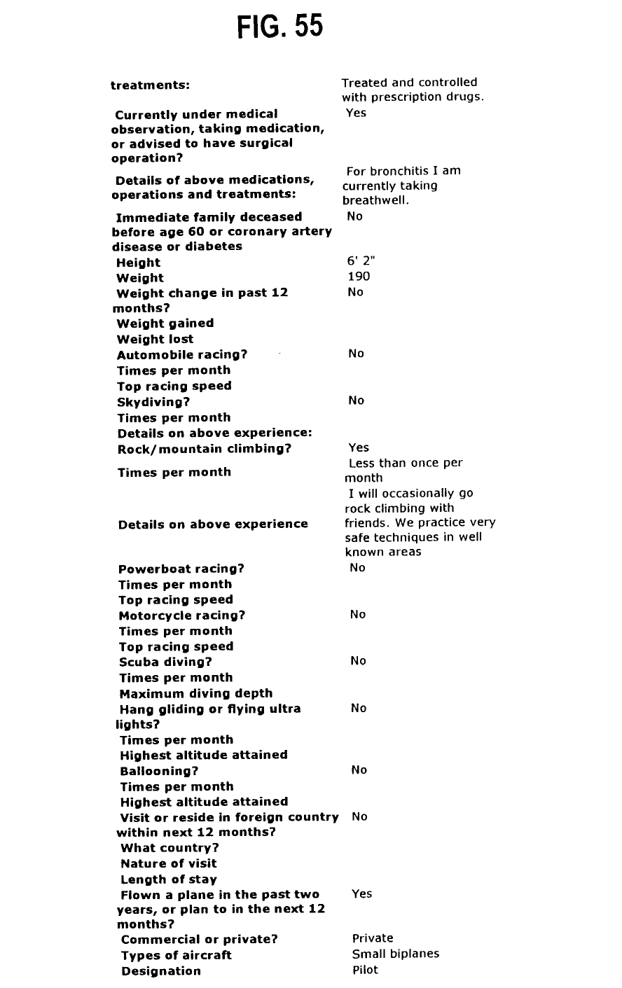

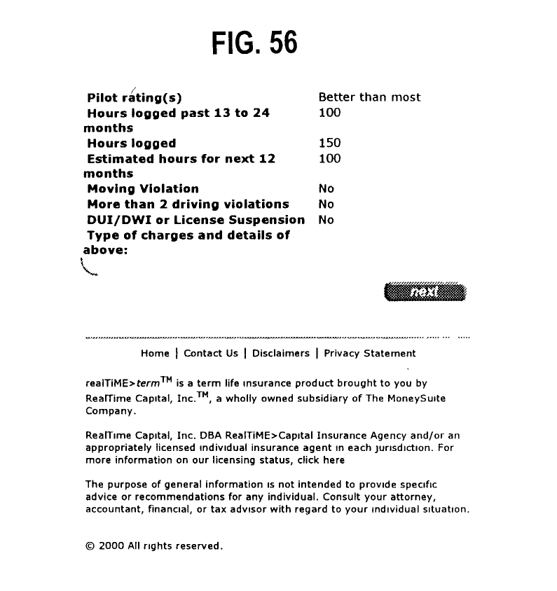

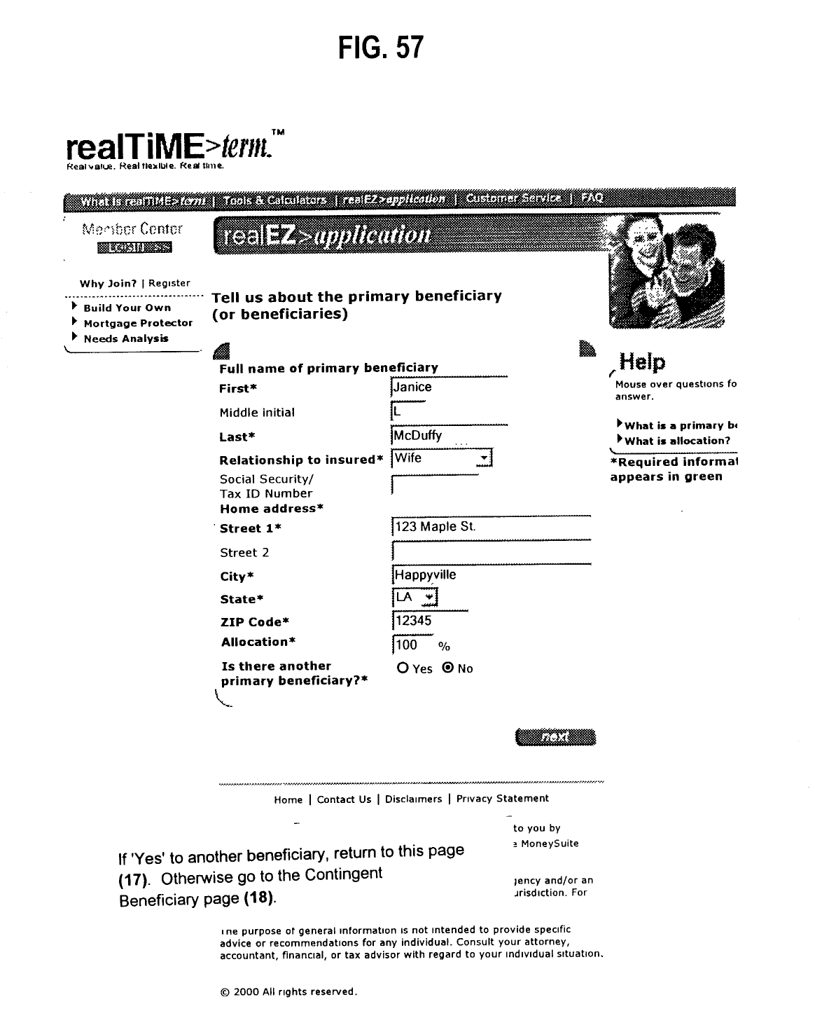

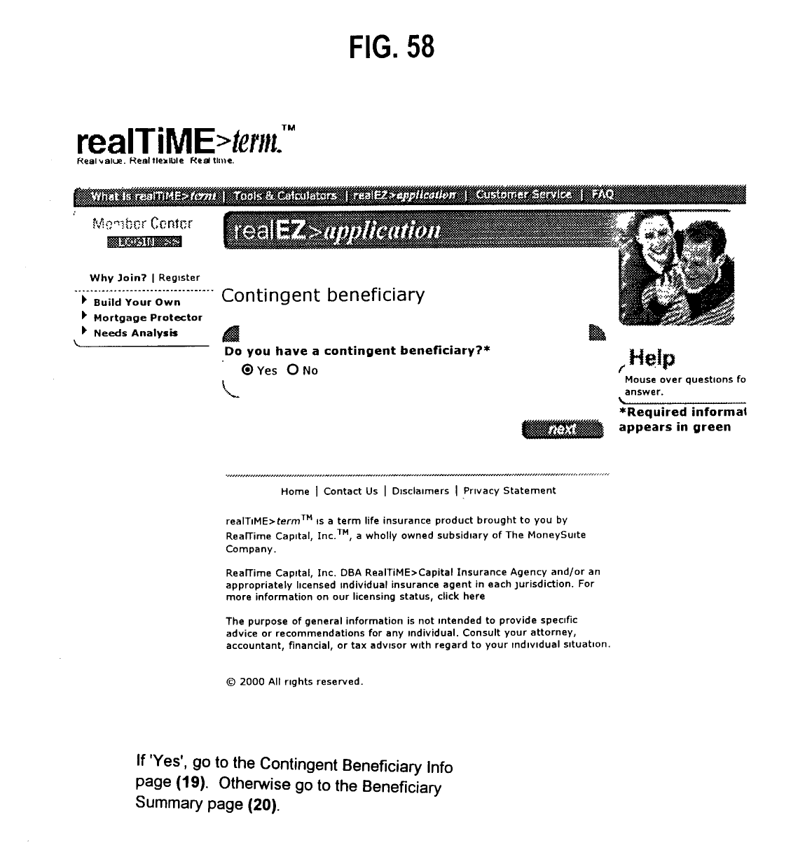

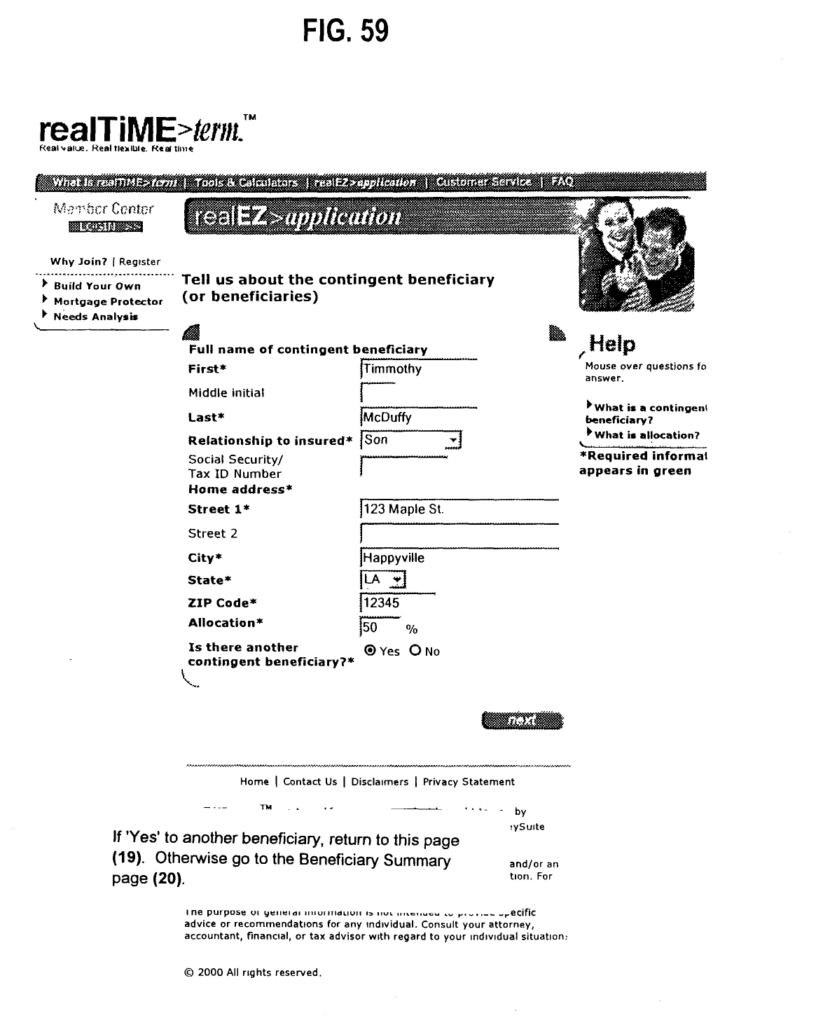

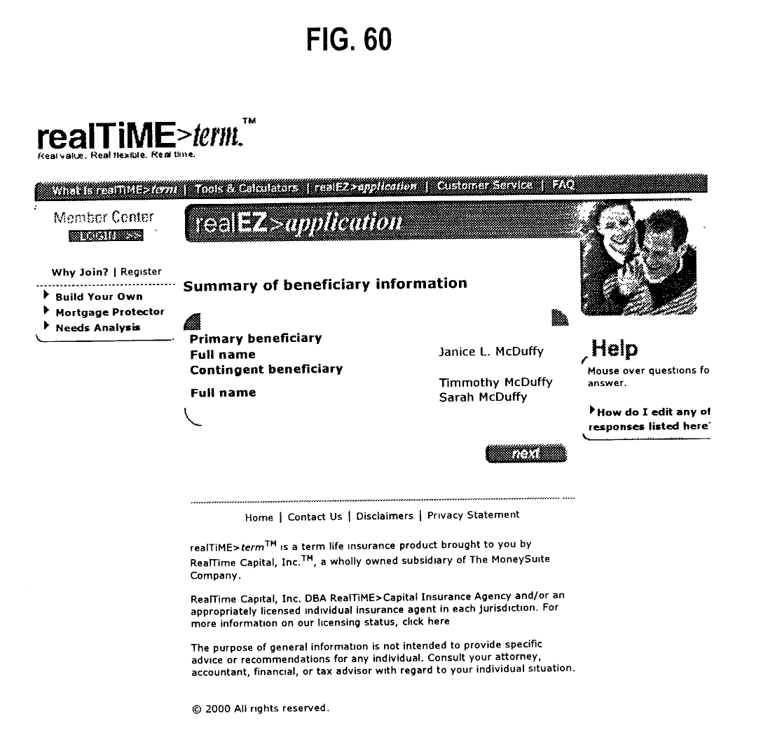

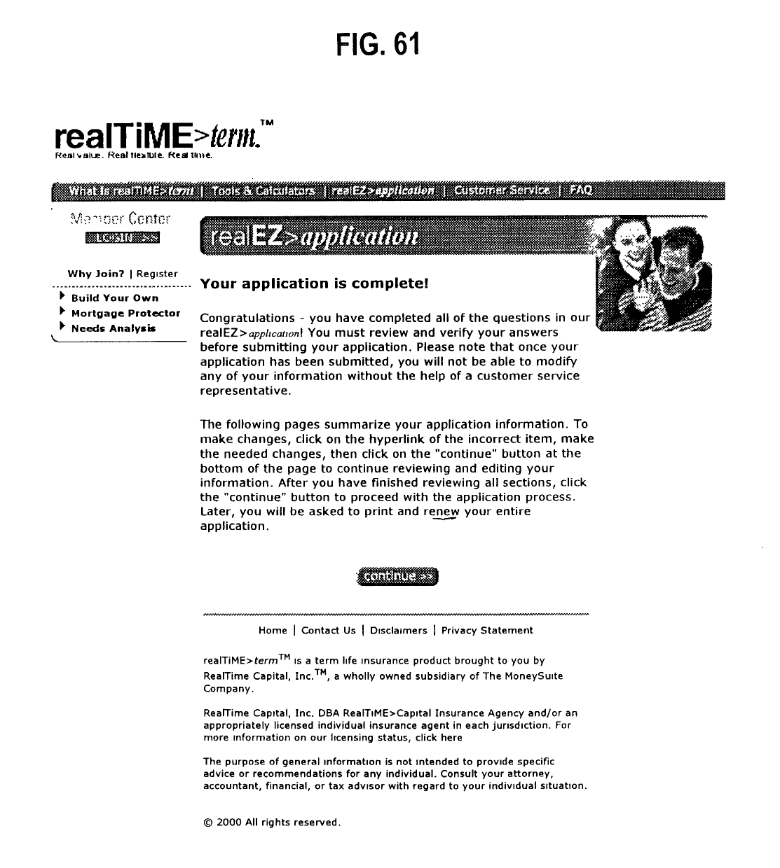

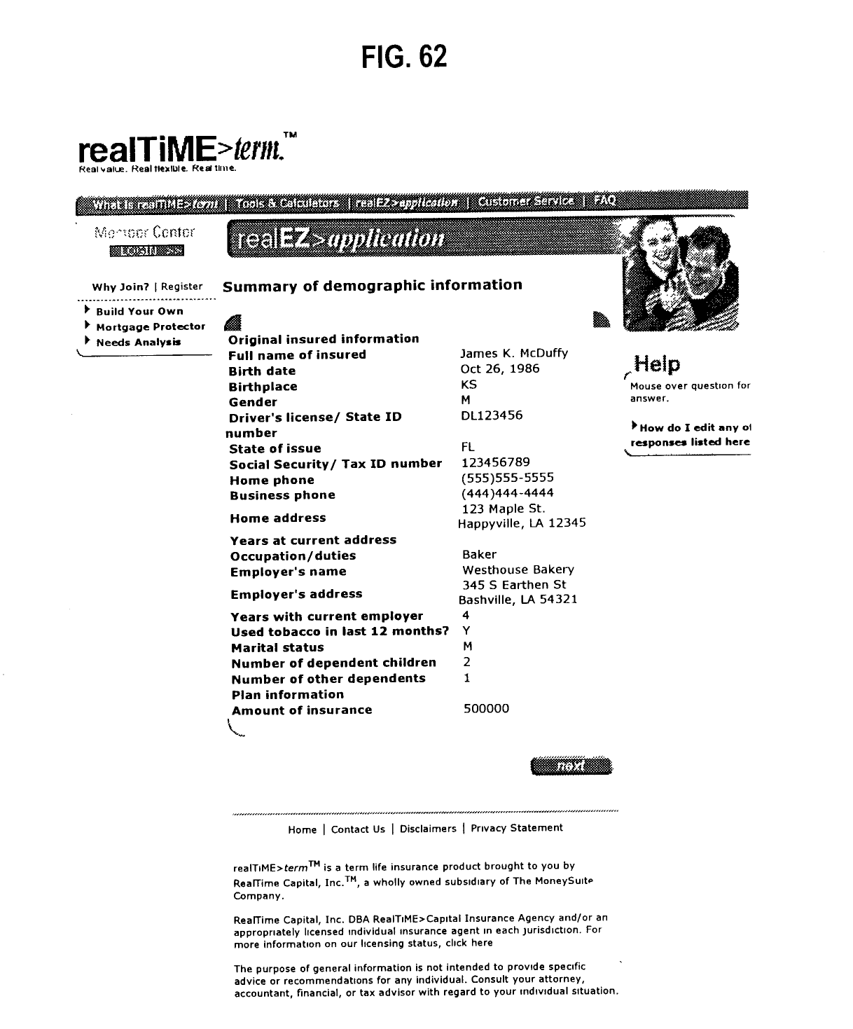

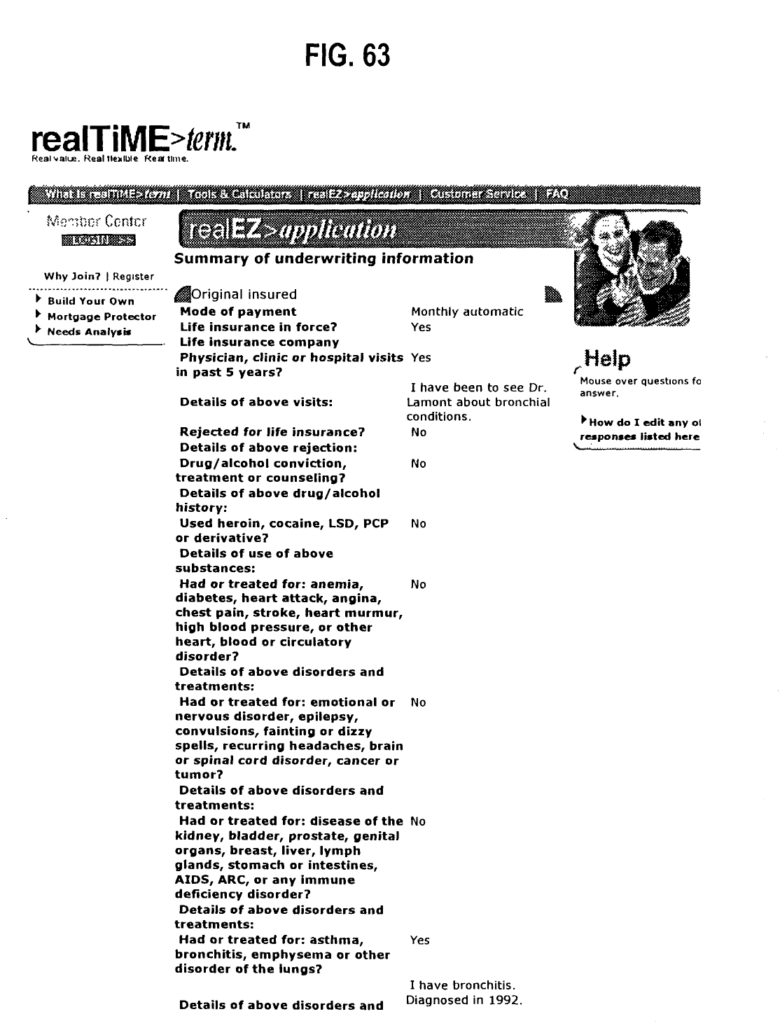

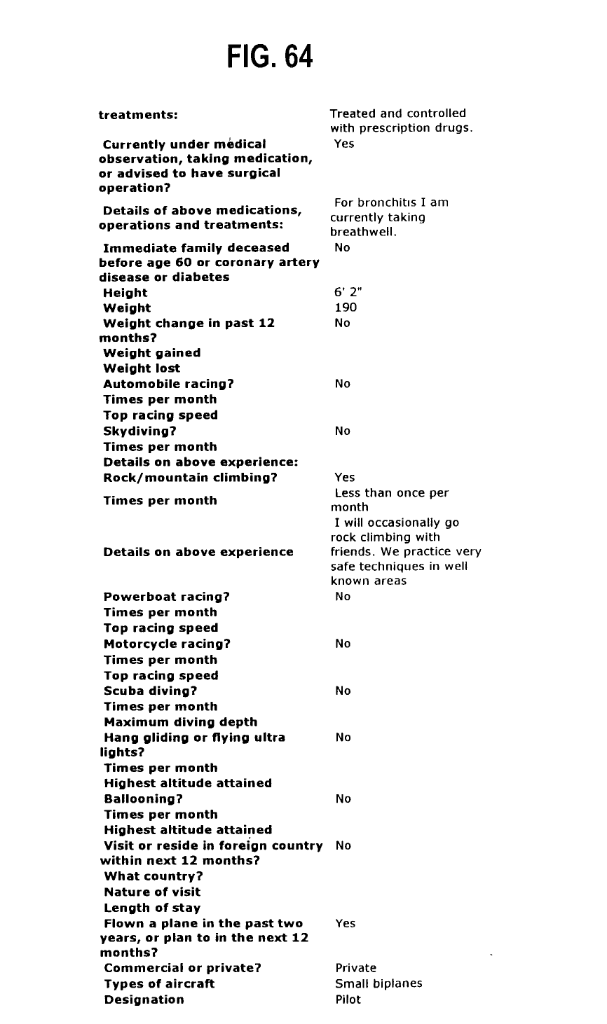

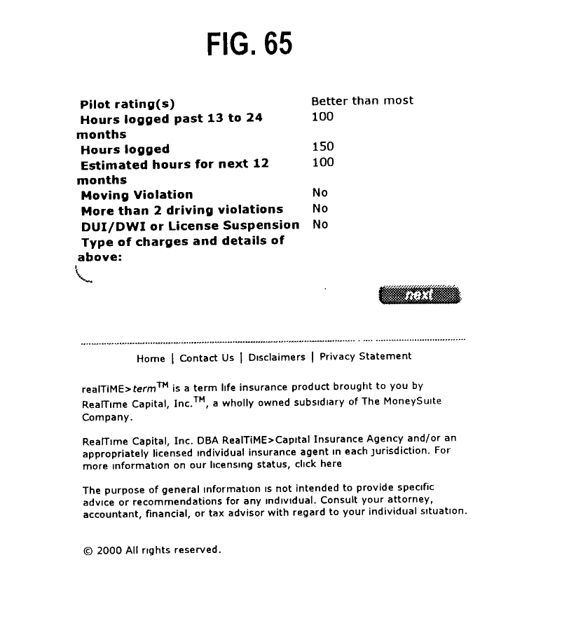

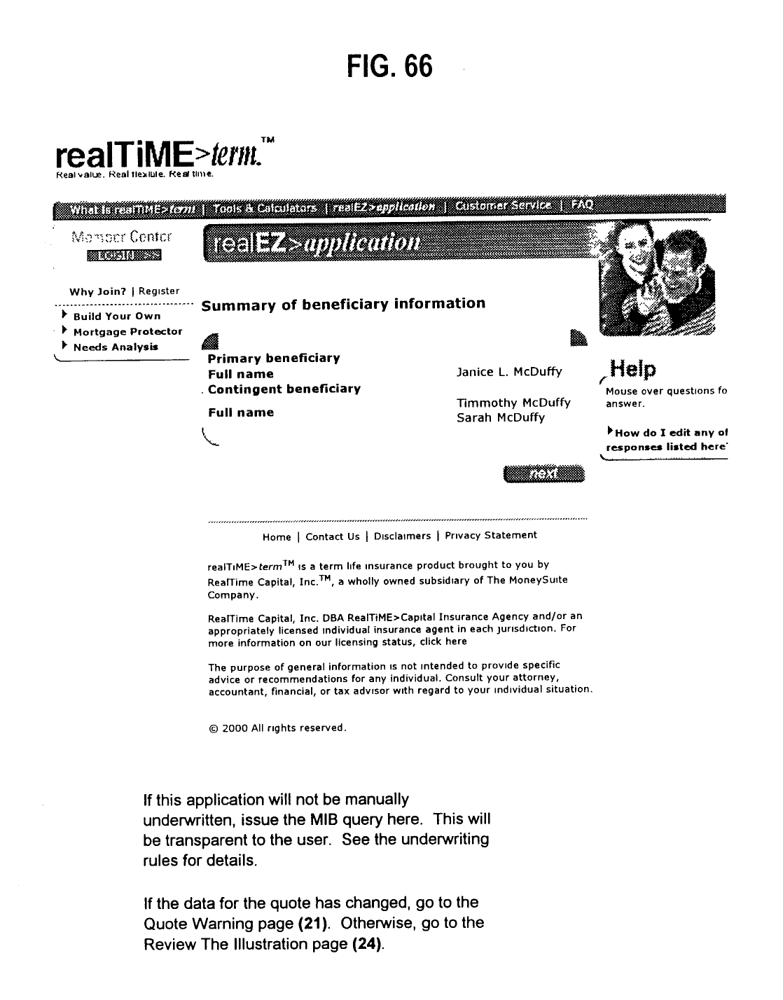

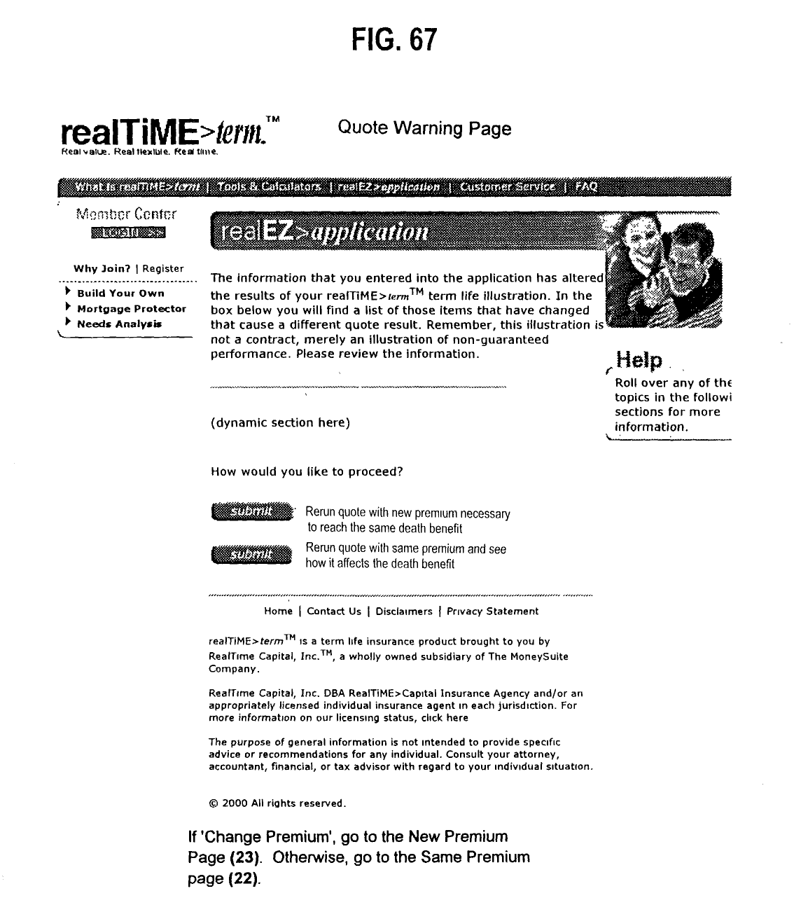

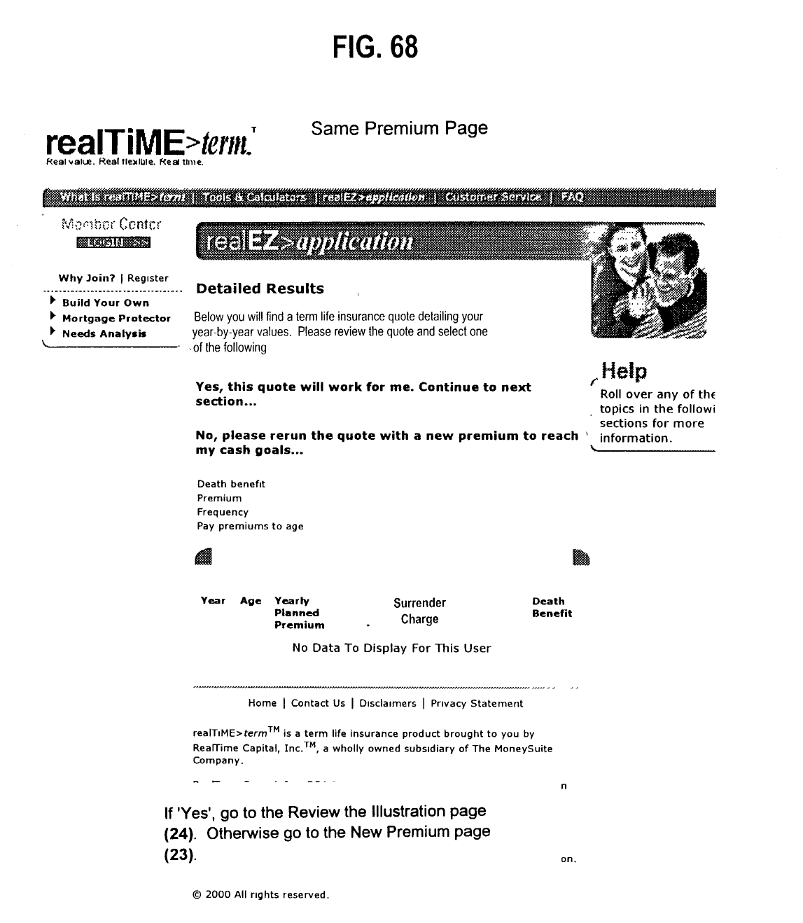

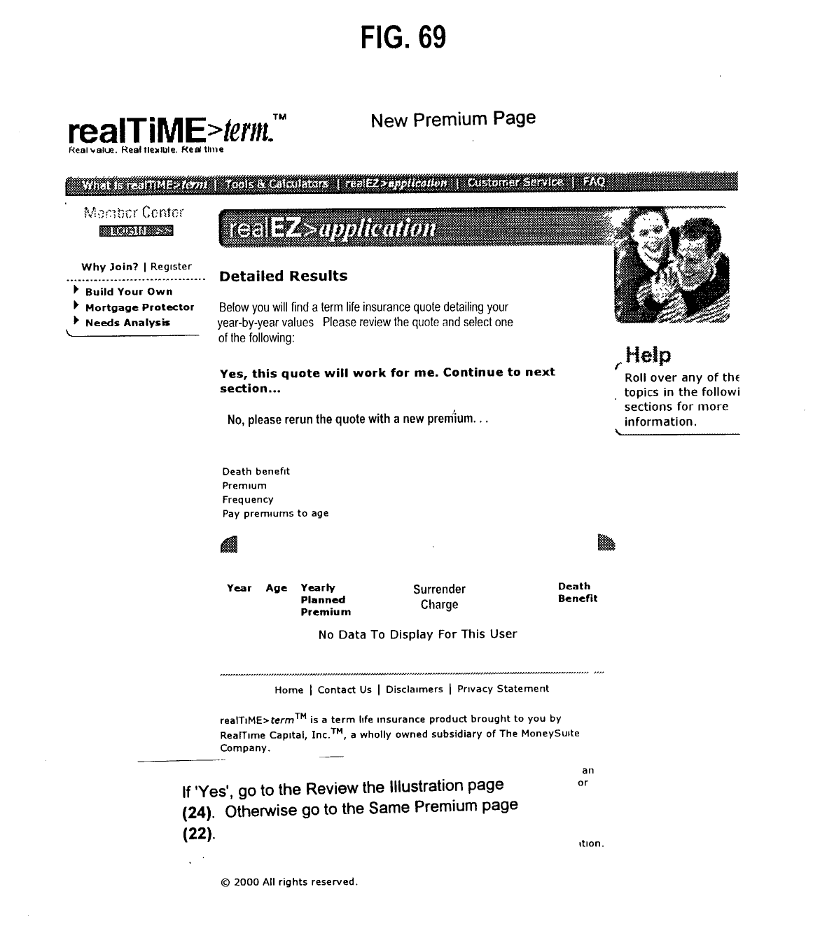

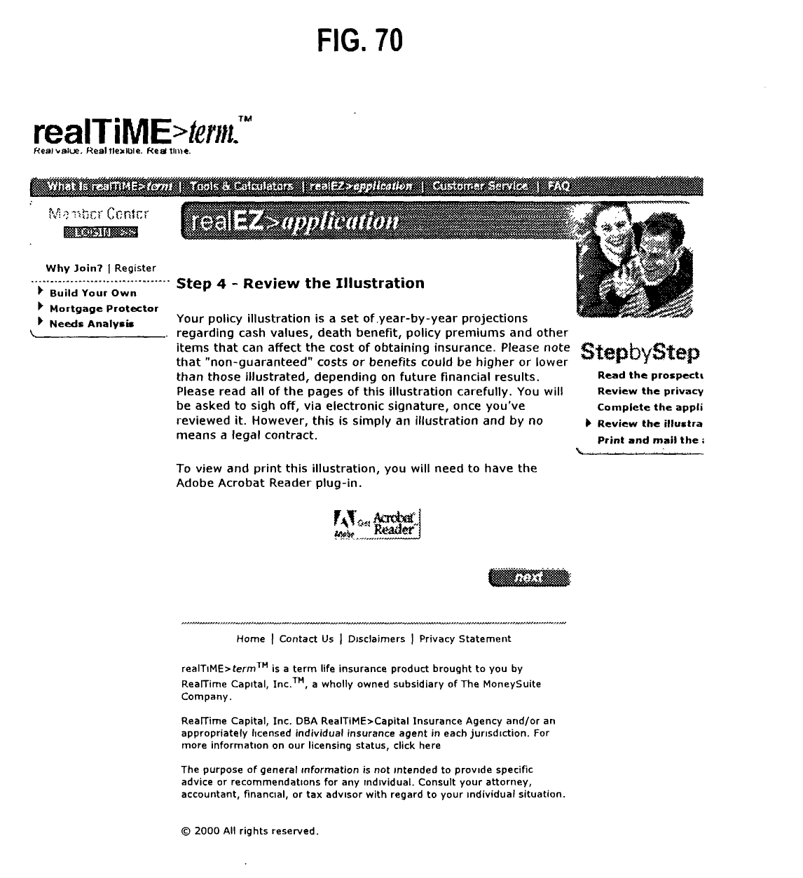

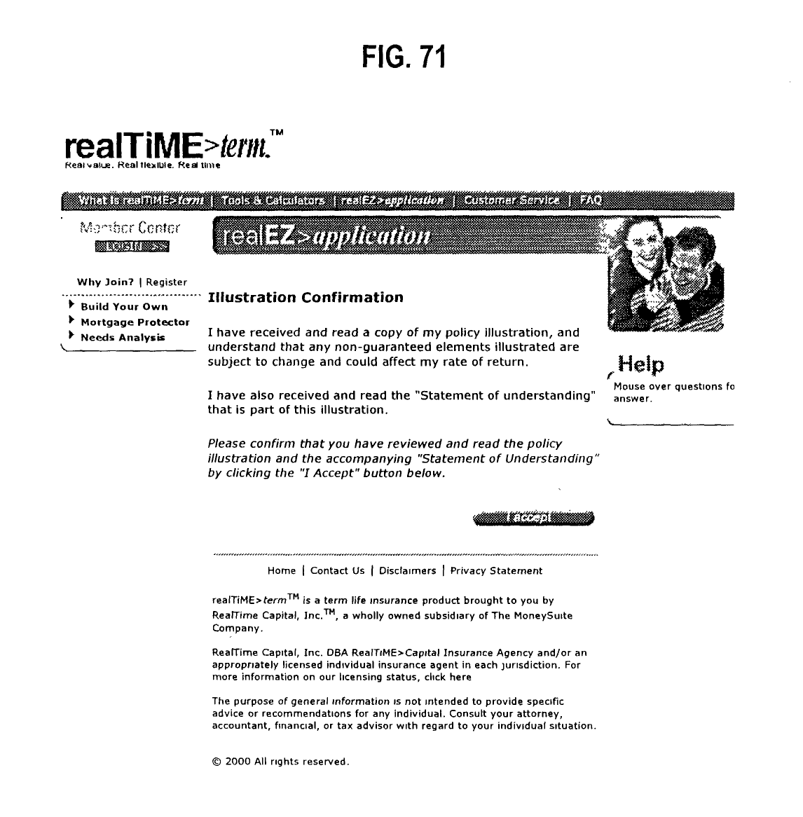

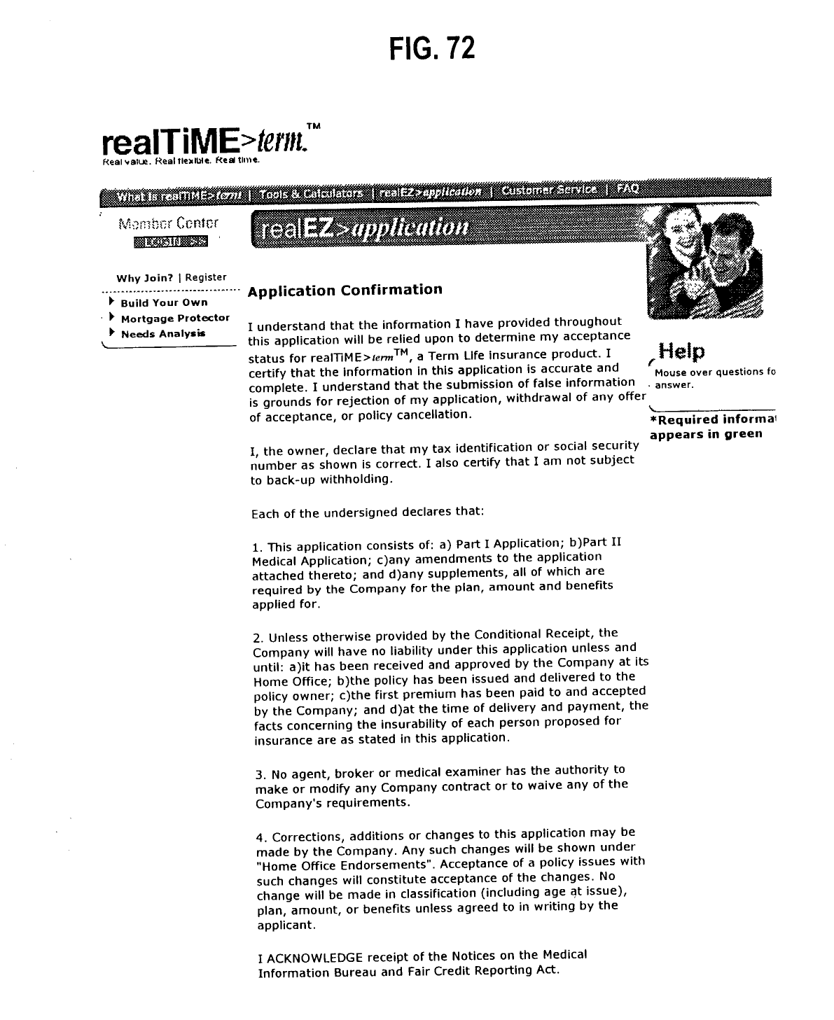

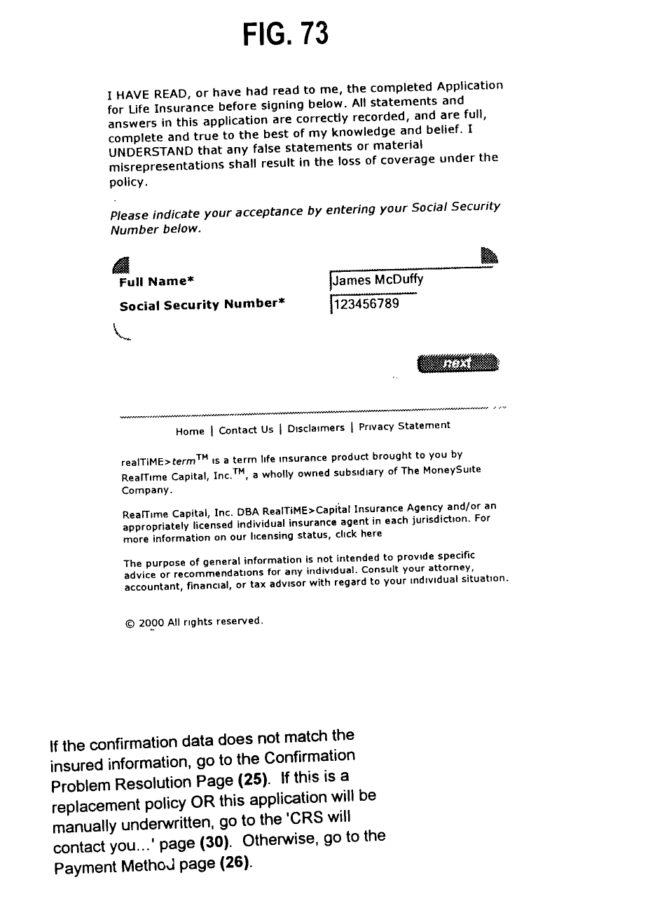

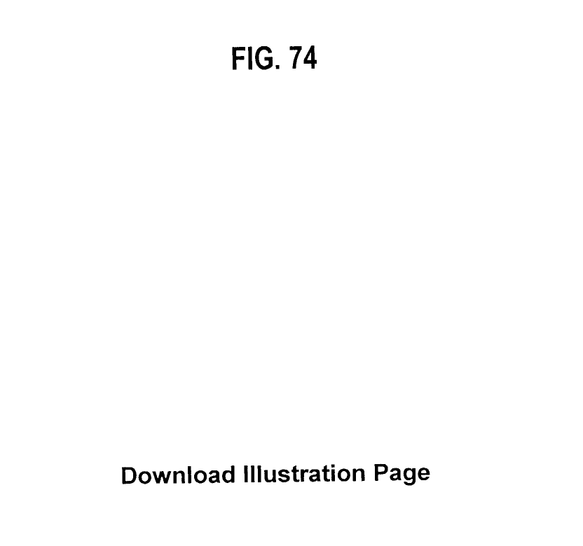

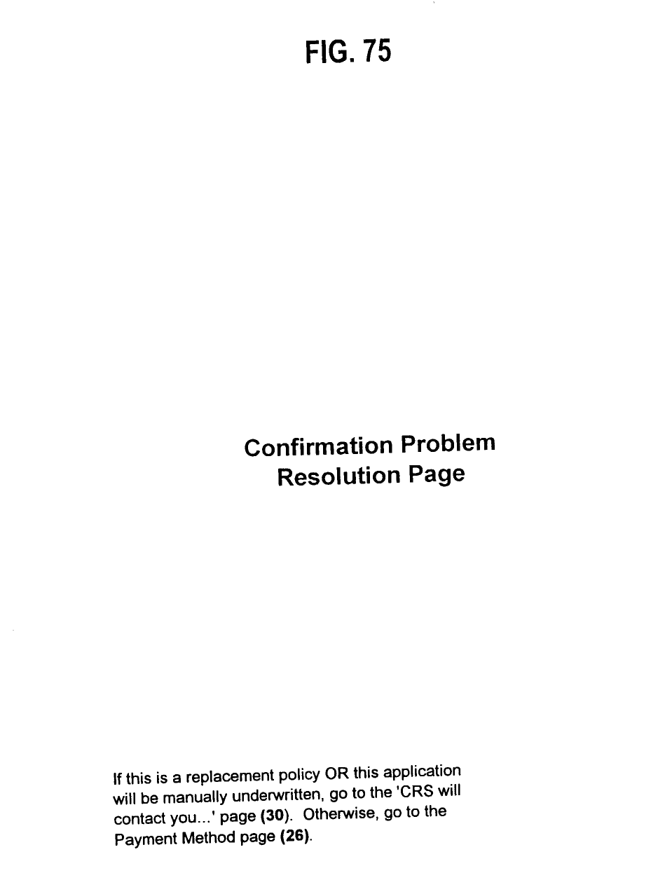

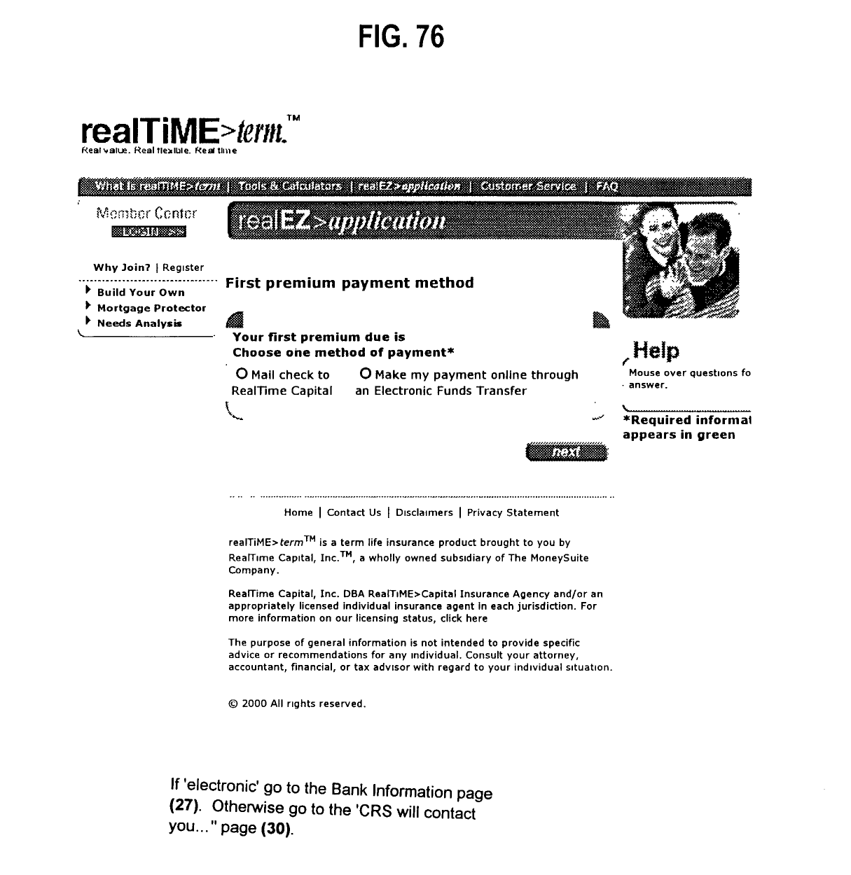

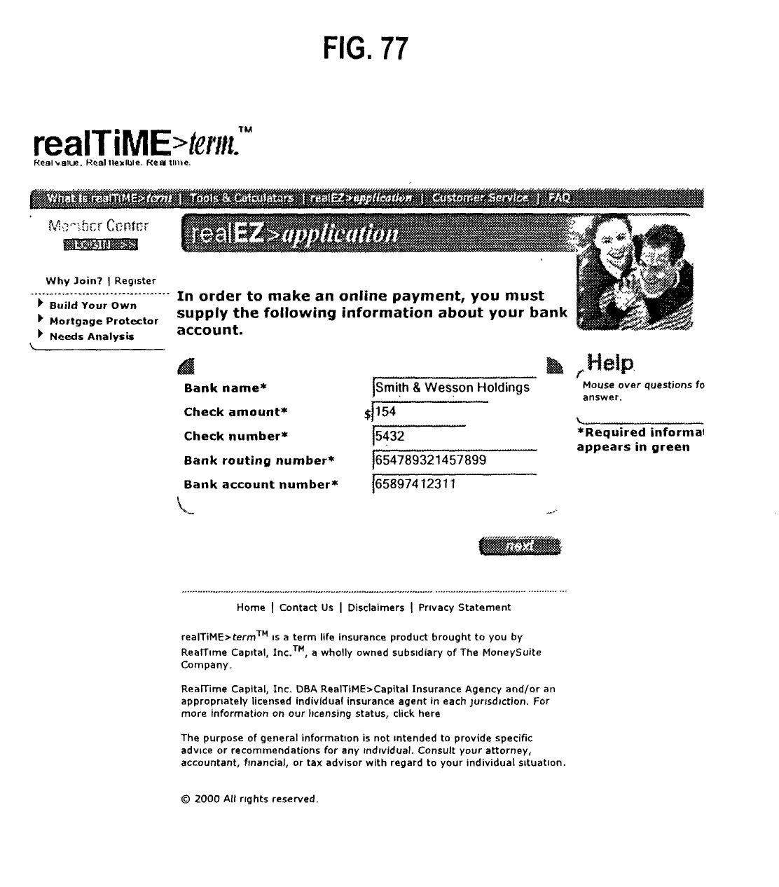

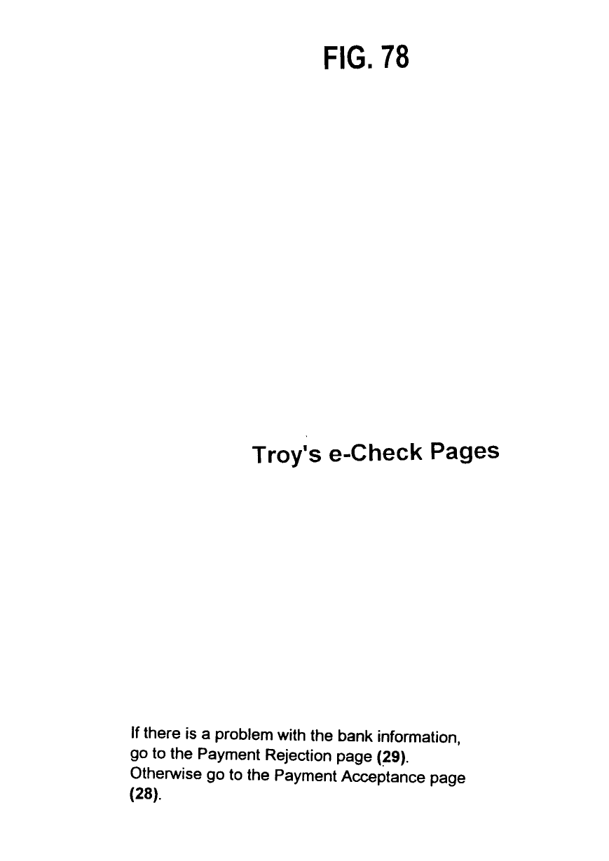

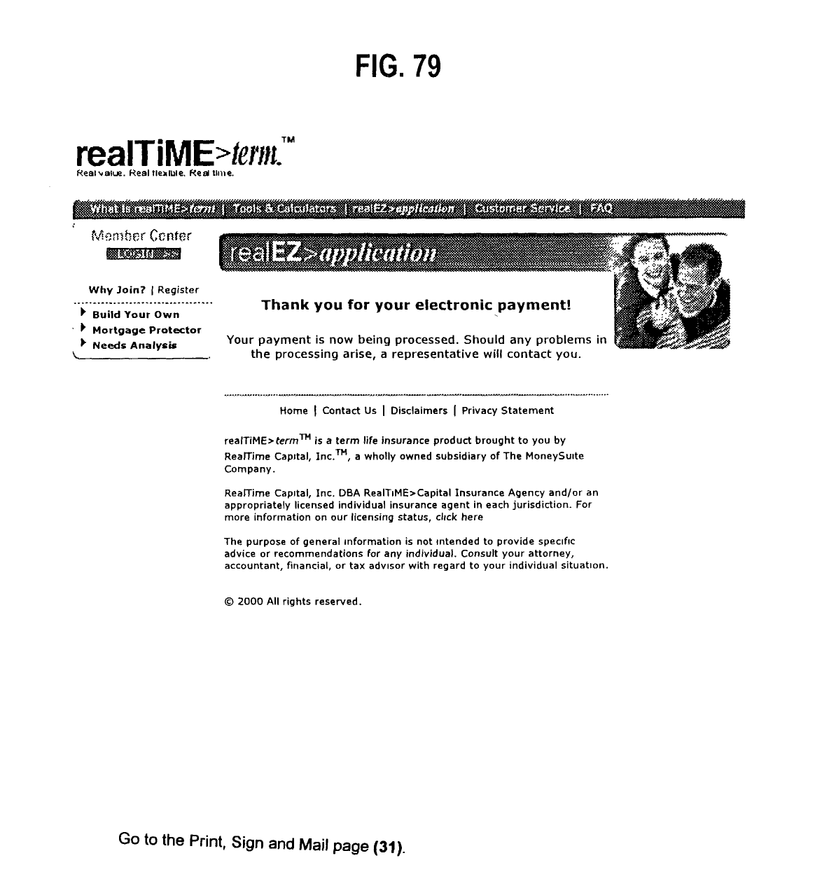

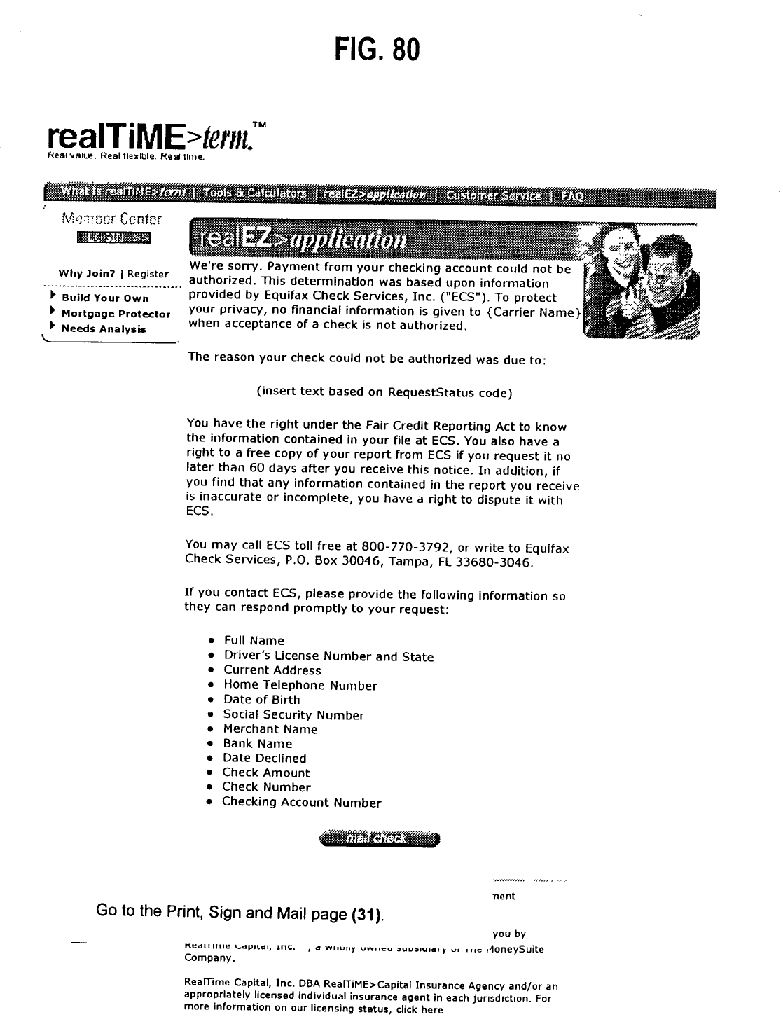

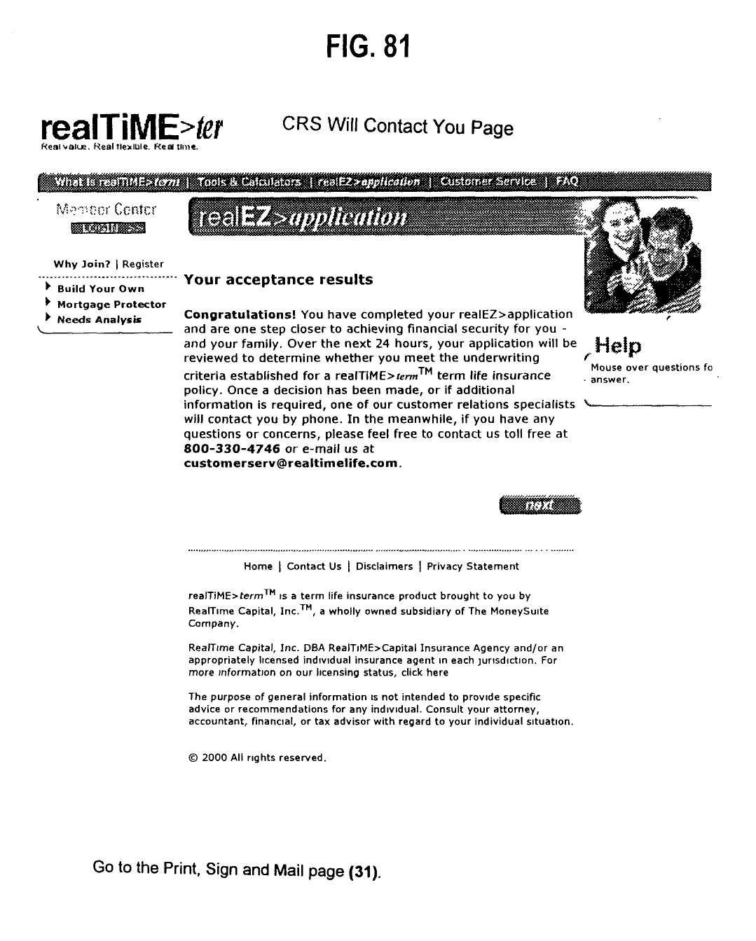

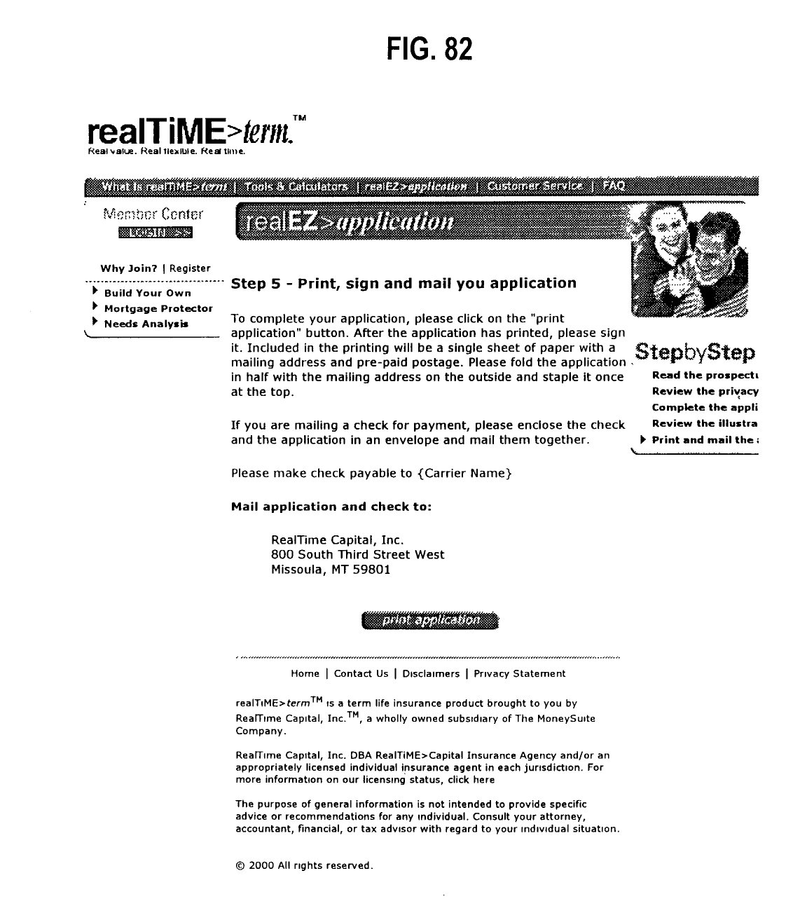

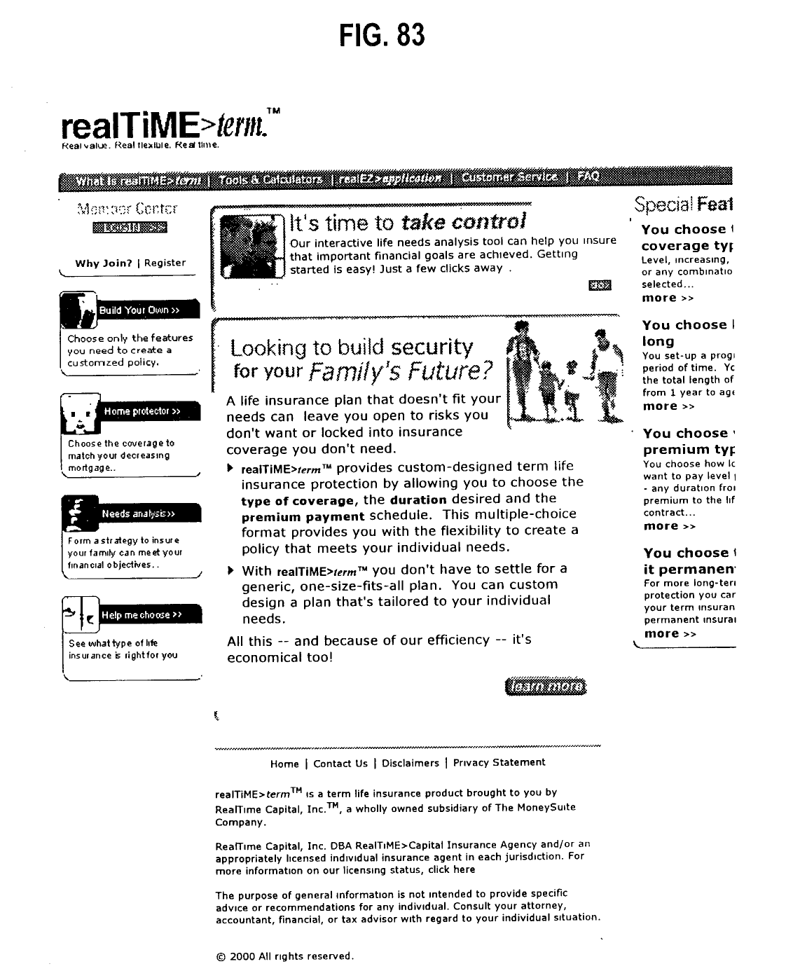

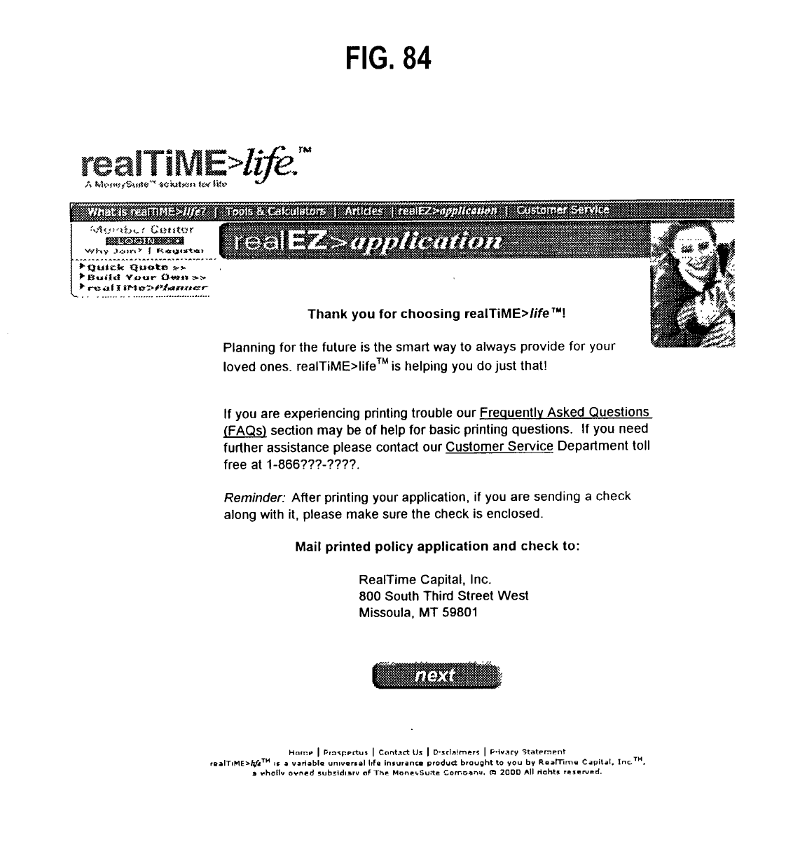

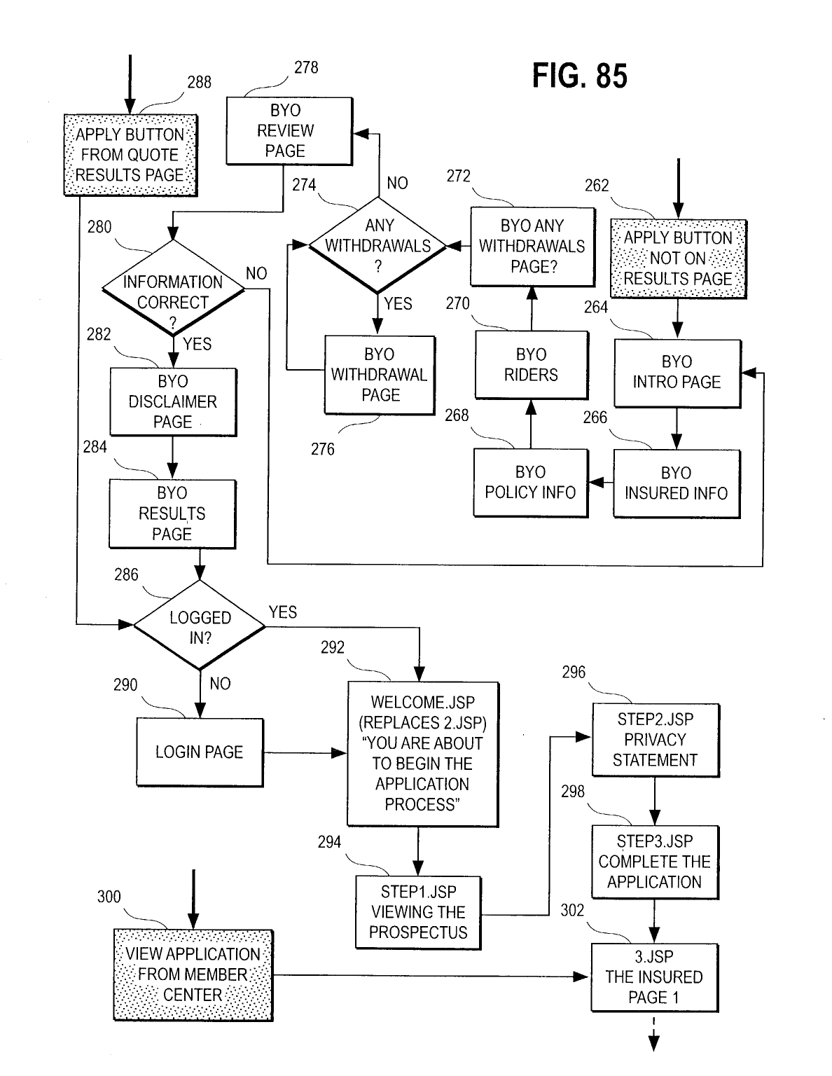

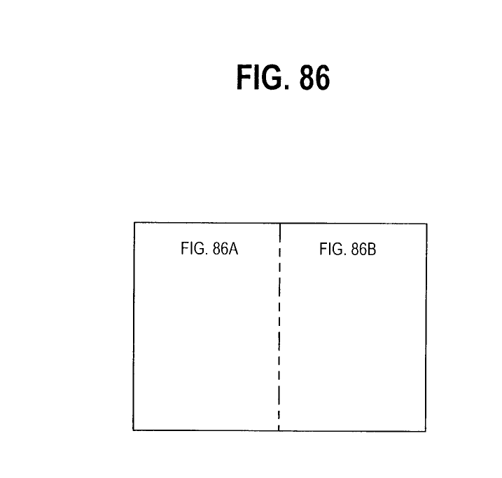

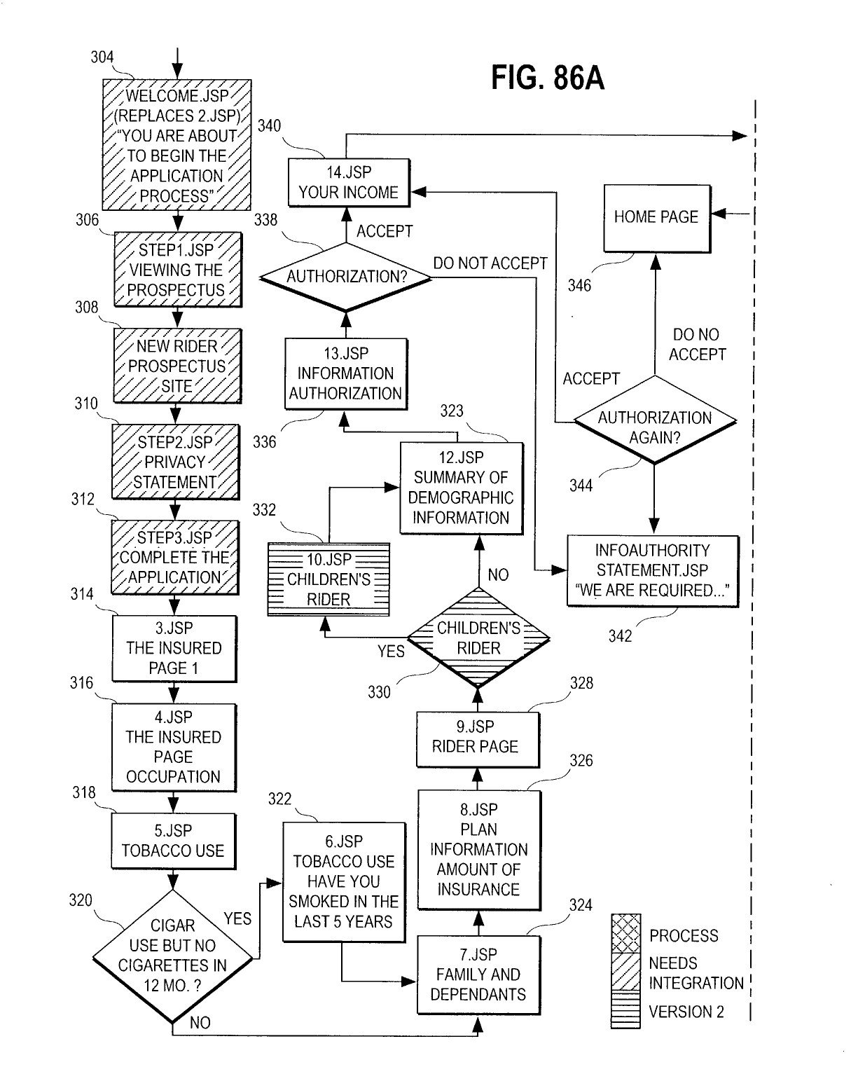

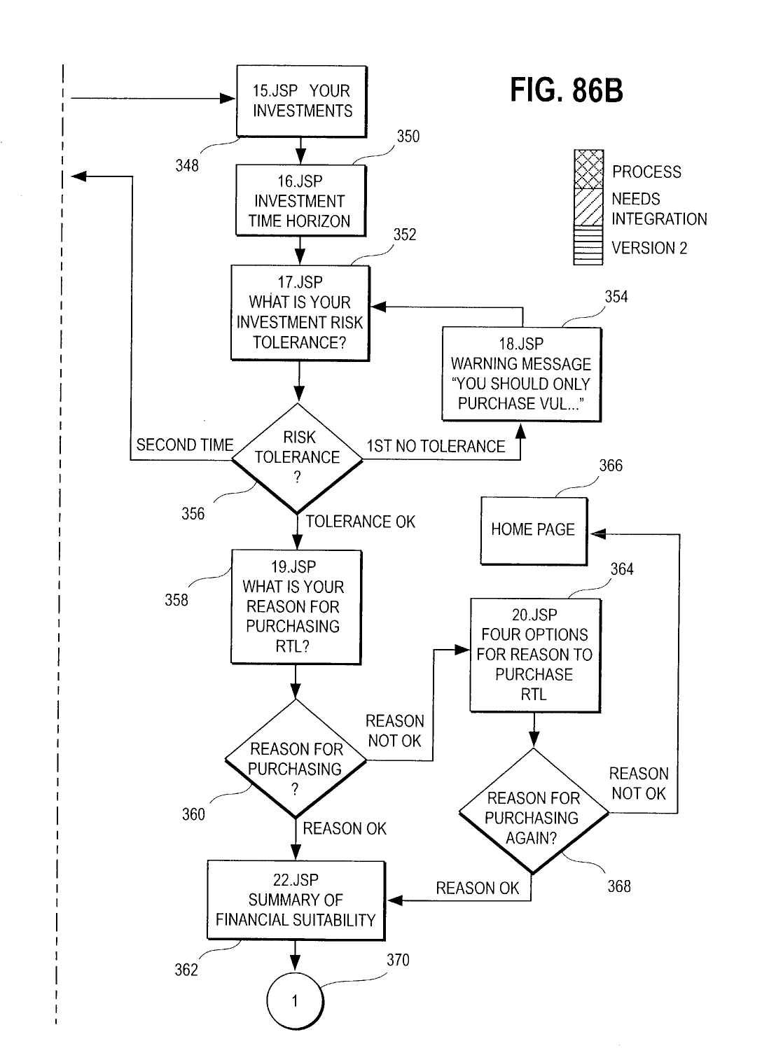

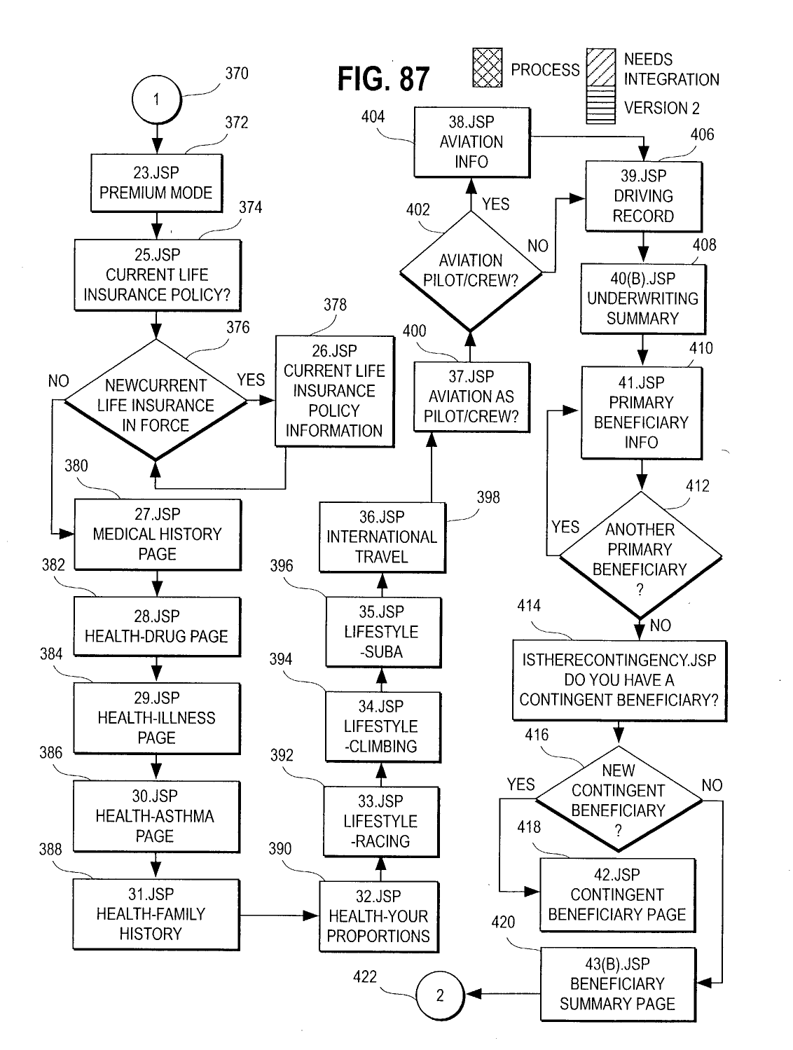

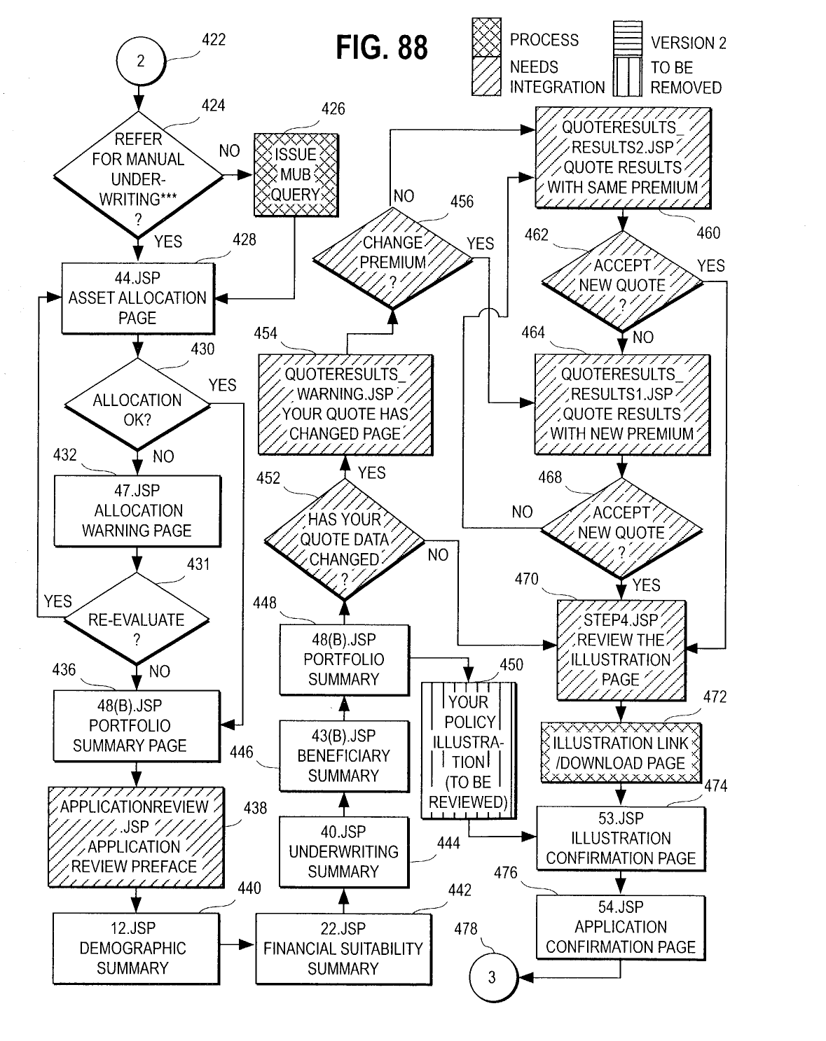

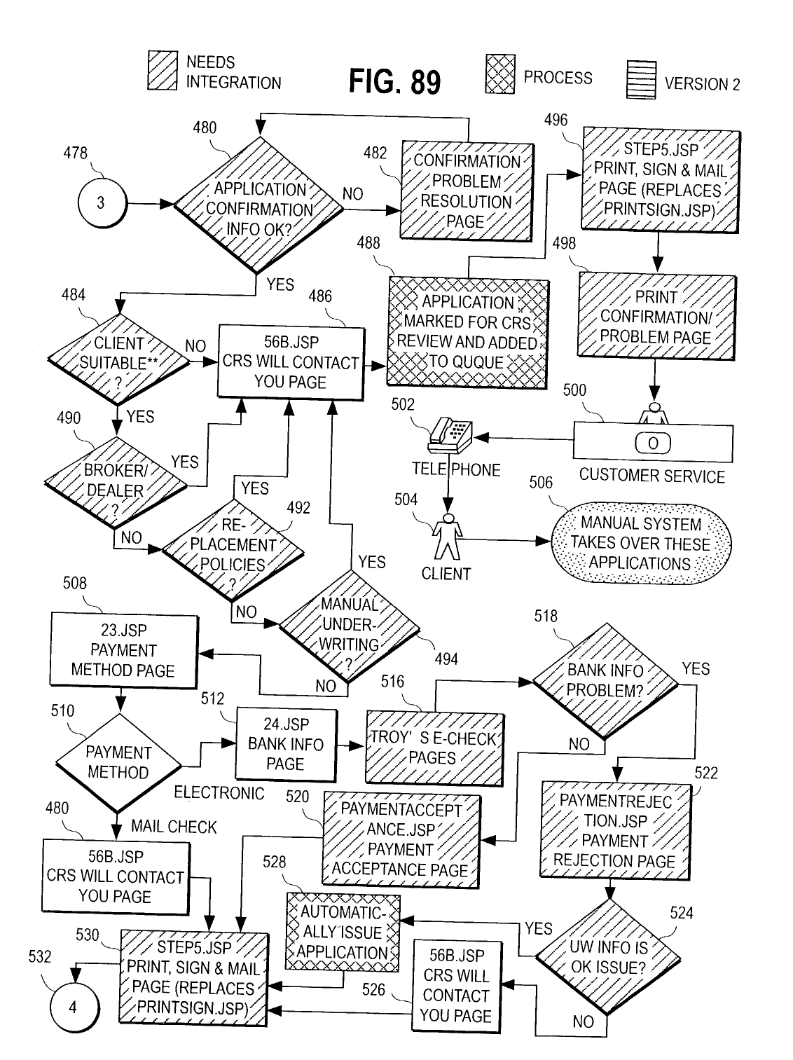

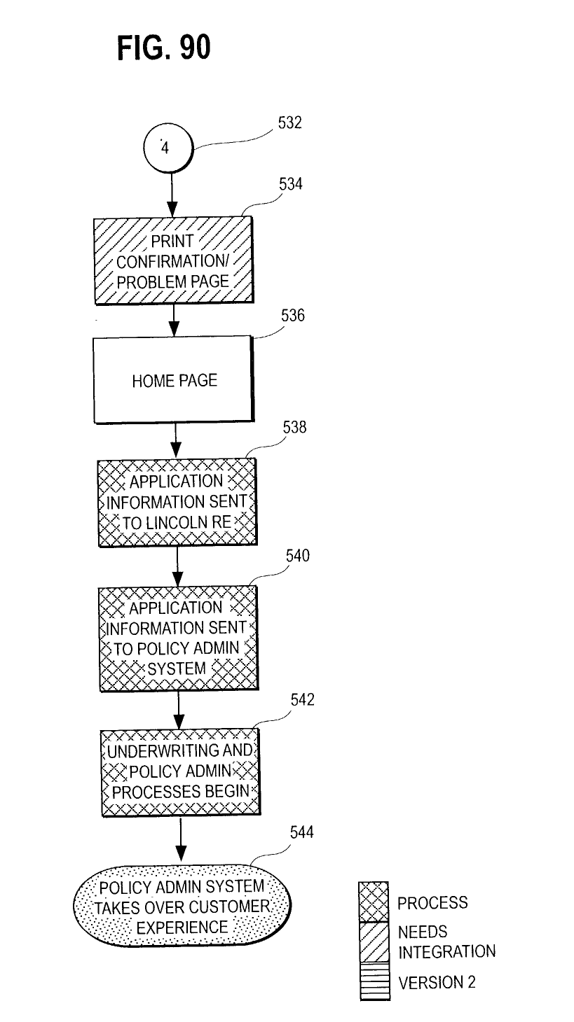

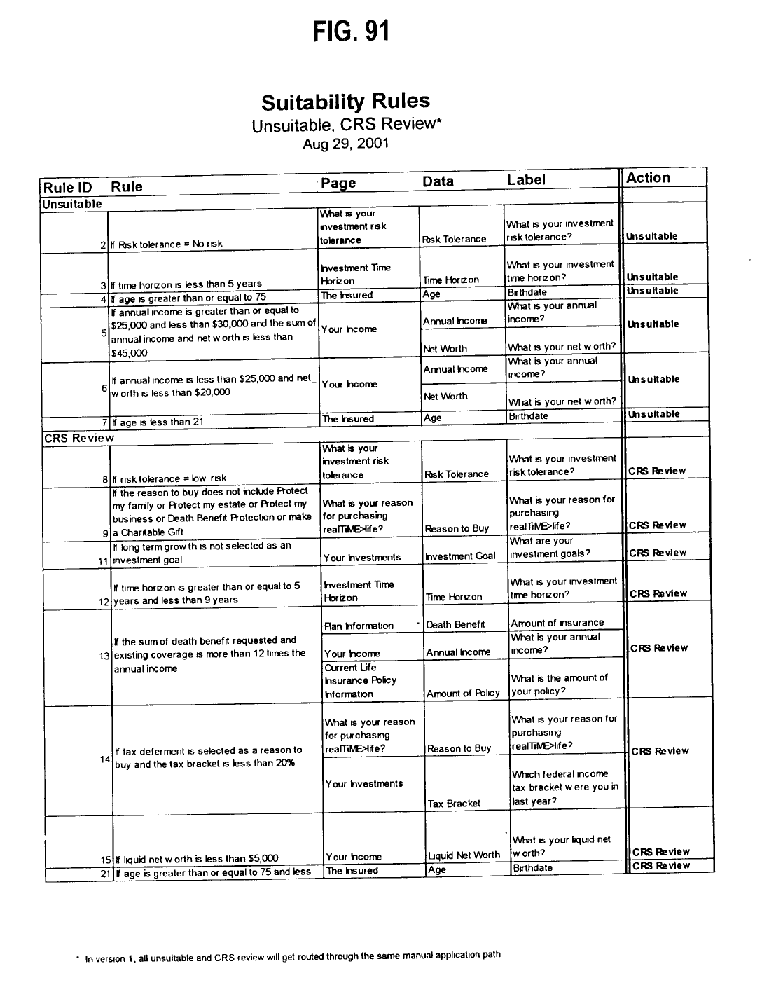

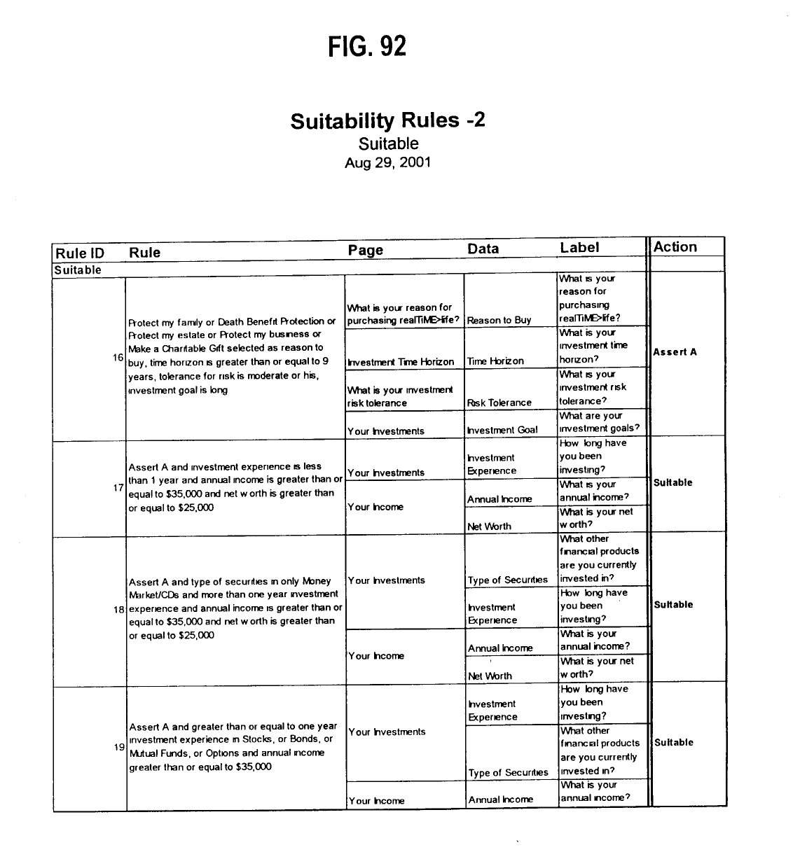

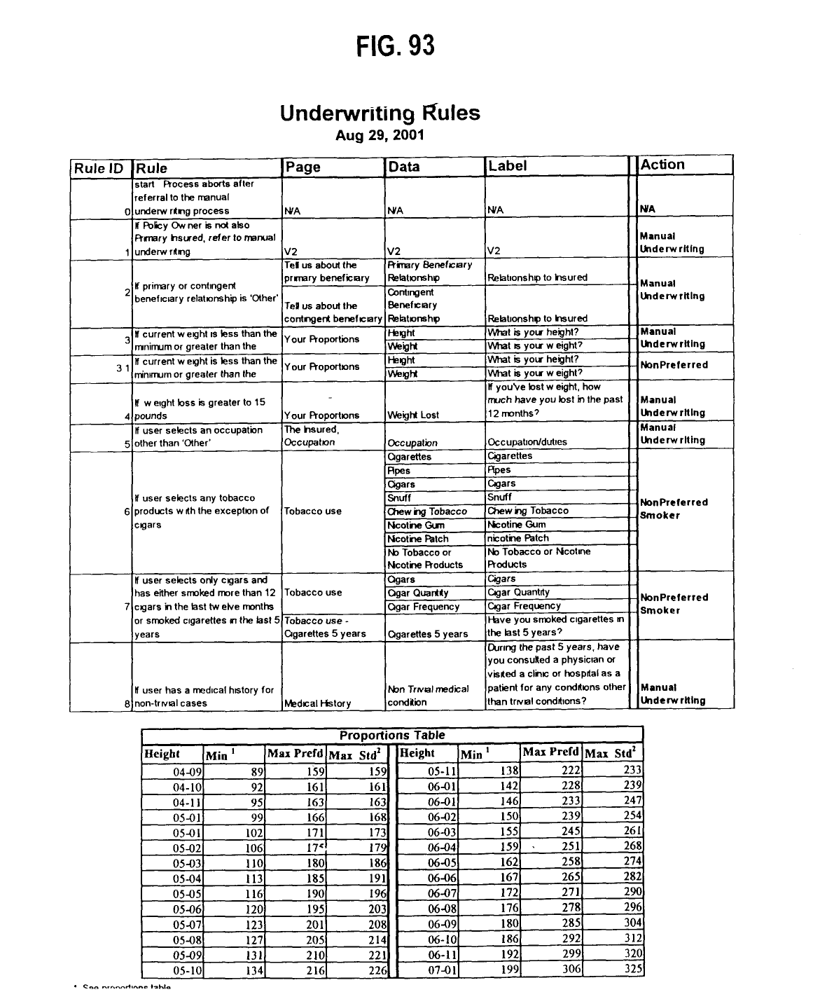

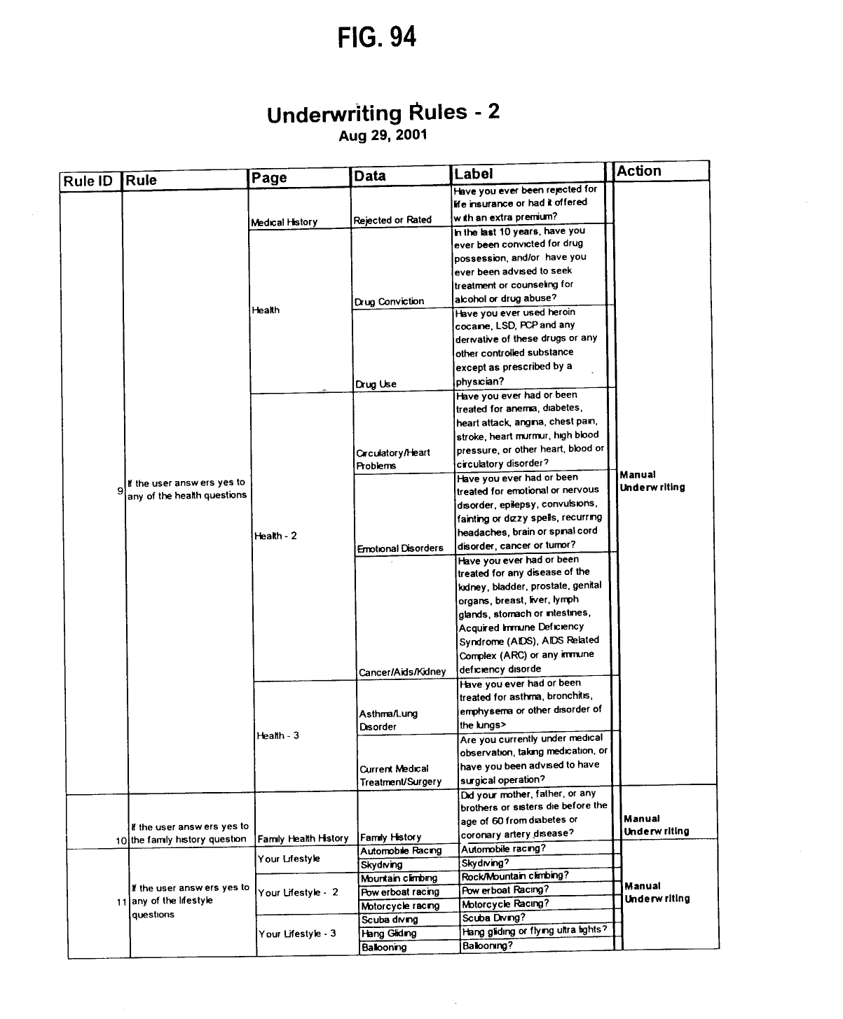

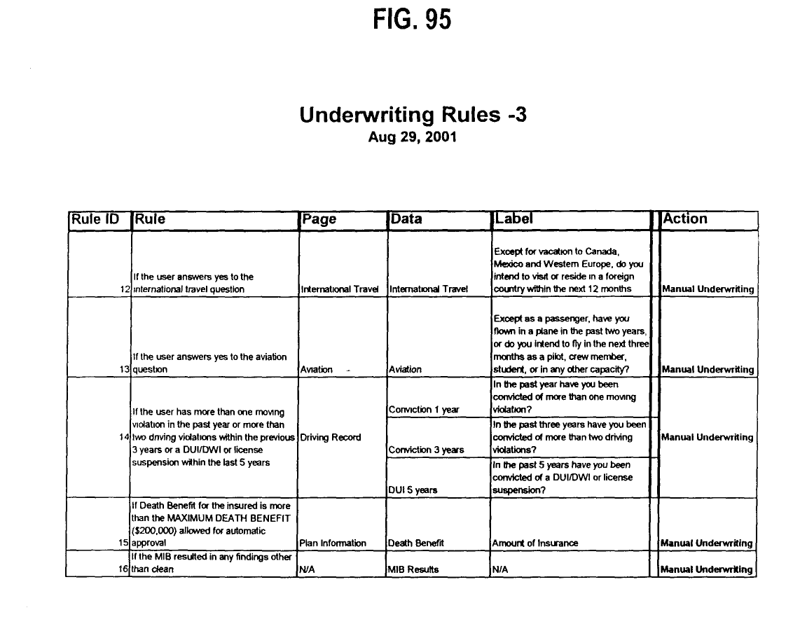

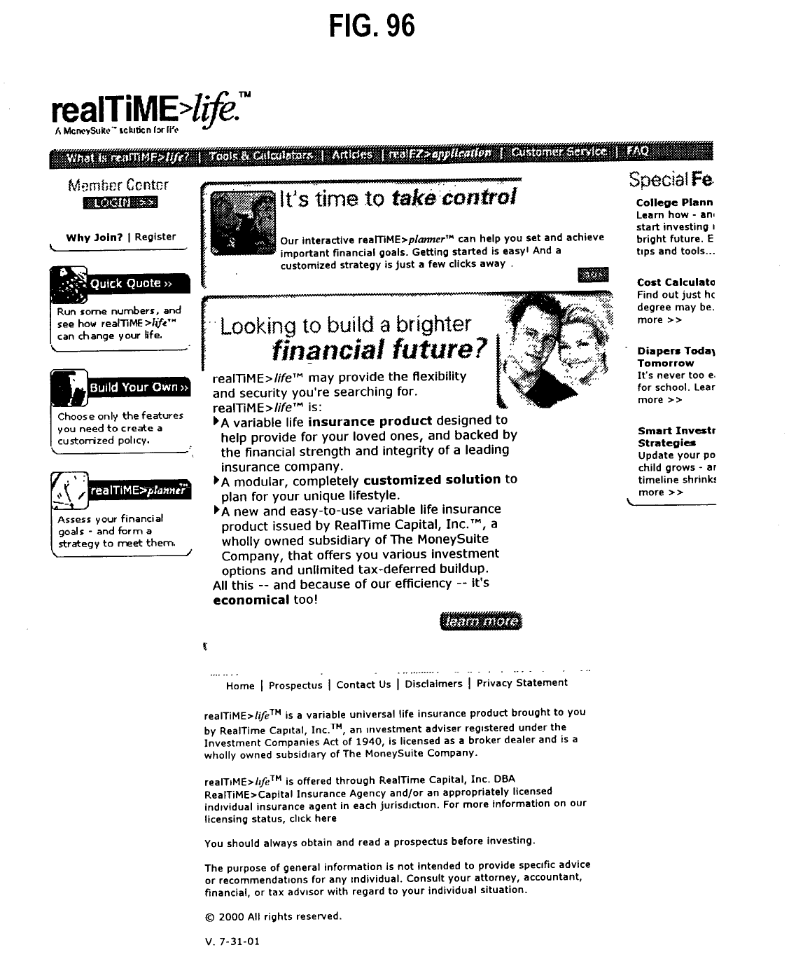

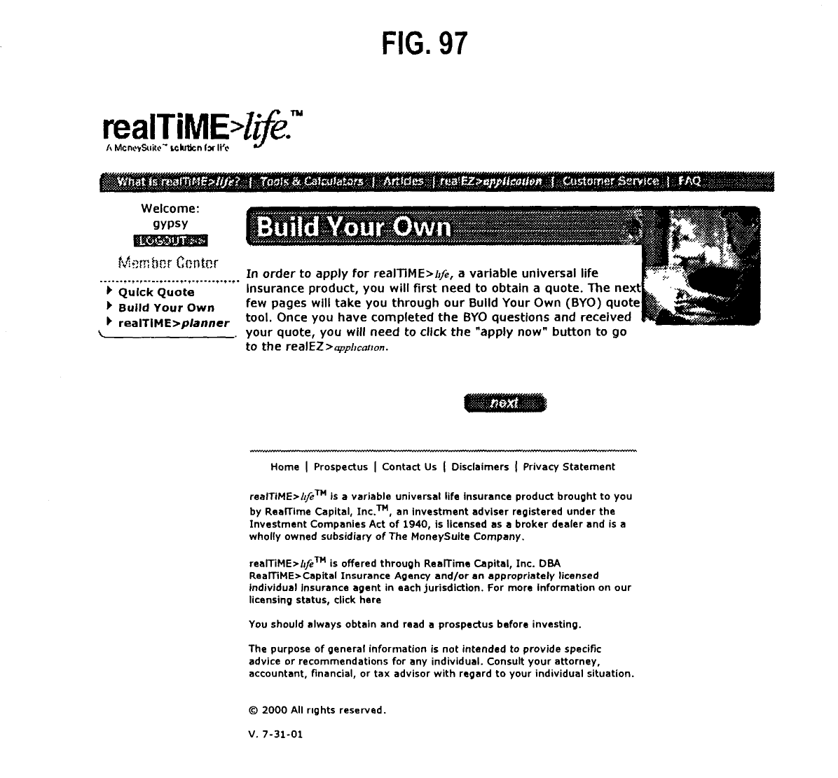

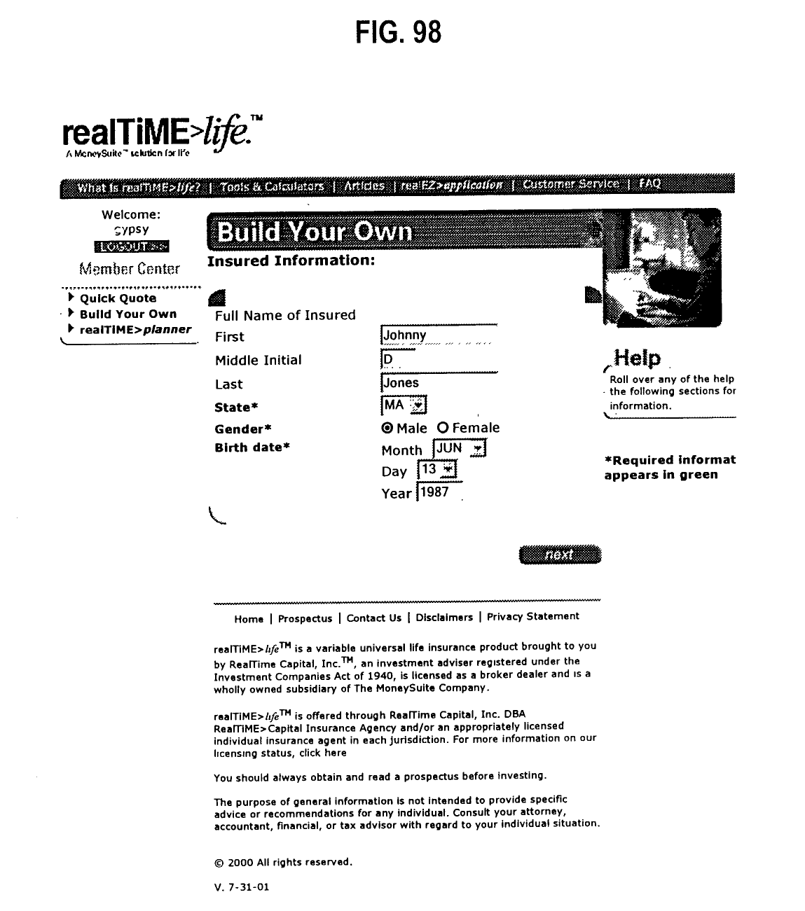

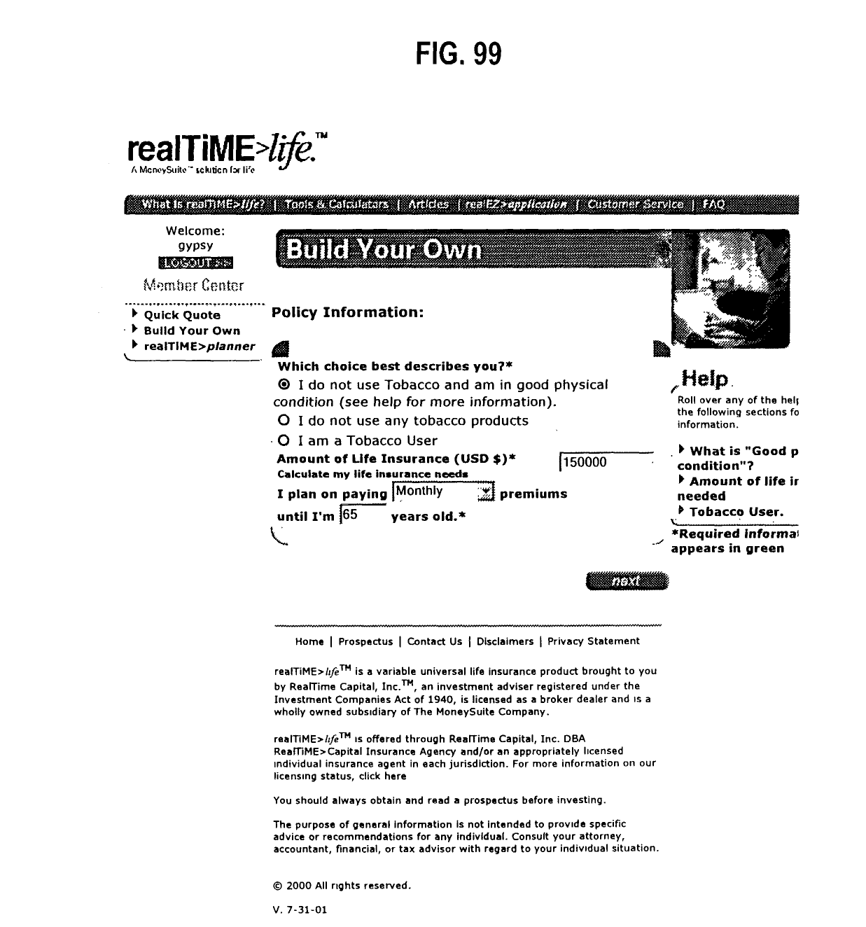

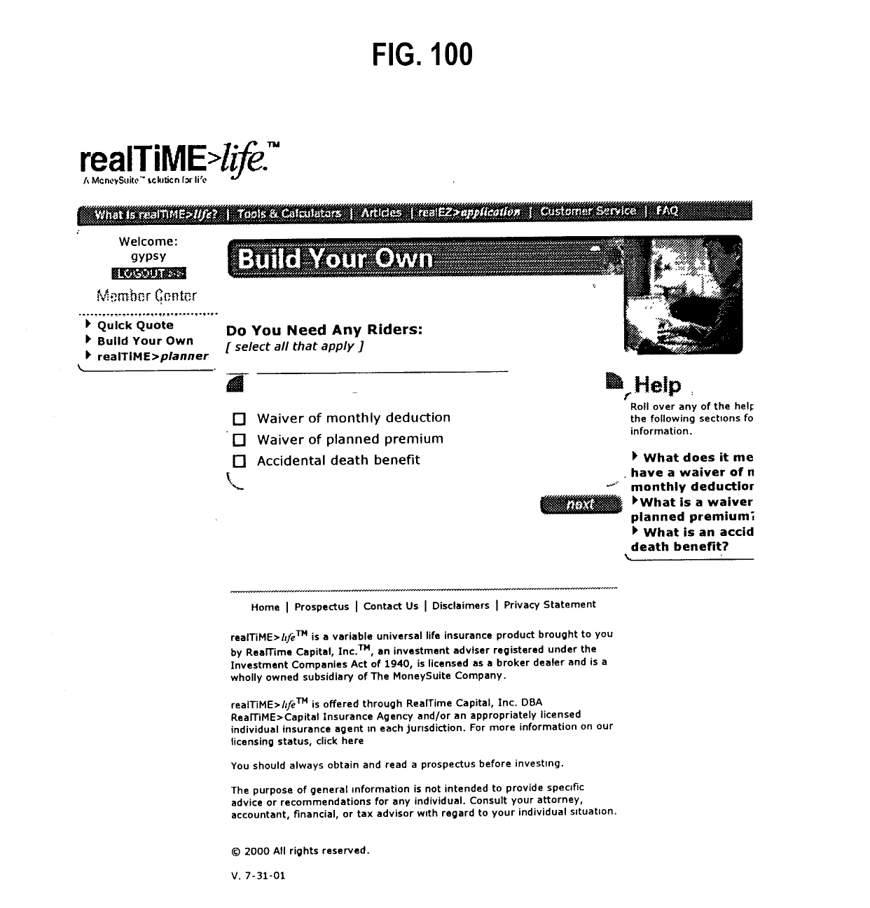

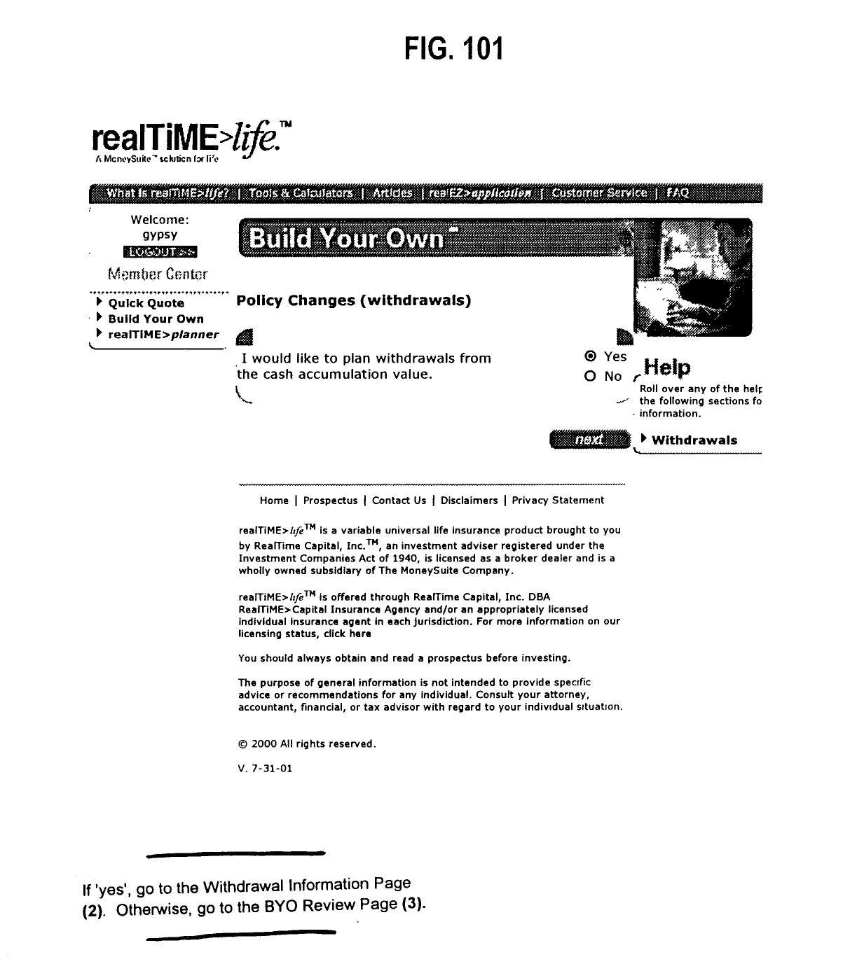

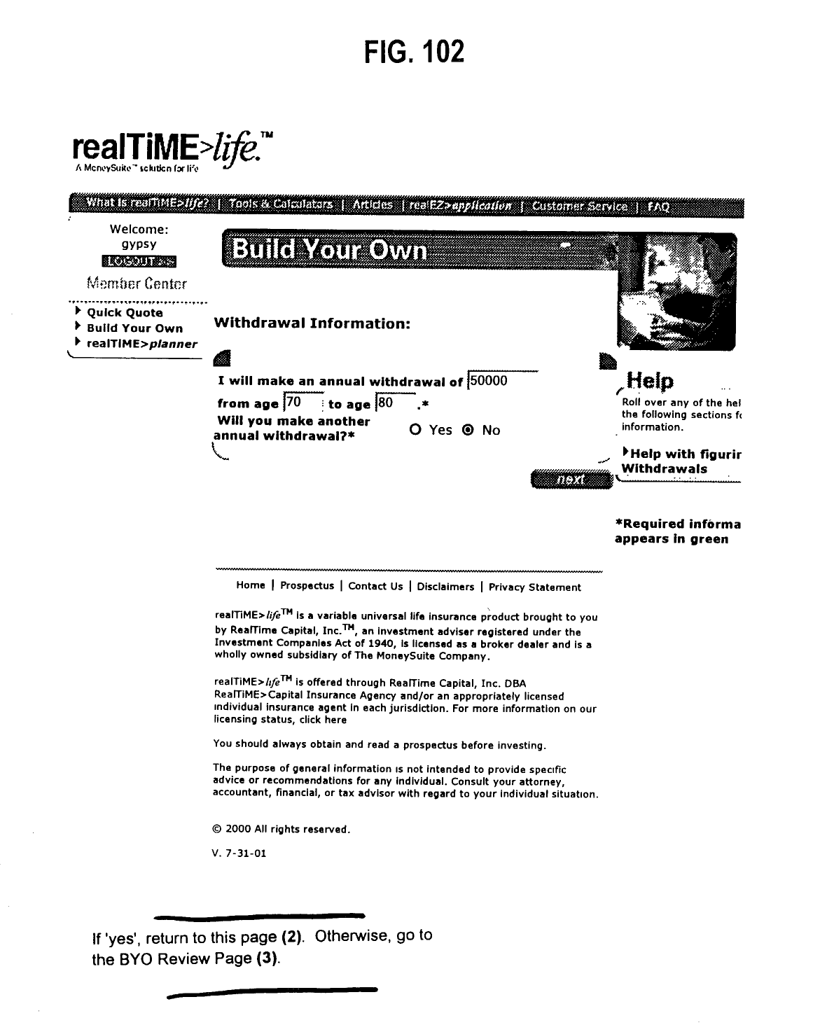

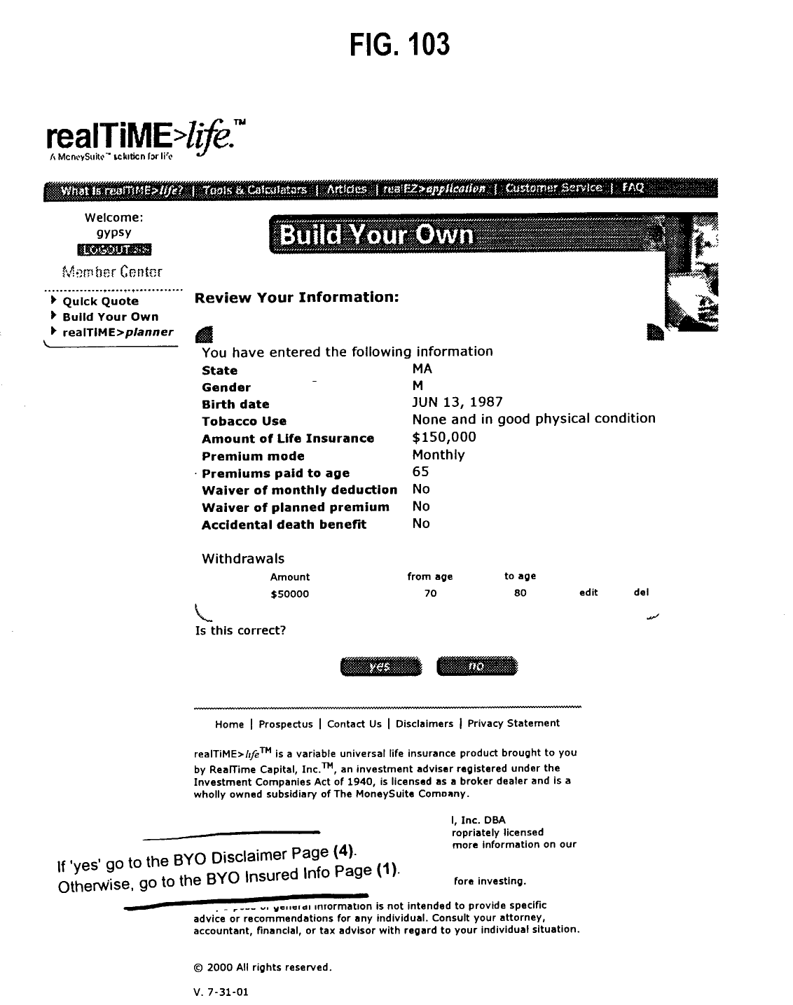

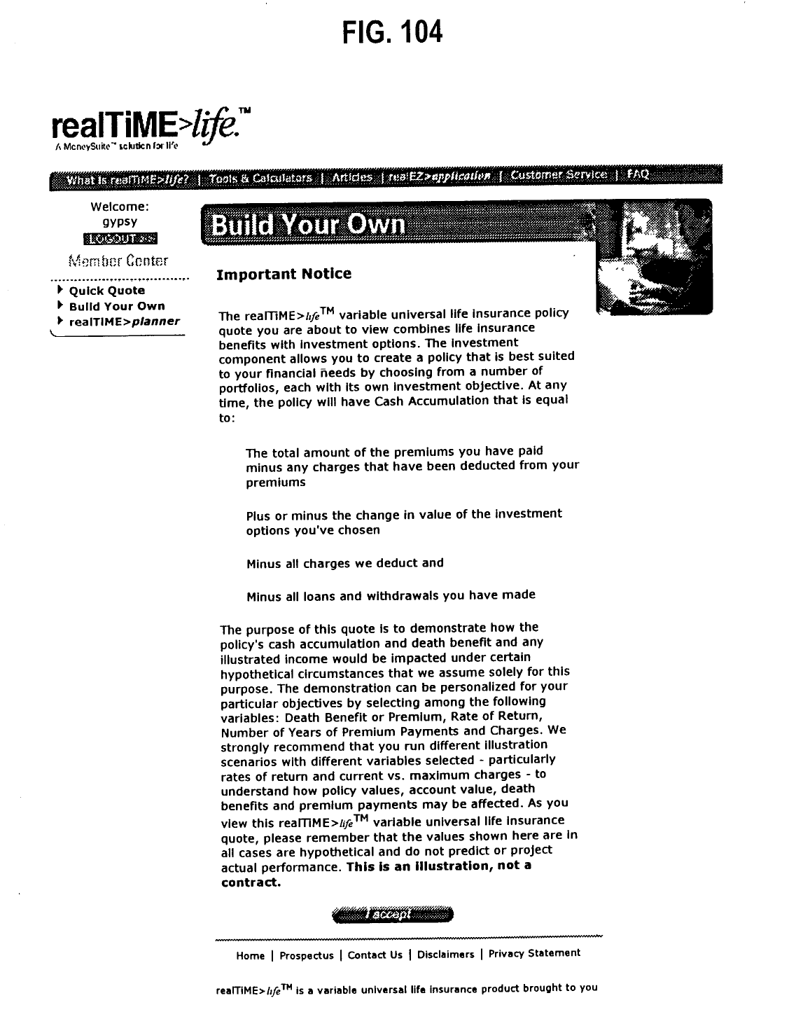

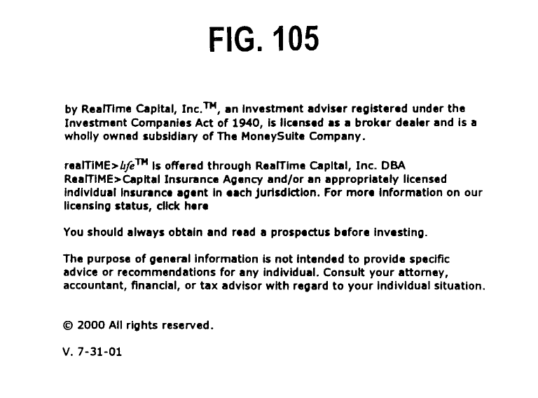

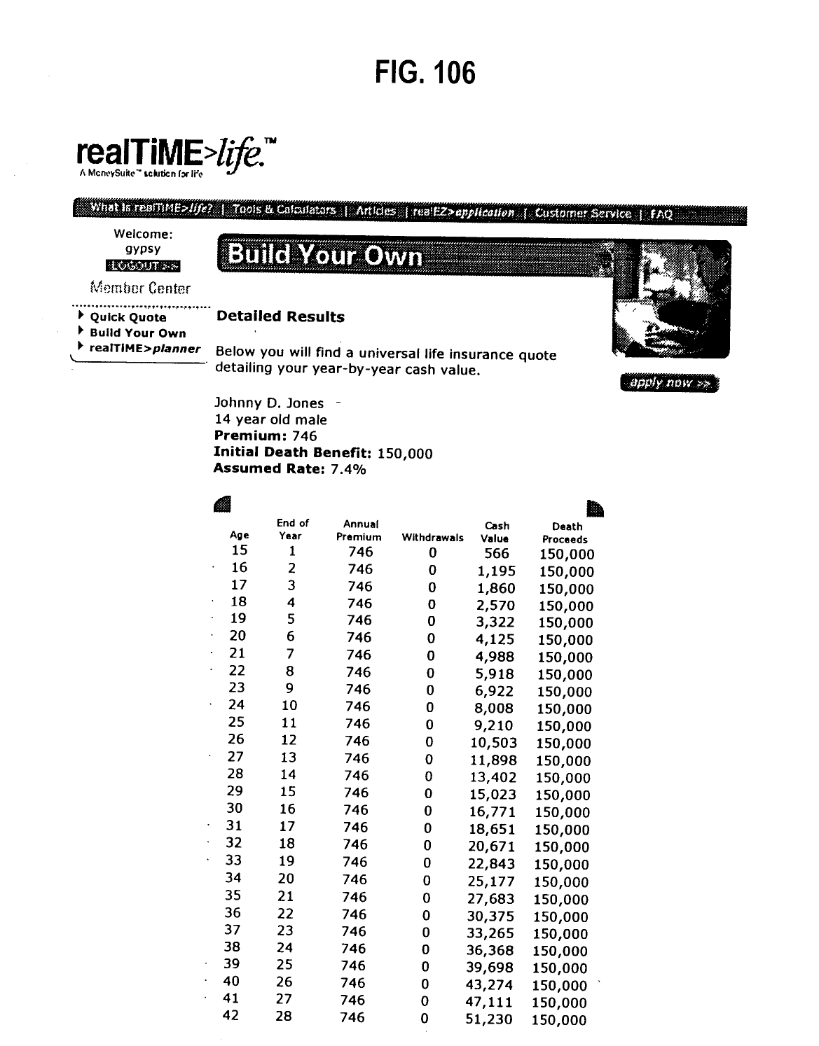

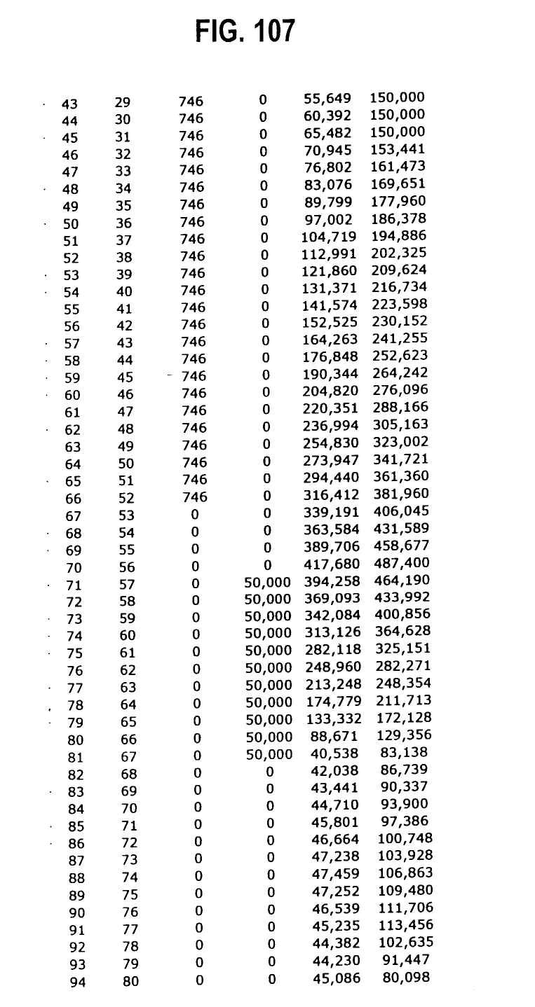

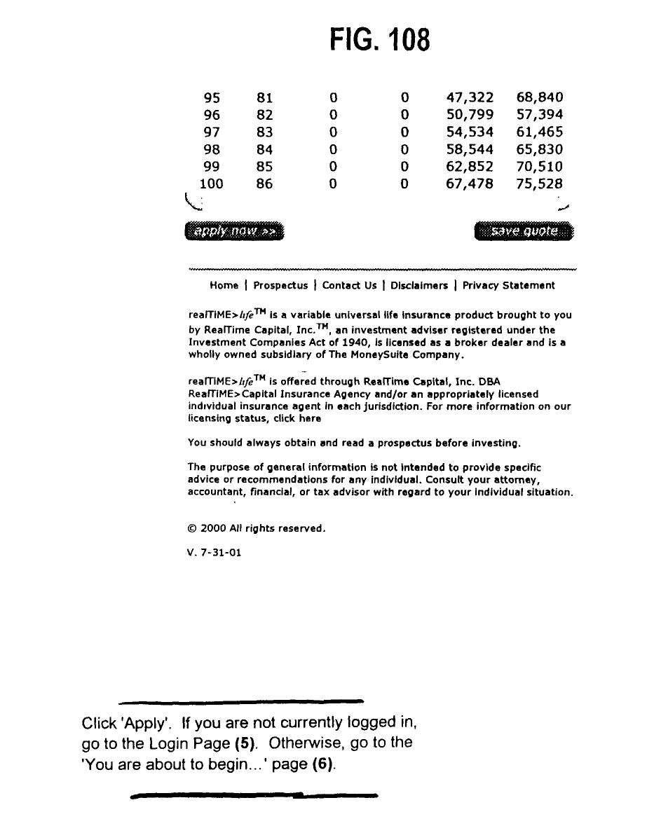

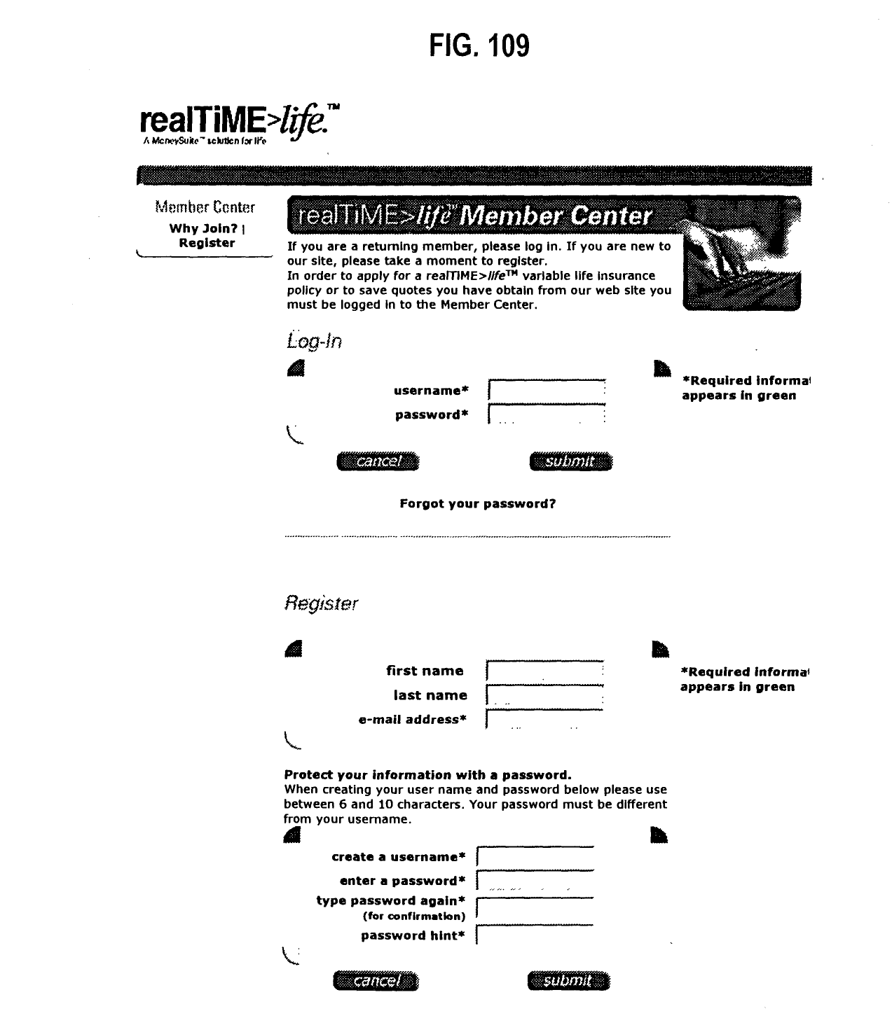

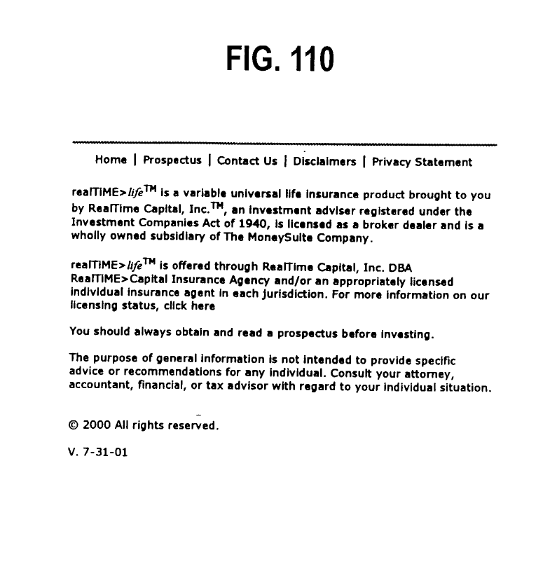

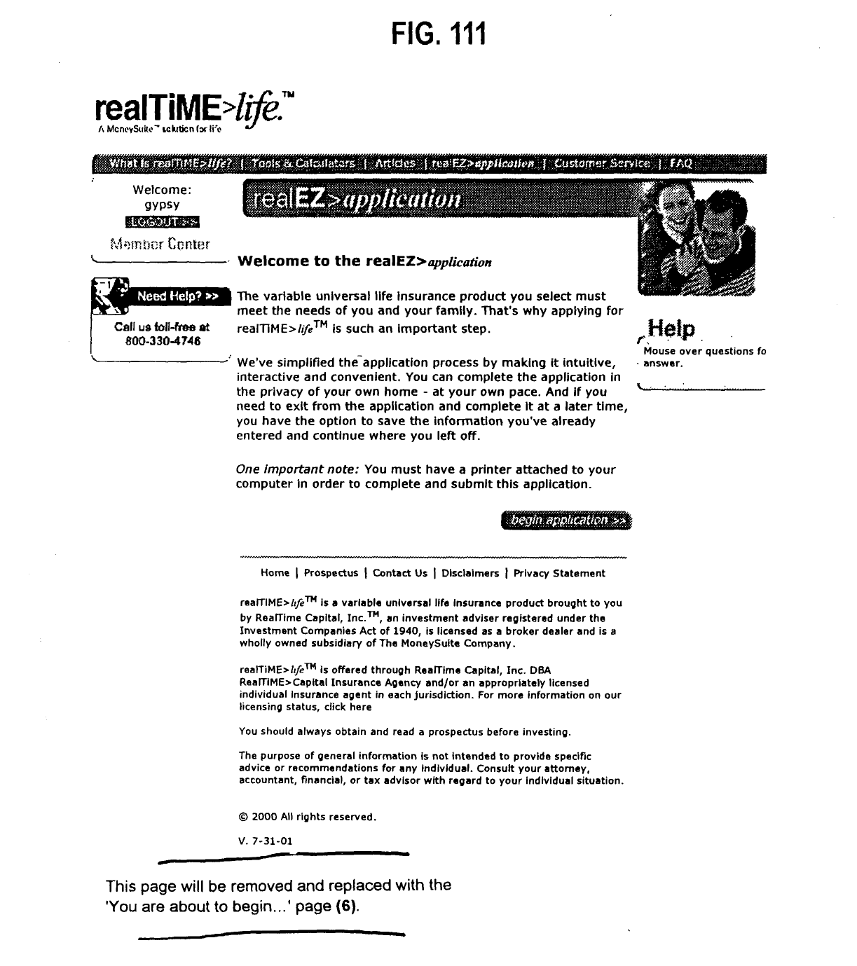

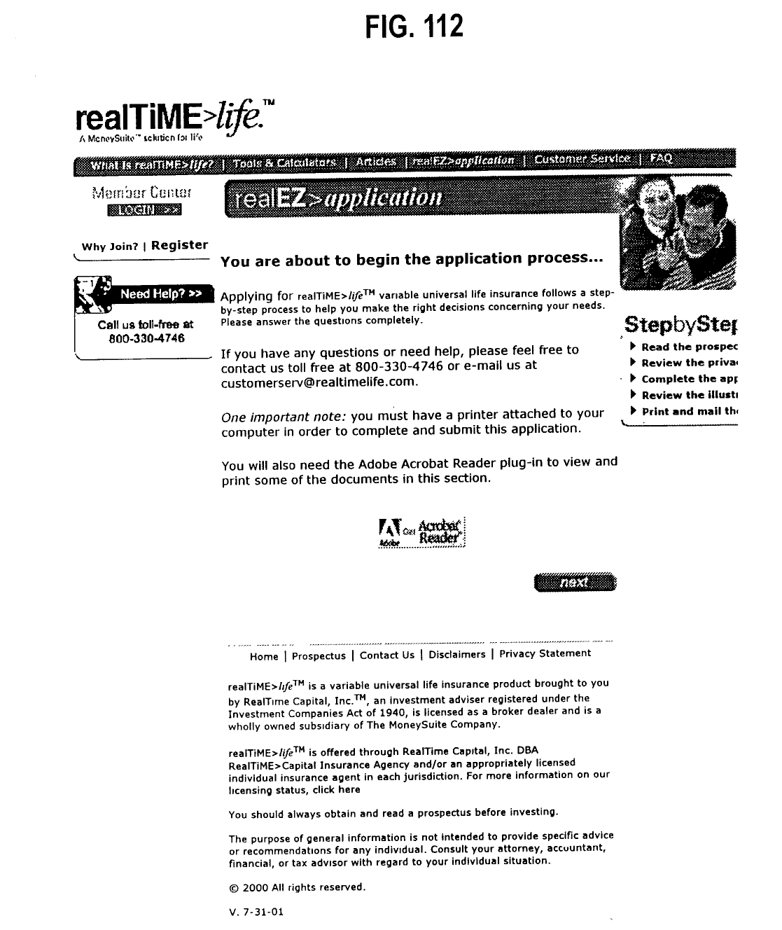

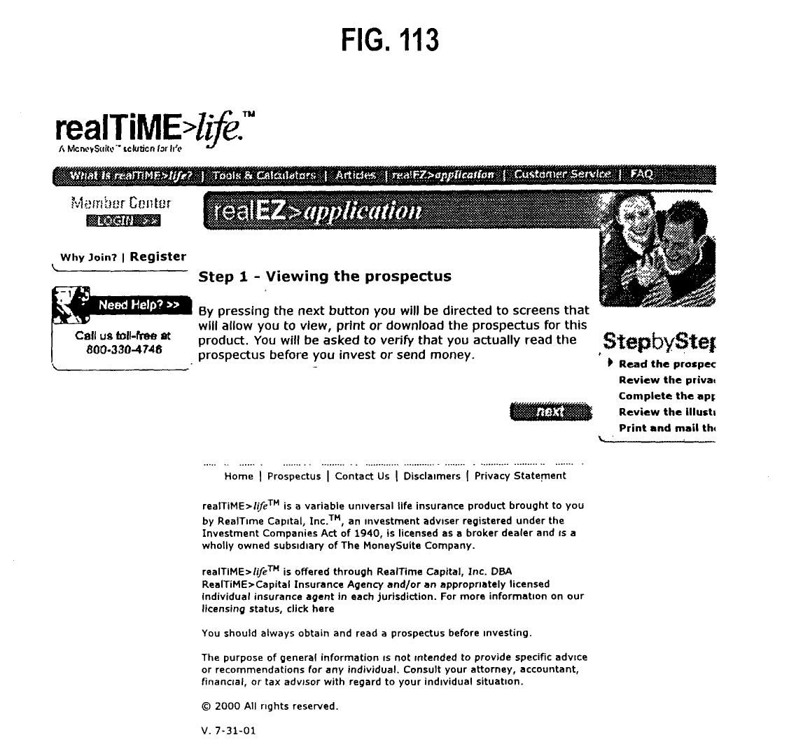

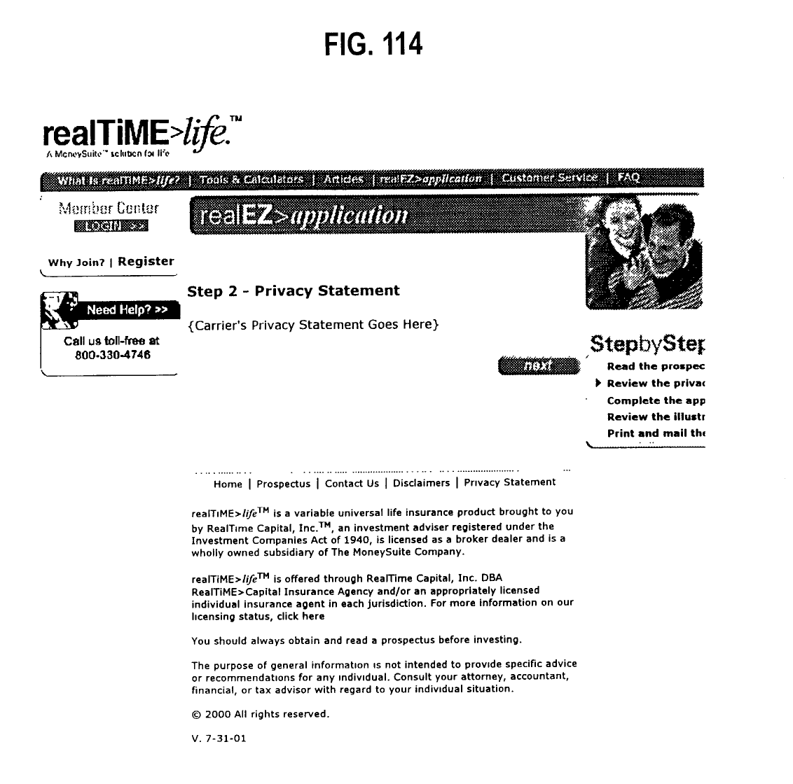

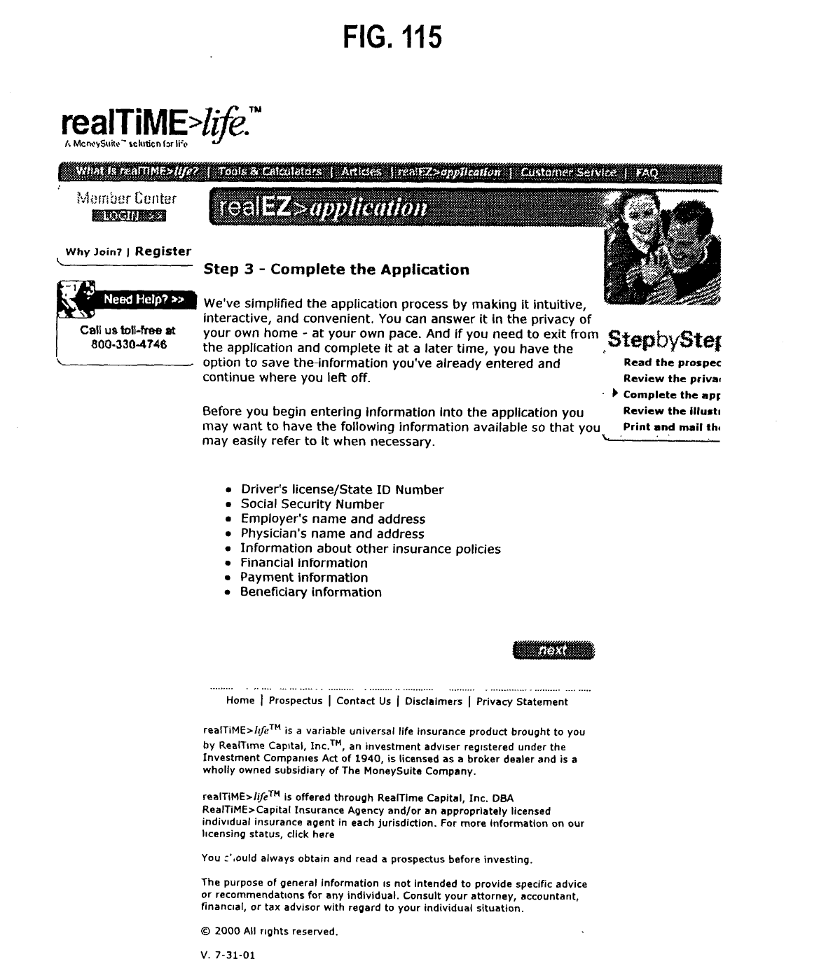

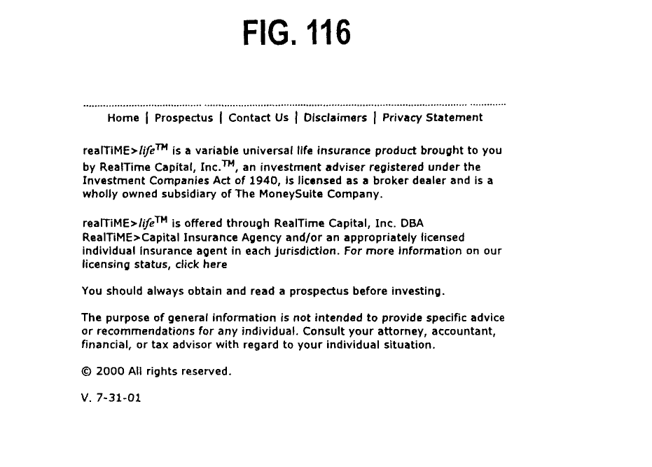

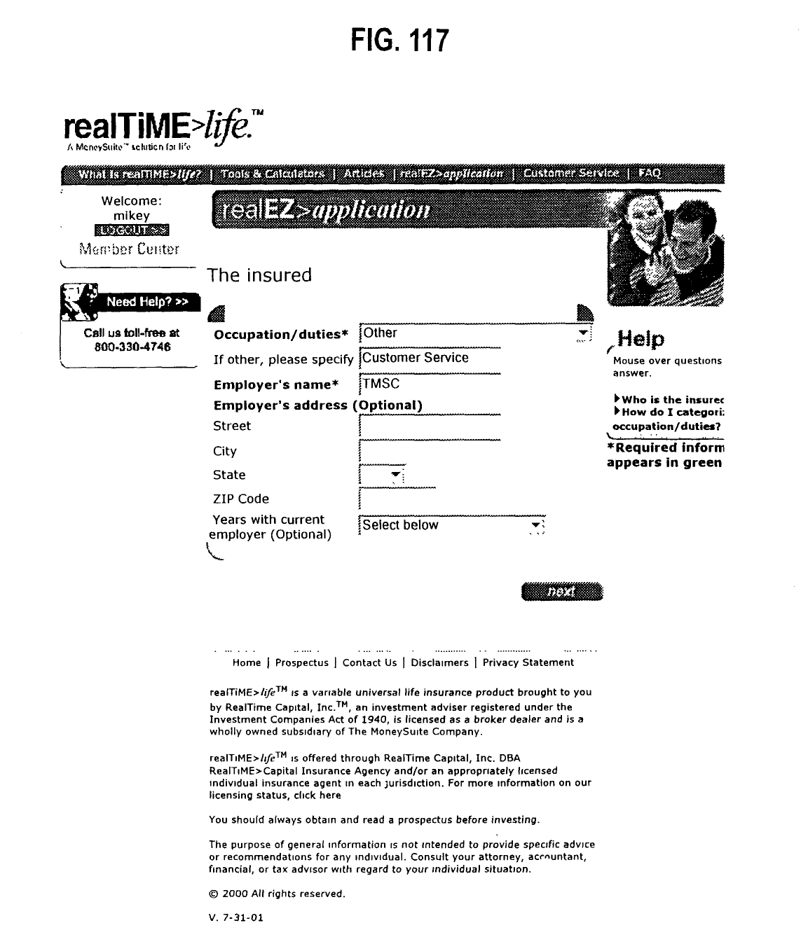

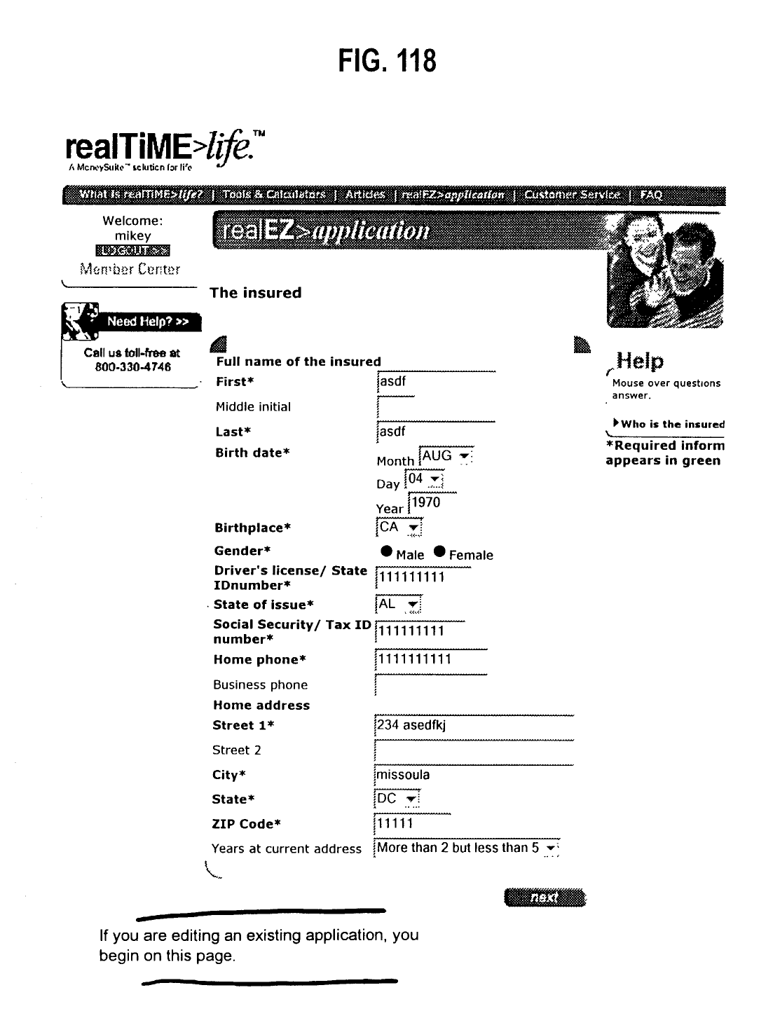

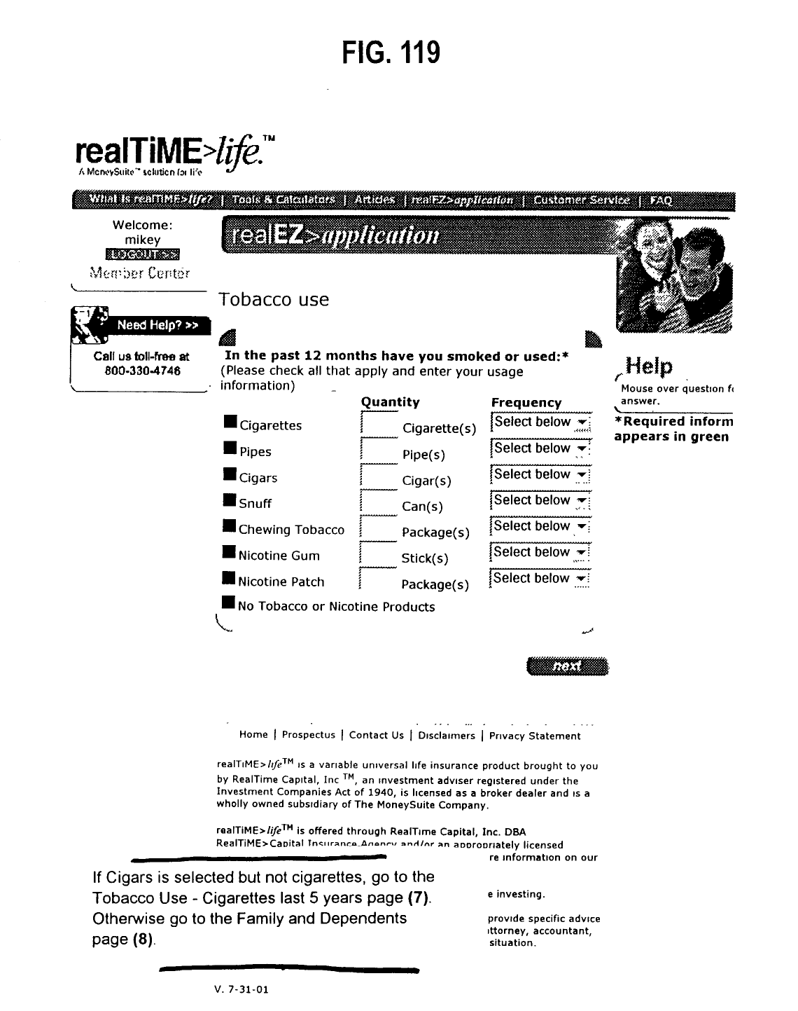

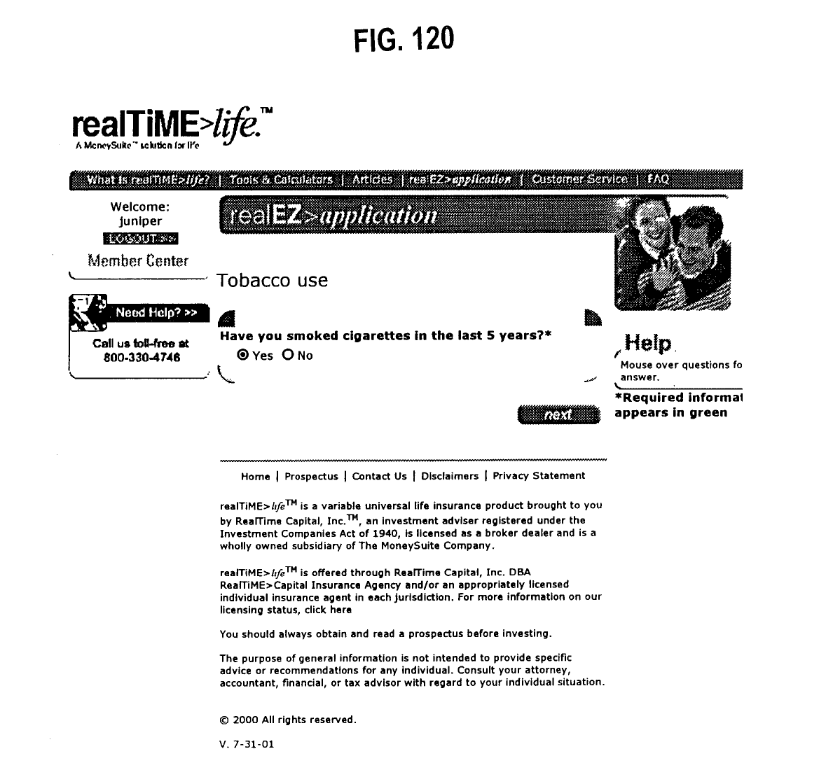

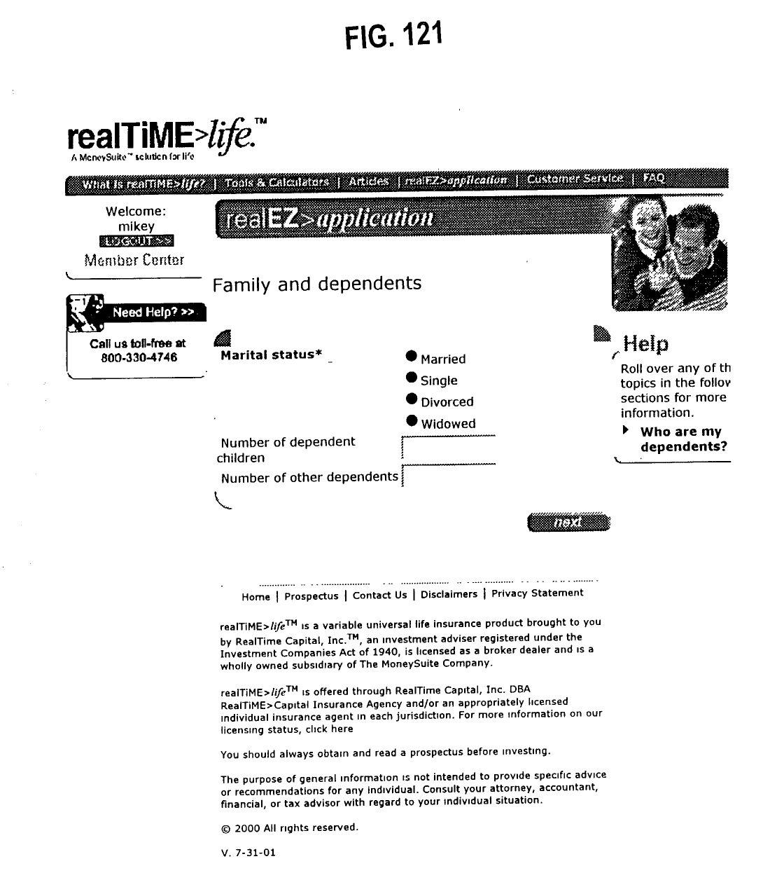

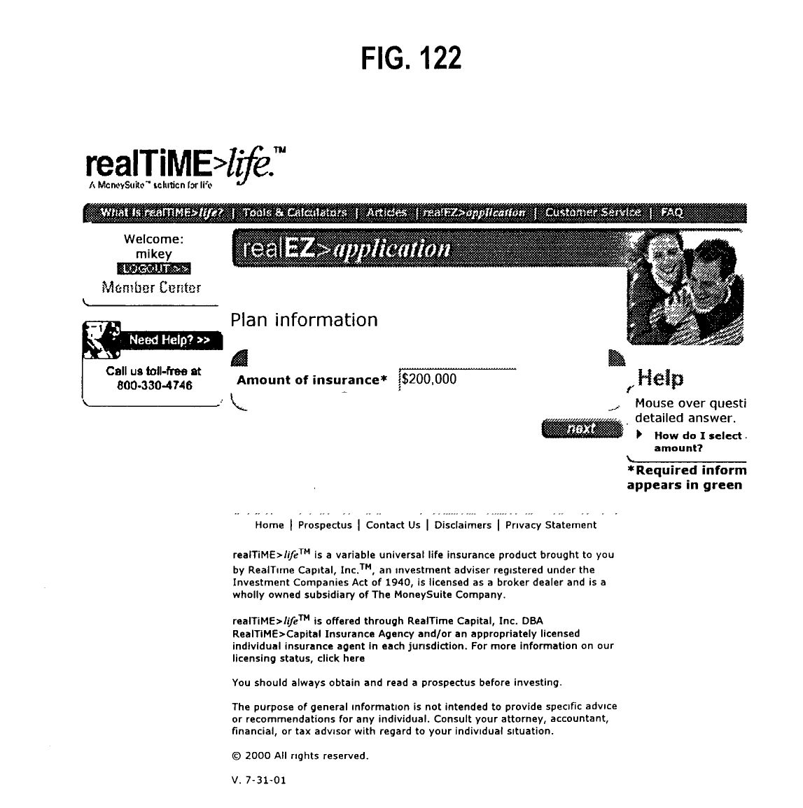

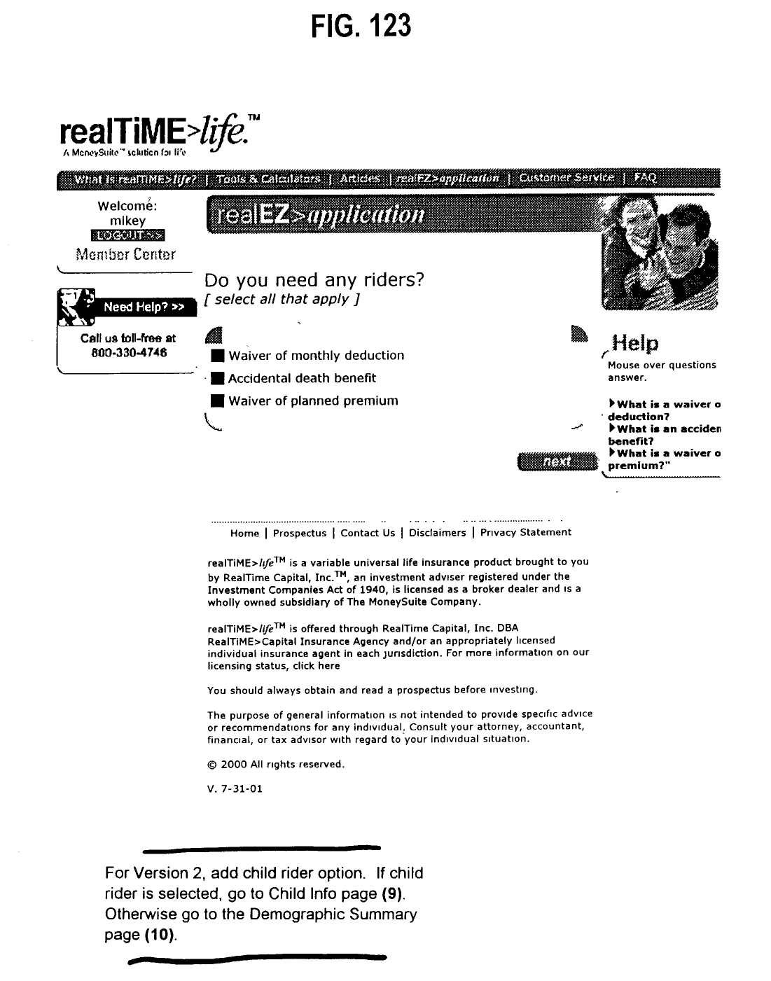

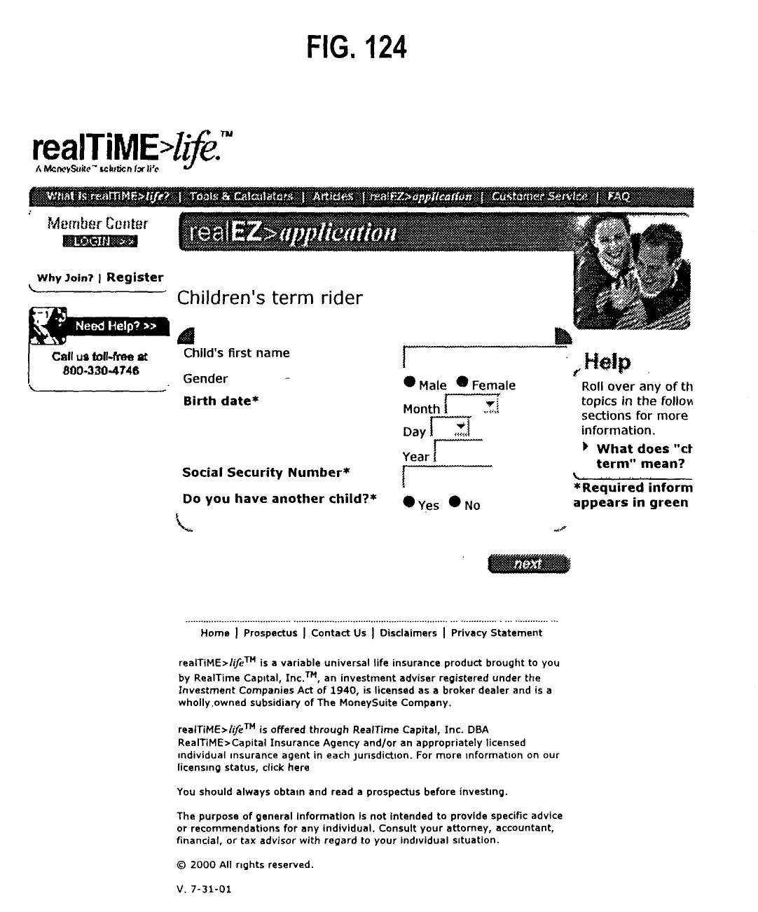

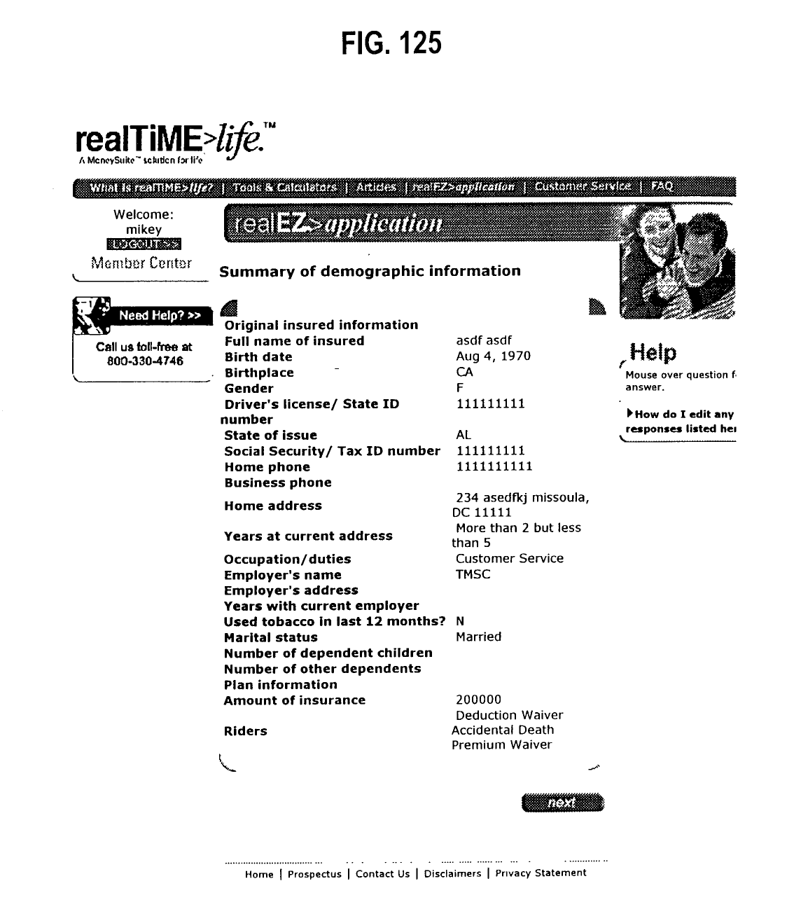

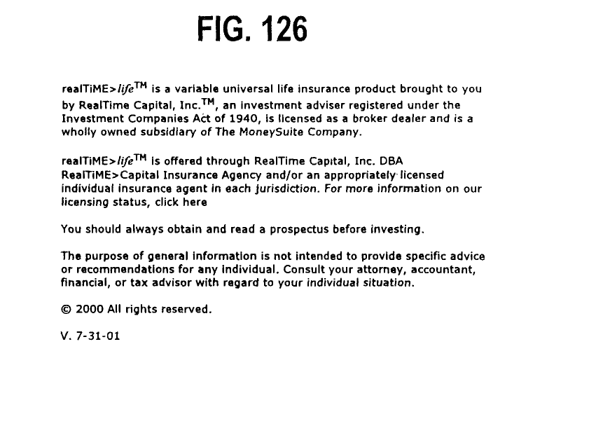

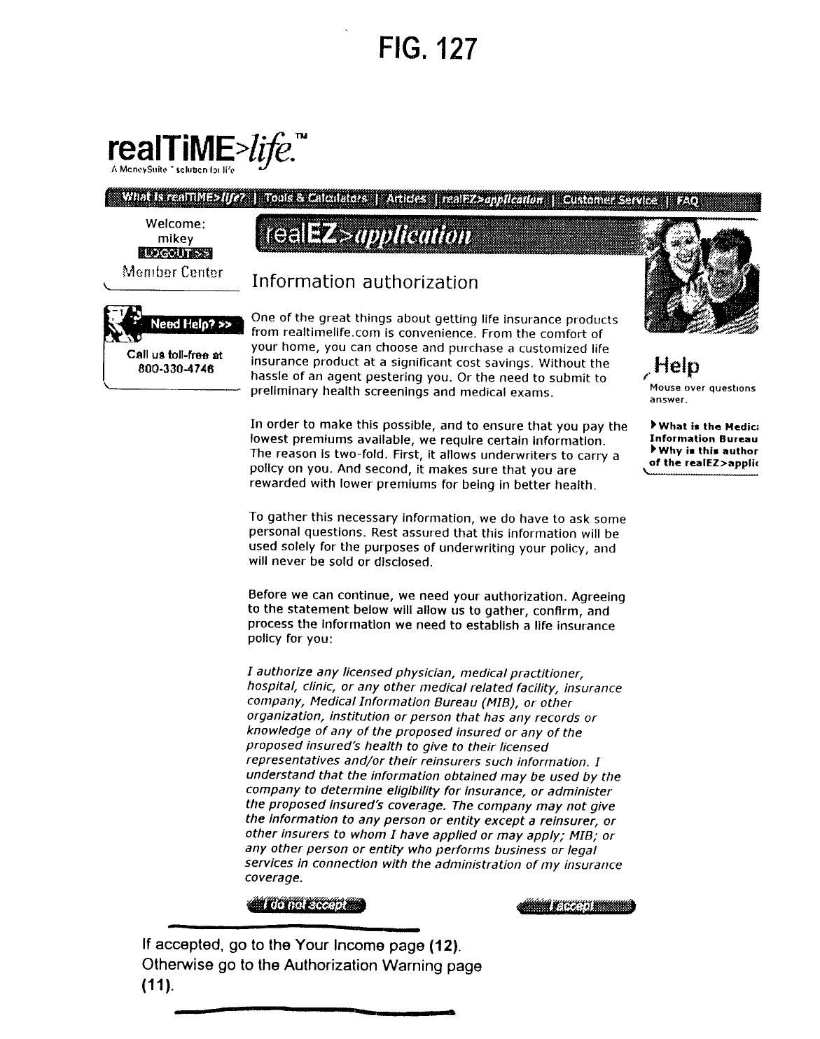

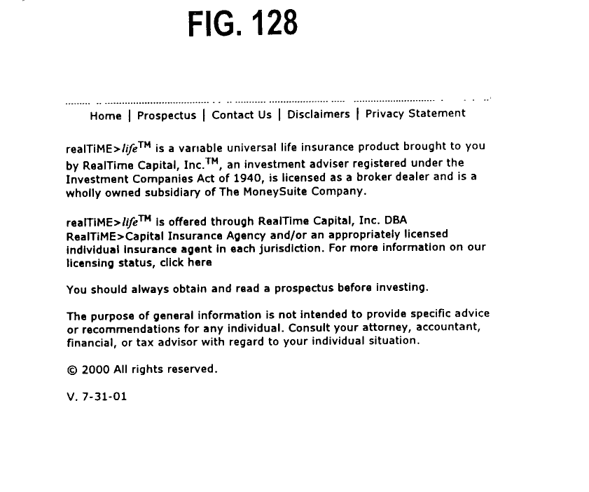

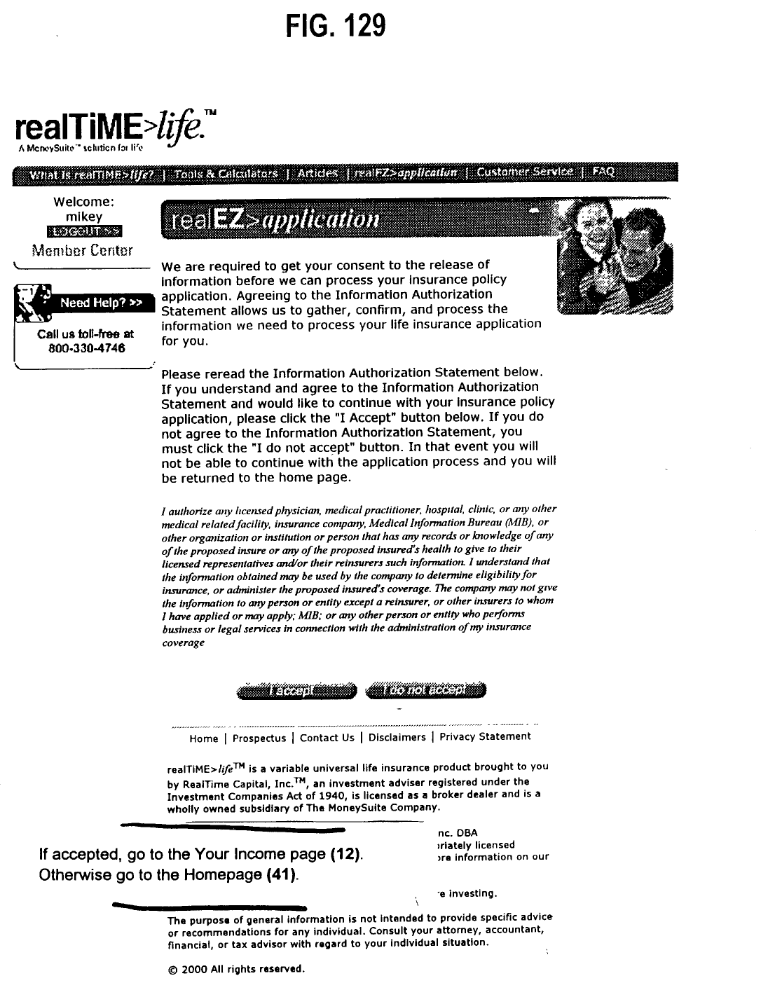

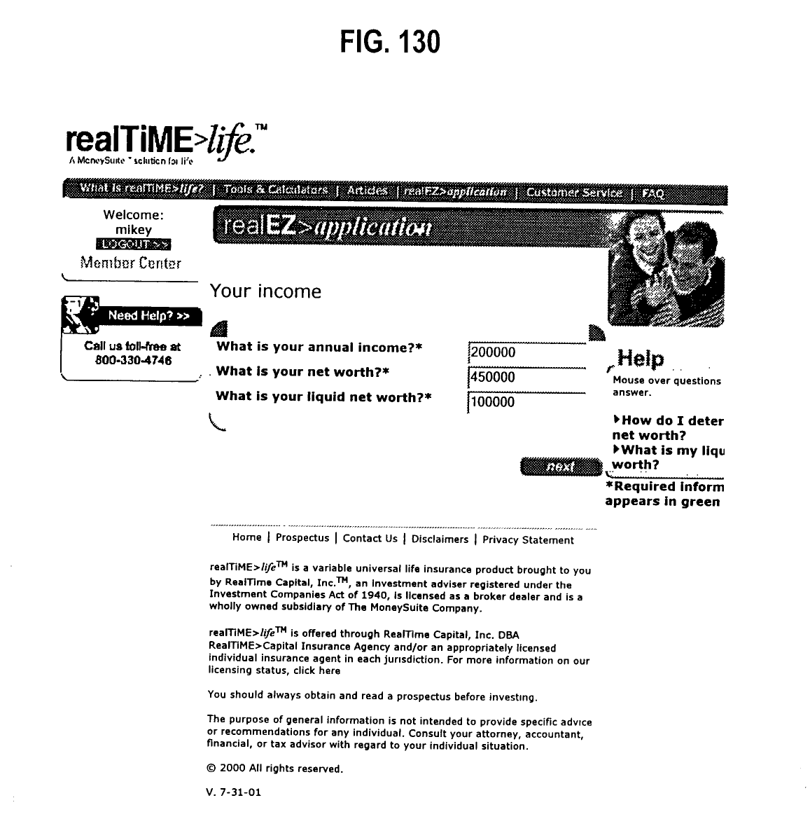

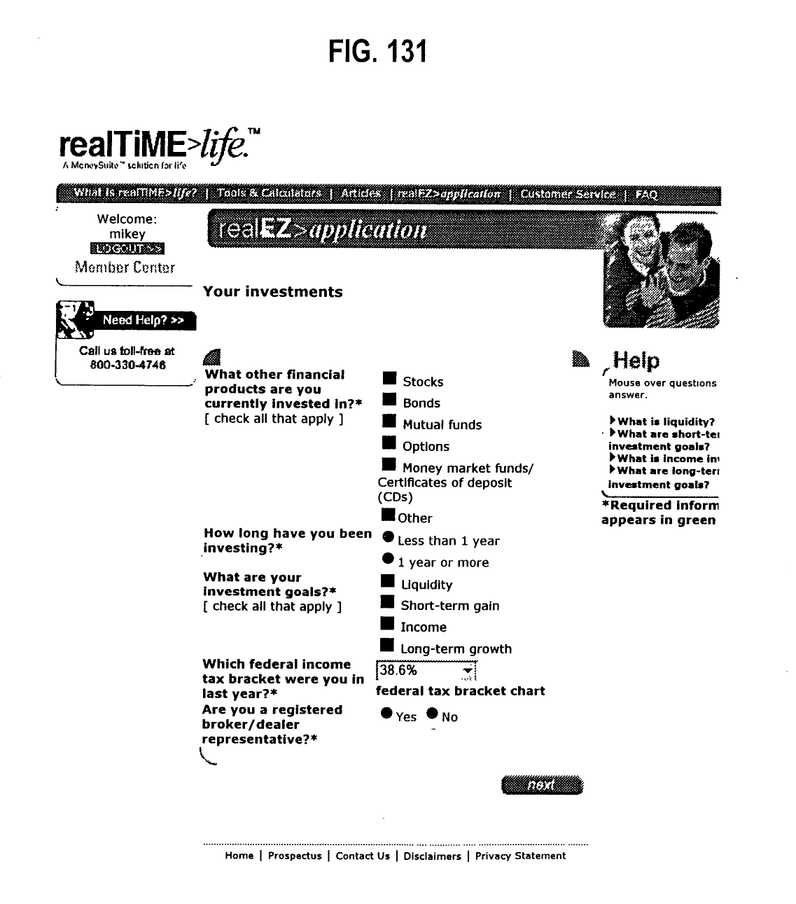

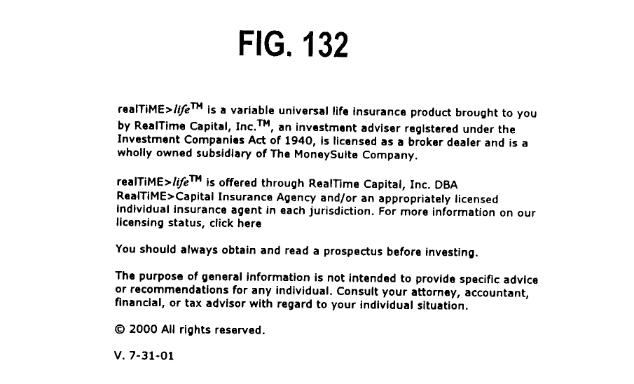

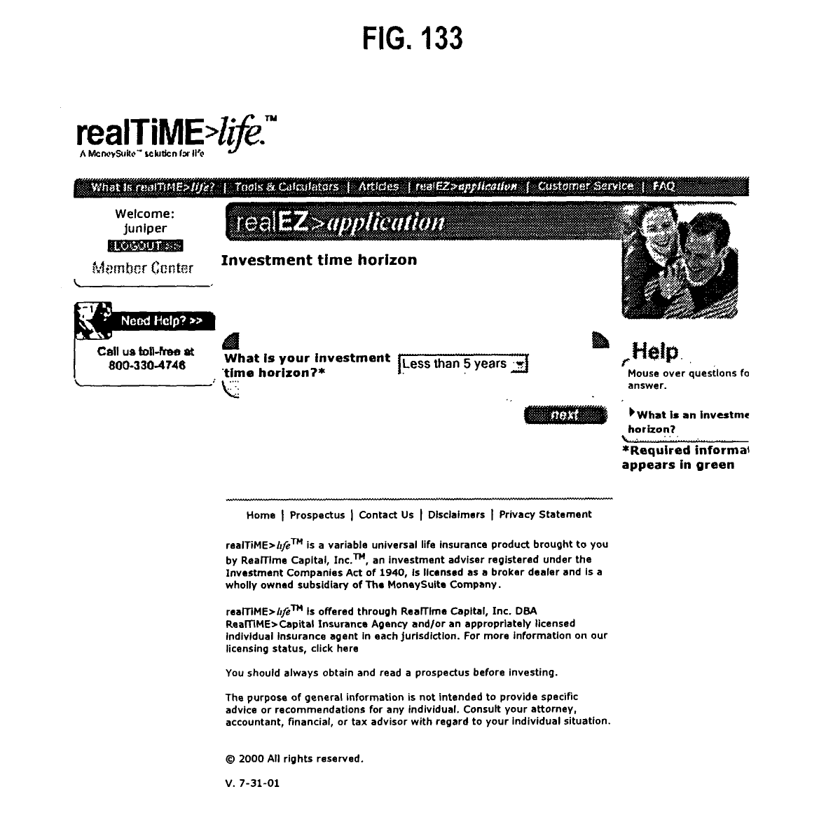

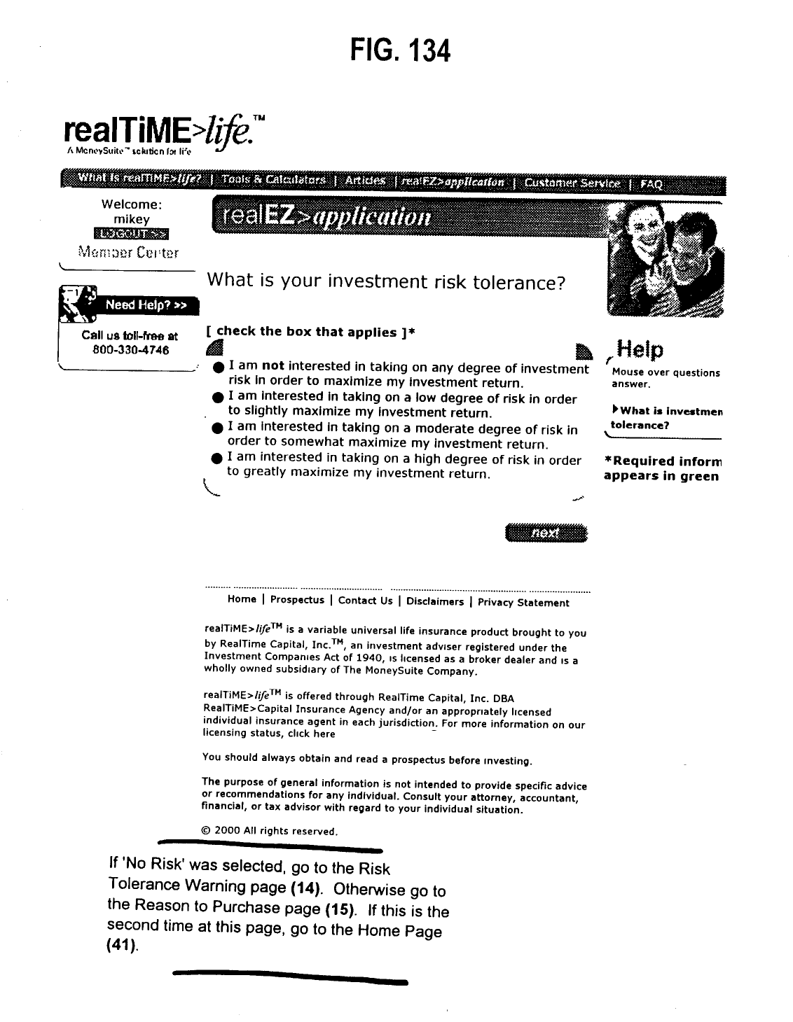

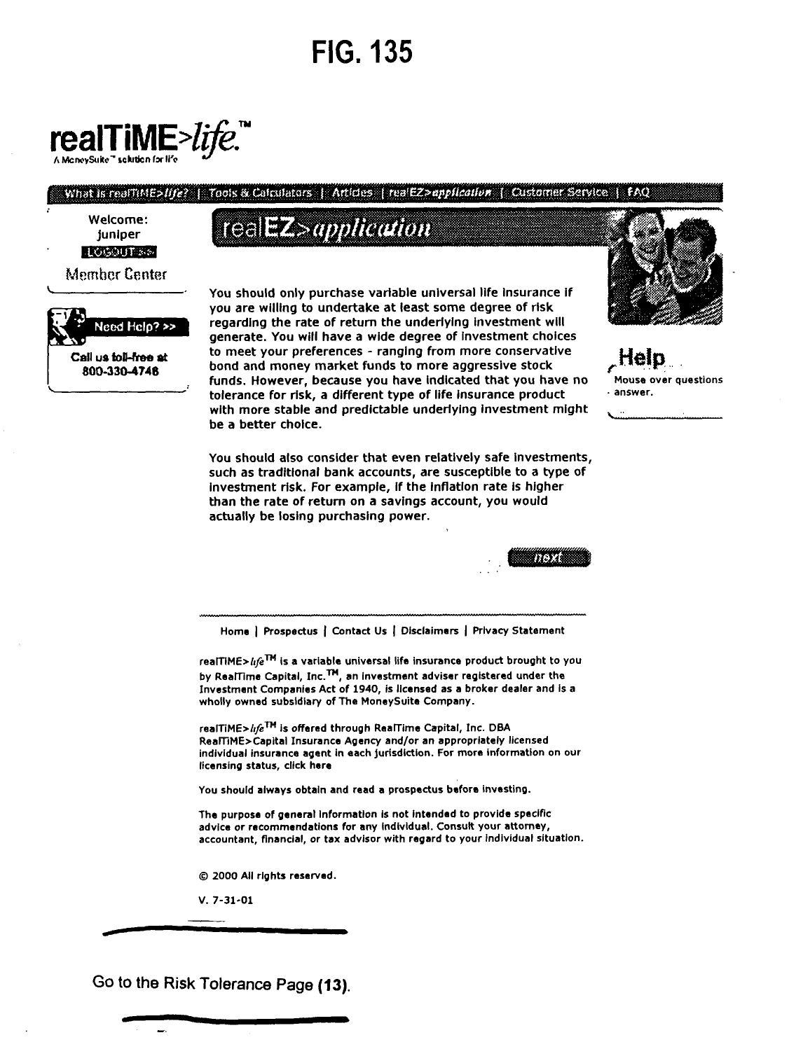

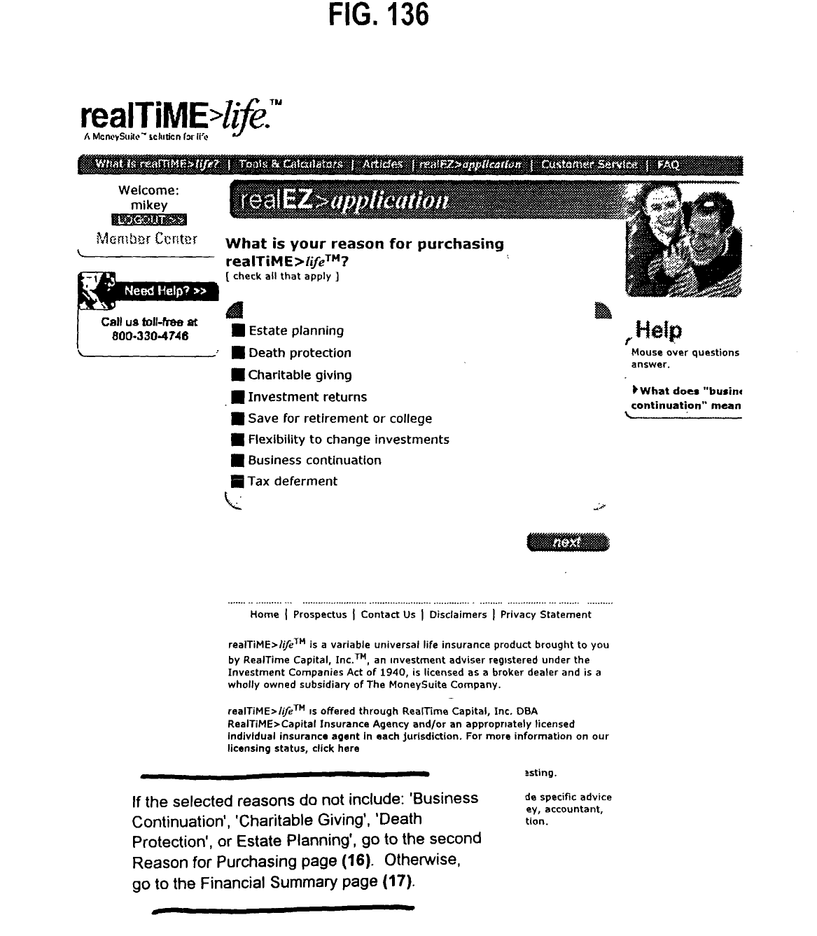

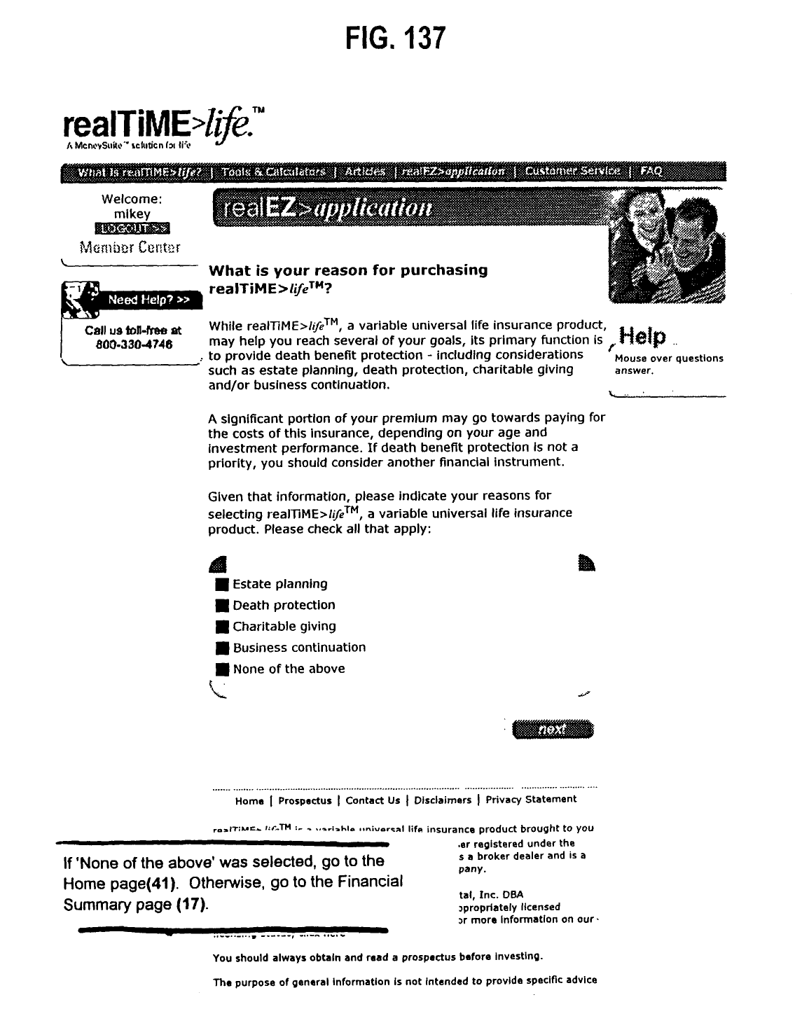

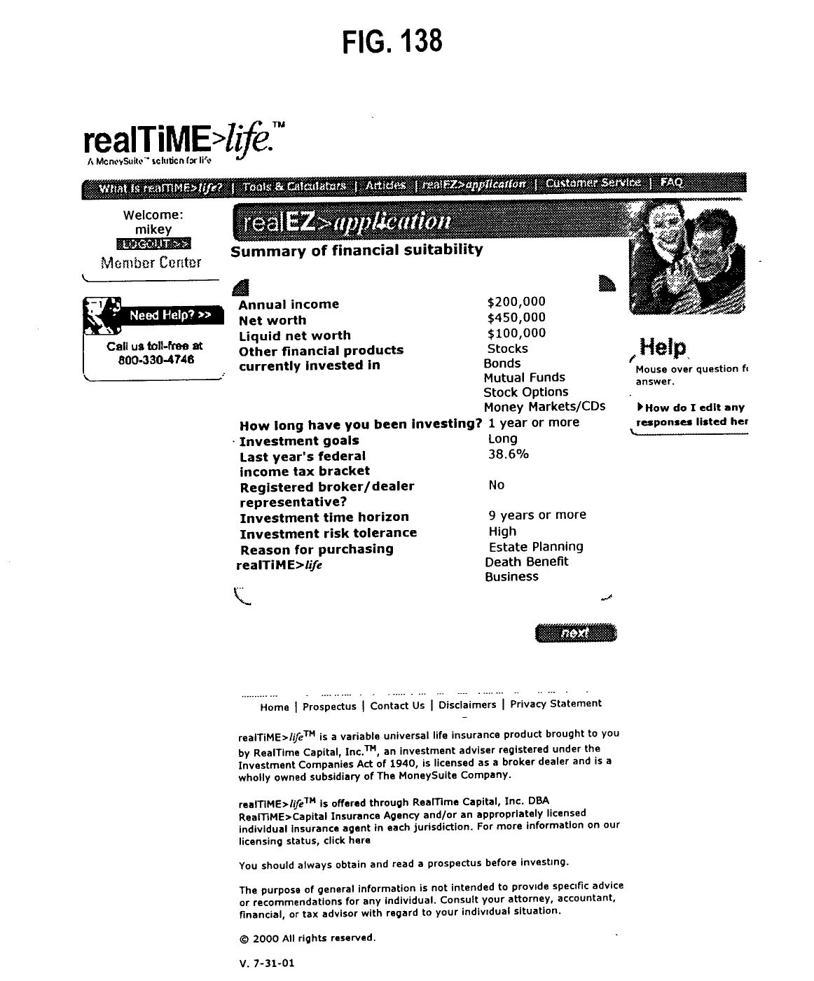

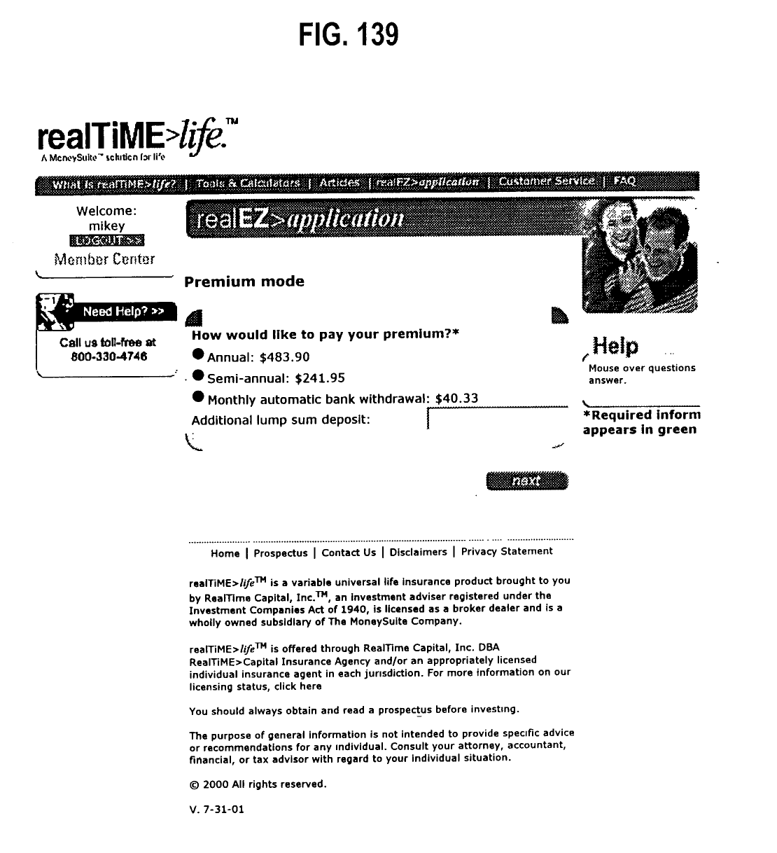

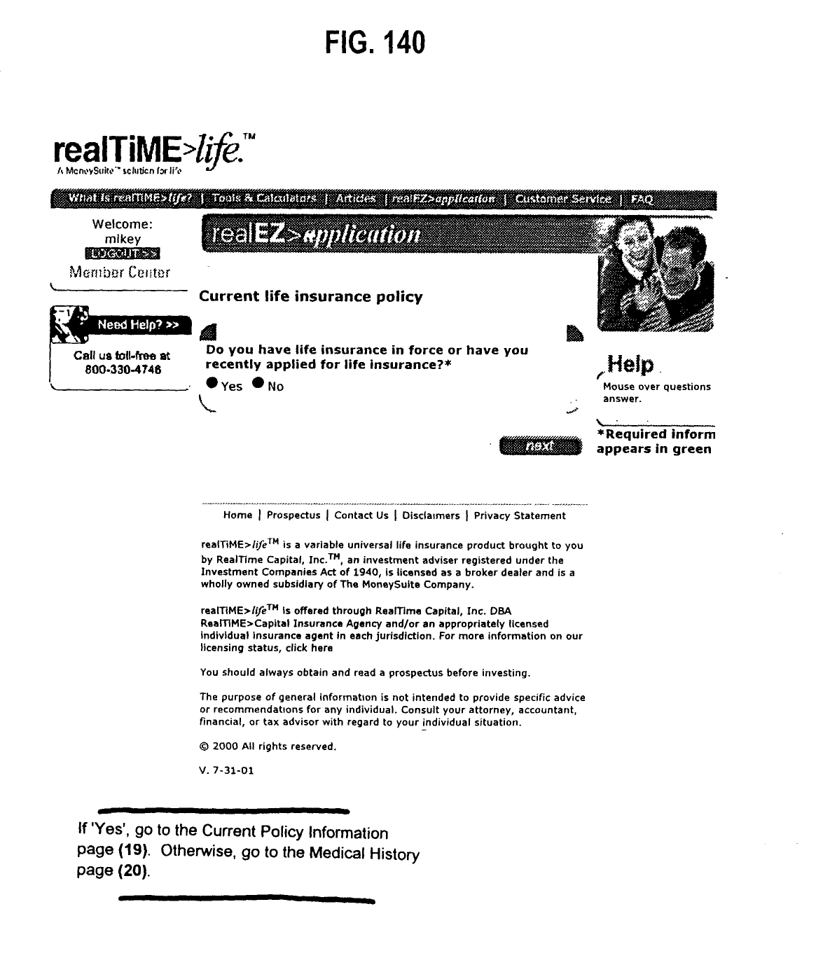

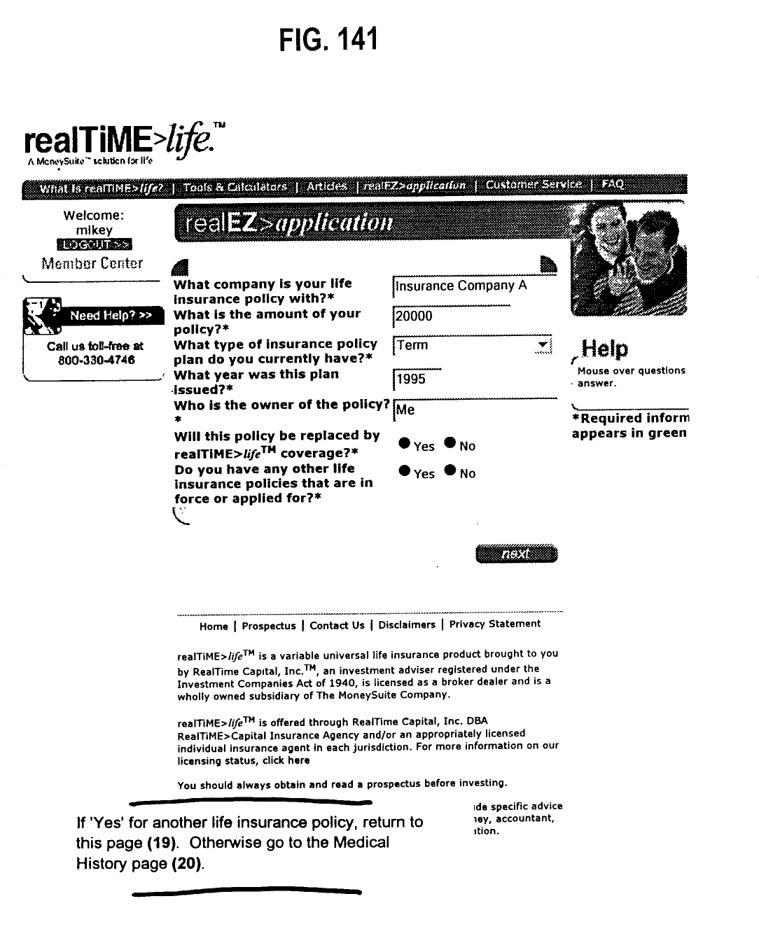

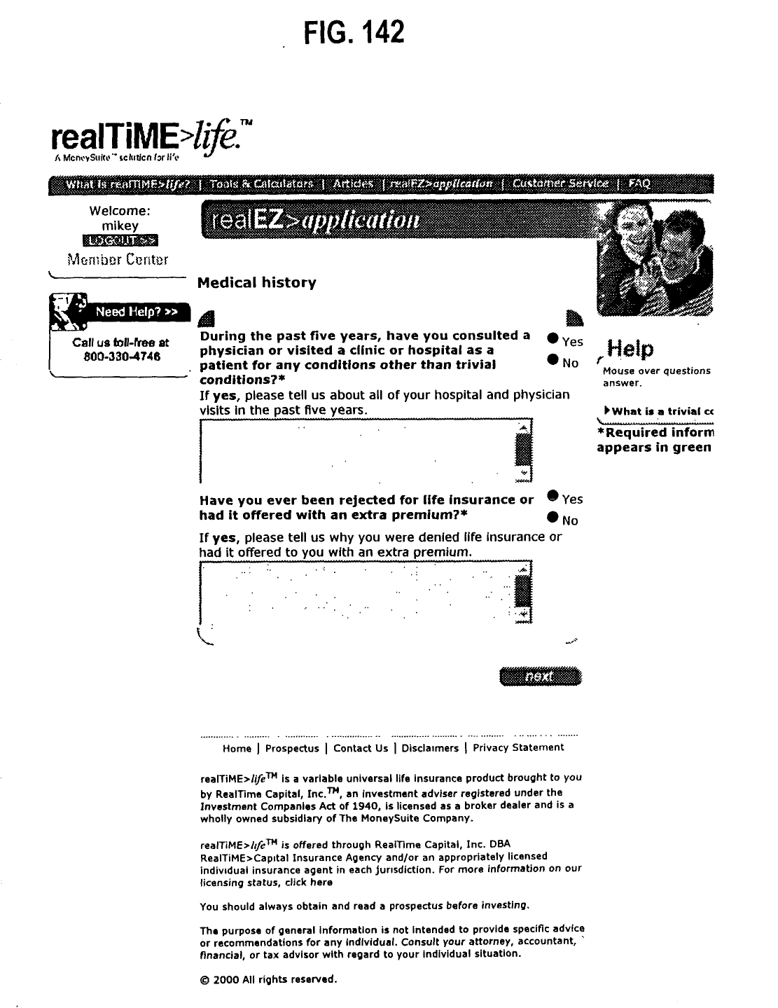

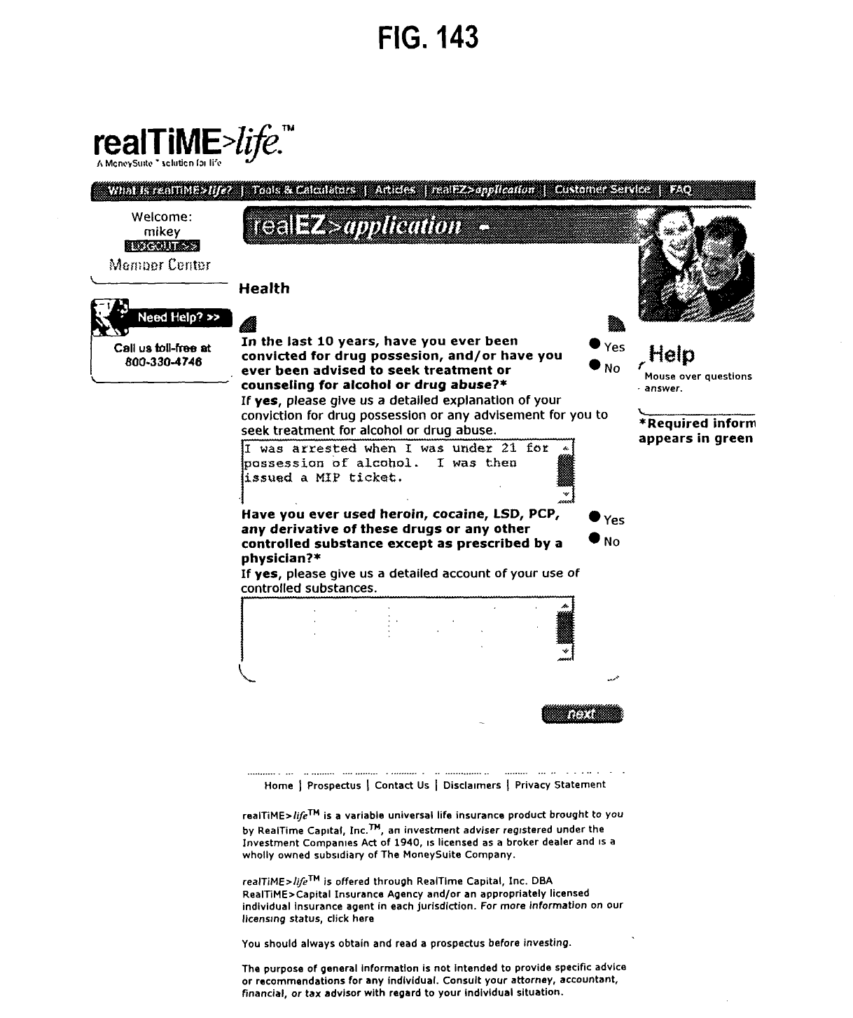

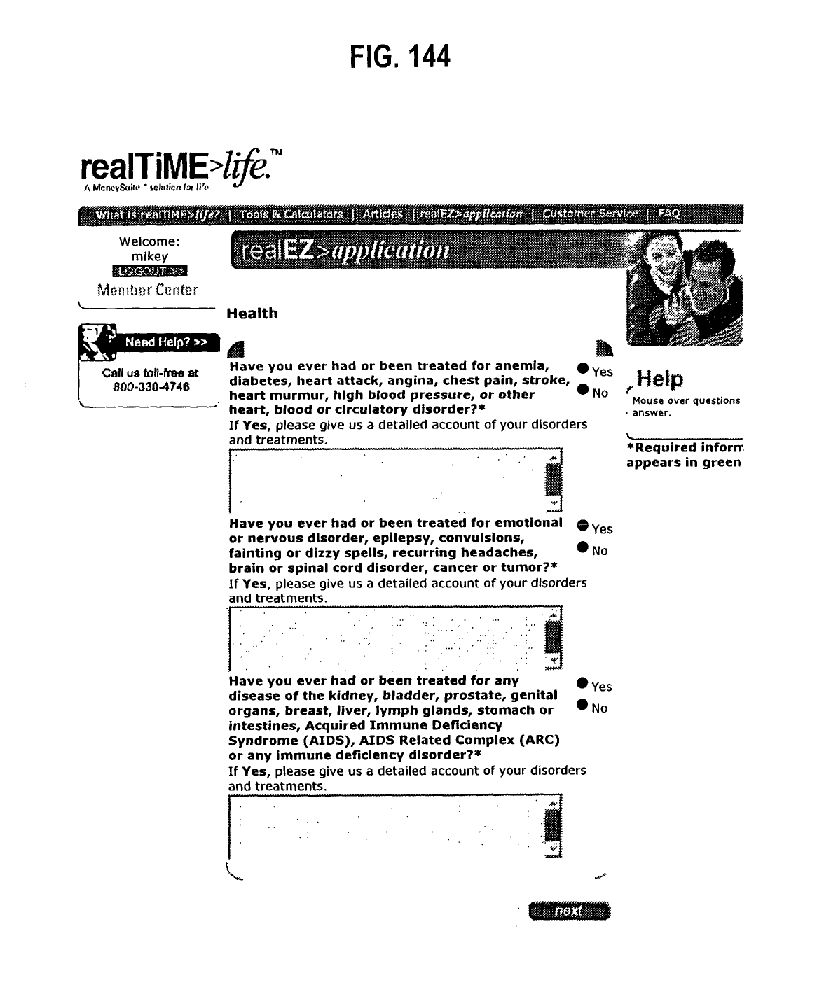

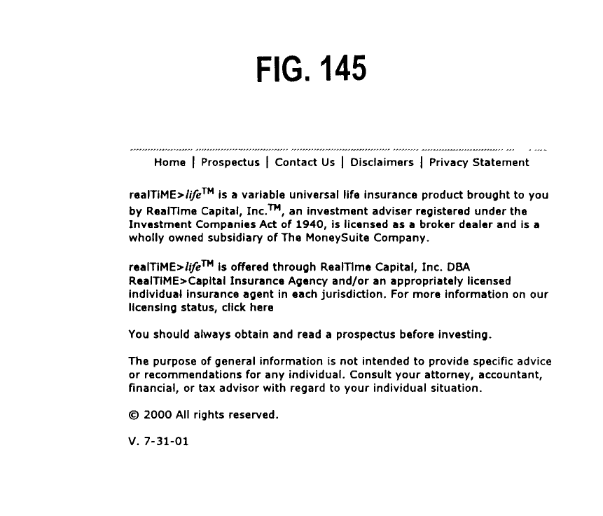

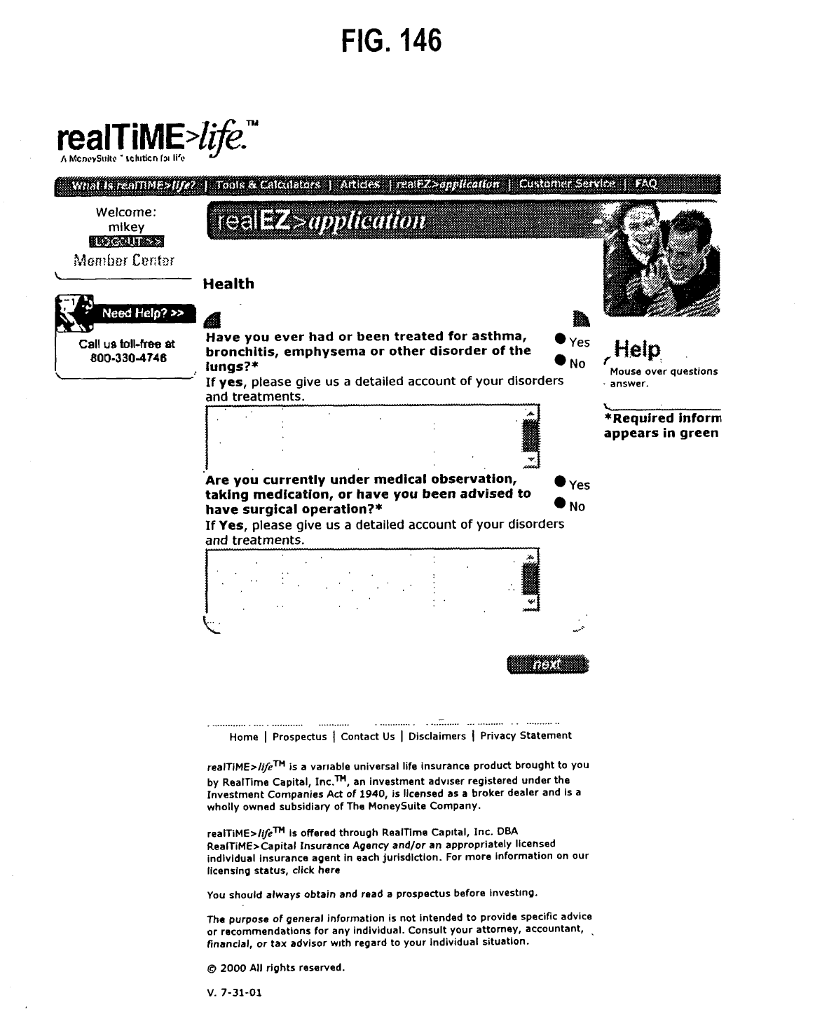

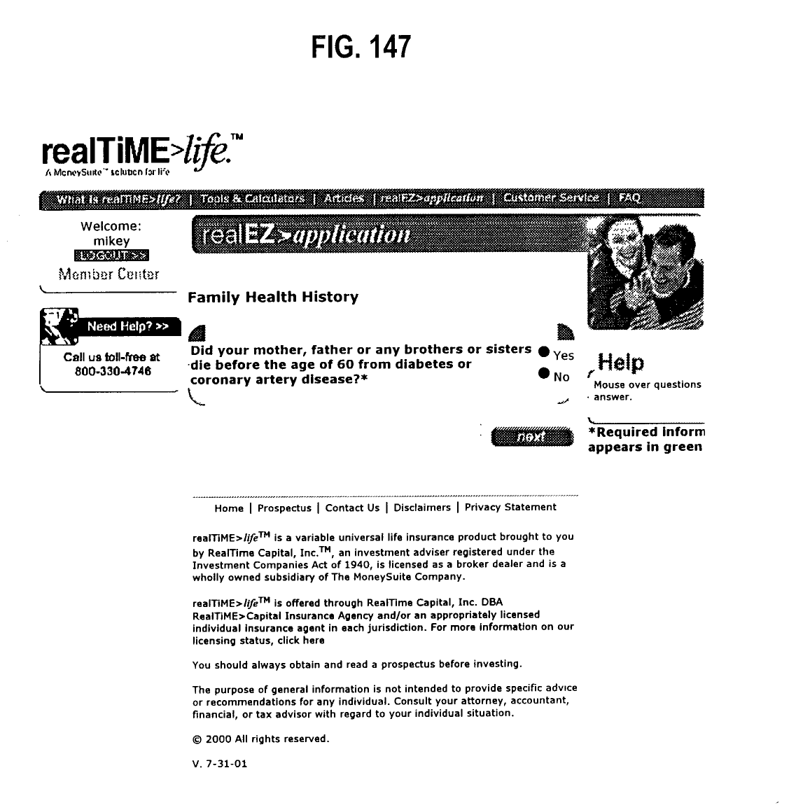

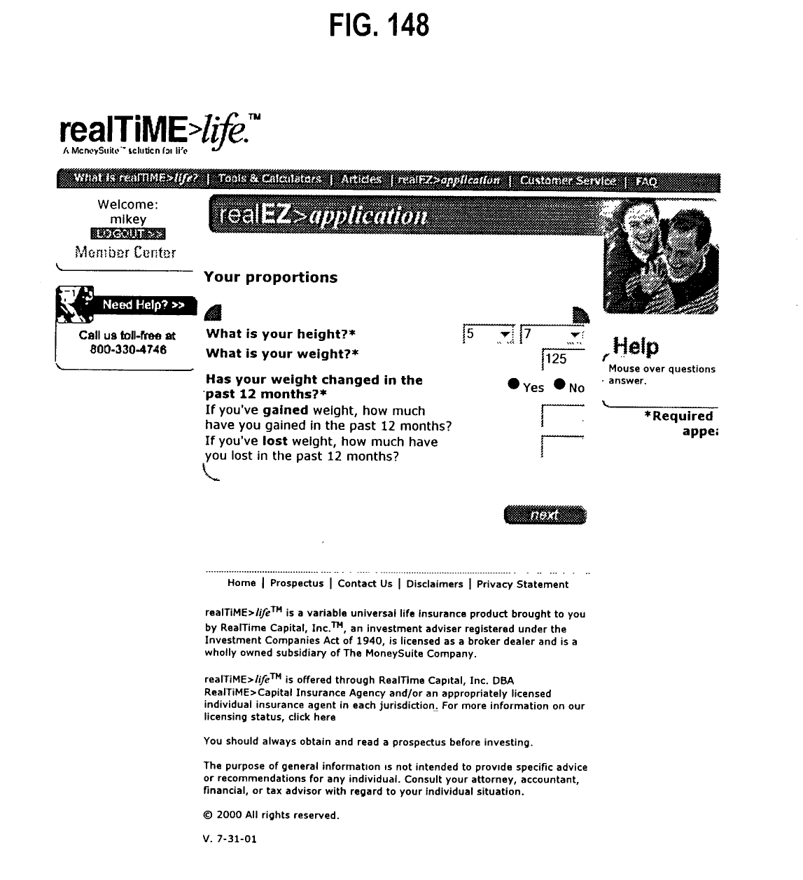

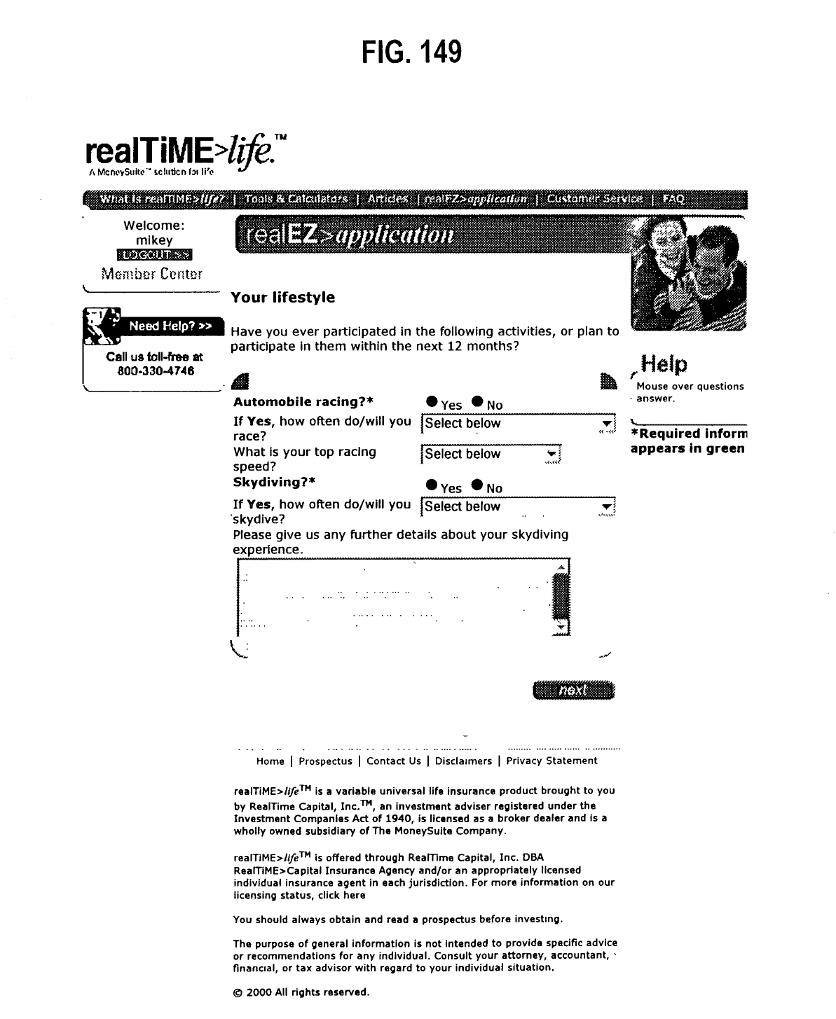

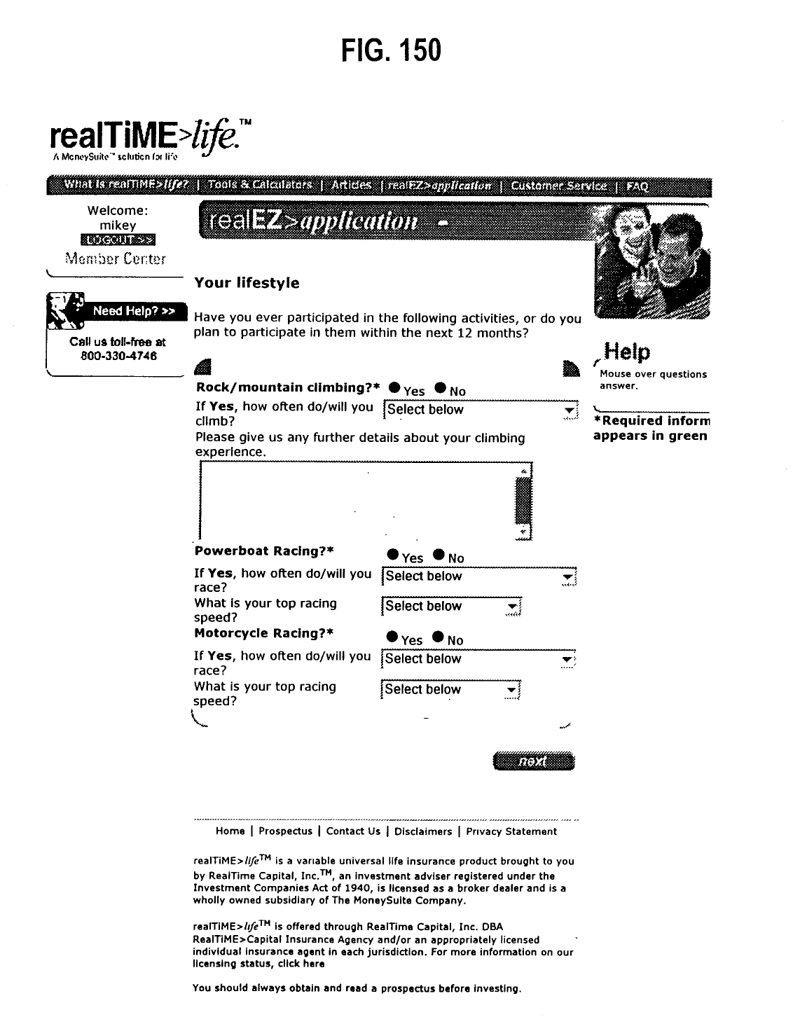

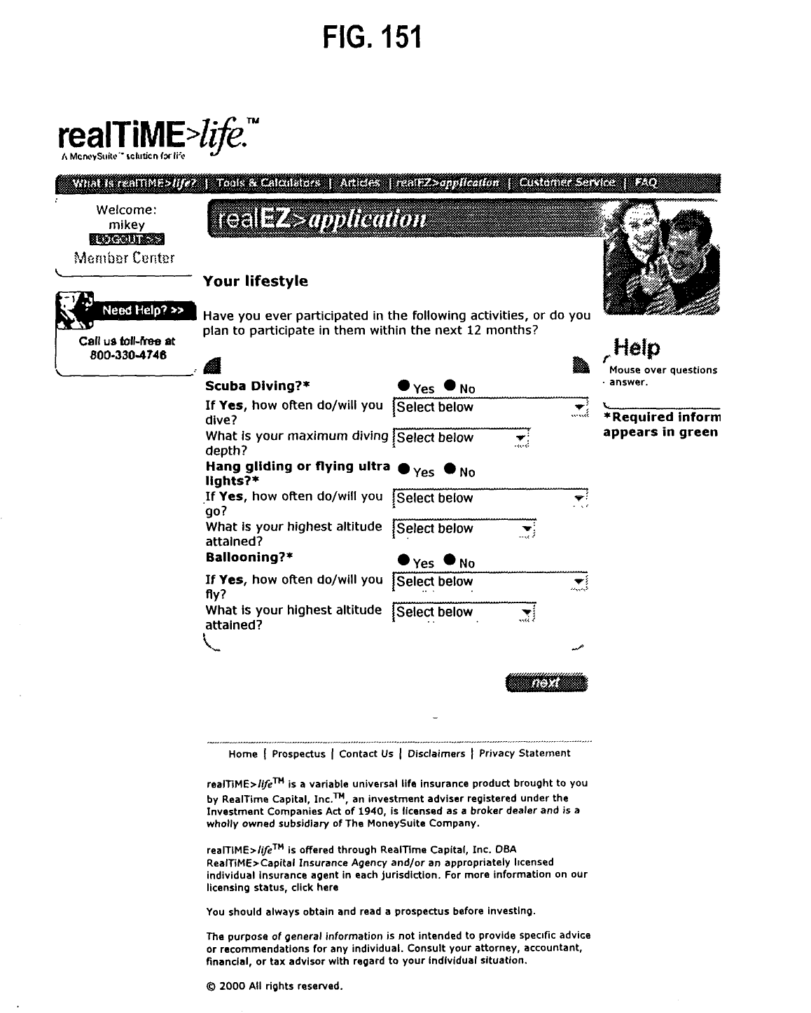

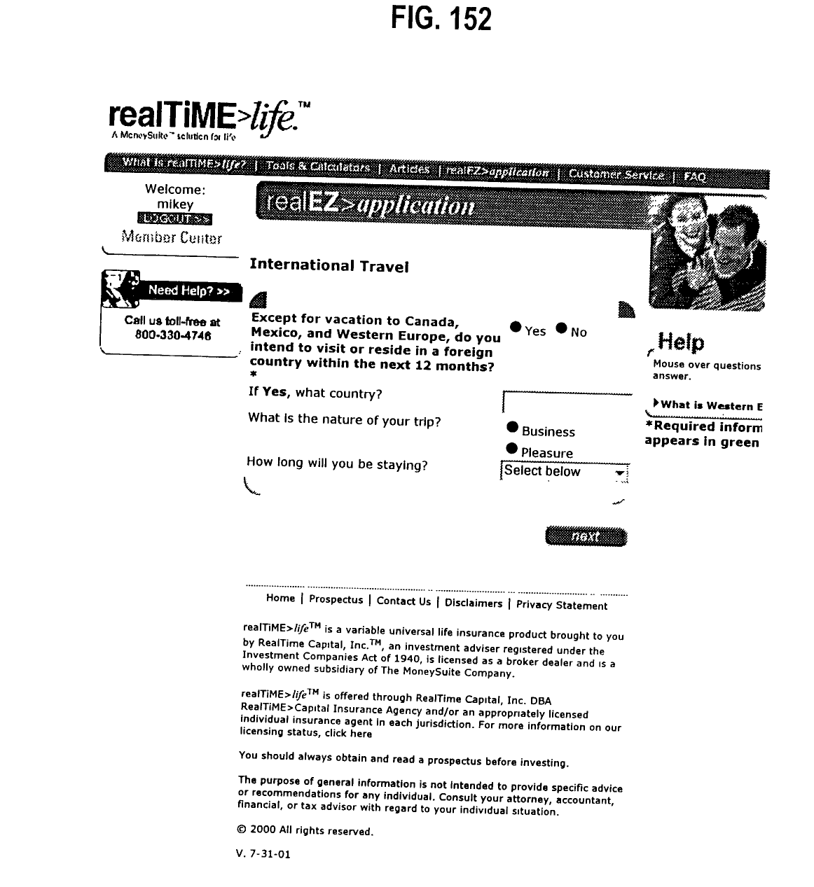

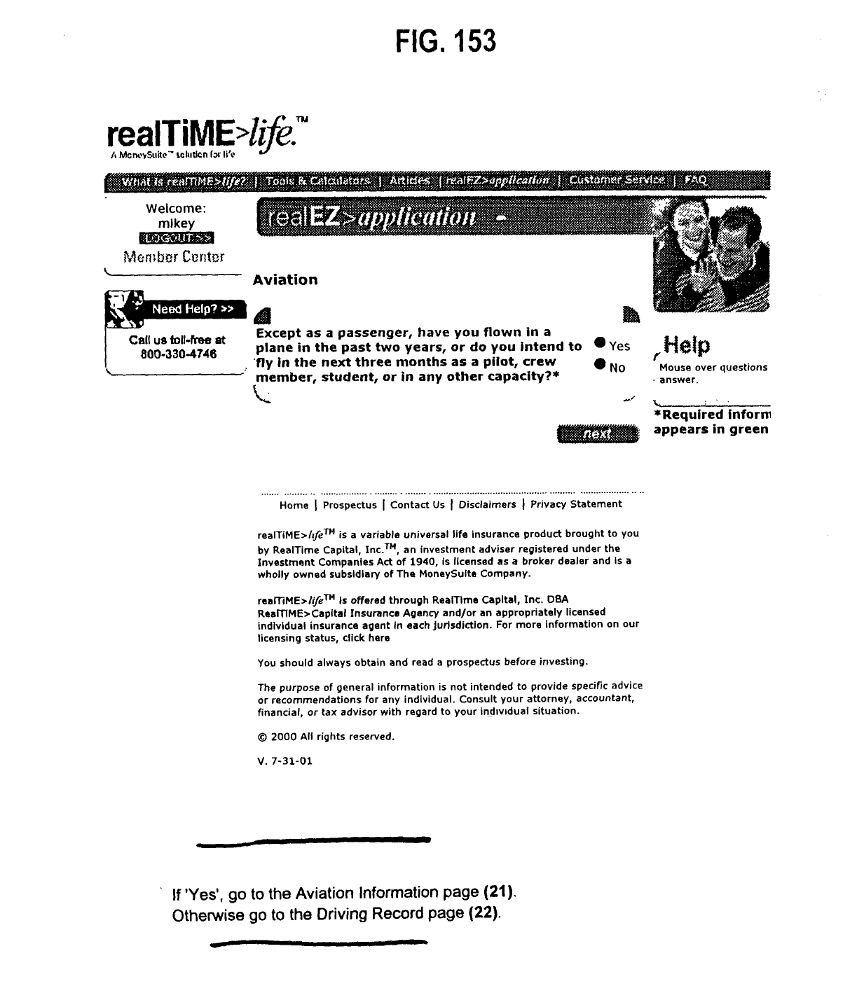

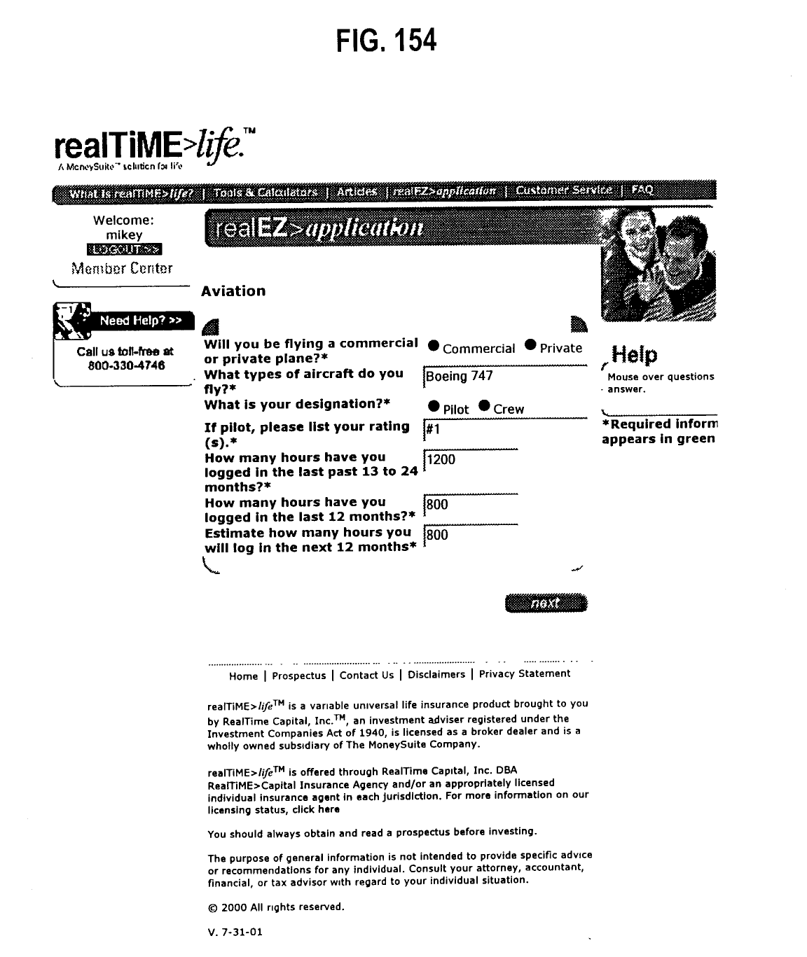

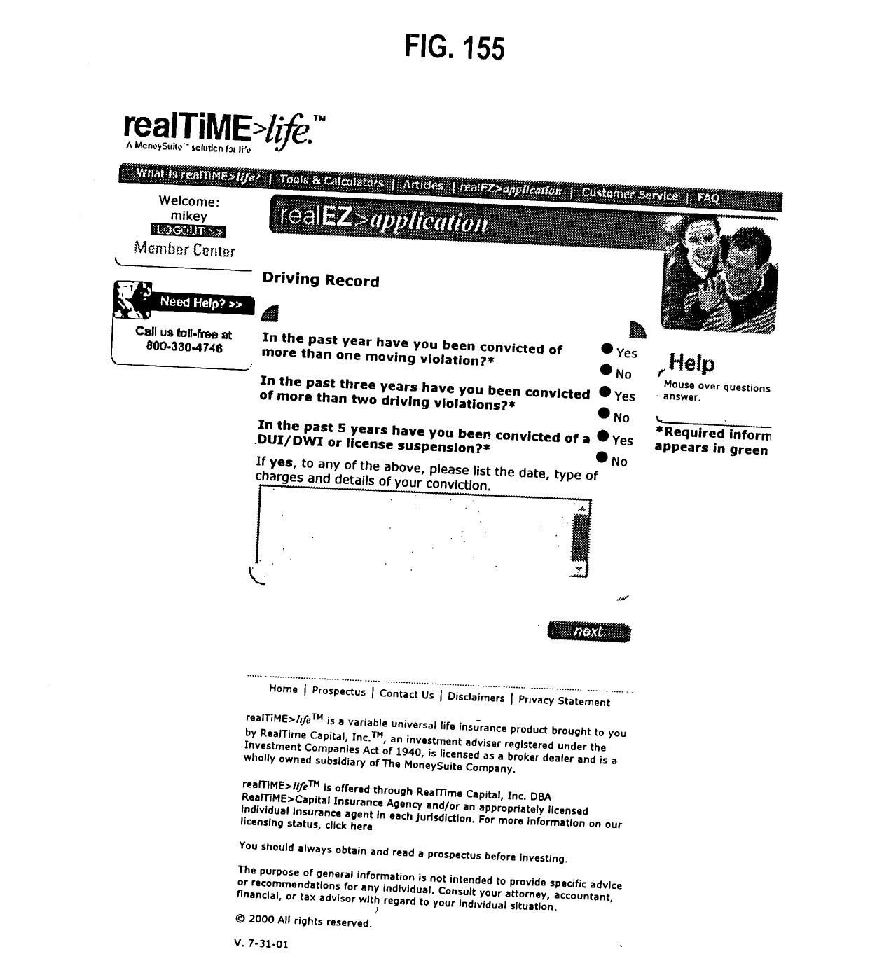

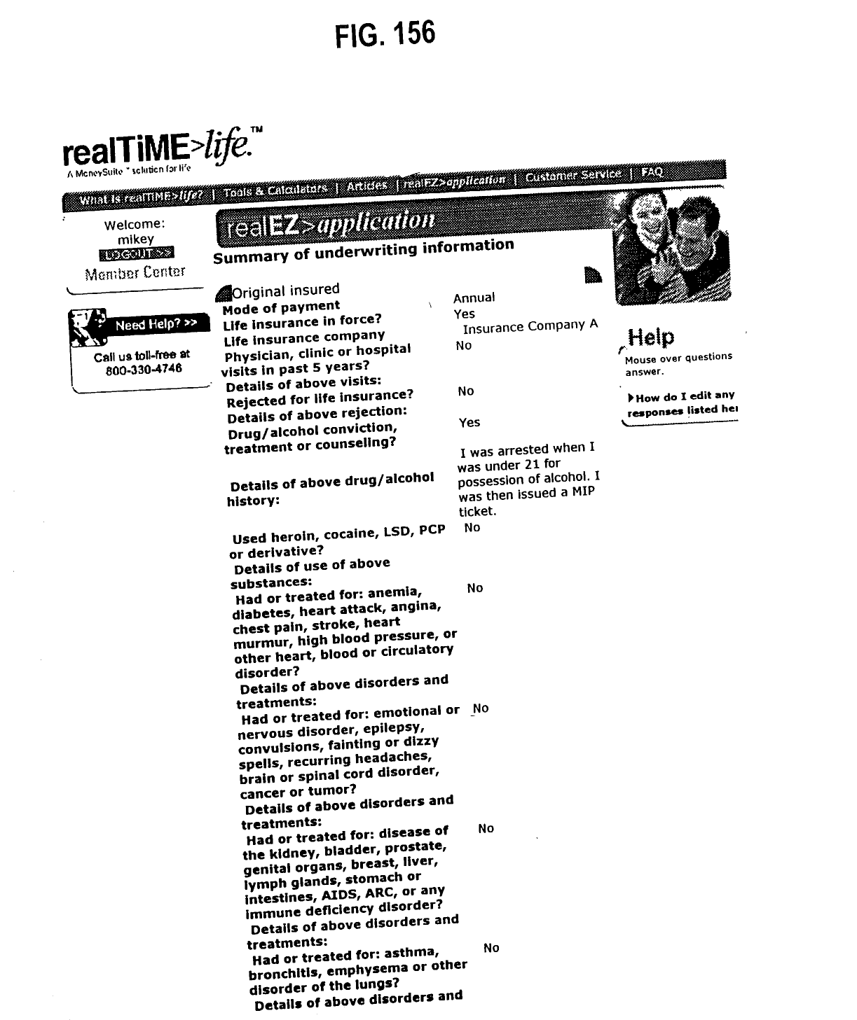

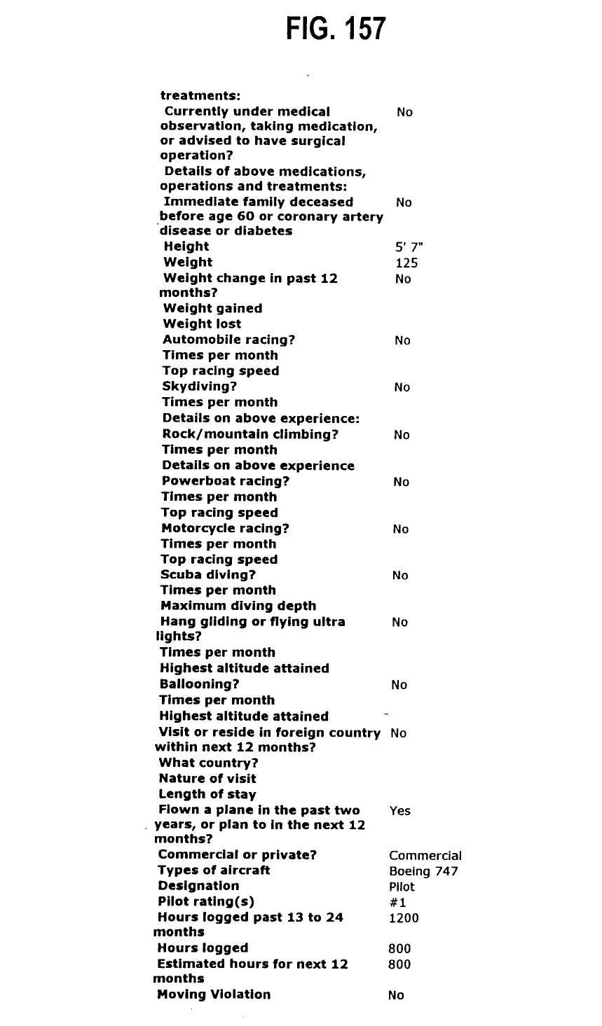

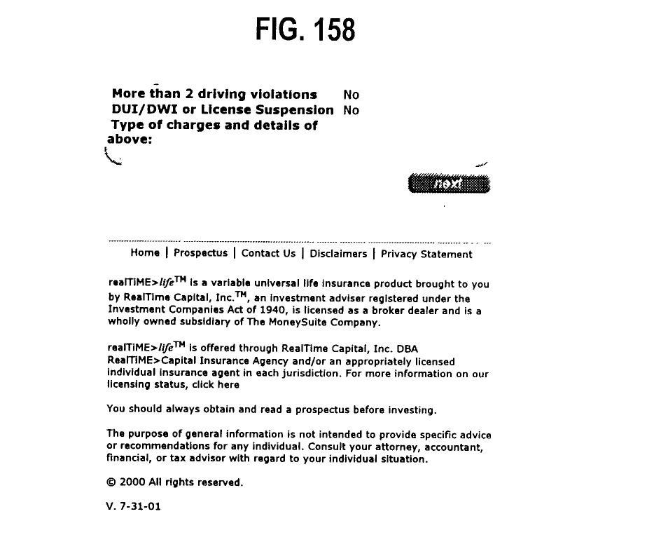

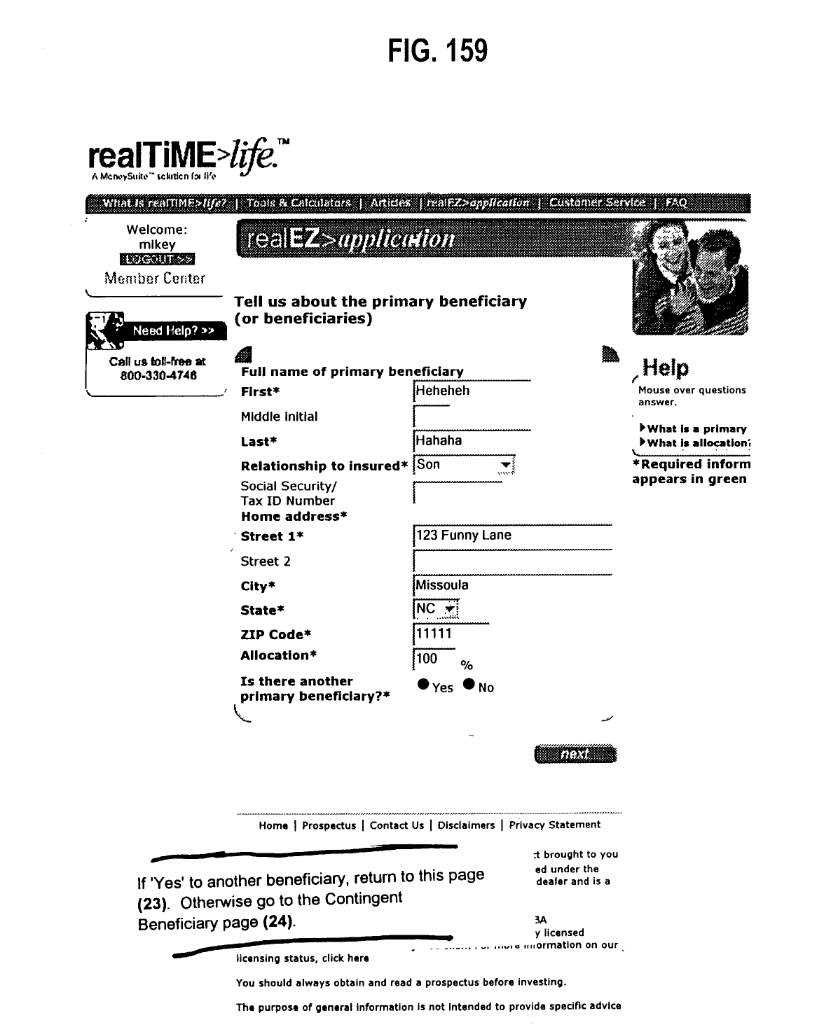

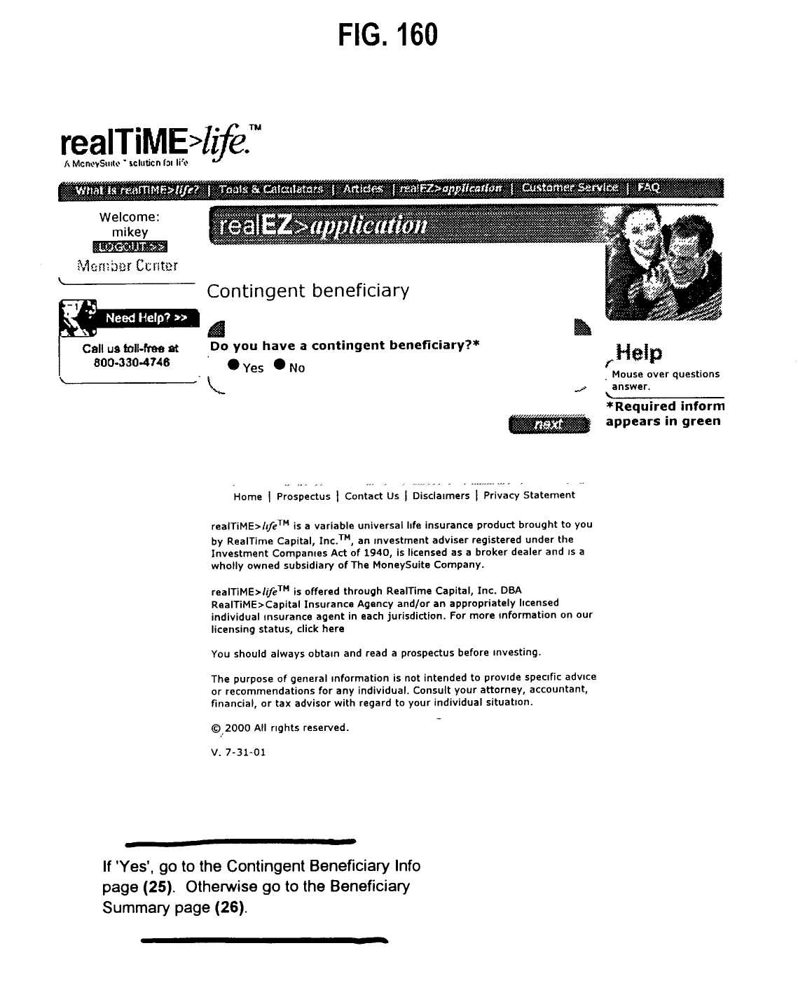

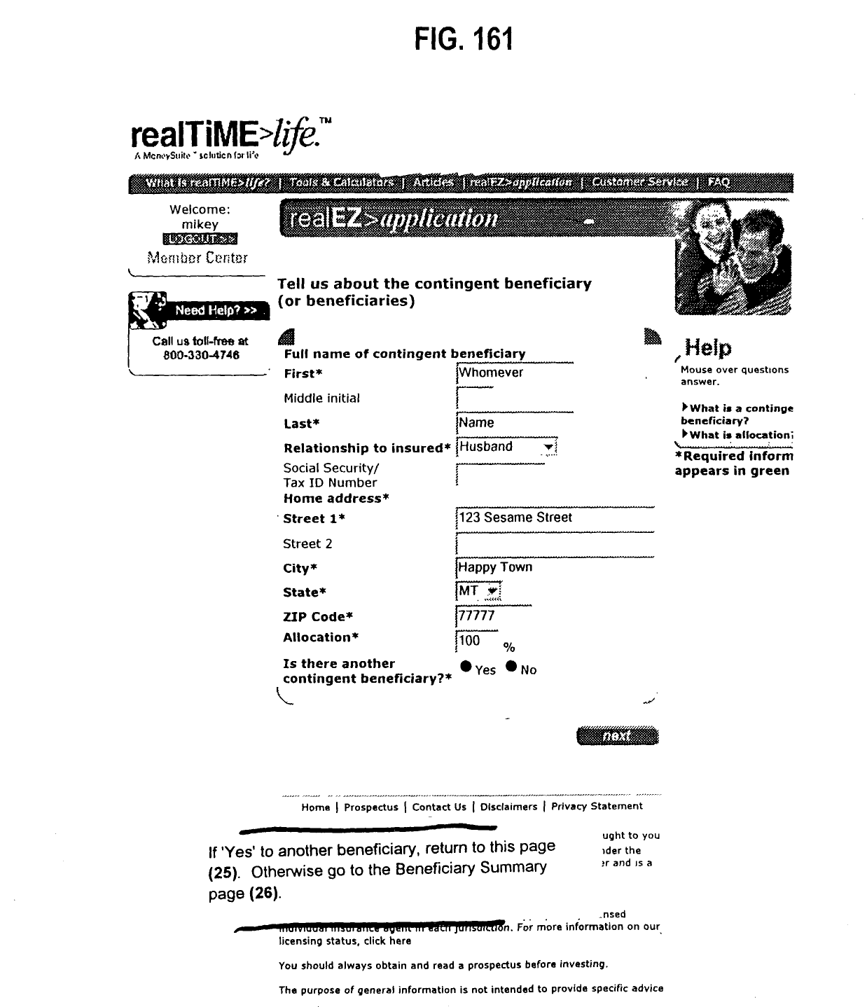

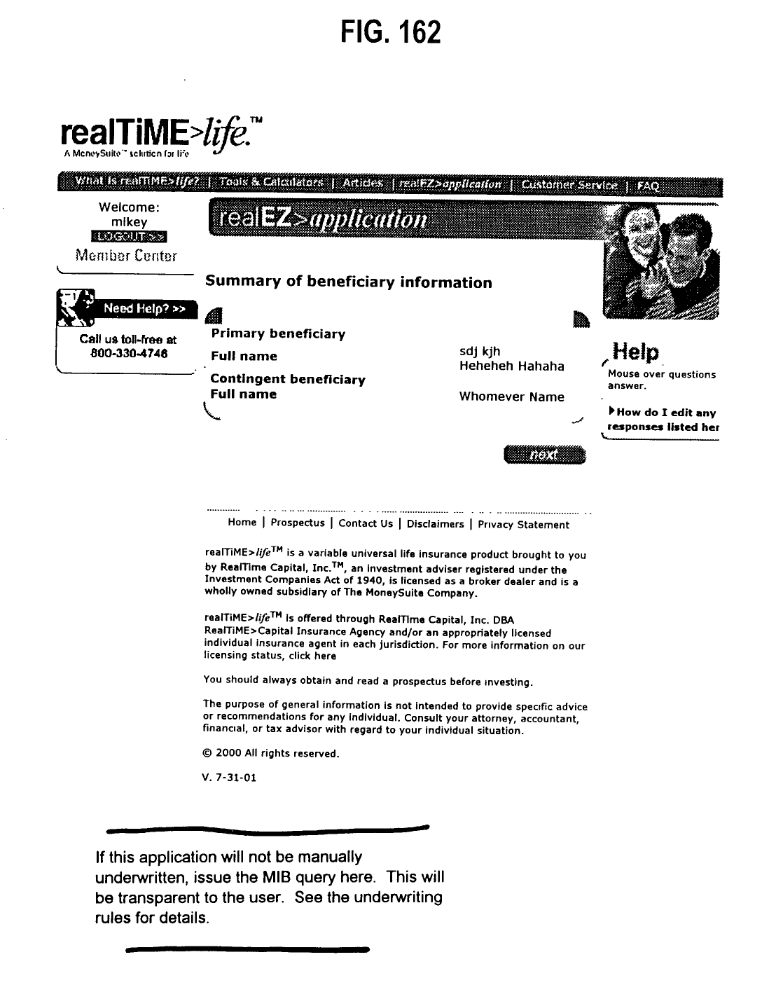

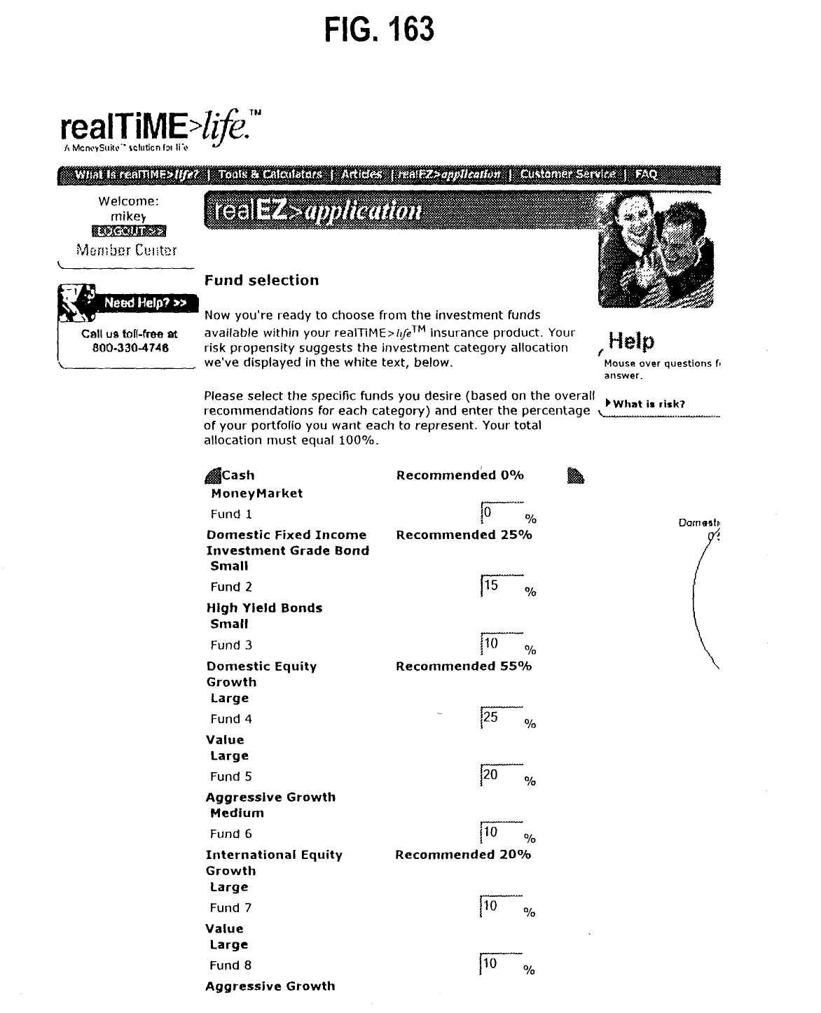

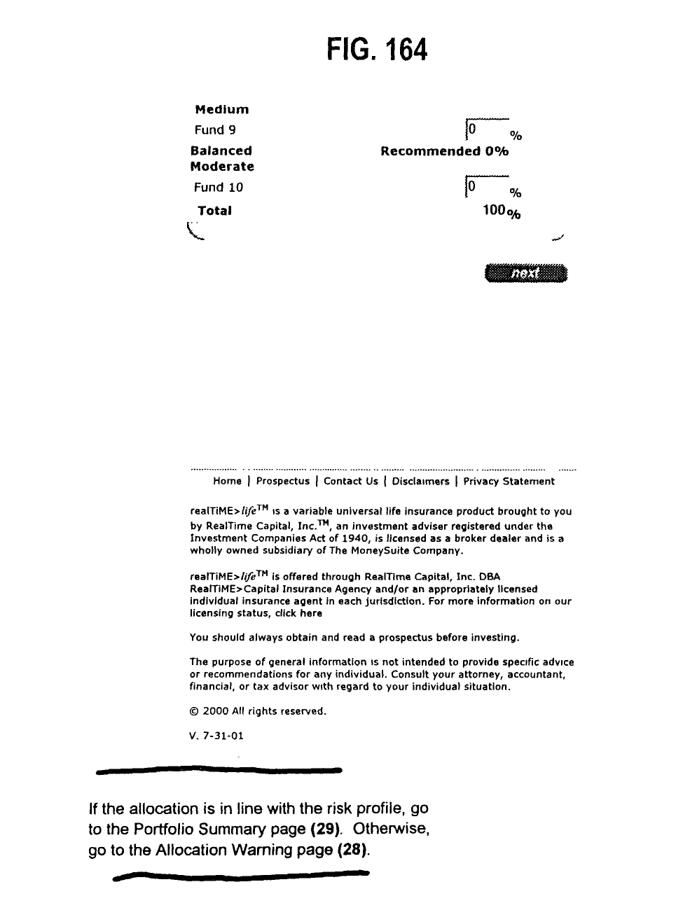

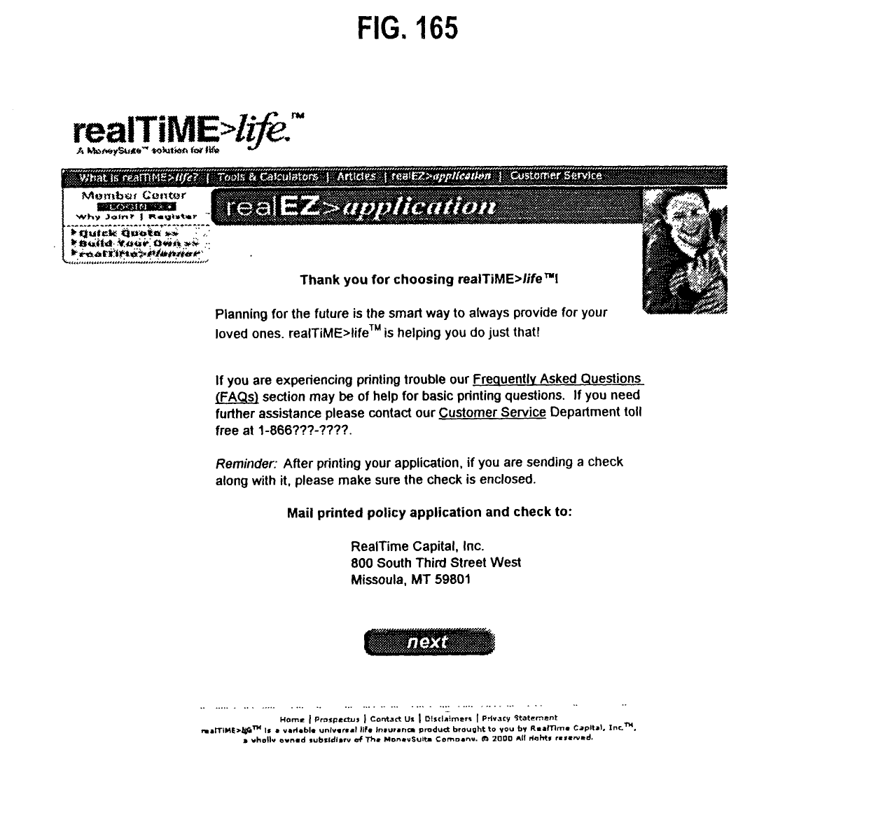

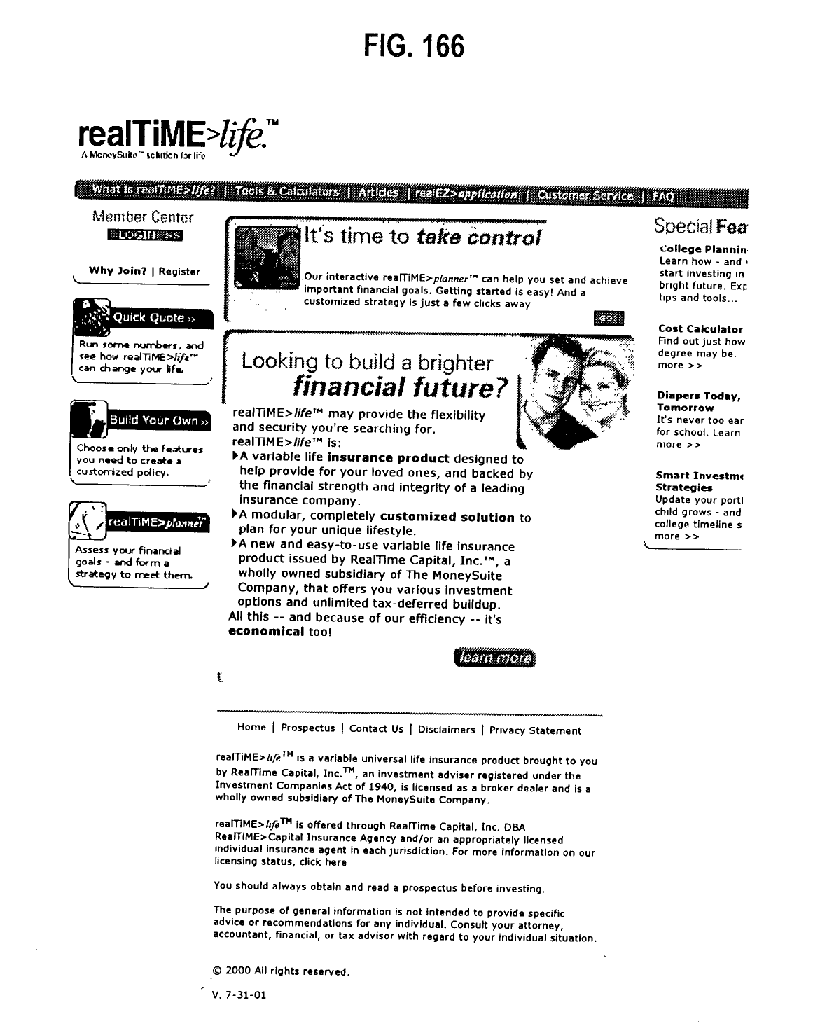

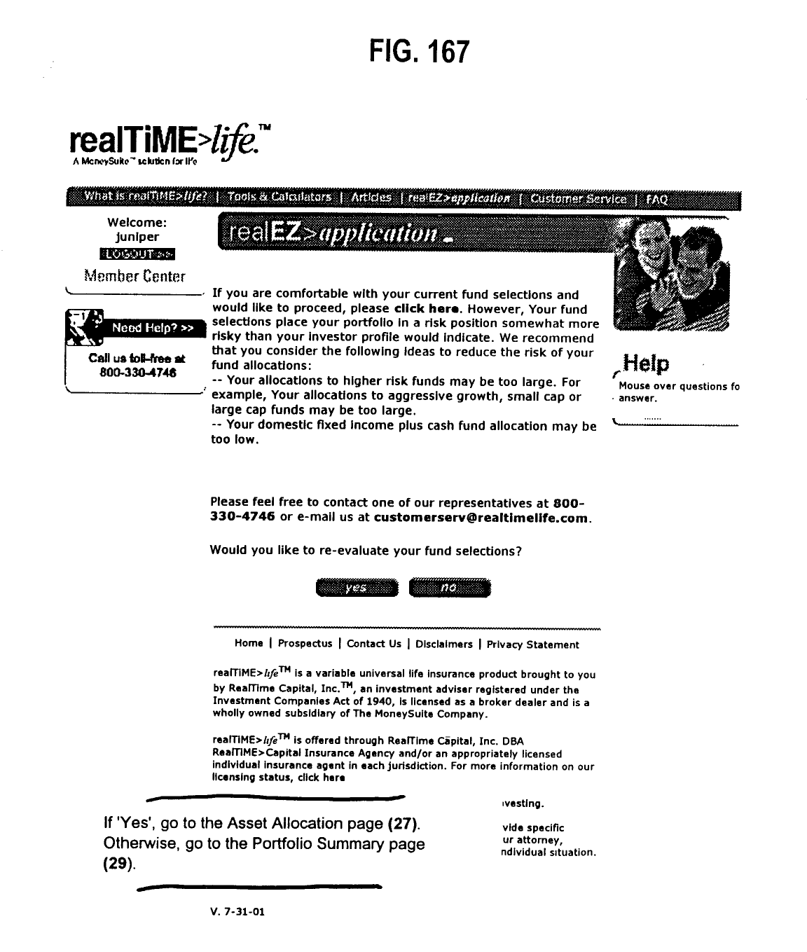

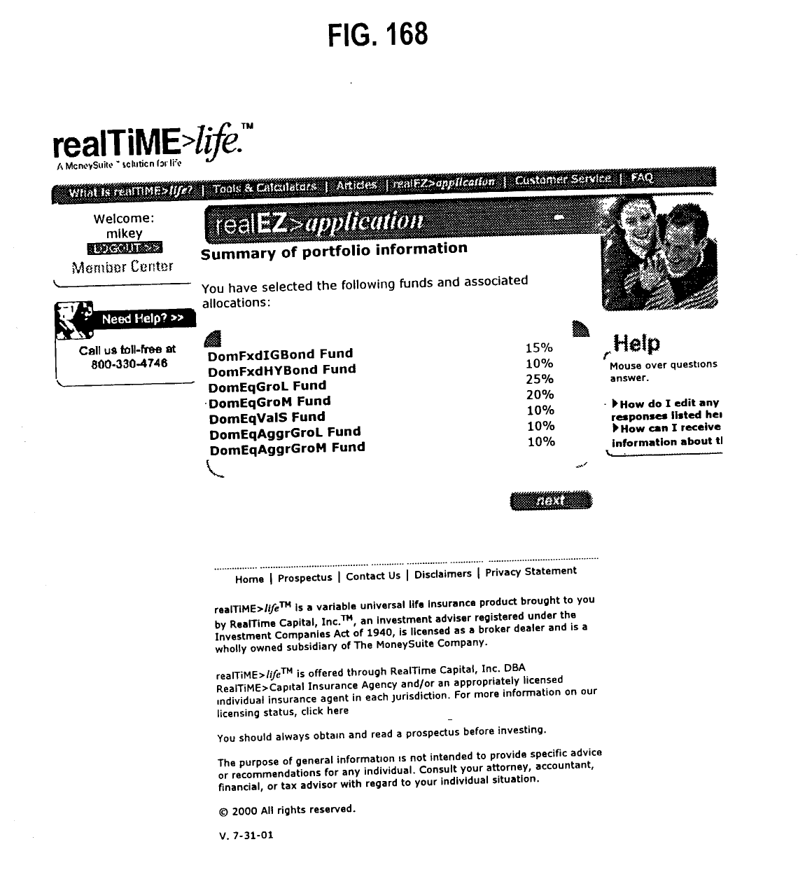

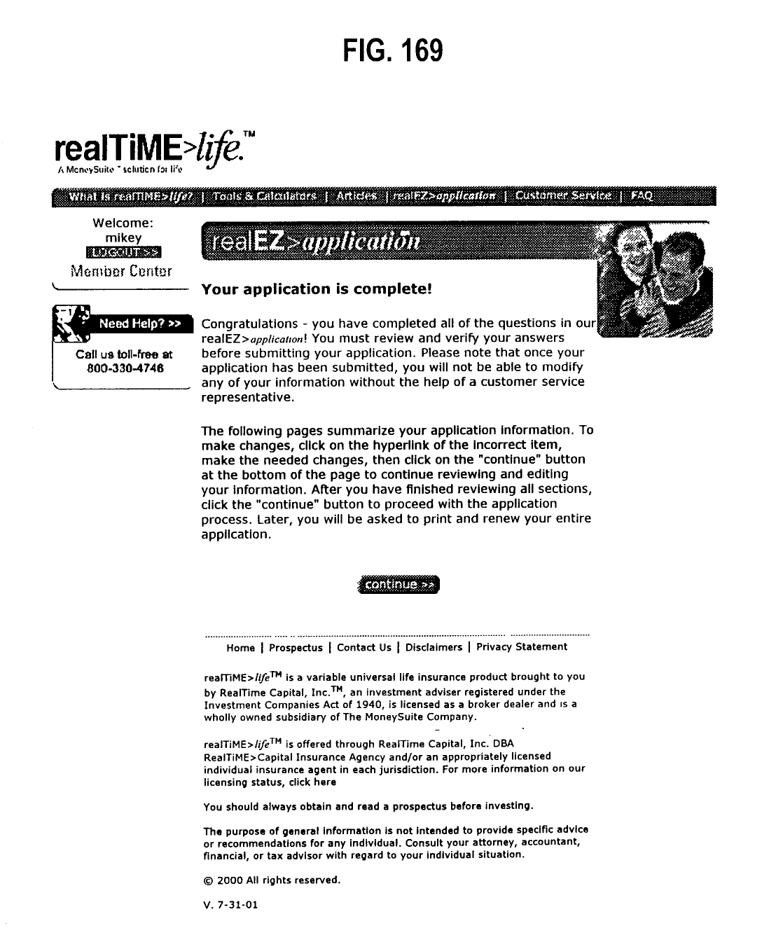

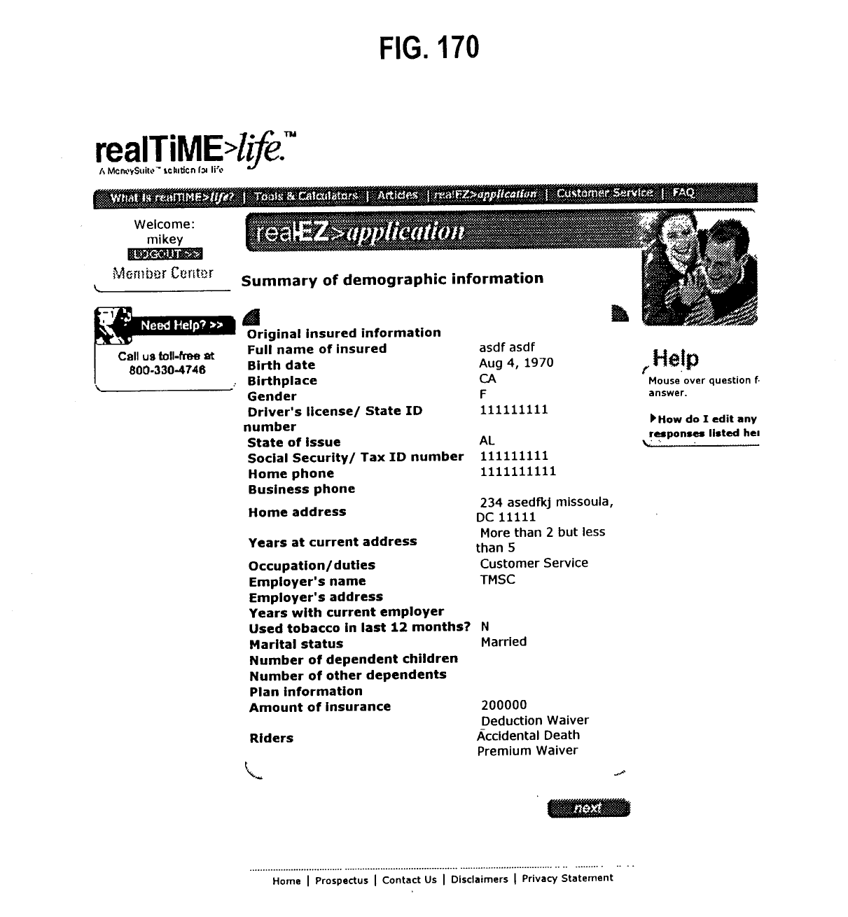

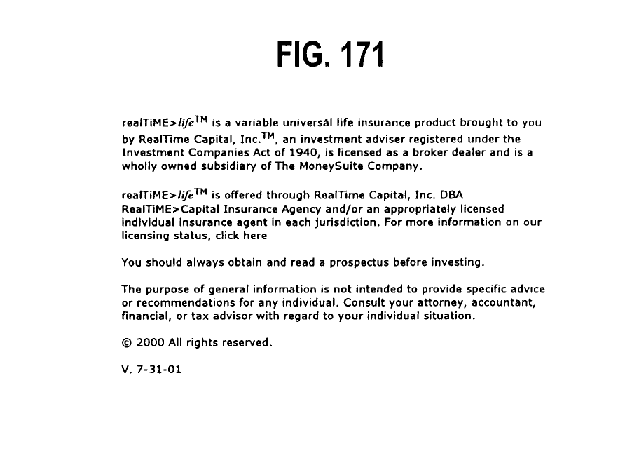

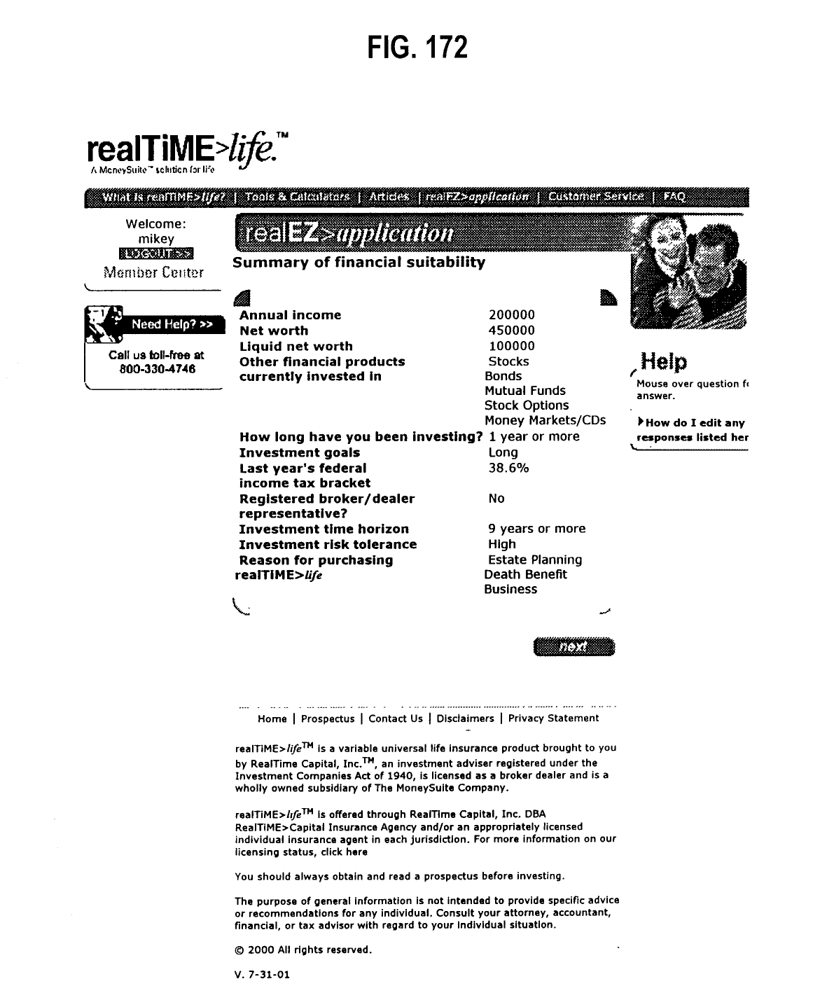

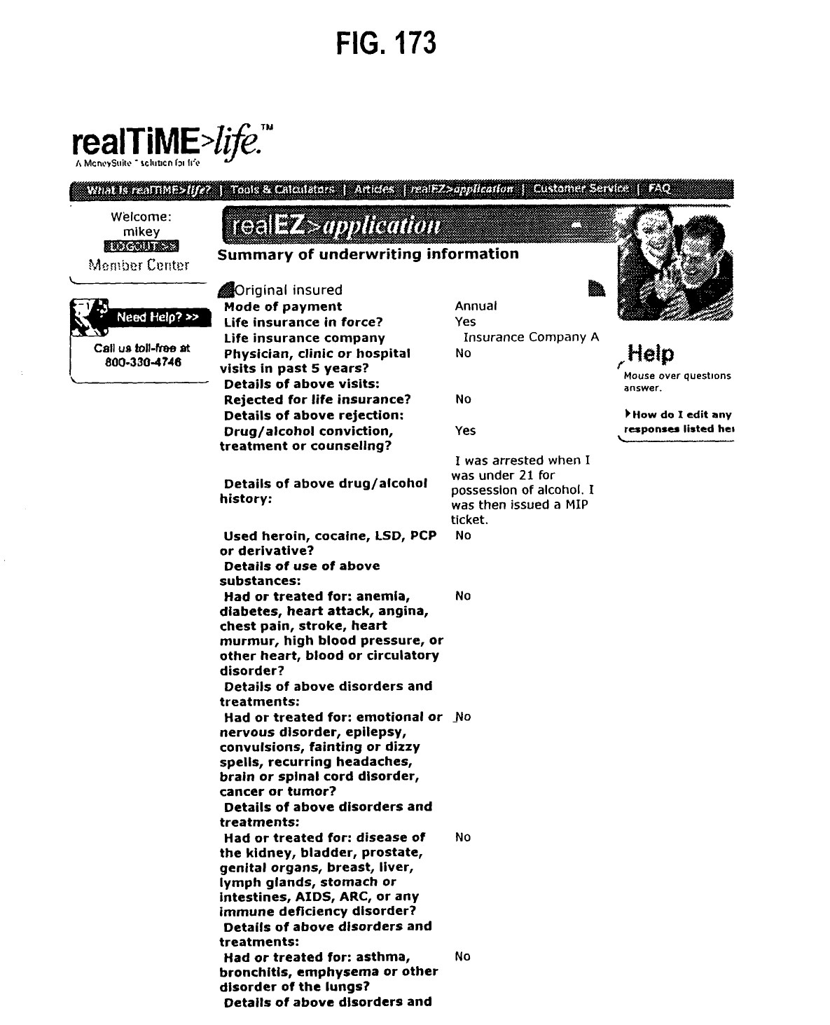

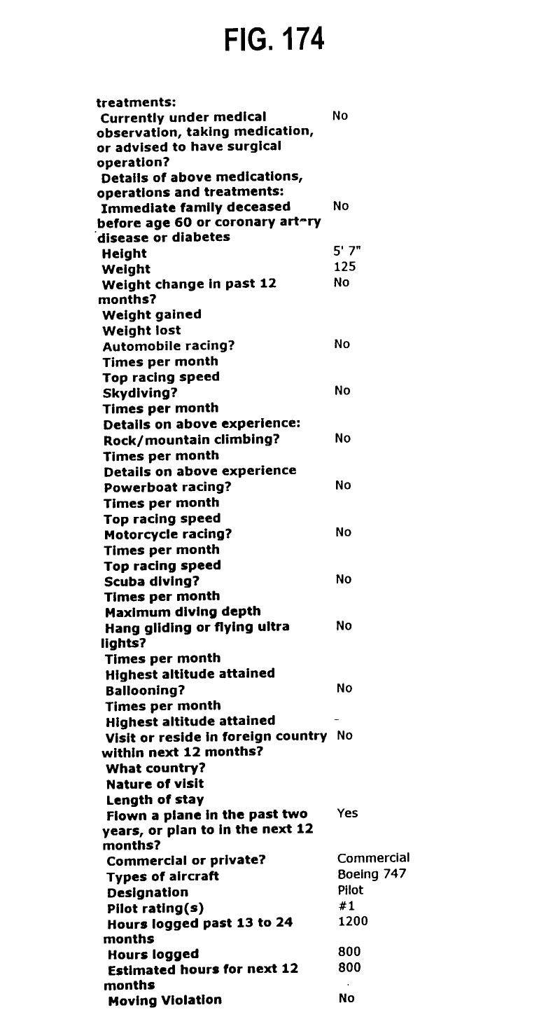

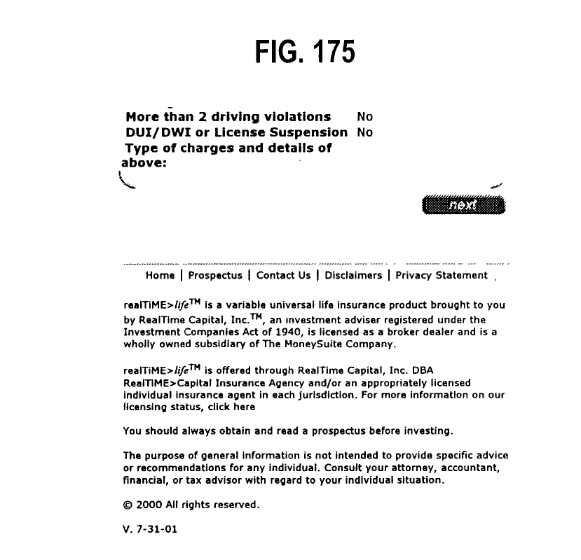

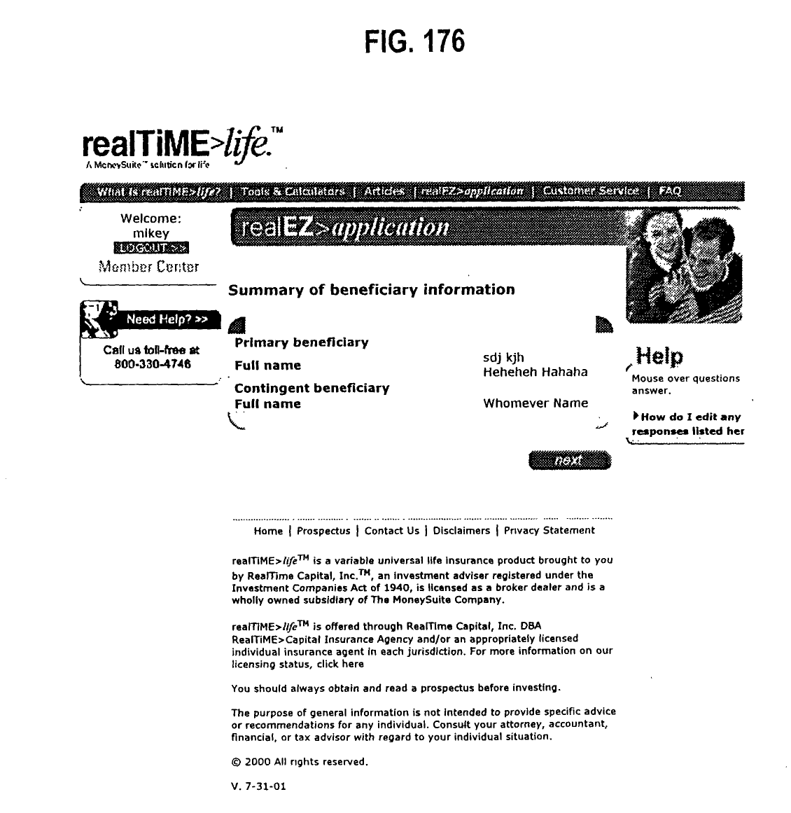

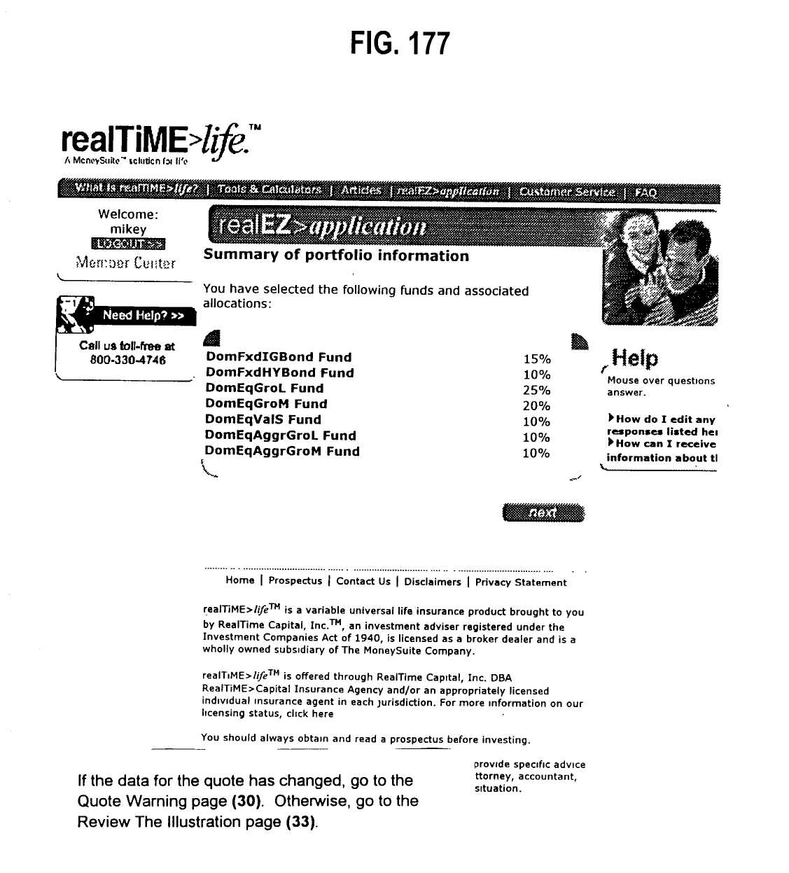

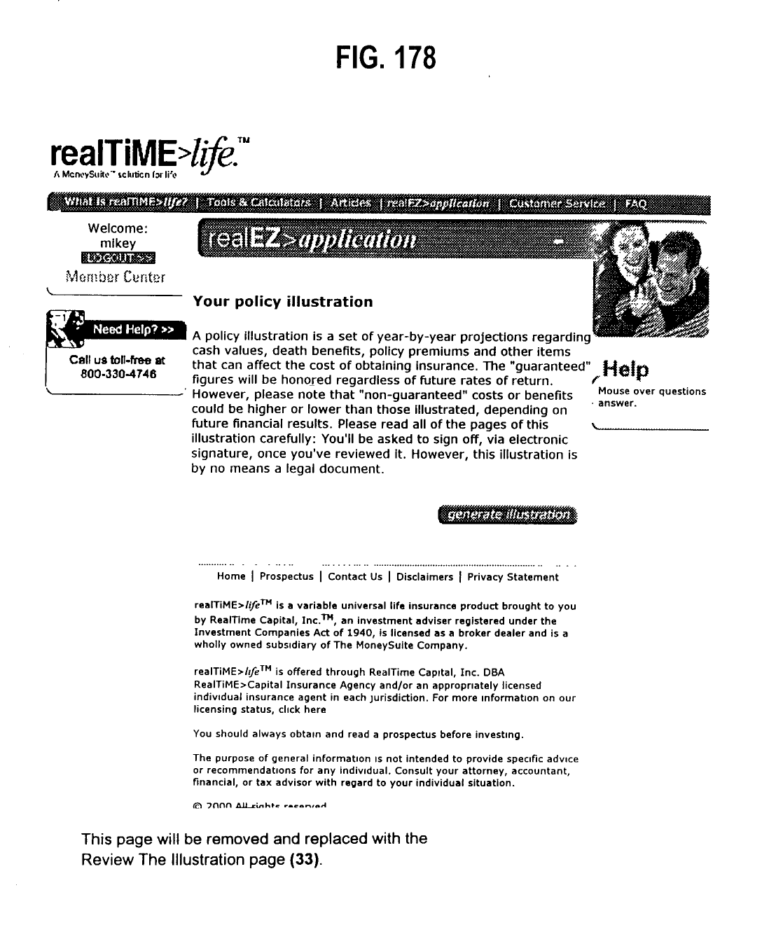

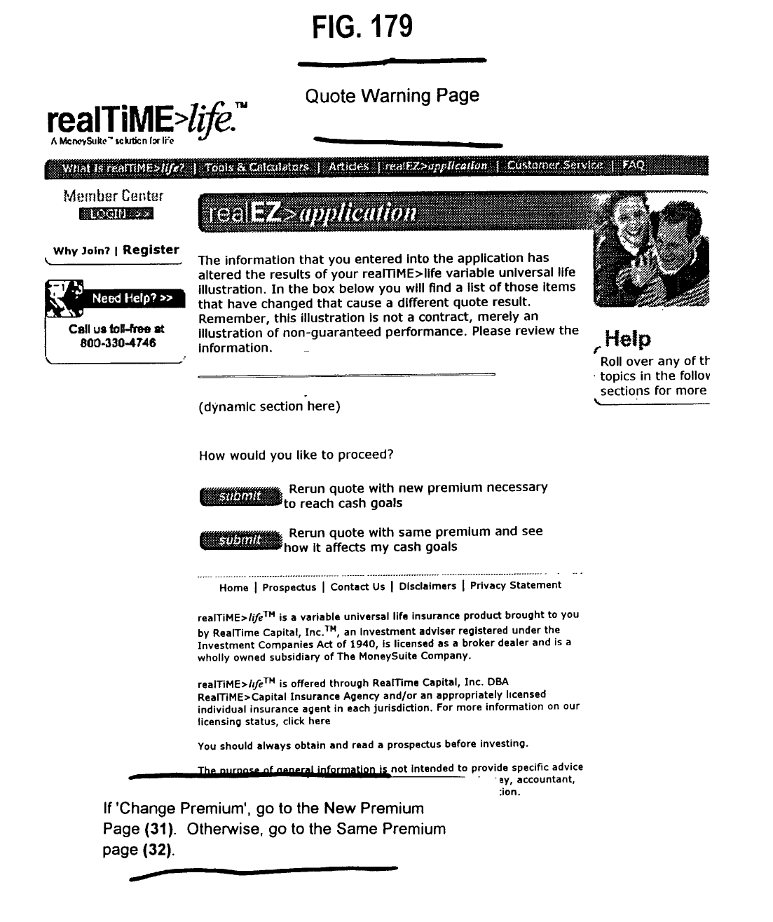

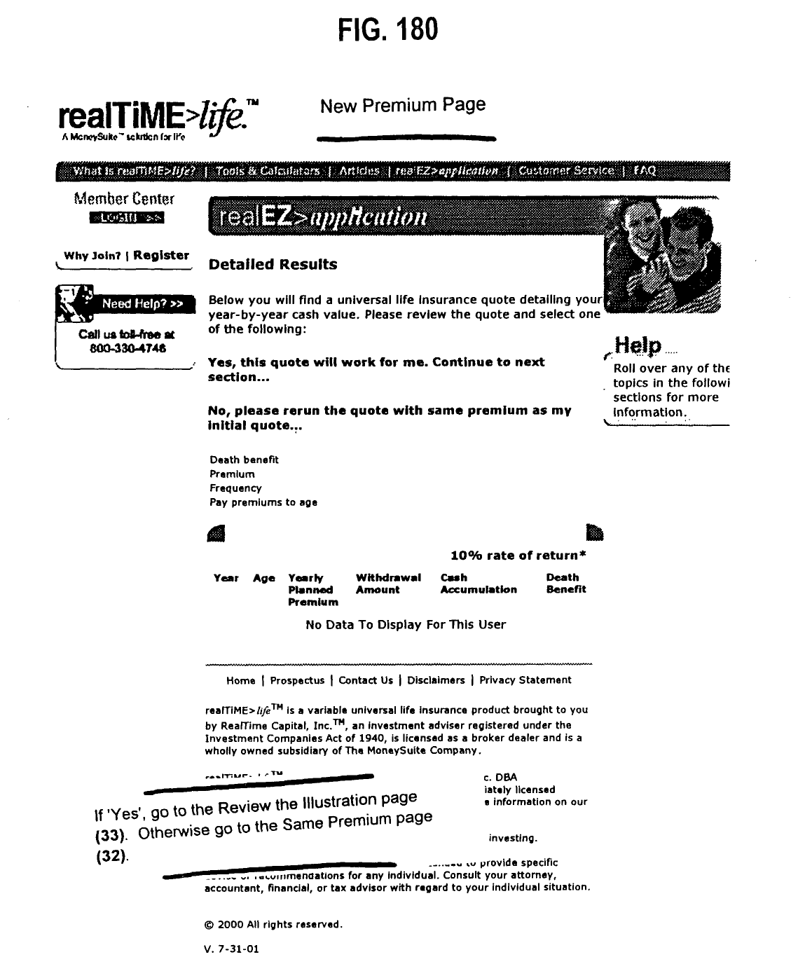

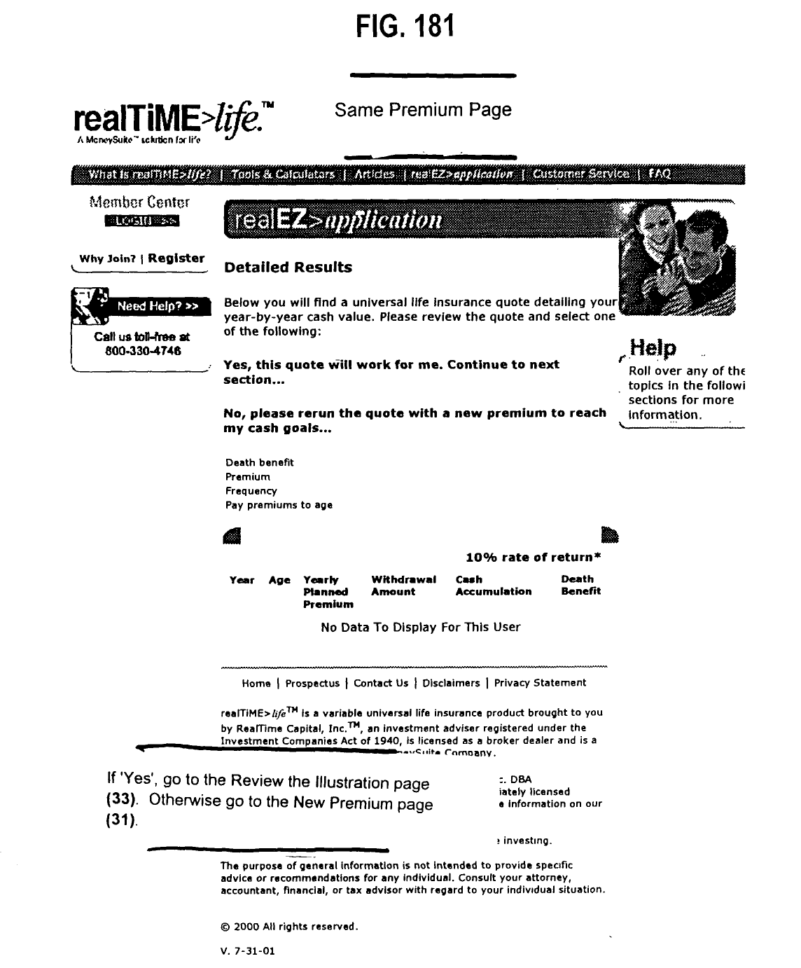

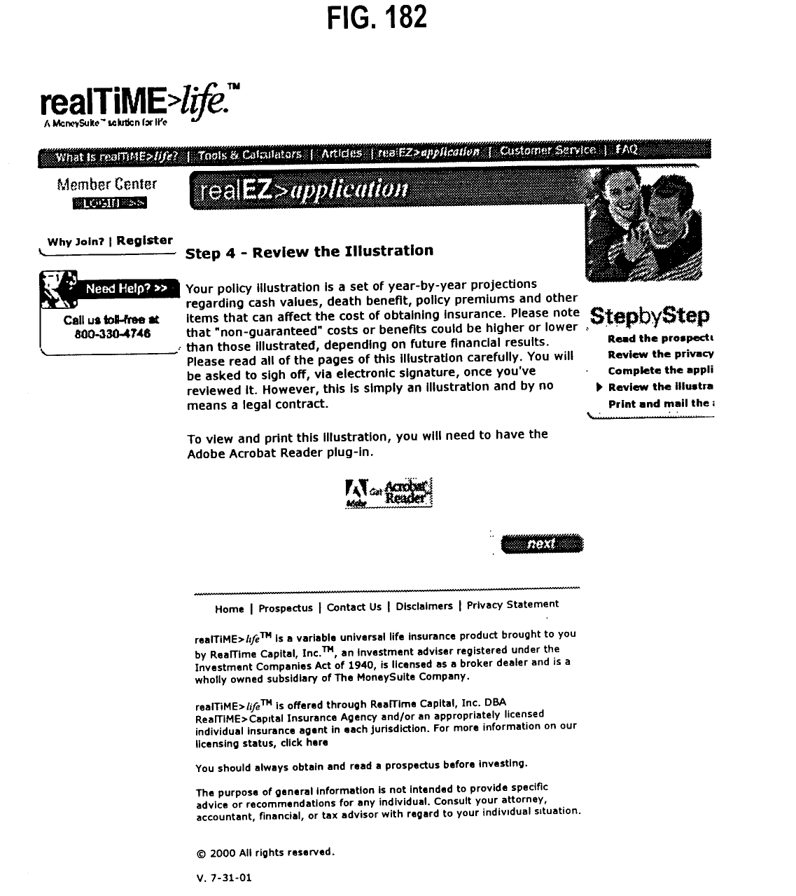

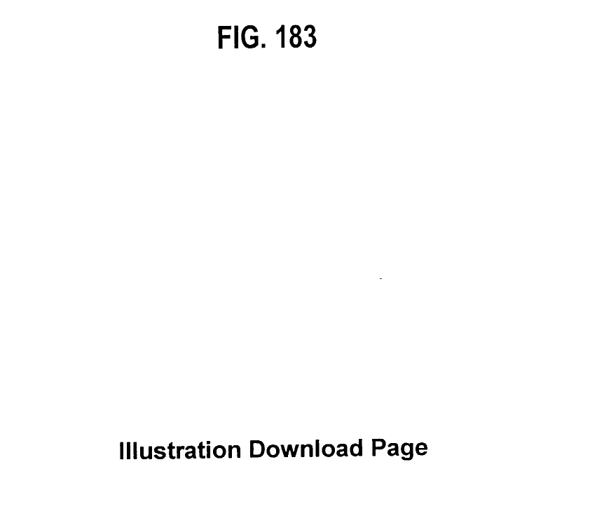

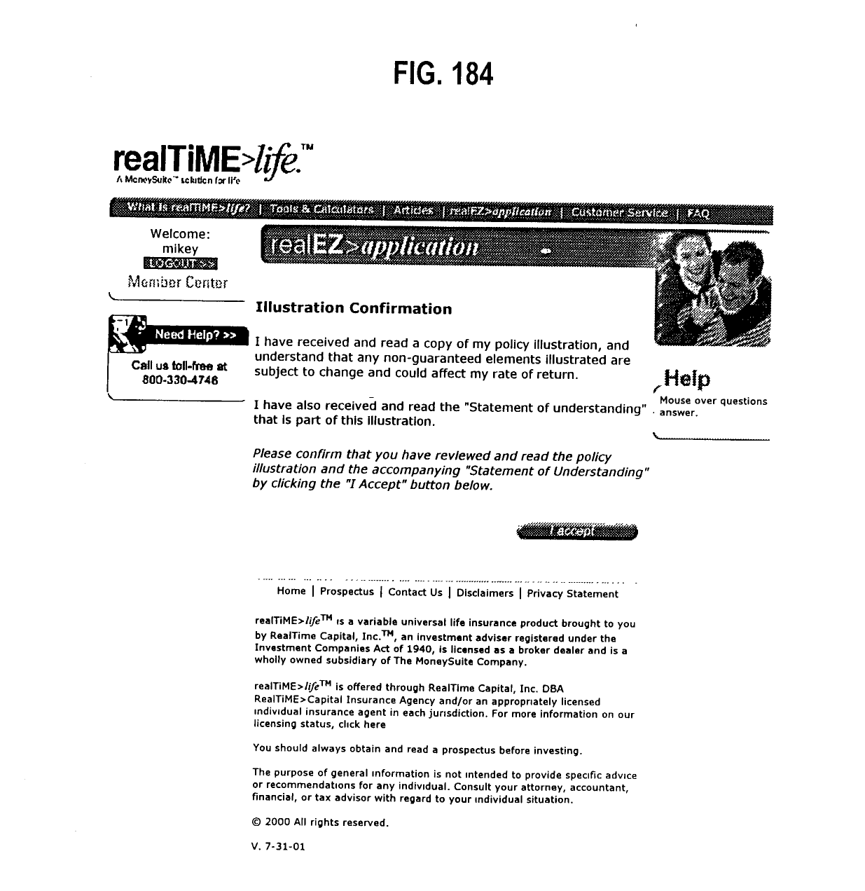

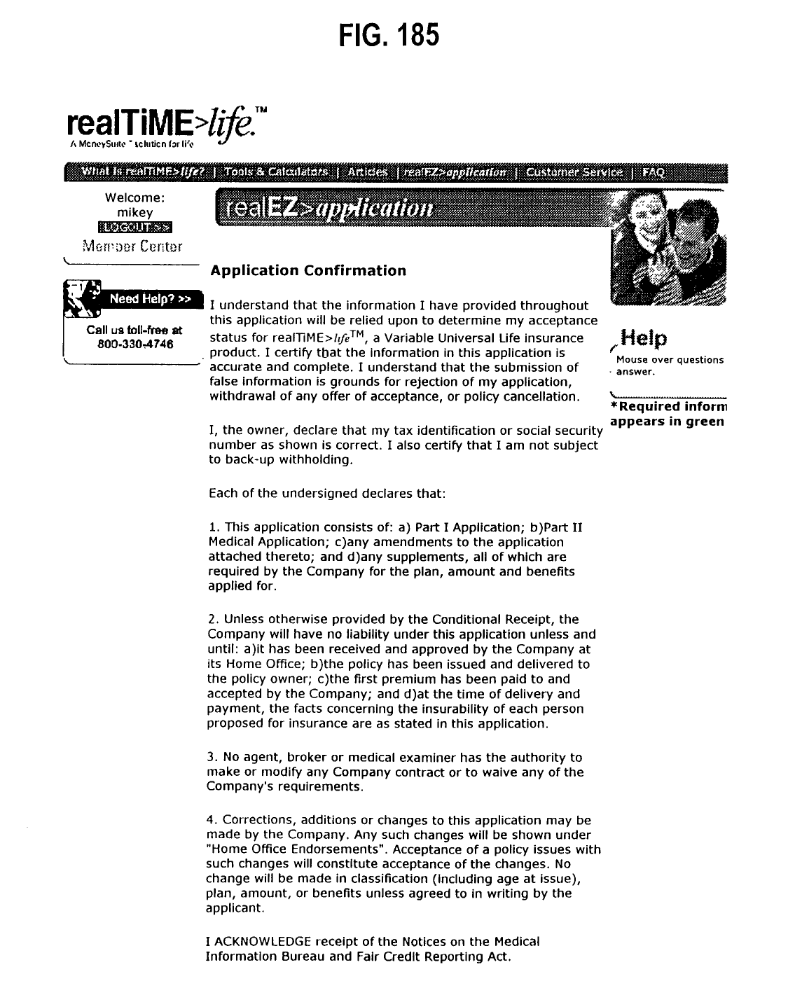

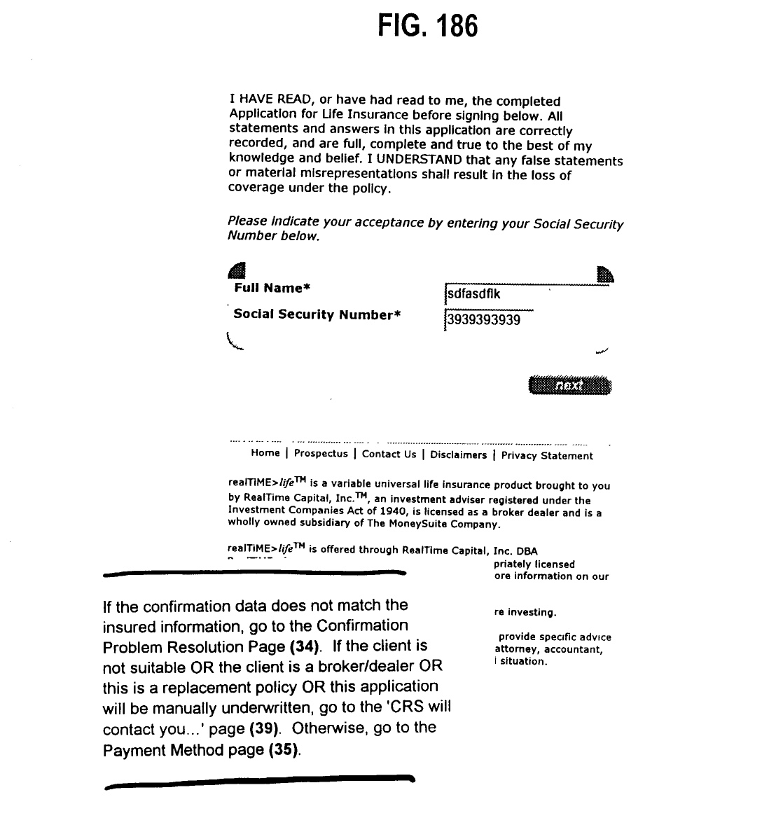

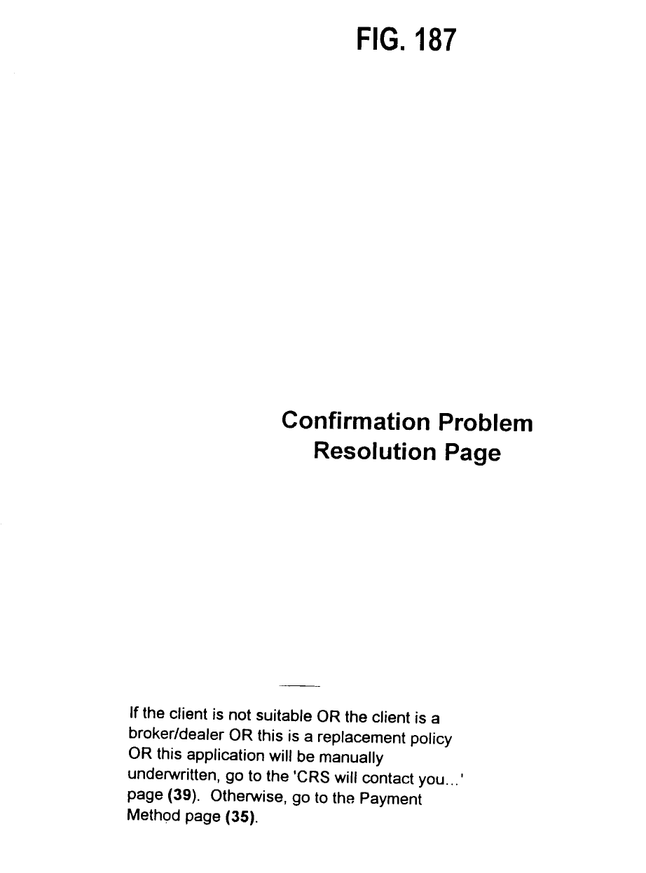

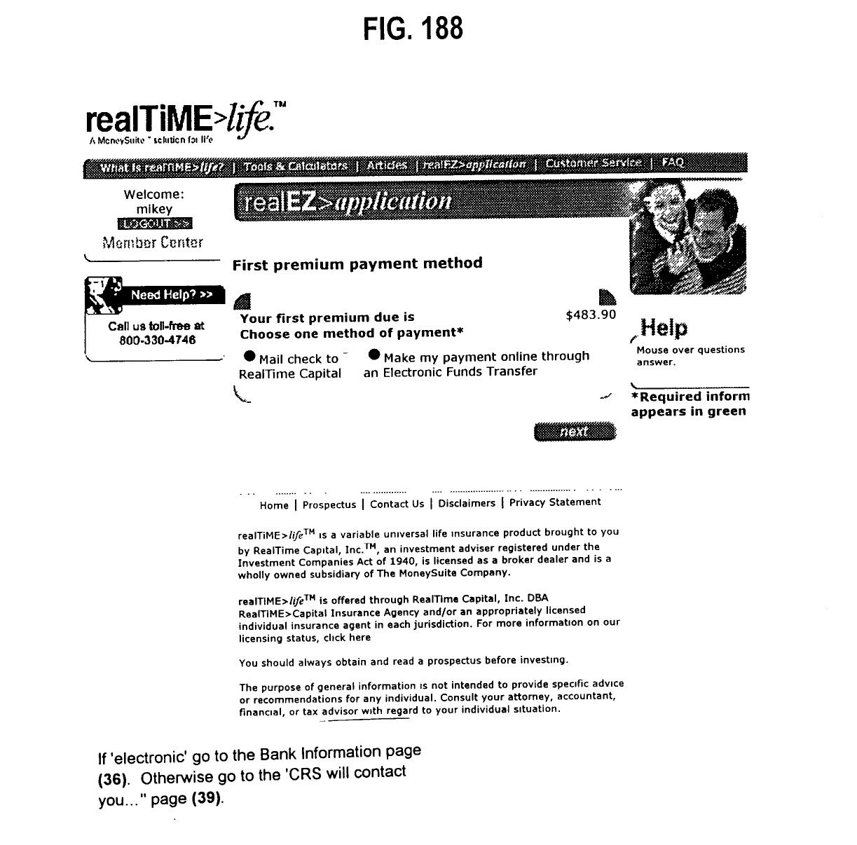

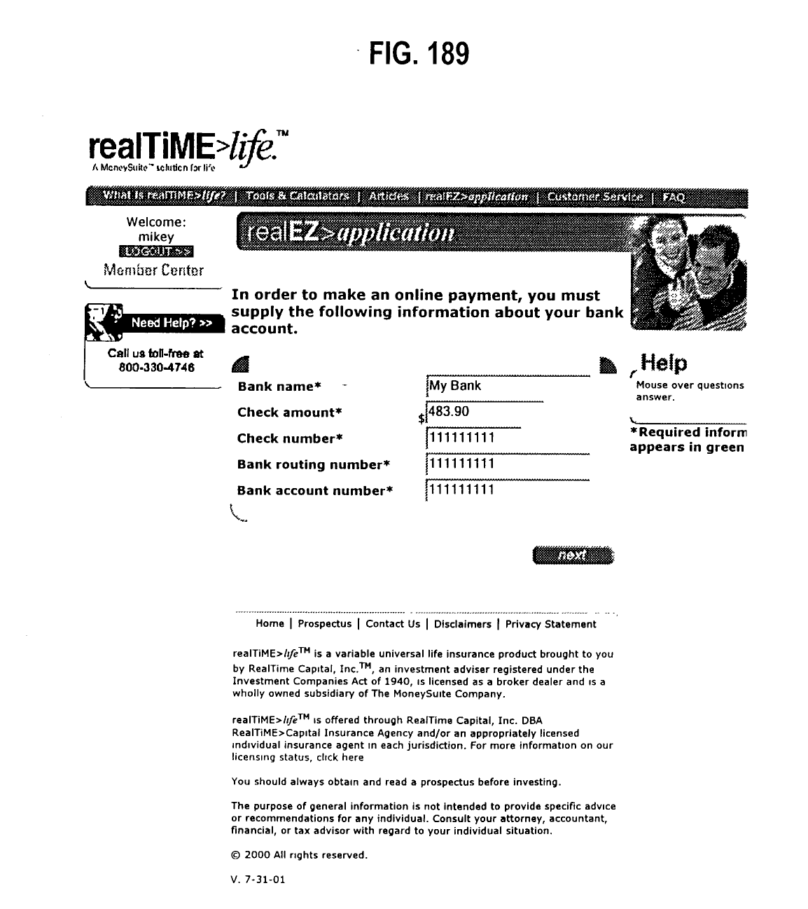

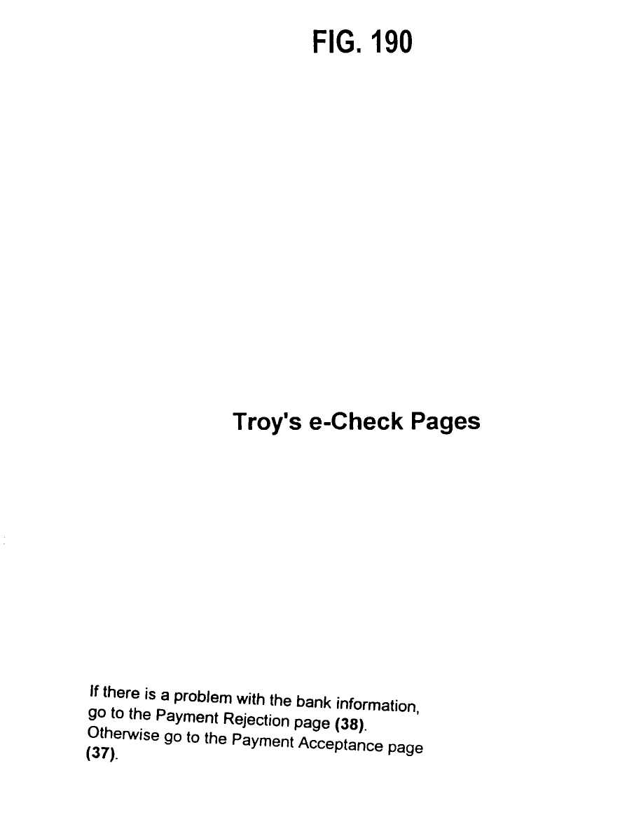

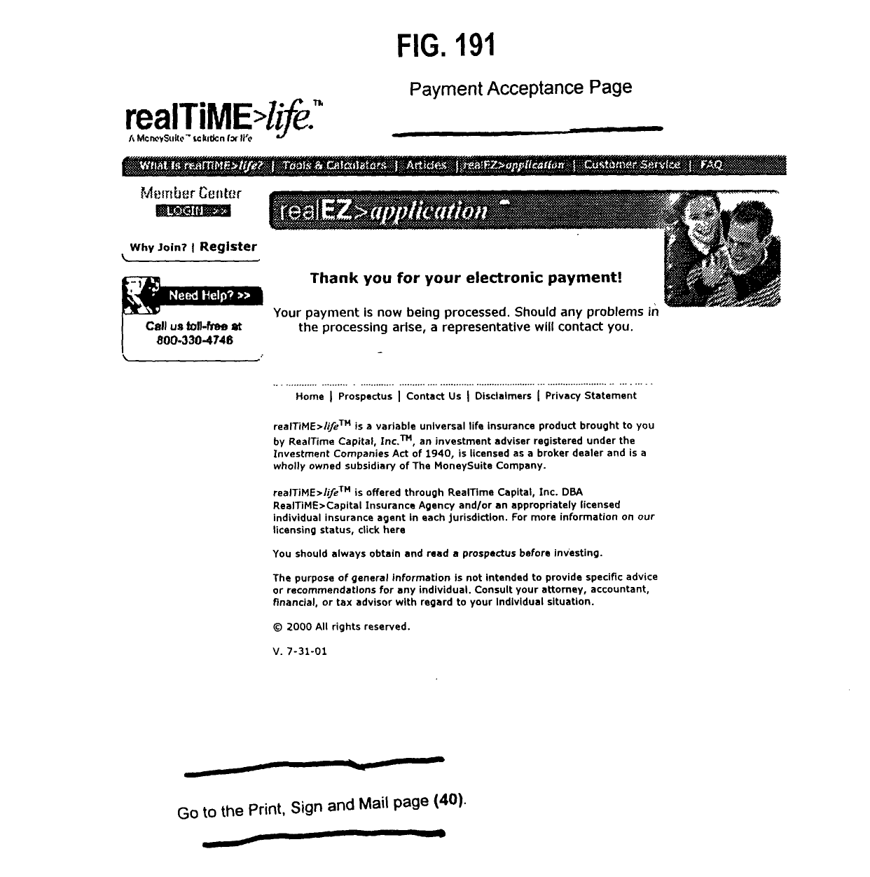

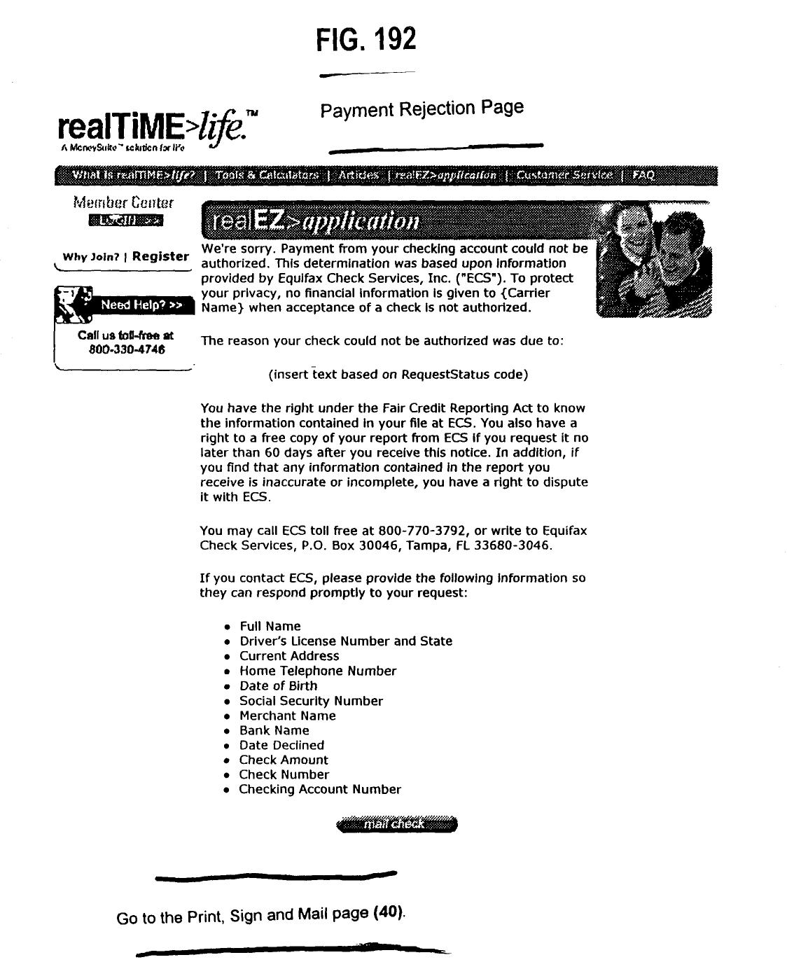

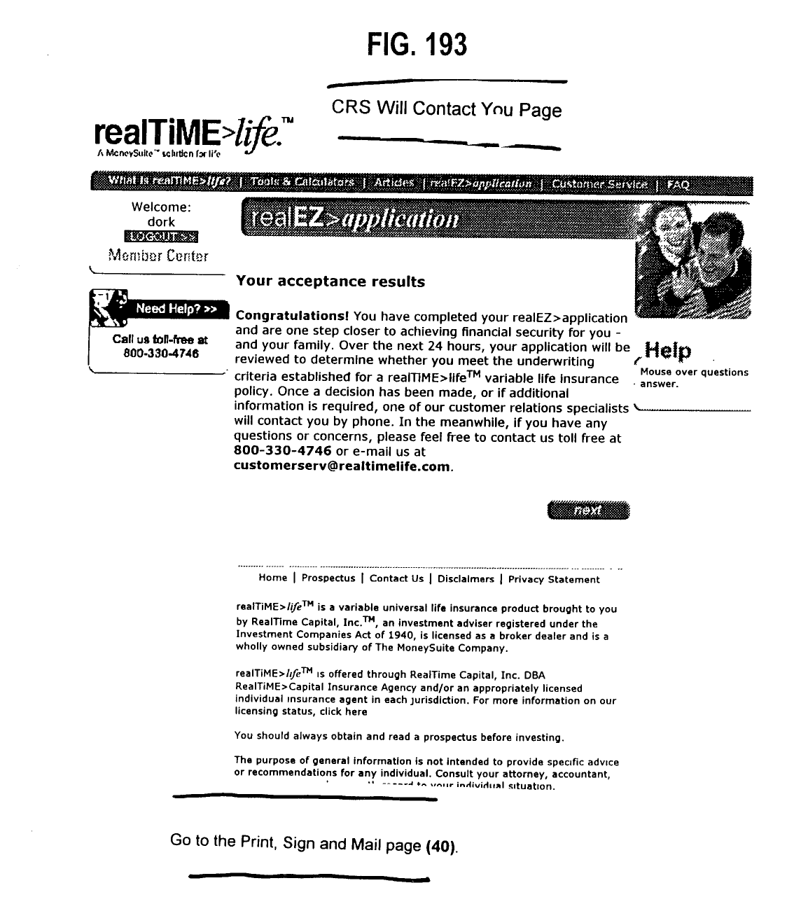

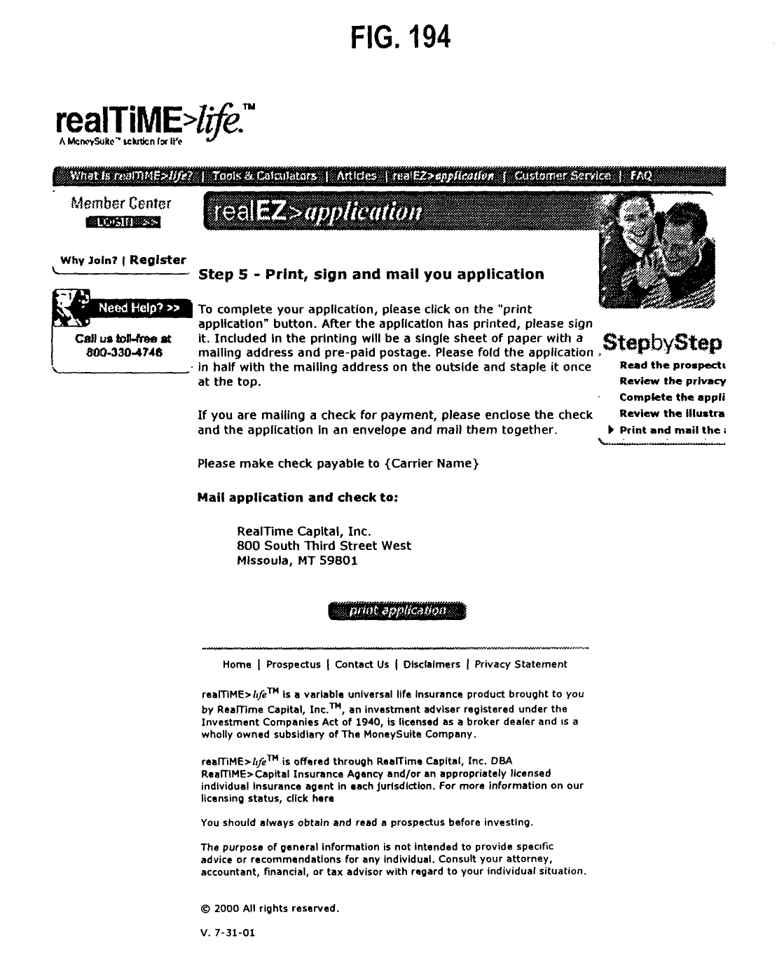

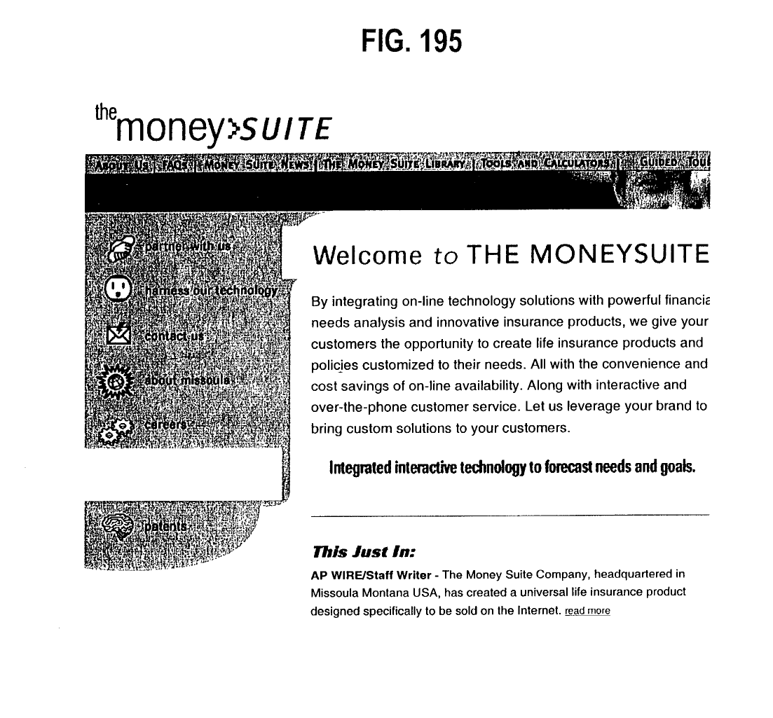

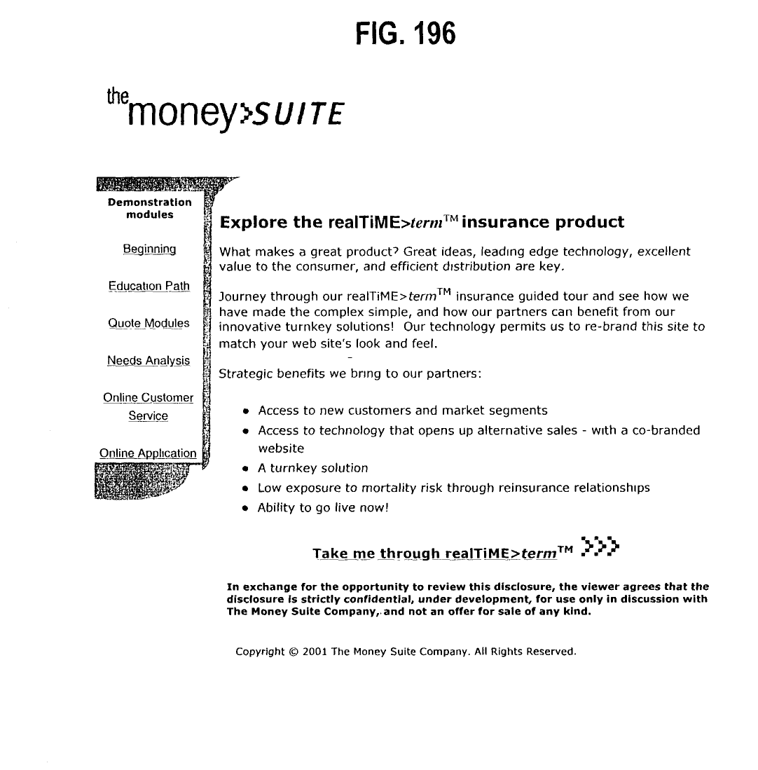

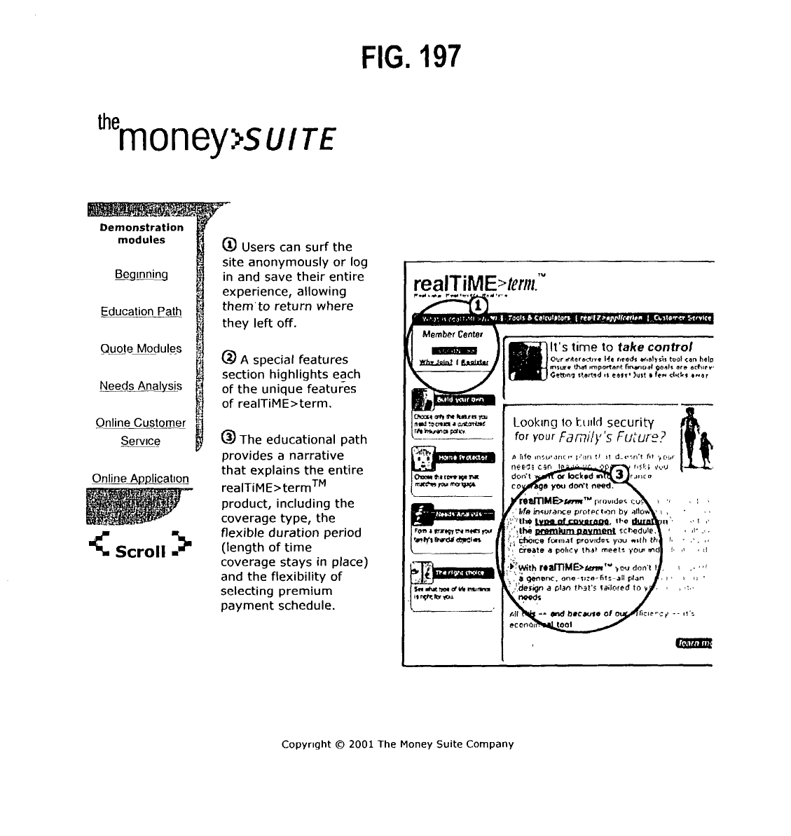

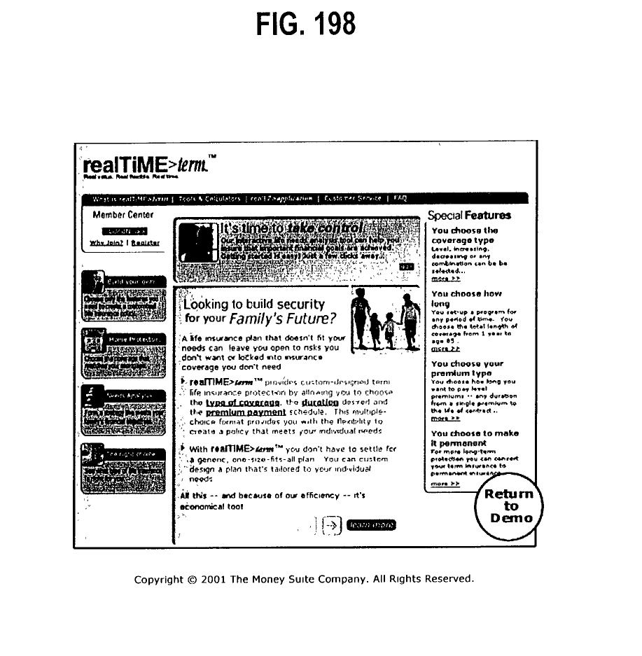

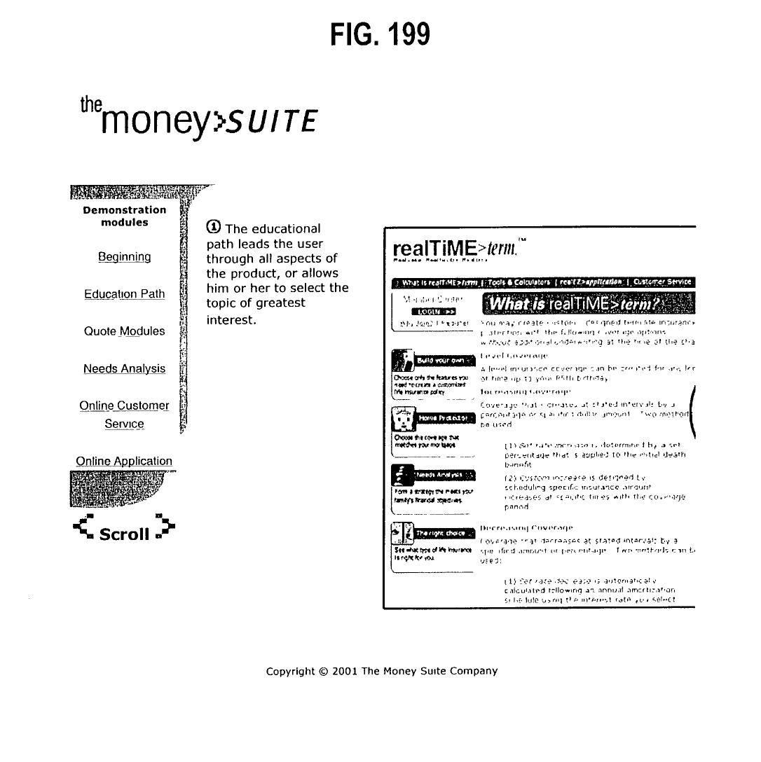

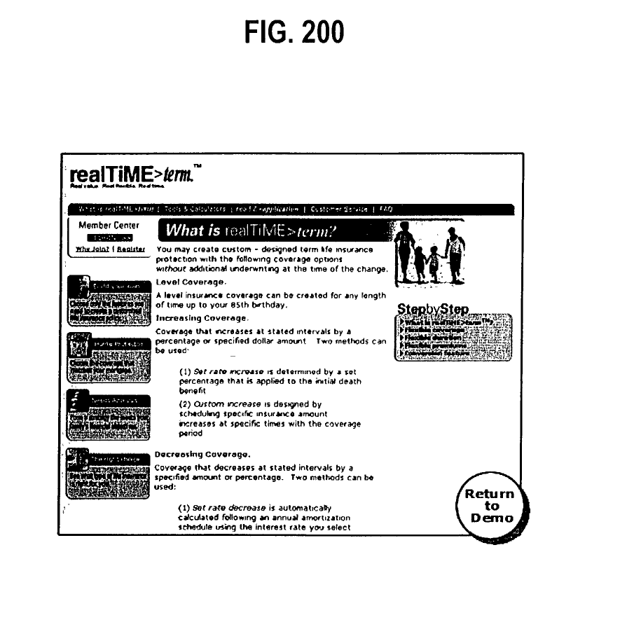

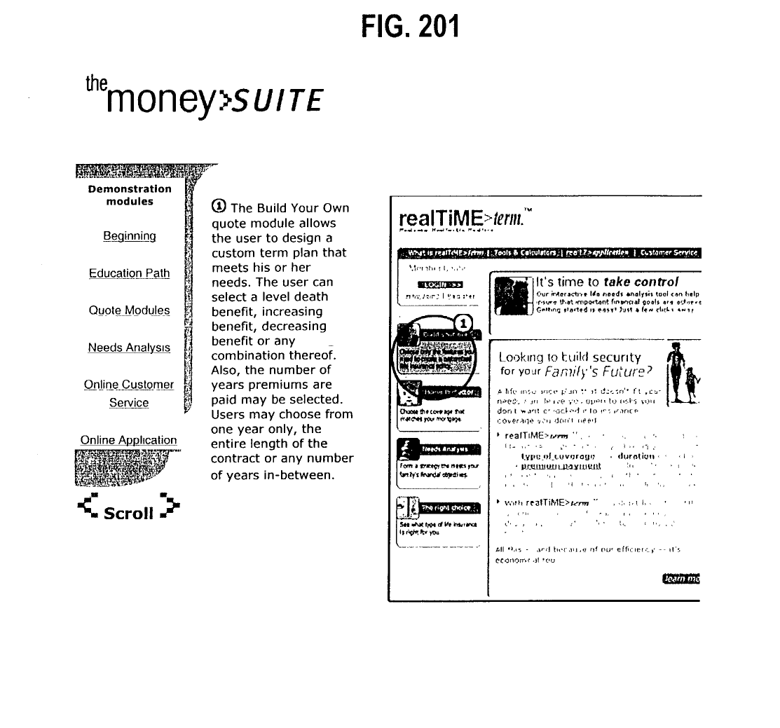

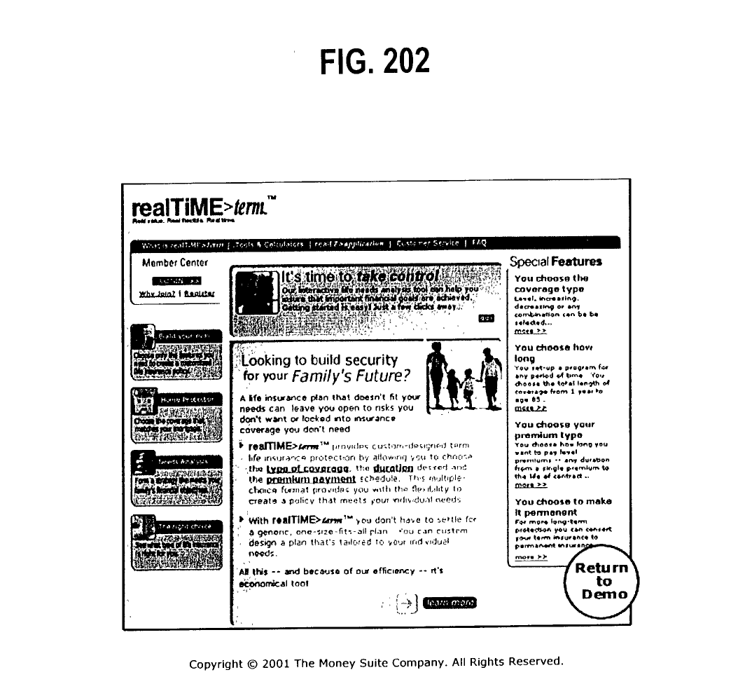

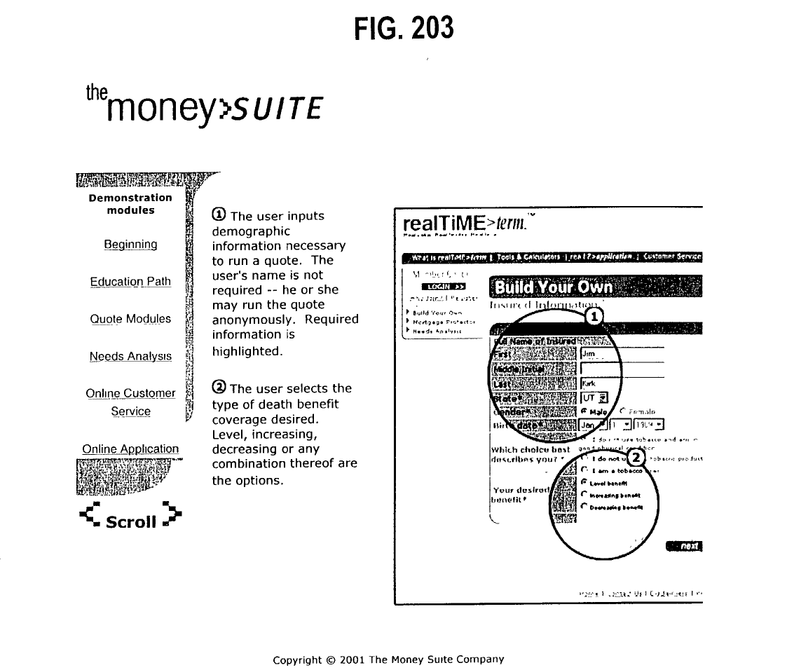

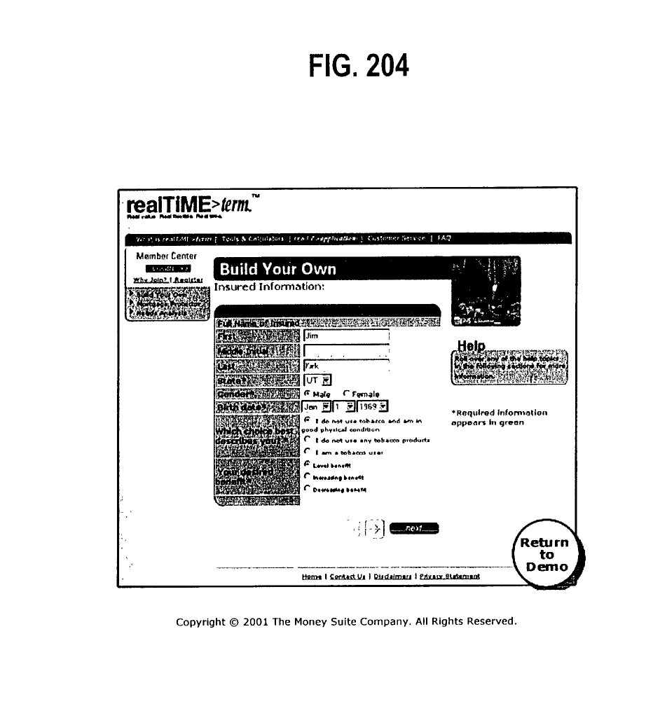

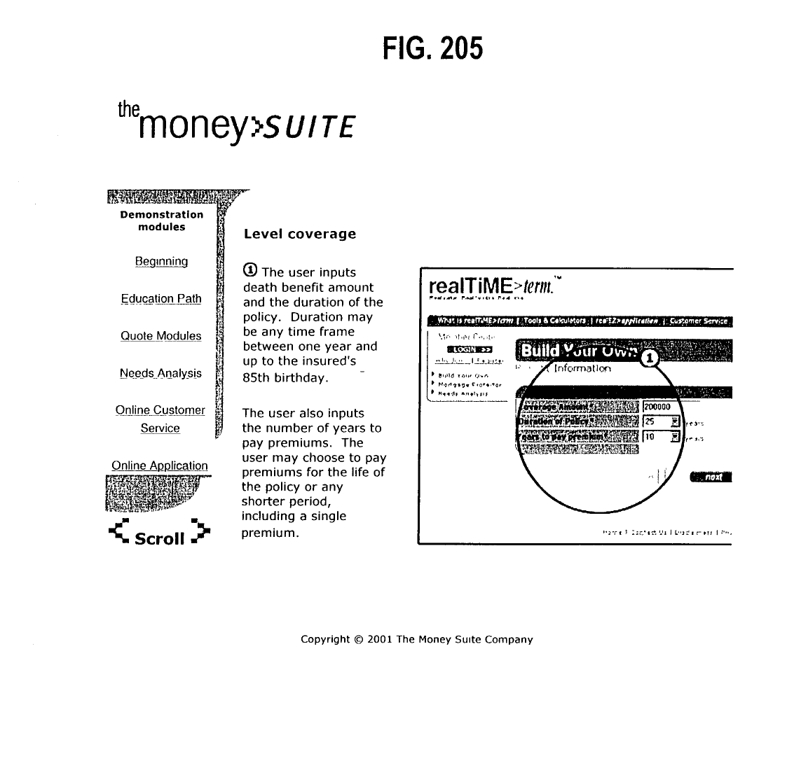

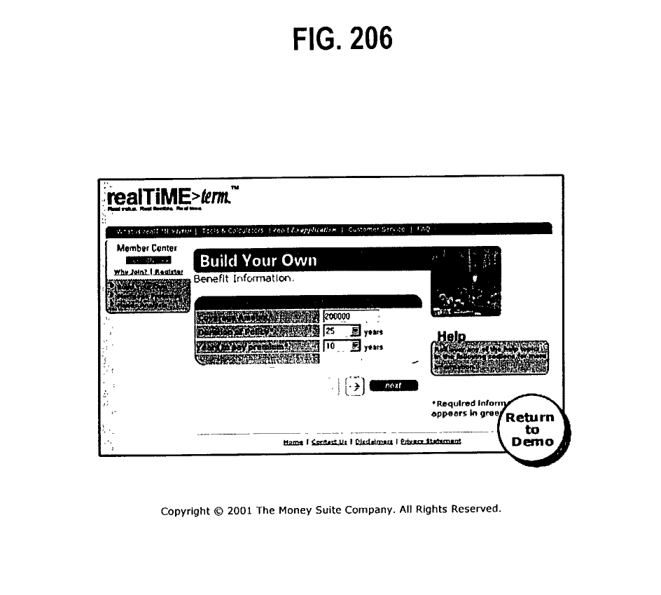

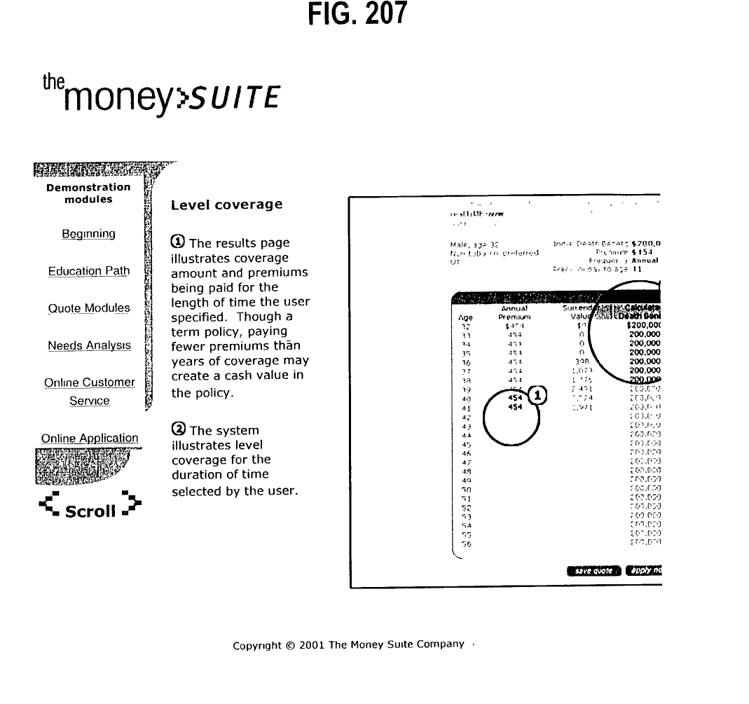

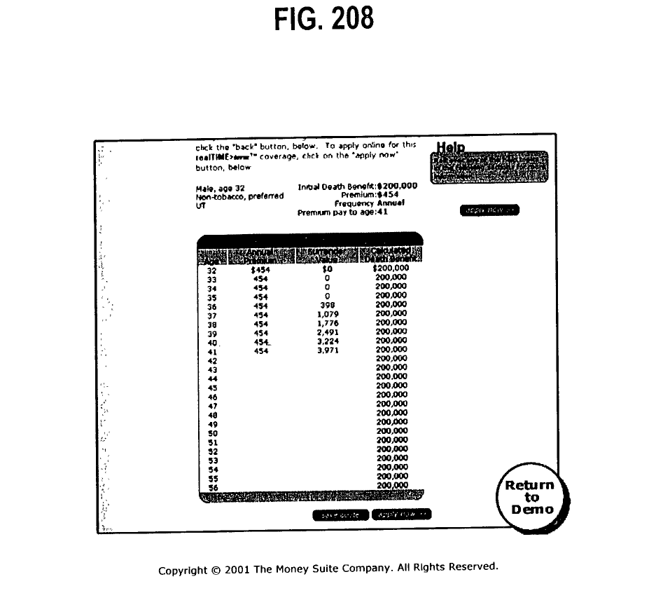

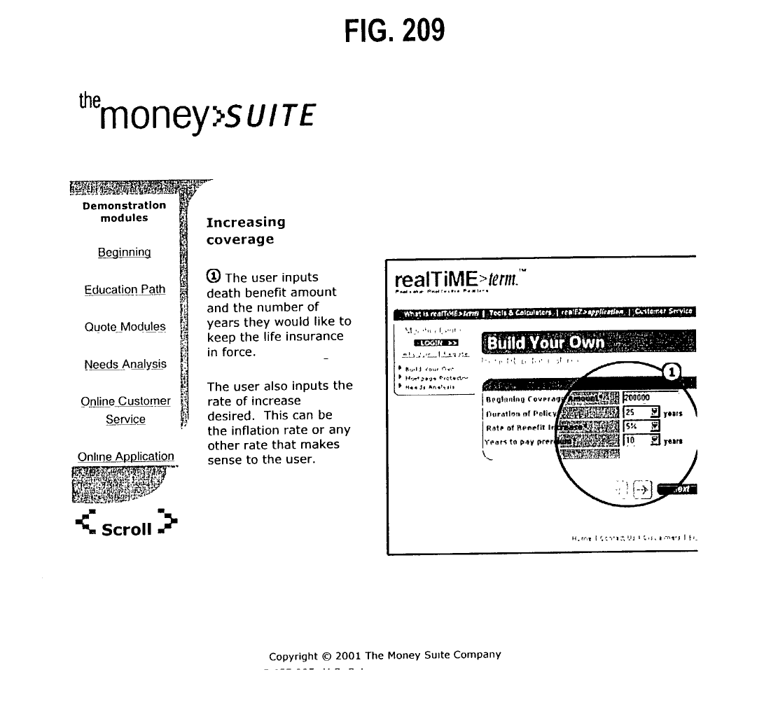

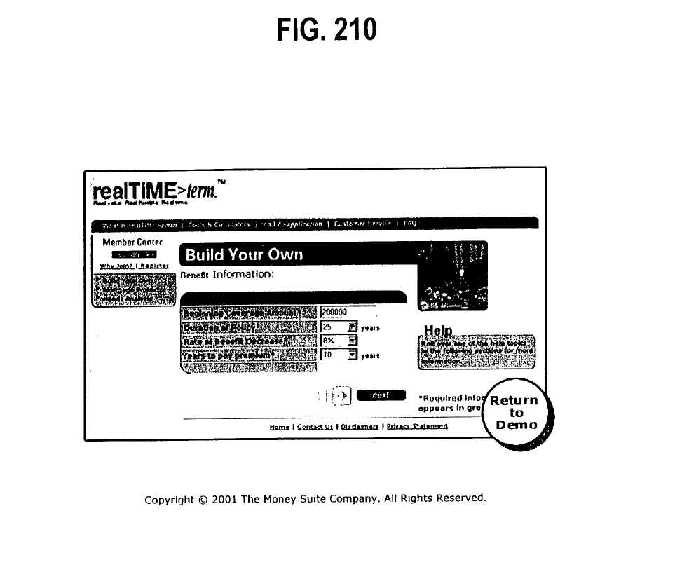

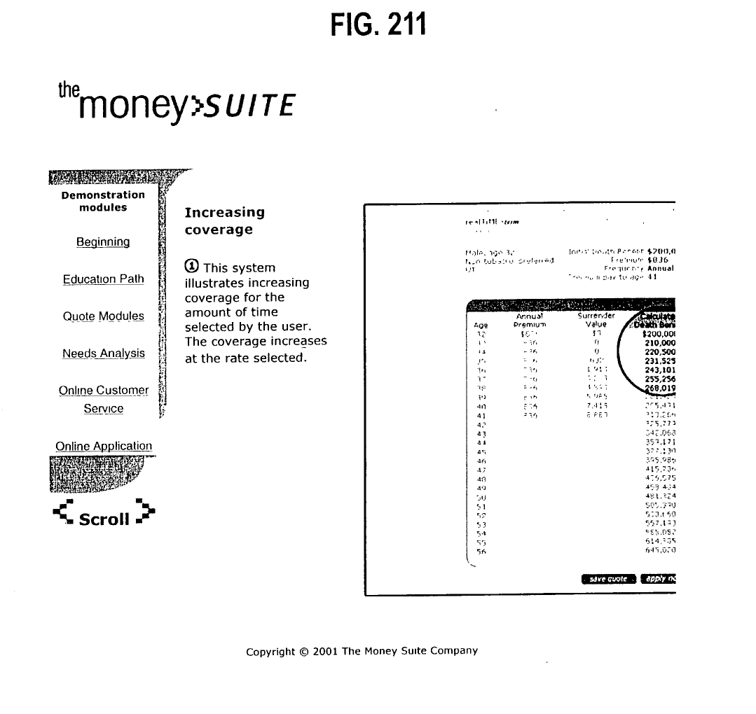

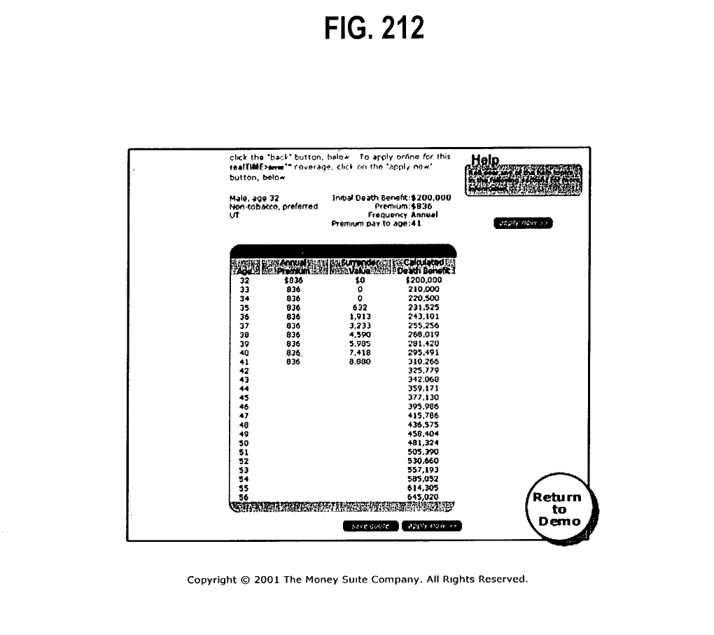

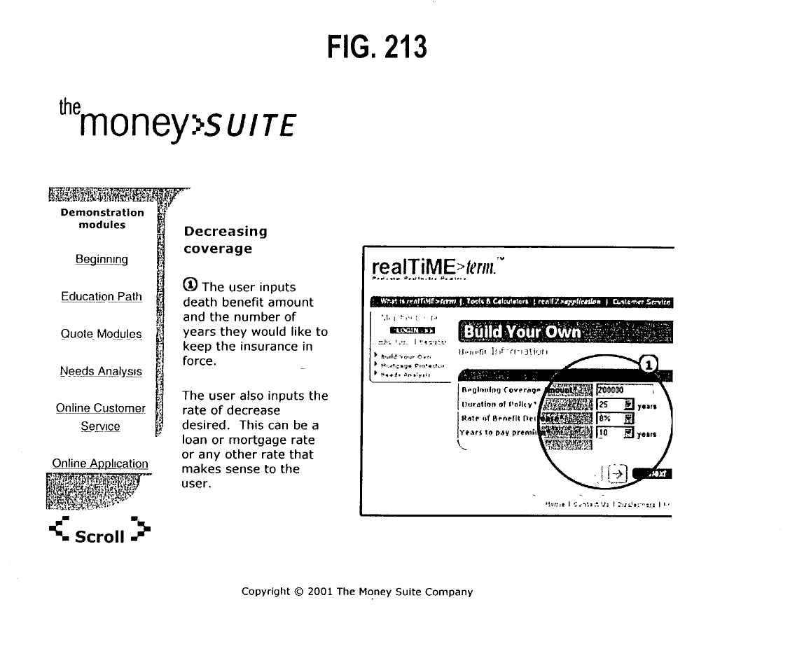

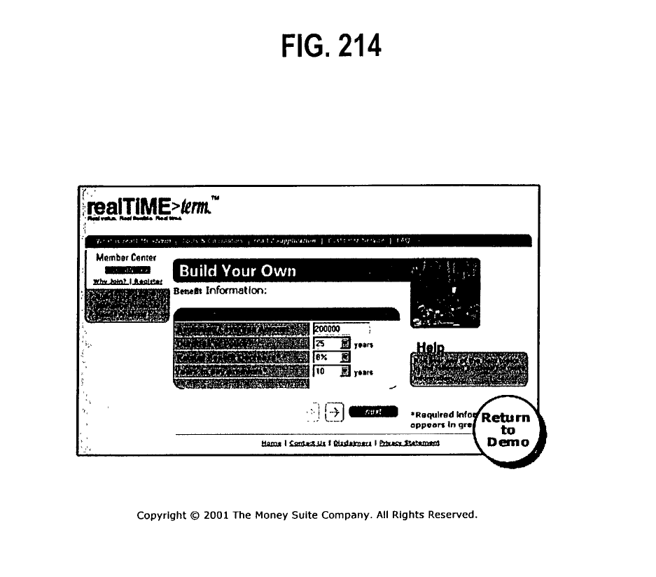

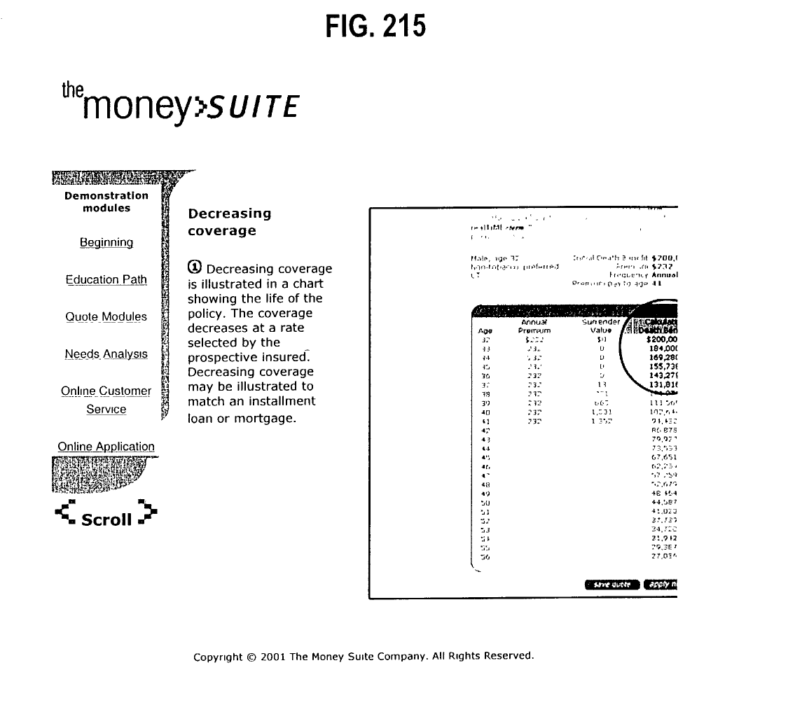

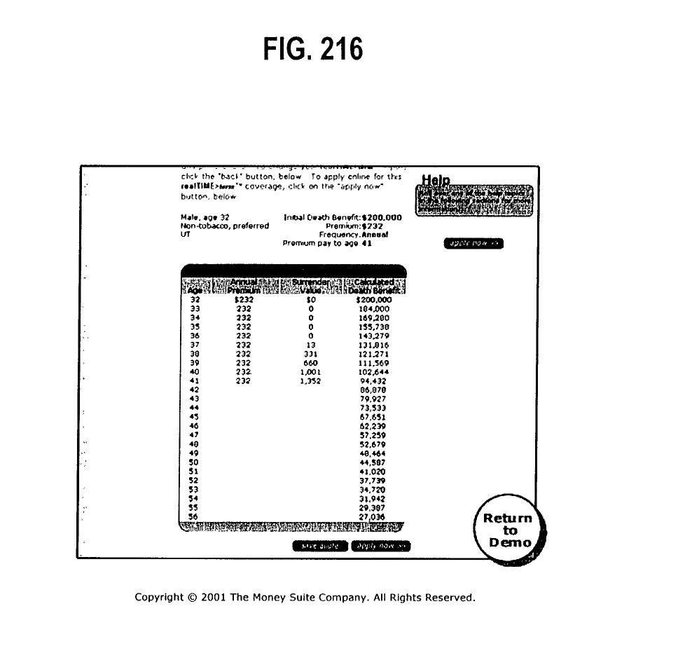

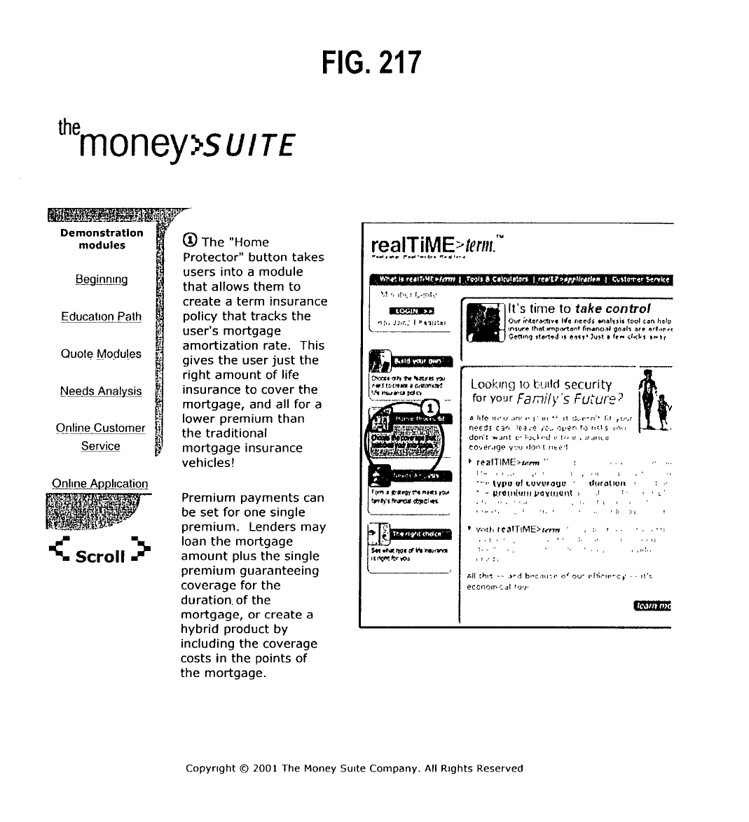

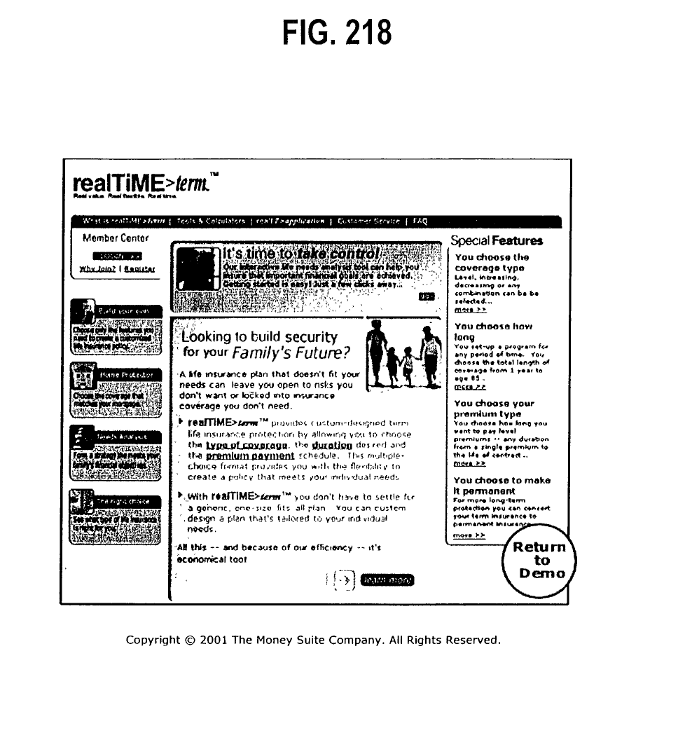

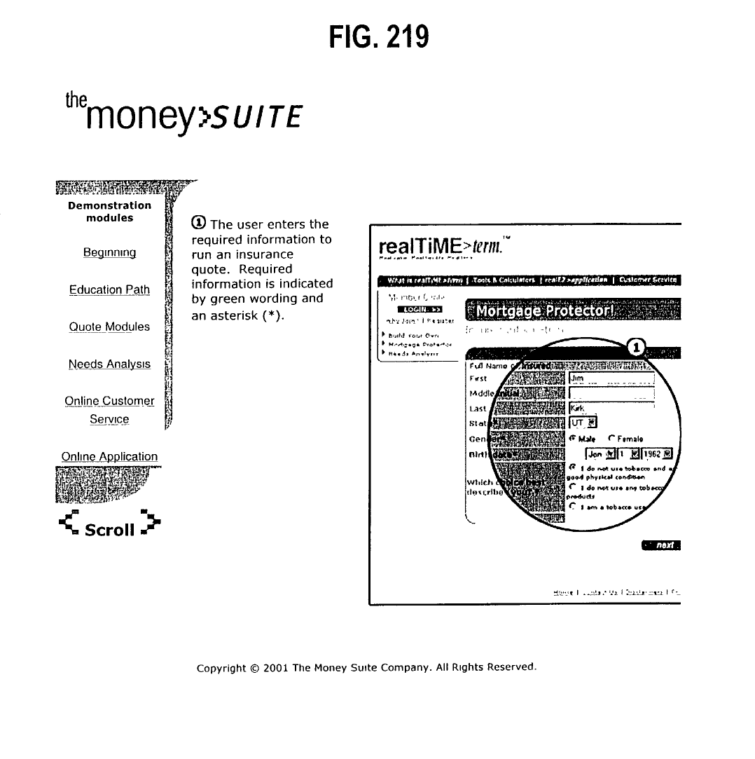

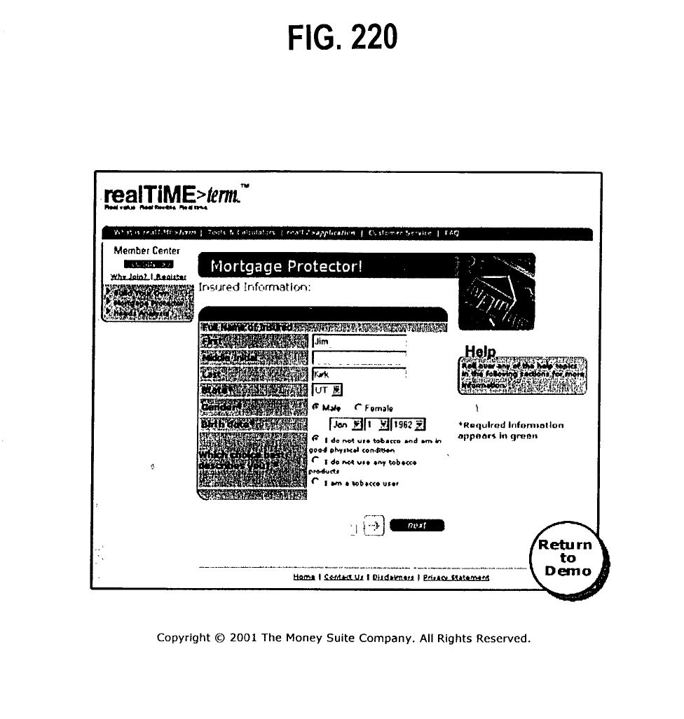

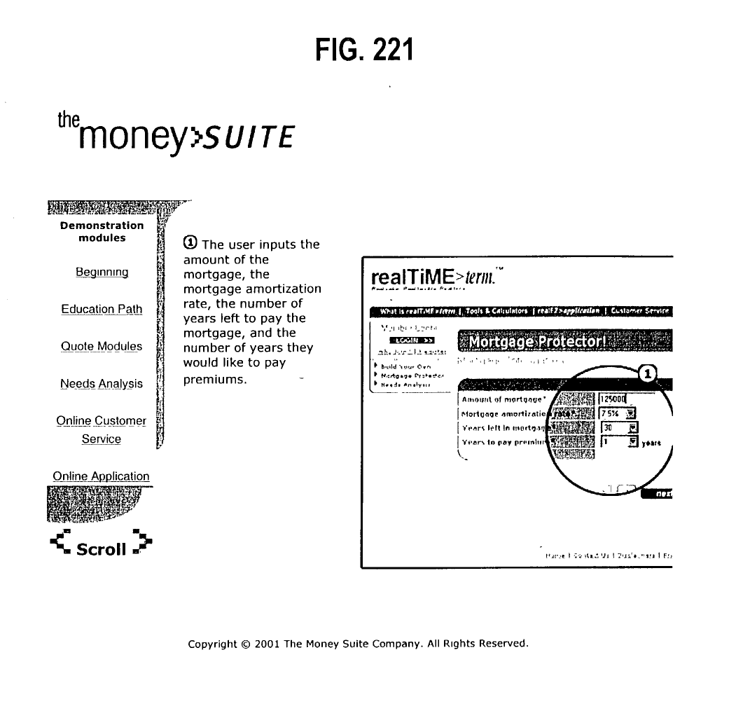

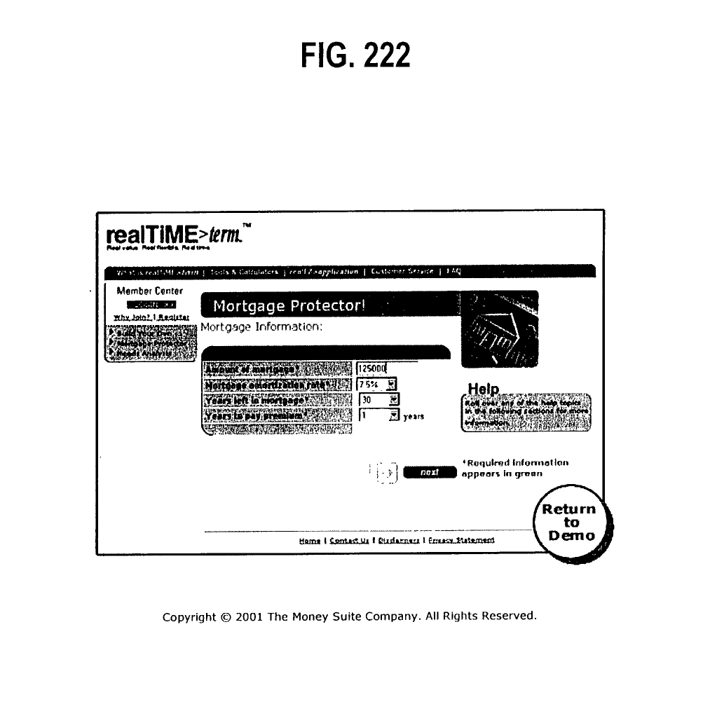

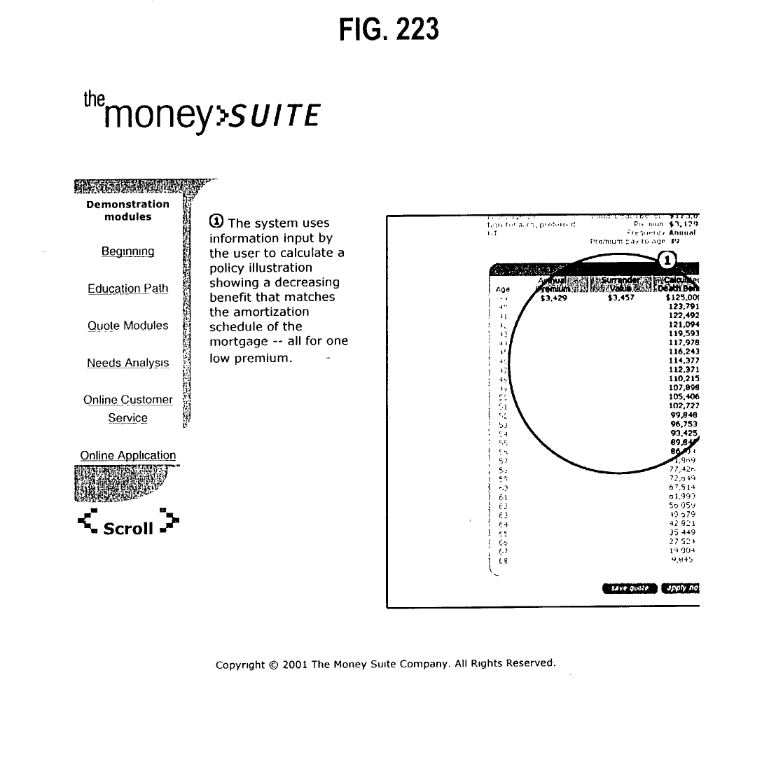

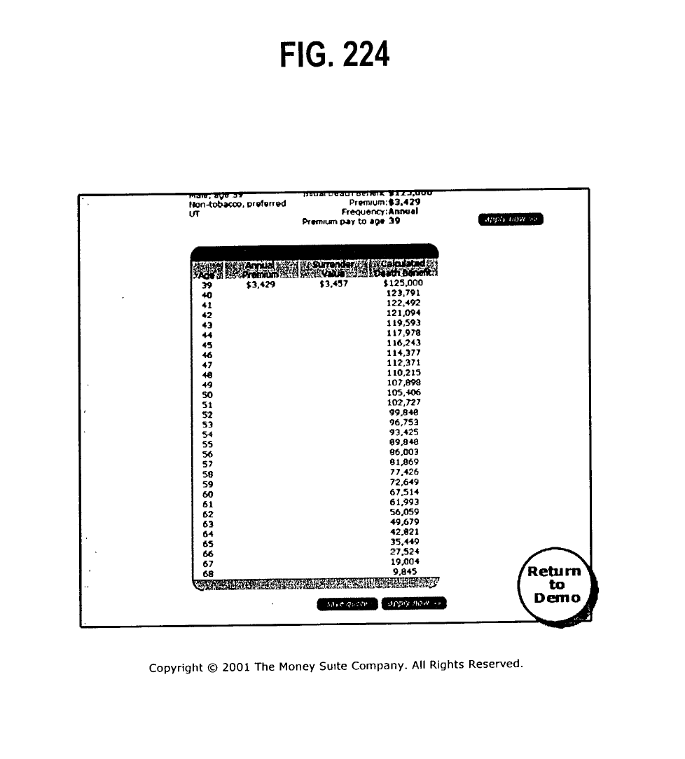

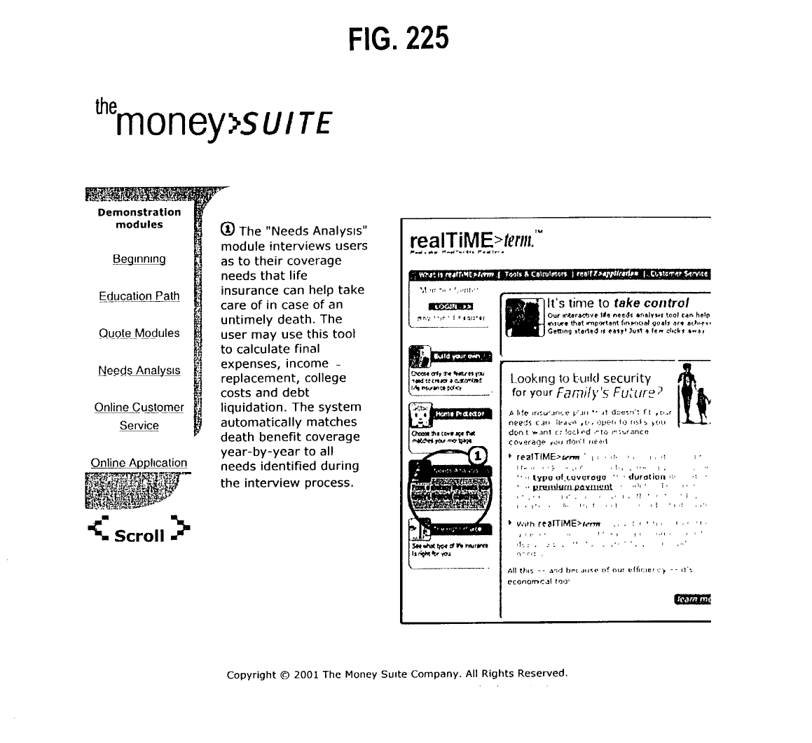

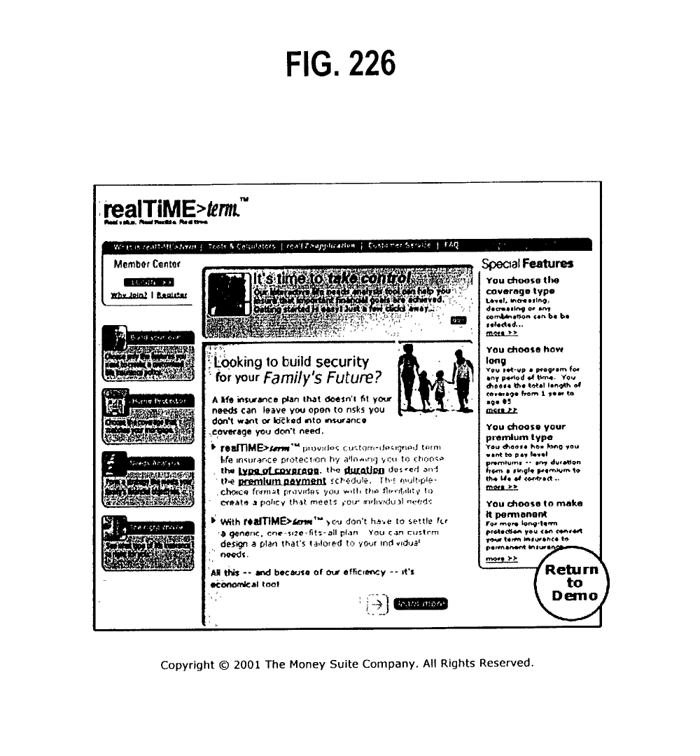

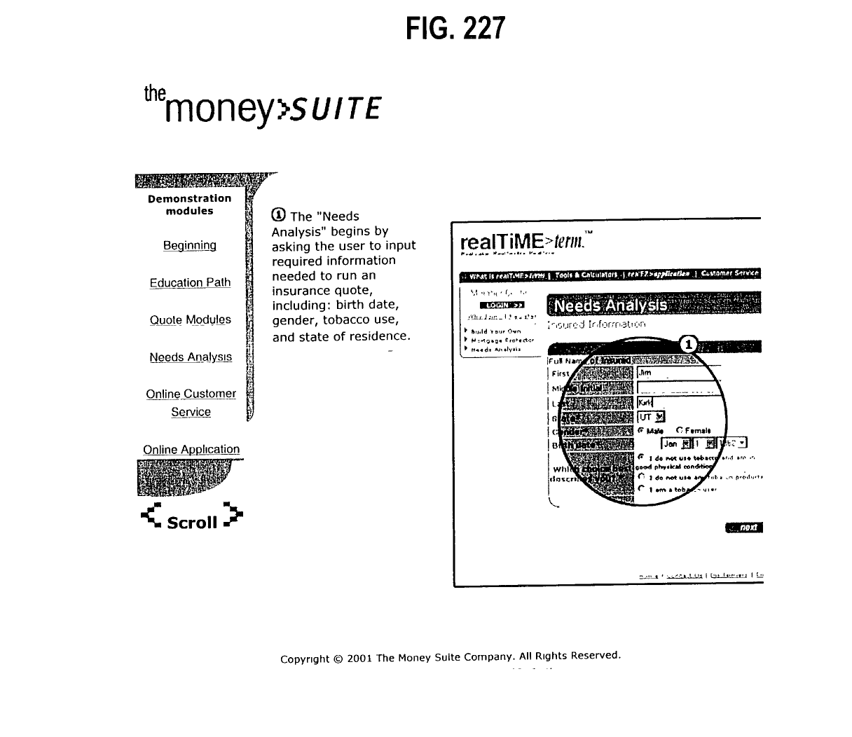

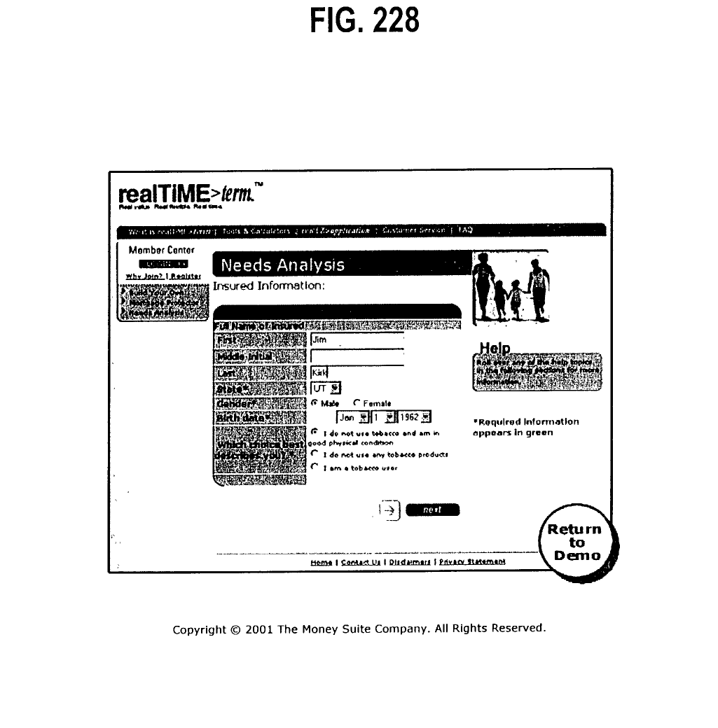

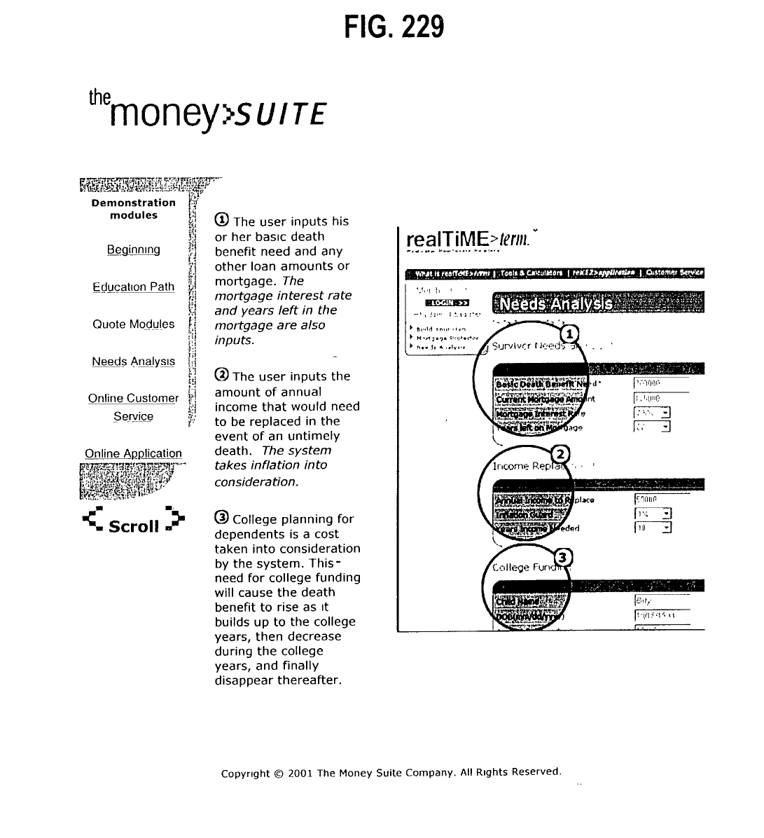

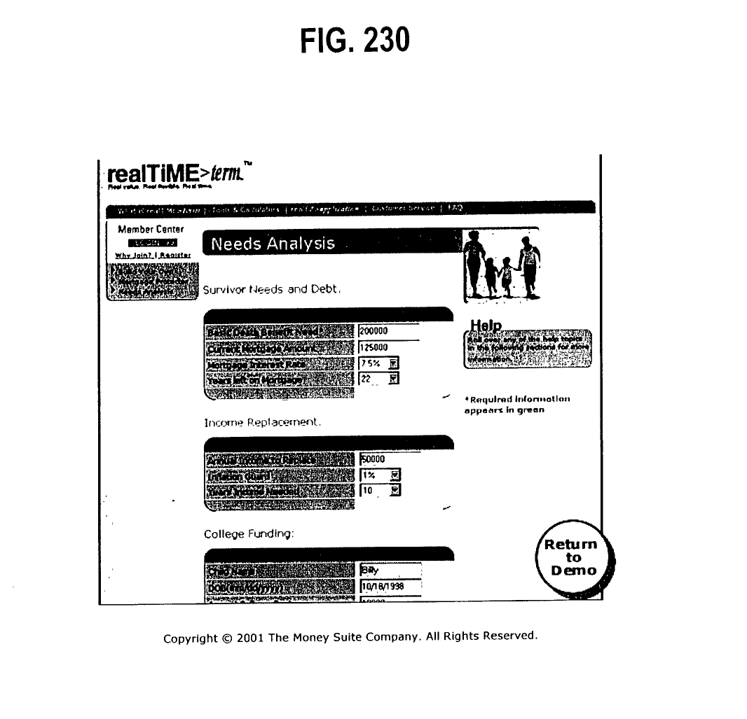

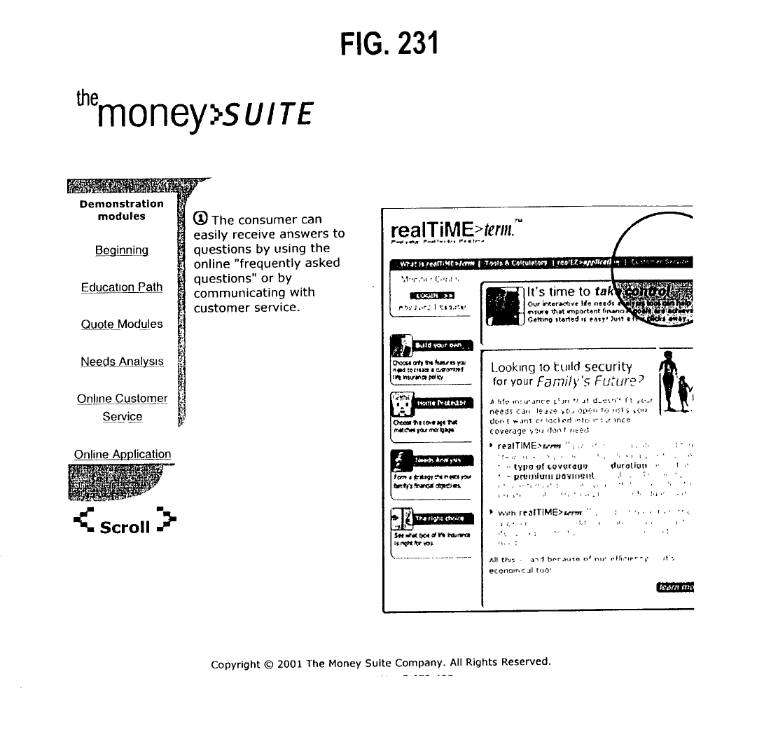

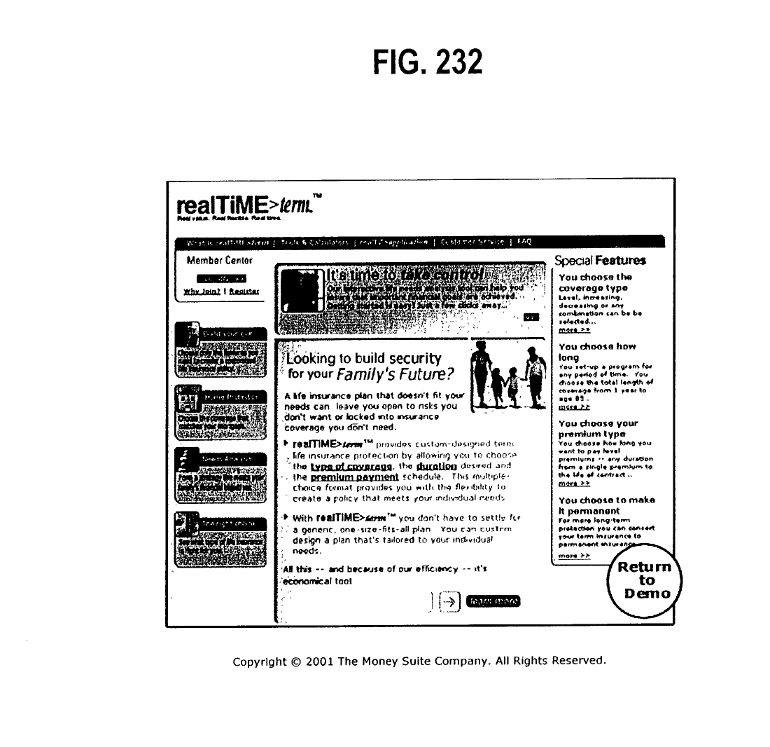

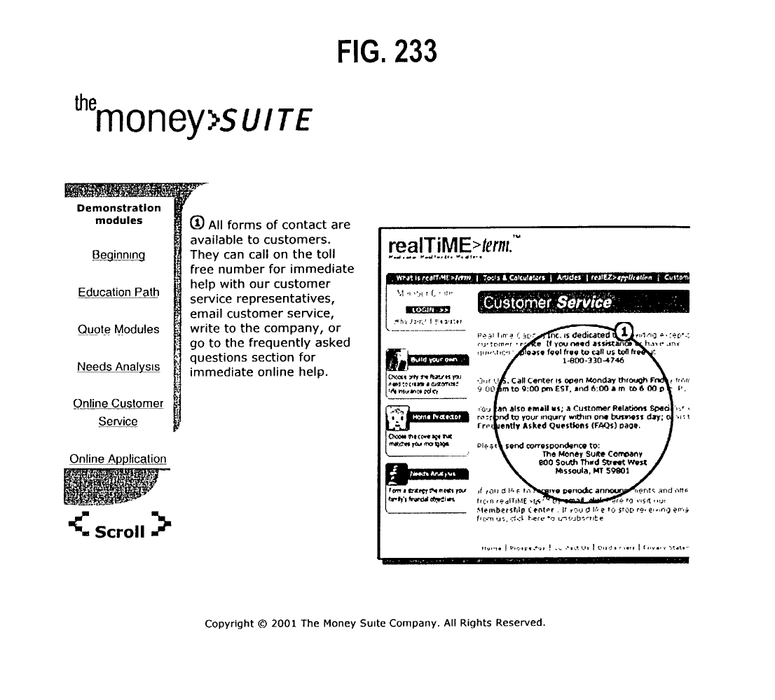

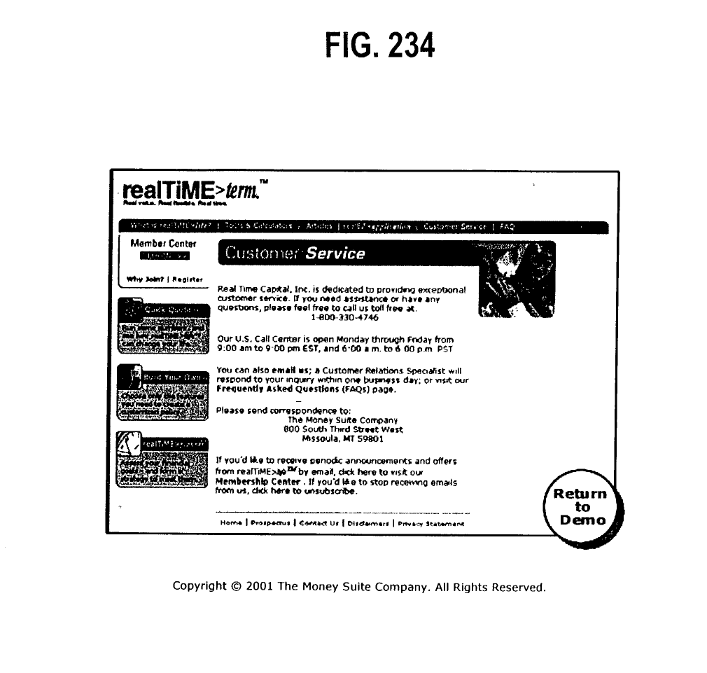

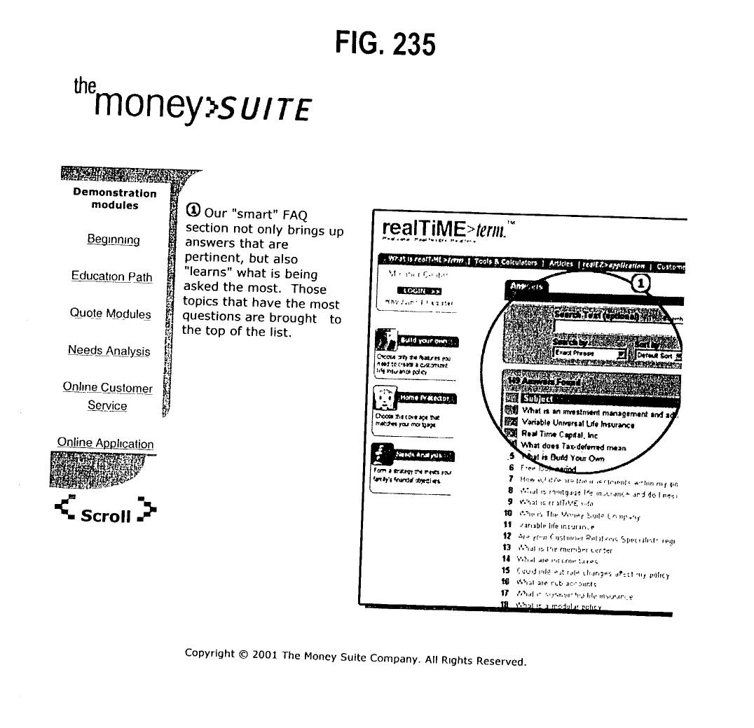

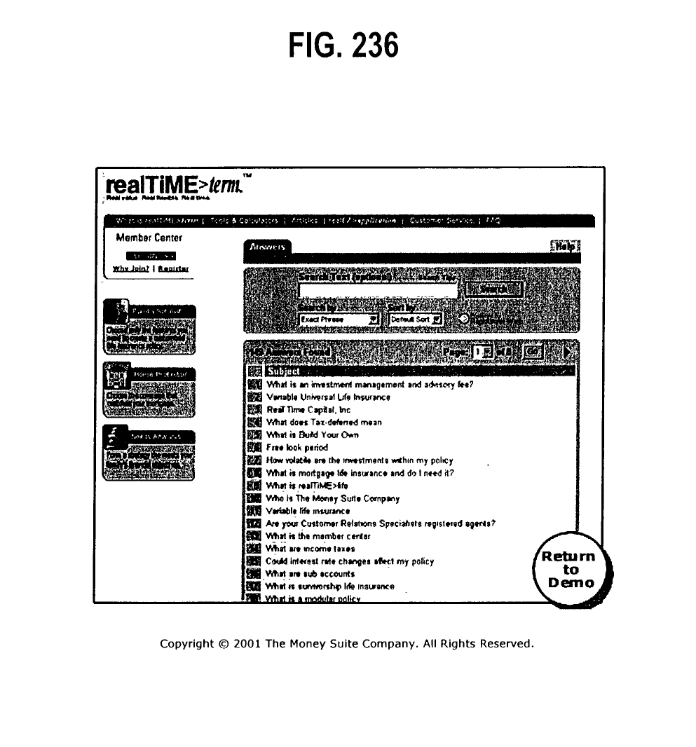

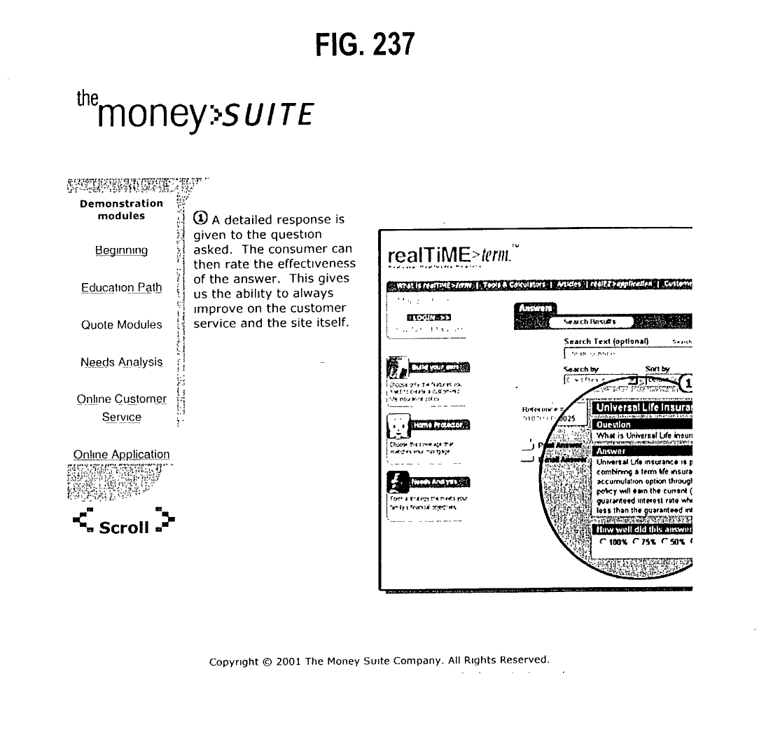

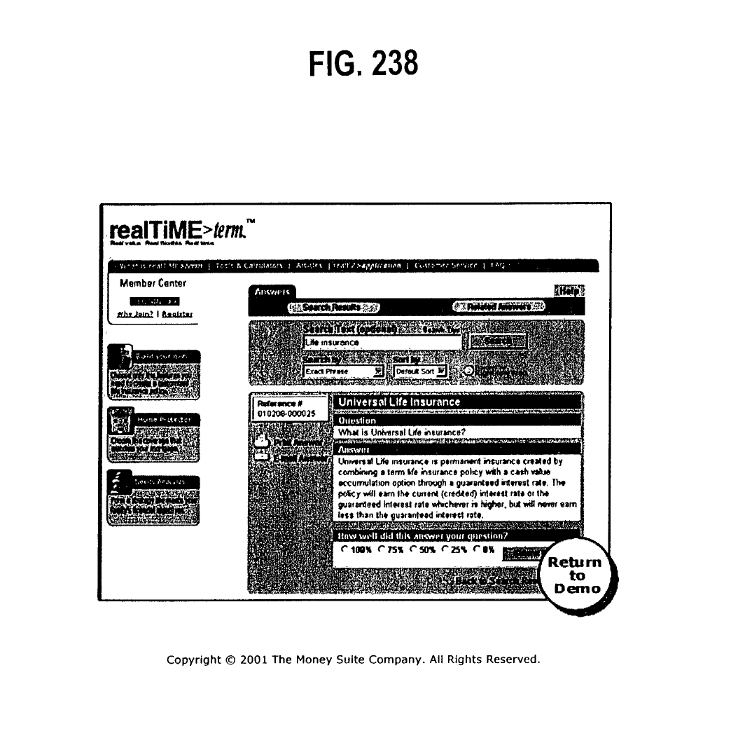

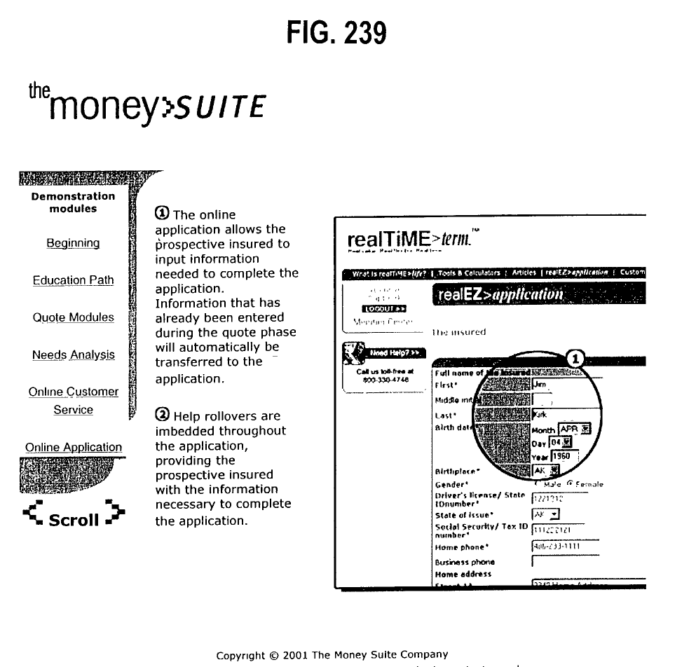

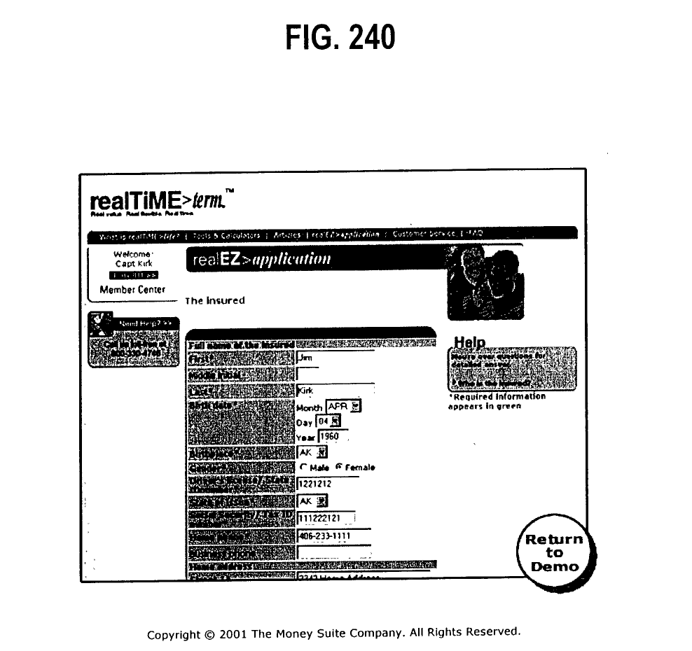

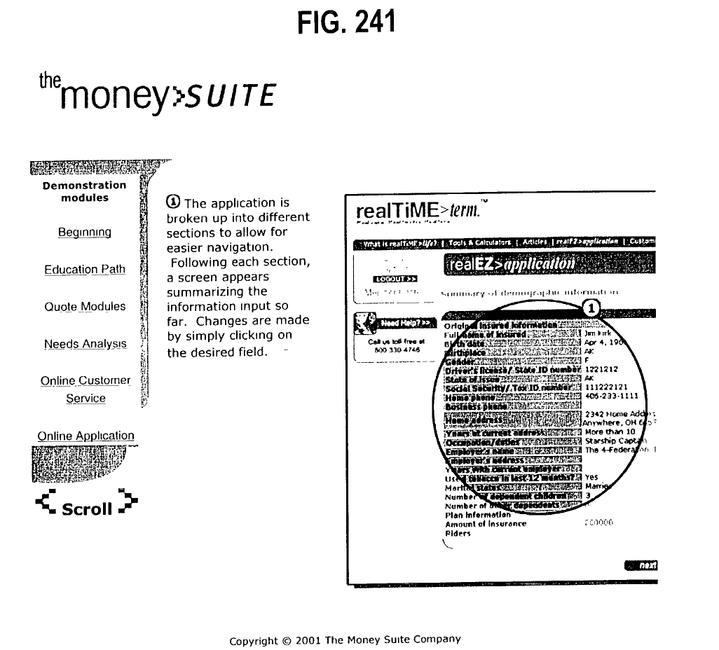

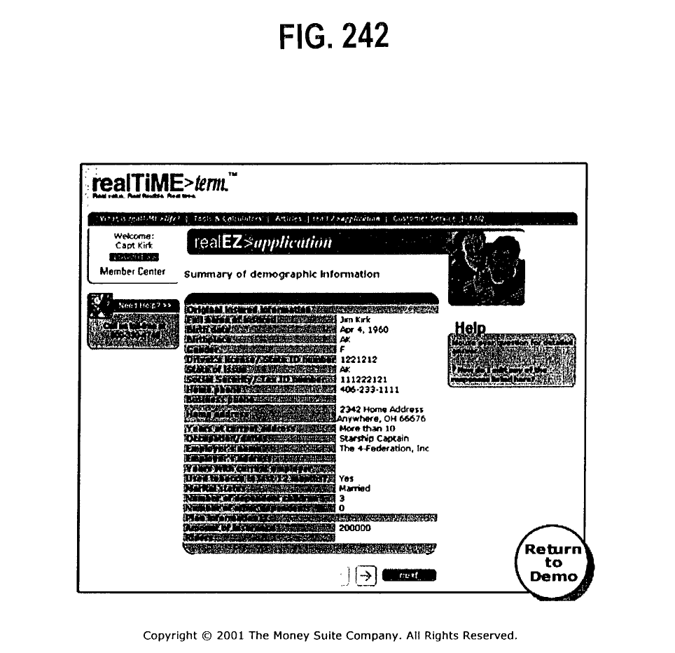

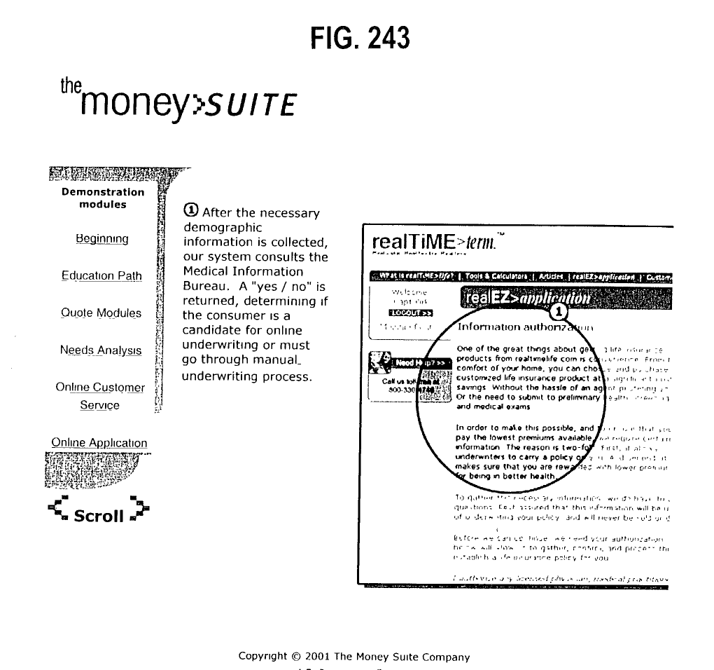

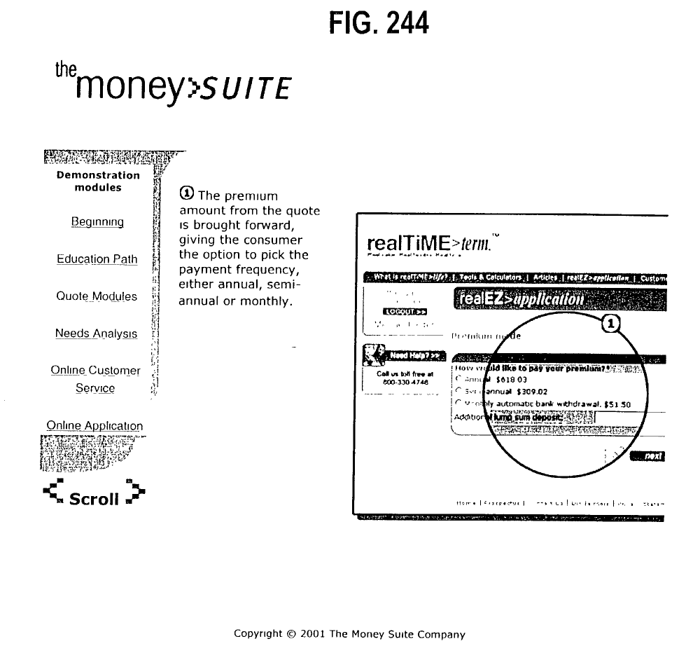

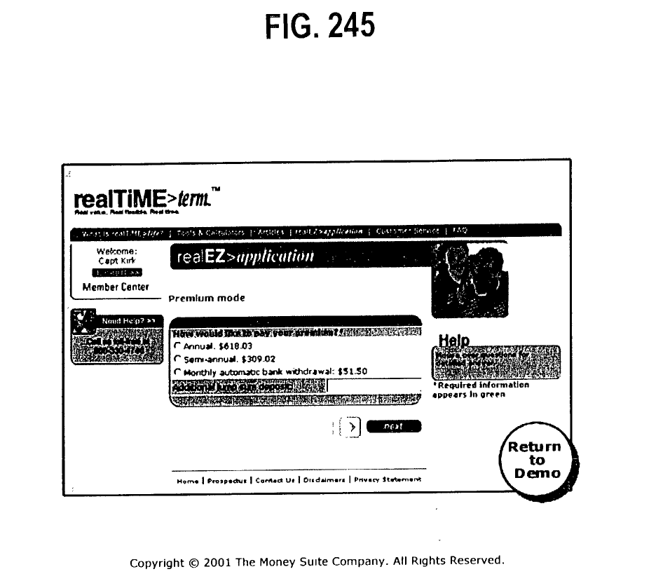

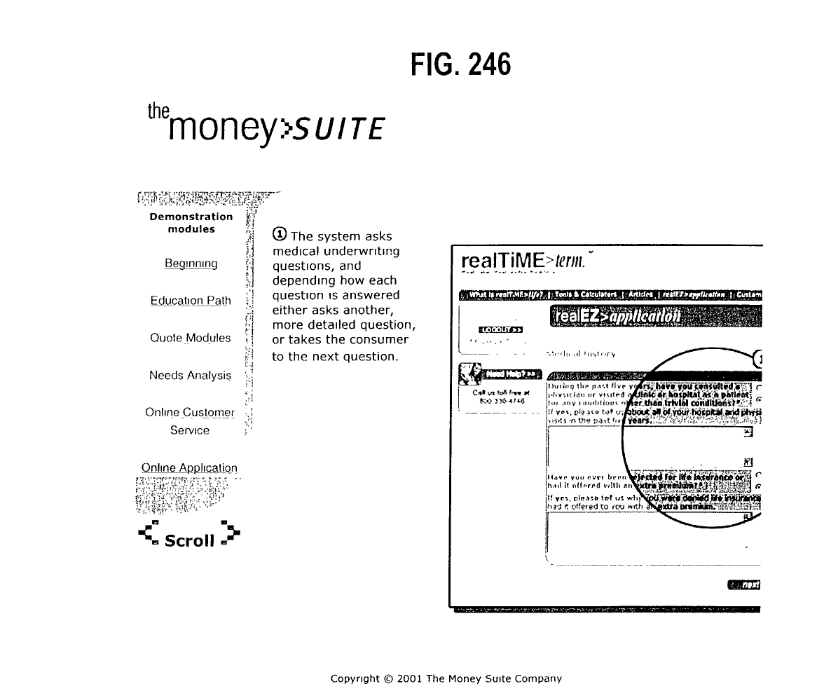

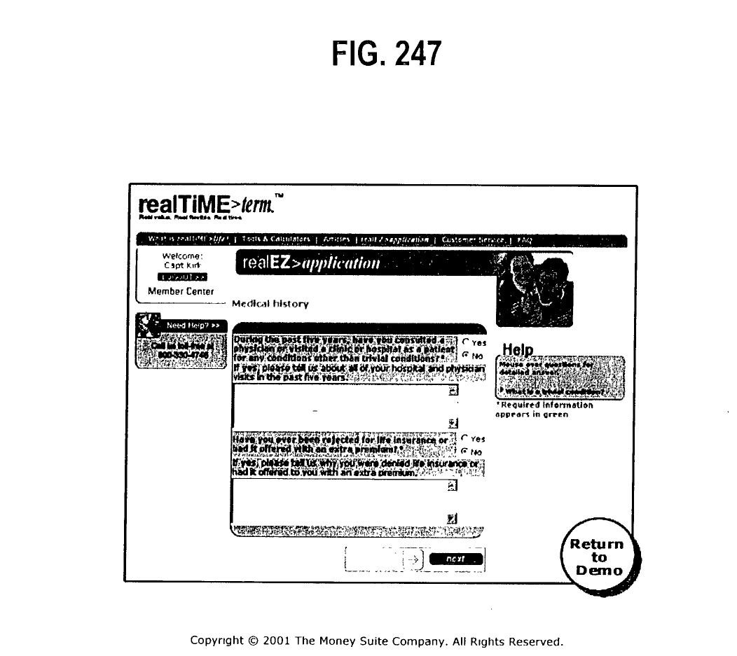

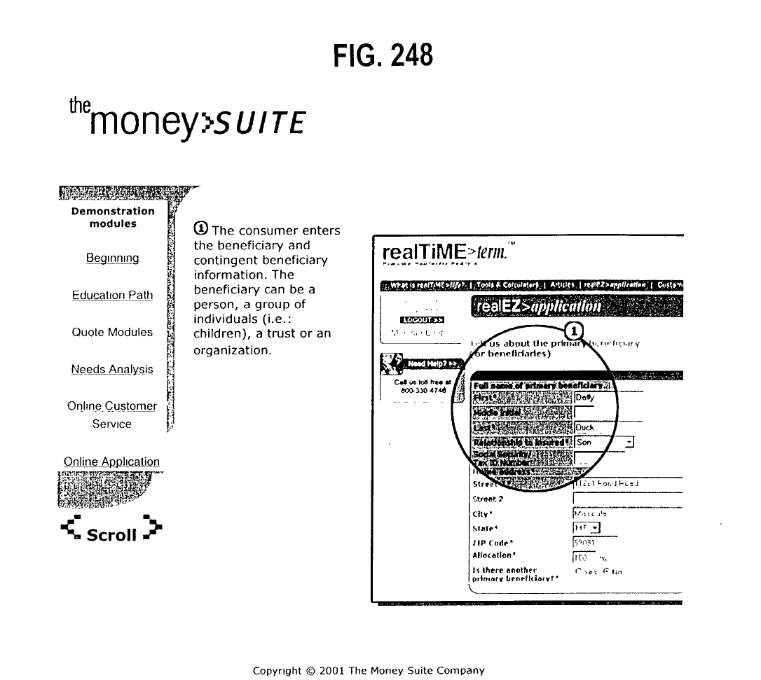

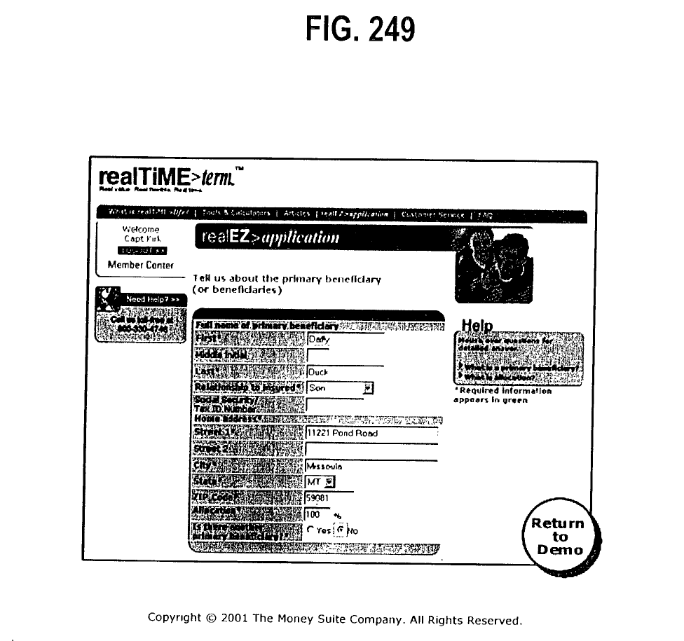

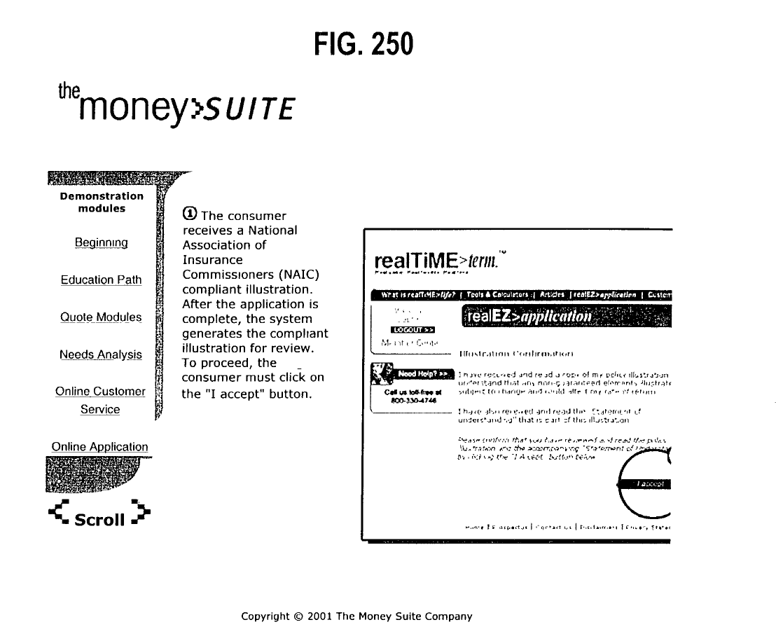

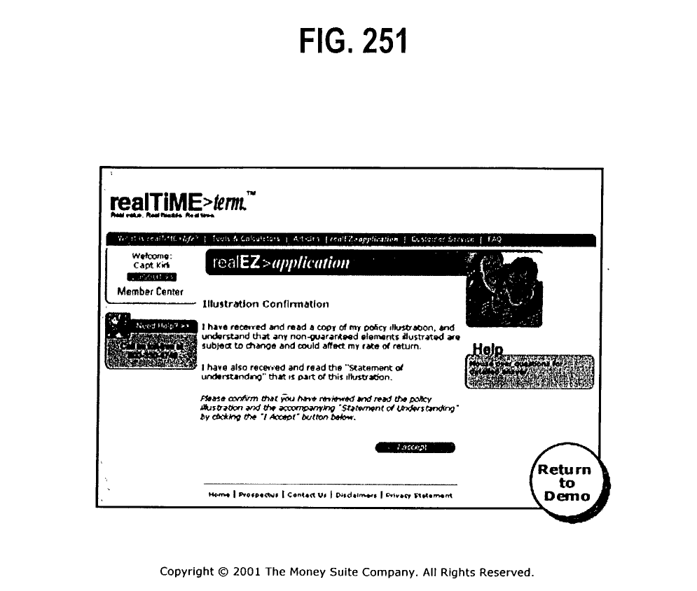

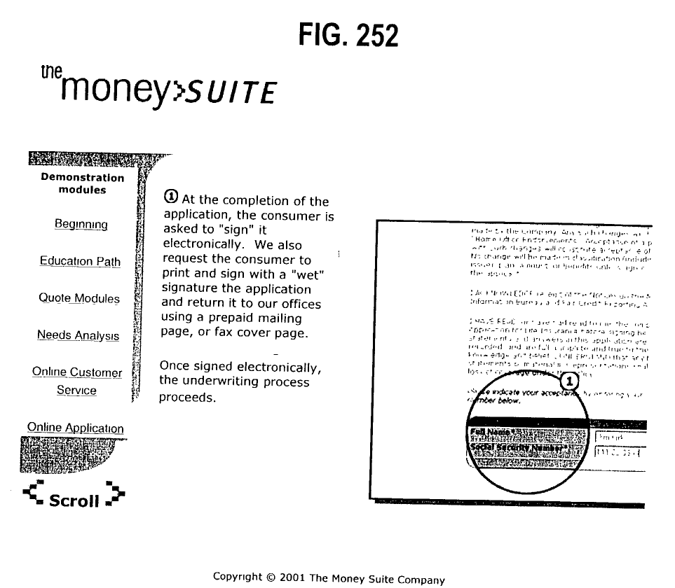

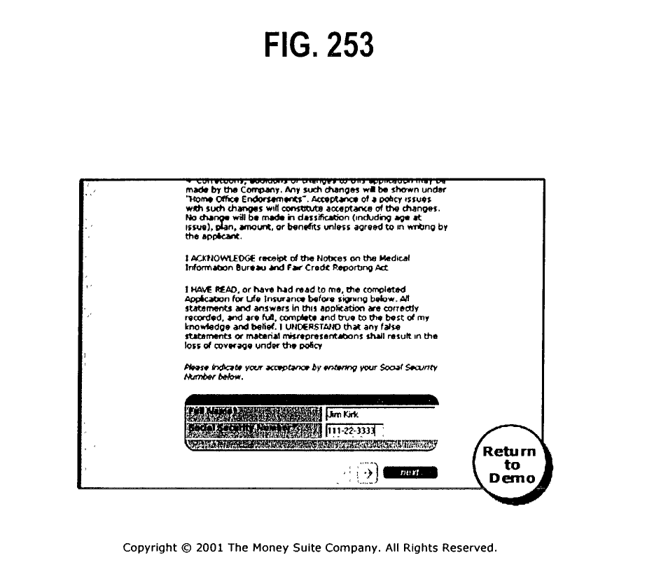

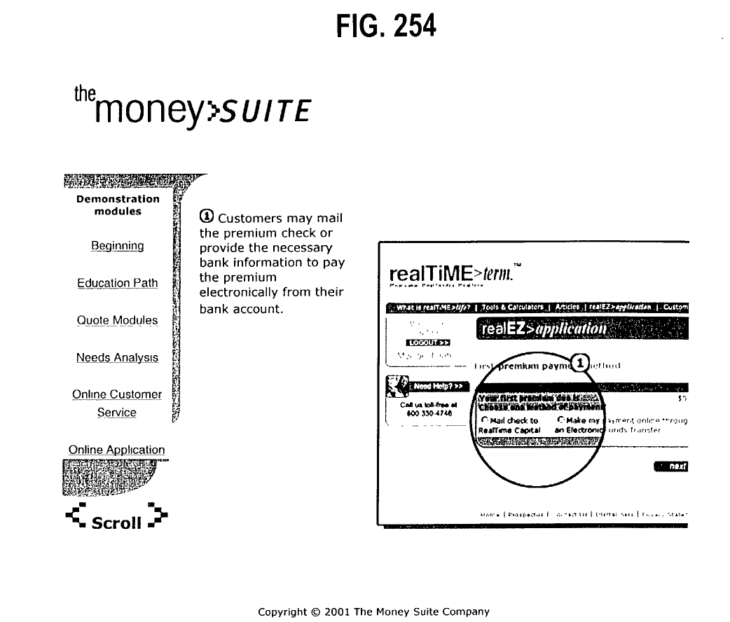

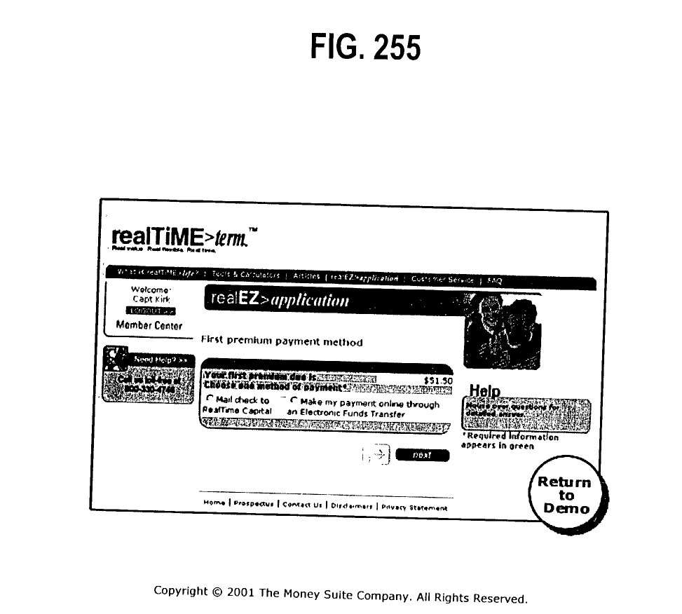

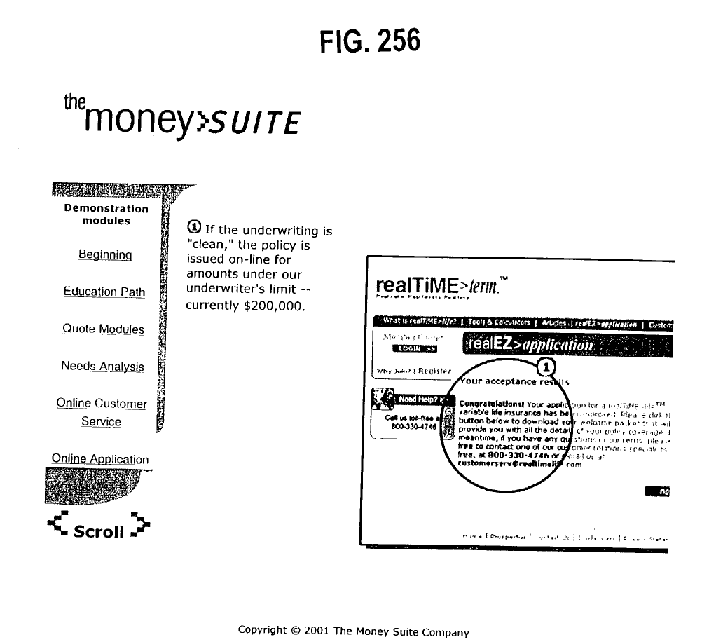

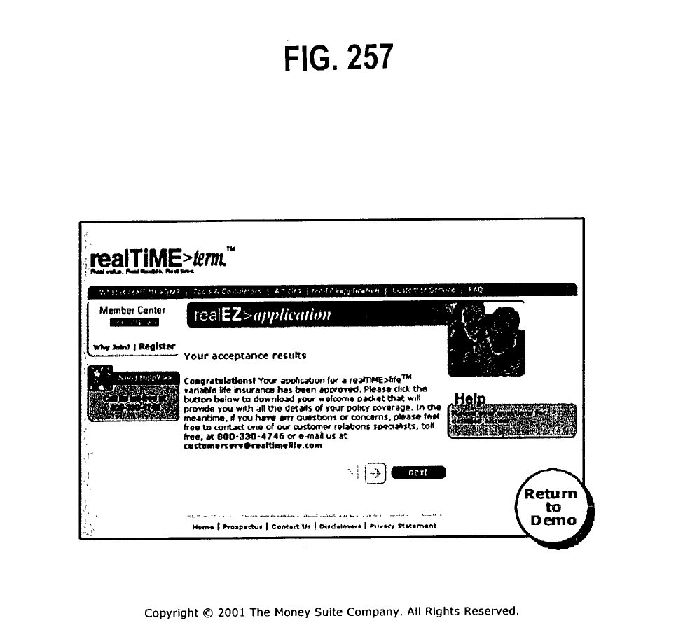

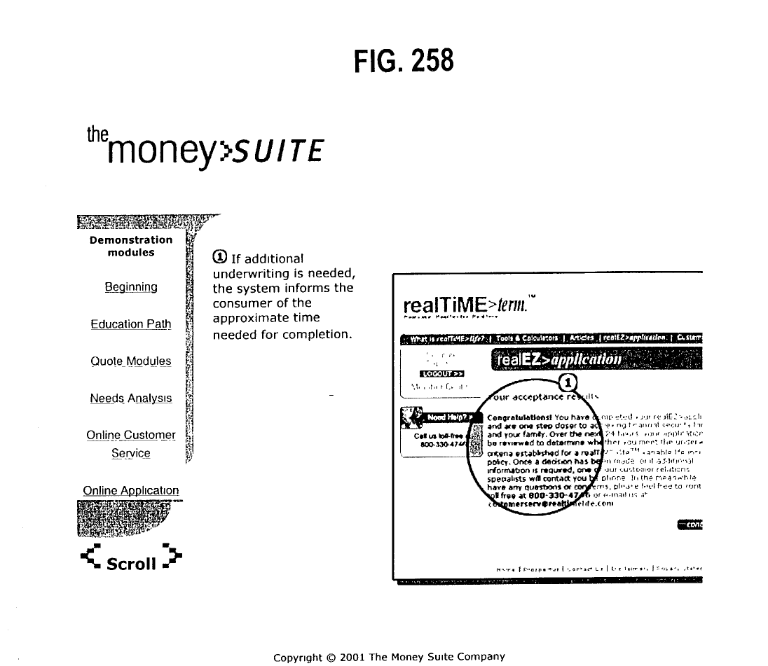

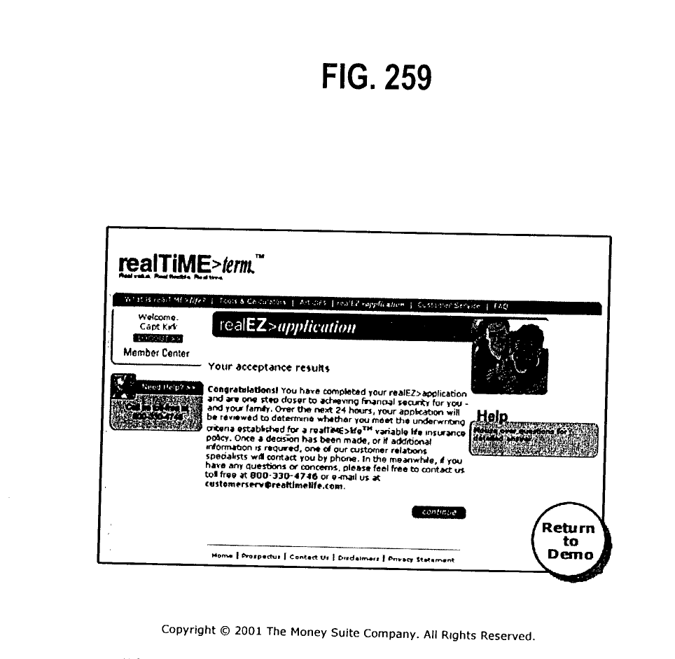

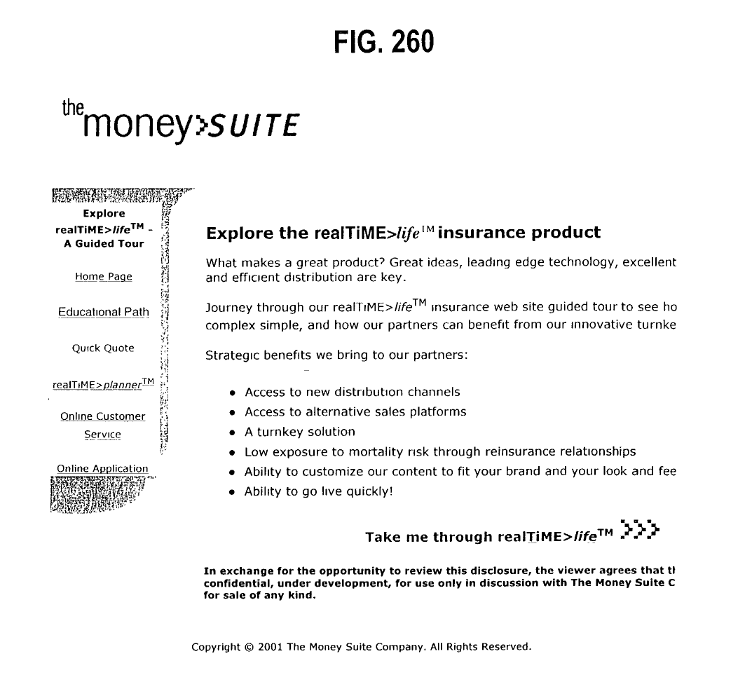

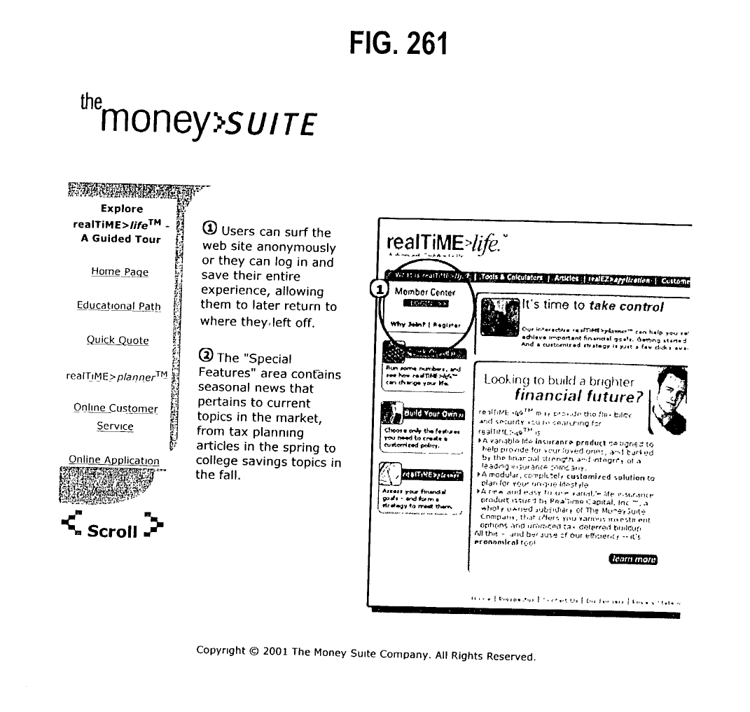

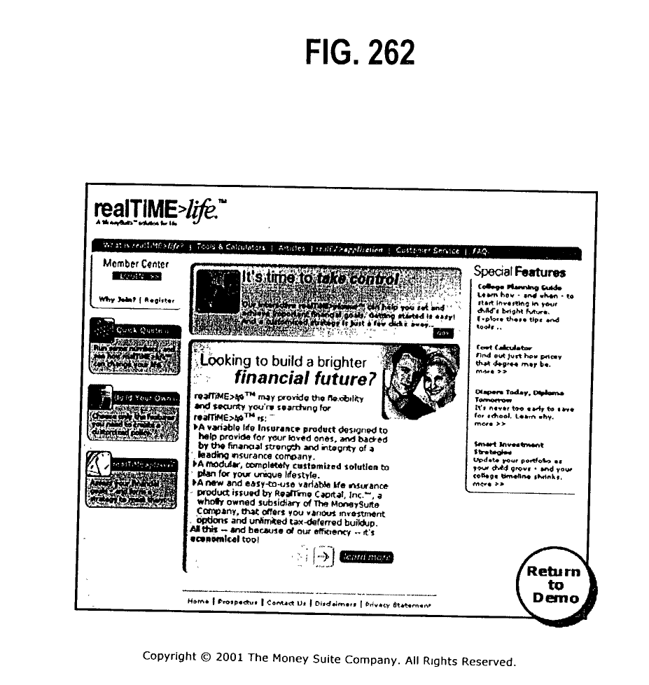

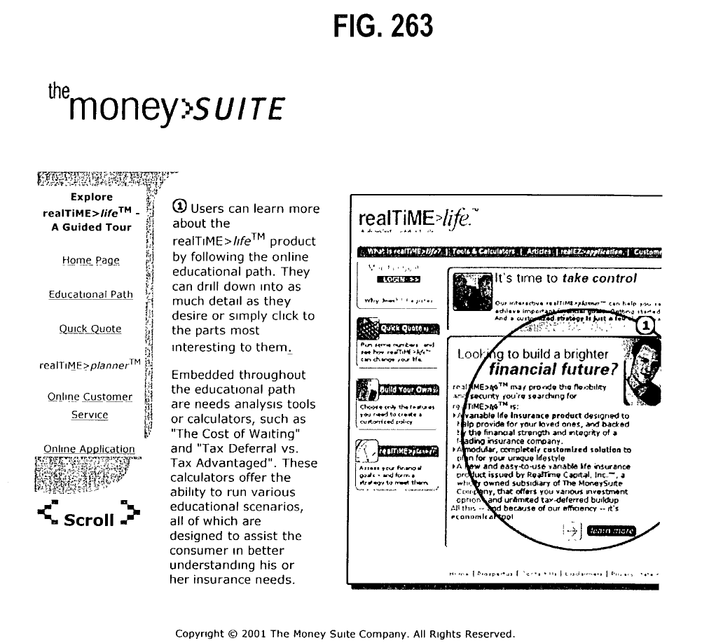

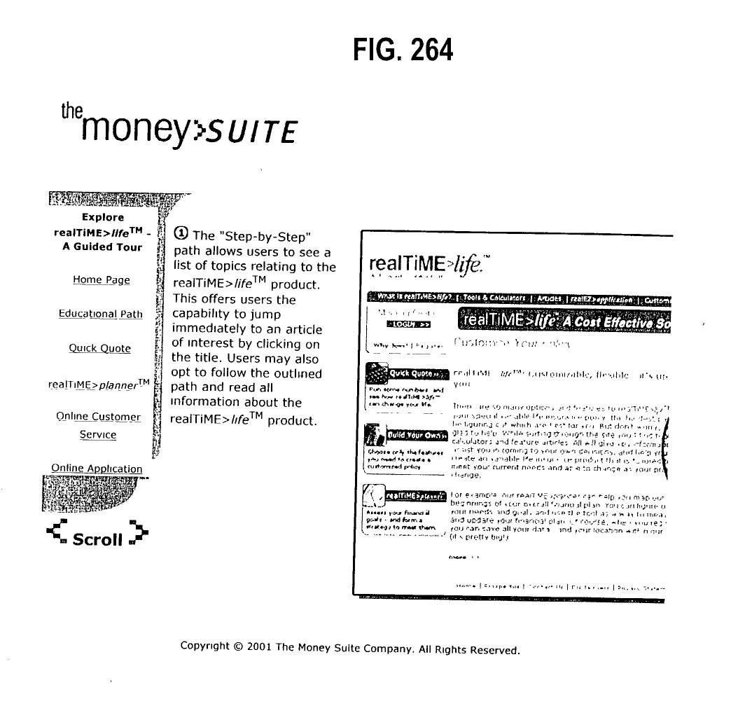

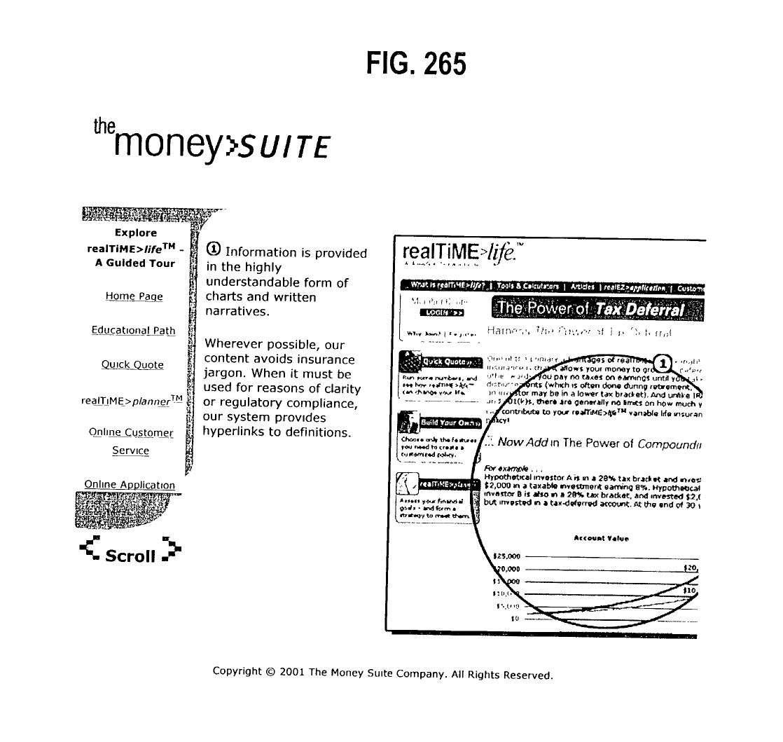

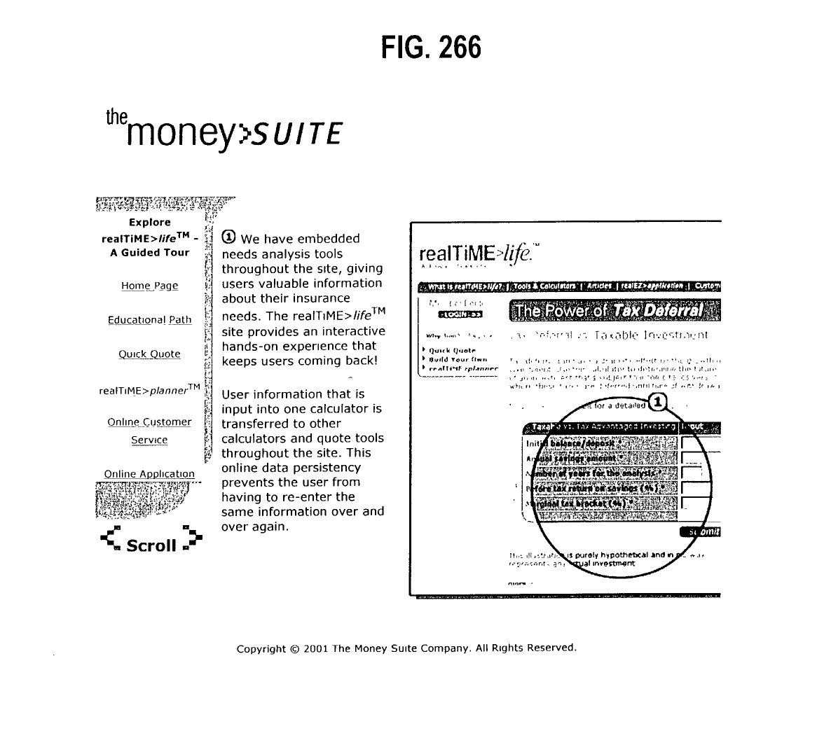

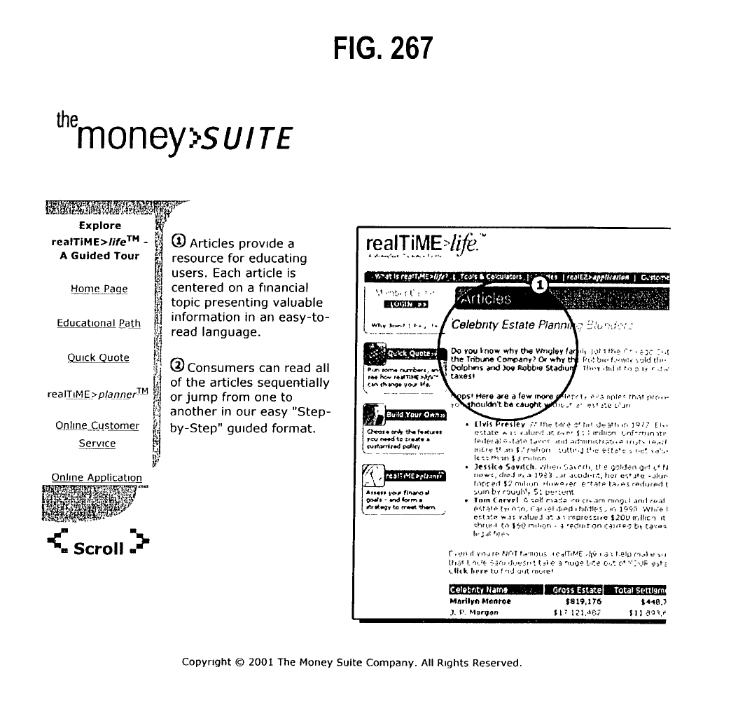

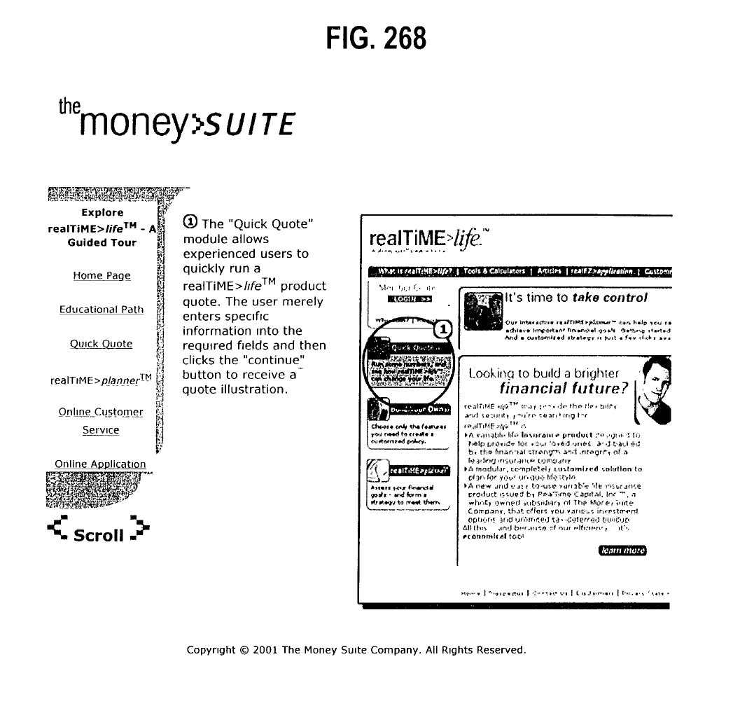

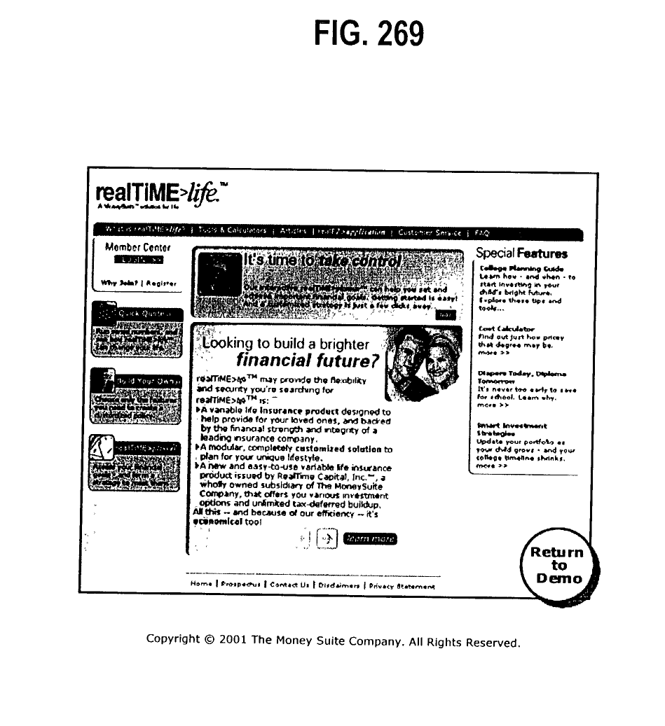

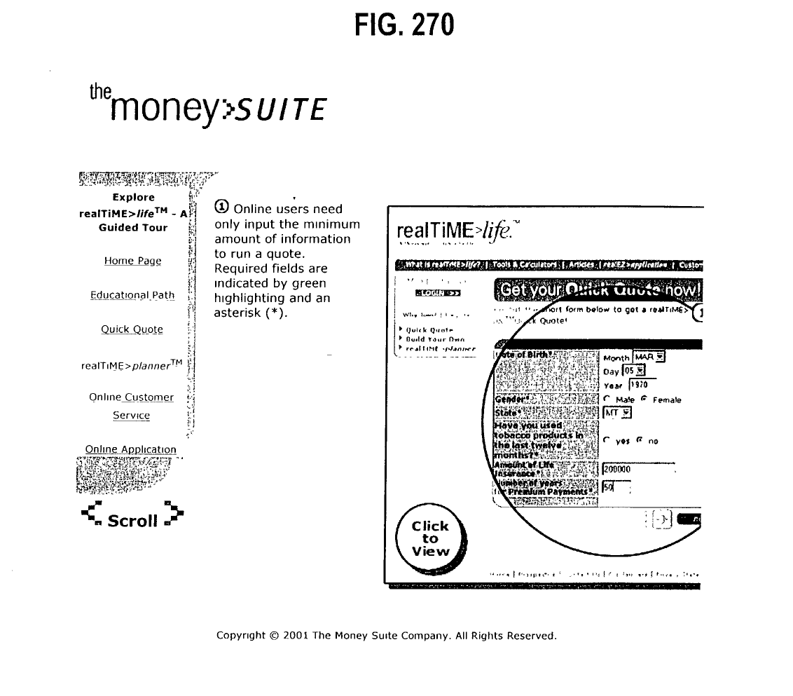

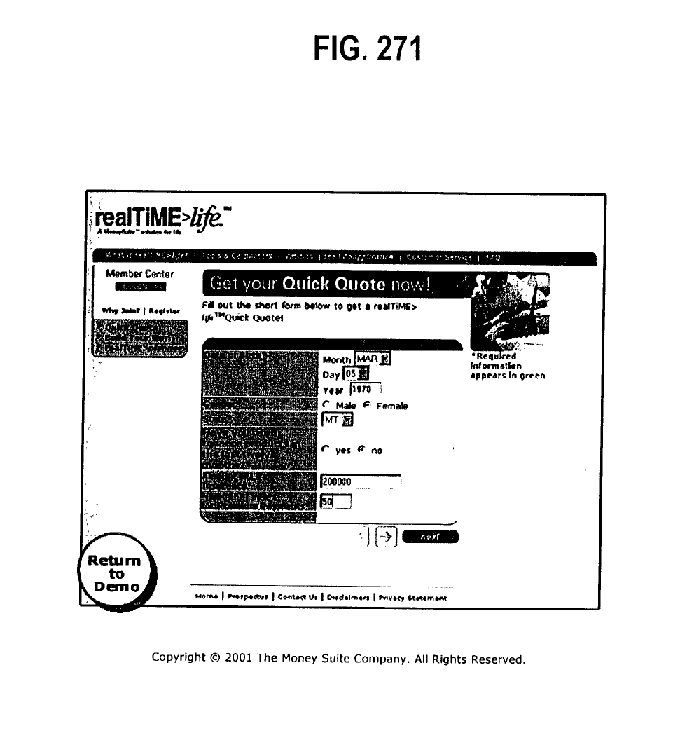

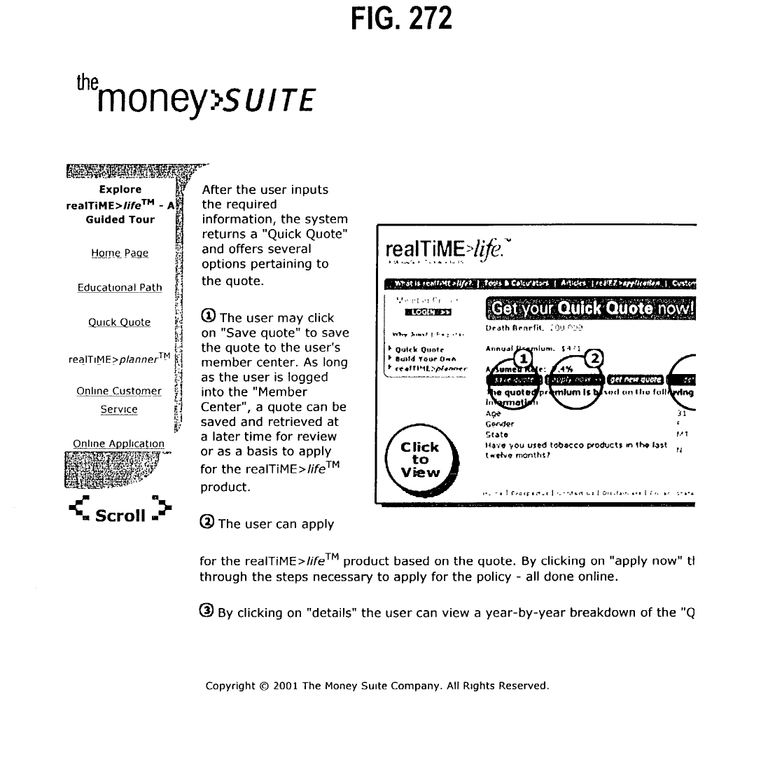

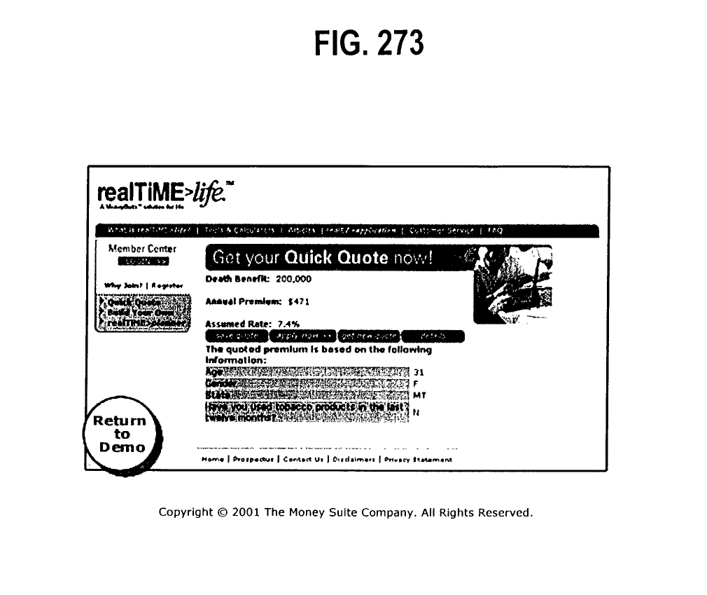

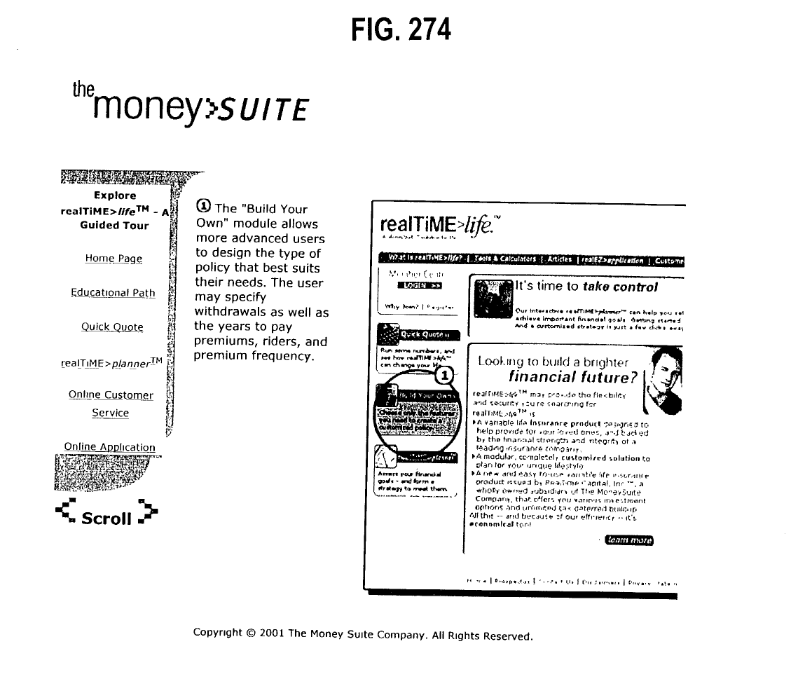

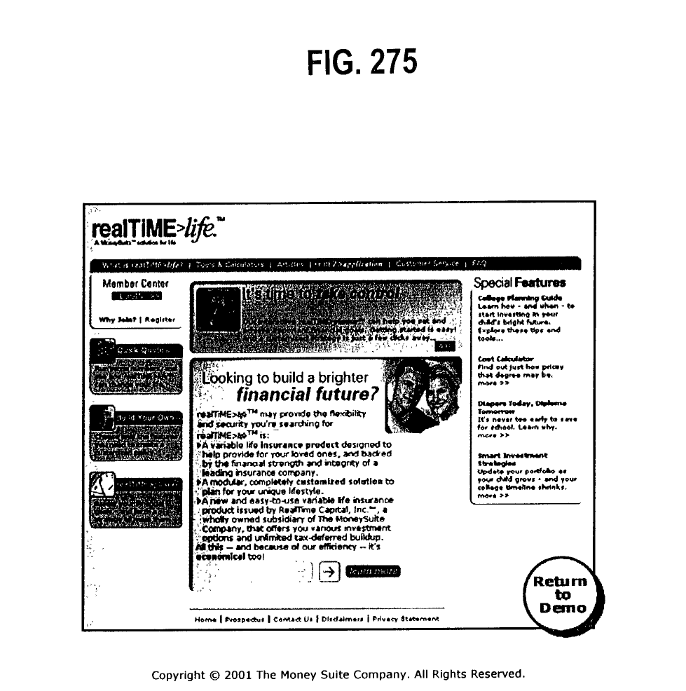

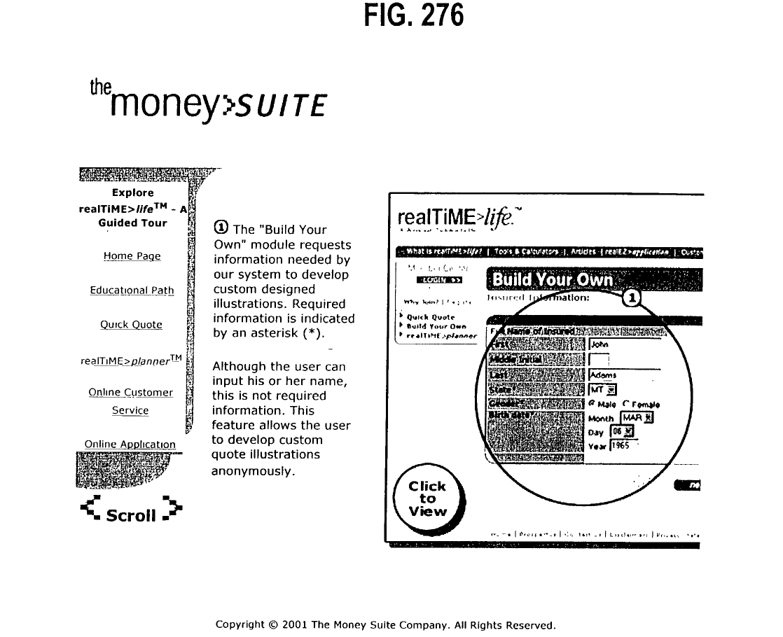

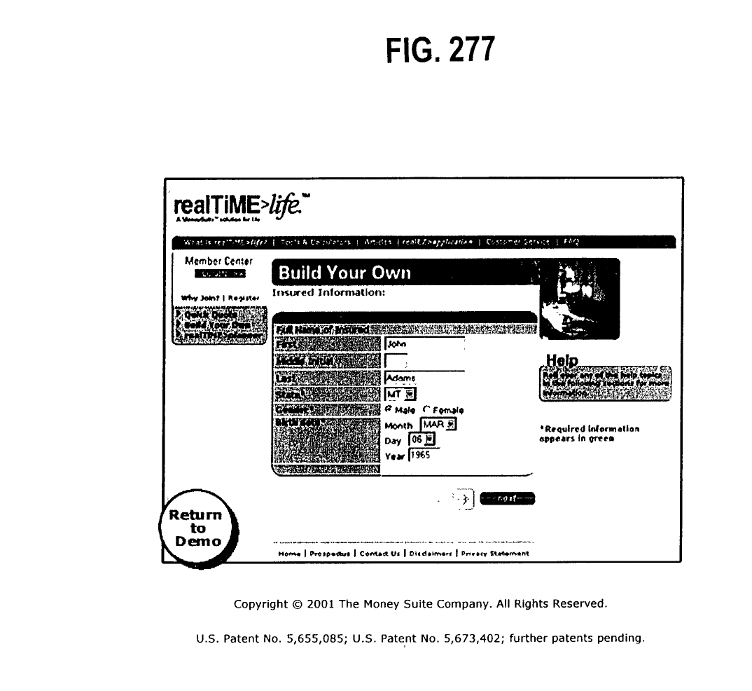

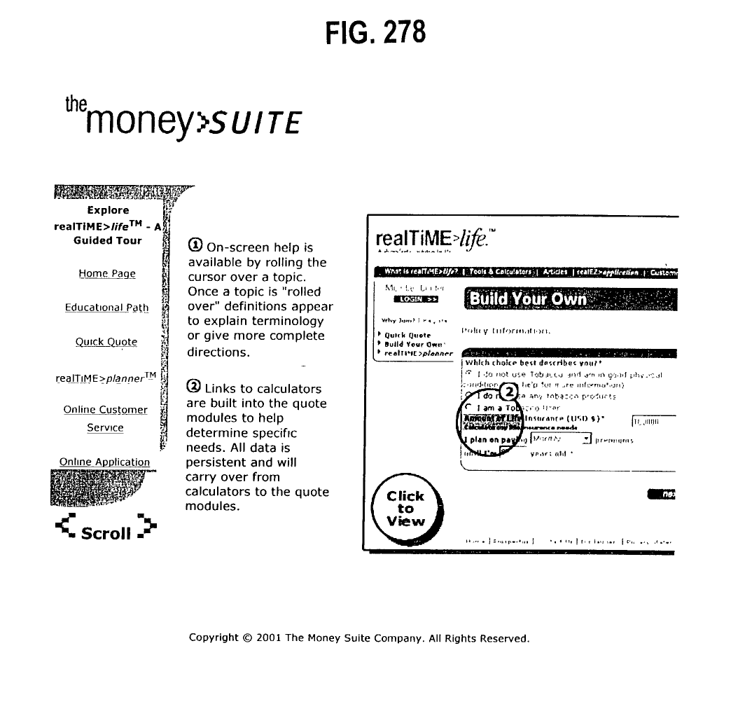

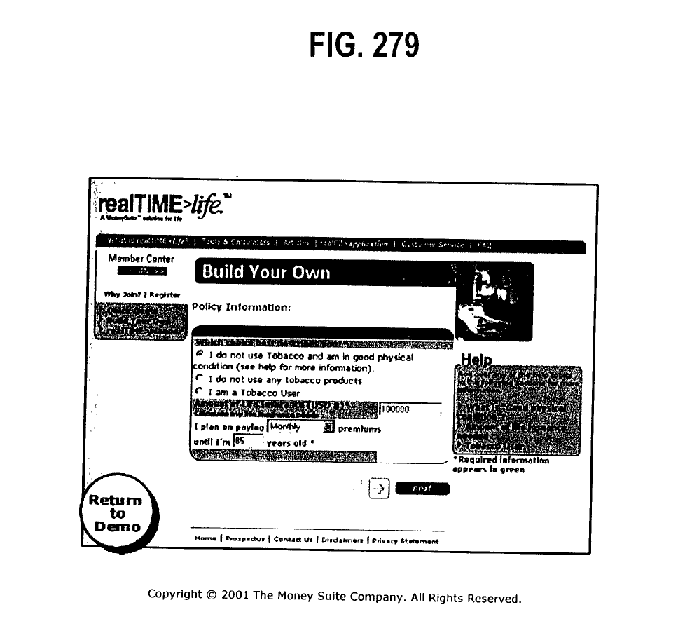

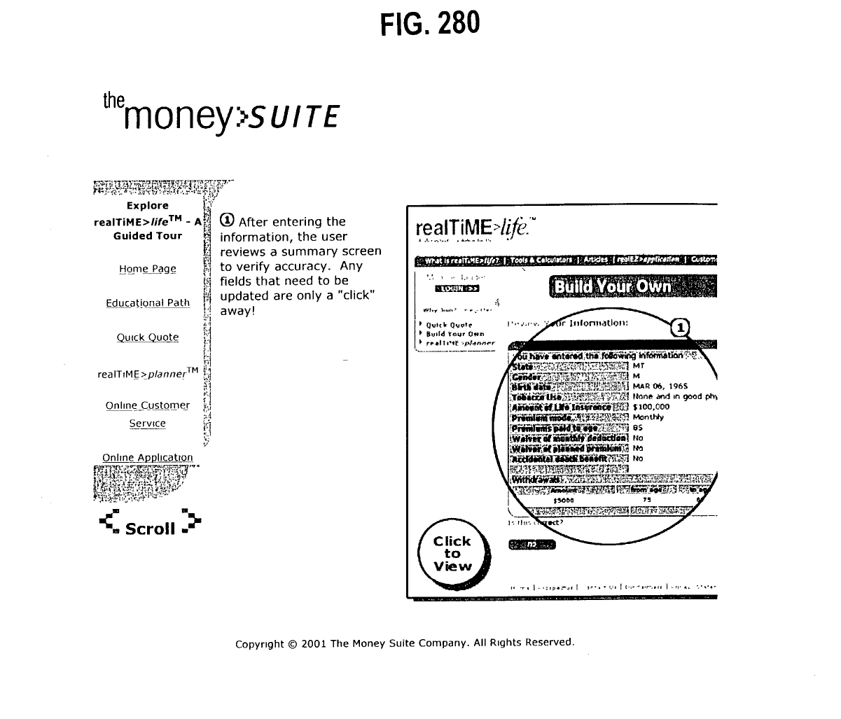

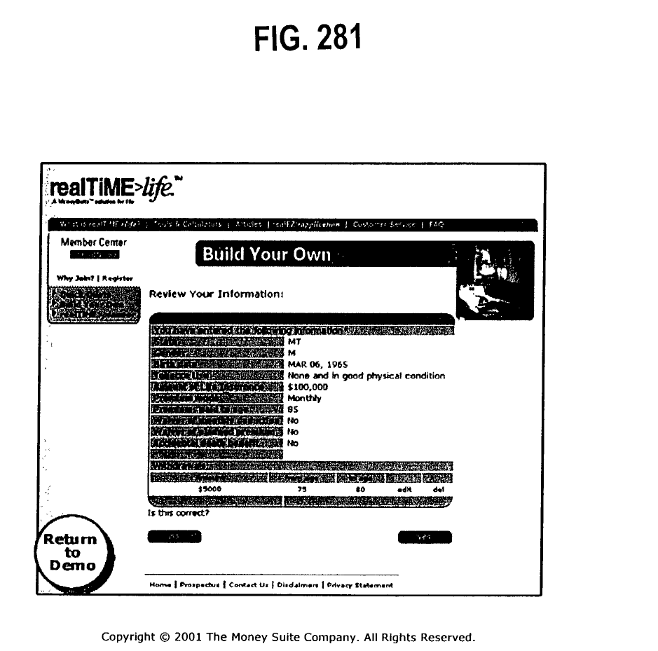

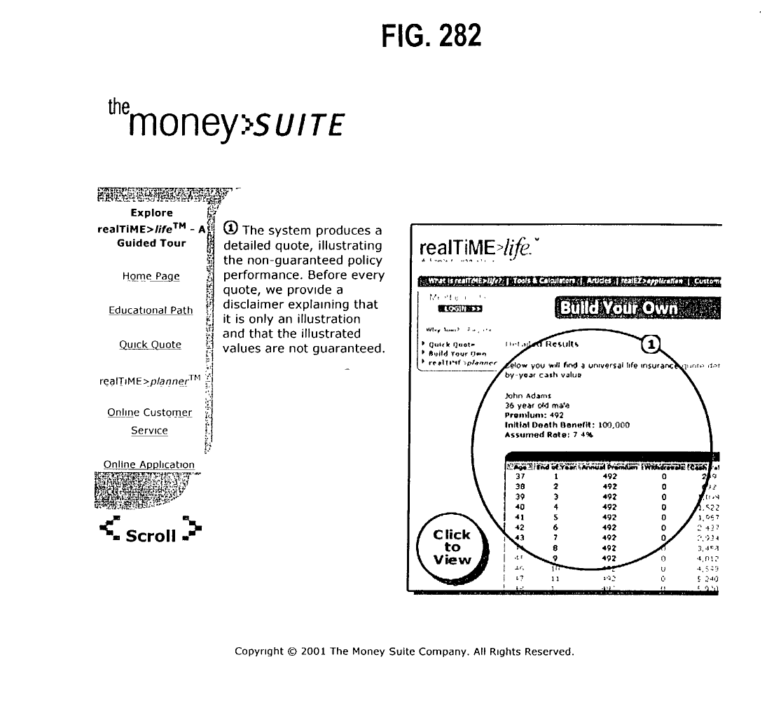

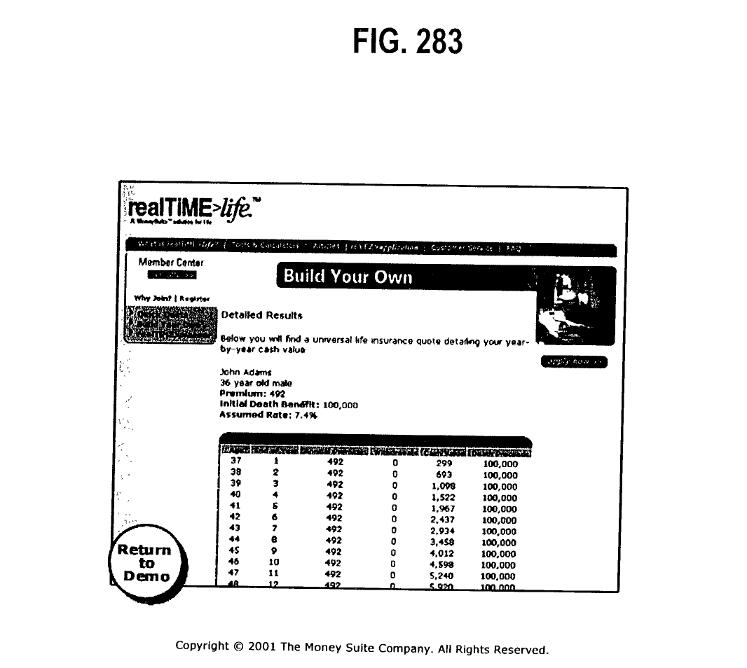

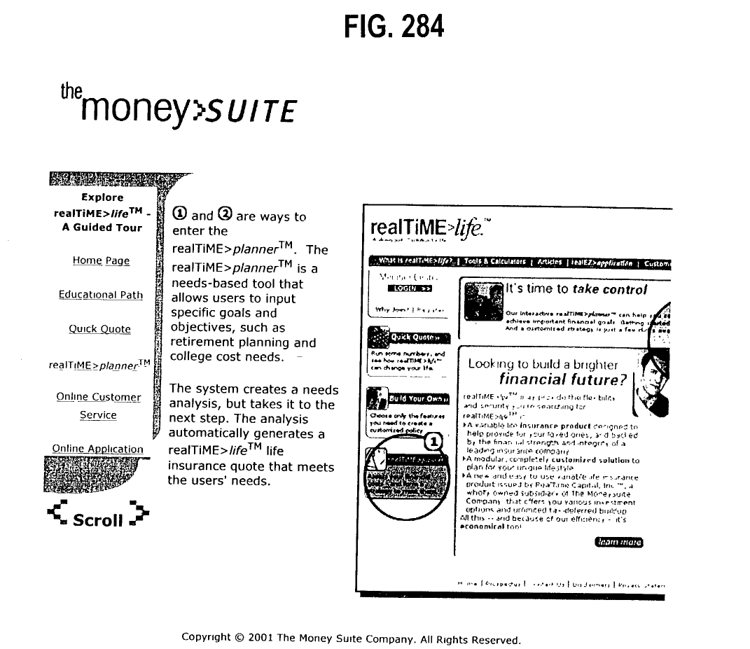

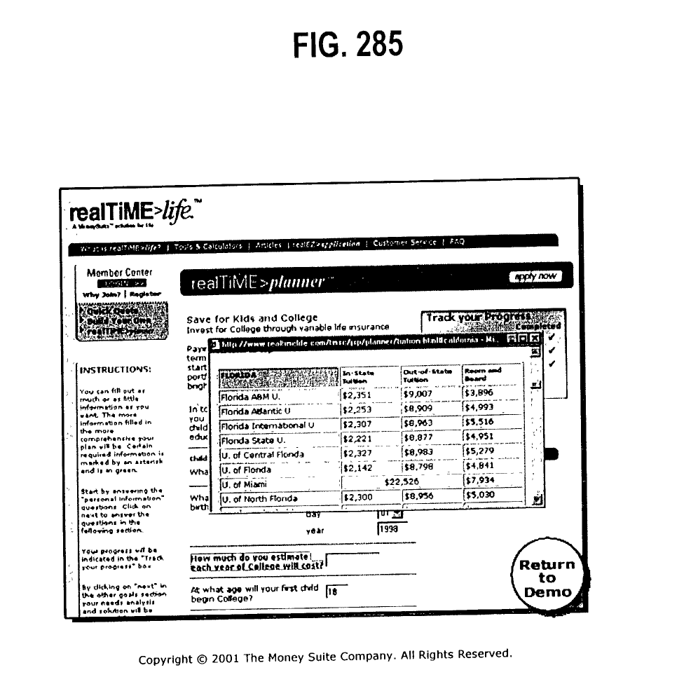

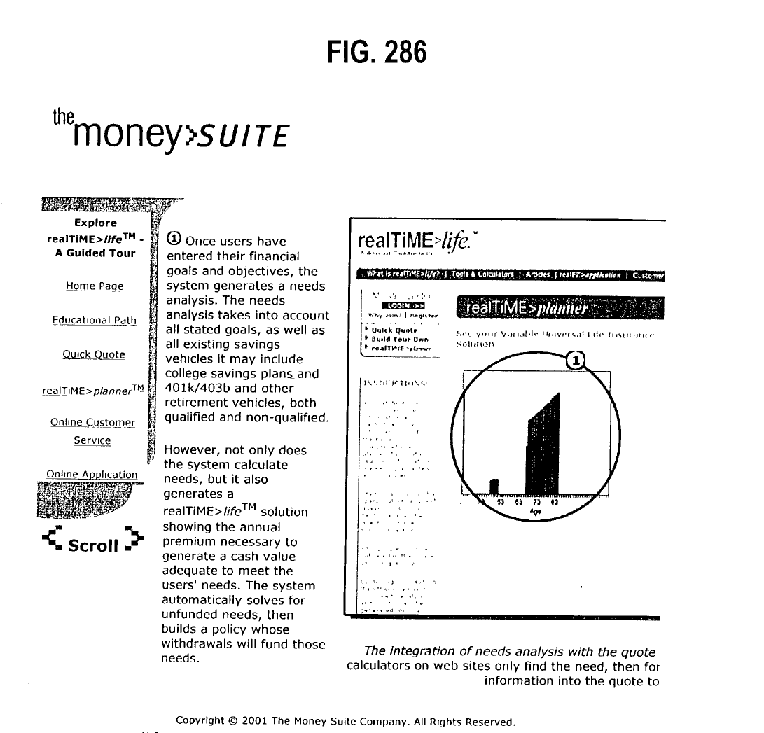

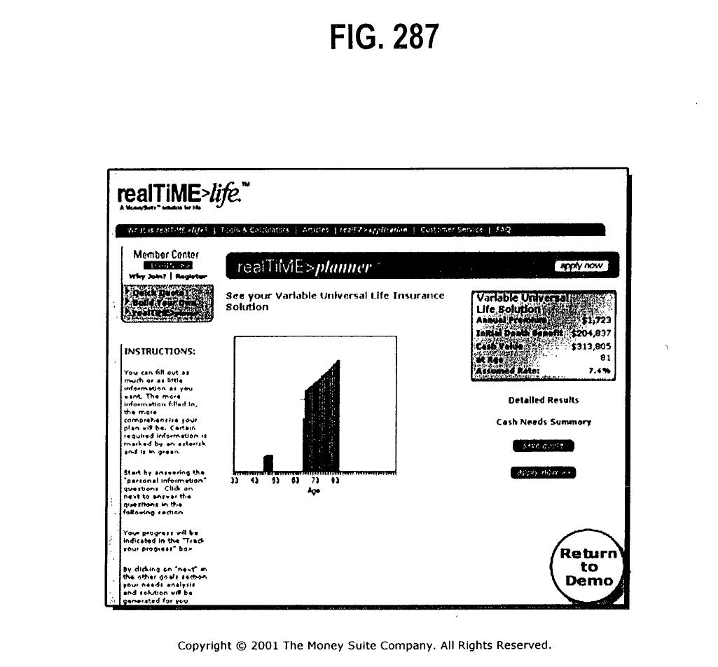

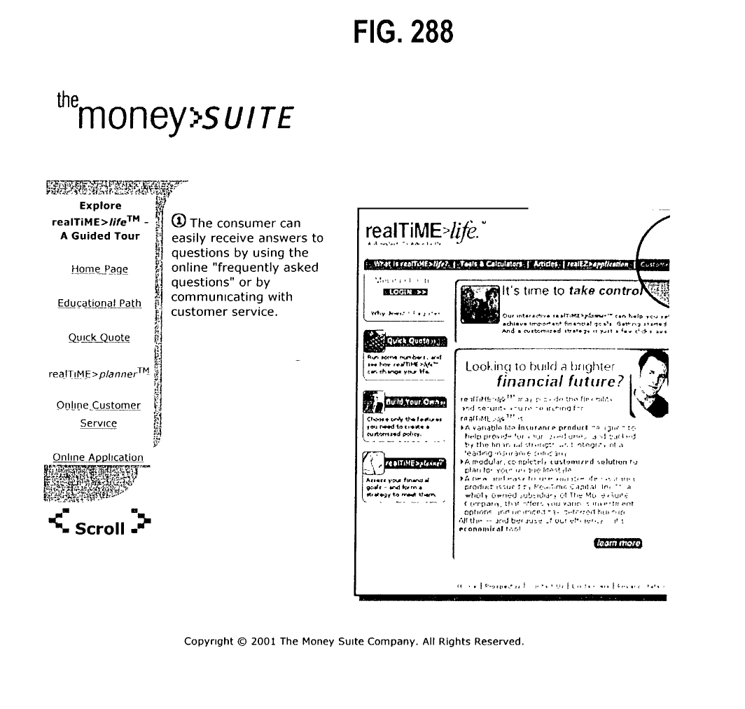

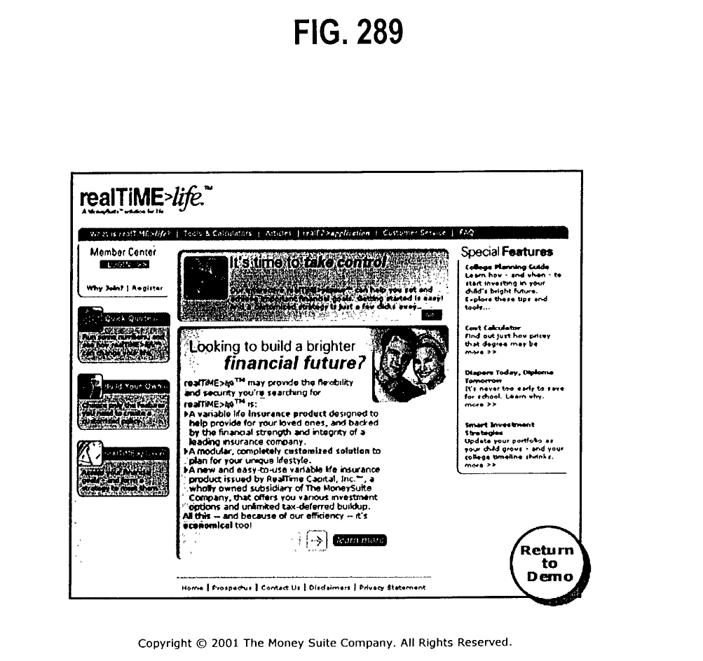

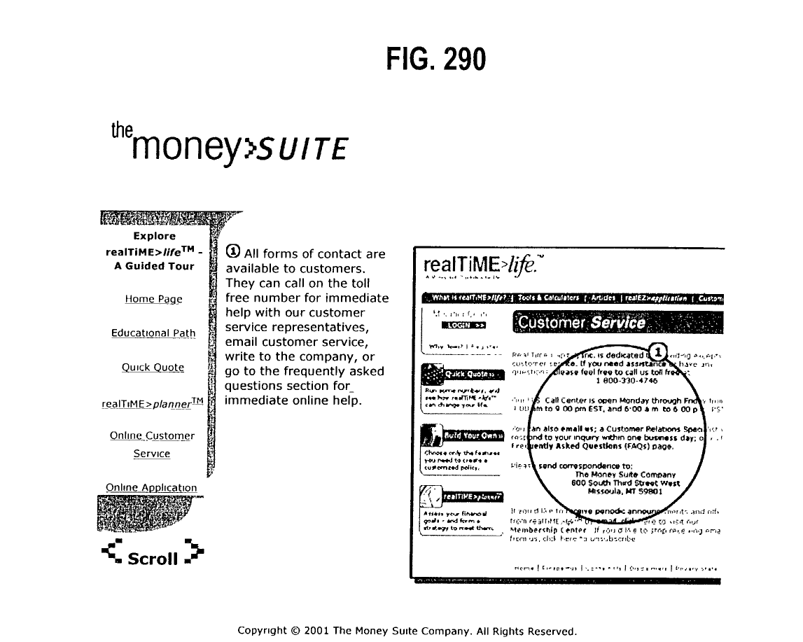

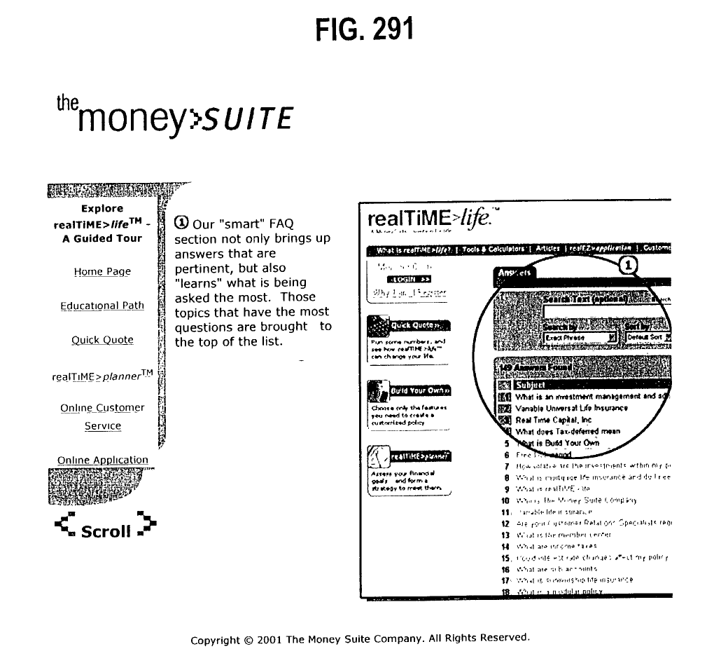

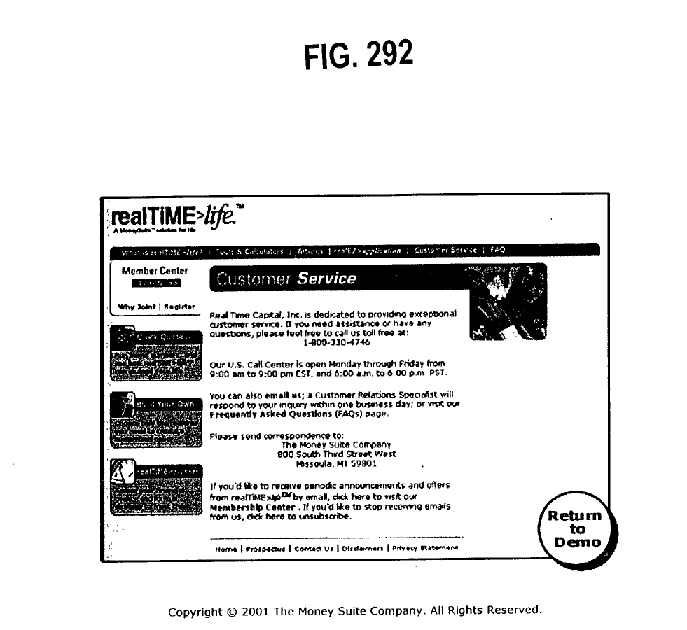

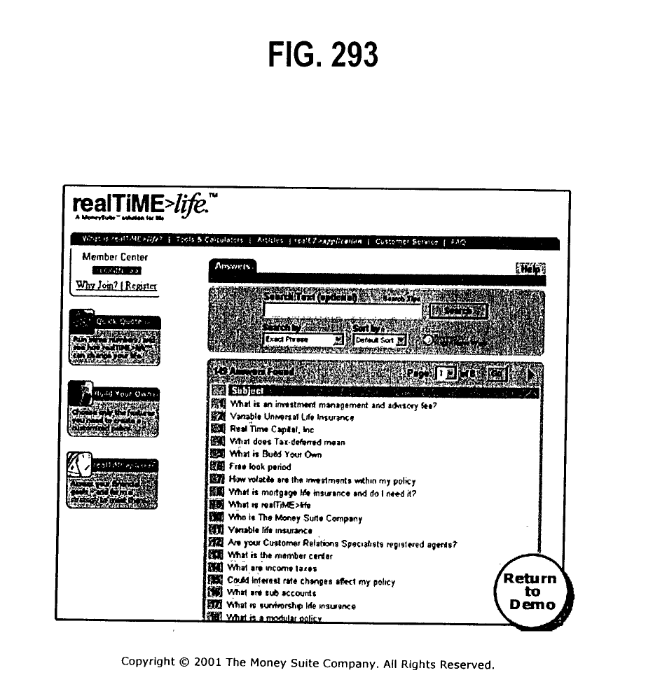

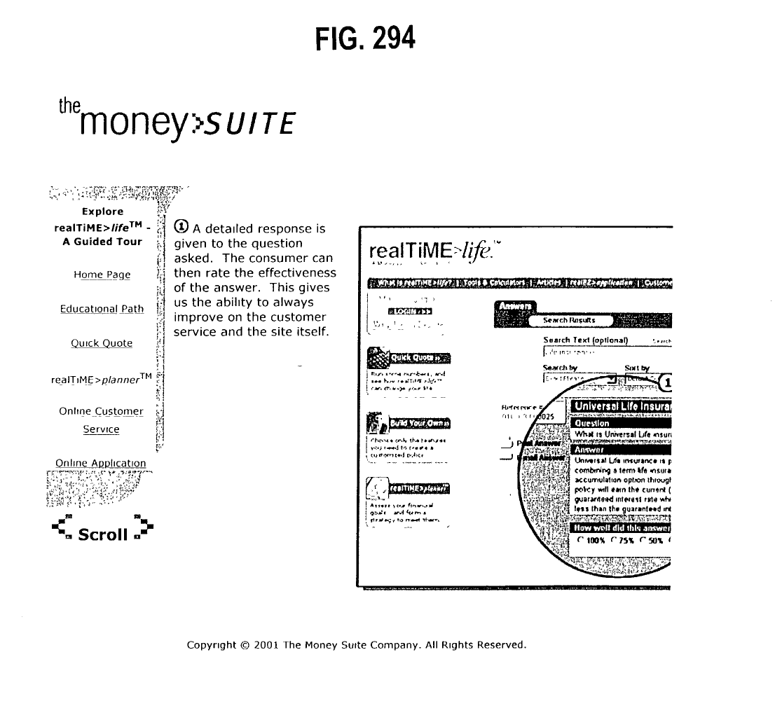

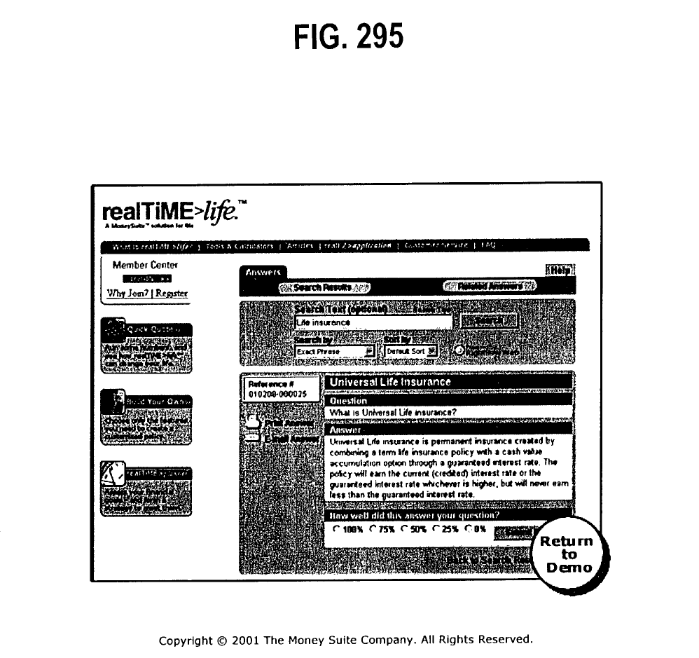

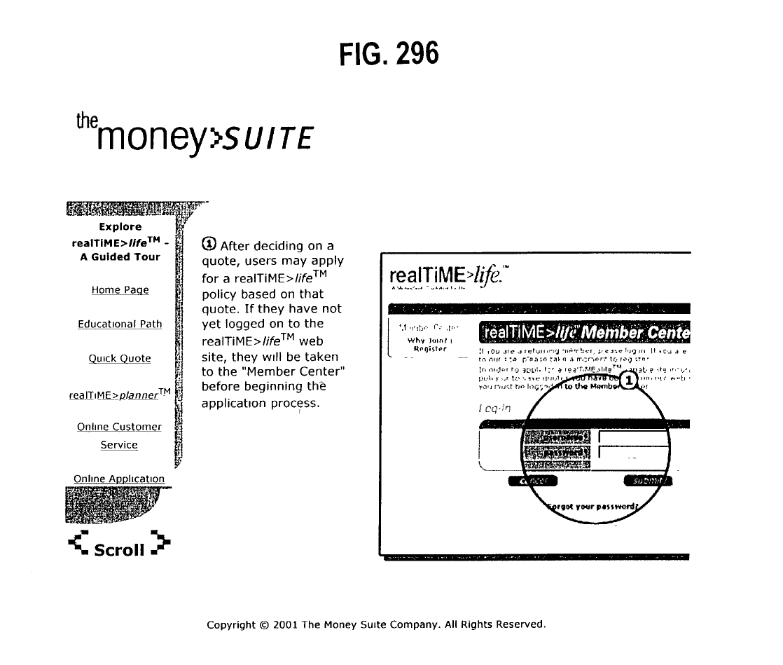

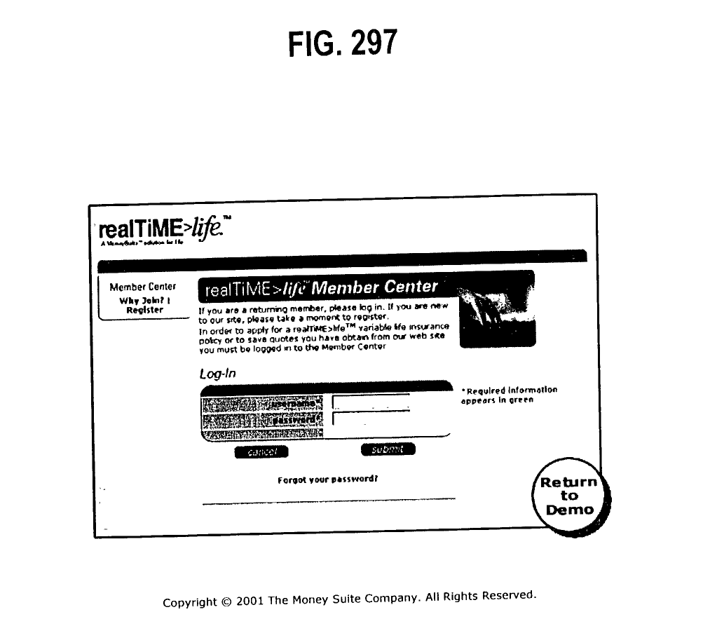

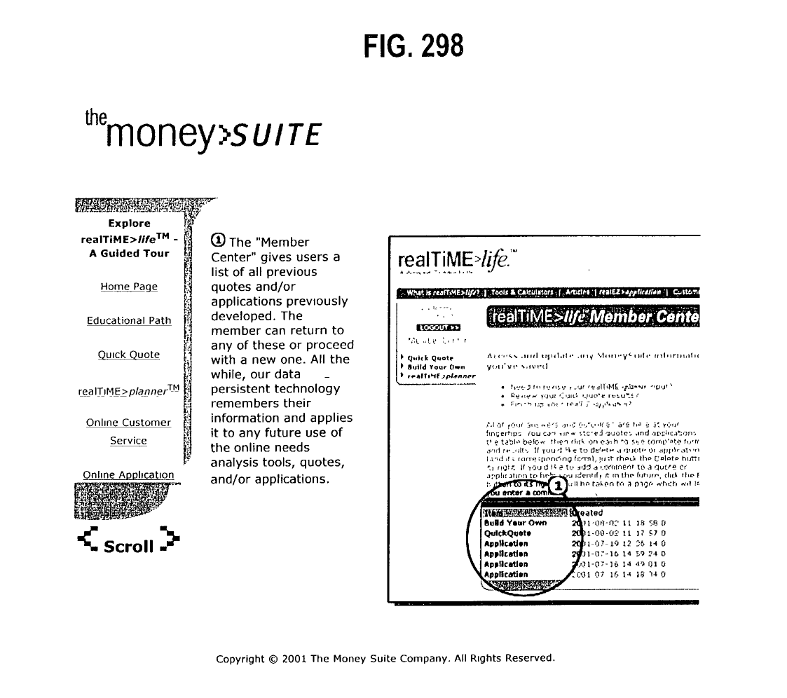

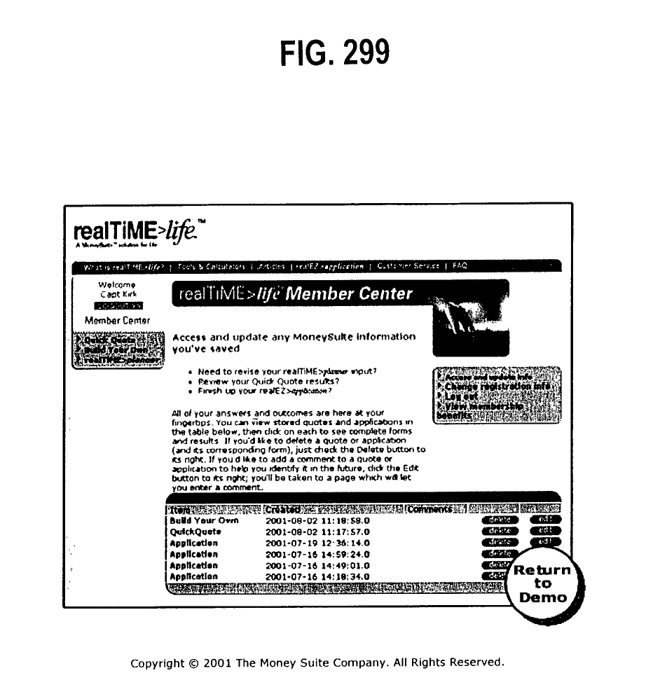

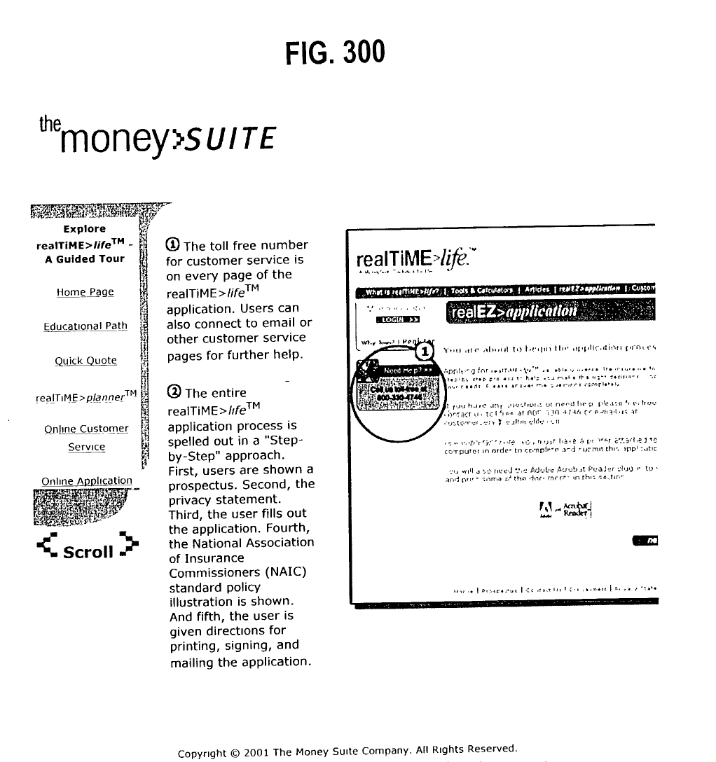

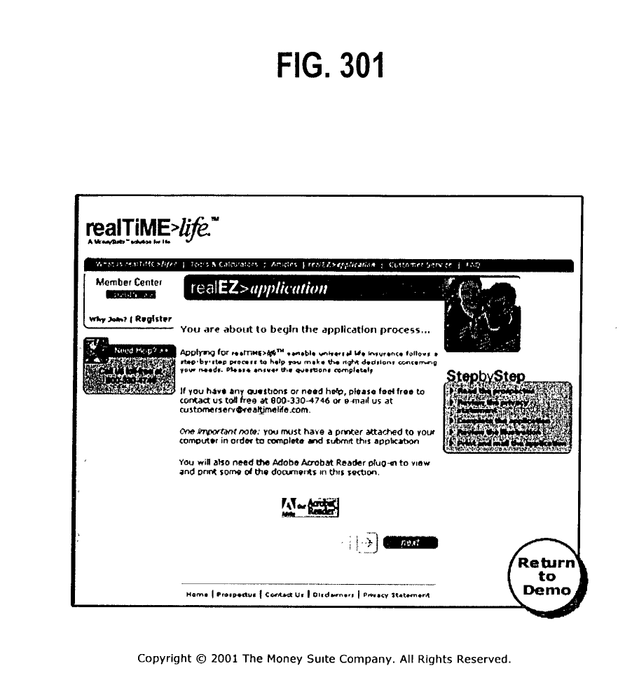

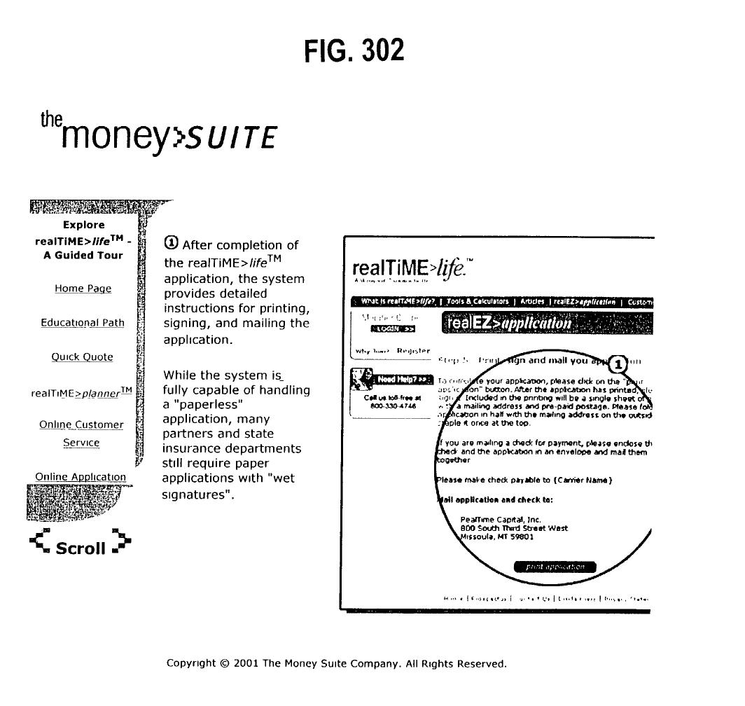

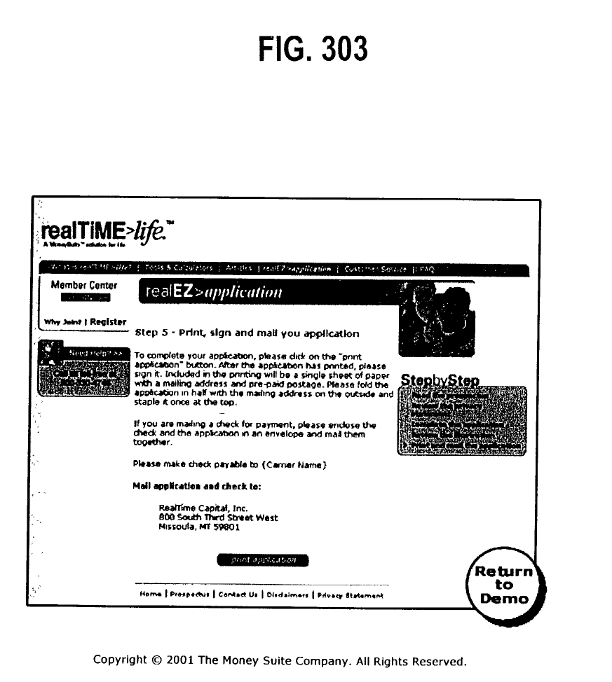

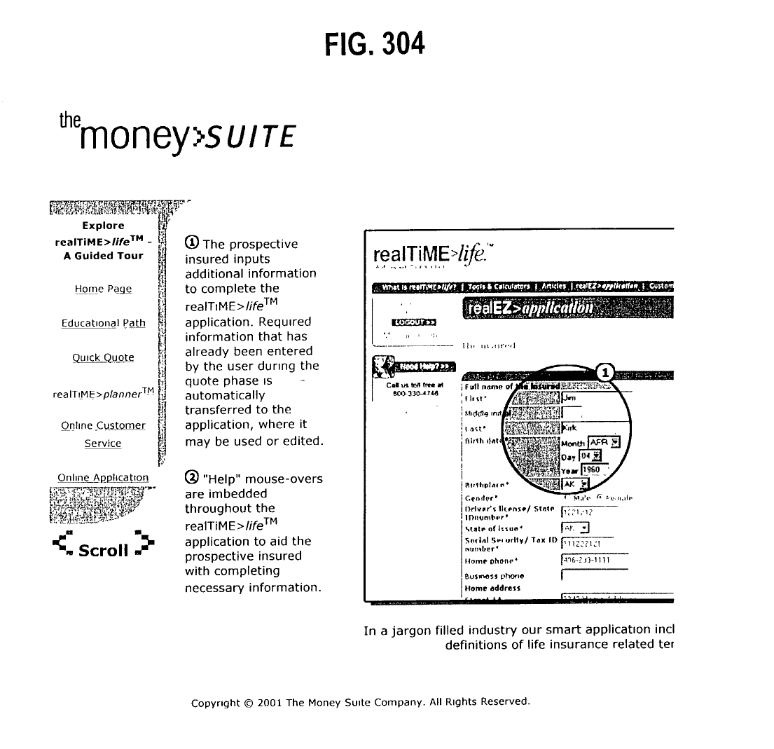

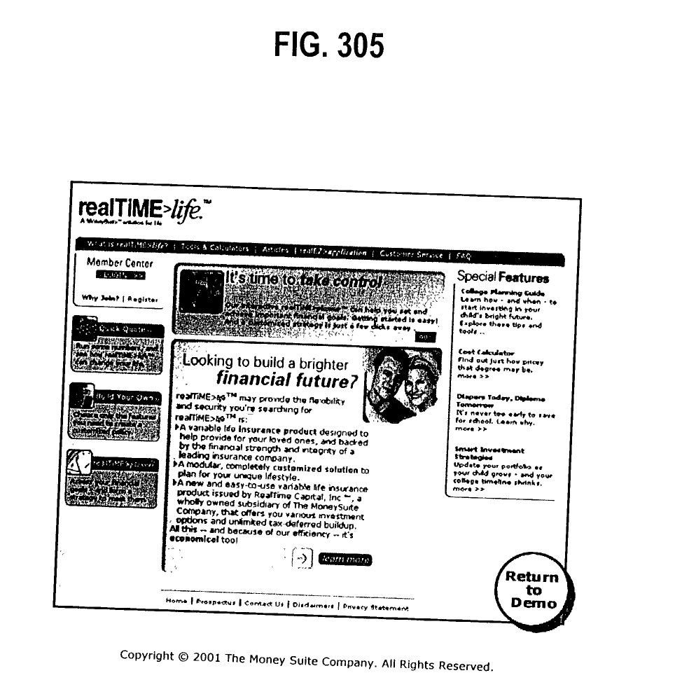

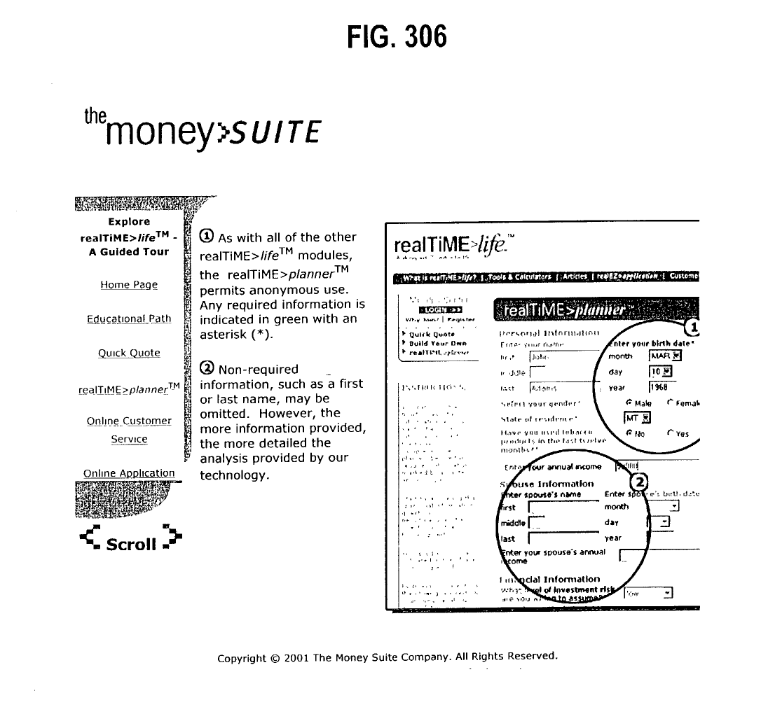

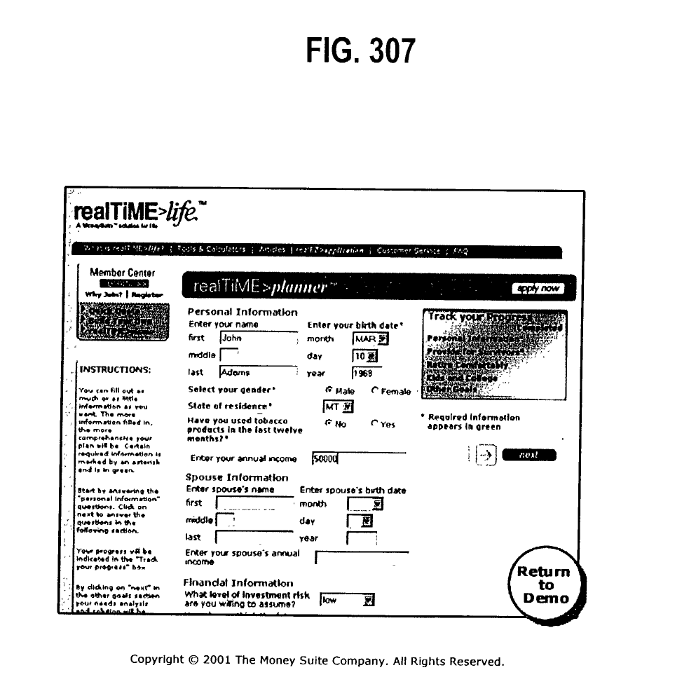

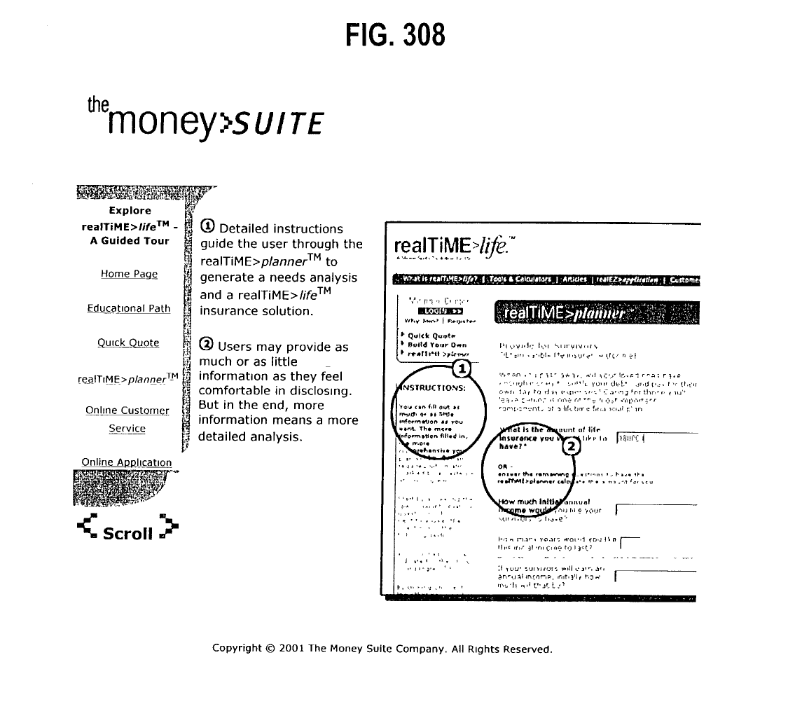

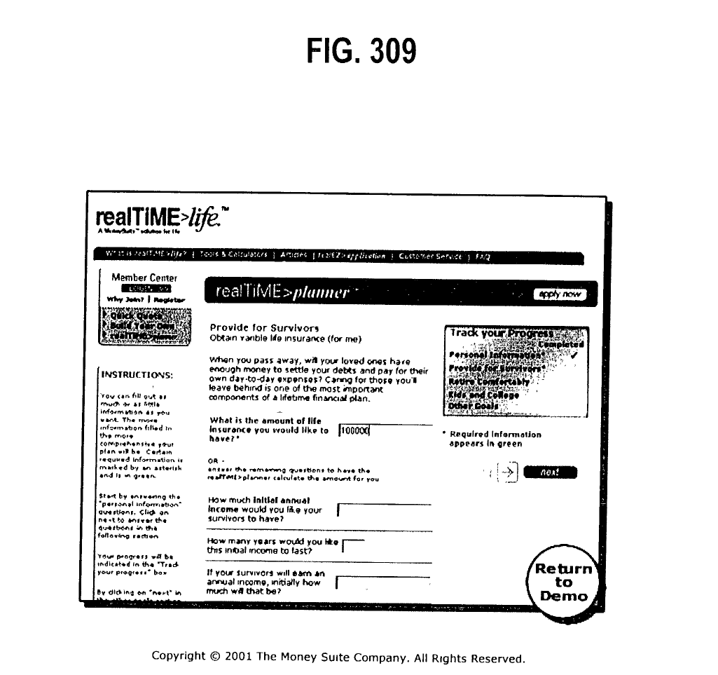

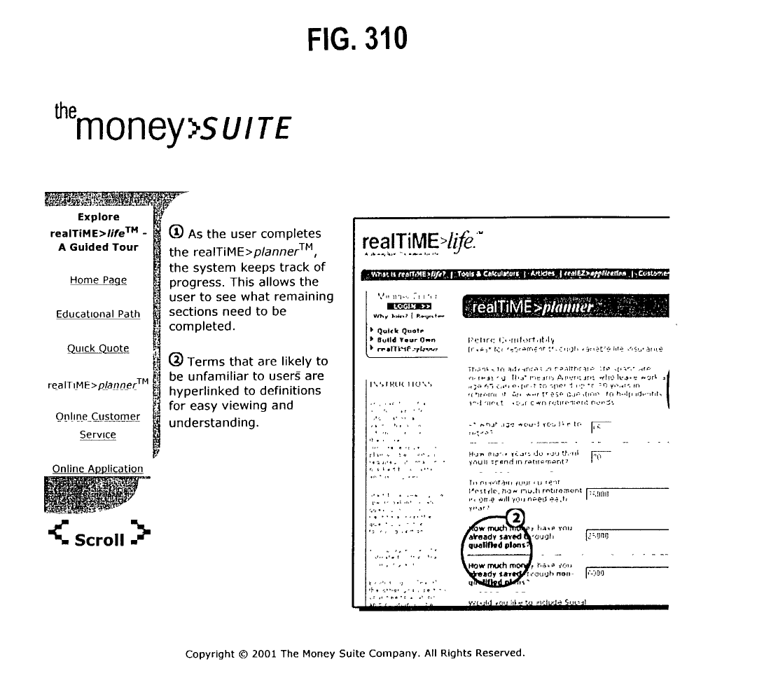

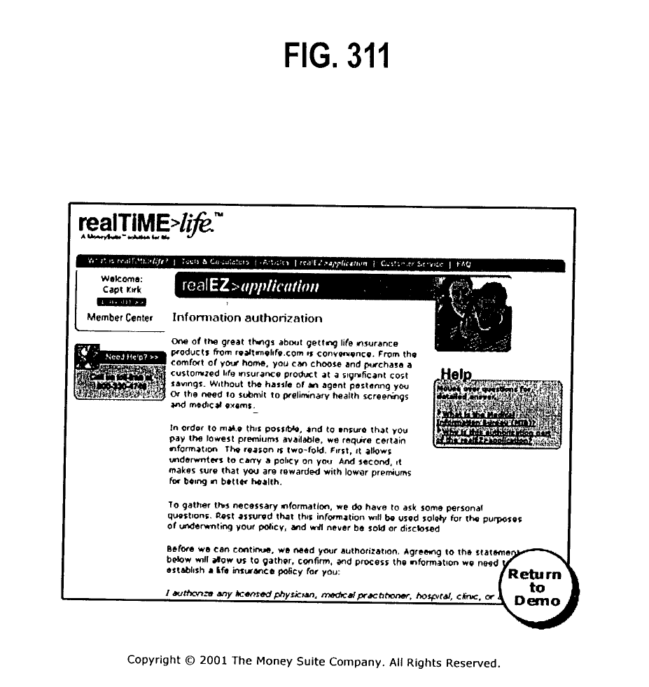

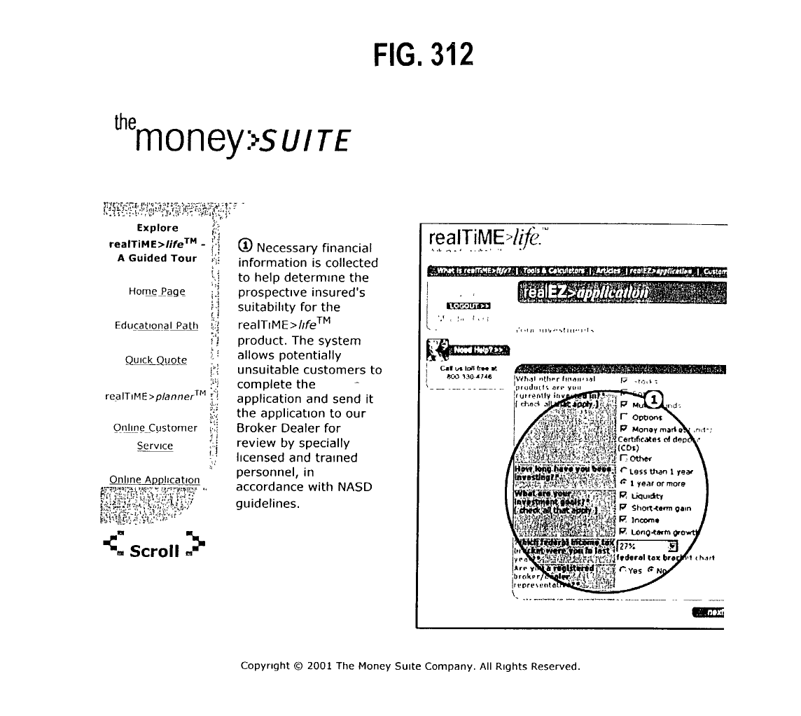

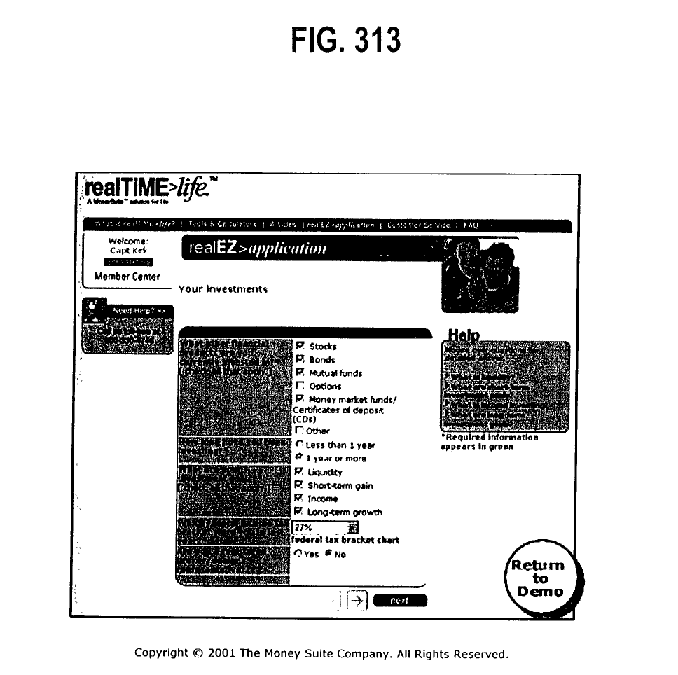

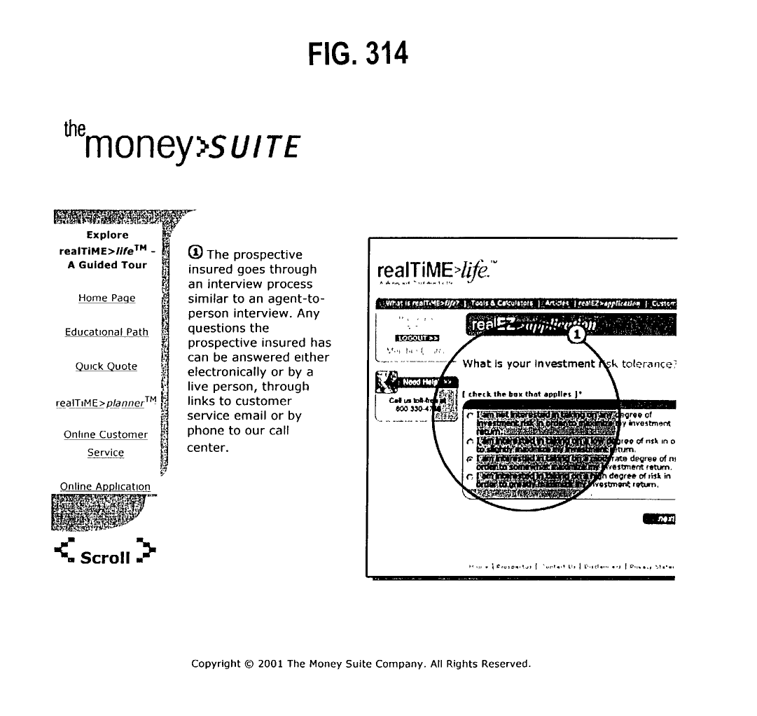

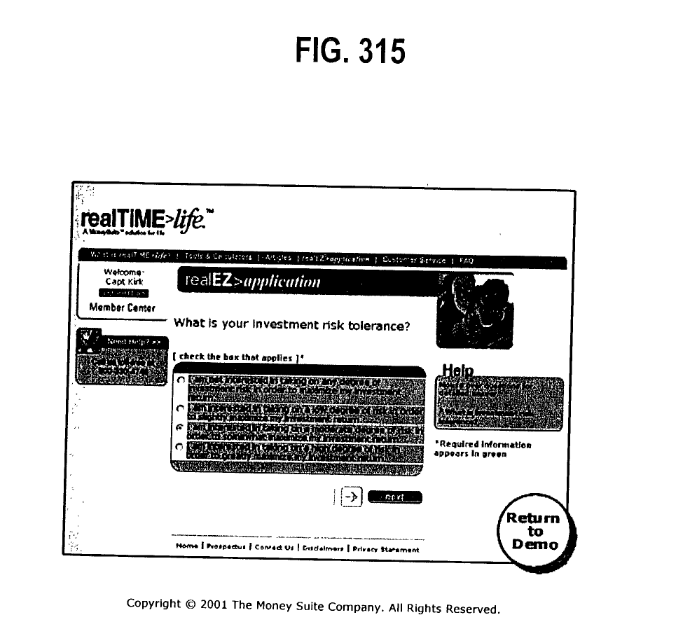

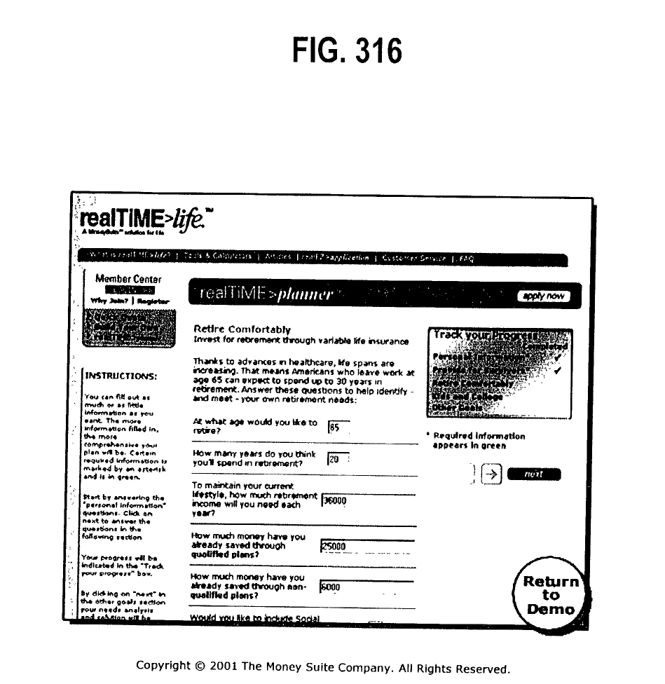

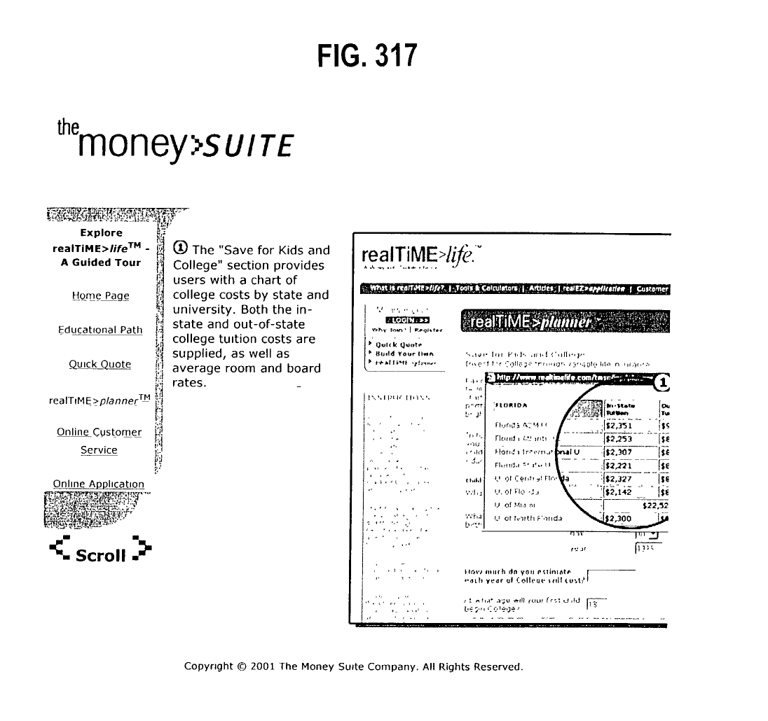

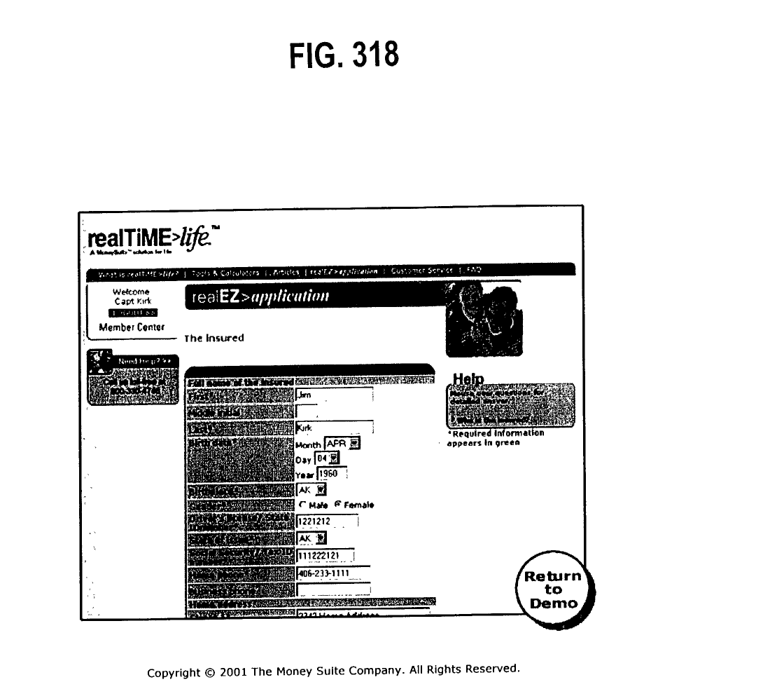

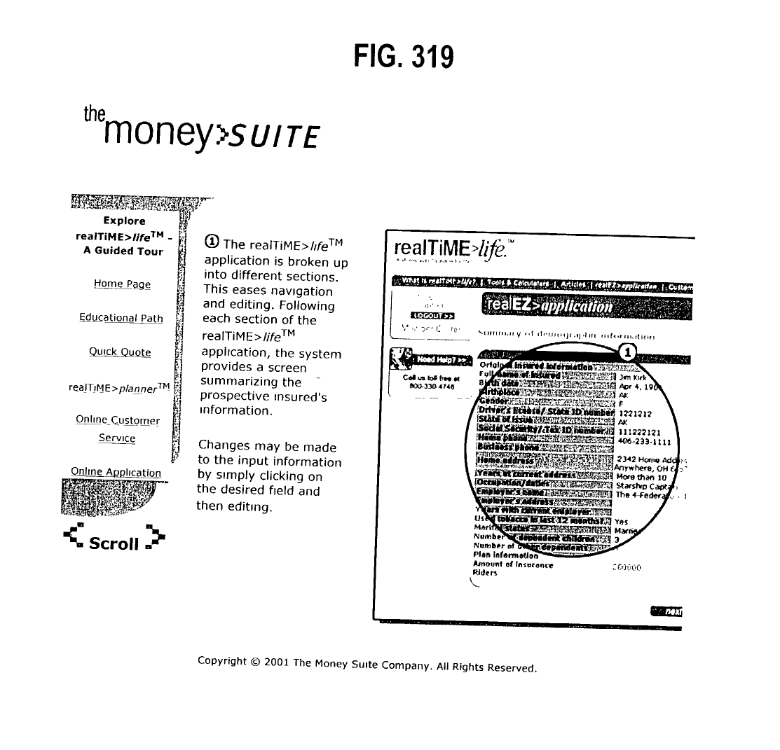

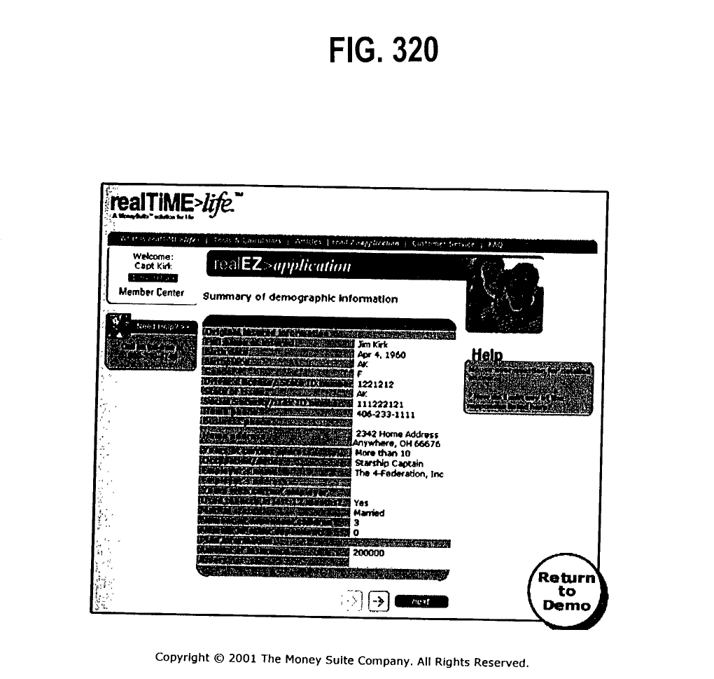

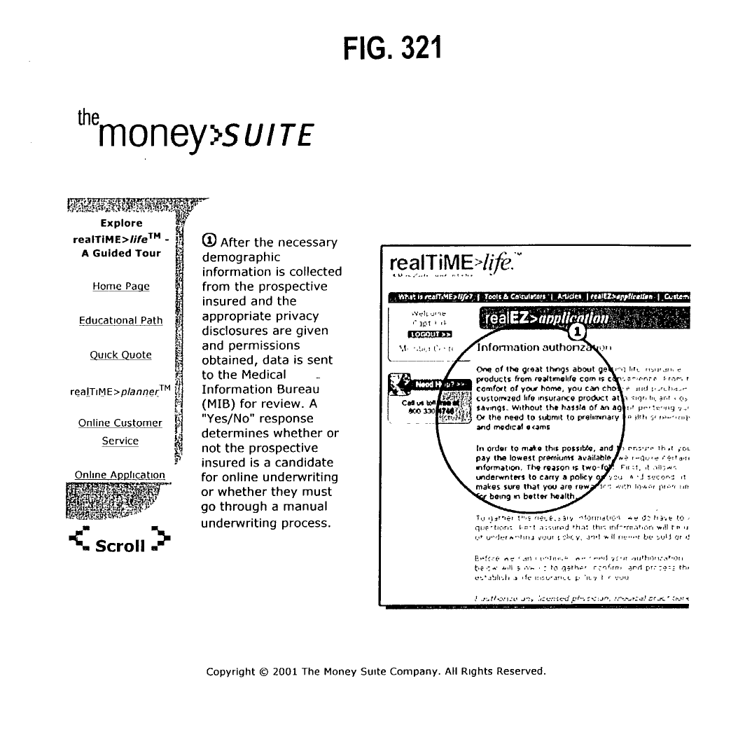

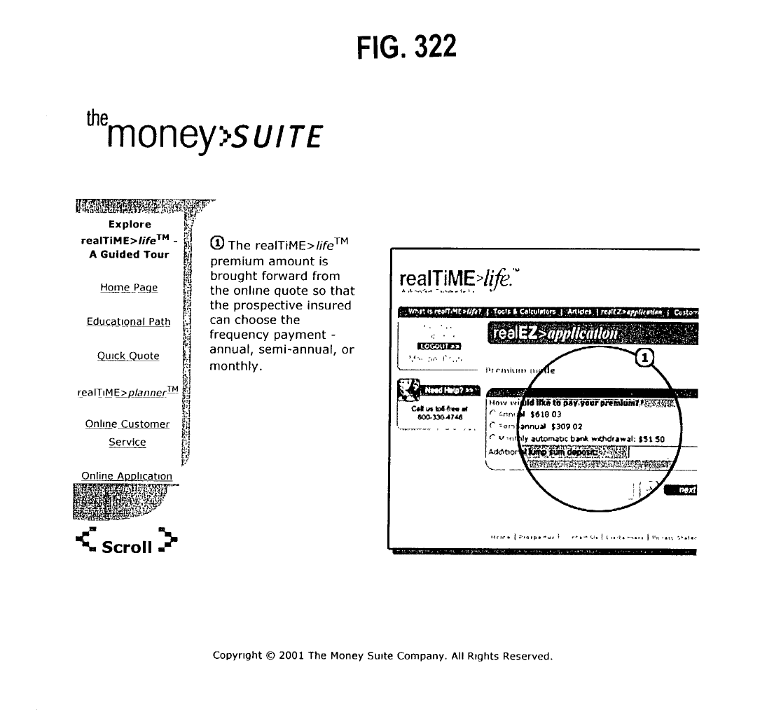

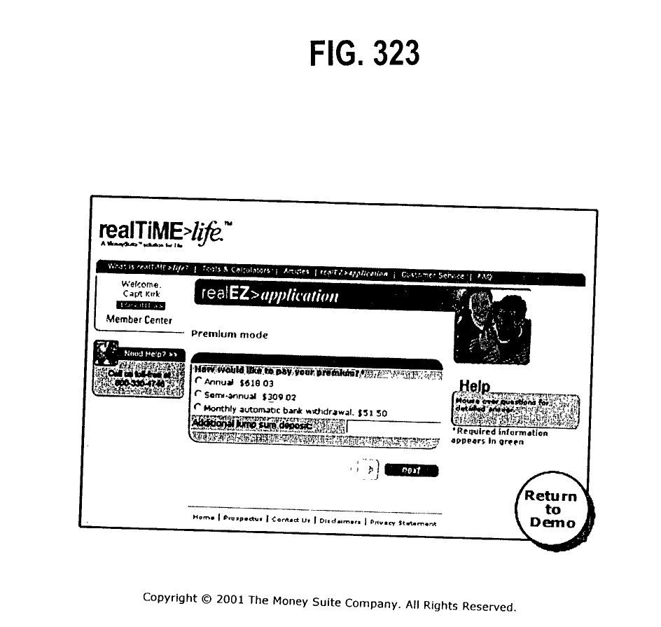

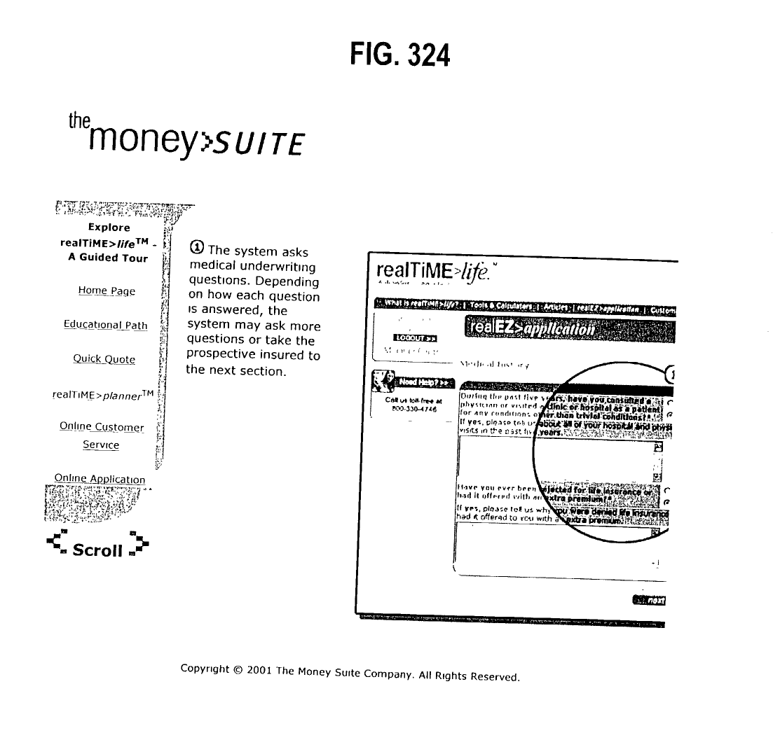

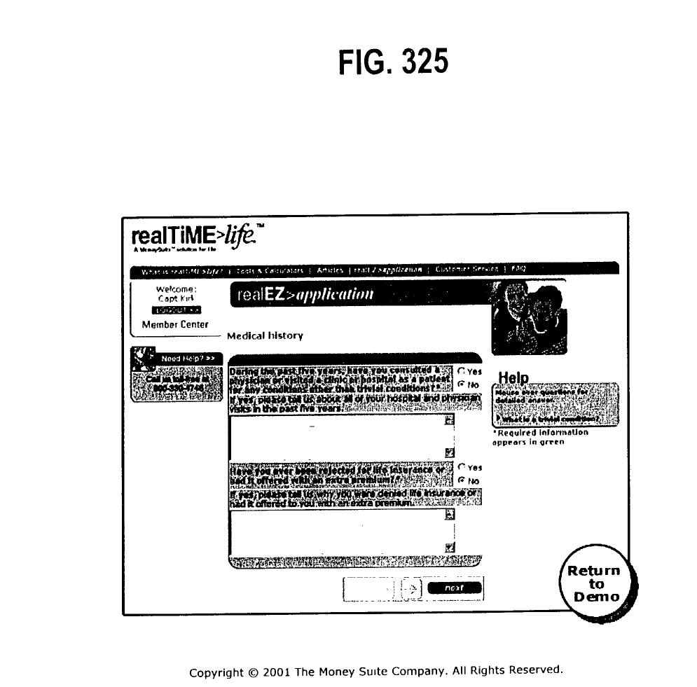

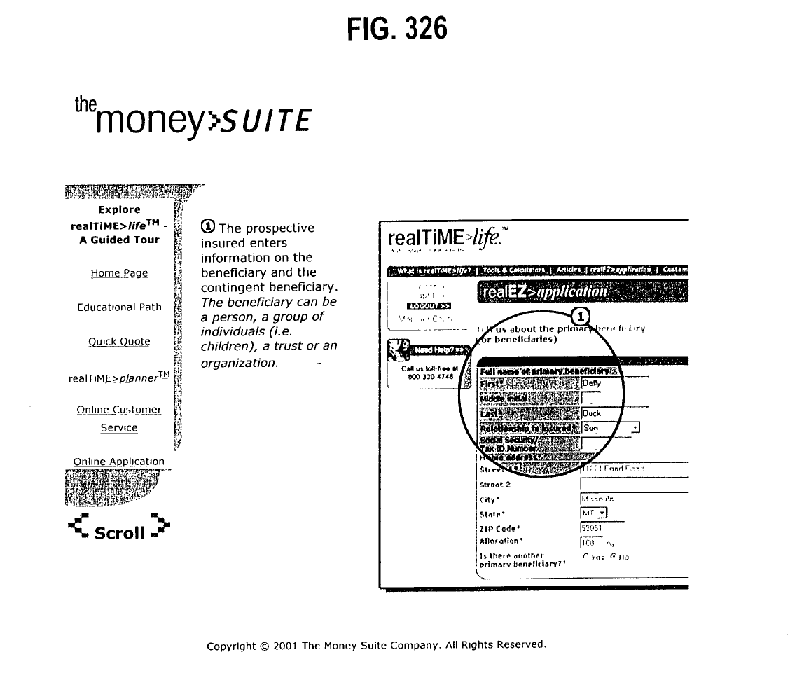

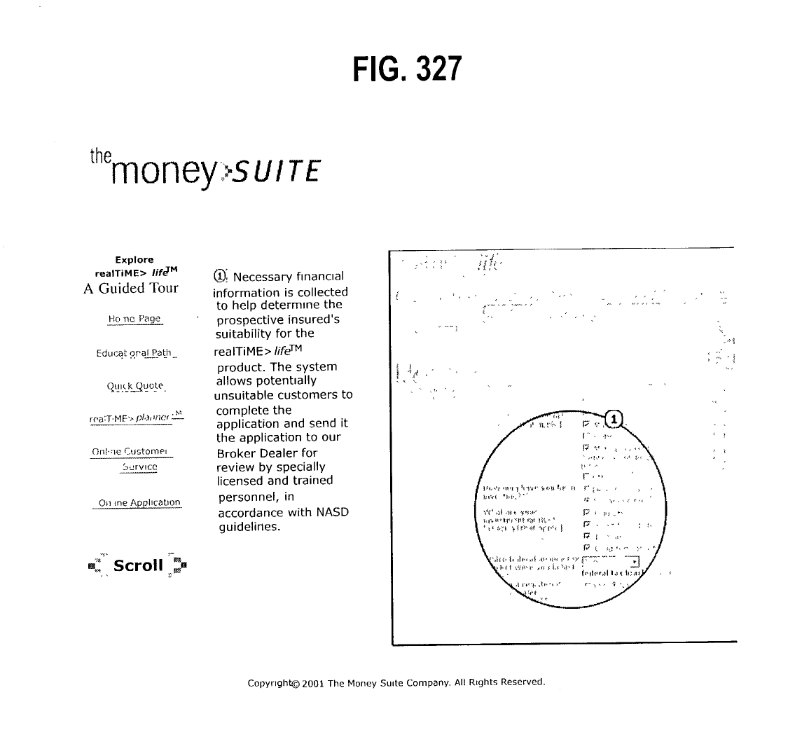

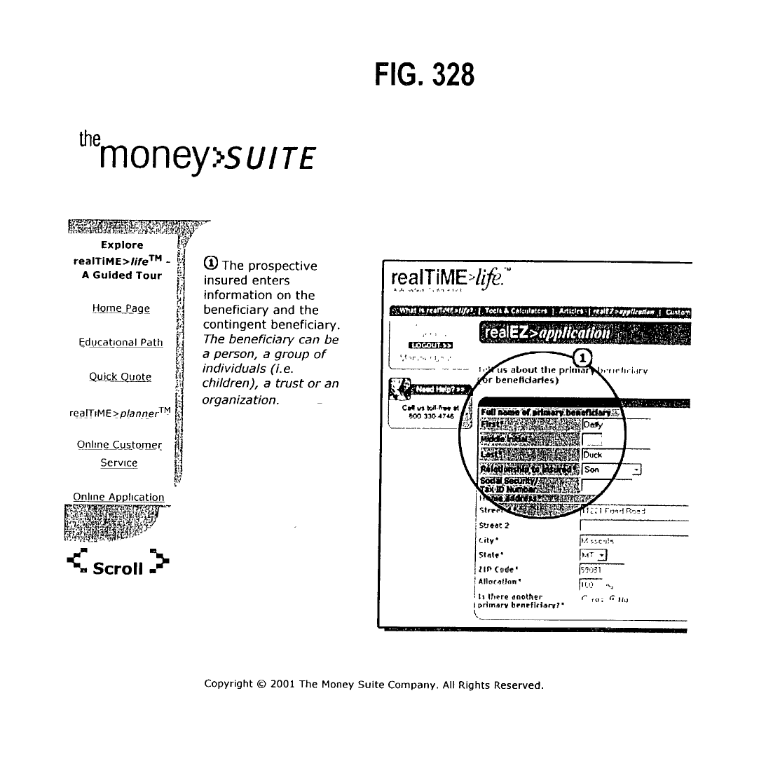

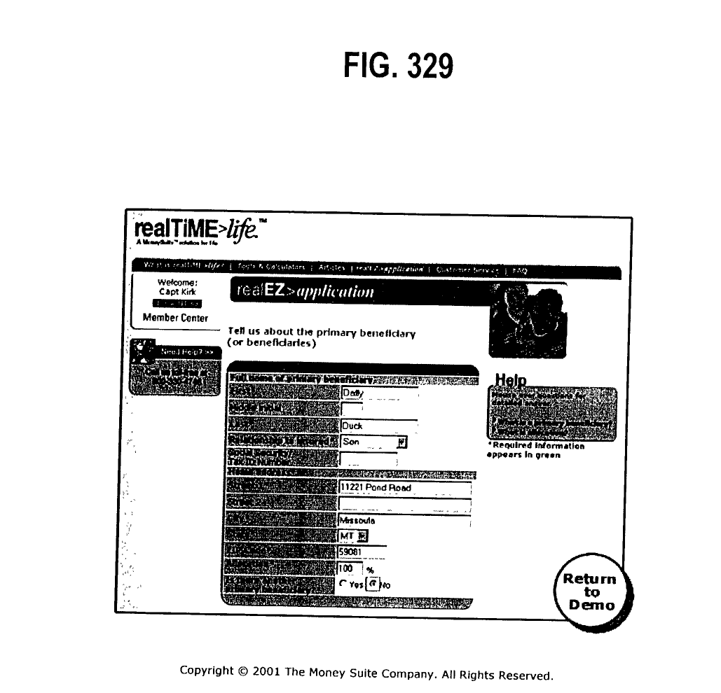

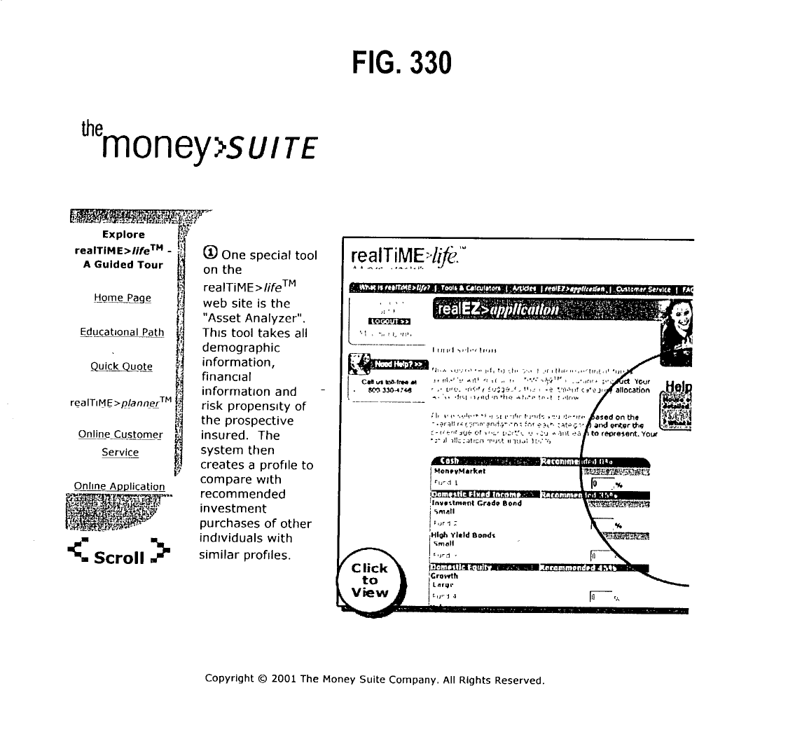

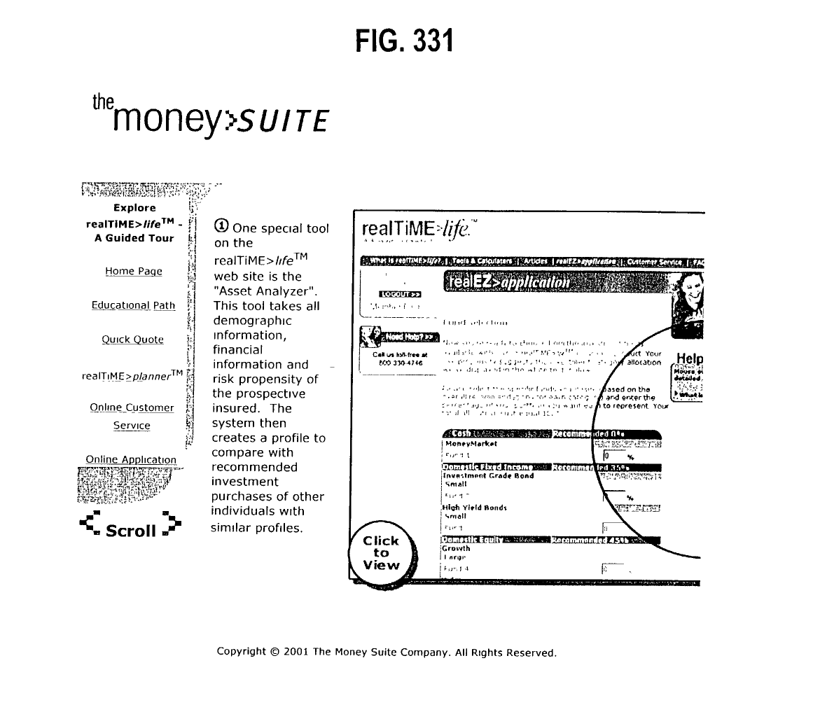

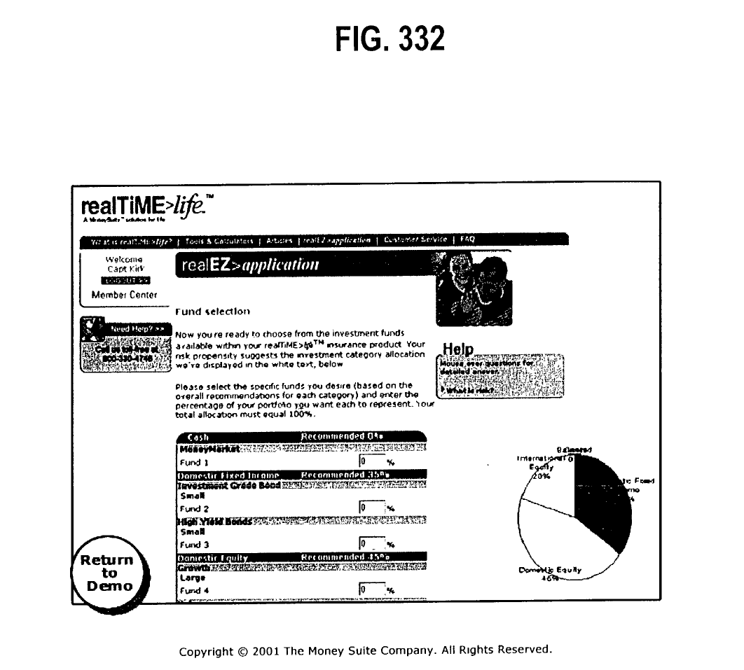

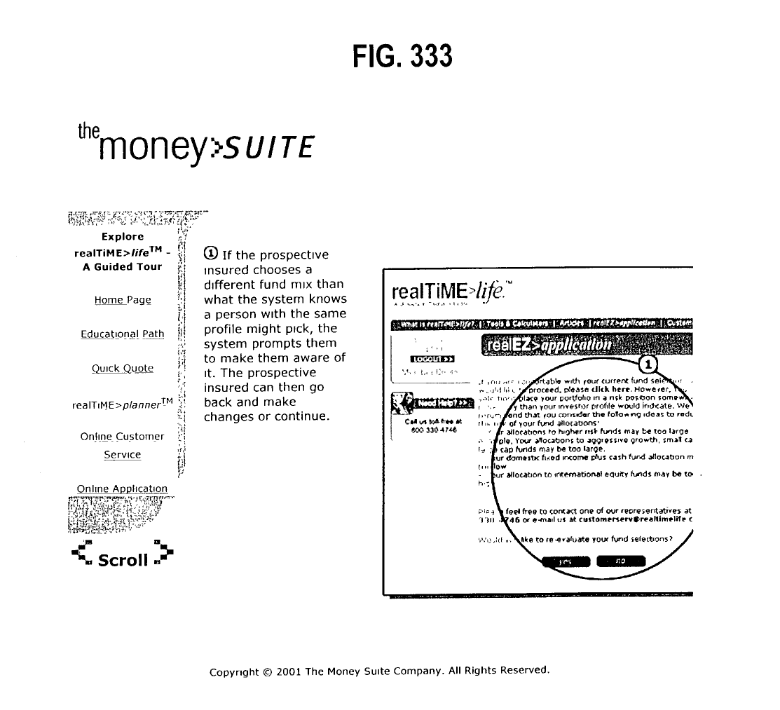

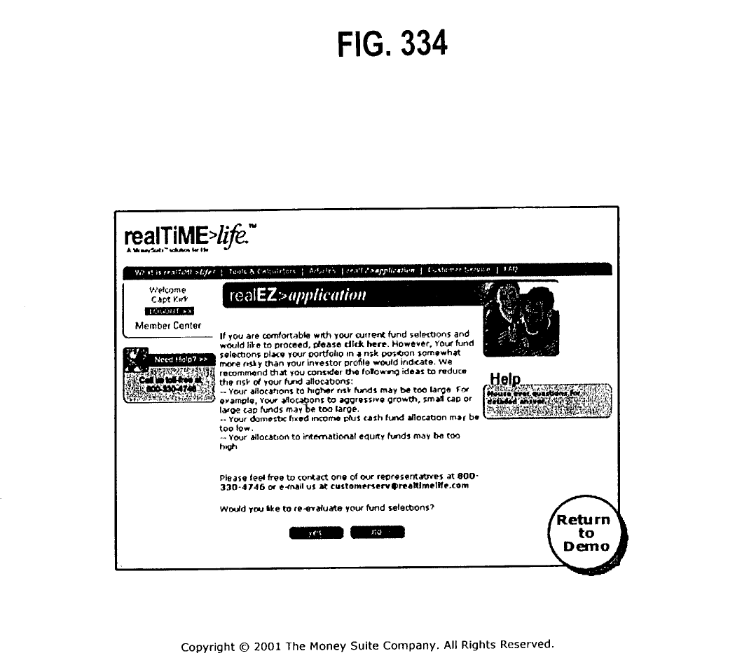

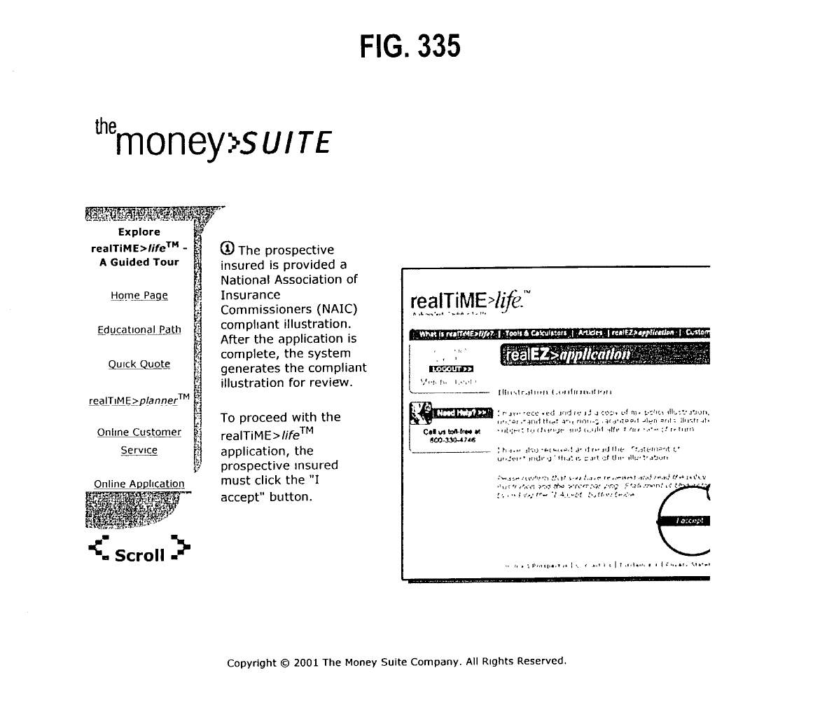

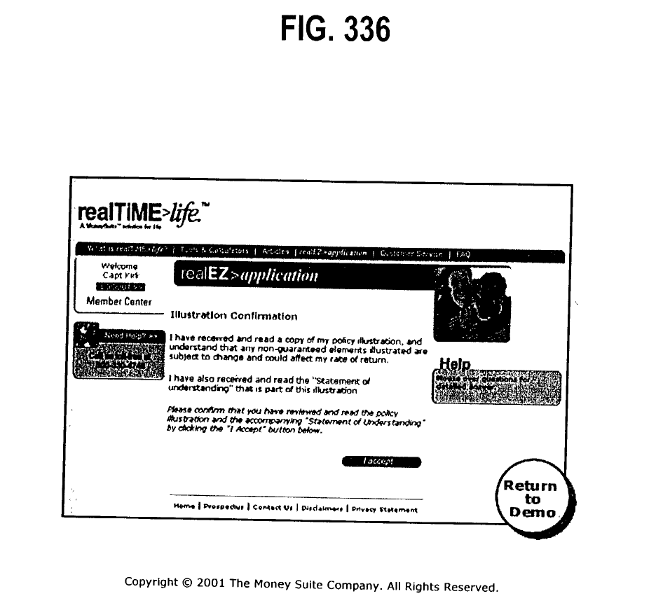

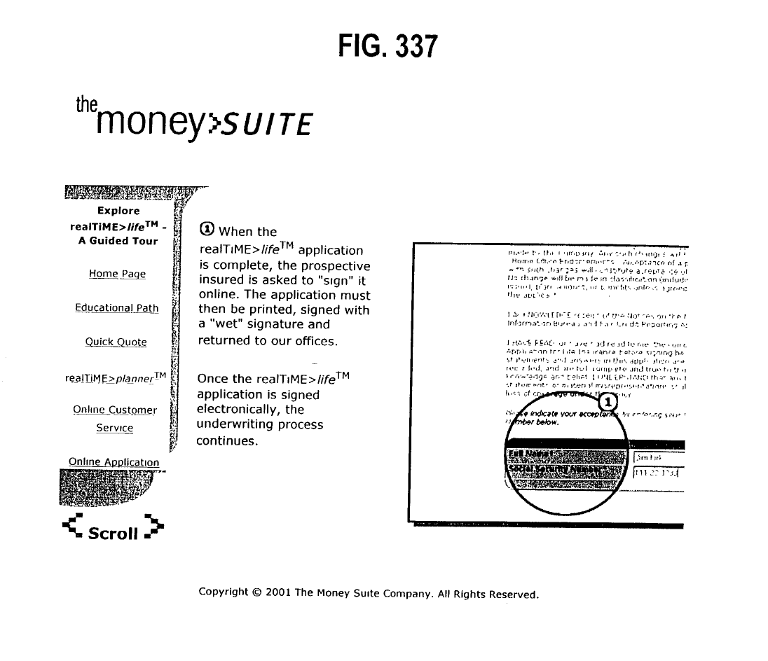

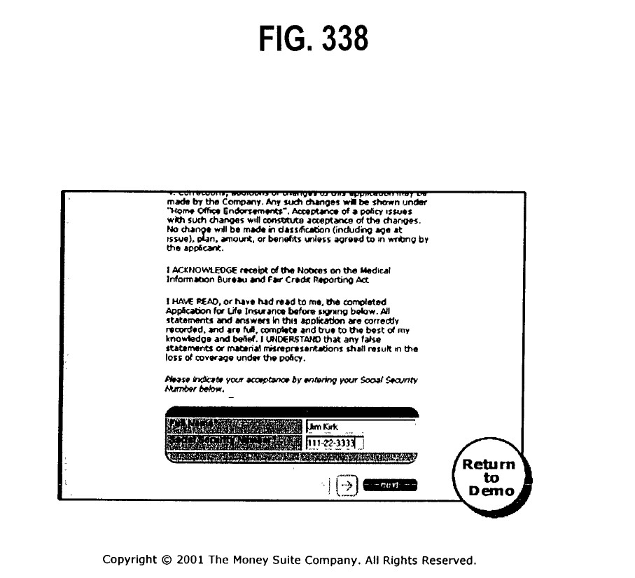

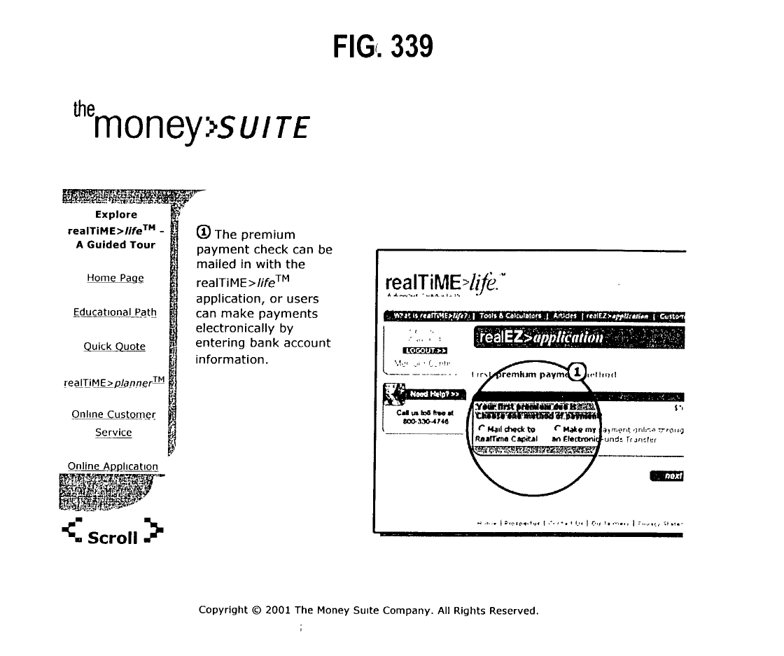

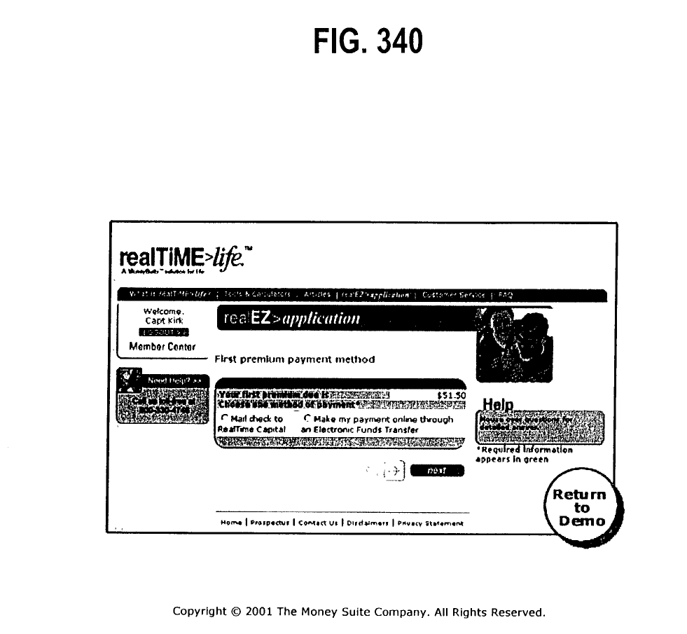

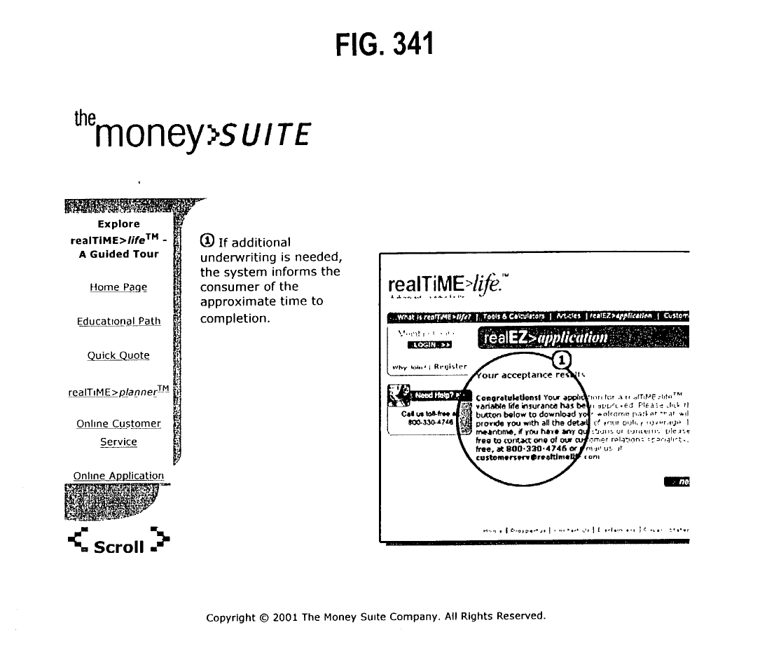

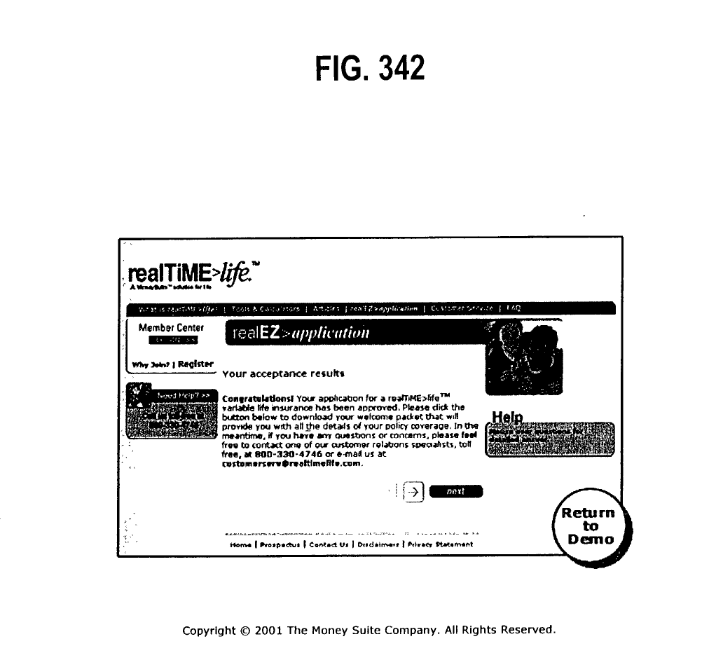

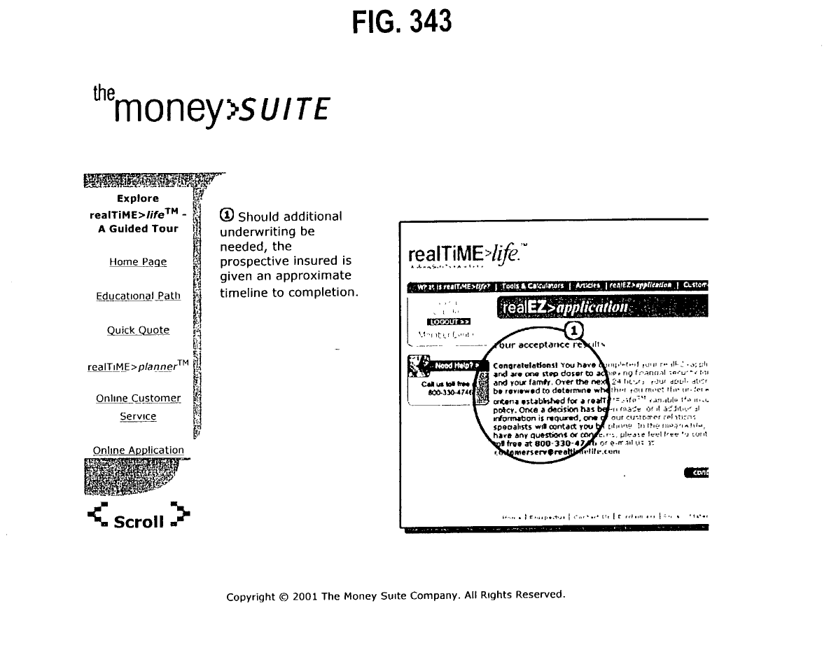

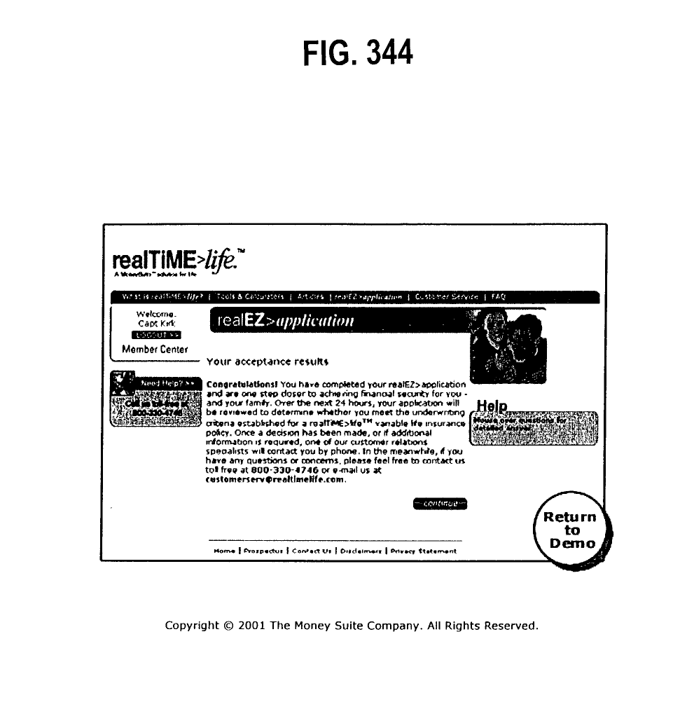

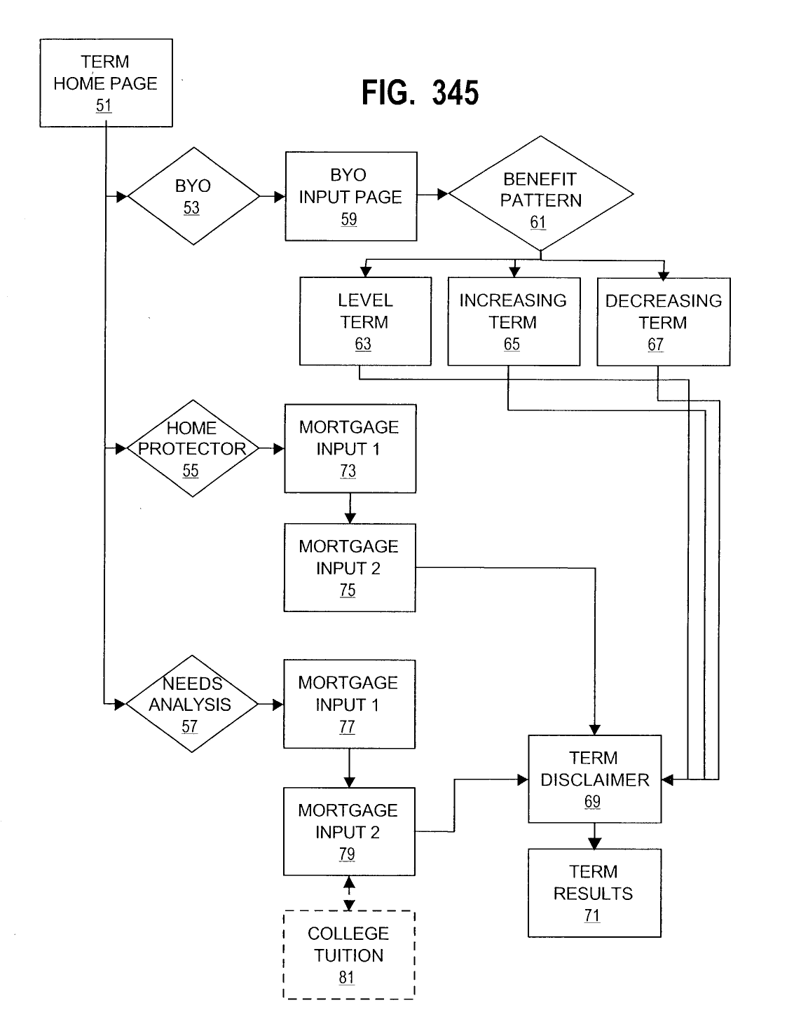

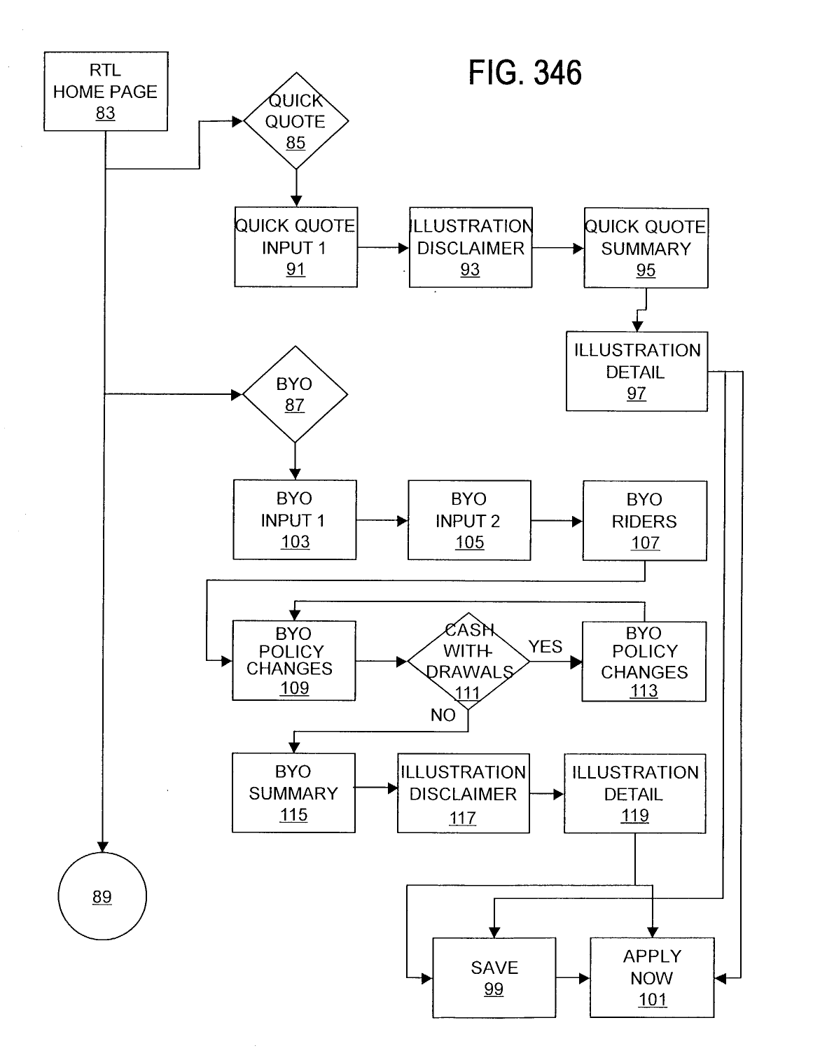

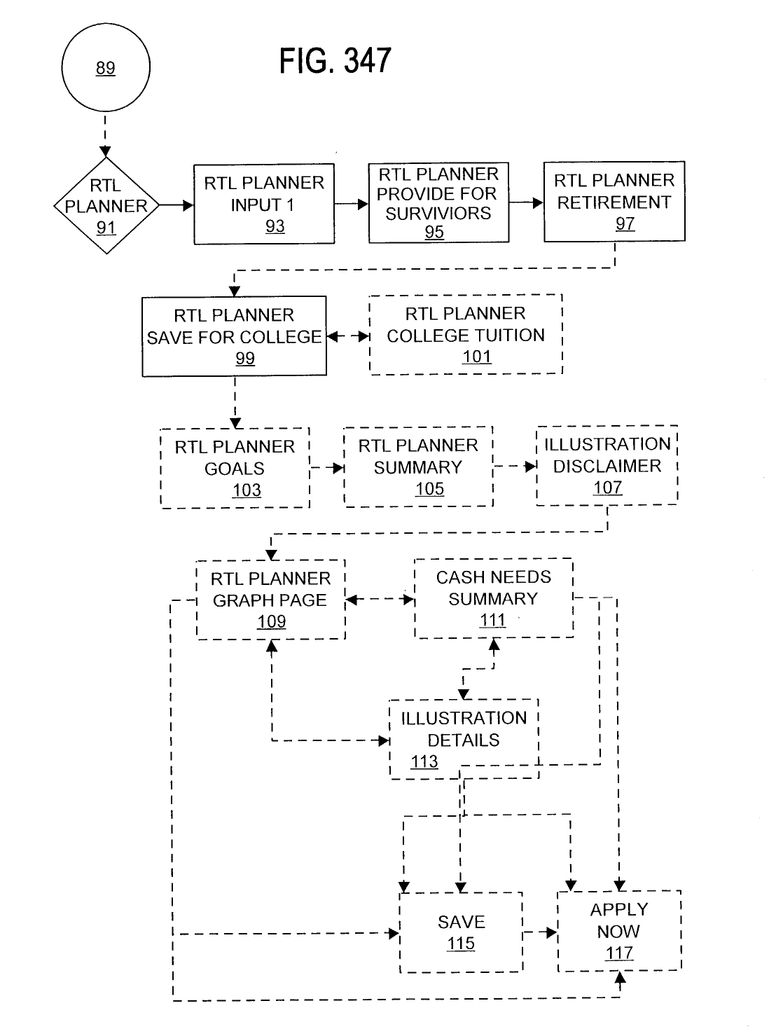

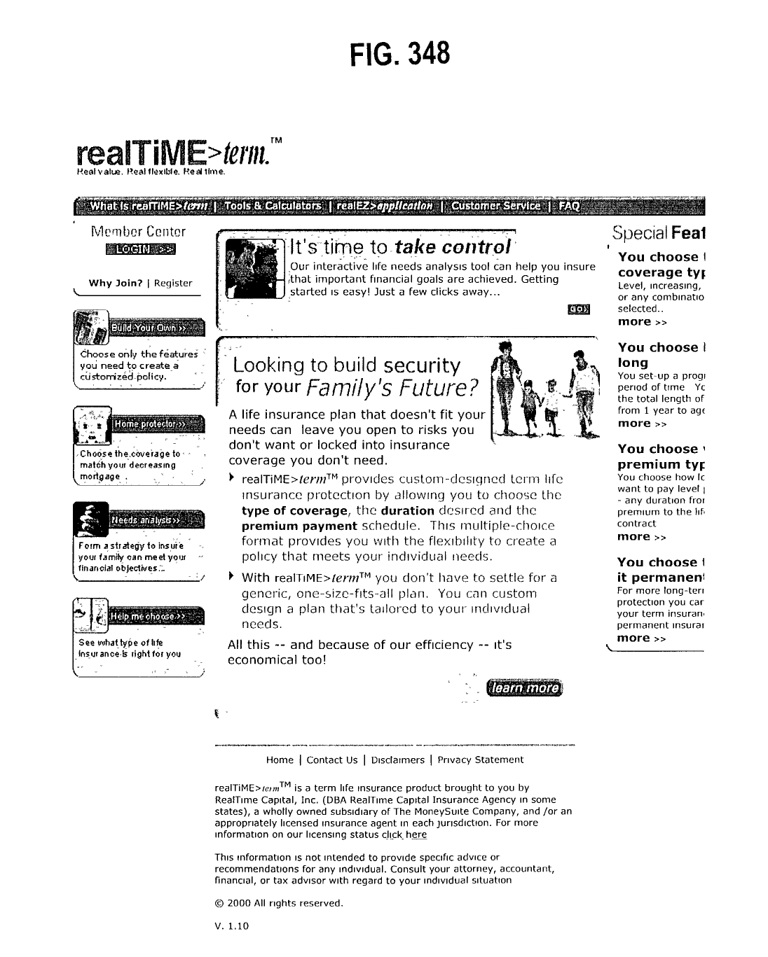

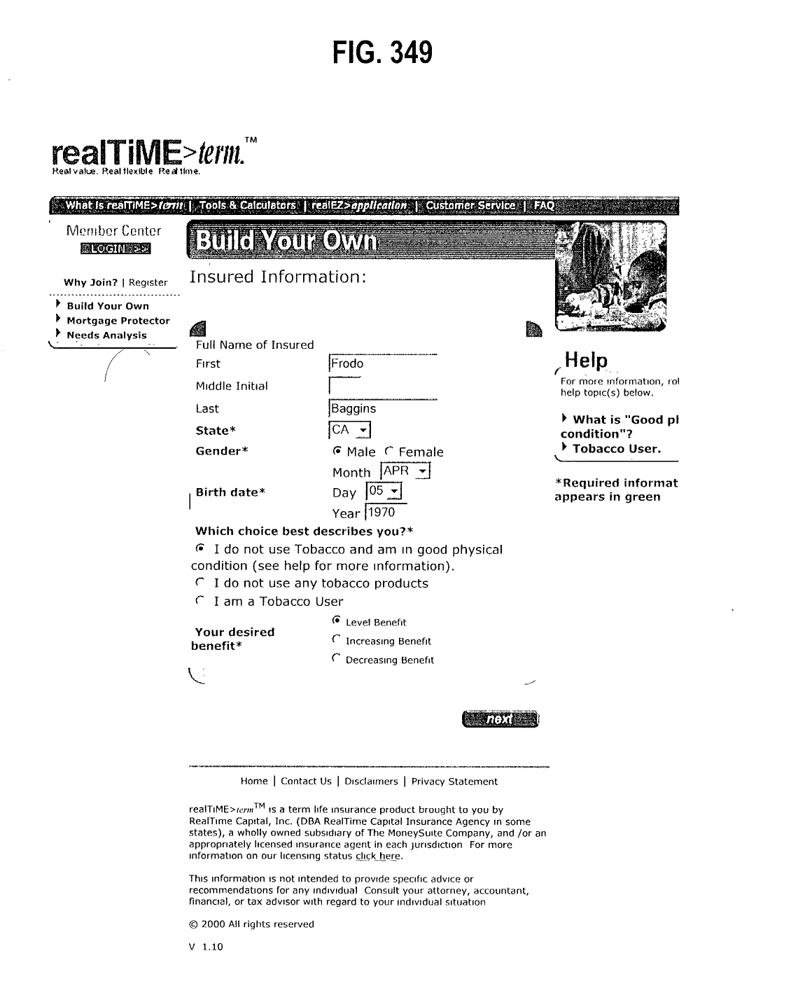

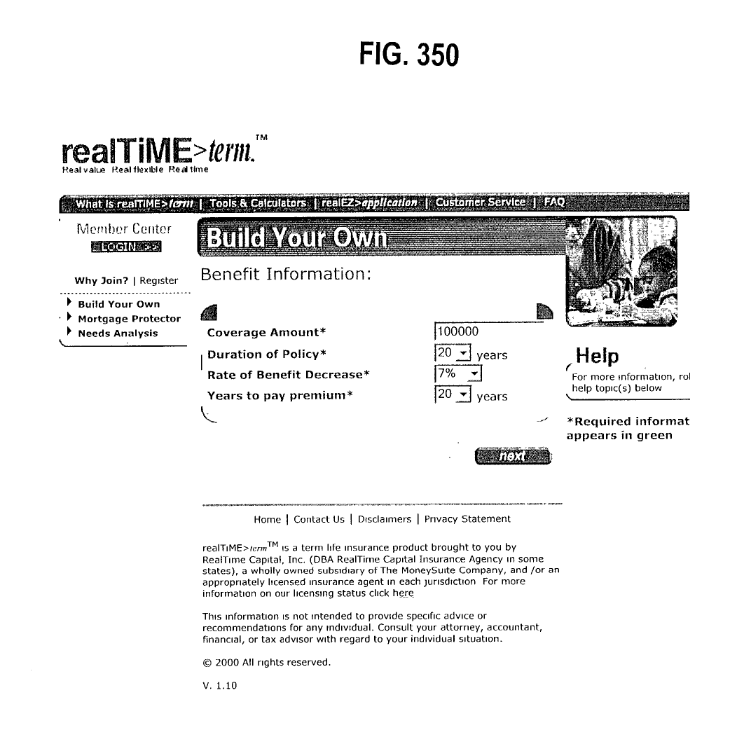

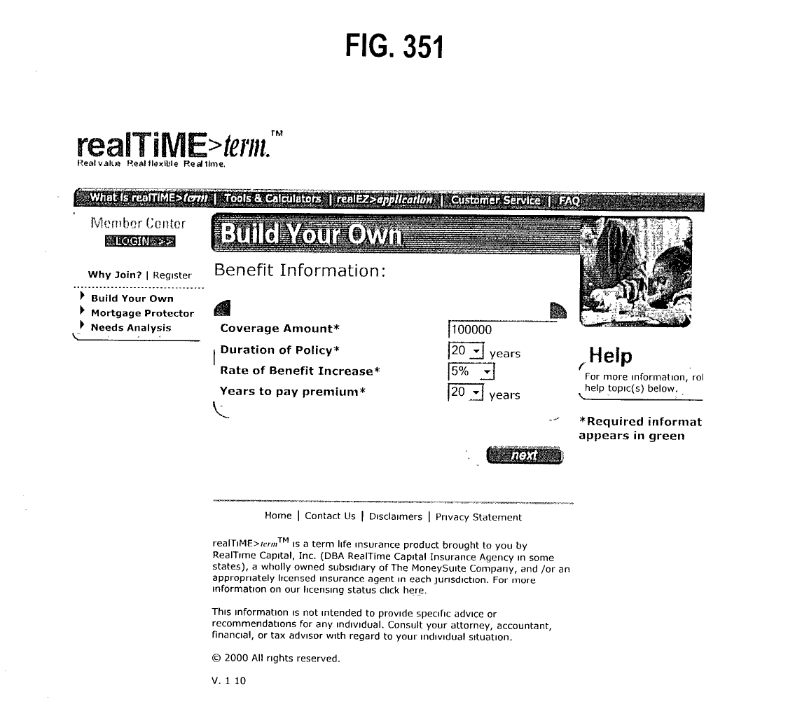

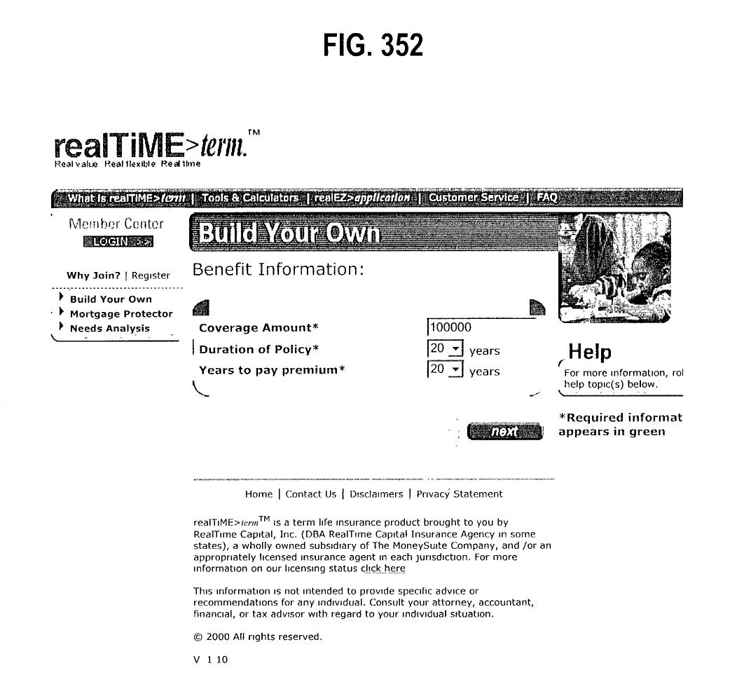

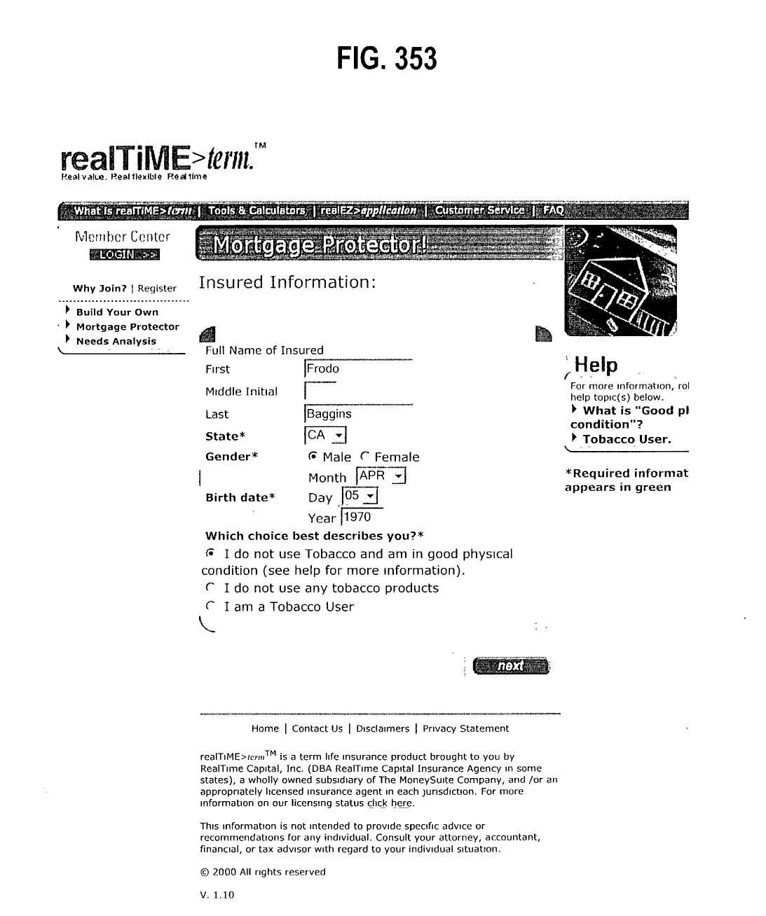

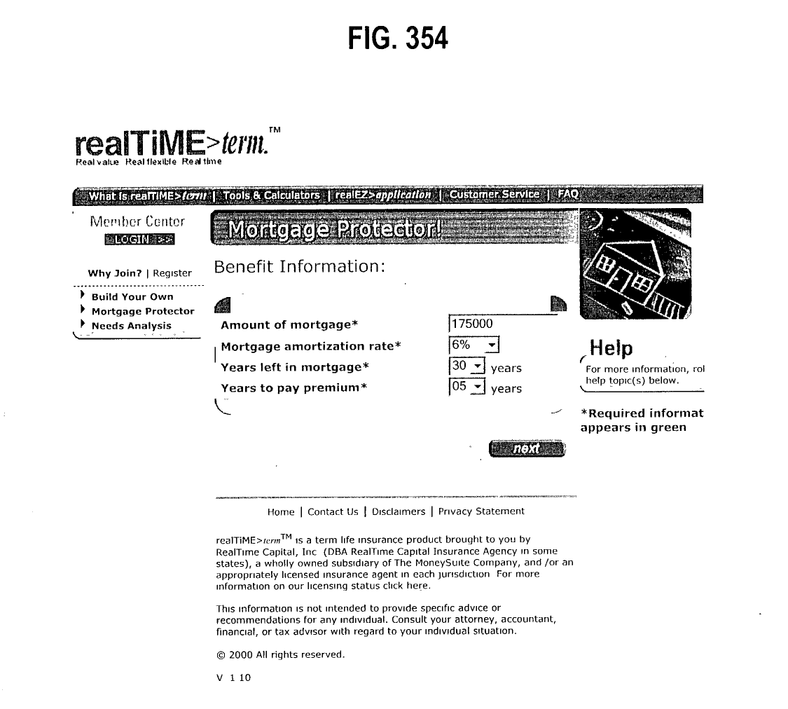

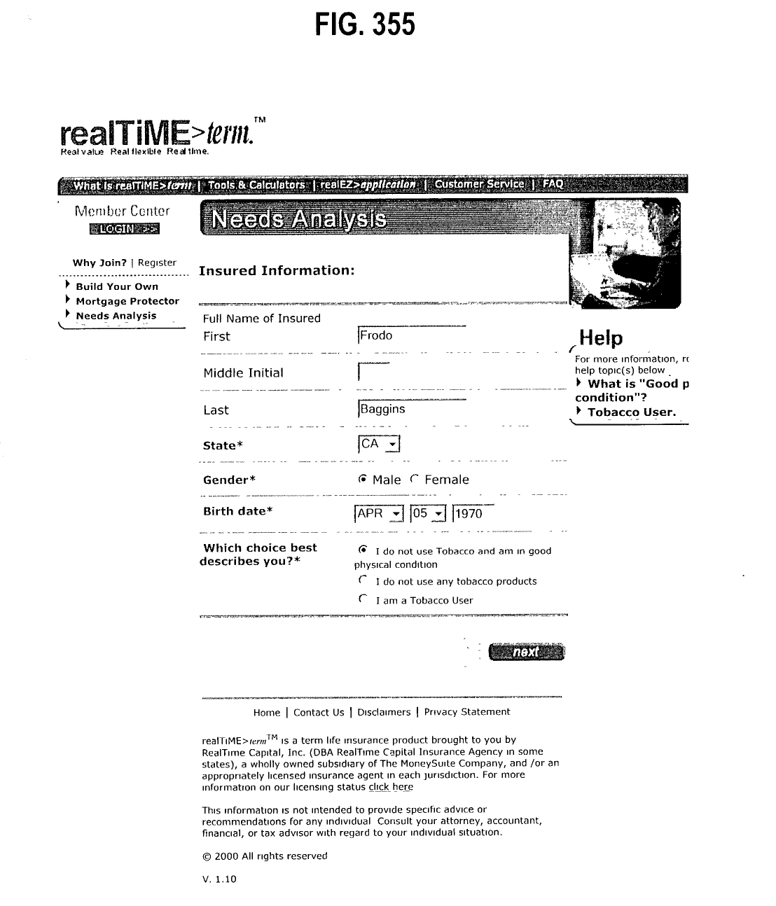

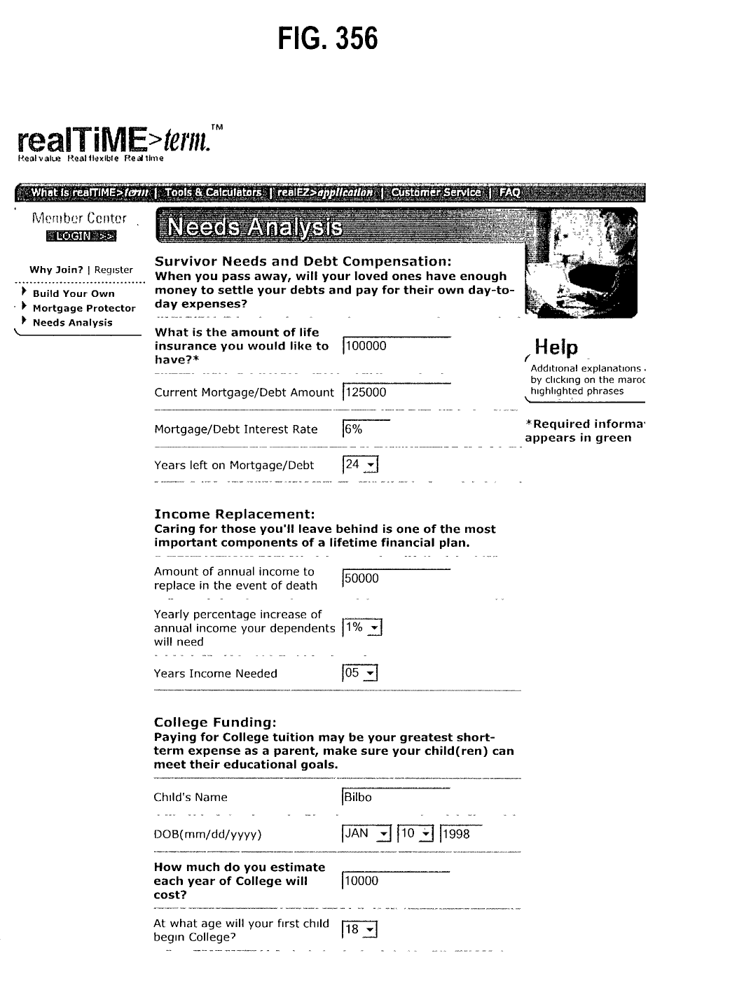

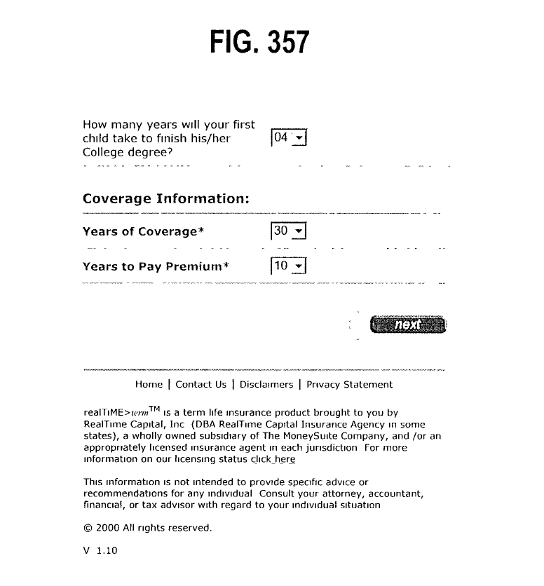

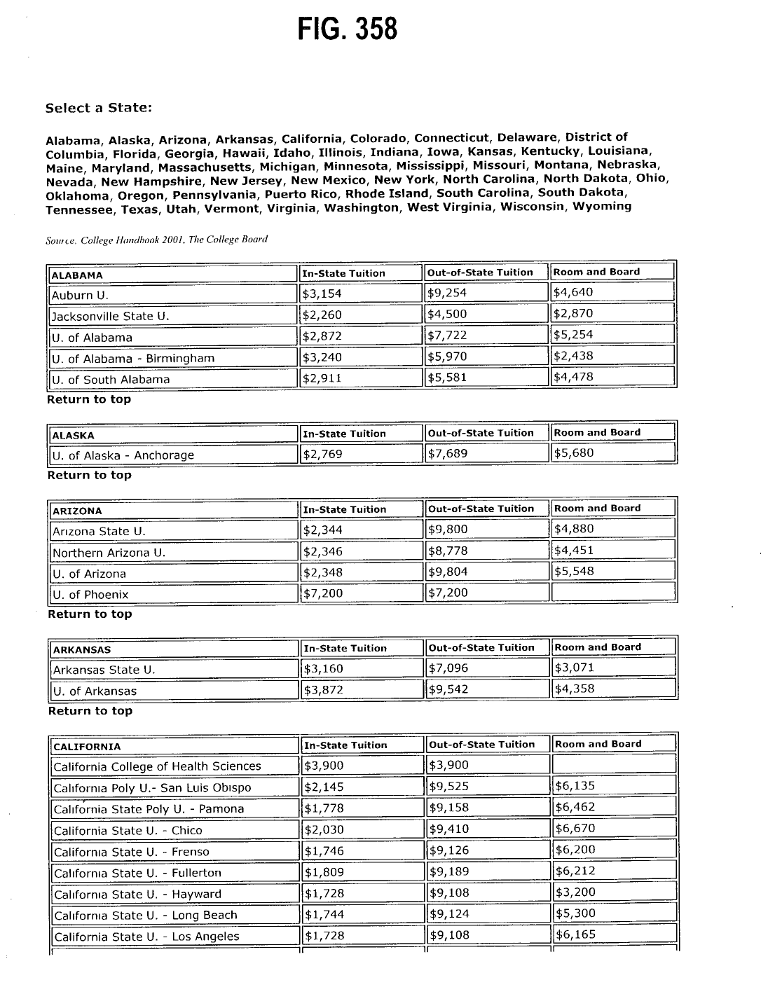

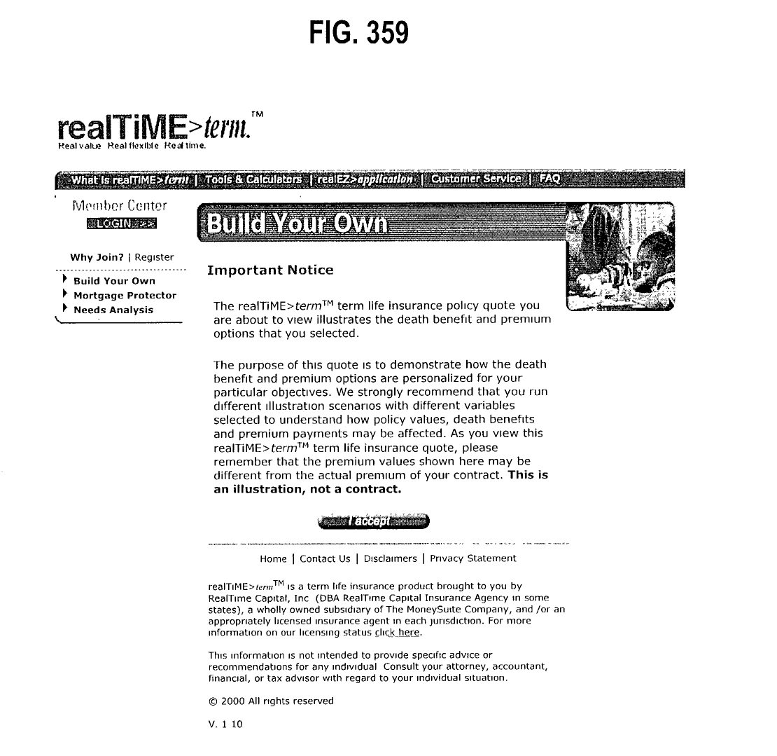

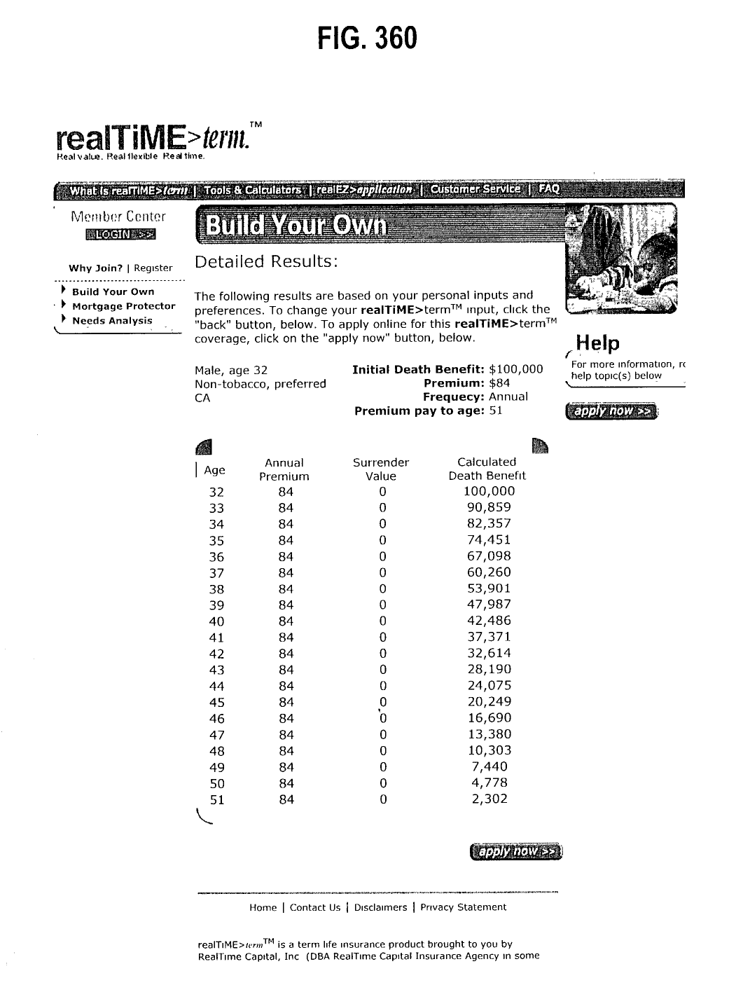

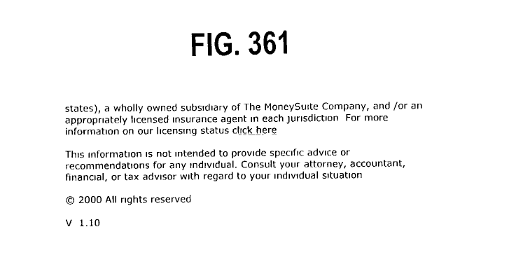

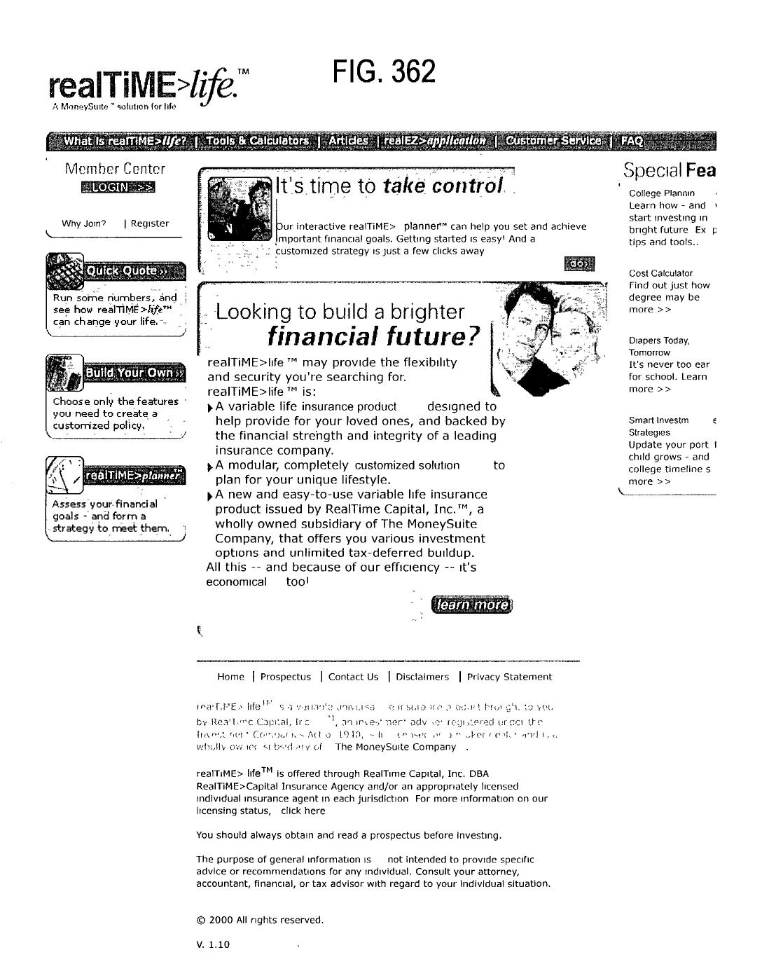

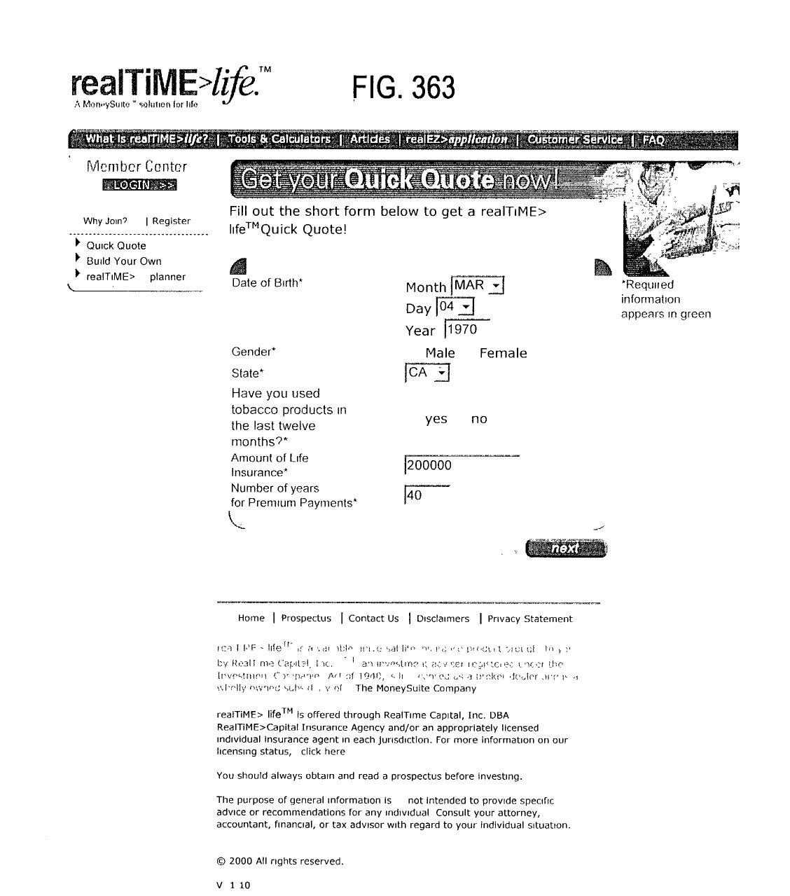

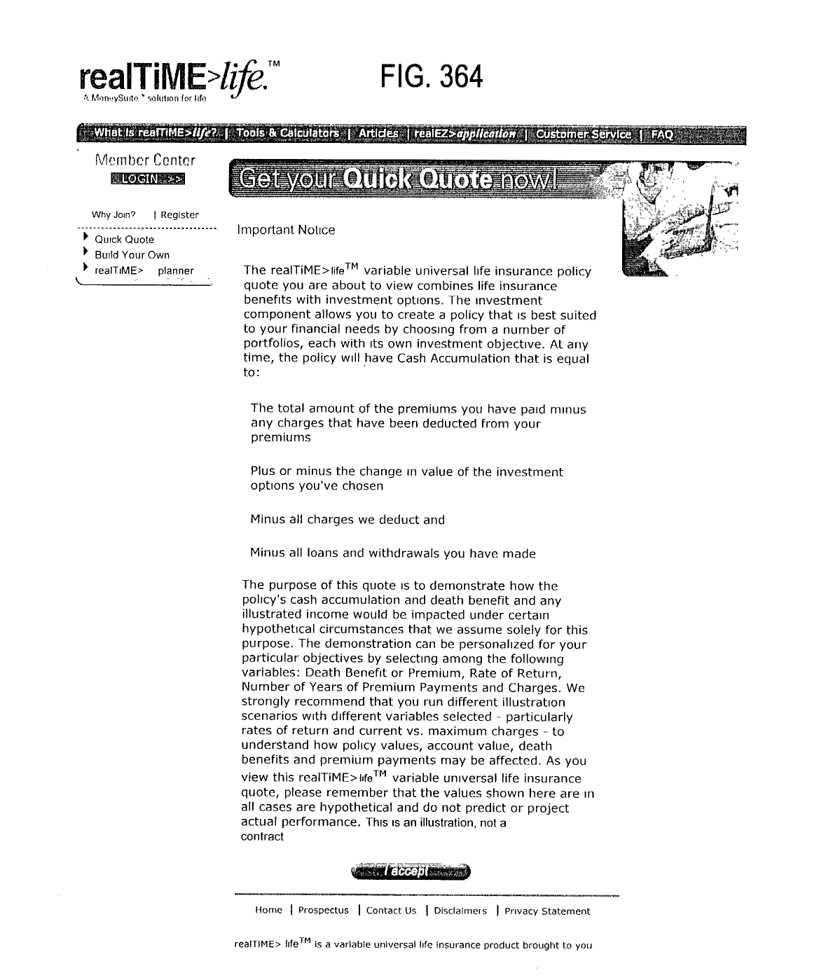

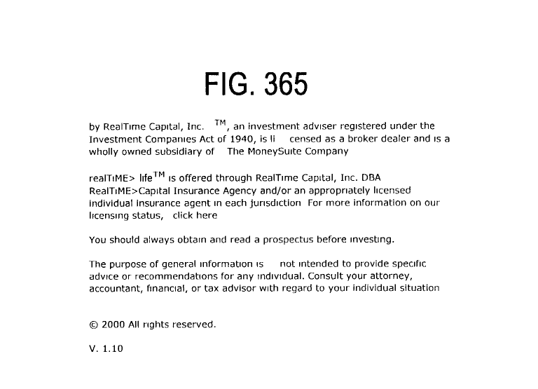

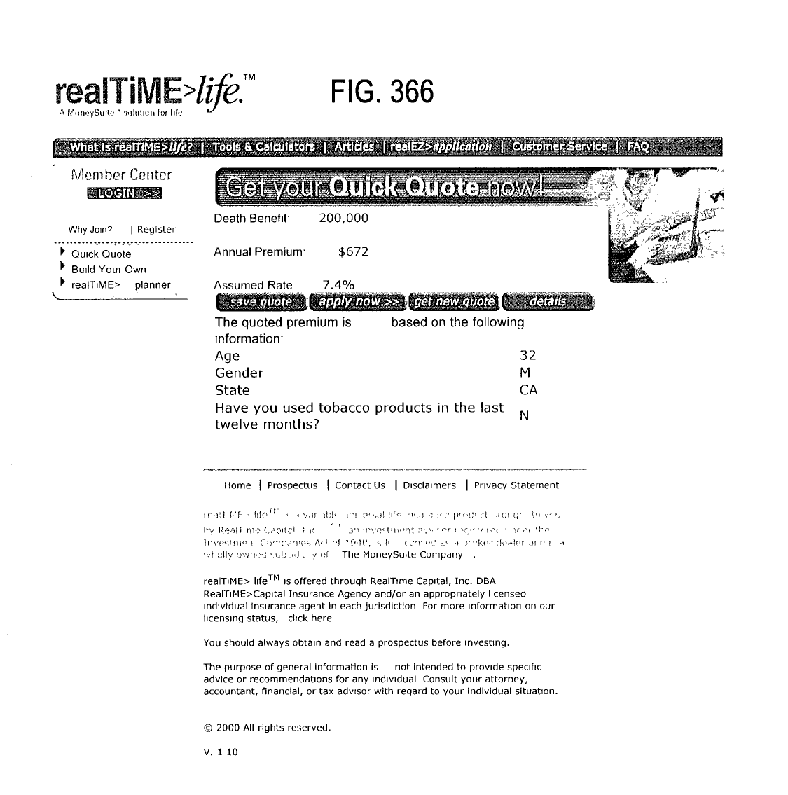

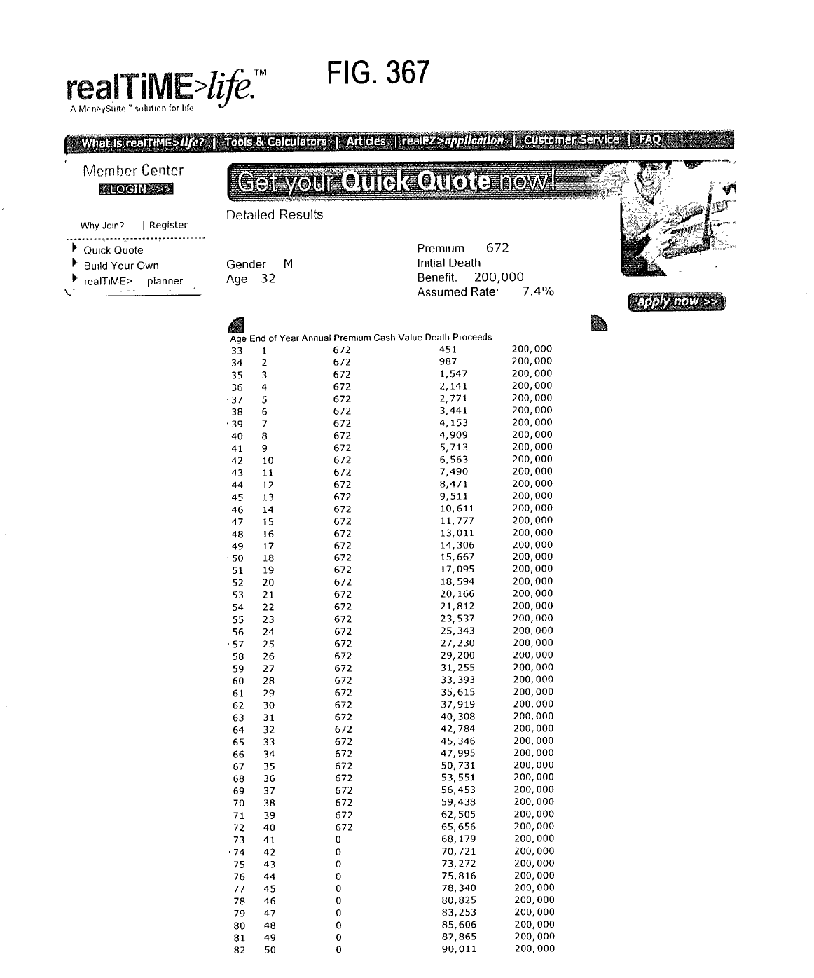

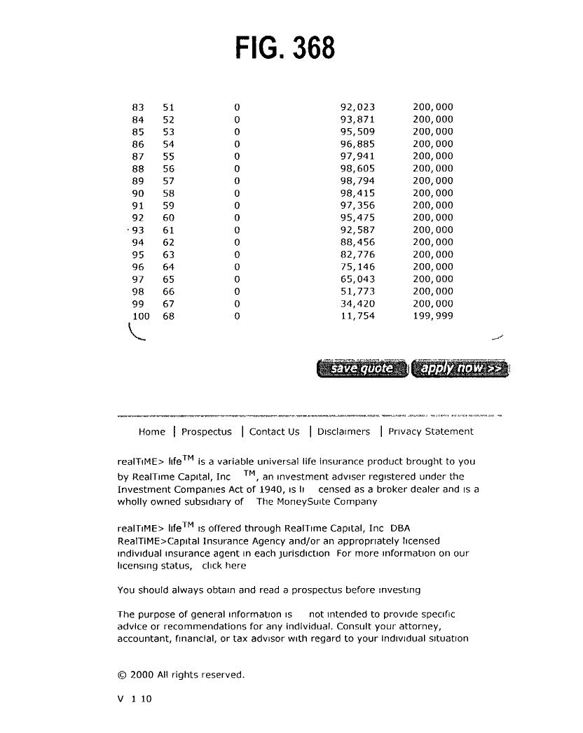

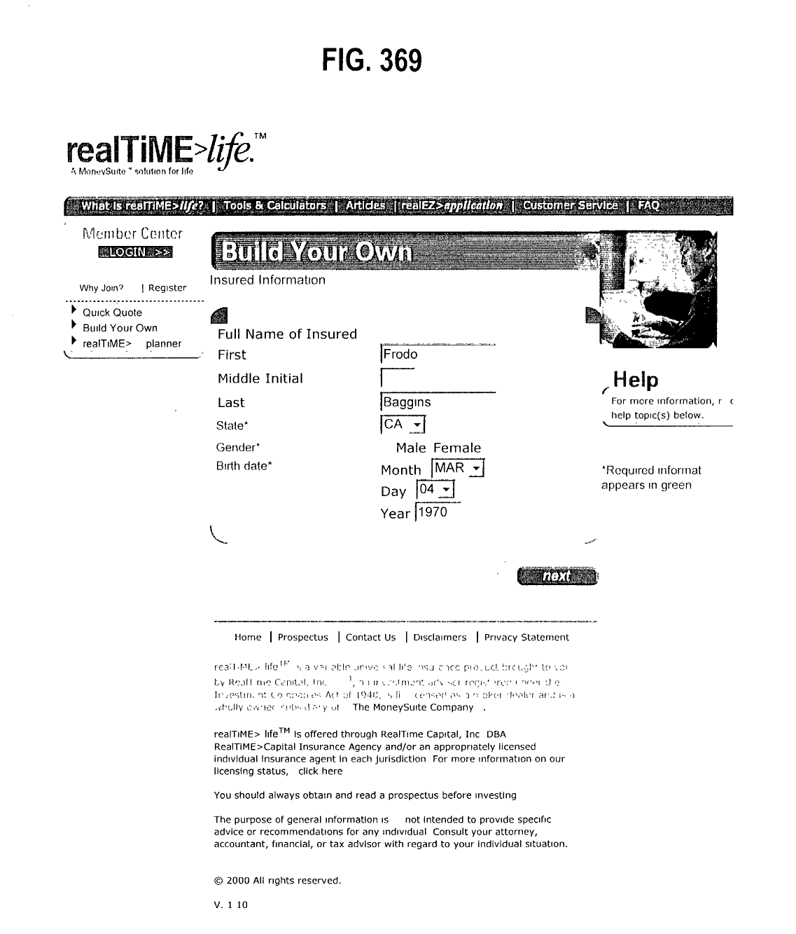

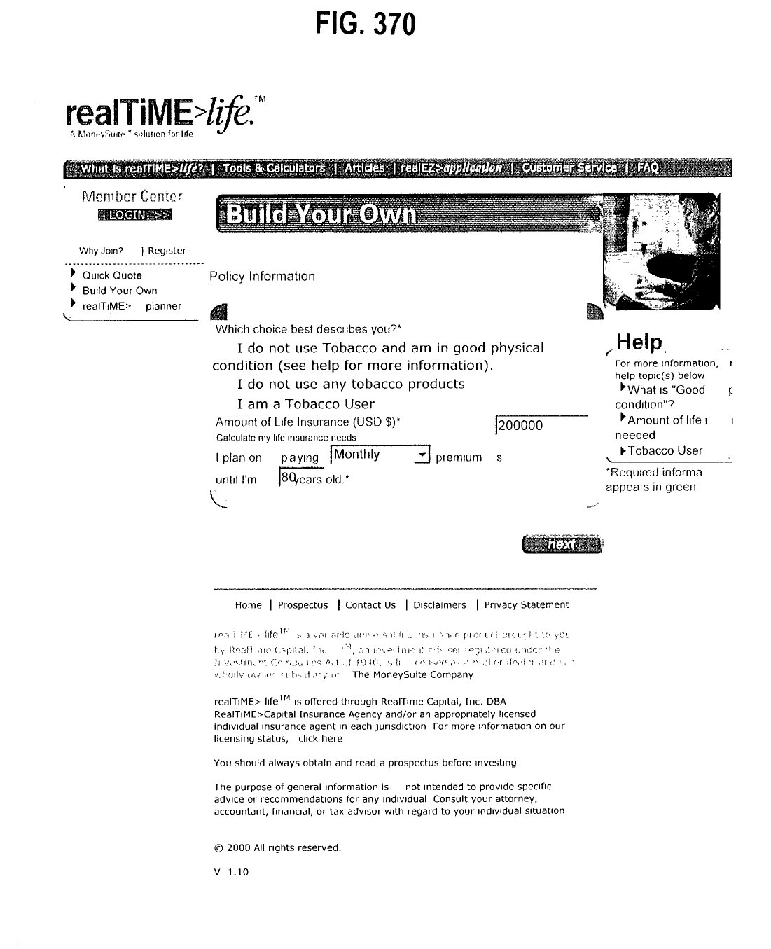

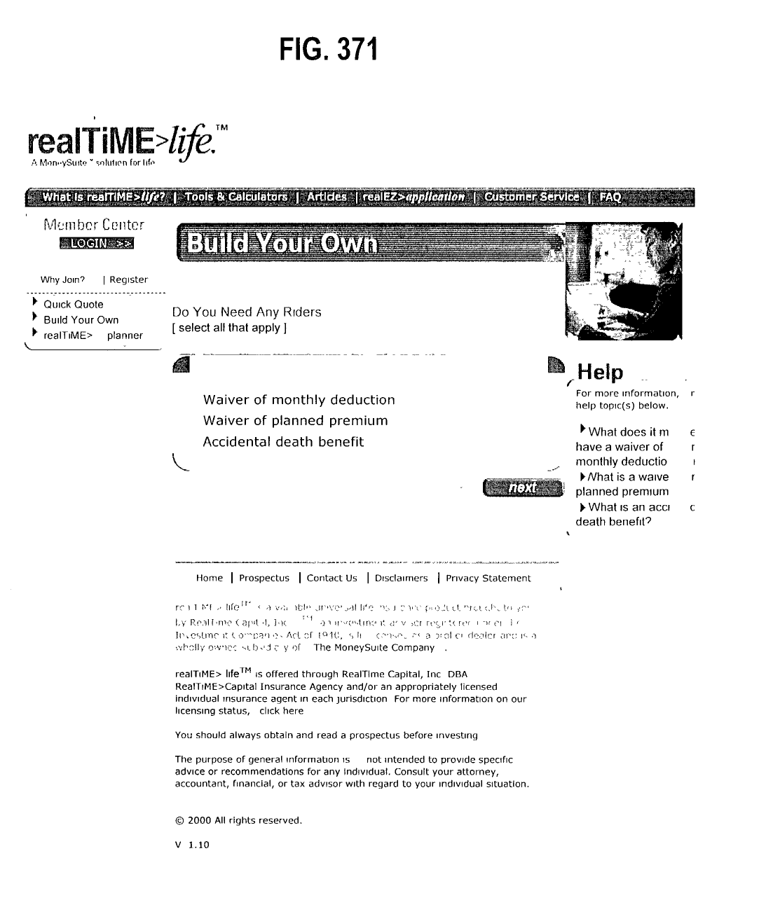

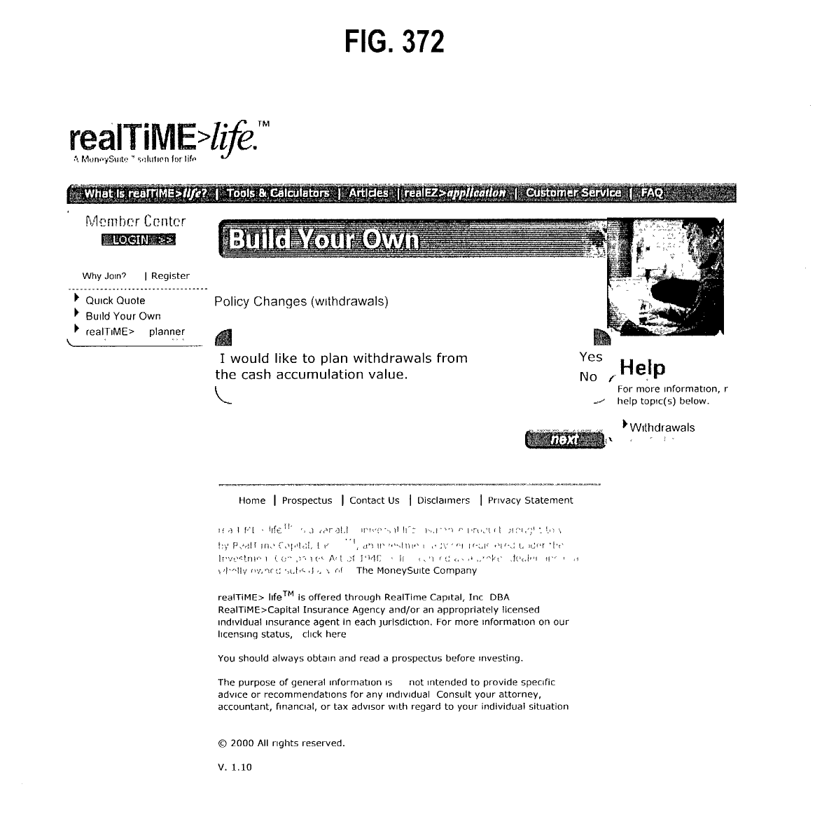

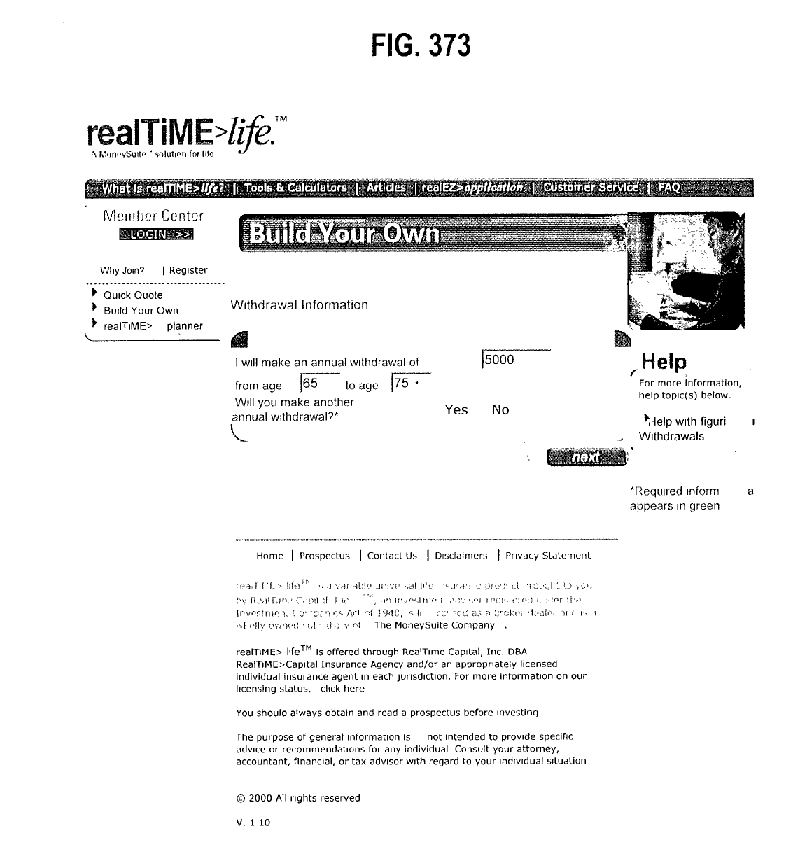

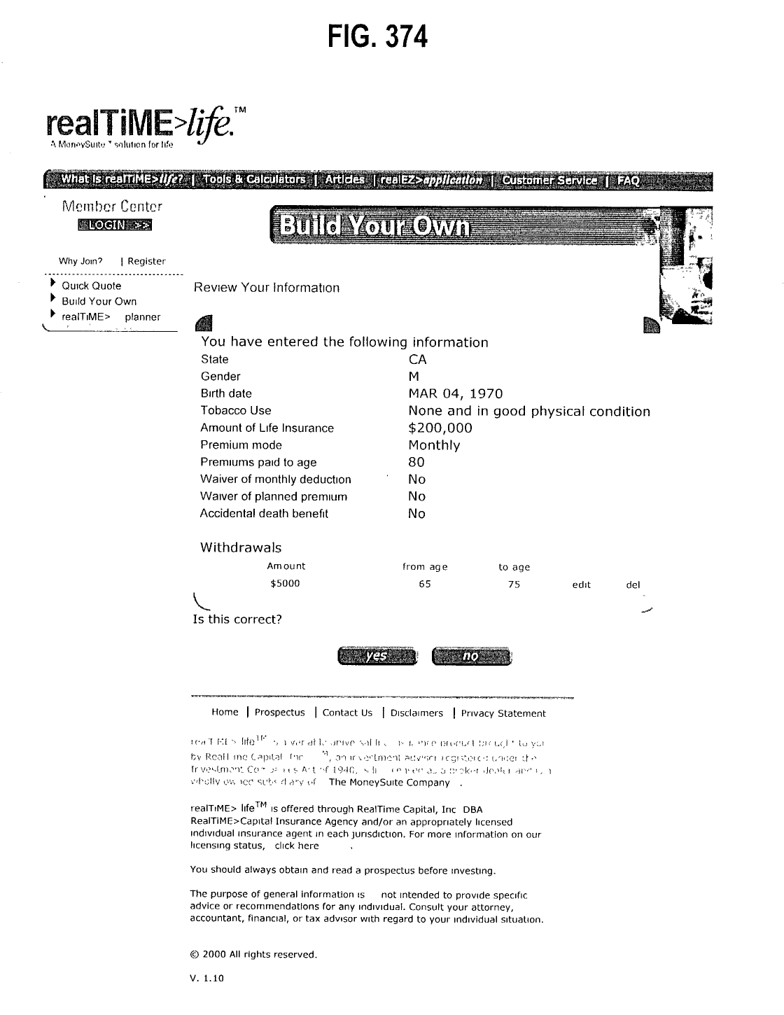

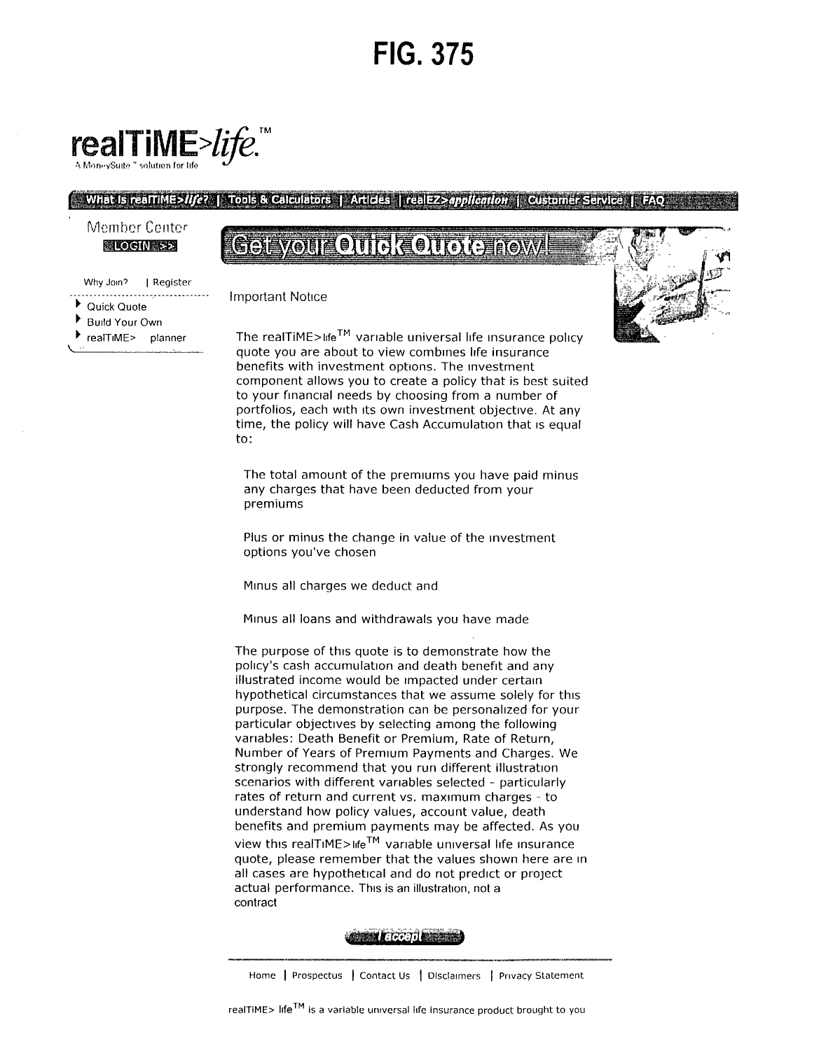

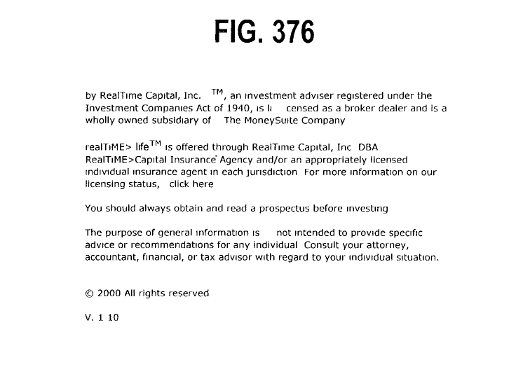

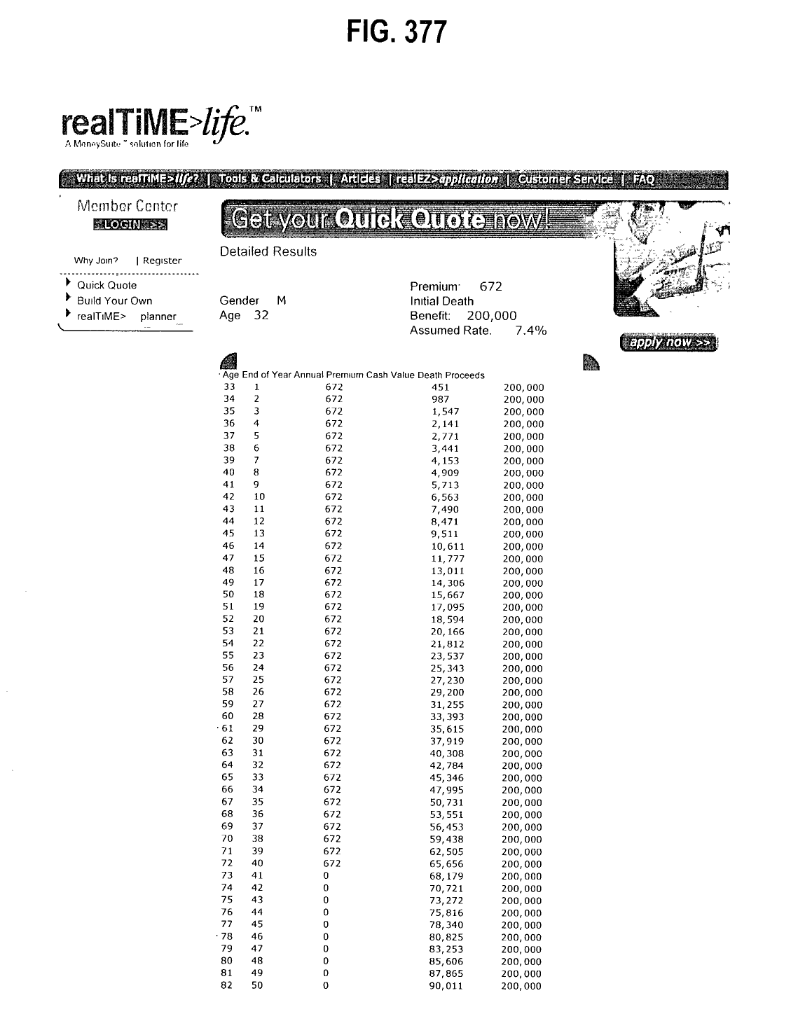

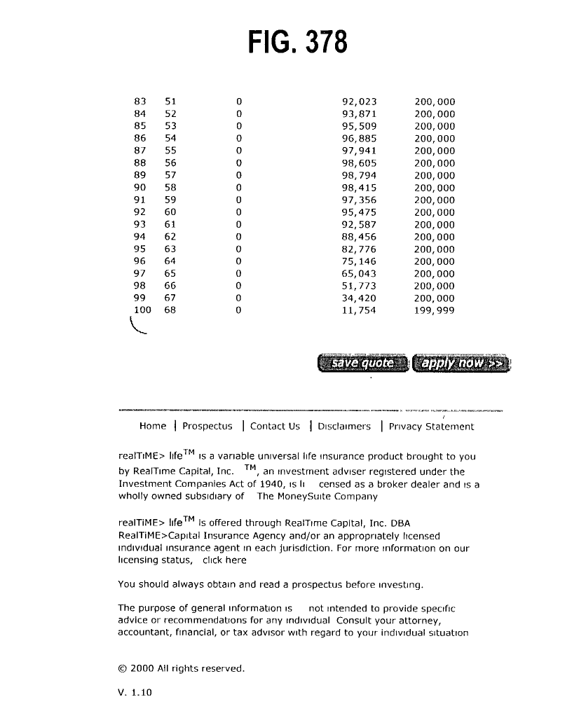

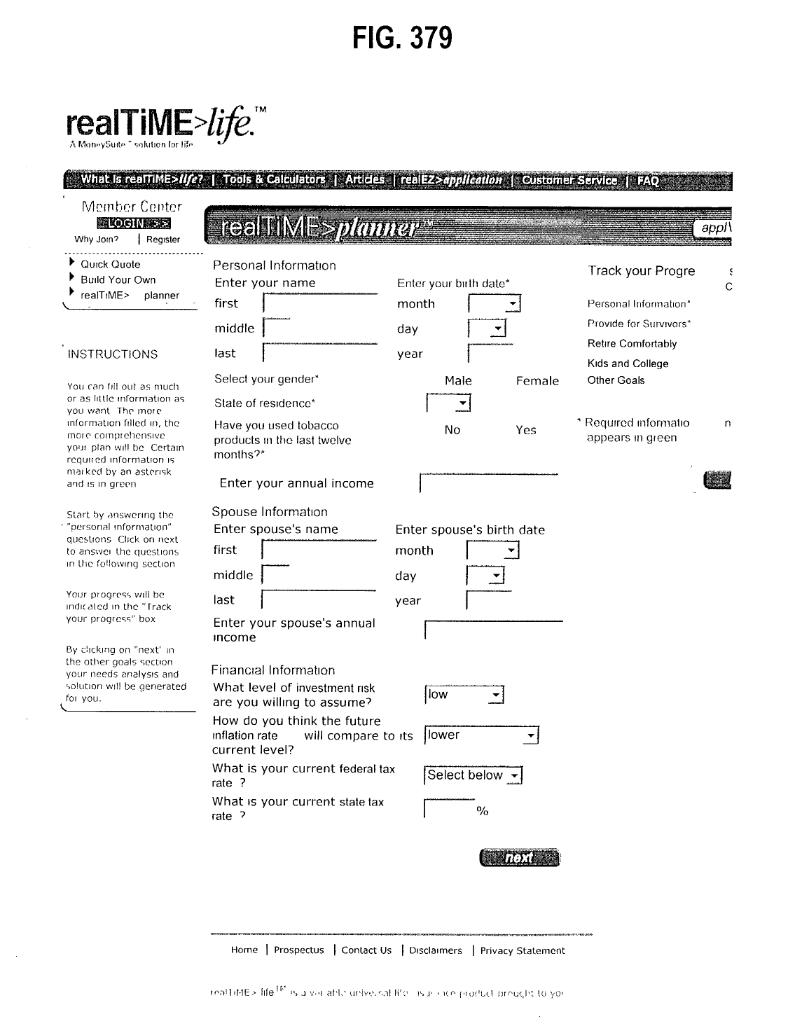

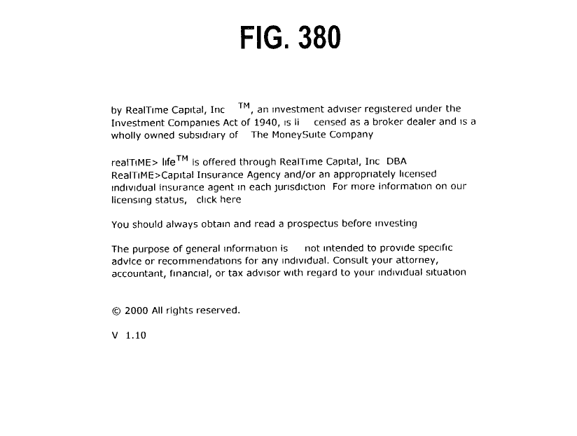

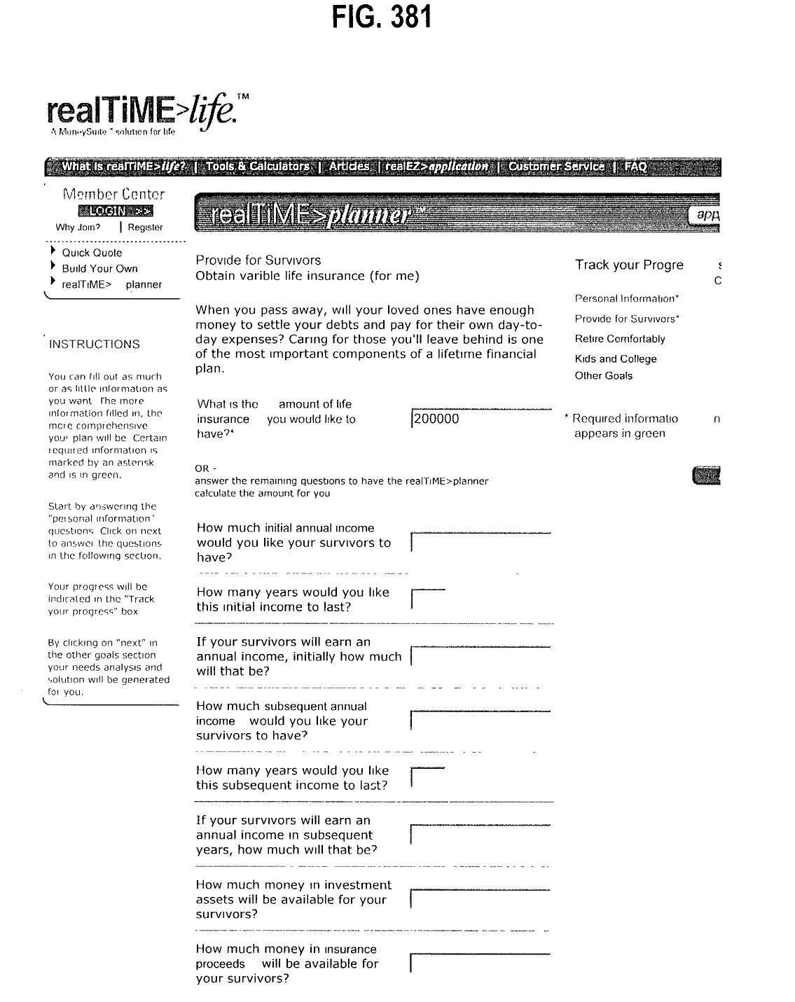

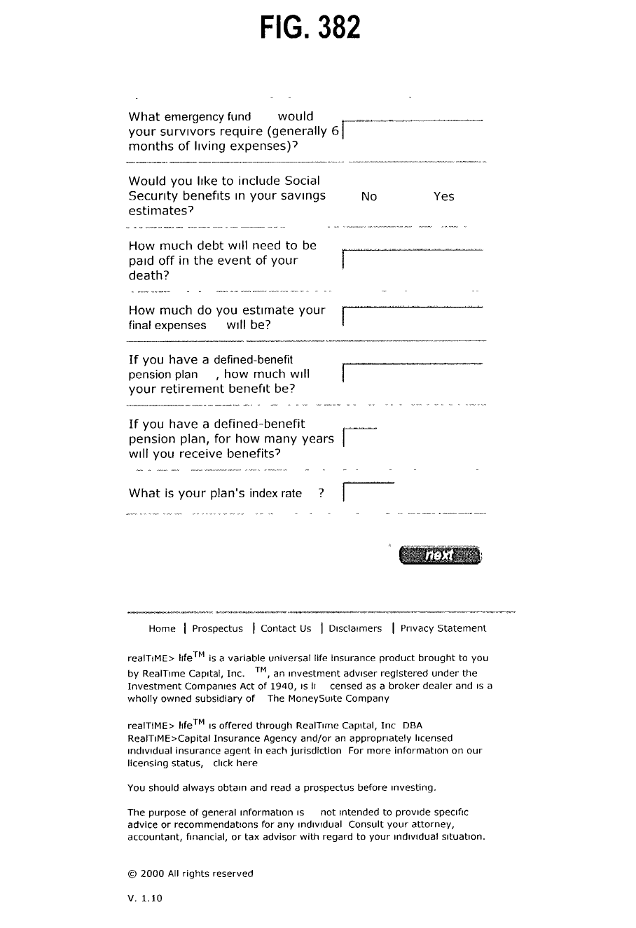

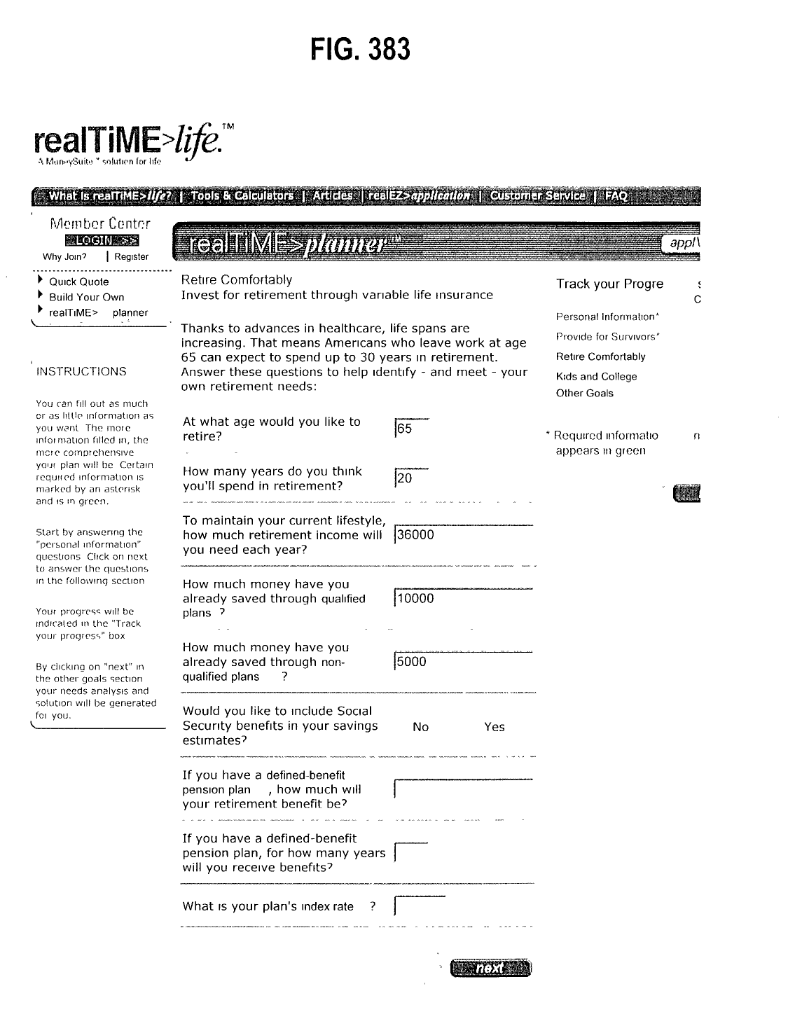

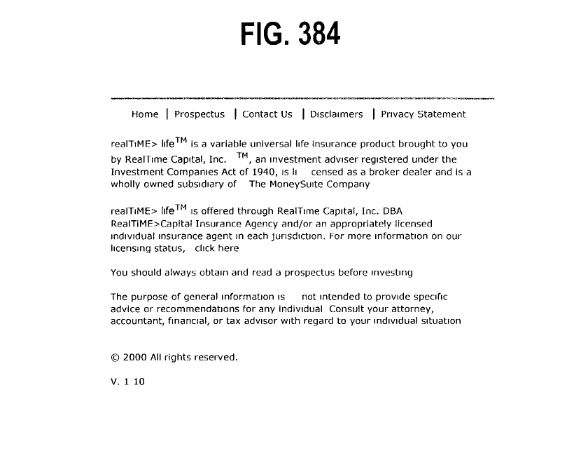

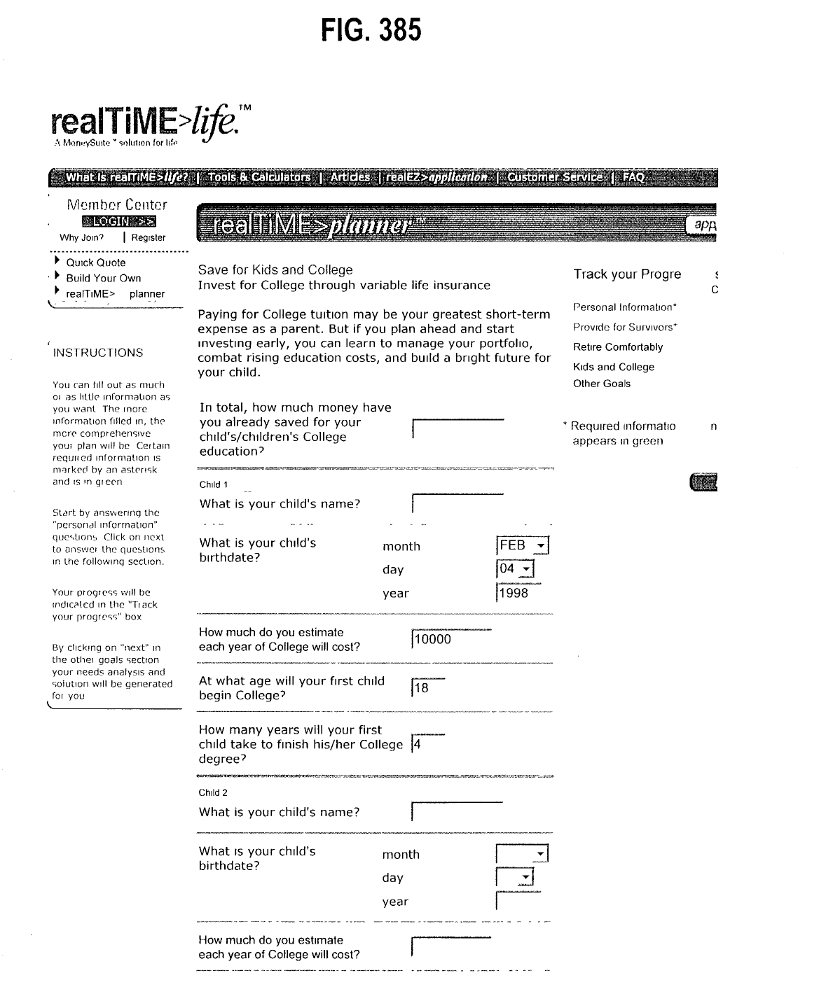

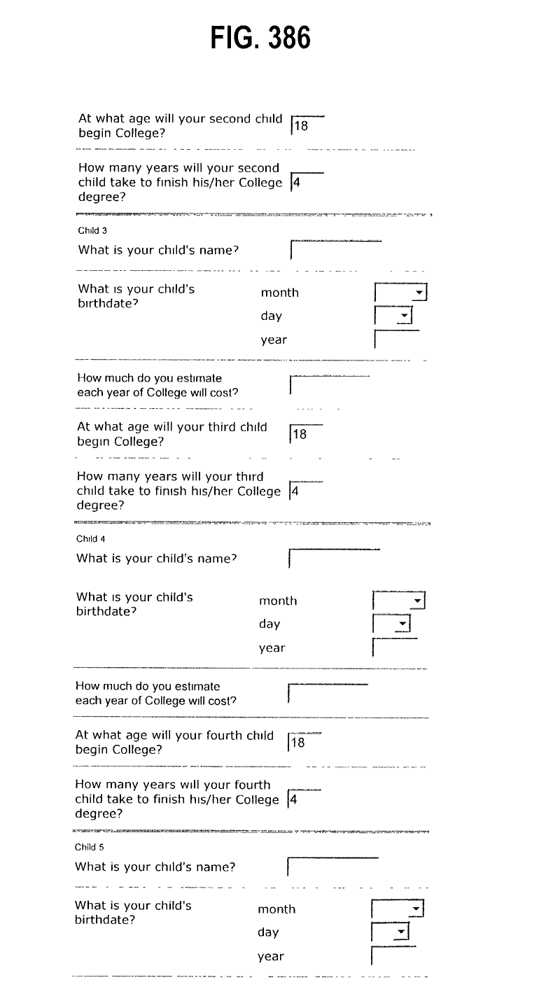

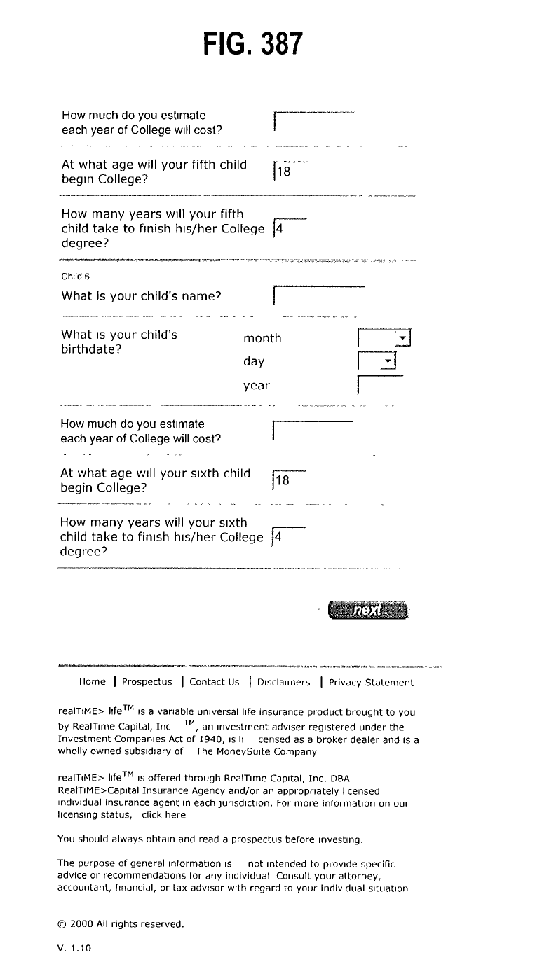

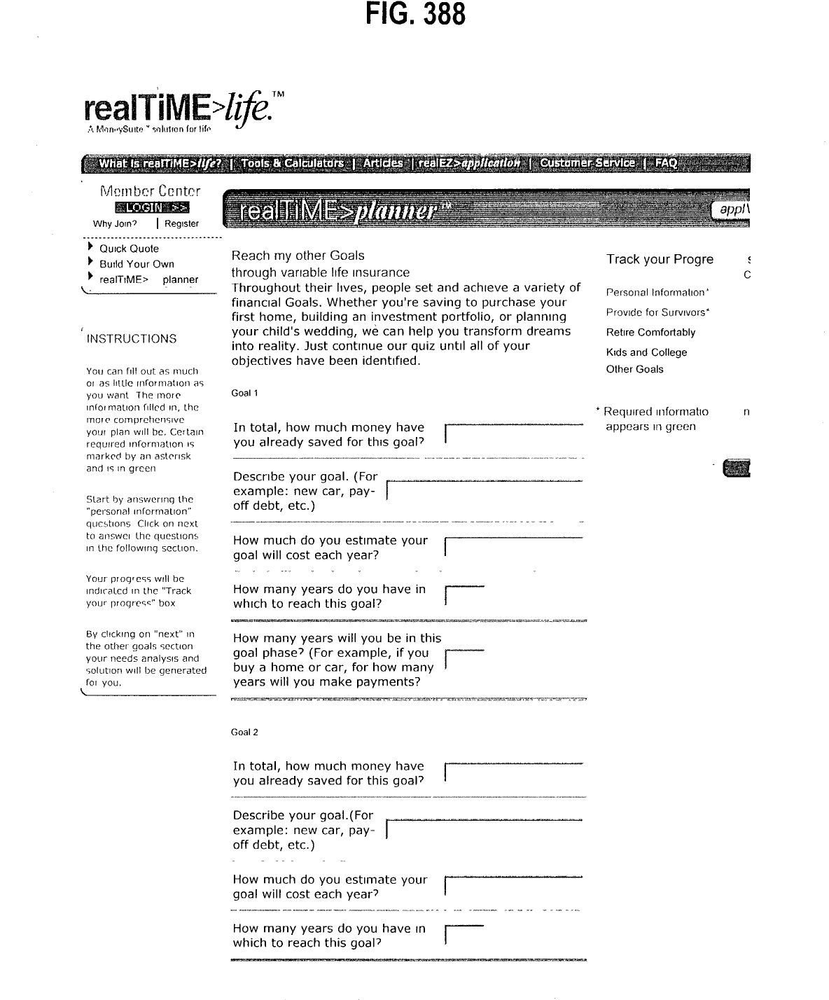

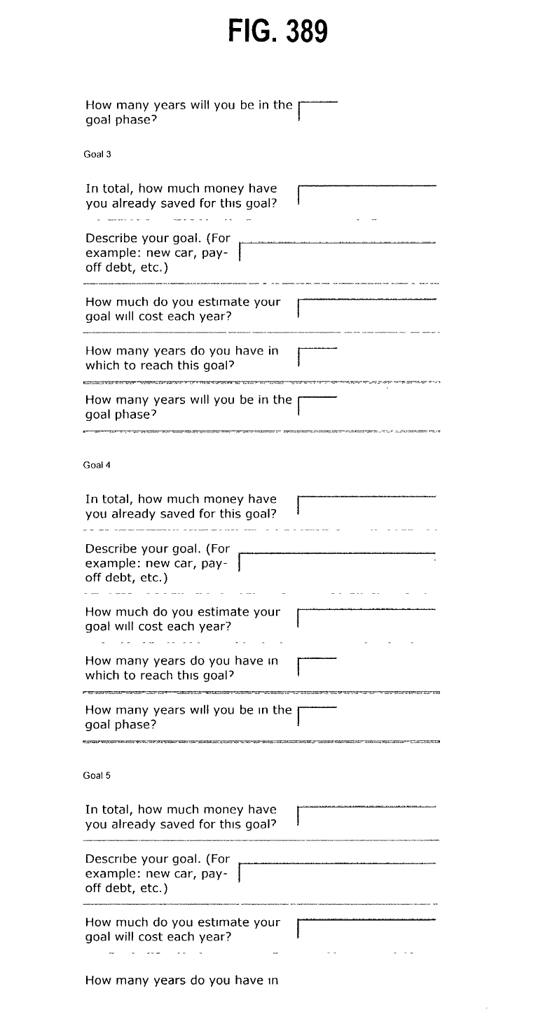

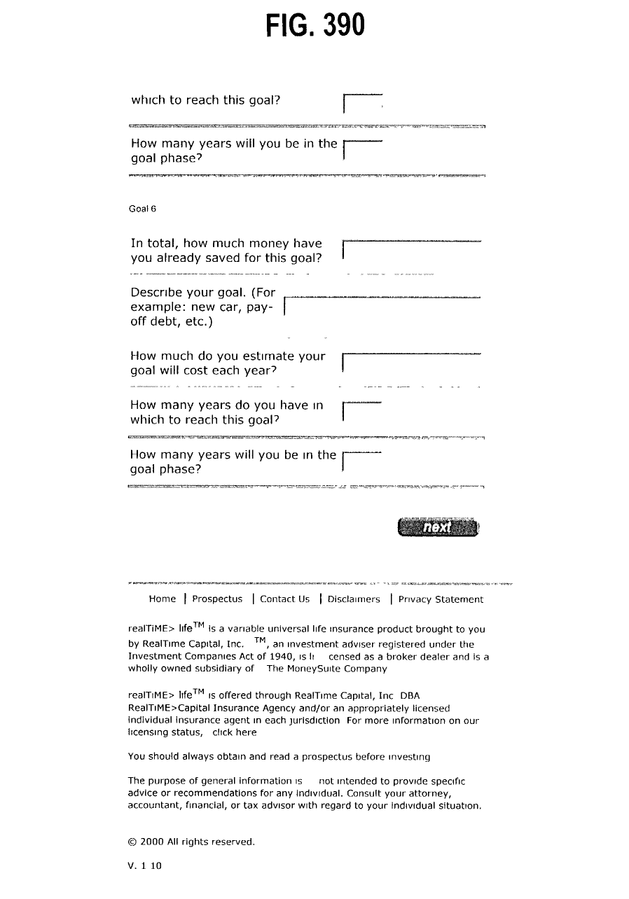

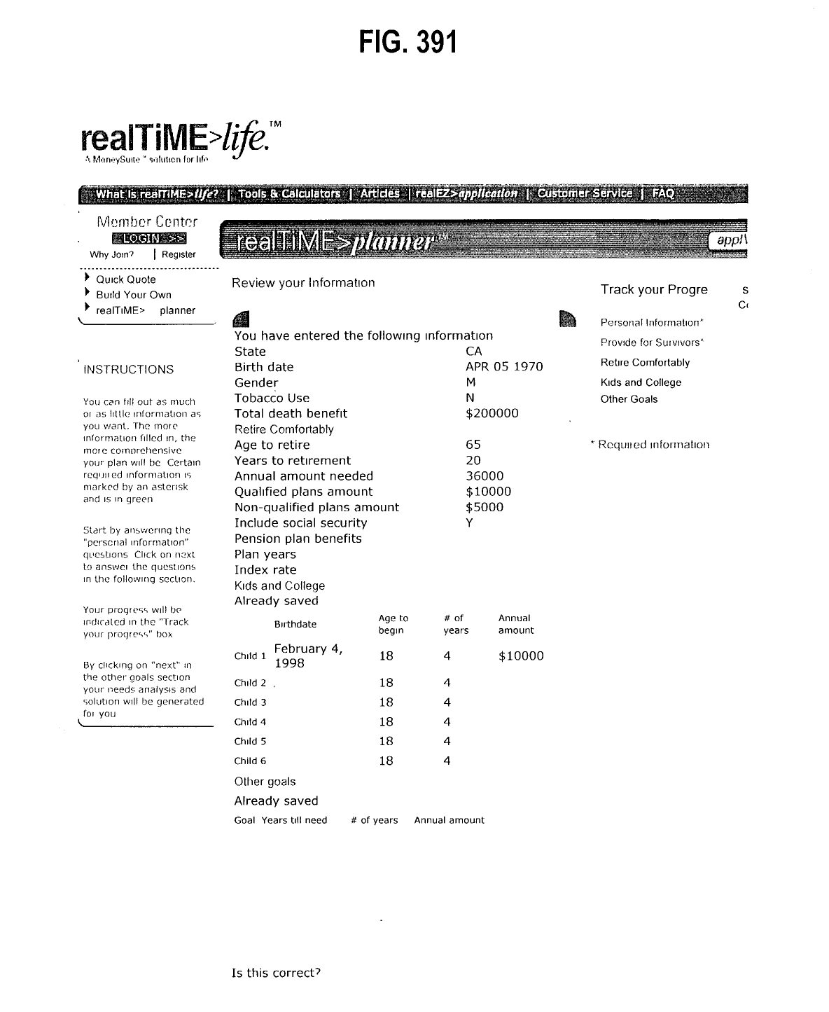

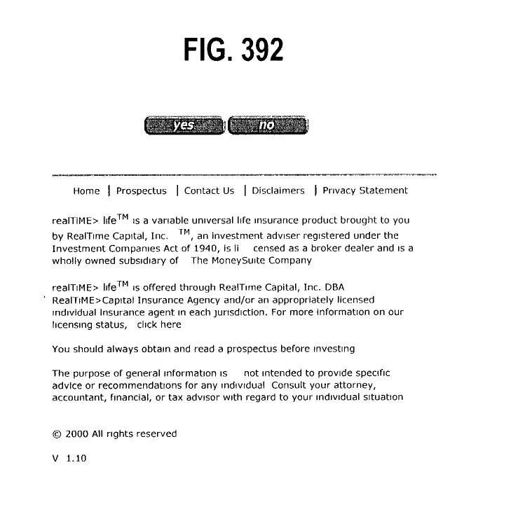

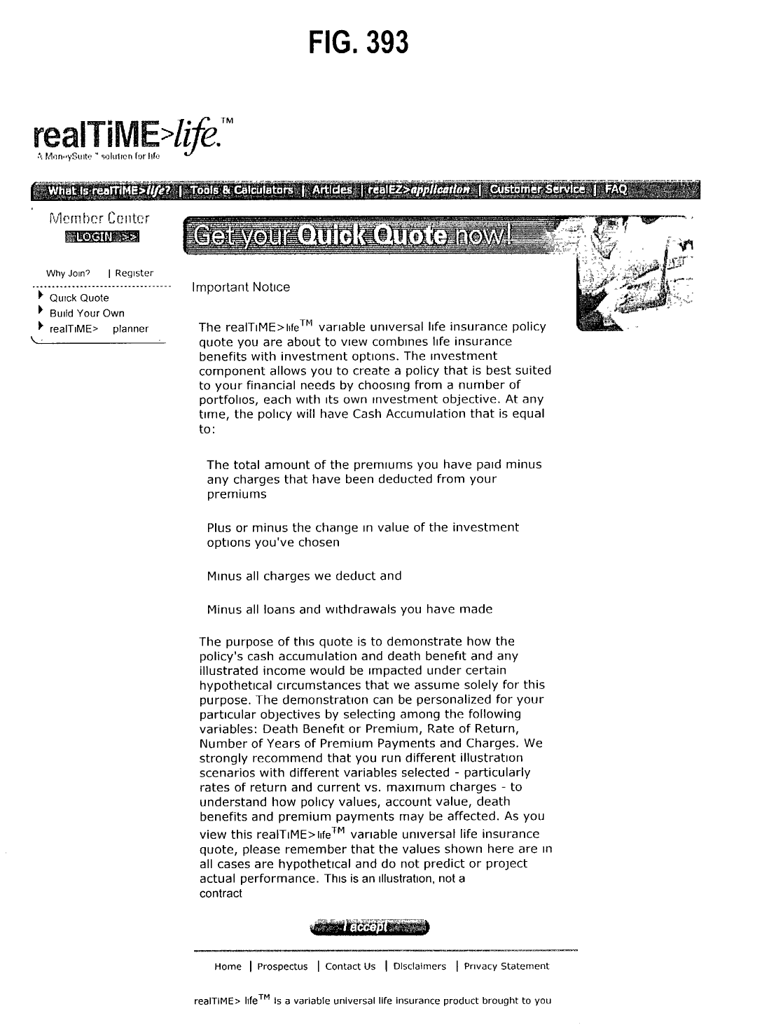

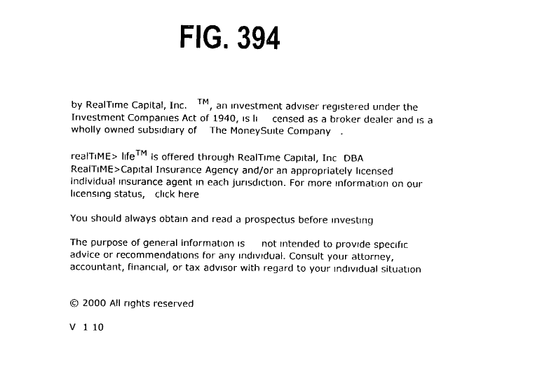

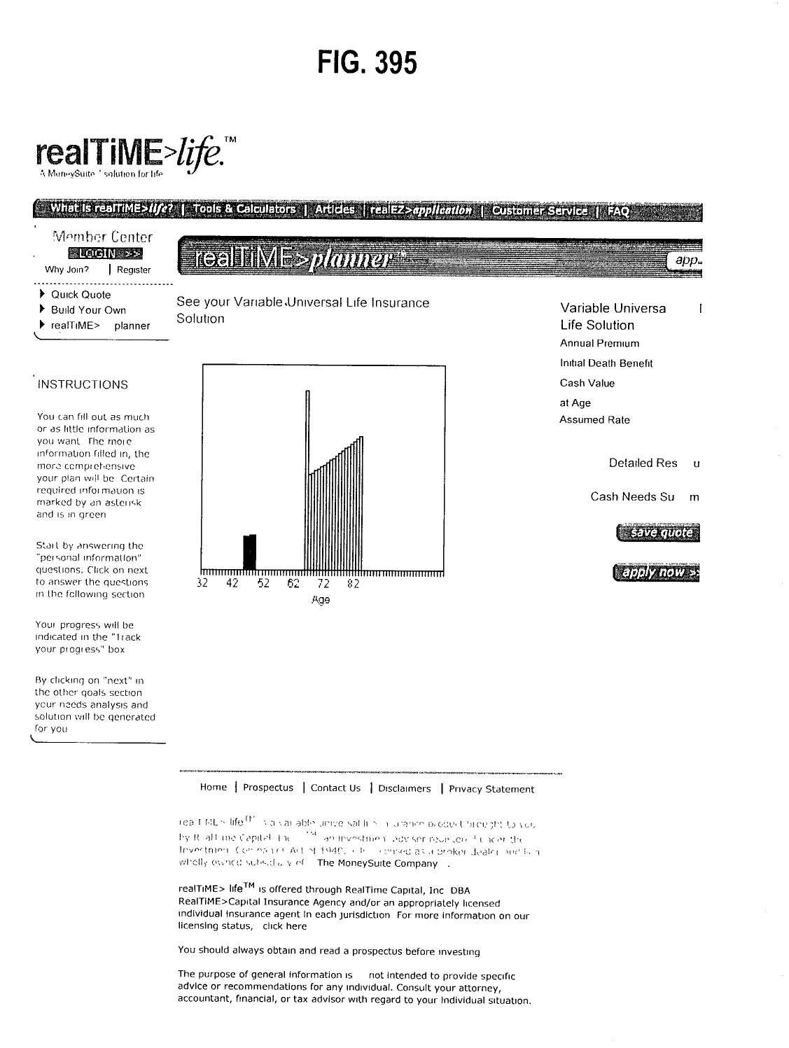

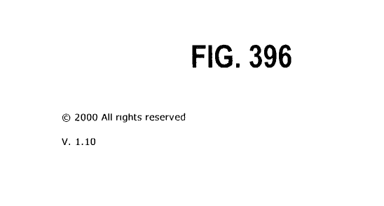

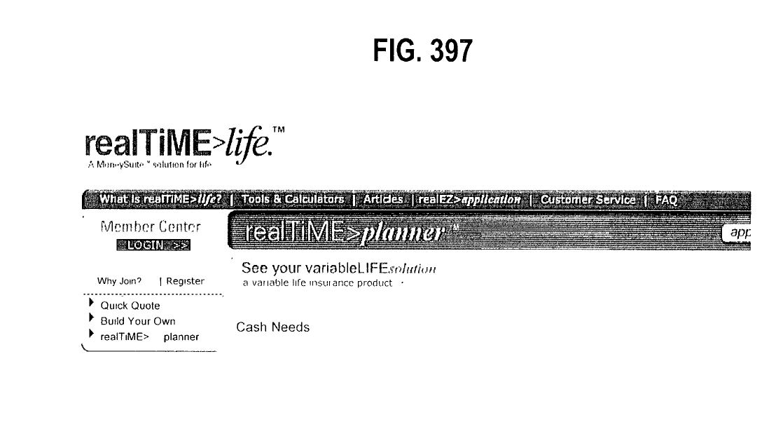

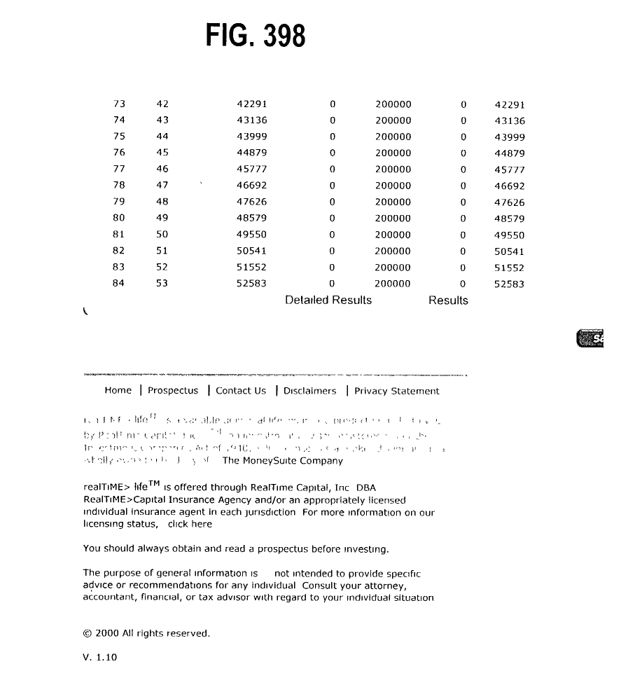

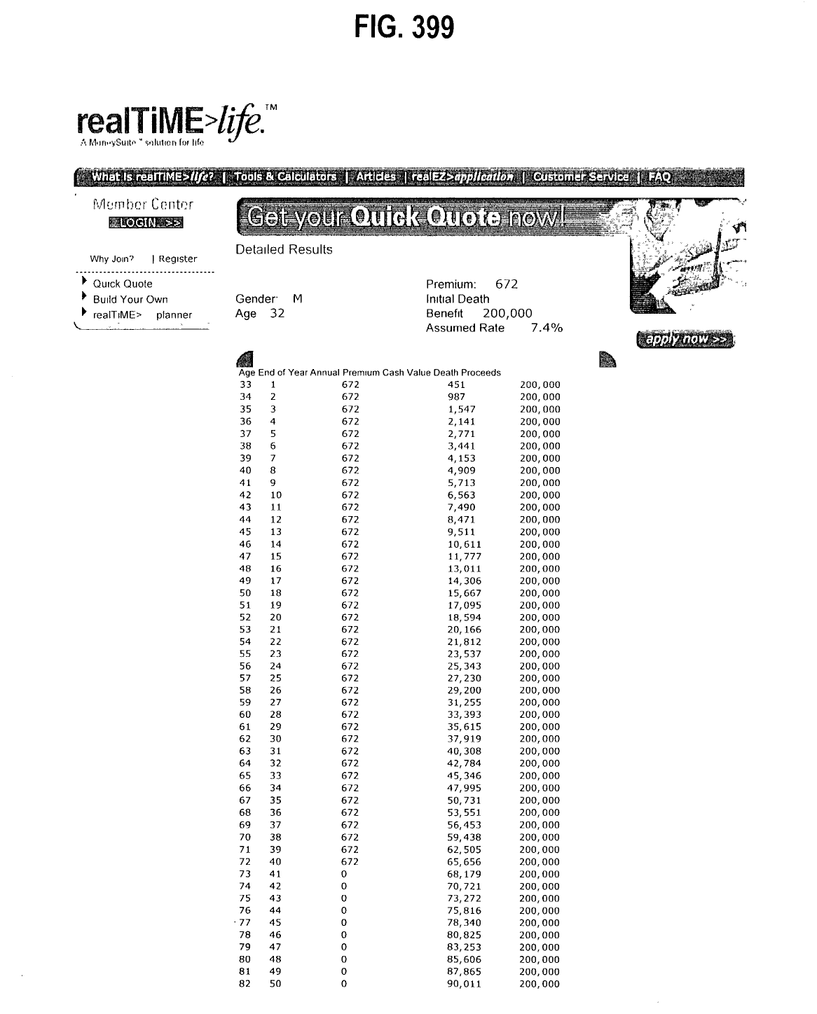

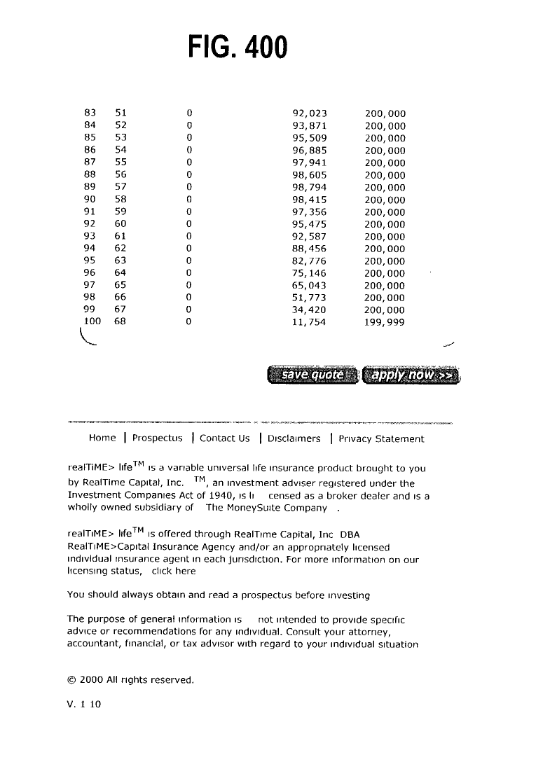

More particularly, see FIG. 1 and observe for the following components. Member Center. The Member Center 2 is a repository in which customers can create and store a unique member name and password, save copies of all their activities on the system and store personal financial information. Additional functionality integrates various data sources within a corporate context, as they become available:

Quoted products; products illustrated but not yet purchased on the system;

Products the customer has already purchased on the system;

Products the customer previously purchased; and

Current balance information for each of the products on the system.

Personal Data Center. This component will expand and enhance the capability of the Member Center essentially turning it into an online “safe deposit box” which allows customers to save all their important personal information in a single place. The purpose of this offering is to gather information as a convenience to the users, putting at the users' finger tips all the information that they or their loved ones are likely to need in the event of an emergency. From a commercial perspective, the data, with the customer's permission, is also available for use in creating tailored product offerings. Personal Data Center 4 Data elements can include:

Key Information about member and spouse: Birth dates, passport numbers, drivers license numbers, health insurance policy numbers, etc.;

Key Information about member's children: Birth dates, social security numbers, passport numbers, drivers license numbers

Key information about member's assets: Account numbers for both assets and liabilities including brokerage funds, mortgages, loans and credit cards, frequent flier programs etc.

Retirement Account Information. Account numbers for 401(k), 403(b), IRA, and other retirement programs.

Real estate and other real assets. The location of all real estate, the associated mortgages and insurance coverage.

Advisor Information. Contact information for doctors, lawyers, accountants, etc.

Life Insurance Policies. The location and amount of all Life Insurance Policies.

Wills & Trust Documents. Copies of wills and trust documents including any special request for funeral arrangements.

Profiler. This component of the system is a modular, rules-based tool that can be augmented by increasingly refined business logic to develop more and more focused “triggers” and advice modules, as the system evolves. As a first step, we recommend:

1. A “where are you on the road to financial success?” tool located on the home page that asks a series of questions regarding age, financial status, financial needs, and life event triggers;

2. An engine which generates a custom list of financial to-do's linked to associated calculators and content based on age, family, financial status and/or life event status, initially choosing one of five generic stage of life demographic profiles;

3. Functionality that pre-fills calculators with whatever data are currently available in the system, and solicits the sale of products according to life stage and indicated needs.

Life Stages. This is the content path that follows the Profiler. Individuals have discernable needs during each stage of their life. Within each stage, events occur that trigger needs for life insurance and financial products. Among these life events, the most important to the sale of life insurance and financial products are transitional life events; those that lead to some major change in location or family structure. The Profiler 6, through a question and answer format, will gather and analyze information and classify the customer into the appropriate life stage.

Life Events 8: Each life stage will identify key life events and educate the consumer about financial concerns they may have to investigate, understand, and act upon as a result of these life events. In addition to the internal content, the present invention provides framed links to additional, external resources with information related to the relevant life event. Each life event module also includes appropriate calculators to help the consumer analyze the needs identified by the education content as well as links to the appropriate product solutions. A series of integrated triggers and links to this content is part of a preferred integration with HRIM platforms. An initial list of life events might include:

Moving. When employees move, the HRIM system is among the first to know. Sales opportunities can include mortgages and checking accounts from a partner bank and the full spectrum of annuity, life insurance and disability products.

New Mortgage. A new mortgage results in a need for life insurance and disability coverage. The system has an integrated mortgage calculator that automatically obtains a quote for its financial product(s).

Getting Married. Marriage is a trigger for relocation, and often a new mortgage. It often results in the development of an early financial plan that can lead to the purchase of life insurance and disability products.

Becoming a Parent. The birth of a child almost always stimulates an awareness of the need for life and disability insurance. It also can lead to the purchase of a new home. Integration with HRIM platforms creates significant opportunities

Becoming a Grandparent. Grandchildren trigger estate and college planning concerns on the part of grandparents.

Divorce. Divorce triggers reallocation of family assets, the need for a comprehensive financial plan, life insurance, and often, relocation and new mortgages.

Educational Platform 10 Content. For each of the following products, the invention provides information designed to demystify and explain how, and by whom, each should be used. The products which can be supported can include:

| Mortgages | Term Life Insurance |
|---|---|
| CD's | Variable Universal Life |
| Mutual Funds | Disability |
| 401 (k)s | Cancer |
| Variable Annuities | |

Life Segments: Life stage segmentations, for example, can be five or six basic life event content modules for each stage as follows:

Single and renting. They don't own their own home and often don't own their own car. They realize a need to start a savings program and begin to accumulate capital.

Life Events: Moving to a new home, starting a career, getting married

Target products: Mutual funds, increased 401(k) contributions, mortgages, and credit cards, term insurance.

Calculators: Focus of calculators and content lead to starting or increasing a 401 (k), budgeting, savings, and preparing for financial emergencies. The calculators for this life stage are:

1. How much home can I afford?

2. How much life insurance?

3. What could my savings grow to?

4. Cafeteria/401(k) analysis.

5. realTiME>planner™

Just married. Often own their car, saving for or have just completed home purchase. Thinking of having children.

Life Events: Becoming a parent, new mortgage, moving.

Target products: Mutual funds, increased 401(k) contributions, life insurance, section 529 plans, mortgages, and credit cards.

Calculators: Focus of these calculators and content is to increase capital accumulation, buying a new home and necessity of insurance. The calculators for this life stage are:

1. How much home can I afford?

2. What could my savings grow to?

3. College funding needs

4. Cost of waiting

5. How much life insurance?

6. Cafeteria/401(k) analysis.

7. realTiME>planner™

Married with children. Early stage married and mortgaged set. They need a bigger house and a bigger paycheck!

Life Events: Moving or refinancing mortgage, debt reduction, planning for college tuition.

Target products: Mutual funds, increased 401 (k) contributions, variable universal life insurance, disability products

Calculators: Focus of these calculators and content is to continue with capital accumulation, looking for tax advantages, and preparing for financial changes. The calculators for this life stage are:

1. Cost of waiting.

2. College funding needs.

3. Paycheck analyzer

4. How much home can I afford?

5. Should I refinance my mortgage?

6. Taxable vs. Tax advantage

7. How much life insurance?

8. realTiME>planner™

Married with growing children. Later stage married segment.

Life Events: Children leaving home, contemplating divorce, retirement looming.

Target products: Increased 401(k) contributions, variable universal life, section 529 plans and annuities

Calculators: Focus is on accumulation and saving for retirement, estate planning, and some college. Calculators for this life stage include:

1. College funding needs.

2. How much life insurance?

3. Estate tax estimator

4. Should I refinance my mortgage

5. Taxable vs. tax advantage

6. Divorce calculator

Empty nest and married, no children. This is the pre-retirement segment.

Life Events: Becoming a grandparent, moving to smaller home, retirement, care giver to aging parents

Target products: Annuities, variable universal life, long term care insurance, cancer insurance

Calculators: The focus of this group is on estate planning, retirement planning, and tax avoidance, as well as gifting to family or charities. The calculators for this life stage are:

Estate Tax Estimator

Needed Savings

College funding (grandchildren)

The chart in FIG. 3 illustrates some of the many different calculators available and how they link from a life stage to a life event to a product solution. Calculators marked in the table are included herein, but others or more are optional, and of course would reflect the particular financial product at issue, e.g., Taxable vs. Tax Advantage.

Integrated Frequently Asked Questions, as a part of the Educational Platform 10, has a natural language search capability for its database of Frequently Asked Questions (FAQ's). FAQ's are formed for products such as term and variable universal life insurance products, to support the products to be sold as part of the invention. This engine links to life stage and life event content and adds html links.

Fast track 12 is an abbreviated skips much of the educational platform and is particularly suited for customers who want to buy a product, more or less, straightaway,—or to get a quick quote.

Product Offering 14. The present invention has all of the components needed to provide product quotes, produce e-applications and permit online fulfillment of the products sold thereby or in support therewith. This includes, by way of example and not limitation, processing applications for mutual funds, variable and fixed annuities, life insurance, and health and disability insurance products, etc.

The software system in connection with the present invention can be a multi-tiered architecture with XML over sockets as the data interchange format between the tiers and among non-native modules, and Oracle pipes to transfer control data between its internal components.

The html pages are served by the XML Factory. All submissions from a user are parsed, checked, and transferred to the back end site using XML over sockets. The system then awaits the response XML from the back end, parses it, and combines it with JSPs (JavaServer Pages) to produce the html pages served to the user. The definitions of the fields in each page and how they are mapped to fields in the XML messages are contained in metadata (data that describes other data); addition of a new page requires no new code beyond the creation of the JSP and its associated metadata.

All session and data persistence is maintained by the back end, with its Screen Manager determining what function to invoke and which page to present to the user in response to each submission. It, too, is controlled by metadata that includes tests on the user submissions to determine the course of action to be followed. Multiple security controls are imbedded in all user submissions and are validated by the back end to defend against even the sophisticated spoofing that a serious hacker might attempt.

Internally, the back end uses both sockets and Oracle pipes for communication among its modules. The XML Parser converts incoming data, from both the external Web farm and those modules that use sockets for their communication, into database updates, and then invokes the Screen Manager, which determines how to respond. Once the requested function, if any, is completed, the XML Generator creates the outgoing message, sent via the socket connection established by the initiating submission. All incoming and outgoing XML messages are logged and form a permanent archive of user activity.

Socket connections can also go off-site through VPN tunnels as well as communicate among disparate machines, such as between our standard Sun/Solaris boxes and NT servers dedicated to special functions exemplified by Excel spreadsheets. This provides a completely general methodology for the integration of processing modules, wherever they may be located.

Controls and function requests for native modules—written in C++ under Oracle Pro*C—are sent via Oracle pipes. This methodology, while not as sophisticated in its structure and generality as XML, is much faster, avoiding the overhead associated with message construction, message parsing, and socket manipulation. Its “data transfer” actually consists of storage and recovery of the data from the database; only the request for action and responding notification that the action has been completed are sent over the pipes.

With reference to the Appendix on the CD filed herewith, The contents are ASCII except for the graphics, which perforce are gif or jpeg files. There are certain utilities that must be compiled and turned into executables to use even the build process. An appropriate software platform can include the CVS source control package, Apache, tomcat, Java, all on a Sun solaris box for the front end. On the back end, can have source control system RCS, Oracle 8, Pro*C precompiler, C++ compiler, Java, again on a Sun Solaris box.

This architecture is illustrated in the state map of FIG. 2 and is designed for versatility, security, and scalability. With the interchange with the Web farm being limited to controls and actual data, the bandwidth requirements of that connection are less than one hundredth of that needed to serve formatted and graphics-enhanced pages; maintaining multiple redundant paths between the servers and the back end, thus, is not a significant cost, and is economically scalable, obviating the need for dedicated wideband facilities between the Web farm and the back end. Since the Web farm servers are stateless, retaining no data and maintaining no persistence, any user request can go to any server, and any server can be taken out of service at any time; the servers do not maintain a session. Similarly, with the relatively low data insertion and retrieval volume required, a single database machine can service essentially any number of business process and system management machines, each using Oracle Net8 to access the database server.

The data storage uses an ultrahigh reliability network appliance running RAID in a defect tolerance mode. It can withstand failure of any disk without loss of data or service capability, its disks are hot swappable, and it is designed to perform incremental snapshots of changed Oracle blocks to yet another pair of disk drives automatically. Of course, the database is also backed up to tape, stored off site. The network appliance is connected via dedicated and isolated optical gigabit Ethernet to two database servers, with the second providing redundancy.

With the generality of the Web page server, the location of site navigation, security, session persistence, and data storage at a centralized reliable facility, redundancy of communication paths, a design that minimizes data transfer volume among components and locations, and the use of data transfer protocols that are operating system agnostic, the present invention architecture provides a state-of-the art platform for the creation of reliable, secure, versatile, and effective Web-based financial service systems.

Typical System Components:

Creation of both informational Web pages and pages for data entry and display

Use of style sheets to change the look and feel and graphics for all pages as a unit

Mapping page data fields to XML message fields

Transmission of data between the Web server and the back end system using XML

Mapping XML message fields to database locations

Data error checking

Multilevel data structures for multiple items—e.g., multiple beneficiaries in an application, multiple cash goals in a needs analysis 13:

Creation of “shopping cart” pages for user access to, control of, those multiple items

Archiving of the user experience—every page visited, every XML sent and received

Archiving of all items—quotes, calculator uses, applications—that the user creates

Audit trails relating every quote, calculator, application, or other user-created item to the submissions that created or altered it

Anti-spoofing and other system security features

Page navigation control

Session maintenance

User registration and login

A Member Center where the user can save, then access to review or revise, any quote, application, or calculator result

Automatic compiling of user demographic data from user inputs to quotes, calculators, applications

Automatic prefilling of user data input pages from previous visits to those pages and from the general user demographic data

Inclusion of Excel-based calculators, to be invoked by user submission of data in standard pages

Addition of computational “engines”—e.g., quotation generators—without disturbing the existing code

All of these functions except, of course, the last—the custom computational engines—are created and maintained by control data, and require no programming. Hooks are provided for the inclusion of Oracle procedures to handle non-standard needs—e.g., prefilling an application's policy requirements from the quote that the user wishes to buy.

Typical System Features

The present invention can handle an interview process that collects the following information:

Demographic data—name, gender, date of birth, state, etc.

Risk tolerance

Survivor needs and existing fund sources

Retirement needs and existing assets

College funding needs and existing savings

Other financial goals and existing savings

From this, the system creates database records for the submitted data and computes and stores death benefit and cash withdrawal schedules that the financial instrument to be offered to the user is to satisfy.

All existing static educational pages and Web page rollover explanations

The existing set of insurance FAQs

To illustrate the foregoing concepts more particularly, logic begins generally traceable from log in and menu screens as overviewed in FIG. 1. As an illustration, consider that there are multiple ways to apply for a term policy, like there are multiple ways to apply for other financial products. From the home page (FIG. 12), a consumer can choose to run a policy illustration or select “realEZ>application”. If the consumer selects “realEZ>application”, then referring now to FIG. 4 with apply button not on results page Block 50 which proceeds to term BYO (Build Your Own)introduction page Block 52. Thereafter logic proceeds to term BYO insured information Block 54, which allows consumer to input their personal criteria, such as birth date, smoking information, etc., as seen on FIG. 14, to create an insurance policy that meets their individual and family needs. Thereafter logic proceeds to coverage type Block 56, which allows the consumer to select one of three types of coverage—Increasing death benefit, decreasing death benefit, or level death benefit

If increasing death benefit is selected, logic proceeds from coverage type Block 56 to increasing benefit information Block 58 (FIG. 17), where the consumer inputs a rate of increase in death benefit for each year. The duration of the policy and number of years to pay premium is also specified by the consumer. Thereafter logic proceeds to BYO disclaimer page Block 64 (FIG. 18).

Alternatively, if level death benefit is selected, logic from coverage type Block 56 proceeds to Level Benefit Information Block 60 (FIG. 15) where the consumer selects the policy duration and number of years to pay premium. Thereafter logic proceeds to BYO disclaimer page Block 64.

Further, if decreasing death benefit is selected, logic from coverage type Block 56 proceeds to decreasing benefit information Block 62 (FIG. 16) where the consumer inputs a rate of decrease in death benefit for each year. The duration of the policy and number of years to pay premium is also specified by the consumer. Thereafter logic proceeds to BYO disclaimer page Block 64.

Logic proceeds from BYO disclaimer page Block 64 to BYO results page Block 66 (FIG. 19) where consumer views an illustration depicting premium, surrender value and death benefit for each year of the policy's duration. Thereafter logic proceeds to logged in block 68. If the consumer has previously logged in to their personal member center logic proceeds to welcome.jsp (replaces 2.jsp) “You are about to begin the application process” Block 74 (FIG. 22).

If the consumer has not previously logged in, logic from Block 68 proceeds to no login page Block 72 (FIG. 21) where the consumer either registers for the first time by inputting name, email address and password, or logs into their current member center by inputting user name and password. Thereafter logic proceeds to welcome.jsp (replaces 2.jsp) “You are about to begin the application process” Block 74.

Logic proceeds from Block 74 to step2.jsp privacy statement Block 78 (FIG. 24), where the Insurance Carrier's privacy statement is dynamically inserted. Logic then proceeds to step3.jsp complete the application Block 80 (FIG. 25). From Block 80 logic proceeds to 3.jsp the insured page 1 Block 84. (FIG. 26) Alternatively, if the consumer has requested an illustration, logic begins with apply button quote results page Block 70 (FIG. 20). Thereafter logic proceeds to logged in Block 68. If log in occurs, logic proceeds to welcome.jsp (replaces 2.jsp) “You are about to begin the application process” Block 74.

Thereafter logic proceeds to logged in Block 68. If the consumer has previously logged in to their personal member center logic proceeds to welcome.jsp (replaces 2.jsp) “You are about to begin the application process” Block 74 (FIG. 22).

If the consumer has not previously logged in, logic from Block 68 proceeds to login page Block 72 (FIG. 21) where the consumer either registers for the first time by inputting name, email address and password or logs into their current member center by inputting user name and password. Thereafter logic proceeds to welcome.jsp (replaces 2.jsp) “You are about to begin the application process” Block 74.

Logic proceeds to step2.jsp privacy statement Block 78 (FIG. 24) where the Insurance Carrier's privacy statement is dynamically inserted. Logic then proceeds to step3.jsp complete the application Block 80 (FIG. 25). From Block 80 logic proceeds to 3.jsp the insured page 1 Block 84. (FIG. 26) Logic then goes from FIG. 4, Block 84 to FIG. 5, welcome.jsp (replaces 2.jsp) “you are about to begin the application process” Block 86 (FIG. 22).

Referring now to FIG. 5, logic from Block 86 proceeds to step 2.jsp privacy statement Block 88 (FIG. 24). Thereafter logic proceeds to step3.jsp complete the application block 90 (FIG. 25). Logic then proceeds to 3.jsp the insured page 1 Block 92 (FIG. 26), where the consumer inputs information to complete application as seen on FIG. 26.

From Block 92, logic proceeds to 4.jsp the insured page 2 occupation Block 94 (FIG. 27), where consumer inputs occupation and any other optional information. Thereafter logic proceeds to 5.jsp tobacco use Block 96 (FIG. 28), where the consumer selects type of tobacco usage or no tobacco or nicotine products. If “Cigar” use is selected, logic then proceeds to cigar use but no cigarettes in 12 months Block 98.

If cigarettes were used in the past 12 months, logic proceeds from Block 98 to 6.jsp tobacco use have you smoked in the last 5 years Block 100 (FIG. 29). Thereafter logic proceeds to 7.jsp family and dependents Block 102 (FIG. 30).

If cigarettes were not used in the past 12 months, logic proceeds from Block 98 to 7.jsp family and dependants Block 102 (FIG. 30).

From Block 102, logic proceeds to 8.jsp plan information amount of insurance Block 104 (FIG. 31), where the death benefit from the most-recent previous illustration will be the default input. Thereafter logic proceeds to 9.jsp rider page Block 106 (FIG. 32). Logic then proceeds to children's term rider Block 108.

If there a children's term rider is selected, logic proceeds from Block 108 to 10.jsp children's term rider Block 110 (FIG. 33) where the consumer completes information on children—one at a time (see FIG. 33). Thereafter, logic proceeds to 12.jsp summary of demographic information Block 112 (FIG. 34).

If there is not a children's term rider, logic proceeds from Block 108 to

12.jsp summary of demographic information Block 112 (FIG. 34) where information input in the previous screens is displayed for review. Consumer can “click” on any of the fields on this page and be returned to the original screen to update or change the information. Thereafter logic proceeds to 13.jsp information authorization Block 114 (FIG. 35). Logic then proceeds to authorization Block 116.

If authorization is not accepted, logic proceeds from Block 116 to infoauthoritysystement.jsp “we are required . . . ” Block 118 to give the consumer one more chance to provide their authorization. Thereafter logic proceeds to authorization again Block 120.

If authorization again is not accepted, logic proceeds from Block 120 to home page Block 122 (FIG. 12).

If authorization again is accepted, logic proceeds from Block 120 to 14.jsp your income block 124 (FIG. 27).

Alternatively, if authorization is initially accepted, logic proceeds from authorization Block 116 to 14.jsp your income block 124 (FIG. 37). Thereafter logic proceeds to 23b.jsp premium mode Block 126 (FIG. 38), where the consumer can select the premium payment mode. The system generates and displays the different premium amounts based on the illustration, for the different premium modes. Thereafter, logic proceeds to 25.jsp current life insurance policy Block 128 (FIG. 39). Logic then proceeds to new current life insurance in force Block 130.

If there is current life insurance in force or insurance recently applied for, logic proceeds from Block 130 to 26.jsp current life insurance policy information Block 132 (FIG. 40). Thereafter logic proceeds back to Block 130 where consumer selects whether or not they have additional policies. If yes, logic proceeds from Block 130 to 26.jsp current life insurance policy information Block 132 (FIG. 40). Thereafter logic proceeds back to Block 130 where consumer selects whether or not they have additional policies.

If there is no new current life insurance in force, logic proceeds from Block 130 to 27.jsp medical history page Block 134 (FIG. 41). Thereafter logic proceeds to 28.jsp health-drugs page Block 136 (FIG. 42). Logic then proceeds to circle 1 Block 138.

Logic proceeds from FIG. 5, Block 138 to FIG. 6, 29.jsp health-illness page Block 140 (FIG. 43). Thereafter logic proceeds to 30.jsp health-asthma page Block 142 (FIG. 44). Logic then proceeds to 31.jsp health-family history page Block 144 (FIG. 45).

Referring now to FIG. 6, logic proceeds from Block 144 to 32.jsp health—your proportions Block 146 (FIG. 46). Thereafter logic proceeds to 33.jsp lifestyle—racing Block 148 (FIG. 47). Logic then proceeds to 34.jsp lifestyle-climbing Block 150 (FIG. 48)

From Block 150, logic proceeds to 35.jsp lifestyle—scuba Block 152 (FIG. 49). Thereafter logic proceeds from 36.jsp international travel Block 154 (FIG. 50). Logic then proceeds from 37.jsp aviation as pilot crew Block 158 (FIG. 51).

From Block 158, logic proceeds to aviation pilot/crew Block 160. If the answer is yes, logic proceeds to 38.jsp aviation info Block 162 (FIG. 52), where the consumer inputs information on aviation experience. Thereafter logic proceeds 39.jsp driving record Block 164 (FIG. 53).

Alternatively, if the answer is no, logic proceeds to 39.jsp driving record Block 164 (FIG. 53). Thereafter logic proceeds to 40(b).jsp underwriting summary Block 166 (FIG. 54), where the information input since last summary (Block 112, FIG. 5) is displayed. Consumer can “click” on any field to return to screen and update or change information. Logic then proceeds to 41.jsp primary beneficiary information Block 168 (FIG. 57).

From Block 168, logic proceeds to another primary beneficiary Block 170. If there is another primary beneficiary, logic proceeds back to 168 (FIG. 57). Logic then proceeds to Block 170 until there are no other primary beneficiaries.

If there is no other primary beneficiaries, logic proceeds from Block 170 to istherecontingency.jsp do you have a contingent beneficiary Block 172 (FIG. 58). Thereafter logic proceeds to new contingent beneficiary Block 174.

If there is a new contingent beneficiary, logic proceeds from Block 174 to 42.jsp contingent beneficiary page Block 176 (FIG. 59). Thereafter logic proceeds to Block 174 until there are no other contingent beneficiaries.

If there is no contingent beneficiary, logic proceeds from Block 180 to 43(b).jsp beneficiary summary page Block 178 (FIG. 60), where summary of beneficiary information is displayed. The consumer can “click” on any field and update or change such information. Thereafter logic proceeds to refer for manual underwriting**? Block 180.

Using rules implemented by the Insurance Carrier and Reinsurer, the system determines if the policy can be approved on-line or must be submitted for manual underwriting. If the application is not referred for manual underwriting, logic proceeds from Block 180 to issue MIB inquiry Block 182, where the system sends out the certain personal information to the Medical Information Bureau (MIB). Logic then proceeds to applicationpreview.jsp application review preface Block 184 (FIG. 61).

If the application is referred for manual underwriting, logic proceeds from Block 180 to applicationpreview.jsp application review preface Block 184 (FIG. 61). Thereafter logic proceeds to display the summary pages for each section starting with 12.jsp demographic summary Block 186 (FIG. 62) giving the consumer another opportunity to make changes or updates. Logic then proceeds to 40(b).jsp underwriting summary Block 188 (FIGS. 63 through 65).

From Block 188, logic proceeds to circle 2 Block 190. Thereafter logic flows from FIG. 6, Block 190 to FIG. 7, 43(b).jp beneficiary summary Block 192 (FIG. 66).

Referring now to FIG. 7, logic proceeds from Block 192 to has the quote data changed Block 194. If the answer is no, logic proceeds from Block 194 to steps4.jsp review the illustration page Block 208 (FIG. 70). If the answer is yes, meaning that underwriting information input by the consumer changed the original illustrated quote, logic proceeds from Block 194 to quoteresults_warning.jsp your quote has changed Block 196 (FIG. 67), where the changes to the original quote are dynamically displayed. The consumer can select whether to change the premium to match the new policy or to change the death benefit to match the original premium.

From Block 196, logic proceeds to change premium Block 198. If the answer is no, logic flows from Block 198 to quoteresults_results2.jsp quote results with same premium Block 200 (FIG. 69), where the consumer chooses to accept the quote or rerun quote with same premium as the original illustrated quote. Thereafter logic proceeds to accept new quote Block 204. If the answer is yes, logic proceeds from Block 204 to steps4.jsp review the illustration page Block 208 (FIG. 70). If the answer is no, logic flows from Block 204 to quoteresults_results1.jsp quote results with new premium Block 202 (FIG. 68).

From Block 202, logic proceeds to accept new quote Block 206. If the answer is yes, logic flows from Block 202 to steps4.jsp review the illustration page Block 208 (FIG. 70). If the answer is no, logic proceeds to Block 200 (FIG. 69). Thereafter logic proceeds to Block 204. If the answer is yes, logic proceeds from Block 204 to 208.

If the answer is yes, logic proceeds from Block 198 to quoteresults_results1.jsp quote results with new premium Block 202 (FIG. 68). Thereafter logic proceeds to accept new quote Block 206. If the answer is no, logic proceeds from Block 206 to Block 200 (FIG. 69). Thereafter logic proceeds to Block 204. If the answer is yes, logic proceeds from Block 204 to 208 (FIG. 70).

From Block 208, logic proceeds to illustration_link/download page Block 210 (FIG. 74), where the illustration is displayed for the consumer. Thereafter logic proceeds to 53.jsp illustration confirmation page Block 212 (FIG. 71), where the consumer clicks on the “I Accept” button. Logic then proceeds to 54.jsp application confirmation page Block 214 (FIGS. 72 and 73) where the consumer electronically “signs” the application by inputting their full name and social security number.

From Block 214, logic proceeds to application confirmation information ok Block 216. If the answer is no, logic proceeds from Block 216 to confirmation problem resolution page Block 218 (FIG. 75). Thereafter logic proceeds to Block 216.

Once the answer is yes to Block 216, logic proceeds to replacement policies Block 220. If there are replacement policies determined during the application process (Block 130, FIG. 5), logic proceeds from Block 220 to 56b.jsp CRS will contact you Block 226 (FIG. 81). Thereafter logic proceeds to application marked for CRS review and added to queue Block 228. Logic then proceeds to step5.jsp print, sign and mail page (replaces printsign.jsp) Block 230 (FIG. 82).

From Block 230 logic proceeds to print confirmation/problem page Block 232. Thereafter logic proceeds to customer service Block 234. Logic then proceeds to the telephone Block 236.

From Block 236, logic proceeds to client Block 238. Thereafter logic flows to manual system takes over these applications Block 240.

If there are no replacement policies, logic proceeds from Block 220 to manual underwriting Block 222.

If answers on the application warrant or if the MIB return is positive, the policy is manually underwritten. If the answer is yes, logic proceeds from Block 222 to 56b.jsp CRS will contact you Block 226 (FIG. 81). Thereafter logic proceeds to application marked for CRS review and added to queue Block 228. Logic then proceeds to step5.jsp print, sign and mail page (replaces printsign.jsp) Block 230 (FIG. 82).

From Block 230 logic proceeds to print confirmation/problem page Block 232. Thereafter logic proceeds to customer service Block 234. Logic then proceeds to the telephone Block 236.

From Block 236, logic proceeds to client Block 238. Thereafter logic flows to manual system takes over these applications Block 240.

If the policy can be issued online, logic proceeds from Block 222 to circle 3 Block 224. Thereafter, logic proceeds from FIG. 7, Block 224, to FIG. 8, 23.jsp payment method page Block 226 (FIG. 76).

Referring now to FIG. 8, logic proceeds from Block 226 to payment method Block 228.

If the payment method is mail check, logic proceeds from Block 228 to 56b.jsp CRS will contact you page Block 246 (FIG. 81). Thereafter logic proceeds to step5.jsp print, sign, and mail page (replaces printsign.jsp) Block 248 (FIG. 82).

If the payment method is electronic, logic proceeds to 24.jsp bank information page Block 230 (FIG. 77). Thereafter logic proceeds to Troy's e-check pages Block 232 (FIG. 78). Logic then proceeds to bank information problem Block 234.

If there is no bank information problem, logic proceeds to paymentacceptance.jsp payment acceptance page Block 244 (FIG. 79). Thereafter logic proceeds to step5.jsp print, sign, and mail page (replaces printsign.jsp) Block 248 (FIG. 82).

If Troys eCheck indicates there is a bank information problem, logic proceeds to paymentrejection.jsp payment rejection page Block 236 (FIG. 80). Thereafter logic proceeds to UW information ok to issue.

If it is ok to issue the UW information, logic proceeds to automatically issue application Block 242. Thereafter logic proceeds to step5.jsp print, sign, and mail page (replaces printsign.jsp) Block 248 (FIG. 82).

If it is not ok to issue UW information, logic proceeds to 56b.jsp CRS will Contact you page Block 240 (FIG. 81). Thereafter logic proceeds to step5.jsp print, sign, and mail page (replaces printsign.jsp) Block 248 (FIG. 82).

From Block 248, logic proceeds to print confirmation/problem page Block 250 (FIG. 84). Thereafter logic proceeds to home page 252 (FIG. 83). Logic then proceeds to application information sent to Lincoln RE Block 254.

From Block 254, logic proceeds to application information sent to policy admin system Block 256. Thereafter logic proceeds to underwriting and policy admin processes begin Block 258. Logic then proceeds to policy admin system takes over customer experience Block 260.

There are multiple ways to apply for a universal life policy. From the home page (FIG. 100), a consumer can choose to run a policy illustration or select “realEZ>application”. If the consumer selects “realEZ>application”, then referring now to FIG. 85, logic begins with apply button not on results page Block 262 which proceeds to BYO introduction page Block 264 (FIG. 101). Thereafter logic proceeds to BYO insured information Block 266 (FIG. 102) where consumer inputs information to run illustration. Thereafter logic proceeds to BYO Policy information Block 268 (FIG. 103).

Logic proceeds from Block 268 to BYO Riders Block 270 (FIG. 104). Thereafter logic proceeds to BYO any withdrawals page Block 272 (FIG. 105). Logic then proceeds to any withdrawals Block 274.

If there are withdrawals, logic proceeds from Block 274 to BYO withdrawal page Block 276 (FIG. 106). Thereafter logic proceeds back to Block 274. Once the answer to any withdrawals is no, logic then proceeds from Block 274 to BYO review page Block 278 (FIG. 107) where the consumer reviews input information and decides whether or not to make changes. Thereafter logic proceeds to information correct Block 280.

If the information is incorrect, logic proceeds from Block 280 back to BYO introduction page Block 264 (FIG. 101). Thereafter logic proceeds to BYO Policy information Block 268 (FIG. 102).

Logic proceeds from Block 268 to BYO Riders Block 270 (FIG. 104). Thereafter logic proceeds to BYO any withdrawals page Block 272 (FIG. 105). Logic then proceeds to any withdrawals Block 274. Thereafter logic proceeds back to Block 274. Once the answer to any withdrawals is no, logic then proceeds from Block 274 to BYO review page Block 278 (FIG. 107). Thereafter logic proceeds to information correct Block 280.

If the information is correct, logic proceeds from Block 280 to BYO disclaimer page Block 282 (FIG. 108). Insurance regulations require that a consumer acknowledge that what they are about to view is not a contract, but only an illustration of hypothetical circumstances. Thereafter logic proceeds to BYO results page Block 284 (FIGS. 110 to 112). Logic then proceeds to logged in Block 286. If consumer has logged in previously and has completed the application through running an illustration, logic proceeds from Block 286 to welcome.jsp (replaces 2.jsp) “You are about to begin the application process” Block 292 (FIG. 116).

If consumer has not previously logged in, logic from Block 286 proceeds to login page Block 290 (FIG. 113) where the consumer either registers for the first time by inputting name, email address and password or logs into their current member center by inputting user name and password. Thereafter logic proceeds to welcome.jsp (replaces 2.jsp) “You are about to begin the application process” Block 292 (FIG. 116).

Logic proceeds from Block 292 to step1.jsp viewing the prospectus Block 294 (FIG. 117) where the consumer will be redirected to screens that will display and allow the consumer to print and view the prospectus. Thereafter logic proceeds to step2.jsp privacy statement Block 296 (FIG. 118) where the insurance carrier's privacy statement will be dynamically displayed. Logic then proceeds to step3.jsp complete the application Block 298 (FIG. 119). From Block 298 logic proceeds to 3.jsp the insured page 1 Block 302 (FIG. 121).

Alternatively, if the consumer is applying for an insurance policy from a previously ran illustration logic begins with apply button quote results page Block 288. Thereafter logic proceeds to logged in Block 286. If consumer has logged in previously and has completed the application through running an illustration, logic proceeds from Block 286 to welcome.jsp (replaces 2.jsp) “You are about to begin the application process” Block 292 (FIG. 116).

If consumer has not previously logged in, logic from Block 286 proceeds to login page Block 290 (FIG. 113), where the consumer either registers for the first time by inputting name, email address and password or logs into their current member center by inputting user name and password. Thereafter logic proceeds to welcome.jsp (replaces 2.jsp) “You are about to begin the application process” Block 292 (FIG. 116).

Logic proceeds from Block 292 to step1.jsp viewing the prospectus Block 294 (FIG. 117), where the consumer will be redirected to screens that will display and allow the consumer to print and view the prospectus. Thereafter logic proceeds to step2.jsp privacy statement Block 296 (FIG. 118), where the insurance carrier's privacy statement will be dynamically displayed. Logic then proceeds to step3.jsp complete the application Block 298 (FIG. 119). From Block 298 logic proceeds to 3.jsp the insured page 1 Block 302 (FIG. 121), where consumer inputs information to complete application. Information obtained from the illustration will be defaulted to the appropriate field on the application screens.

Alternatively, if the consumer has previously completed or partially completed an application in a previous session and is returning to review or complete their application, they will begin in their personal member center. The logic begins with view application from member center block 300. Thereafter logic proceeds to 3.jsp the insured page 1 Block 302 (FIG. 121). Logic then takes us from FIG. 85, Block 300 to FIG. 86, 4.jsp the insured page 2 occupation Block 316 (FIG. 122). Thereafter logic proceeds to 5.jsp tobacco use Block 318 (FIG. 123), where the consumer selects type of tobacco usage or no tobacco or nicotine products. If “Cigar” use is selected, logic then proceeds to cigar use but no cigarettes in 12 months Block 320.

If cigarettes were used in the past 12 months, logic proceeds from Block 320 to 6.jsp tobacco use have you smoked in the last 5 years Block 322 (FIG. 124). Thereafter logic proceeds to 7.jsp family and dependents Block 324 (FIG. 125).

If cigarettes were not used in the past 12 months, logic proceeds from Block 320 to 7.jsp family and dependants Block 324 (FIG. 125).

From Block 324, logic proceeds to 8.jsp plan information amount of insurance Block 326 (FIG. 126), where the death benefit from the most-recent previous illustration will be the default input. Thereafter logic proceeds to 9.jsp rider page Block 328 (FIG. 127). Logic then proceeds to children's term rider Block 330.

If there a children's term rider is selected, logic proceeds from Block 330 to 10.jsp children's term rider Block 332 (FIG. 128) where the consumer completes information on children—one at a time (see FIG. 128). Thereafter, logic proceeds to 12.jsp summary of demographic information Block 334 (FIG. 129).

If there is not a children's term rider, logic proceeds from Block 330 to 12.jsp summary of demographic information Block 334 (FIG. 129) where information input in the previous screens is displayed for review. Consumer can “click” on any of the fields on this page and be returned to the original screen to update or change the information. Thereafter logic proceeds to 13.jsp information authorization Block 336 (FIG. 131). Logic then proceeds to authorization Block 338.

If authorization is not accepted, logic proceeds from Block 338 to infoauthoritysystement.jsp “we are required . . . ” Block 342 (FIG. 133) to give the consumer one more chance to provide their authorization. Thereafter logic proceeds to authorization again Block 344.

If authorization again is not accepted, logic proceeds from Block 344 to home page Block 346 (FIG. 100).

If authorization again is accepted, logic proceeds from Block 344 to 14.jsp your income block 340 (FIG. 134).

Alternatively, if authorization is initially accepted, logic proceeds from authorization Block 338 to 14.jsp your income block 340 (FIG. 133). All of the information on this screen is for the consumer to input before advancing. Thereafter logic proceeds to 15.jxp your investment Block 348 (FIG. 135) where the corresponding information is obtained. Thereafter, logic proceeds to 16.jsp Investment Time Horizon Block 350 (FIG. 137). Logic then proceeds to 17.jsp what is your investment risk tolerance Block 352 (FIG. 138).

From Block 352, logic proceeds to risk tolerance Block 356. If consumer selects “not interested in taking any degree of risk”, logic proceeds to 18.jsp warning message “you should only purchase VUL . . . ” Block 354 (FIG. 139). Thereafter logic proceeds back to Block 352 (FIG. 138) where consumer is given another chance to select risk tolerance.

If consumer selects “not interested in taking any degree of risk” a second time, logic then proceeds from Block 356 to home page Block 346 (FIG. 100).

If the customer's risk tolerance is appropriate, logic proceeds from Block 356 to 19.jsp what is your reason for purchasing RTL Block 358 (FIG. 140), where the consumer checks all items that apply. Thereafter logic proceeds to reason for purchasing* Block 360.

If “estate planning”, “death protection”, “charitable giving”, and/or “business continuation” are checked logic proceeds from Block 360 to 22.jsp summary of financial suitability Block 362 (FIG. 142).

If none of the aforementioned are checked, logic proceeds to 20.jsp four options for reasons to purchase RTL Block 364 (FIG. 141), where the consumer is offered an opportunity to check one of the items (see FIG. 141). Logic then proceeds to reason for purchasing again Block 368. If “none of the above” is checked, logic proceeds from Block 368 to home page Block 366 (FIG. 100).

If any of the items are checked other than “none of the above”, logic proceeds from Block 368 to 22.jsp summary of financial suitability Block 362 (FIG. 142) where consumer reviews their answers to the questions on the previous screens. Consumer can click on any of the fields and return to a screen to update his/her selection. Thereafter logic proceeds from Block 362 to circle 1 Block 370. Logic then proceeds from FIG. 86, Block 370 to FIG. 87, 23b.jsp premium mode Block 372 (FIG. 143), where the consumer selects the premium payment mode. The system generates and displays the different premium amounts based on the illustration, for the different premium modes. Thereafter, logic proceeds to 25.jsp current life insurance policy Block 374 (FIG. 144). Logic then proceeds to new current life insurance in force Block 376.

If there is current life insurance in force or insurance recently applied for, logic proceeds from Block 376 to 26.jsp current life insurance policy information Block 378 (FIG. 145). Thereafter logic proceeds back to Block 376 where the consumer selects whether or not they have additional policies. If yes, logic proceeds from Block 376 to 26.jsp current life insurance policy information Block 378 (FIG. 145). Thereafter logic proceeds back to Block 376 where consumer selects whether or not they have additional policies.

If there is no new current life insurance in force, logic proceeds from Block 376 to 27.jsp medical history page Block 380 (FIG. 41). Thereafter logic proceeds to 28.jsp health-drugs page Block 382 (FIG. 147). Logic then proceeds from Block 382 to 29.jsp health-illness page Block 384 (FIG. 148). Thereafter logic proceeds to 30.jsp health-asthma page Block 386 (FIG. 150). Logic then proceeds to 31.jsp health-family history page Block 388 (FIG. 151).

Referring now to FIG. 87, logic proceeds from Block 388 to 32.jsp health-your proportions Block 390 (FIG. 152). Thereafter logic proceeds to 33.jsp lifestyle-racing Block 392 (FIG. 153). Logic then proceeds to 34.jsp lifestyle—climbing Block 394 (FIG. 154)

From Block 394, logic proceeds to 35.jsp lifestyle—scuba Block 396 (FIG. 155). Thereafter logic proceeds from 36.jsp international travel Block 396 (FIG. 156). Logic then proceeds from 37.jsp aviation as pilot crew Block 400 (FIG. 157).

From Block 400, logic proceeds to aviation pilot/crew Block 402. If consumer answers yes, logic proceeds to 38.jsp aviation info Block 404 (FIG. 158), where the consumer inputs information on aviation experience. Thereafter logic proceeds 39.jsp driving record Block 406 (FIG. 159).

Alternatively, if the consumer answers no, logic proceeds to 39.jsp driving record Block 406 (FIG. 159). Thereafter logic proceeds to 40(b).jsp underwriting summary Block 408 (FIG. 160), where the information input since last summary (Block 362, FIG. 86) is displayed. Consumer can “click” on any field to return to a screen and update or change information. Logic then proceeds to 41.jsp primary beneficiary information Block 410 (FIG. 163).

From Block 410, logic proceeds to another primary beneficiary Block 412. If there is another primary beneficiary, logic proceeds back to 410 (FIG. 163). Logic then proceeds to Block 412 until there are no other primary beneficiaries.

If there is no other primary beneficiaries, logic proceeds from Block 412 to istherecontingency.jsp do you have a contingent beneficiary Block 414 (FIG. 165). Thereafter logic proceeds to new contingent beneficiary Block 416.

If there is a new contingent beneficiary, logic proceeds from Block 416 to 42.jsp contingent beneficiary page Block 418 (FIG. 166). Thereafter logic proceeds to Block 416 until there are no other contingent beneficiaries.

If there is no contingent beneficiary, logic proceeds from Block 416 to 43(b).jsp beneficiary summary page Block 420 (FIG. 168), where summary of beneficiary information is displayed. The consumer can “click” on any field and update or change such information. Thereafter logic proceeds to circle 2 Block 422. Logic then proceeds from FIG. 87, Block 422 to FIG. 88, refer for manual underwriting**? Block 424.

Referring now to FIG. 88, if the application is not referred for manual underwriting, logic proceeds from Block 424 to issue MIB inquiry Block 426, where the system sends out the certain personal information to the Medical Information Bureau (MIB). Logic then proceeds to 44.jsp asset allocation page Block 428 (FIG. 169).

If the application is referred for manual underwriting, logic proceeds from Block 424 to 44.jsp asset allocation page Block 428 (FIG. 169). A list of funds available is displayed dynamically. The consumer inputs the allocation percentage for each desired fund, the total equaling 100%. Thereafter logic proceeds to allocation ok Block 430 where the system fires the allocation engine that determines if the allocation selection matches a pre-determined risk profile.

If the allocation fits the pre-determined risk profile, logic proceeds from Block 430 to 48.jsp portfolio summary page Block 436 (FIG. 172). If the allocation does not fit the pre-determined risk profile, logic proceeds from Block 430 to 47.jsp allocation warning page Block 430 (FIG. 171). Thereafter logic proceeds to re-evaluate Block 434 where the consumer is given an option to re-evaluate their fund allocation selections.

If the consumer choose not to re-evaluate, logic proceeds from Block 434 to 48.jsp portfolio summary page Block 436 (FIG. 436). If the consumer chooses to re-evaluate, logic proceeds from Block 434 back to asset allocation page Block 428 (FIG. 169). Thereafter logic proceeds to allocation ok Block 430. This sequence repeats until the allocation fits the pre-determined risk profile. Logic then proceeds to 48.jsp portfolio summary page Block 436 (FIG. 436) where a fund summary is displayed.

From Block 436, logic proceeds to applicationreview.jsp application review preface Block 438 (FIG. 173). Thereafter logic proceeds to display the summary pages for each section starting with 12.jsp demographic summary Block 440 (FIG. 174). Logic then proceeds to 22.jsp financial suitability summary Block 442 (FIG. 176).

From Block 442, logic proceeds to 40(b).jsp underwriting summary Block 444 (FIGS. 177-179). Thereafter logic proceeds to 43(b).jsp beneficiary summary Block 446 (FIG. 180). Logic then proceeds to 48(b) portfolio summary Block 448 (FIG. 181).

Thereafter logic proceeds from Block 448 to has the quote data changed Block 452. If, during the application process, no information was input that would change the original illustration prepared prior to the application process, logic proceeds from Block 452 to steps4.jsp review the illustration page Block 470. If during the application process information was input that changed the values of the original illustration, logic proceeds from Block 452 to quoteresults_warning.jsp your quote has changed Block 454 (FIG. 183), where the changes to the original quote are dynamically displayed. The consumer can select whether to change the premium to match the new policy or to change the death benefit to match the original premium.

From Block 454, logic proceeds to change premium Block 456. If the answer is no, logic flows from Block 456 to quoteresults_results2.jsp quote results with same premium Block 460 (FIG. 185), where the consumer chooses to accept the quote or rerun quote with same premium as the original illustrated quote. Thereafter logic proceeds to accept new quote Block 462. If the answer is yes, logic proceeds from Block 462 to steps4.jsp review the illustration page Block 470 (FIG. 186). If the answer is no, logic flows from Block 462 to quoteresults_results1.jsp quote results with new premium Block 464 (FIG. 184).

From Block 464, logic proceeds to accept new quote Block 468. If the answer is yes, logic flows from Block 468 to steps4.jsp review the illustration page Block 470 (FIG. 186). If the answer is no, logic proceeds to Block 460 (FIG. 185). Thereafter logic proceeds to Block 462. If the answer is yes, logic proceeds from Block 462 to 470.

Alternatively, If the answer is yes, logic proceeds from Block 456 to quoteresults_results1.jsp quote results with new premium Block 464 (FIG. 184). Thereafter logic proceeds to accept new quote Block 468. If the answer is no, logic proceeds from Block 468 to Block 460 (FIG. 185). Thereafter logic proceeds to Block 462. If the answer is yes, logic proceeds from Block 462 to 470 (FIG. 186).

From Block 470, logic proceeds to illustration_link/download page Block 472 (FIG. 187), where the illustration is displayed for the consumer. Thereafter logic proceeds to 53.jsp illustration confirmation page Block 474 (FIG. 188), where the consumer clicks on the “I Accept” button.

Logic then proceeds to 54.jsp application confirmation page Block 476 (FIGS. 189-190) where the consumer electronically “signs” the application by inputting their full name and social security number.

From Block 476, logic proceeds to circle 3, Block 478. Thereafter logic proceeds from FIG. 88, Block 478 to FIG. 89, application confirmation information ok Block 480.

From Block 478, logic proceeds to application confirmation information ok Block 480. If the answer is no, logic proceeds from Block 480 to confirmation problem resolution page Block 482 (FIG. 191). Thereafter logic proceeds back to Block 480.

Once the answer is yes to Block 480, logic proceeds client suitable* Block 484 where the system determines if the consumer is suitable to purchase a variable life insurance product. If the client is not suitable, logic proceeds from Block 484 to 56b.jsp CRS will contact you page Block 486 (FIG. 197). If the client is suitable, logic proceeds from Block 484 to broker/dealer Block 490.

If consumer is a broker/dealer logic proceeds from Block 490 to 56b.jsp CRS will contact you page Block 486 (FIG. 197). If consumer is not a broker/dealer, logic proceeds from Block 490 to replacement policies Block 492.

If consumer indicated that there were policies that would be replaced by the policy being applied for, logic proceeds from Block 492 to 56b.jsp CRS will contact you page Block 486 (FIG. 197). If there are no replacement policies, logic proceeds from Block 492 to manual underwriting Block 494.

If answers on the application warrant or if the MIB return is positive, the policy is manually underwritten. If there is manual underwriting, logic proceeds from Block 494 to 56b.jsp CRS will contact you page Block 486 (FIG. 197). If there is no manual underwriting, logic proceeds form Block 494 to 23.jsp payment method page Block 508 (FIG. 192).

From 56b.jsp CRS will contact you page Block 486 (FIG. 197), logic proceeds to application marked for CRS review and added to queue Block 488. Logic then proceeds to step5.jsp print, sign and mail page (replaces printsign.jsp) Block 496 (FIG. 198).

From Block 496 logic proceeds to print confirmation/problem page Block 498. Thereafter logic proceeds to manual system where customer service contacts and completes the application with the customer.

From payment method Block 508 (FIG. 192), logic proceeds to payment method Block 510. If the payment method is mail check, logic proceeds from Block 510 to 56b.jsp CRS will contact you page Block 514 (FIG. 197). Thereafter logic proceeds to step5.jsp print, sign, and mail page (replaces printsign.jsp) Block 530 (FIG. 198).

If the payment method is electronic, logic proceeds from Block 510 to 24.jsp bank information page Block 512 (FIG. 193). Thereafter logic proceeds to Troy's e-check pages Block 516 (FIG. 194). Logic then proceeds to bank information problem Block 518.

If there is no bank information problem, logic proceeds to paymentacceptance.jsp payment acceptance page Block 520 (FIG. 195). Thereafter logic proceeds to step5.jsp print, sign, and mail page (replaces printsign.jsp) Block 530 (FIG. 198).

If there is a bank information problem, logic proceeds to paymentrejection.jsp payment rejection page Block 522 (FIG. 196) where reason that the check could not be authorized is dynamically inserted into page. Thereafter logic proceeds to UW information ok to issue Block 524.

If underwriting information is acceptable, logic proceeds from Block 524 to automatically issue application Block 528. Thereafter logic proceeds to step5.jsp print, sign, and mail page (replaces printsign.jsp) Block 530 (FIG. 198).

If additional underwriting information is necessary, logic proceeds from Block 524 to 56b.jsp CRS will Contact you page Block 526 (FIG. 197). Thereafter logic proceeds to step5.jsp print, sign, and mail page (replaces printsign.jsp) Block 530 (FIG. 198).

From Block 530, logic proceeds to circle 4, Block 532. Thereafter logic proceeds from FIG. 89, Block 532 to FIG. 90, print confirmation/problem page Block 534 (FIG. 199).

Referring now to FIG. 90, logic proceeds from Block 534 to home page 536 (FIG. 200). Logic then proceeds to application information sent to Lincoln RE Block 538.

From Block 538, logic proceeds to application information sent to policy admin system Block 540. Thereafter logic proceeds to underwriting and policy admin processes begin Block 542. Logic then proceeds to policy admin system takes over customer experience Block 544.

Prior to completing an application for term insurance, the consumer may choose to explore three educational paths to design and build his/her own policy, to decide to insure the consumer's home mortgage, and to use a automated needs analysis tool to help the consumer assess their overall need for term life insurance.

From the Term Home Page Block 51 (FIG. 348), the consumer may proceed to BYO Block 53 (Build Your Own policy) to design and customize their own term life insurance policy. Logic then begins with BYO Input Page Block 59 (FIG. 349), where the consumer enters relevant personal information. Logic then proceeds to Benefit Pattern Block 61 (FIG. 349), where the consumer selects the type of term life insurance coverage desired (level, increasing or decreasing benefit). Logic then proceeds to Level Term Block 63 (FIG. 352), Increasing Term Block 65 (FIG. 351) or Decreasing Term Block 67 (FIG. 350), where the customer enters the amount of coverage (death benefit), the duration of the policy coverage and the number of years to pay the premium. In addition, for the Increasing Term Block 65 and the Decreasing Term Block 67, the consumer must enter the annual rate of death benefit increase or decrease, respectively (FIGS. 350 and 351). Thereafter logic proceeds to Term Disclaimer Block 69 (FIG. 359) where the consumer receives information about the quote illustration that will be provided. Thereafter, logic proceeds to Term Results Block 71 (FIGS. 360 and 361) for an illustration of the policy.

The consumer may select Home Protector Block 55 (FIG. 353), where the consumer enters relevant personal information (unless previously entered in which case it is reproduced here automatically). Logic then proceeds to Mortgage Input 1 Block 73 (FIG. 354), where the consumer enters information regarding the specified mortgage (mortgage balance/amount, interest rate, years left in mortgage and years to pay premium). Thereafter, logic proceeds to Mortgage Input 2 Block 75, where the consumer can modify the mortgage input information as desired. Thereafter logic proceeds to Term Disclaimer Block 69 (FIG. 359) where the consumer receives information about the quote illustration that will be provided. Thereafter, logic proceeds to Term Results Block 71 (FIGS. 360 and 361) for an illustration of the policy.

The consumer may select Needs Analysis Block 57 (FIGS. 355, 356 and 357), where the consumer first enters relevant general personal information (unless previously entered in which case it is reproduced here automatically), and additionally enters information regarding desired life insurance benefit, mortgage amount/balance, various other mortgage parameters, annual income to replace in the event of death and the number of years this income is needed, and further information on college funding for children or others. Logic then proceeds to Mortgage Input 2 Block 79 (FIGS. 355, 356 and 357), where the consumer may elect to modify his prior input to better assess his life insurance needs. During the consumers needs analysis for college funding, logic proceeds to College Tuition Block 81 (FIG. 358), where the consumer can obtain the average tuition, room and board for colleges and universities located the United States, to better assess his/her college funding needs. Thereafter logic proceeds to Term Disclaimer Block 69 (FIG. 359) where the consumer receives information about the quote illustration that will be provided. Thereafter, logic proceeds to Term Results Block 71 (FIGS. 360 and 361) for an illustration of the policy. Logic then proceeds to Apply Button from Quote Results Page Block 70.

Consider another aspect, focussing on the RealTime Term Educational Path (“Front End”). Prior to completing an application for term insurance, the consumer may choose to explore three educational paths to design and build his/her own policy, to decide to insure the consumer's home mortgage, and to use a automated needs analysis tool to help the consumer assess their overall need for term life insurance.

From the Term Home Page Block 51 (FIG. 348), the consumer may proceed to BYO Block 53 (Build Your Own policy) to design and customize their own term life insurance policy. Logic then begins with BYO Input Page Block 59 (FIG. 349), where the consumer enters relevant personal information. Logic then proceeds to Benefit Pattern Block 61 (FIG. 349), where the consumer selects the type of term life insurance coverage desired (level, increasing or decreasing benefit). Logic then proceeds to Level Term Block 63 (FIG. 352), Increasing Term Block 65 (FIG. 351) or Decreasing Term Block 67 (FIG. 350), where the customer enters the amount of coverage (death benefit), the duration of the policy coverage and the number of years to pay the premium. In addition, for the Increasing Term Block 65 and the Decreasing Term Block 67, the consumer must enter the annual rate of death benefit increase or decrease, respectively (FIGS. 350 and 351). Thereafter logic proceeds to Term Disclaimer Block 69 (FIG. 359) where the consumer receives information about the quote illustration that will be provided. Thereafter, logic proceeds to Term Results Block 71 (FIGS. 360 and 361) for an illustration of the policy.

The consumer may select Home Protector Block 55 (FIG. 353), where the consumer enters relevant personal information (unless previously entered in which case it is reproduced here automatically). Logic then proceeds to Mortgage Input 1 Block 73 (FIG. 354), where the consumer enters information regarding the specified mortgage (mortgage balance/amount, interest rate, years left in mortgage and years to pay premium). Thereafter, logic proceeds to Mortgage Input 2 Block 75, where the consumer can modify the mortgage input information as desired. Thereafter logic proceeds to Term Disclaimer Block 69 (FIG. 359) where the consumer receives information about the quote illustration that will be provided. Thereafter, logic proceeds to Term Results Block 71 (FIGS. 360 and 361) for an illustration of the policy.

The consumer may select Needs Analysis Block 57 (FIGS. 355, 356 and 357), where the consumer first enters relevant general personal information (unless previously entered in which case it is reproduced here automatically), and additionally enters information regarding desired life insurance benefit, mortgage amount/balance, various other mortgage parameters, annual income to replace in the event of death and the number of years this income is needed, and further information on college funding for children or others. Logic then proceeds to Mortgage Input 2 Block 79 (FIGS. 355, 356 and 357), where the consumer may elect to modify his prior input to better assess his life insurance needs. During the consumers needs analysis for college funding, logic proceeds to College Tuition Block 81 (FIG. 358), where the consumer can obtain the average tuition, room and board for colleges and universities located the United States, to better assess his/her college funding needs. Thereafter logic proceeds to Term Disclaimer Block 69 (FIG. 359) where the consumer receives information about the quote illustration that will be provided. Thereafter, logic proceeds to Term Results Block 71 (FIGS. 360 and 361) for an illustration of the policy. Logic then proceeds to Apply Button from Quote Results Page Block 70.

Turning now to the RealTime Life (RTL) Educational Path (“Front End”), prior to completing an application for permanent (variable universal) life insurance, the consumer may utilize up to three education paths to obtain a quick quotation (if they know their insurance needs), to design and build their own custom policy and a financial planning analysis tool to help the consumer decide the extent of their need for life insurance.

From the RTL Home Page Block 83 (FIG. 362), the consumer may choose to proceed to Quick Quote Block 85 (FIG. 363), where the consumer enters personal information to obtain a quick quotation of premium for a variable universal life insurance product. Thereafter, logic proceeds to Illustration Disclaimer Block 93 (FIGS. 364-365), which provides the consumer with appropriate disclaimer information prior to obtaining a quote result. Thereafter logic proceeds to Quick Quote Summary Block 95 (FIG. 356), where the essential information input by the consumer is displayed for review. Thereafter logic proceeds to Illustration Detail Block 97 (FIGS. 367-368), where a complete illustration of the life insurance is presented. Logic then proceeds to Save Block 99 where the customer may choose to save his/her illustration for further review at a later date, and also proceeds to Apply Now Block 101, which links to welcome.jsp (replaces 2.jsp) “You are about to begin the application process” Block 86.

From the RTL Home Page Block 83 (FIG. 362), the consumer may choose to build a custom variable universal life insurance policy tailored to his/her individual needs by selecting BYO. This selection causes logic to proceed to BYO Block 87 (FIG. 369), where general personal information is entered (unless previously entered in which case it is reproduced here automatically). Logic then proceeds to BYO Input 1 Block 103 (FIG. 370) where the consumer enters information on tobacco use, the amount of insurance and premium frequency and period. Thereafter logic proceeds to BYO Input 2 Block 105 where the consumer has the option to modify his policy after a review of his/her input parameters. Thereafter logic proceeds to BYO Riders Block 107 (FIG. 371), where the consumer can select various riders for his/her policy. Logic then proceeds to BYO Policy Changes Block 109 (FIG. 372), where the consumer can elect to make periodic withdrawals from the cash accumulation value. Thereafter logic proceeds to Cash Withdrawals Block 111 (FIG. 373), where the consumer specifies the timing and amount of withdrawals from the cash accumulation value. If the consumer answers “yes” to “Will you make another withdrawal?” (see FIG. 373), the logic proceeds to BYO Policy Changes Block 113, and then returns to BYO Policy Changes Block 109, until the consumer has completed their requested withdrawals. Once the consumer responds “No” to “Will you make another withdrawal?” in FIG. 373, the logic proceeds from Cash Withdrawals Block 111 to BYO Summary Block 115 (FIG. 374), where the consumer can review and elect to modify the design of the variable universal life insurance product. If the consumer “clicks” the BYO summary result is correct, logic proceeds to Illustration Disclaimer Block 117 (FIGS. 375-376), where the consumer receives important information on the product and services prior to proceeding further. If the consumer “clicks” “I Accept” on FIG. 375, logic proceeds to Illustration Detail Block 119 (FIGS. 377-378). Logic then proceeds to Save Block 99 where the customer may choose to save his/her illustration for further review at a later date, and also proceeds to Apply Now Block 101, which links to welcome.jsp (replaces 2.jsp) “You are about to begin the application process” Block 86.

From the RTL Home Page Block 83 (FIG. 362), the consumer may choose to use the RealTime Life Planner (RTL Planner). Accordingly, logic proceeds to Connector Circle 89, and then to RTL Planner Block 121 (FIGS. 379-380). Logic then proceeds to RTL Planner Input 1 Block 123 (FIGS. 379-380), where the consumer enters personal information (unless previously entered in which case it is reproduced here automatically). Additionally, the consumer enters certain financial information at this logic step. Thereafter, logic proceeds to RTL Planner Provide for Survivors Block 125 (FIGS. 381-382), where the consumer enters in a step-by-step interactive progression detailed information about the survivor benefit needed. Thereafter, logic proceeds to RTL Planner Retirement Block 127 (FIGS. 383-384), where the consumer enters information about retirement goals and needs. Thereafter logic proceeds to RTL Planner College Tuition Block 129 (FIGS. 385-387), where the consumer enters various information in a step-by-step interactive progression regarding college funding objectives. From Block 129, logic can access information on the costs of college tuition, fees and room & board for various colleges and in the United States through logic to RTL Planner College Tuition Block 131. Upon completion of Block 129 on saving for college, logic proceeds to RTL Planner Goals Block 133 (FIGS. 388-390), where the consumer can enter various other financial saving and funding goals. Thereafter logic proceeds to RTL Planner Summary Block 135 (FIGS. 391-392), where all the information entered into the RealTime Life Planner is presented. The consumer can modify any information during his/her review of the presentation from Block 135. Thereafter, logic proceeds to Illustration Disclaimer Block 137 (FIGS. 393-394), where the consumer receives important information on the product and services prior to proceeding further. Logic then proceeds to RTL Planner Graph Page Block 139 (FIGS. 395-396), where a financial solution using variable universal life insurance is presented in a graphical format. Logic also allows the consumer to select from Block 139 the detailed cash needs by year through Cash Needs Summary Block 141 (FIGS. 397-398). From Cash Needs Summary Block 141, logic can proceed (at the option of the consumer by “clinging on the appropriate “button”) directly to either Save Block 145, where the consumer's planner results are saved for later review, or to Apply Now Block 147, where the consumer proceeds to Apply Now Block 101, which links to welcome.jsp (replaces 2.jsp) “You are about to begin the application process” Block 86. From either RTL Planner Graph Page Block 139 or Cash Needs Summary Block 141, logic proceeds to Illustration Details Block 143 (FIGS. 399-400), which presents a complete policy illustration that meets the previously defined needs and goals from Blocks 121 through 141. From Illustration Details Block 143, logic proceeds to either Save Block 145, where the consumer's planner results are saved for later review, or to Apply Now Block 147, where the consumer proceeds to Apply Now Block 101, which links to welcome.jsp (replaces 2.jsp) “You are about to begin the application process” Block 86.

Returning now to broader concepts, the invention involves an approach to automating in response to problems undetected before the inventors. The approach is broadly applicable, and the foregoing is an illustrative embodiment.

An interesting aspect of the present approach is product delivery. This can be done in an internal operation in one aspect of the present invention, but another approach involves, after handling an application to enable buying the product, triggering delivery of the product via a third party administrator (TPA).

The TPA handles the products (in the present example, life insurance policies) offered for sale by over the Internet-type network with the virtual financial institution (Company) handling a role as an Agent and handling a licensed broker-dealer role too, in all jurisdictions in which the Company transacts business. TPA may perform services through a web site. The TPA is licensed as a life insurance agency with authority to sell variable life insurance products or transacts business through appropriately licensed individual agents in jurisdictions which do not license non-resident corporations as insurance agents. TPA further is licensed as a third party administrator, or registered as a third party administrator. The Company assumes the expense of all appointment fees incurred in connection with initial and renewal appointments of agents. Insofar as any state law requires TPA to be appointed as such by Company, Company assumes the expense of all appointment fees incurred in connection with initial and renewal appointments of TPA. The TPA keeps electronic records of all communications with Company, but shall not be obligated to provide paper copies of any electronic communication with the Company.

The TPA can be responsible for collecting premiums, in one way of handling the situation with respect to the policies, forwarding premiums to the Company or depositing premiums to Company's account. Premiums (product payment) can be remitted directly by customers (insureds) to the Company through credit card payments, electronic funds transfers, or otherwise. The TPA may receive premium payments electronically to the extent allowed by law by any permissible means available. Policy loan and withdrawal requests in the TPA approach can be handled as follows: upon receipt of a request for a policy loan or withdrawal, TPA verifies a policyholder's eligibility, and thereafter transmits electronically to the Company the policyholders request. The Company can transmit the funds requested to TPA, for prompt delivery to the policyholder, even via the Internet-type network.

The TPA and the Company agree and acknowledge that any medical or health information of any policyholder or prospective policyholder with respect to the policies is kept confidential.

The TPA can do the following services: evaluate applications for policies; present binding offers of coverage to prospective policyholders who are approved by the Underwriting System as within underwriting parameters specified by the Company; provide to the Company a review of risks which are not approved by the Underwriting System for a binding offer to be made by TPA; deliver one or more an electronic file(s) of information to Company for manual underwriting; receive a binding offer back from Company, and deliver it to the customer—all this to be triggered by the Company utilizing the present invention.

With respect to risks which are not approved by the Underwriting System: the TPA can order and receive MIB reports, motor vehicle, credit bureau and other reports; order attending physician statements; order medical and paramedical examinations of prospective policyholders who are not within underwriting criteria; provide prospective policyholders with all written disclosures and notices; collect all signatures from applicants; and collect and report specimen testing results in accordance with established guidelines.

The TPA can also maintain a customer service center to assist applicants with the insurance application process and with services—preferably transparent to customers.

The TPA can also print and deliver the policies to policyholders (financial products or related documentation), over the Internet-type delivery is also contemplated. Thus the TPA can deliver in-force files, or, at the Company's request, alternatively printed insurance applications and documentation triggered to be conveyed on to the customer.

Further the TPA can be used to provide written (or electronic) notice to policyholders of the identity of TPA and the relationship among the TPA and the Company and policyholders.

The TPA can additionally be used (via electronic link over said network) to provide policyholders with access to TPA's on-line interactive automated account management and Policy administration services which will allow policyholders to perform the following activities on line: change address, change beneficiary, change investment fund allocations, borrow or withdraw funds and change coverage.

The TPA more over can handle the collecting of premiums and charges and process withdrawal and loan requests, etc.

The TPA electronically reports to the Company as expeditiously as possible the binding of policies to be issued by the Company through the web site. Following the issuance of a policy, the TPA electronically transmits to the Company the underwriting file of the TPA (in digitized form, if such an approach is utilized) and an in-force file in a format to be agreed by the parties; provided, however, that at the Company's request, the TPA can transmit to the Company copies of printed life insurance applications in lieu of in-force files. Company utilizes the present invention in providing TPA computer support, as may be needed, for the TPA to convert its underwriting file and in-force file to a format compatible with the Company's system requirements.

The TPA processes requested policy modifications, transmits confirmation notices to policyholder, and provides reports to the Company of such changes. Such reports may be in an electronic format.

The TPA records all policyholder requests for transfers of funds among investment fund options, and provides the Company with reports of such requests. Such reports may be in an electronic format.

The TPA additionally records and processes policyholder requests for a loan or withdrawal, and remits to the policyholder amounts withdrawn together with applicable tax reporting forms. The TPA provides the Company with reports of such transactions. Such reports, which the TPA generates may be in an electronic format, with suitable responsibility for reporting loans/withdrawals to the IRS.

The Company is responsible for preparing all policies, termination notices or other such communications to insureds, and transmitting them to the TPA in an electronic format or in paper copy where necessitated by law. The TPA is then responsible for promptly delivering the policies, termination notices or other such written communications, and for collecting Policy delivery receipts. The TPA may deliver the policies in an electronic format through electronic means where agreed to by those involved, including a verification by the insured(s).

The Company can handle processing and distributing of all lapse notices and reinstatements, with duplicate notice to TPA.

The Company can forward to the TPA a report of all business becoming effective or renewed, including such information for each policy as: policy number, date of processing, name of insured, name of policy owner, date issued, date premium paid, annual premium, face amount of coverage, and distribution source.

The TPA electronically reports to the Company any changes to the address of beneficiary of a policyholder, changes to investment fund allocations, requested loans or withdrawals of policy amounts or changes in average.

Using either an internal product delivery system to completely automate needs analysis and sale of a financial product over the Internet is a breakthrough over the use of the Internet as a teaser for connecting a potential customer with a human—all by virtue of the present invention.

In sum, the present invention involves a computer system used to support such things as needs analysis and delivery of a financial innovation. A variety of financial products can be supported by the platform in carrying out the innovation, as set out in the patents incorporated by reference. For example, a mortgage with or without an investment as a means for repaying the mortgage. This investment may collateralize the mortgage. Iso, the investment may serve in place of a down payment for a conventional mortgage. The combination is tailored to meet the US legal requirements for offering such a combination.

There are many variations on the theme of this invention, revolving primarily around variations in the kind of financial product and/or investment and combinations thereof—even accounts such as brokerage accounts. All involve providing the consumer access to the financial products in a way not done before.

As to the investment, in one case, it can be a tax-favored account or investment, such as an IRA, Keough, or 401K plan, but in another case, the investment can be held separately (i.e., in a manner that is not tax-favored). Employee benefit plans, including qualified and nonqualified plans, are suitable as well. Indeed, the present structure can operate as a trading system for non-commonly traded or sold products—even non-financial products.

In any of these cases, one alternative is for the investment to include a security or a security in combination with term life insurance. The security can be a zero coupon bond, such as a US Treasury Derivative or a municipal bond derivative, or the security can be a mutual fund.

Another alternative is for the investment to include an annuity. The annuity can be either an immediate annuity or a deferred annuity. Each can be used with or without life insurance. The immediate annuity can be used to pay on an asociated financial product such as a mortgage, more particularly where the mortgage is a home equity loan, and term life insurance can be used in repaying the home equity mortgage. The deferred annuity can be a single premium, level premium, or variable premium annuity and may be used as a means for accumulating the principal to repay the mortgage or some other investment/financial product.

Still another alternative is for the investment to include other known forms of life insurance beyond those representatively discussed herein, e.g., the life insurance can be term or permanent. Or more particularly, the permanent life insurance can be one policy covering two insured lives (e.g., borrower and co-borrower), and such a policy can be a joint policy (which pays on the first death) or a joint and survivor policy (which pays on the second death). The policy may also be a single policy covering a single life. Either way, the permanent life insurance can be universal life insurance or variable life insurance, or the permanent life insurance can have at least one rider, such as a disability rider or an income rider.

For any of these cases and any of these alternatives, an associated mortgage can be more particularly defined as including a first mortgage, a home equity mortgage, a balloon repayment mortgage, a fixed interest mortgage, or a variable interest mortgage. As to the latter, the computer system can be programmed to compute a fixed payment, variable interest rate mortgage having extra amortization of principal when interest rates are low, and negative amortization of the principal when interest rates are high. Such a mortgage may be used together with permanent life insurance or a deferred annuity such that cash value accumulation from the investment is an offset to the negative amortization.

For other variations on a theme, the financial products and disclosure of U.S. patent application Ser. No. 08/906,736 and Ser. No. 089/313,293, both of the inventors herein, are also incorporated by reference.

While this invention has been particularly shown and described with reference to a preferred embodiment, it will be readily appreciated by those of ordinary skill in the art that various changes and modifications may be made without departing from the spirit or scope of the invention. For example, the particular formats of the various display screens or output herein described may be modified, as desired. Likewise, the present invention should not be limited to the specific examples described herein since a greater or lesser number of options and functions are intended to be within the scope of this invention. It is, therefore, contemplated that the appended claims be interpreted as including the foregoing and other changes and modifications.

We claim

1. A method for making a sale of a financial product by computer, the method including the steps of:
interacting over an Internet-type network with a person's computer to determine a financial need of the person, said interacting including the sub-steps of:
associating a financial product with the need;
disclosing the cost of the financial product to the person; and
automatically triggering delivery of the financial product.

2. The method of claim 1, further including the sub-step of:
handling an application to enable carrying out the triggering step.

3. The method of claim 1, further including the sub-step of:
automatically taking payment for the financial product.

4. The method of claim 1, wherein the step of interacting is carried out by using a data persistent architecture.

5. An apparatus for making a sale of a financial product by computer, apparatus including:
a computer interacting over an Internet-type network with a person's computer;
a computer program controlling the interacting by responsively determining a financial need of the person, associating a financial product with the need, disclosing the cost of the financial product to the person; and triggering delivery of the financial product.
